(19) United States
(12) Patent Application Publication
(10) Pub. No.: US 2025/0265637 A1
(43) Pub. Date: Aug. 21, 2025

(54) INTERACTIVE SHOPPING ENVIRONMENT CUSTOMIZATION AND PERSONALIZED RECOMMENDATIONS SYSTEM AND RELATED METHODS

(71) Applicant: PersonalX.com Inc., Dover, DE (US)

(72) Inventors: Adriana Ferreyr, Palm Beach, FL (US); Marcello Di Giovanni, Macerata Campania (CE) (IT)

(21) Appl. No.: 18/963,414

(22) Filed: Nov. 27, 2024

Related U.S. Application Data
(63) Continuation-in-part of application No. 18/792,604, filed on Aug. 2, 2024, now abandoned.
(60) Provisional application No. 63/720,804, filed on Nov. 15, 2024.
(60) Provisional application No. 63/679,937, filed on Aug. 6, 2024.
(60) Provisional application No. 63/505,857, filed on Jun. 2, 2023.

(51) Int. Cl. G06Q 30/0601

(52) U.S. Cl. CPC G06Q 30/0643; G06Q 30/0621; G06Q 30/0631

(57) ABSTRACT

A method of customizing an interactive shopping environment for a user includes receiving user input associated with a shopping session. A design element is generated based on at least a portion of the received user input. The interactive shopping environment including a visual representation of the design element is generated such that the user can interact with the visual representation within the interactive shopping environment. User feedback is received associated with the visual representation. The interactive shopping environment is updated based at least in part on the received user feedback to generate a revised interactive shopping environment including a revised visual representation of the design element. Responsive to receiving user input indicating approval of the revised interactive shopping environment, the revised visual representation is converted into a user selectable element.

### CROSS-REFERENCE TO RELATED APPLICATIONS

This application claims the benefit of and priority to U.S. provisional application No. 63/720,804, filed Nov. 15, 2024, this application also claims the benefit of and priority to U.S. provisional application No. 63/679,937, filed Aug. 6, 2024, this application also claims the benefit of and priority to U.S. provisional application No. 63/588,693, filed Oct. 7, 2023, this application also claims the benefit of and priority to U.S. provisional application No. 63/586,358, filed Sep. 28, 2023, this application is a continuation-in-part of U.S. non-provisional application Ser. No. 18/792,604, filed Aug. 2, 2024, which claims the benefit of and priority to U.S. provisional application No. 63/505,857, filed Jun. 2, 2023, each of which is hereby incorporated by reference herein in its entirety.

### TECHNICAL FIELD

The present disclosure relates generally to an interactive shopping environment. More particularly, the present disclosure relates to a customized interactive shopping environment providing personalized recommendations.

### BACKGROUND

In recent years, the retail industry has been undergoing a significant transformation driven by advancements in technology. The rise of e-commerce has shifted consumer expectations, with shoppers now seeking more personalized and engaging experiences. Traditional brick-and-mortar stores are increasingly integrating digital elements to enhance customer interaction and satisfaction. This shift has led to the development of interactive shopping environments, where technology plays a crucial role in creating immersive and customized shopping experiences.

Artificial intelligence (AI) and machine learning (ML) have emerged as pivotal technologies in this transformation. These technologies enable retailers to analyze vast amounts of data to better understand consumer preferences and behaviors. By leveraging AI and ML, retailers can offer personalized recommendations, tailor marketing strategies, and optimize inventory management. The integration of AI and ML into shopping environments not only enhances the customer experience but also provides retailers with valuable insights to drive sales and improve operational efficiency. As the demand for more interactive and personalized shopping experiences continues to grow, the need for innovative solutions that combine these technologies becomes increasingly apparent.

### SUMMARY

According to some implementations of the present disclosure a method of customizing an interactive shopping environment for a user includes: receiving user input associated with a shopping session; generating a design element based on at least a portion of the received user input; generating the interactive shopping environment including a visual representation of the design element such that the user can interact with the visual representation within the interactive shopping environment; receiving user feedback associated with the visual representation; updating the interactive shopping environment based at least in part on the received user feedback to generate a revised interactive shopping environment including a revised visual representation of the design element; and responsive to receiving user input indicating approval of the revised interactive shopping environment, converting the revised visual representation into a user selectable element.

According to some implementations of the present disclosure a system includes: a control system having one or more processors; and a memory device having stored thereon machine readable instructions, the control system coupled to the memory device such that at least one of the one or more processors is configured to execute the machine executable instructions to cause the system to: receive user input associated with a shopping session; generate a design element based on at least a portion of the received user input; generate the interactive shopping environment including a visual representation of the design element such that the user can interact with the visual representation within the interactive shopping environment; receive user feedback associated with the visual representation; update the interactive shopping environment based at least in part on the received user feedback to generate a revised interactive shopping environment including a revised visual representation of the design element; and responsive to receiving user input indicating approval of the revised interactive shopping environment, convert the revised visual representation into a user selectable element.

According to some implementations of the present disclosure a method of customizing an interactive shopping environment for a user includes: receiving user input associated with a shopping session; generating a design element based on at least a portion of the received user input; generating the interactive shopping environment including a user selectable representation of the design element such that the user can interact with the user selectable representation within the interactive shopping environment; and responsive to a selection associated with the user selectable representation, directing the user to a third party interface to aid the user in purchasing an item associated with the design element.

According to some implementations of the present disclosure a system includes: a control system having one or more processors; and a memory device having stored thereon machine readable instructions, the control system coupled to the memory device such that at least one of the one or more processors is configured to execute the machine executable instructions to cause the system to: receive user input associated with a shopping session; generate a design element based on at least a portion of the received user input; generate the interactive shopping environment including a user selectable representation of the design element such that the user can interact with the user selectable representation within the interactive shopping environment; and responsive to a selection associated with the user selectable representation, direct the user to a third party interface to aid the user in purchasing an item associated with the design element.

According to some implementations of the present disclosure a computer-implemented method for providing personalized recommendations includes: identifying, by a processing unit, a specific agent most suited to respond to a search query, wherein the specific agent is associated with a particular domain or category of items; engaging, by the specific agent, in a personalized interaction with a user by generating targeted follow-up questions related to the search query to refine search results; synthesizing, by a large language model (LLM), user inputs to optimize a recommendation process and provide recommendations in real-time; generating, by a personalized outfit recommendations system, recommendations using machine learning algorithms and recommender systems trained on user preferences and historical data; generating, by a Wedding Planner AI, an image contesting a design of a wedding based on user answers, sharing suggestions to a client based on latest wedding trends, and processing user preferences to create projects and lists of real products to purchase; and processing, by an Interior Designer AI, user preferences to create interior design projects and lists of real products to purchase.

According to some implementations of the present disclosure a system for providing personalized recommendations includes: a processing unit configured to identify a specific agent most suited to respond to a search query, wherein the specific agent is associated with a particular domain or category of items; a specific agent configured to engage in a personalized interaction with a user by generating targeted follow-up questions related to the search query to refine search results; a large language model (LLM) configured to synthesize user inputs to optimize a recommendation process and provide recommendations in real-time; a personalized outfit recommendations system configured to generate recommendations using machine learning algorithms and recommender systems trained on user preferences and historical data; a Wedding Planner AI configured to generate an image contesting a design of a wedding based on user answers, share suggestions to a client based on latest wedding trends, and process user preferences to create projects and lists of real products to purchase; and an Interior Designer AI configured to process user preferences to create interior design projects and lists of real products to purchase.

### BRIEF DESCRIPTION OF THE DRAWINGS

### Customization of Shopping Environment

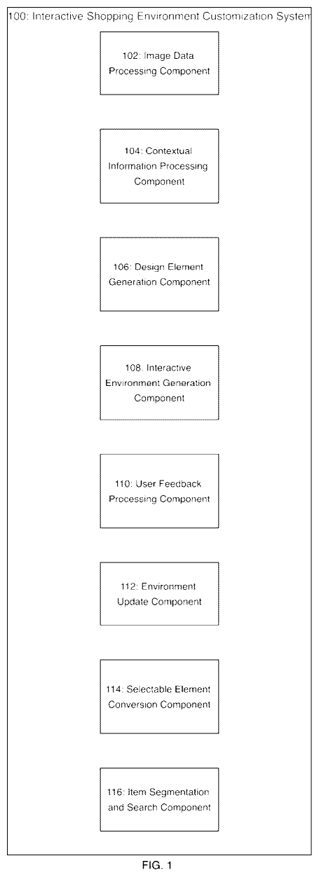

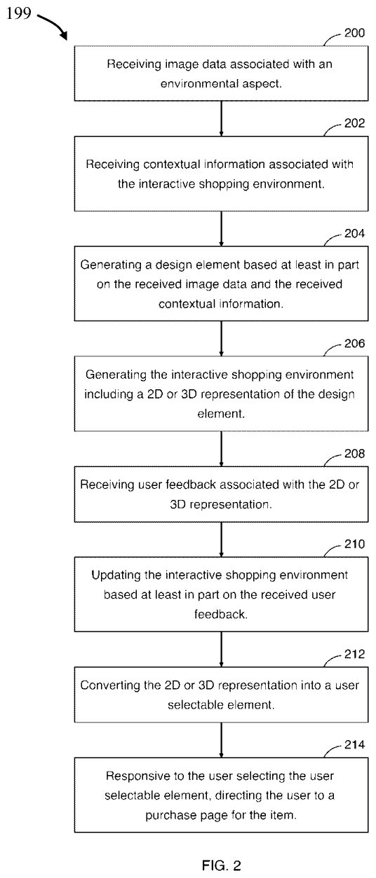

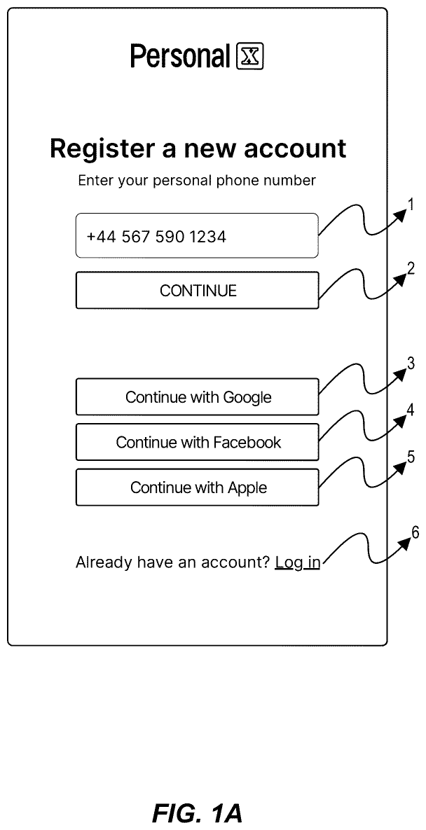

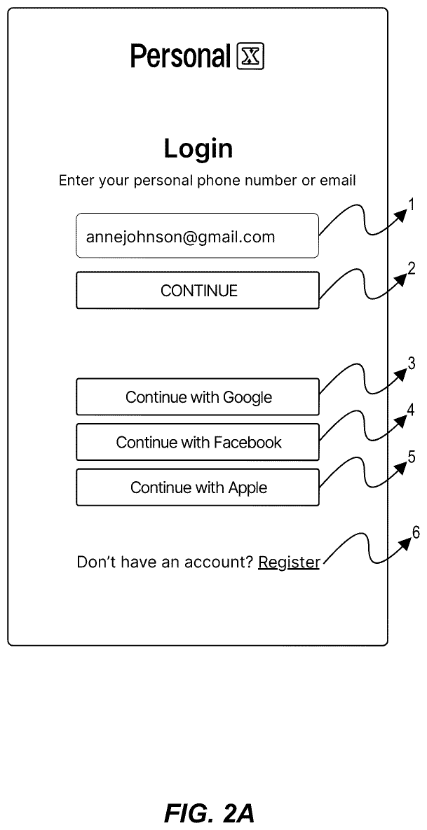

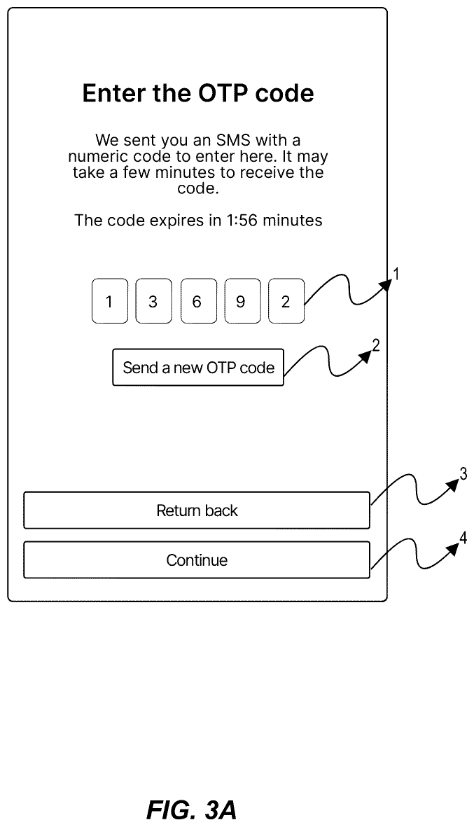

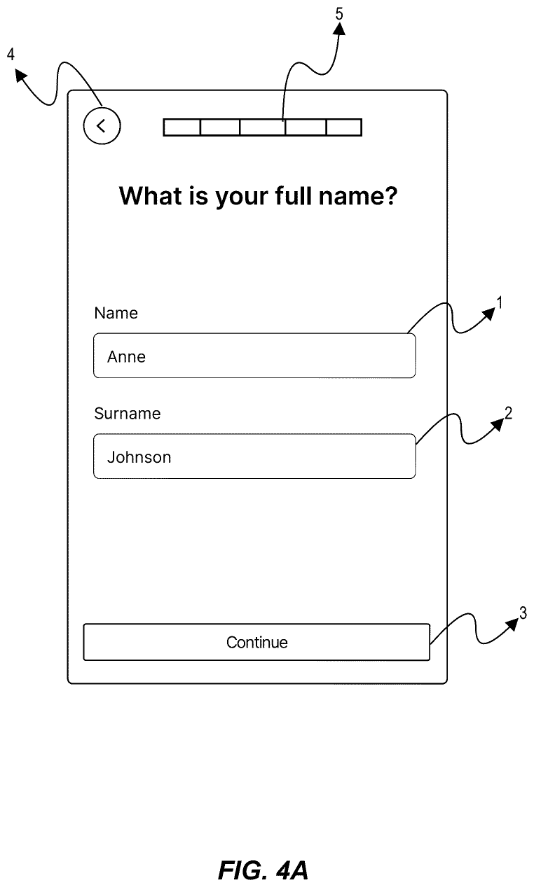

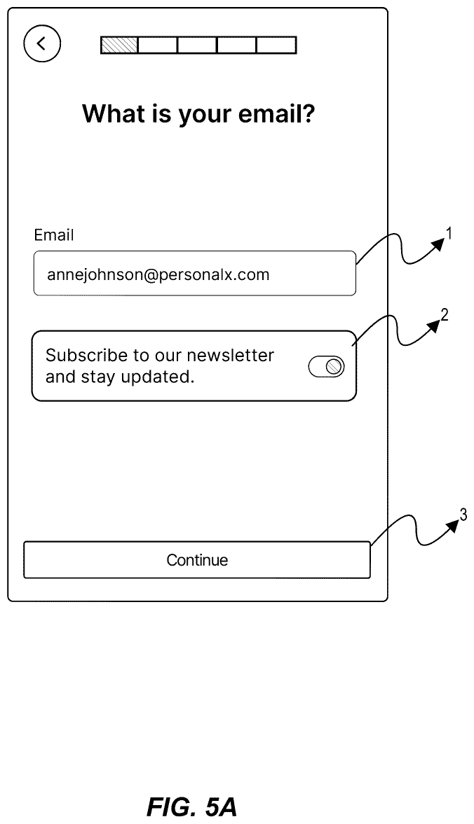

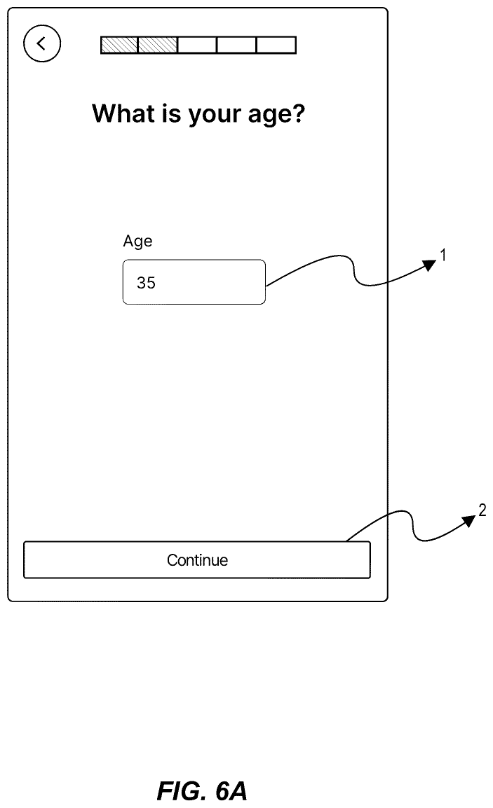

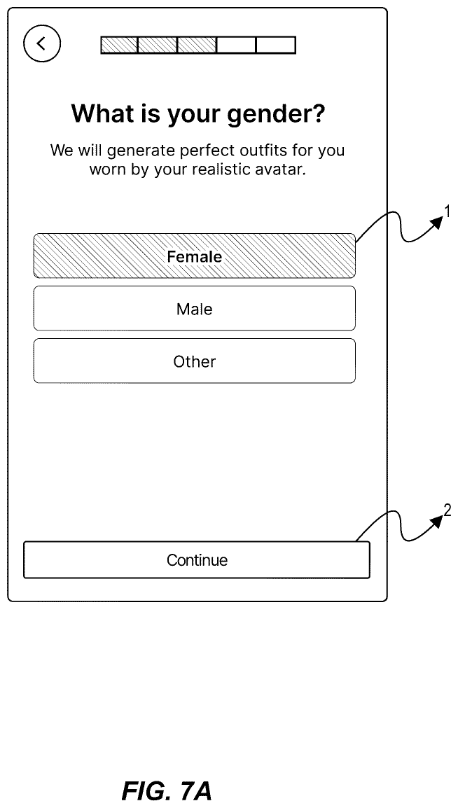

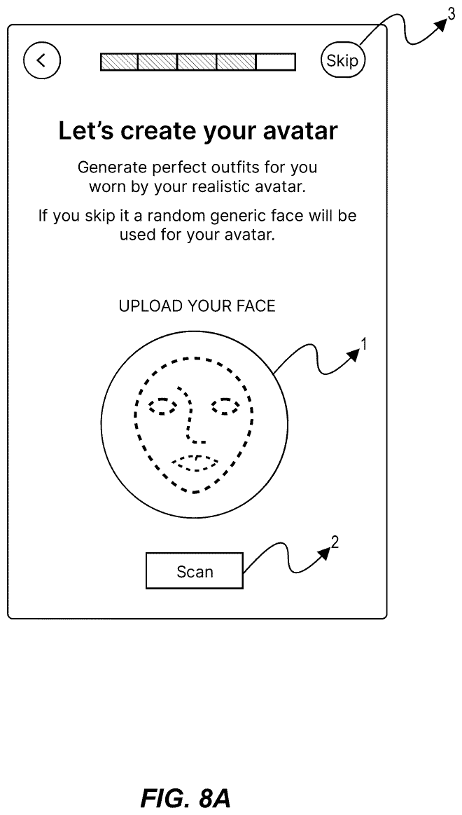

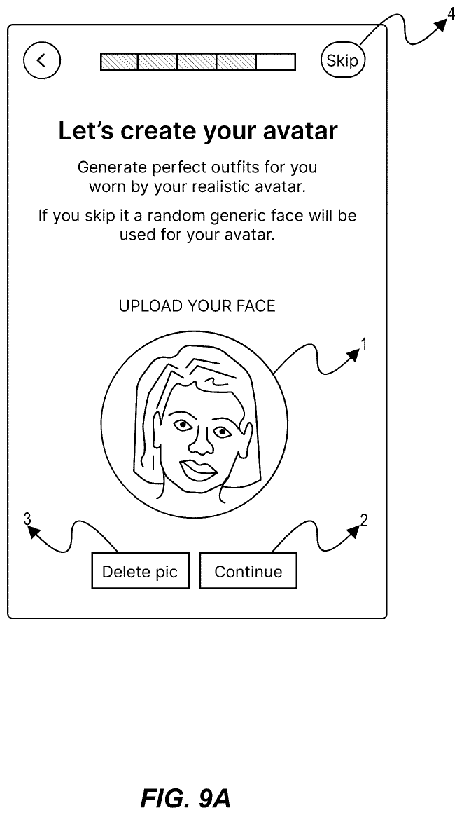

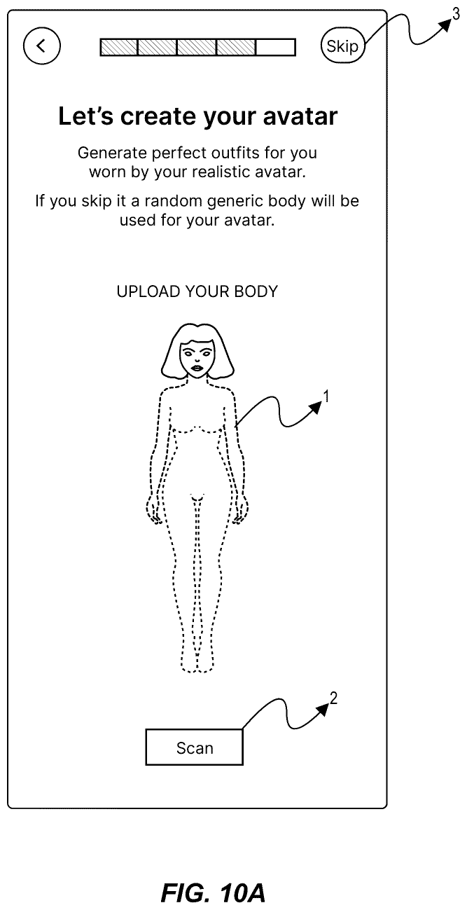

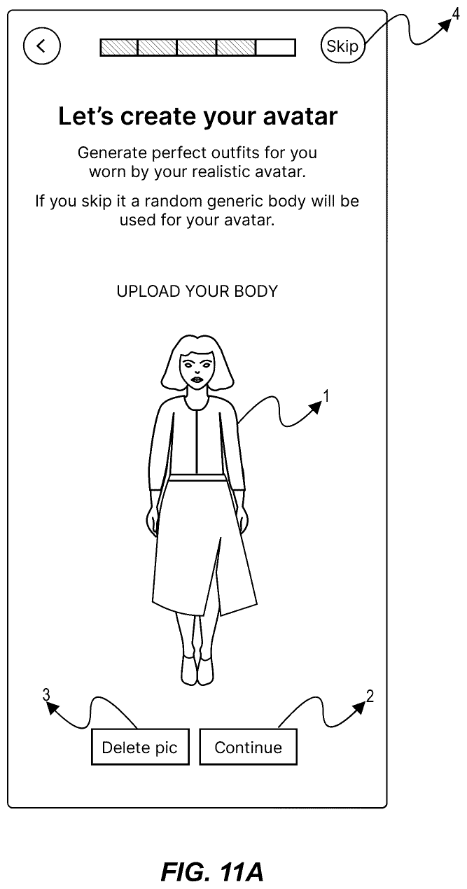

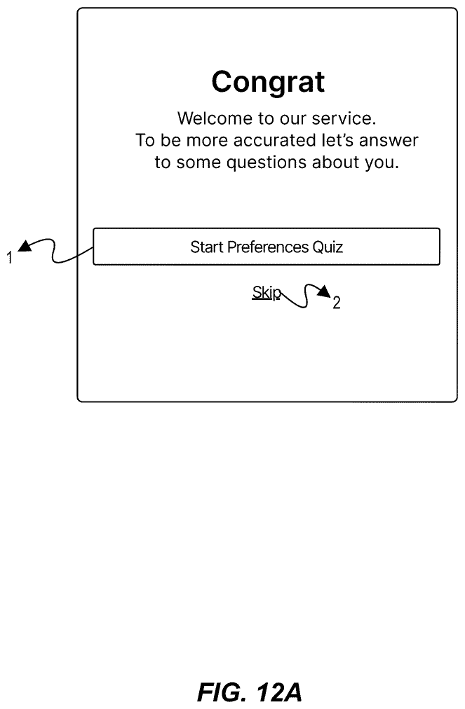

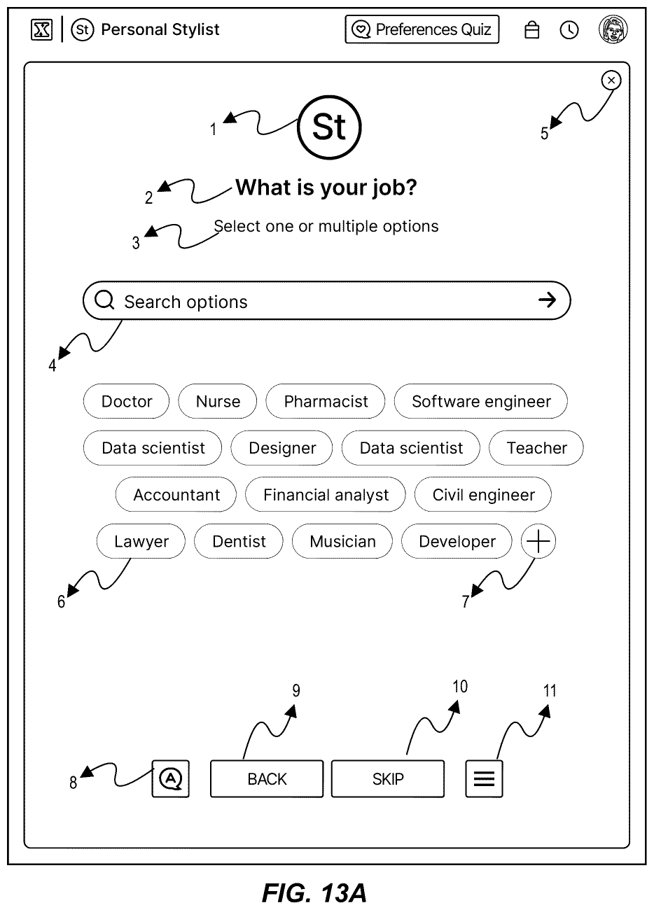

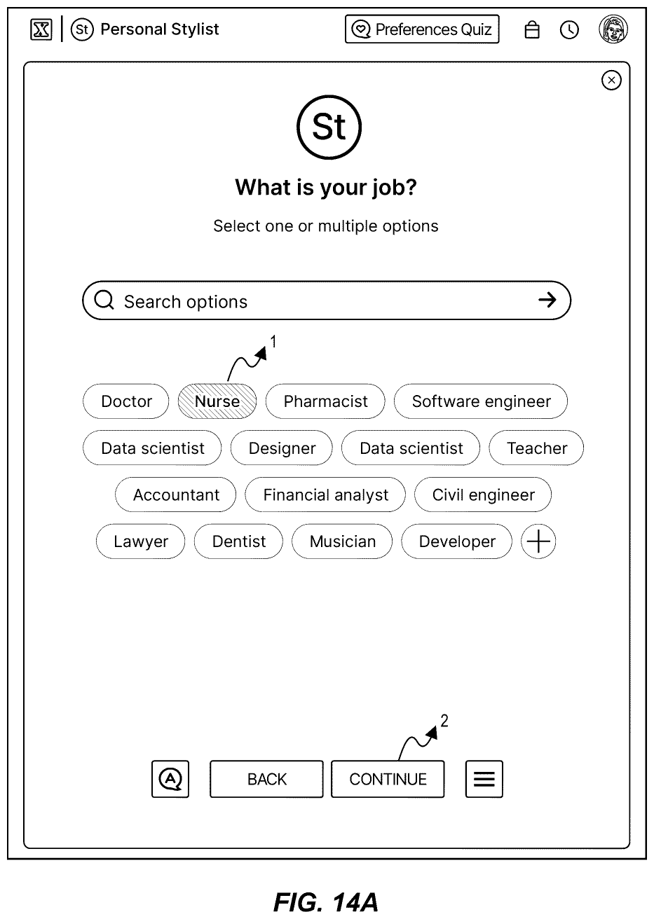

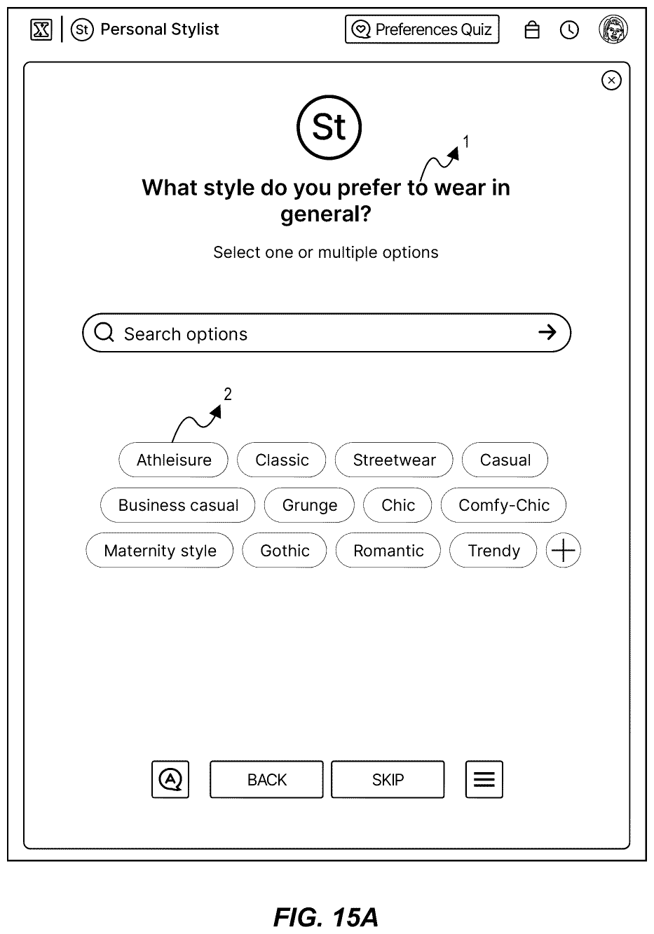

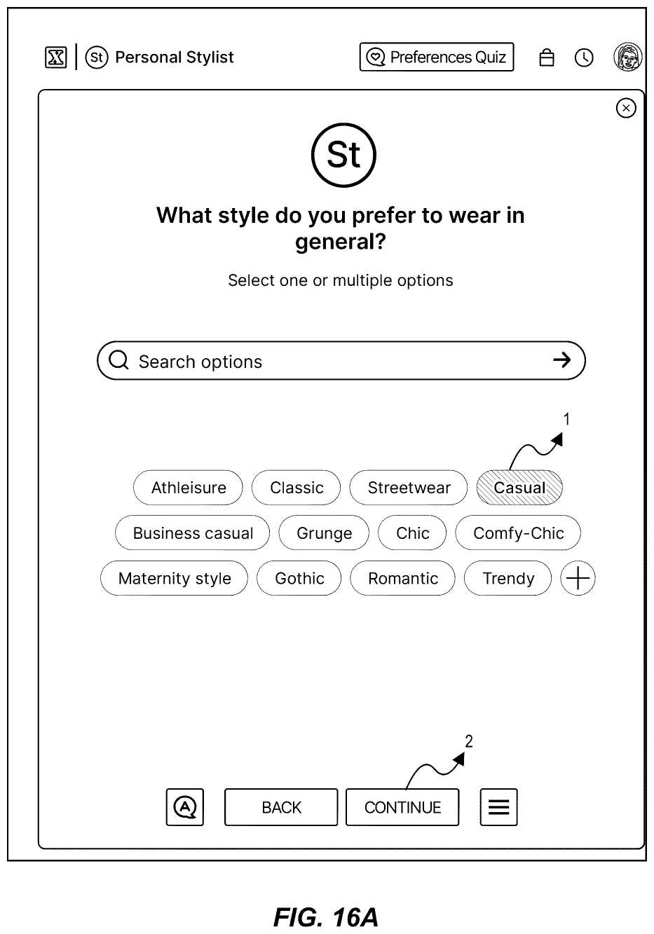

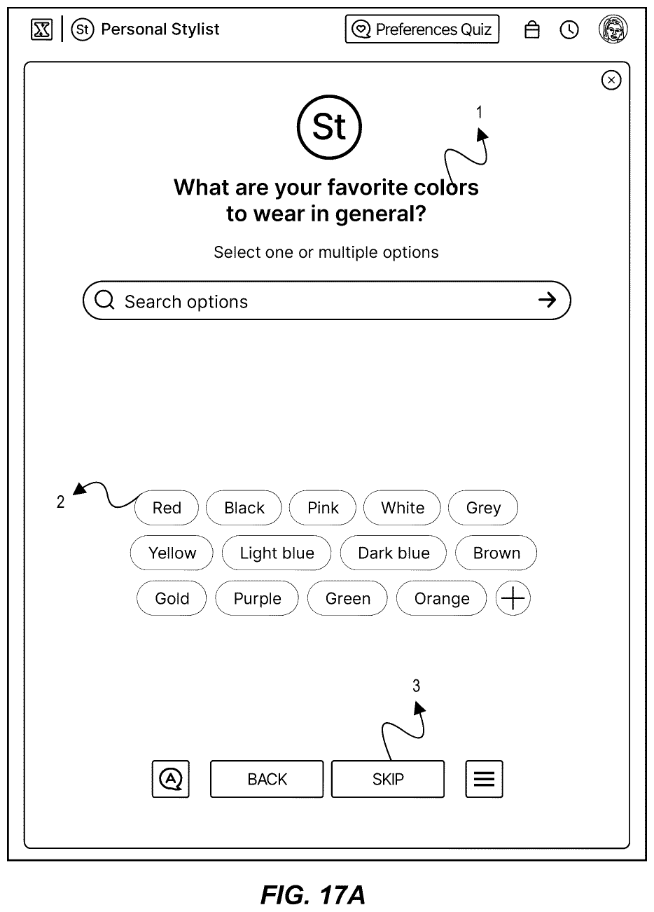

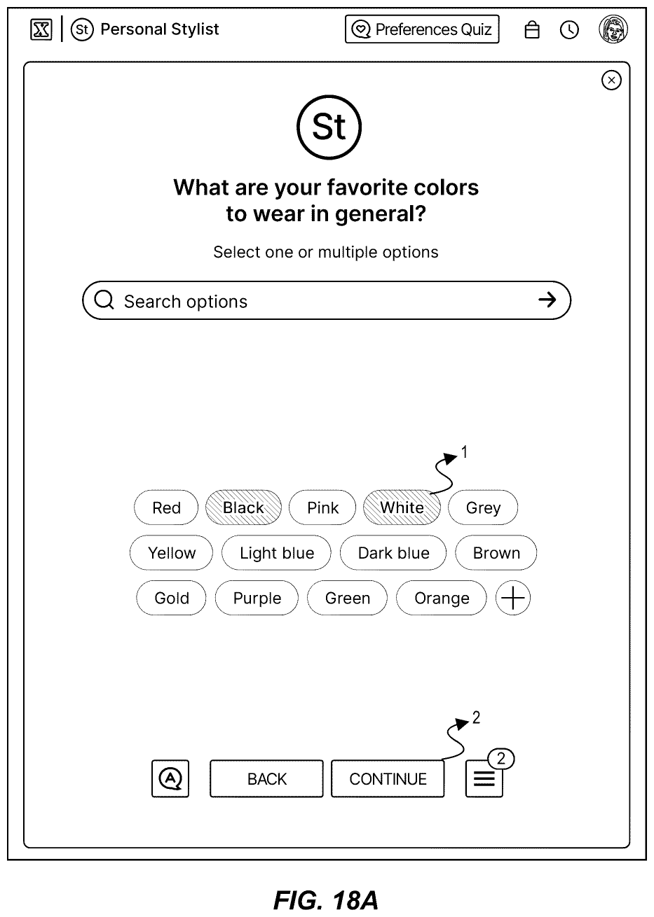

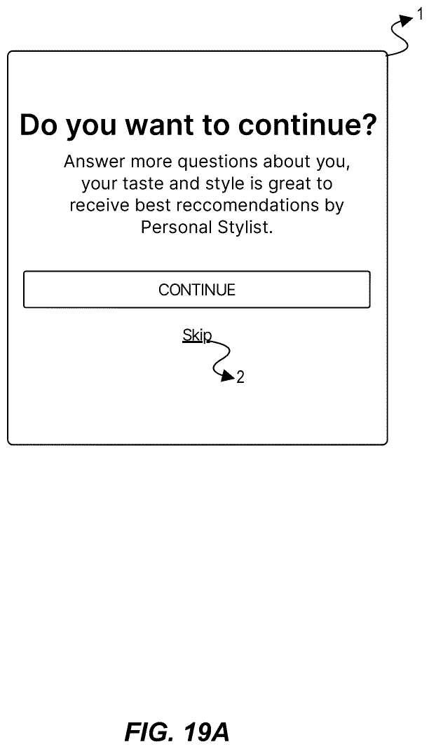

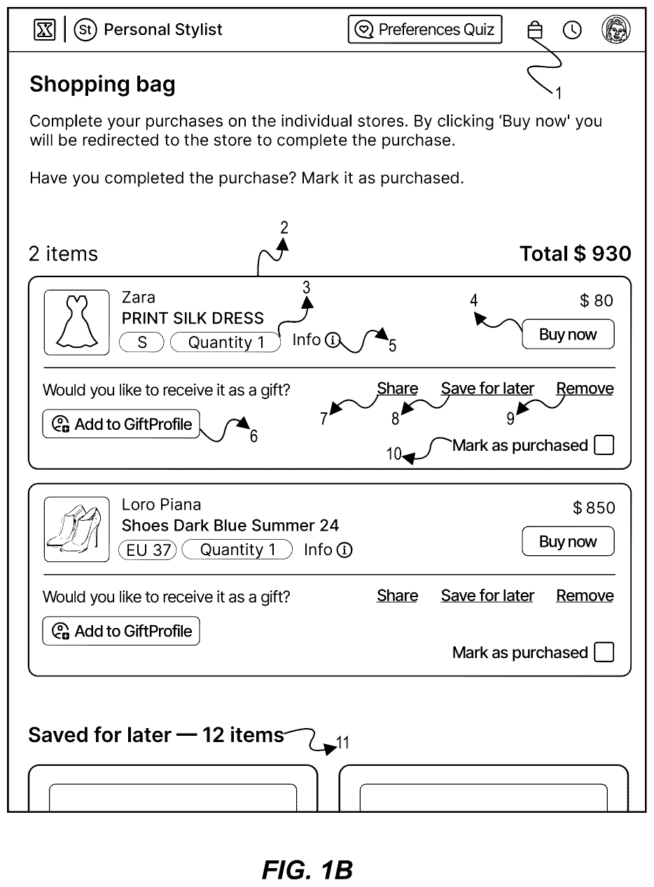

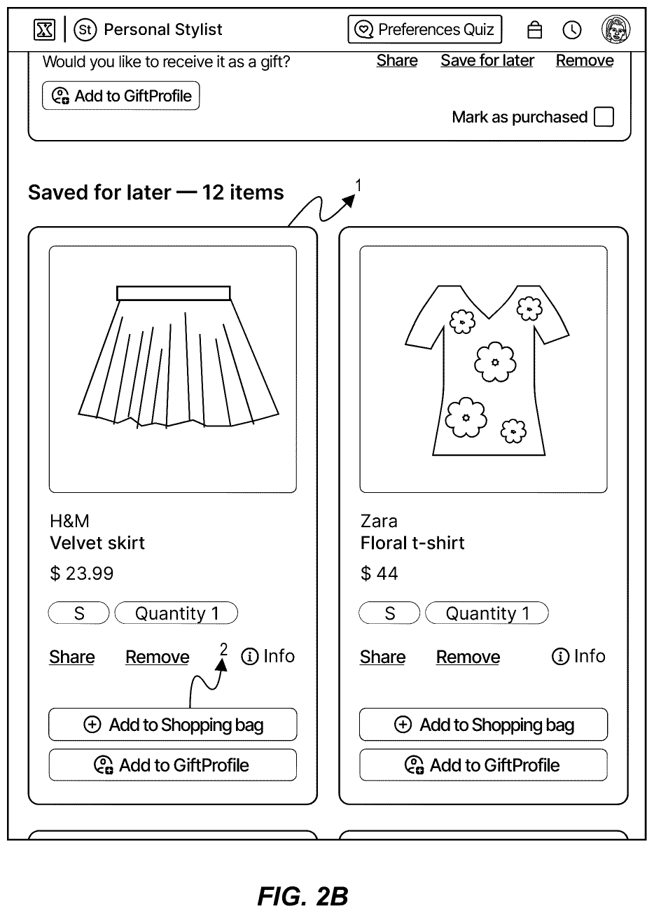

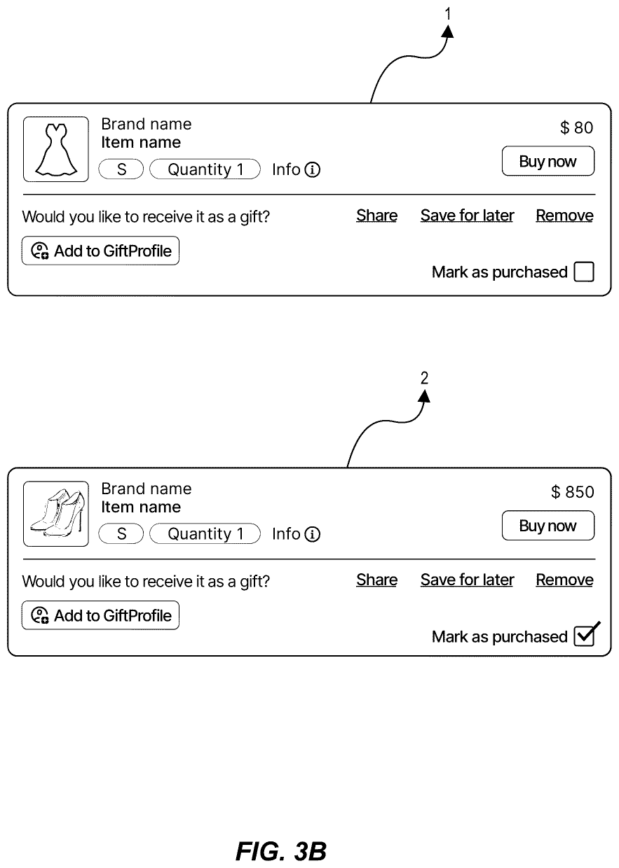

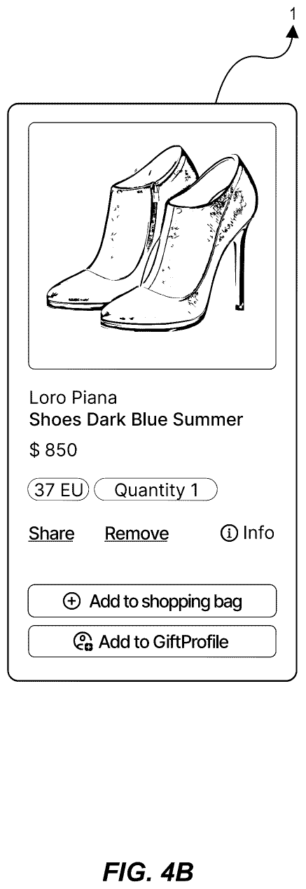

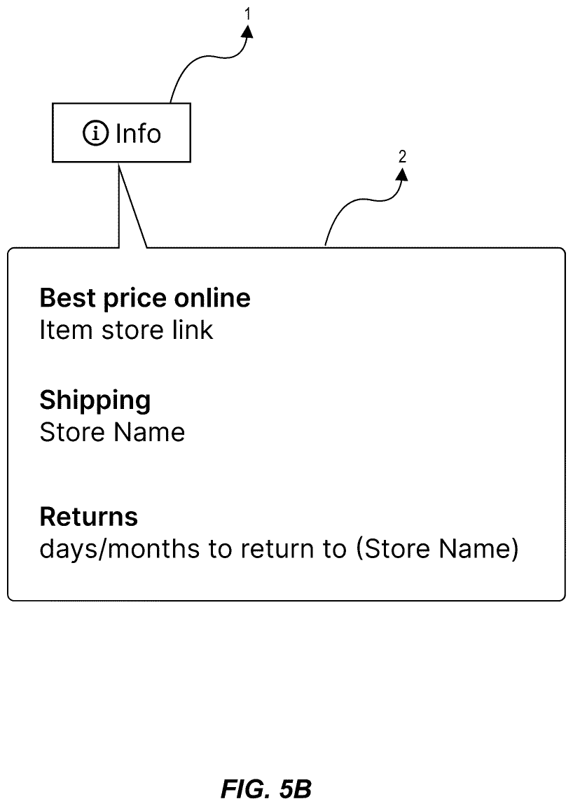

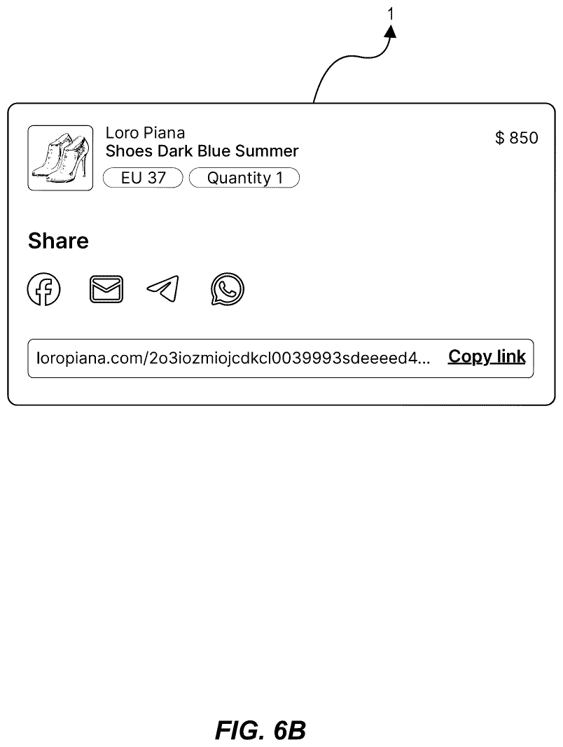

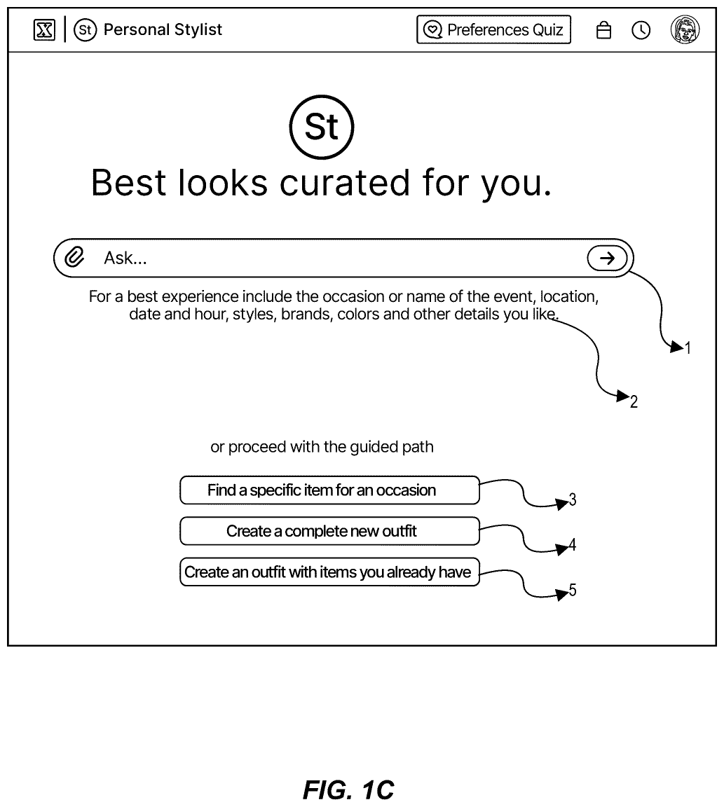

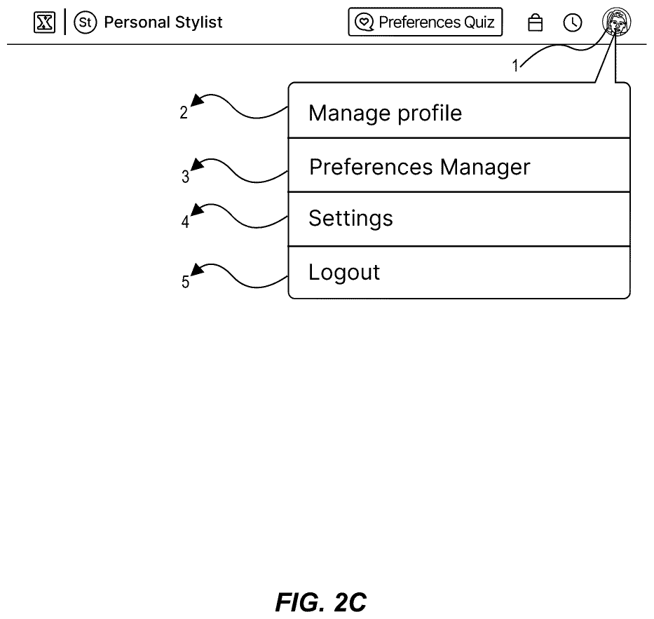

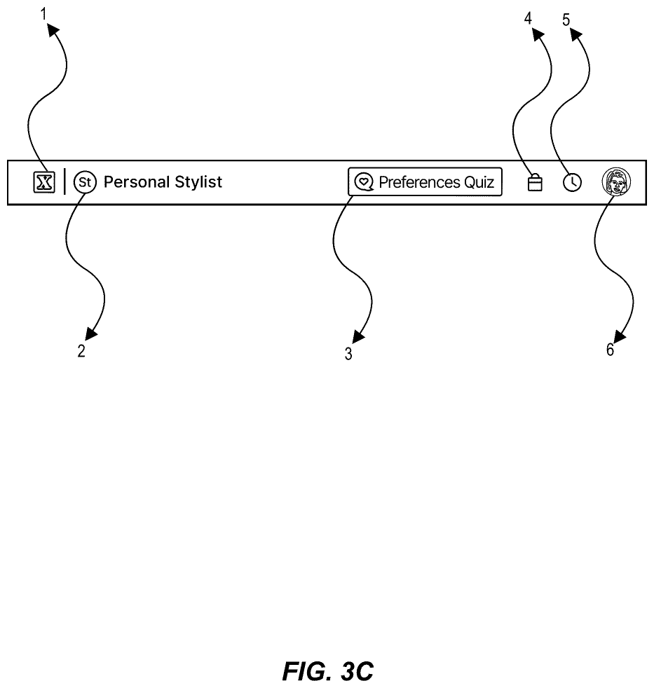

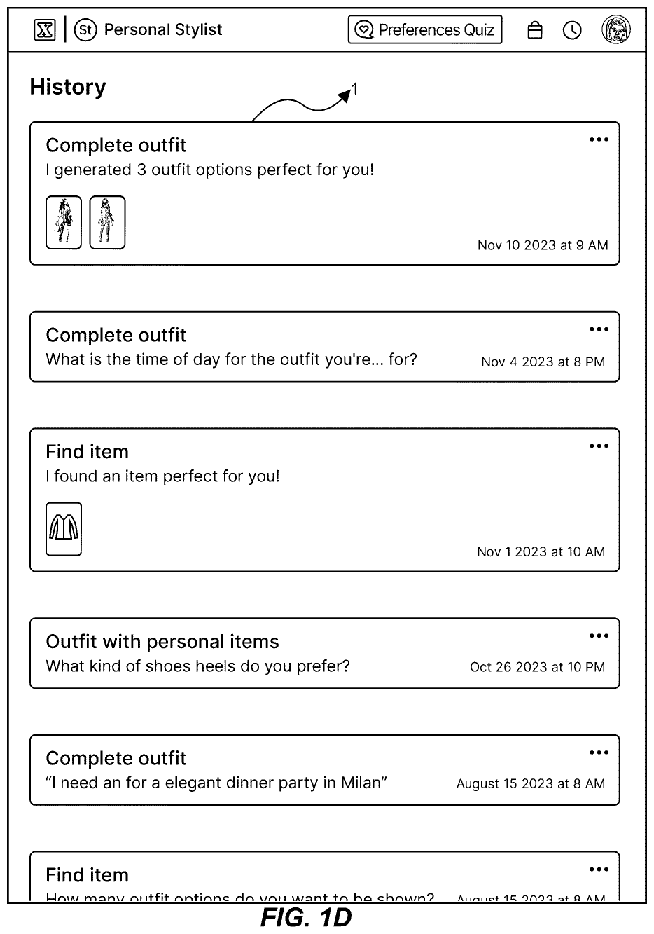

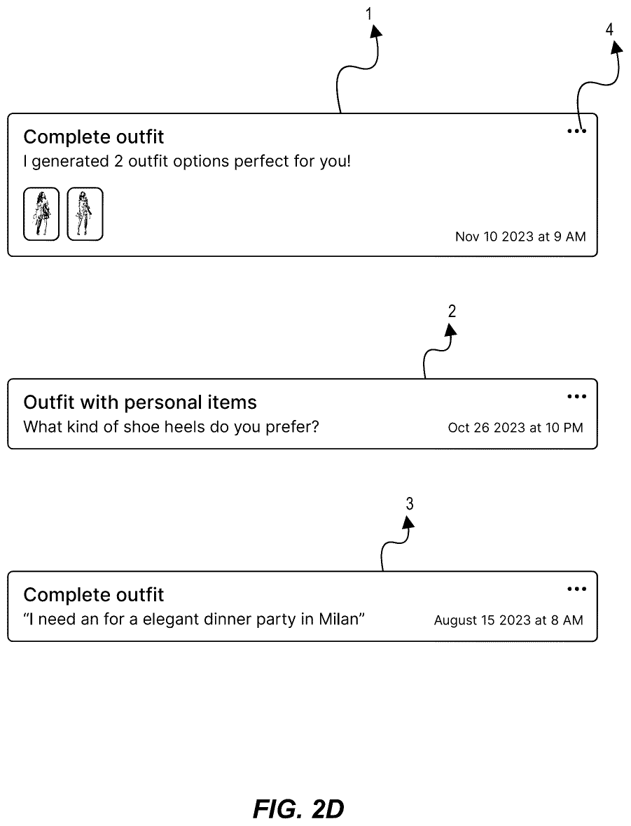

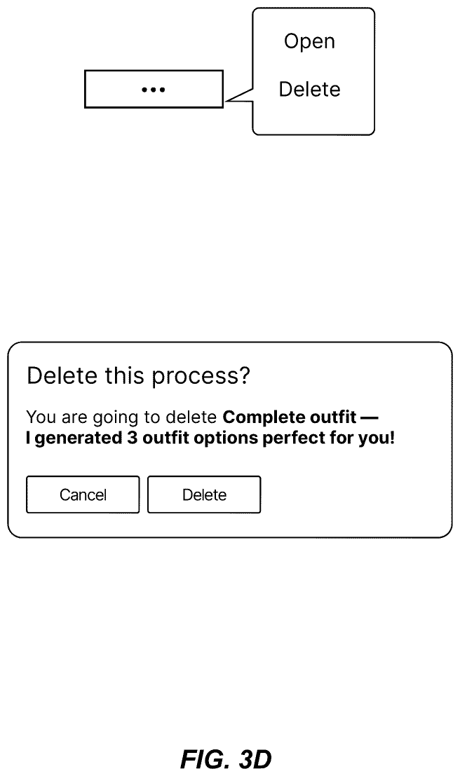

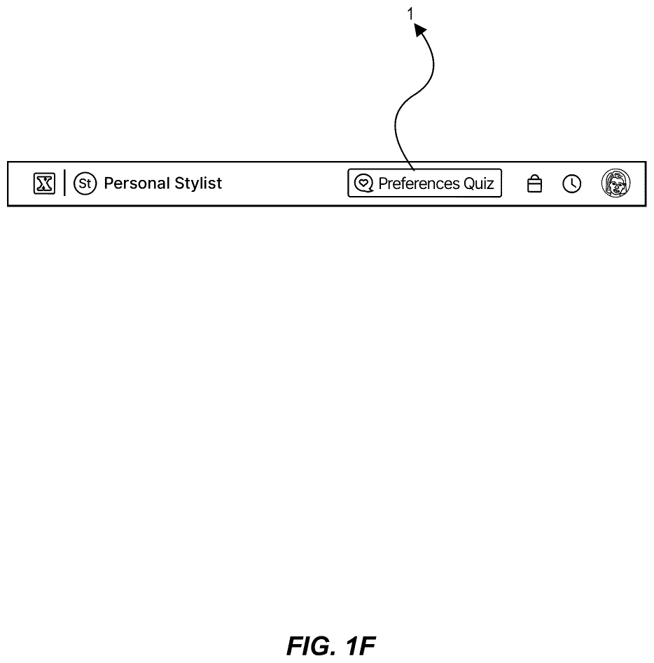

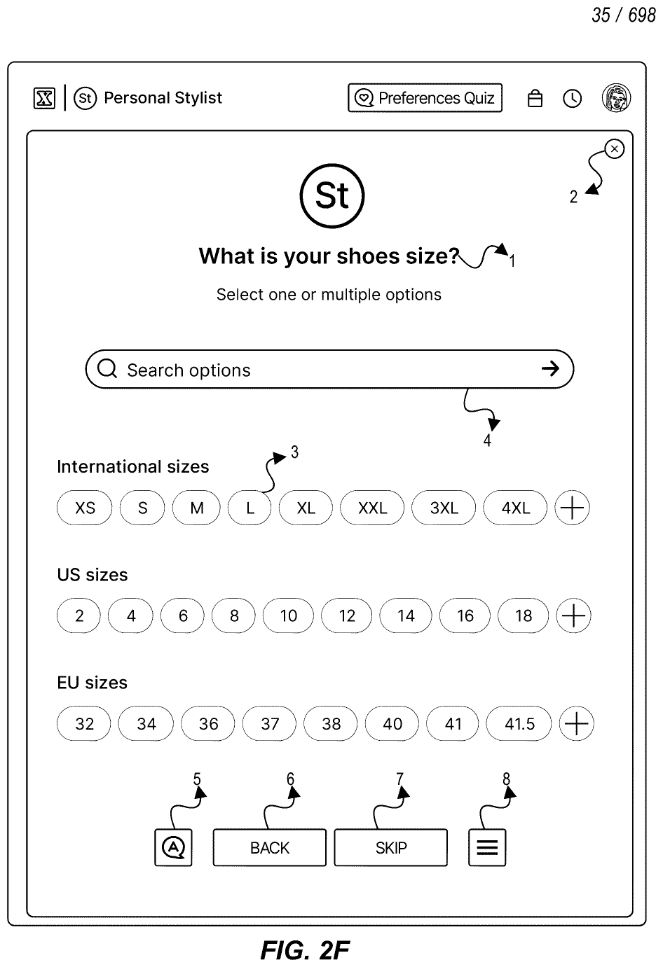

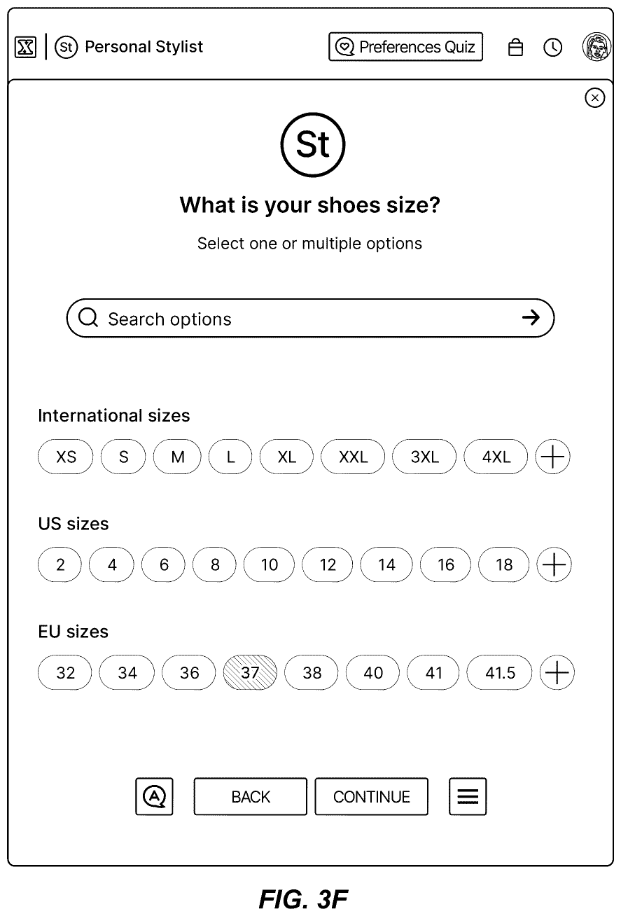

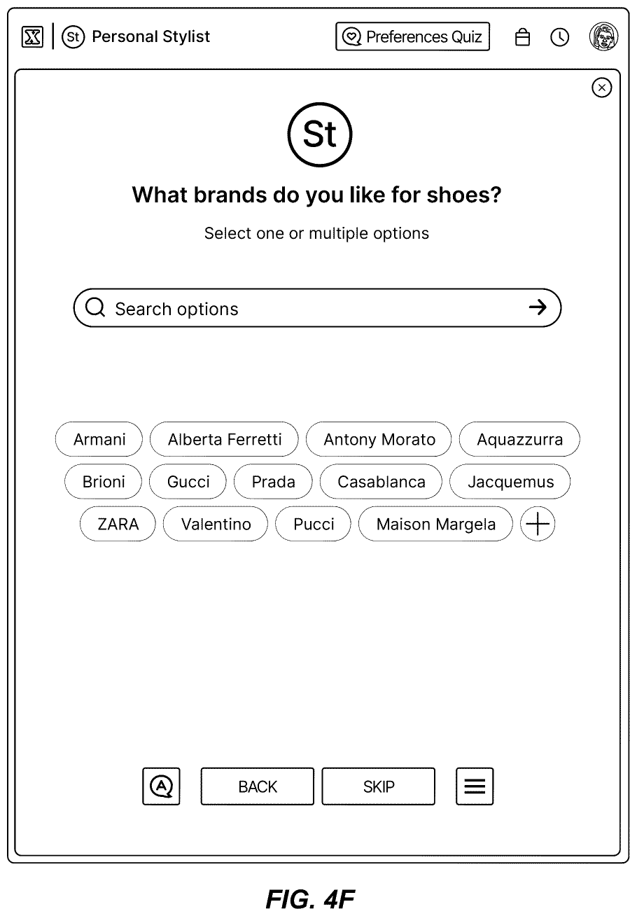

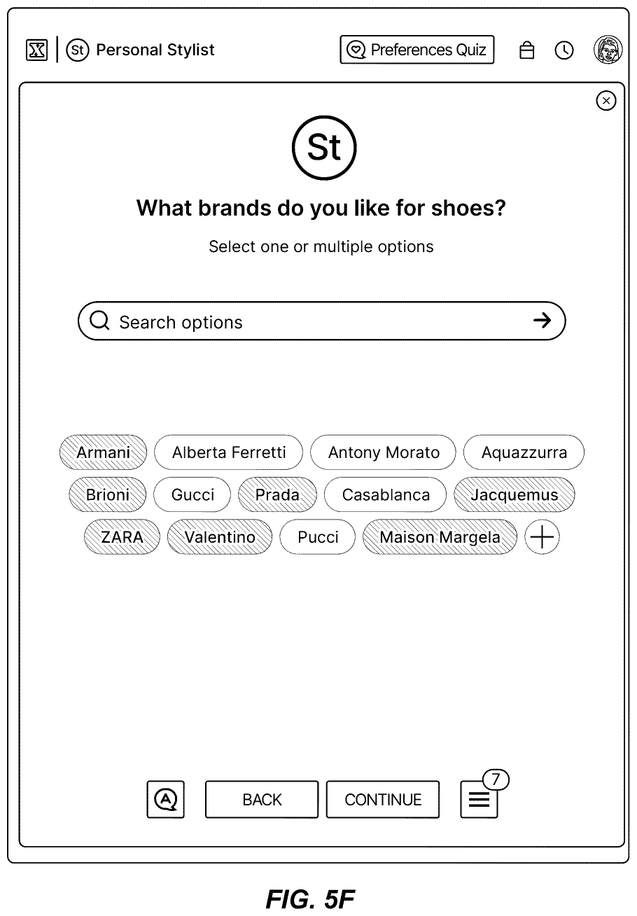

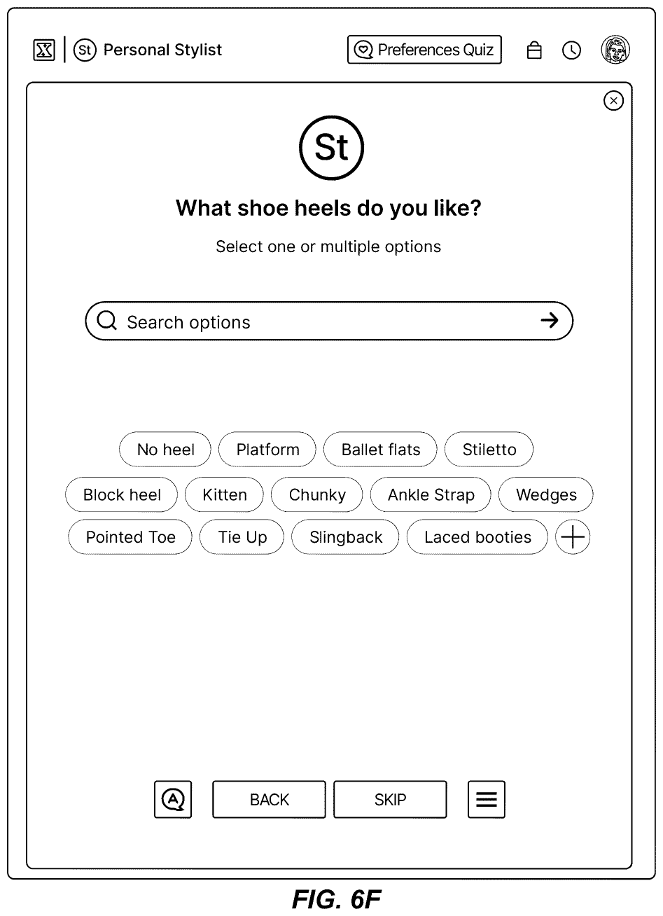

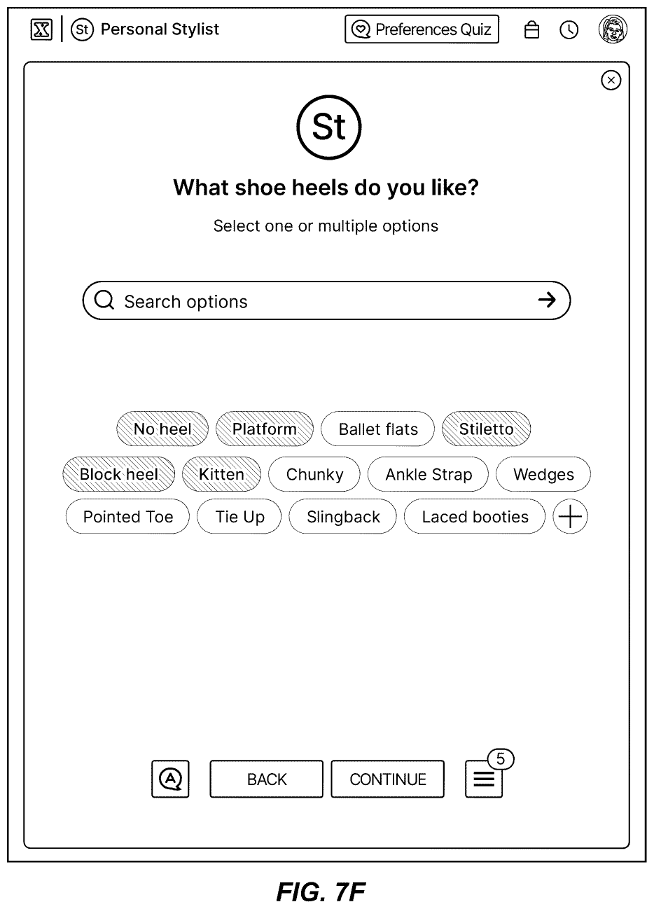

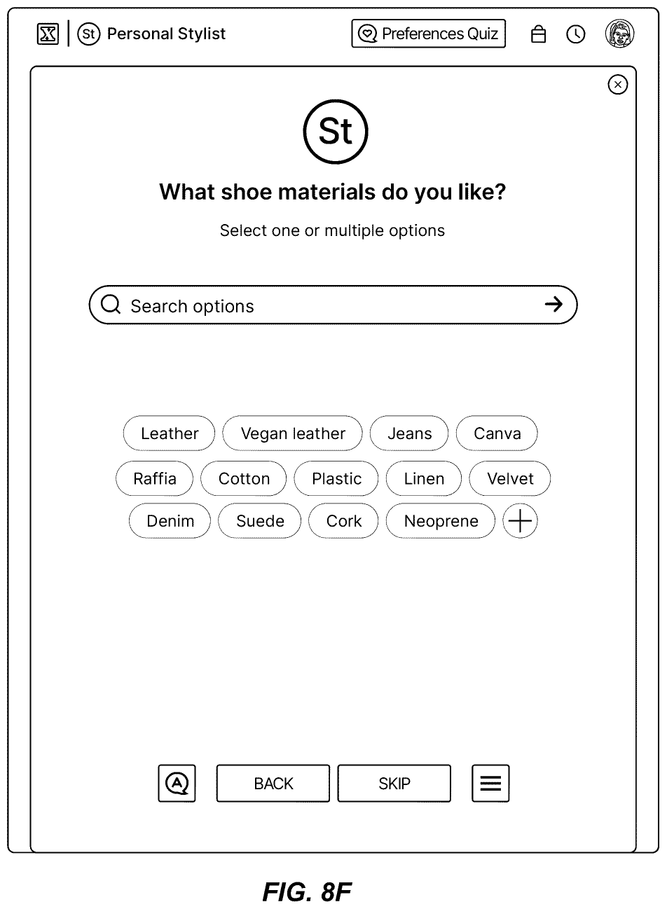

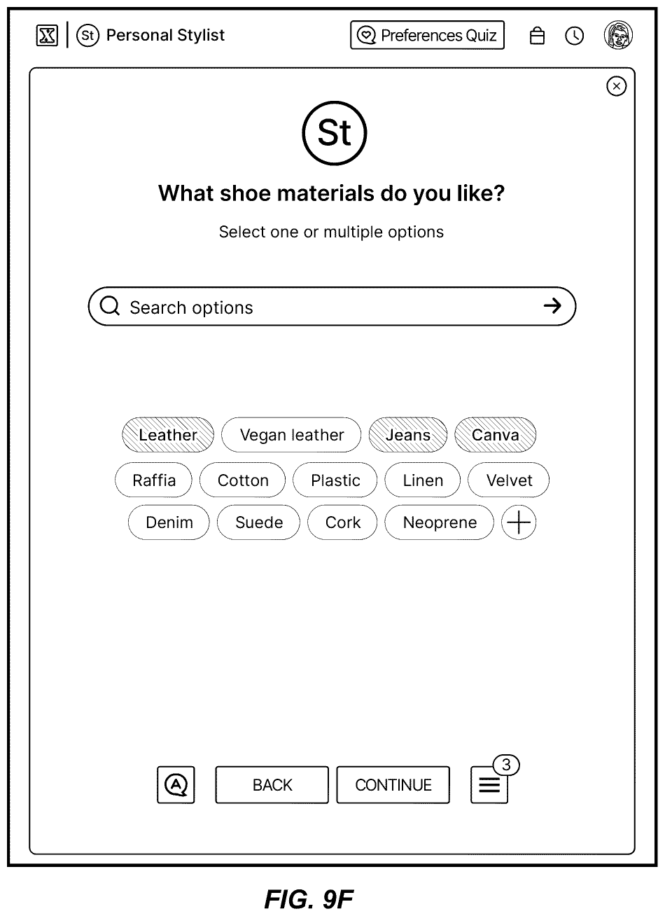

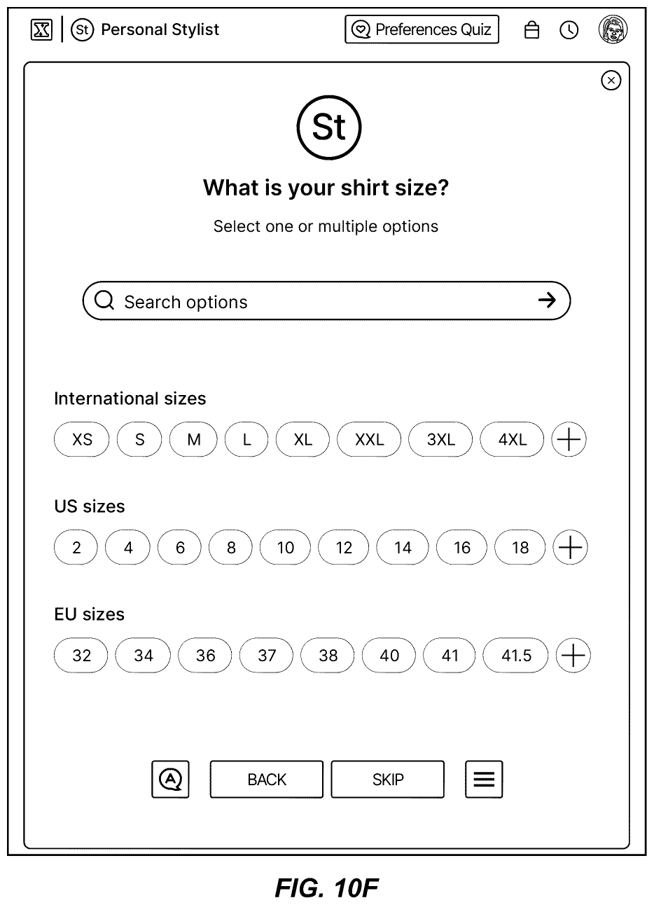

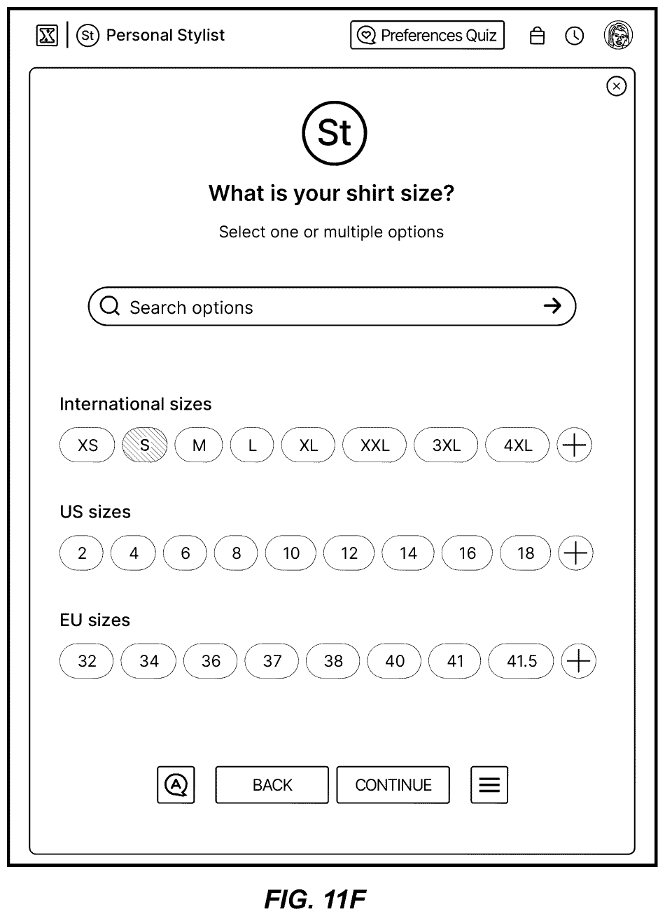

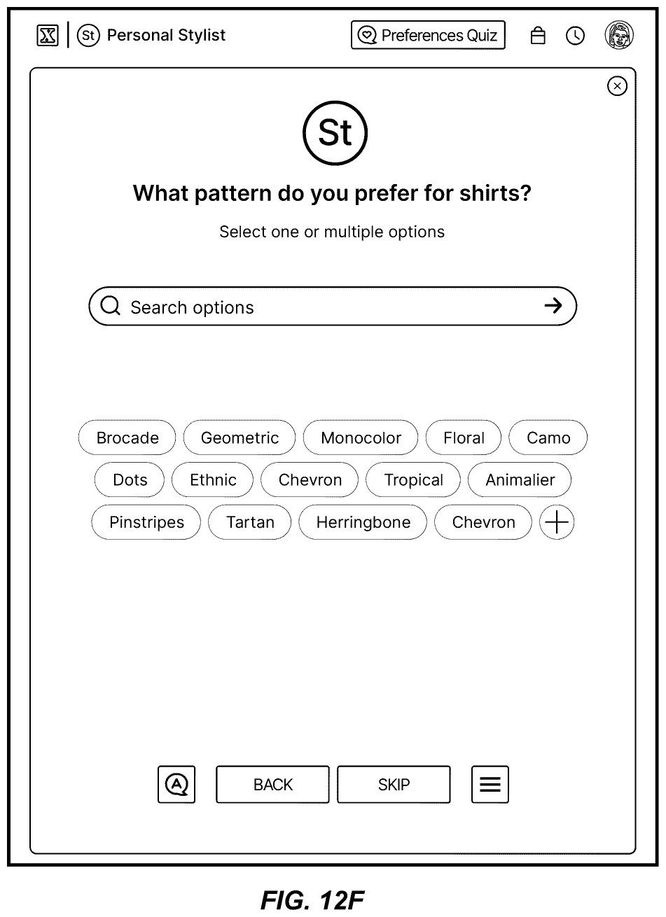

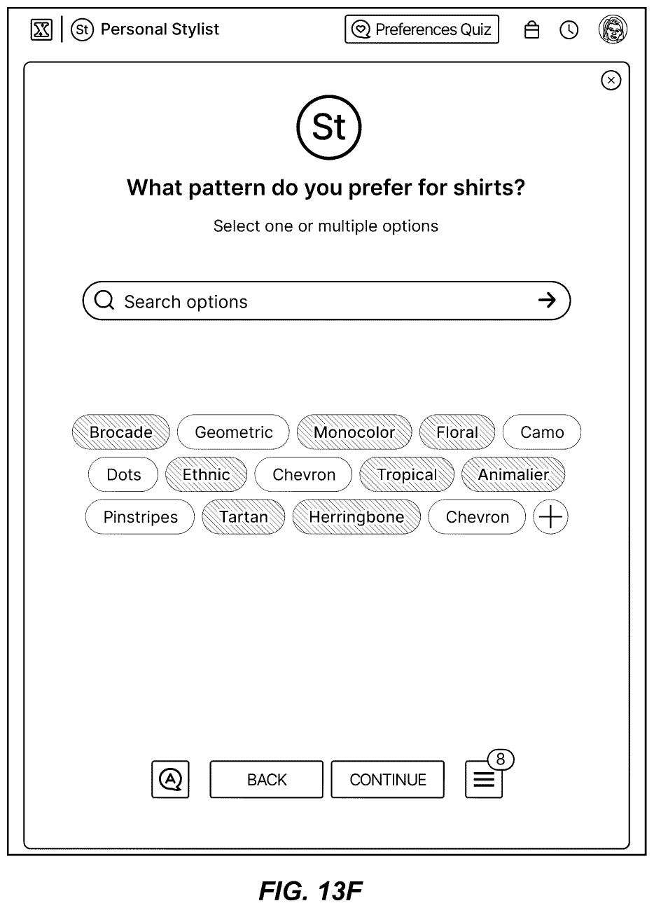

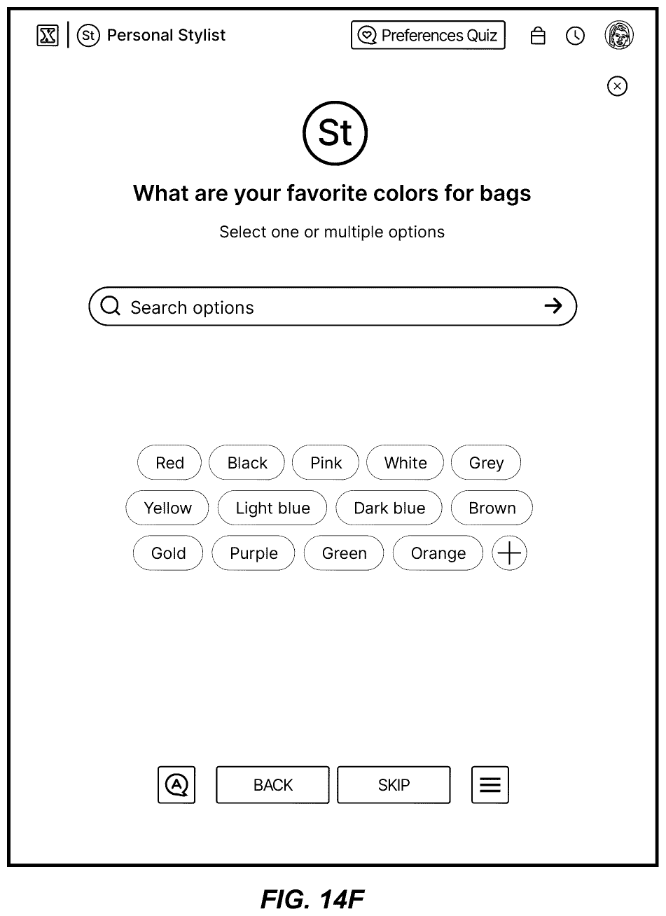

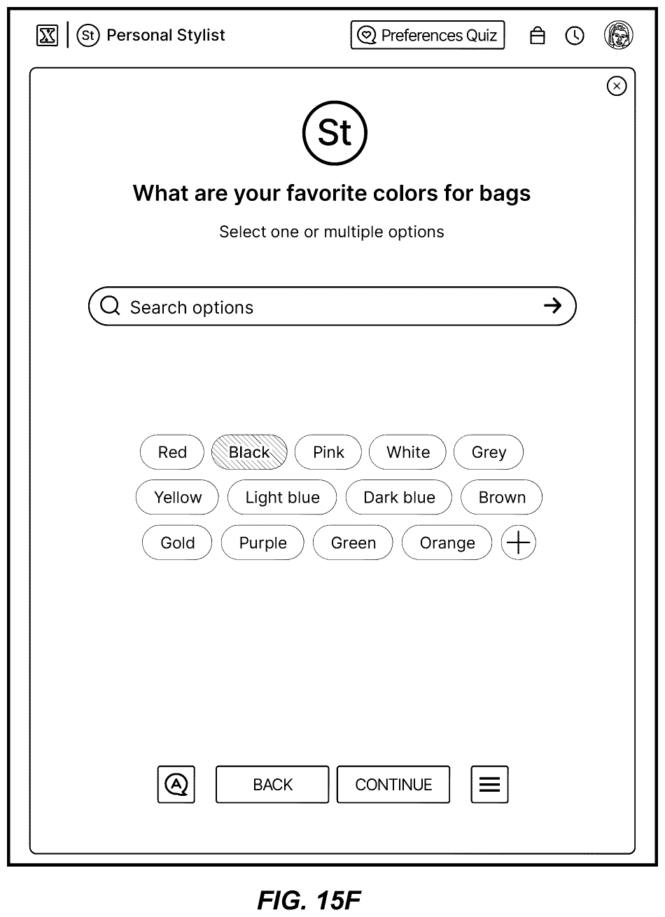

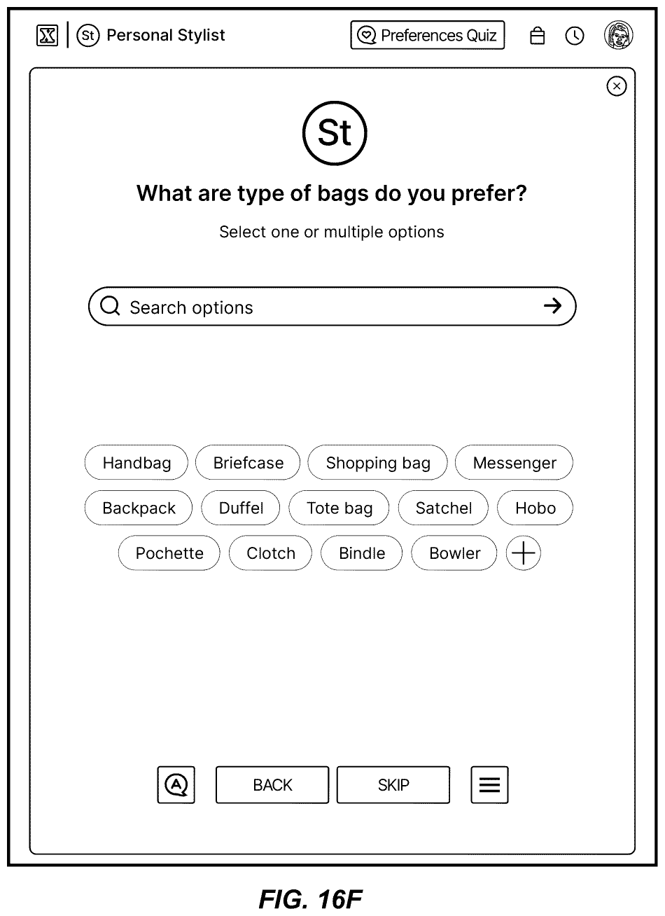

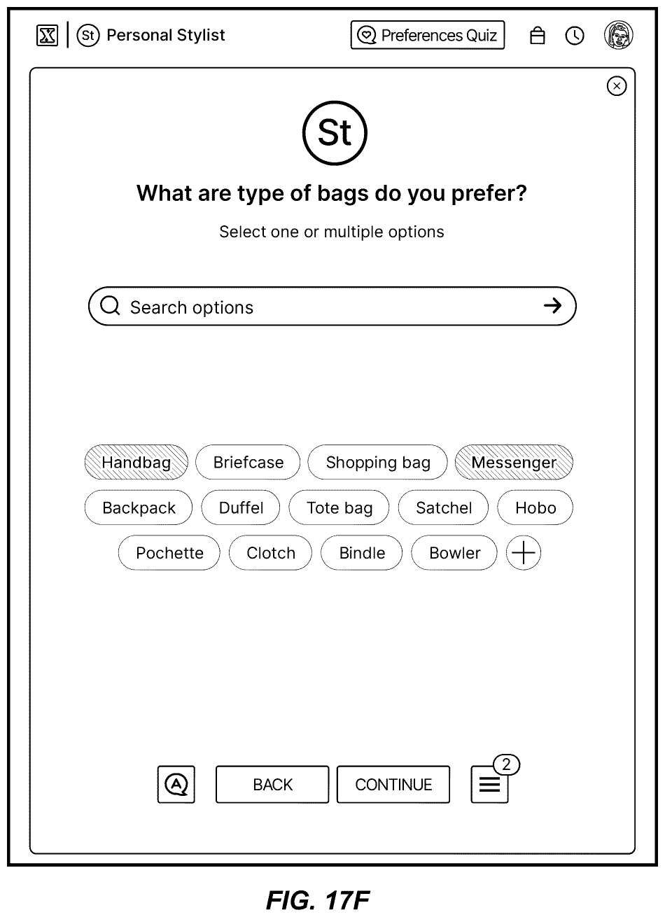

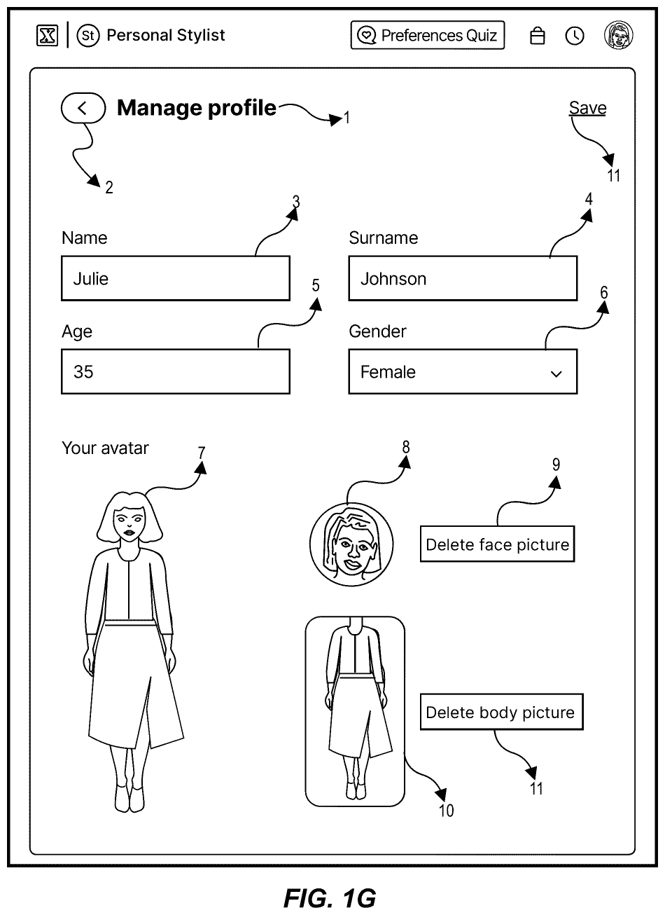

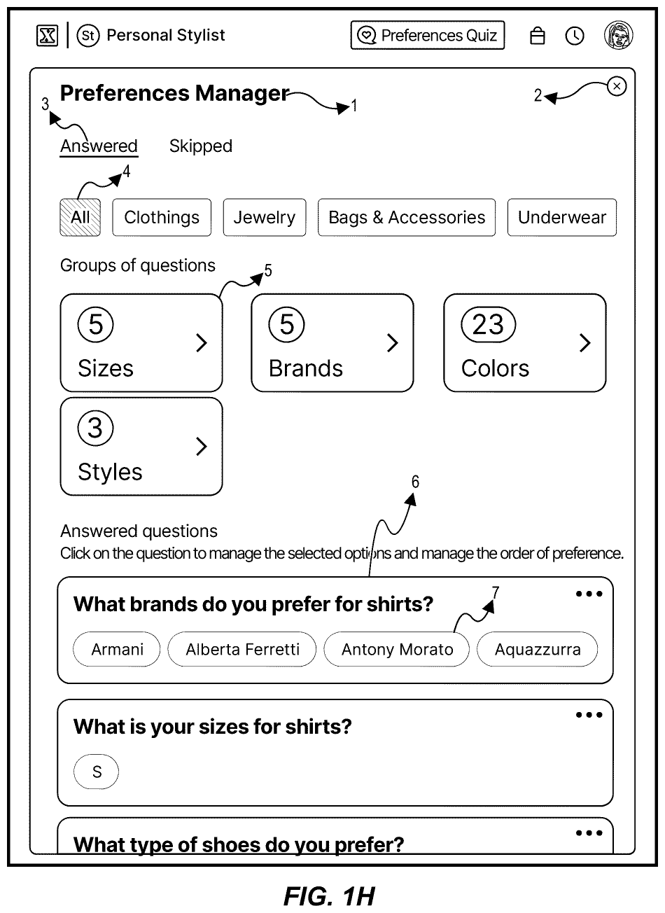

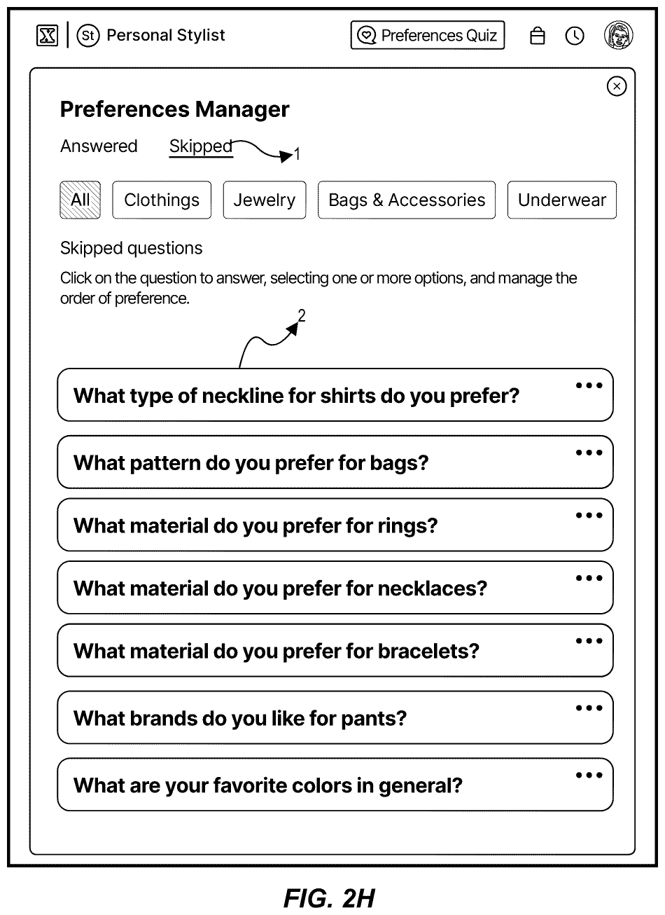

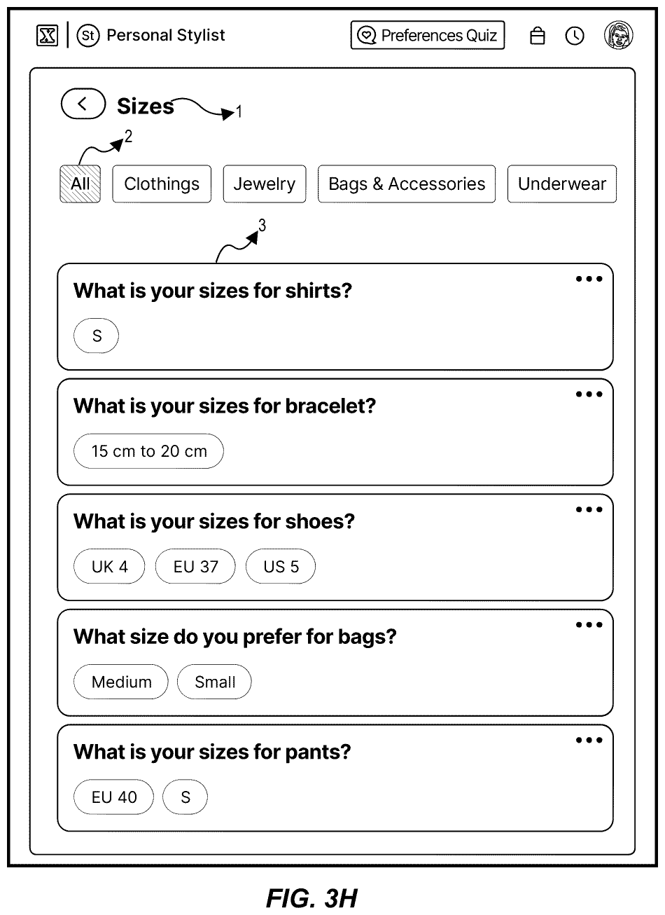

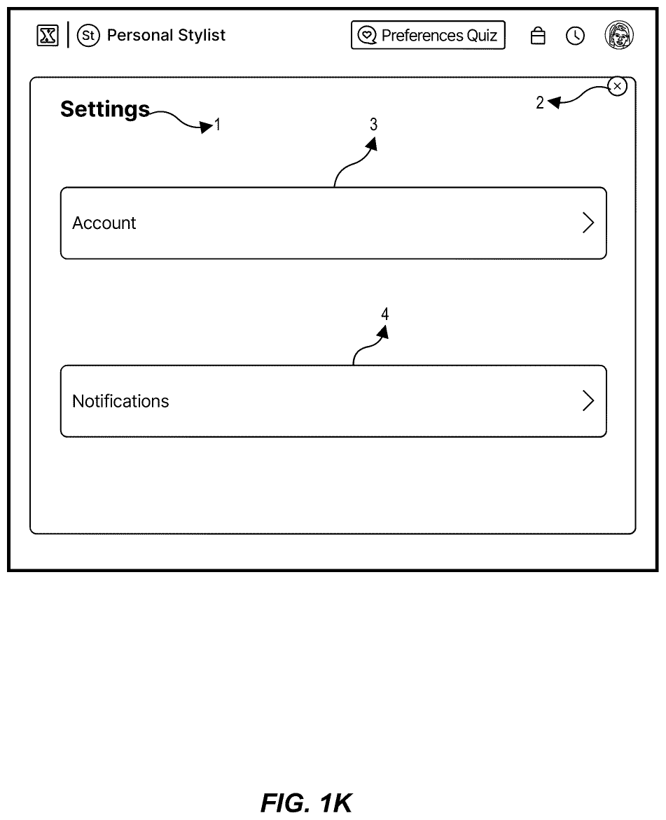

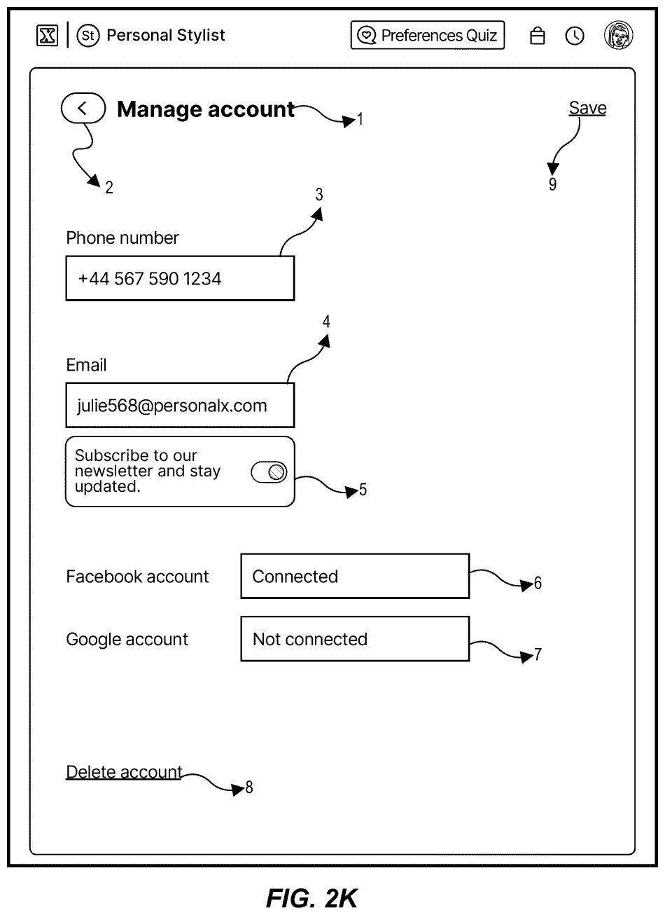

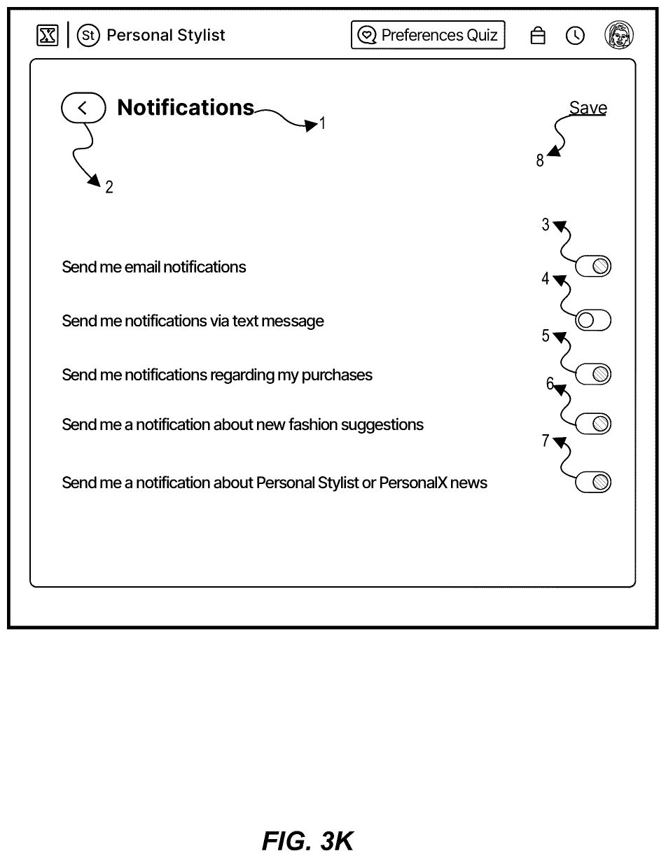

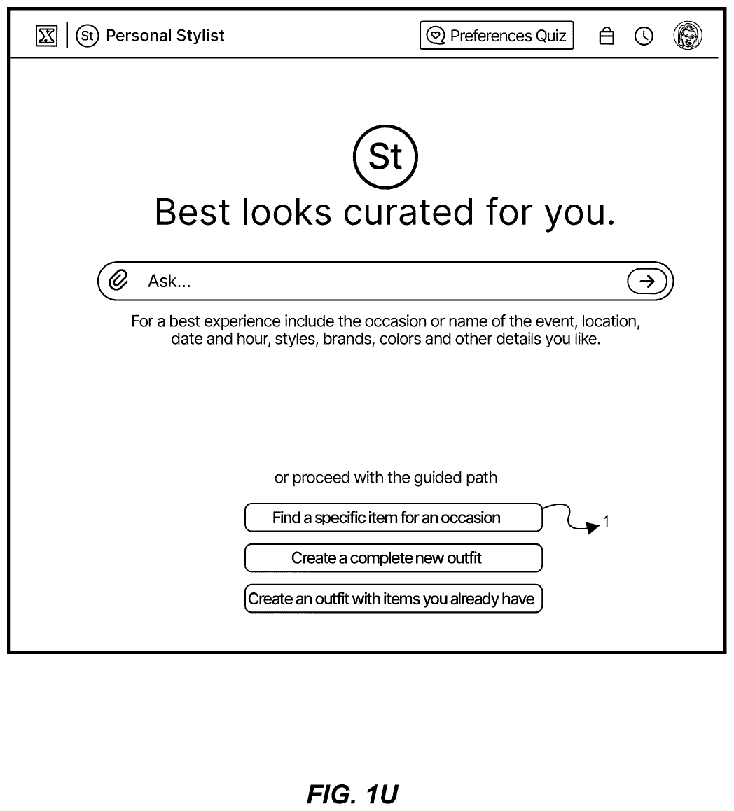

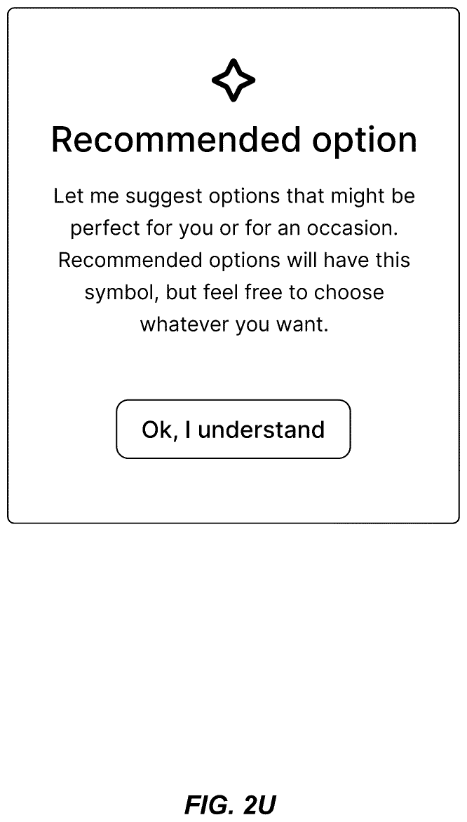

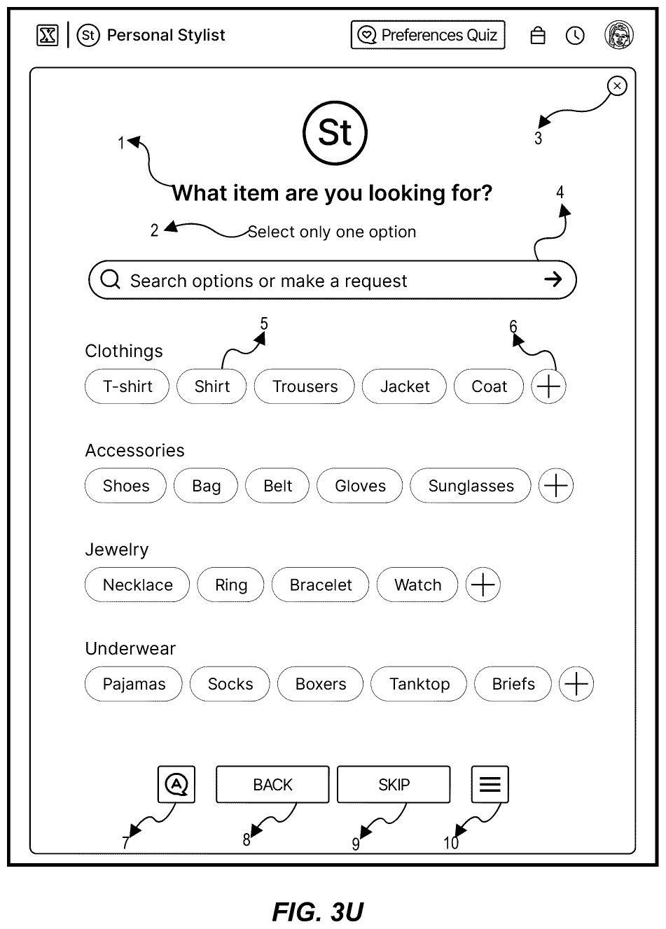

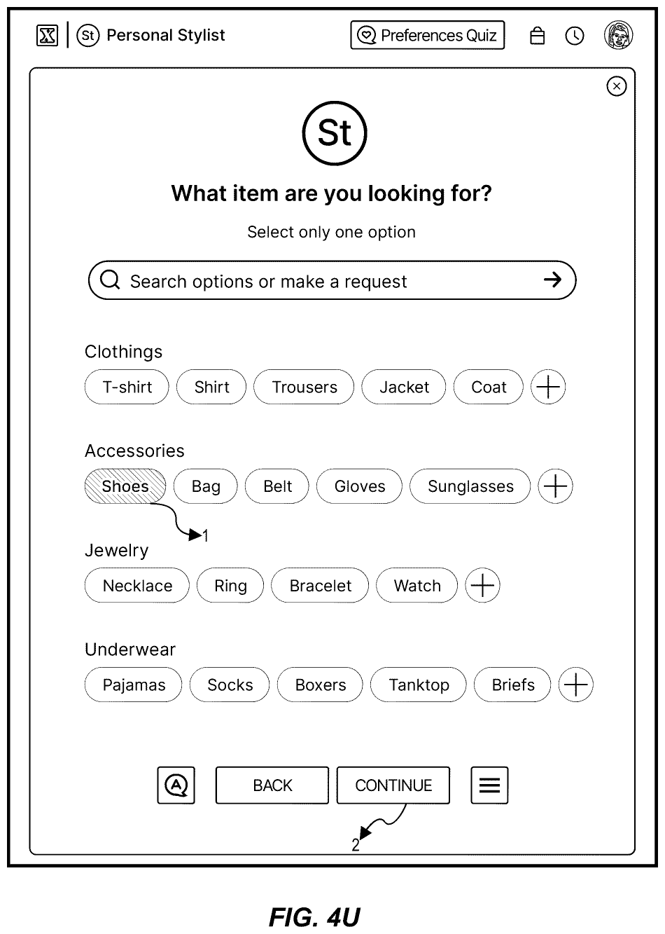

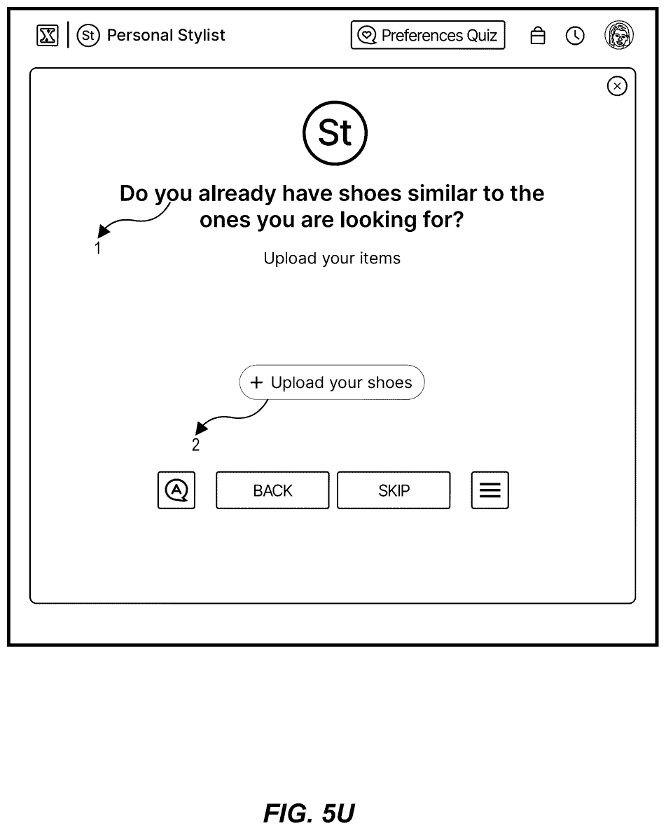

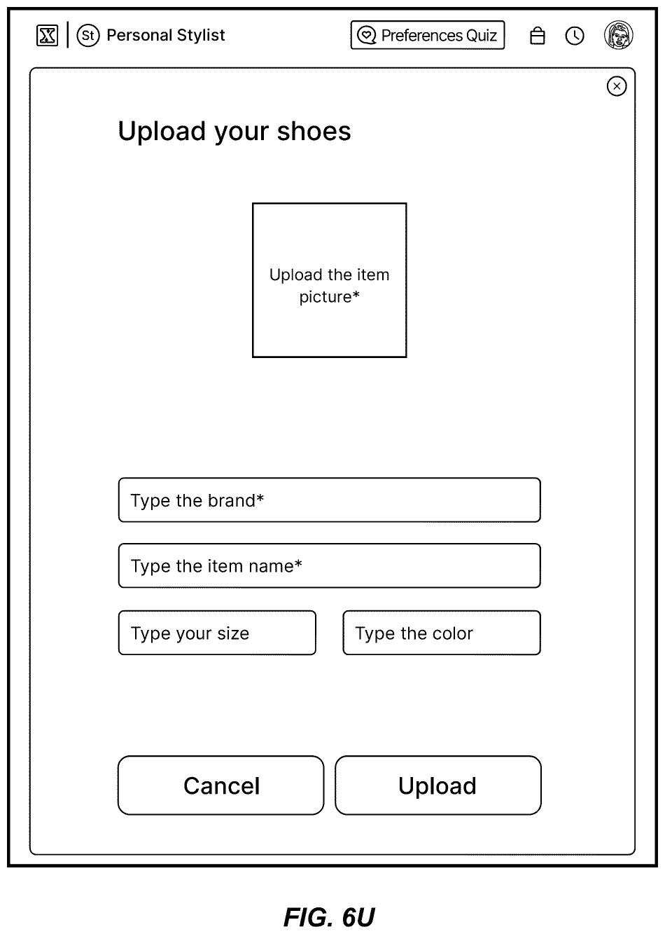

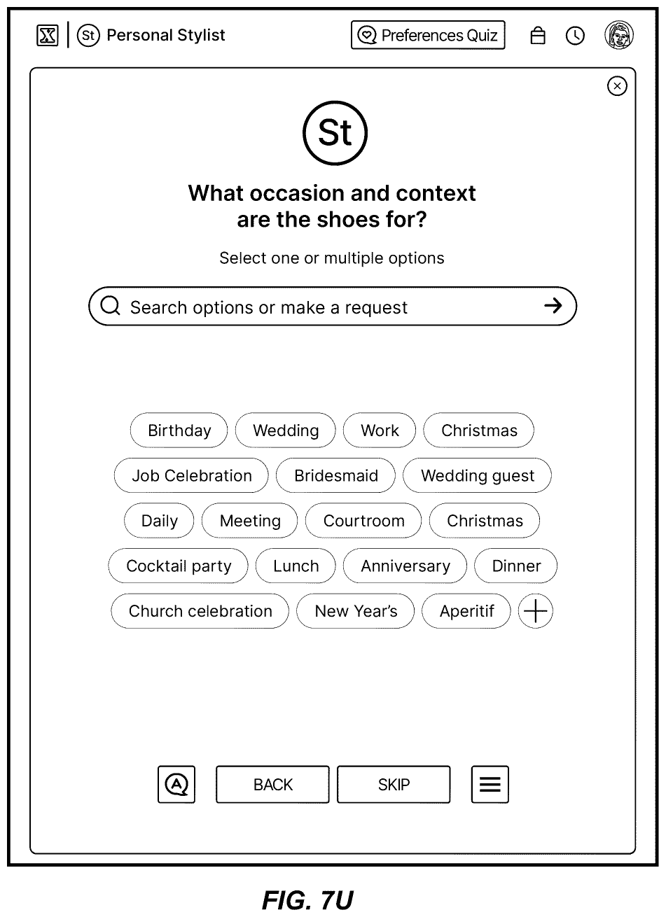

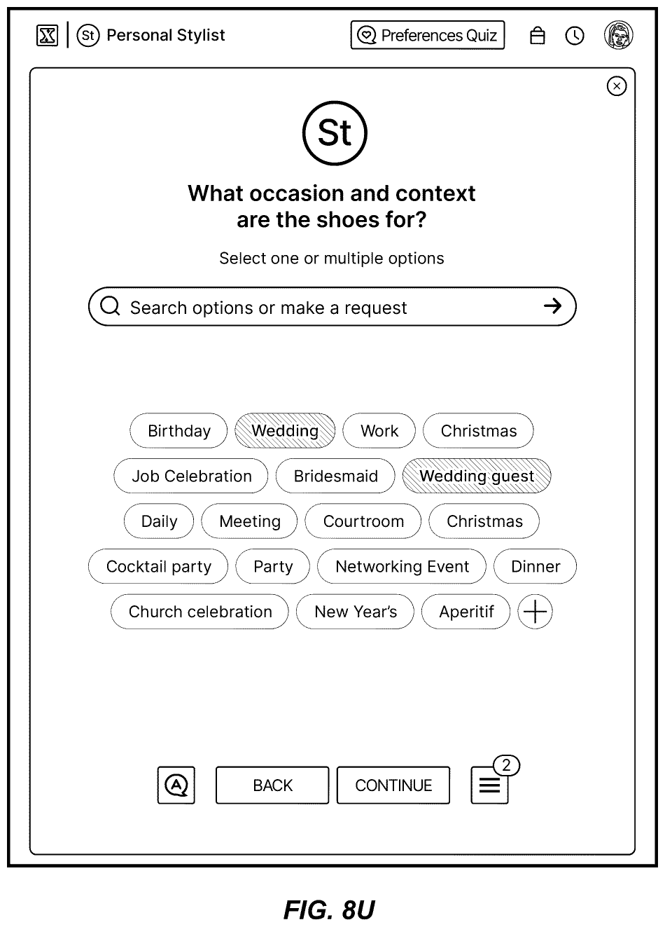

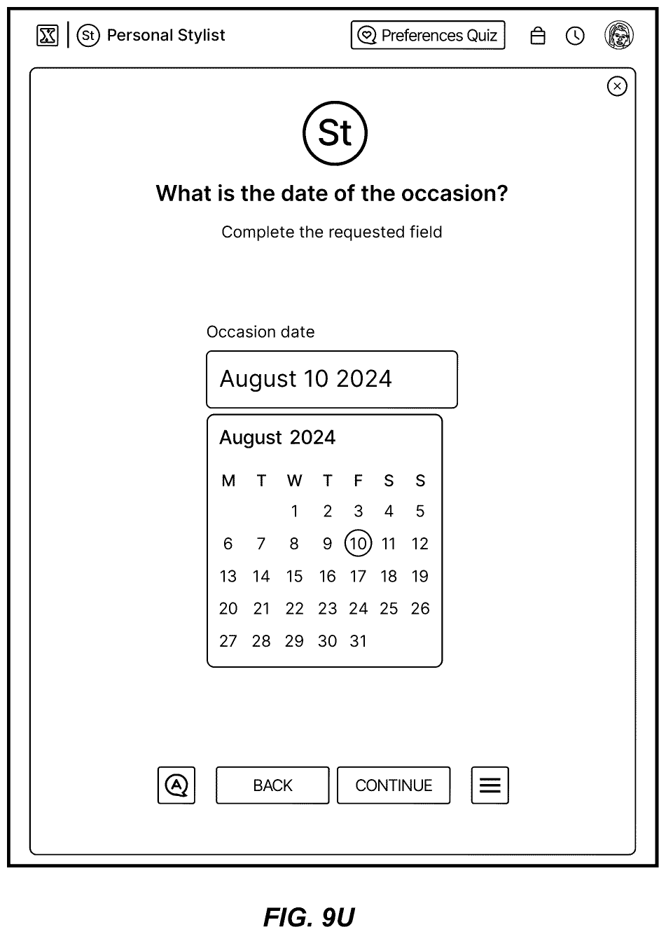

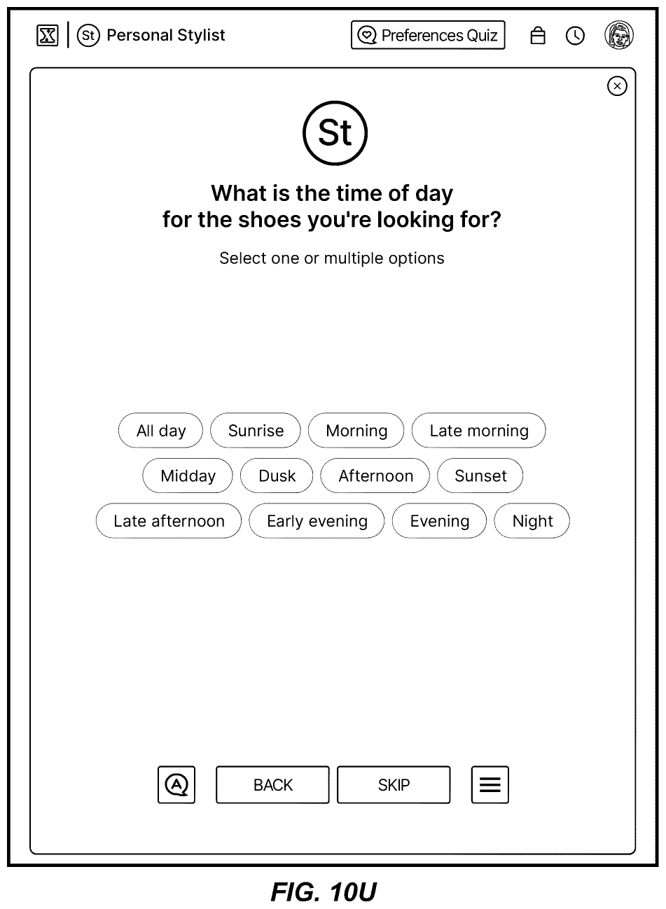

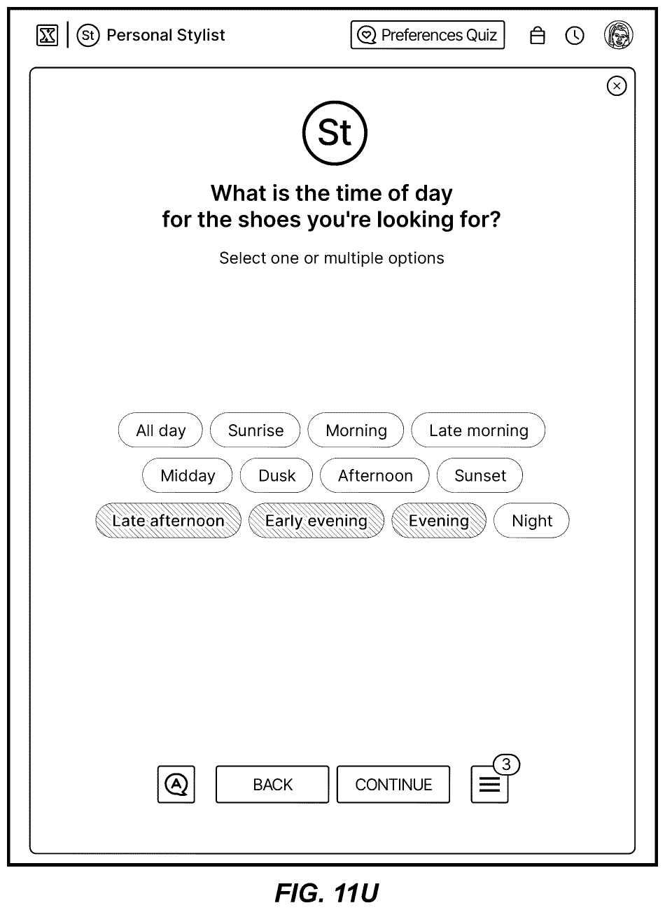

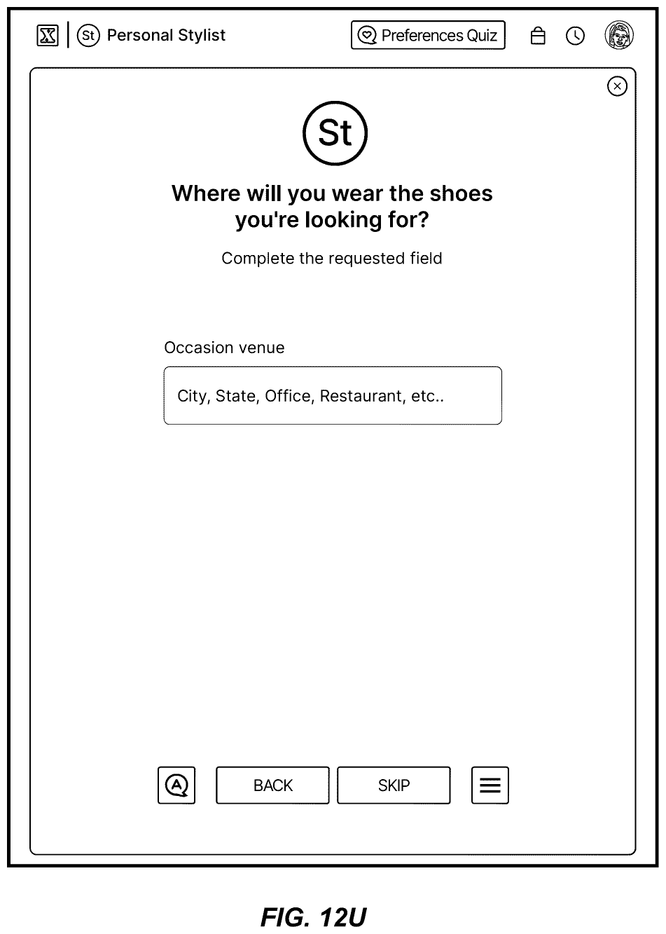

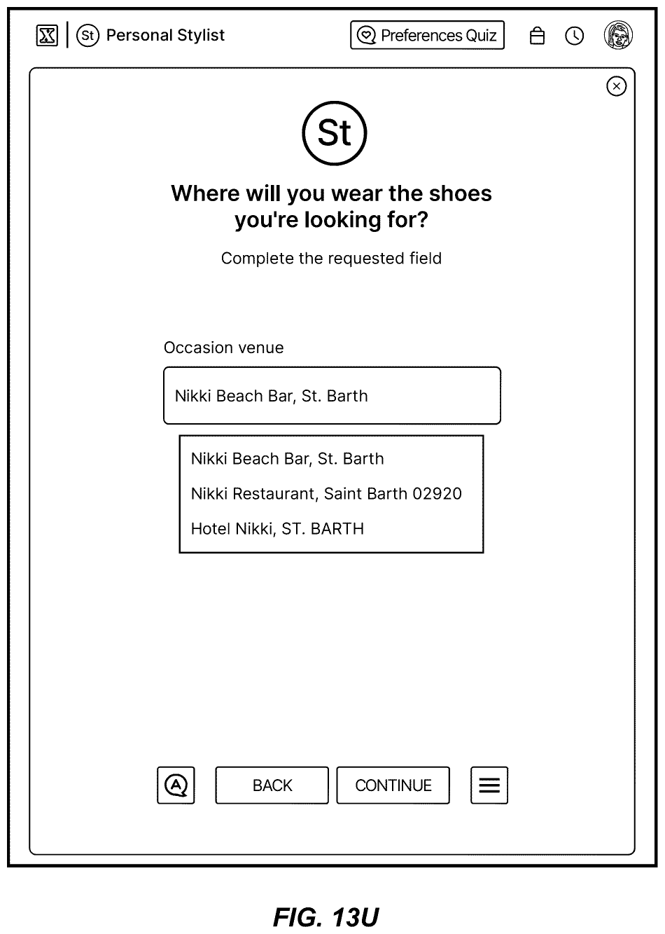

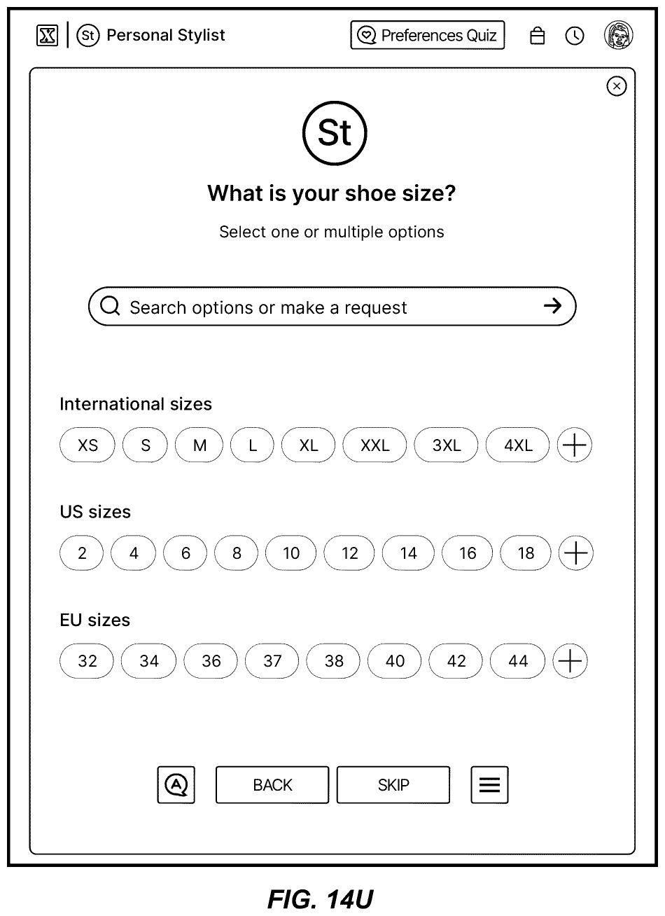

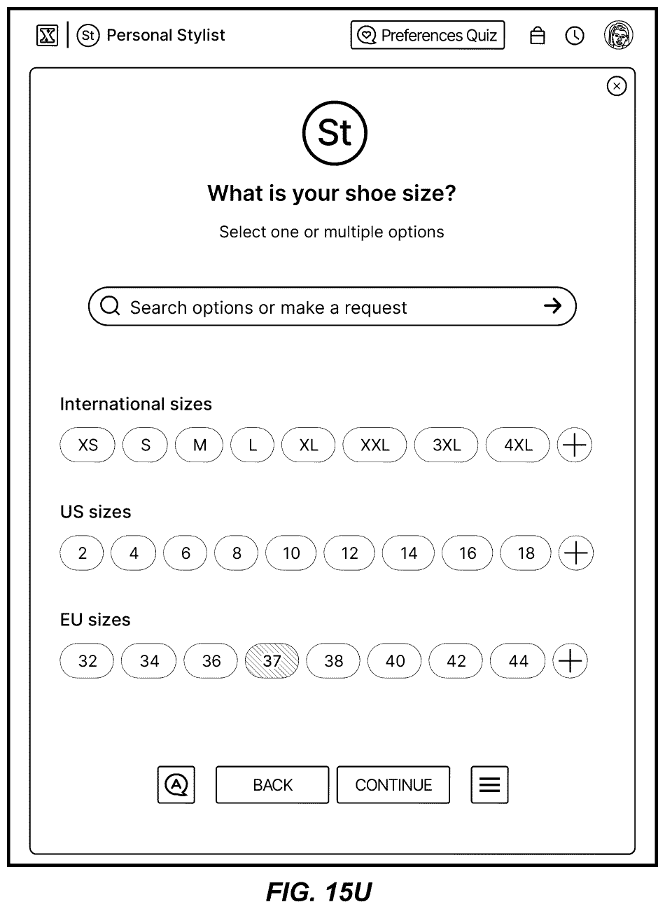

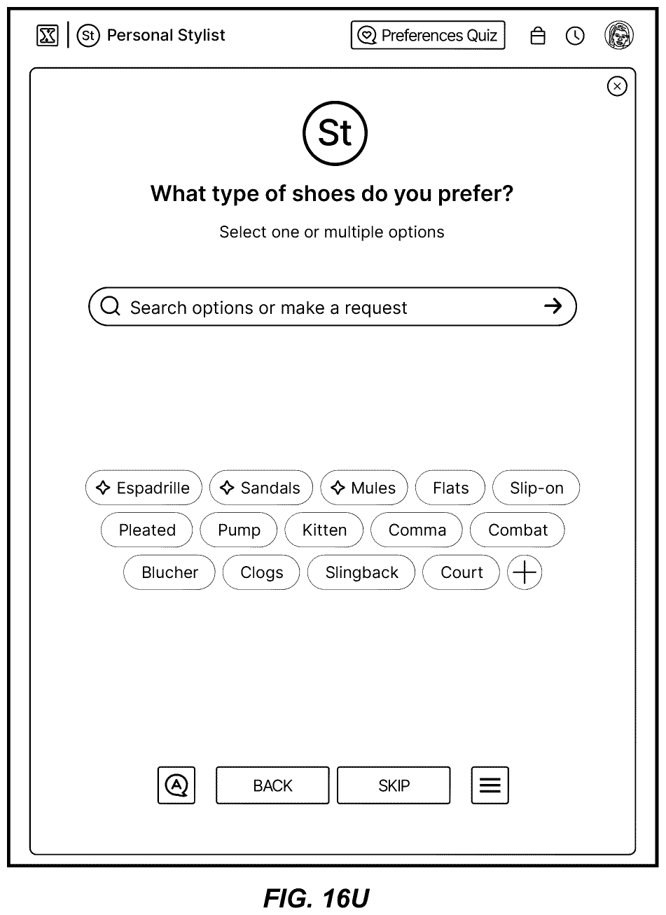

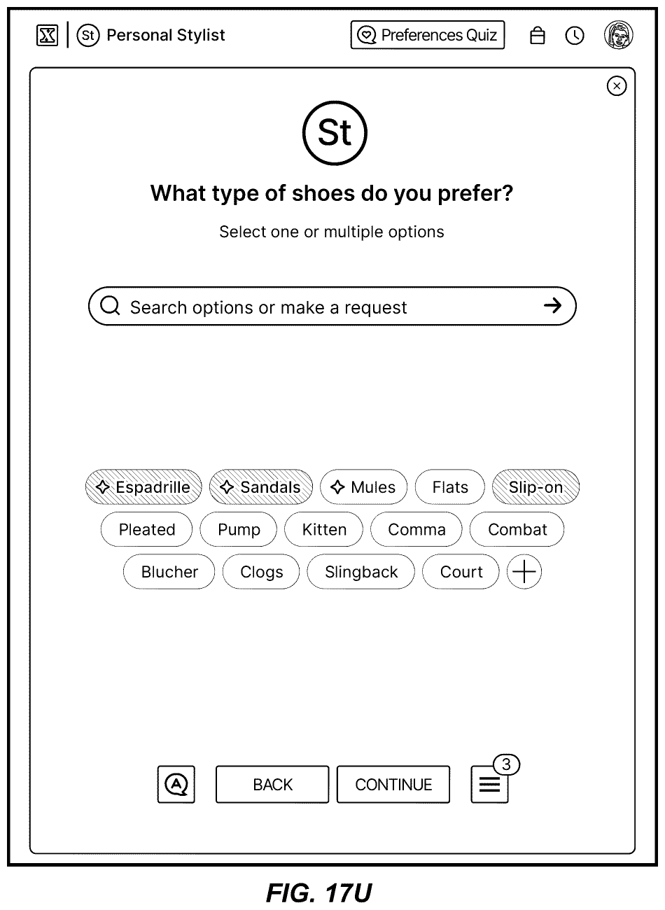

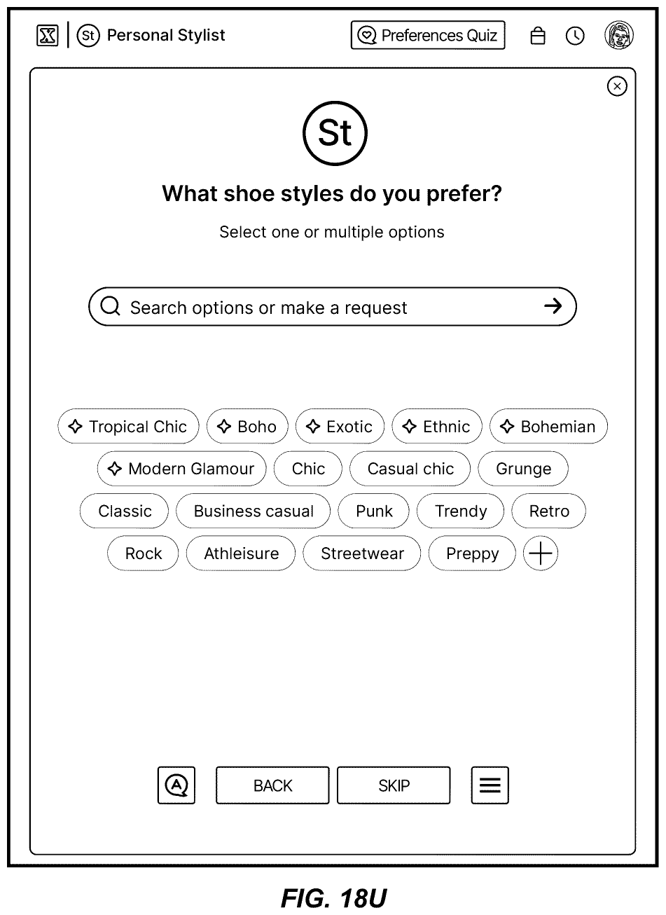

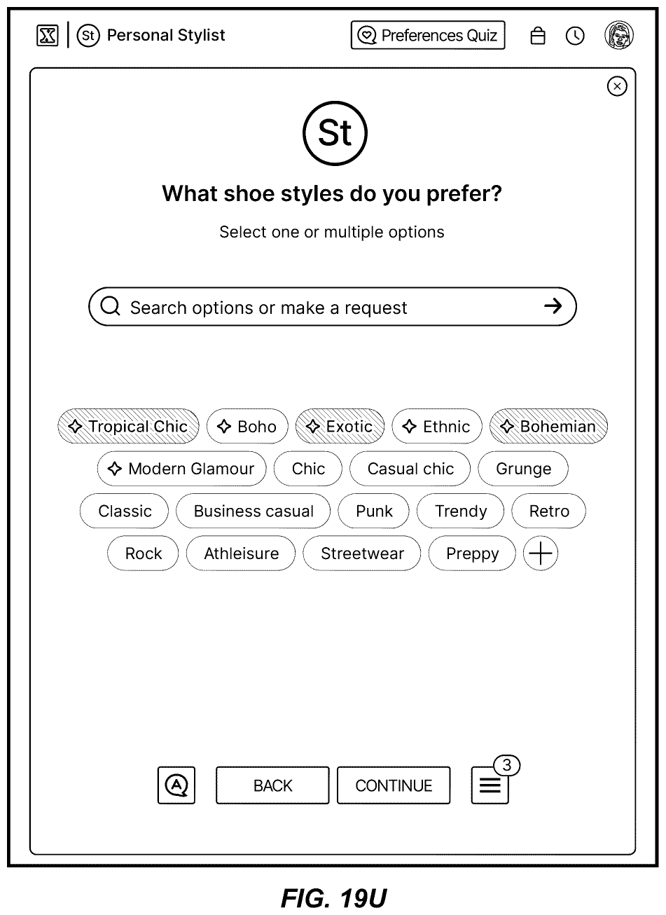

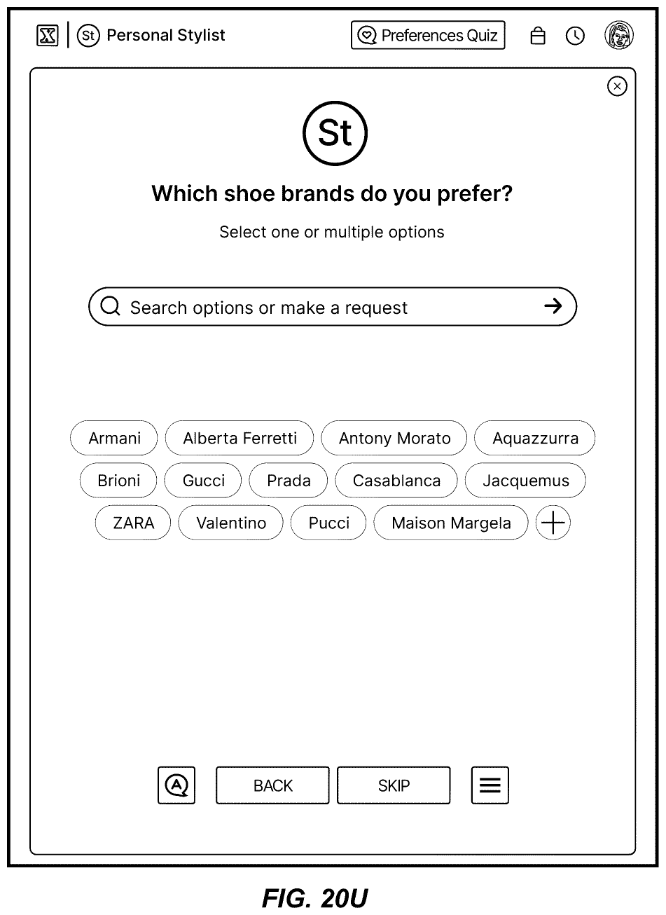

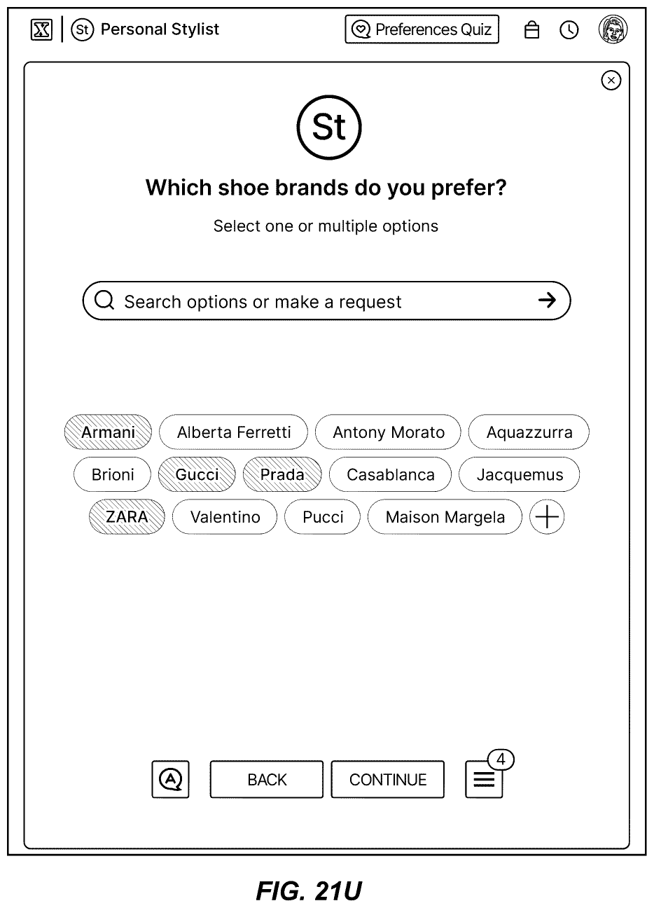

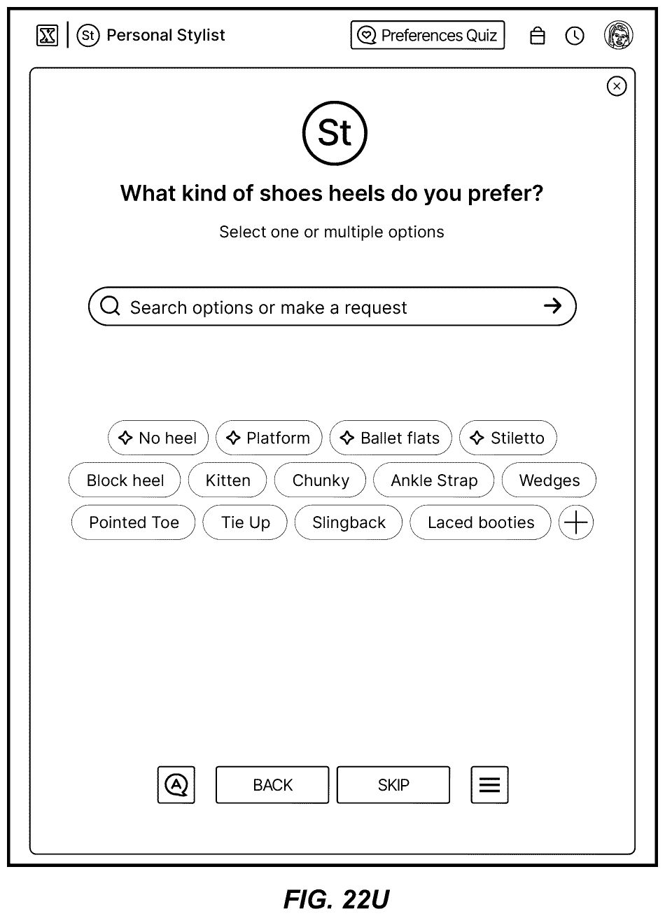

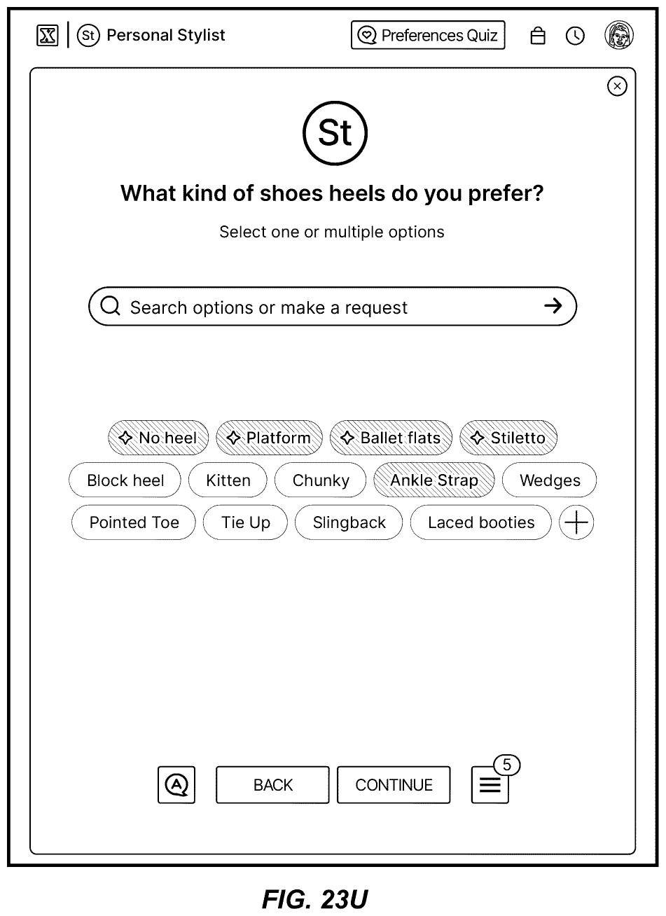

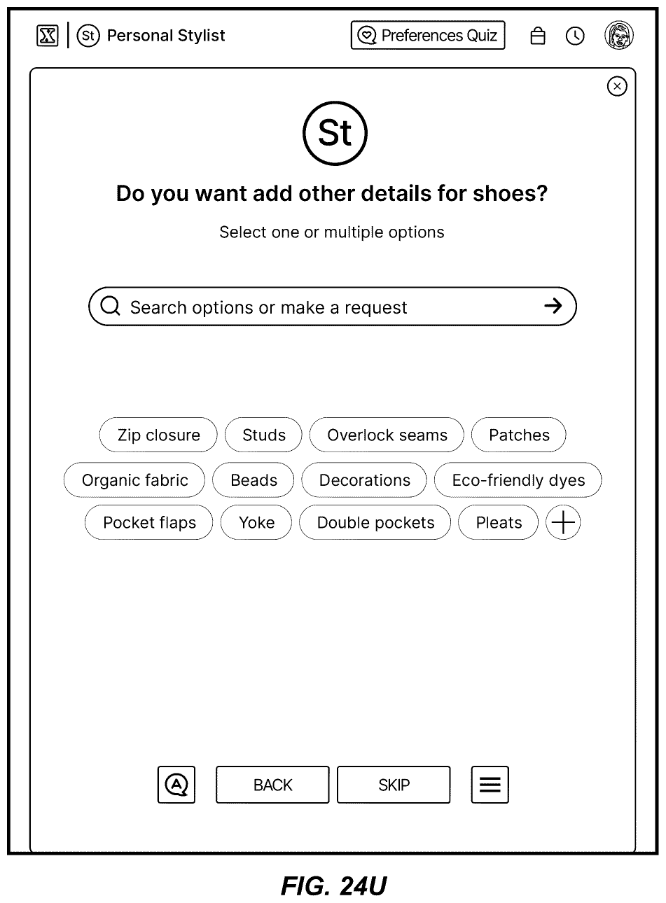

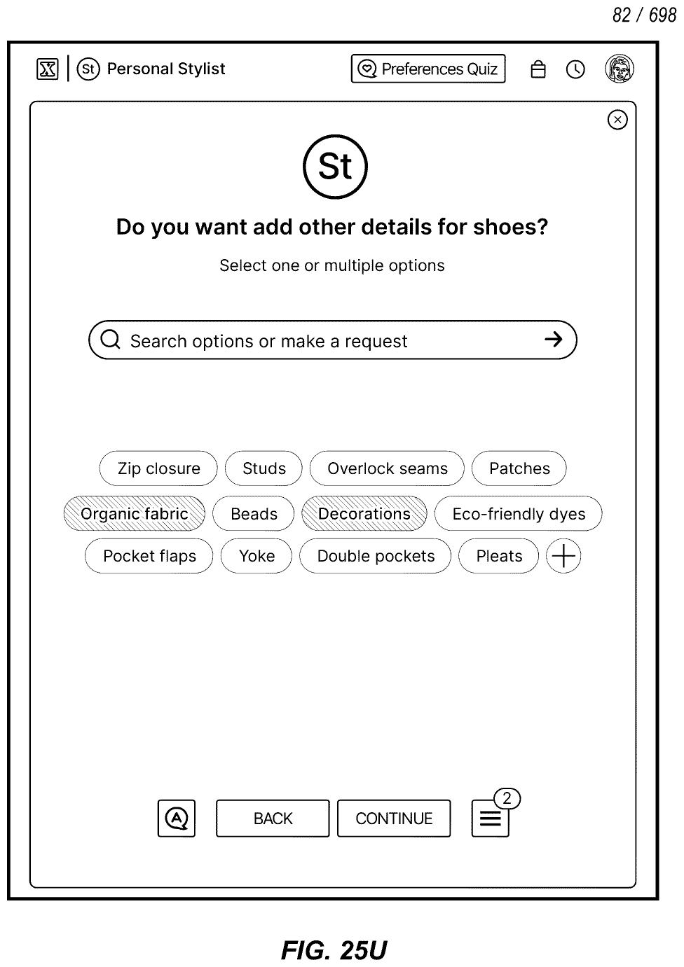

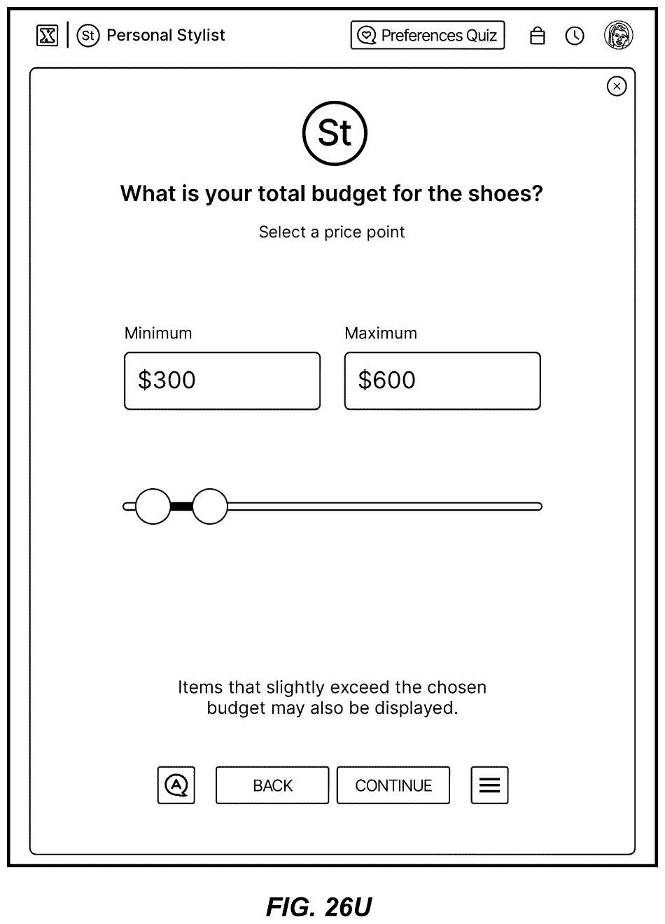

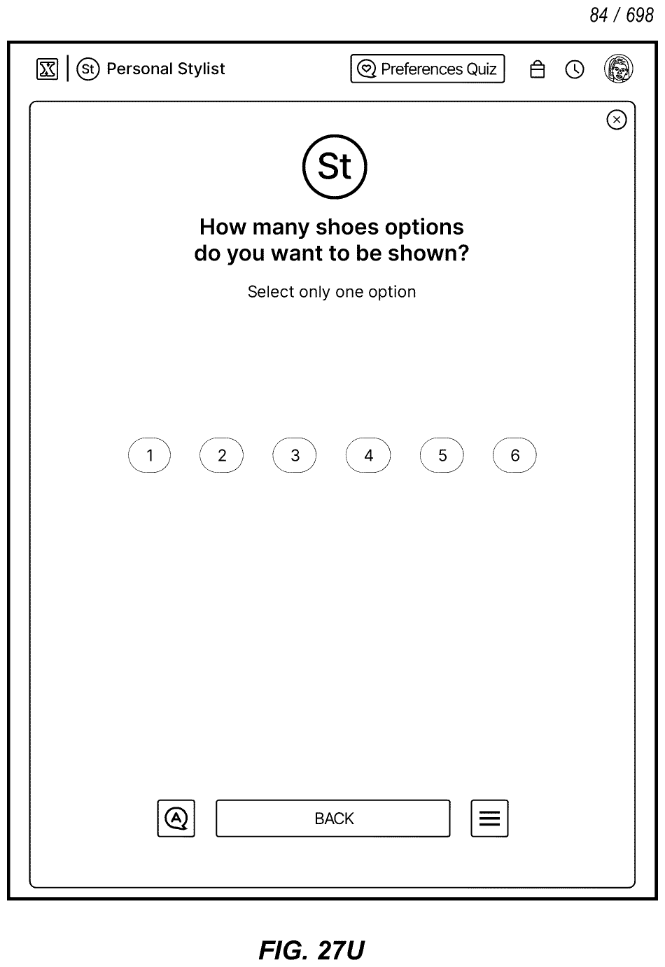

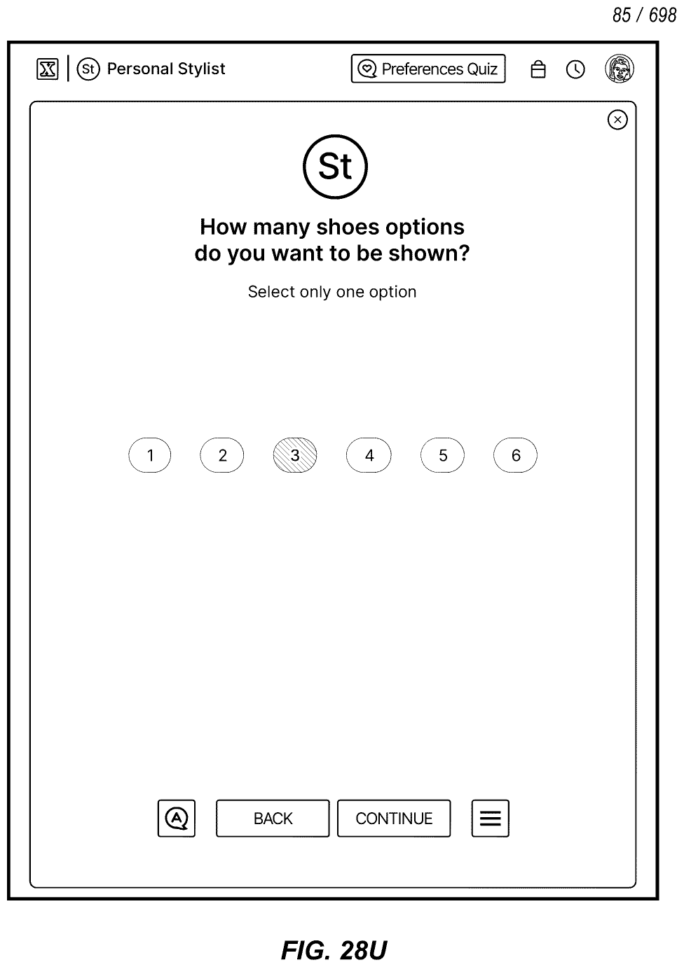

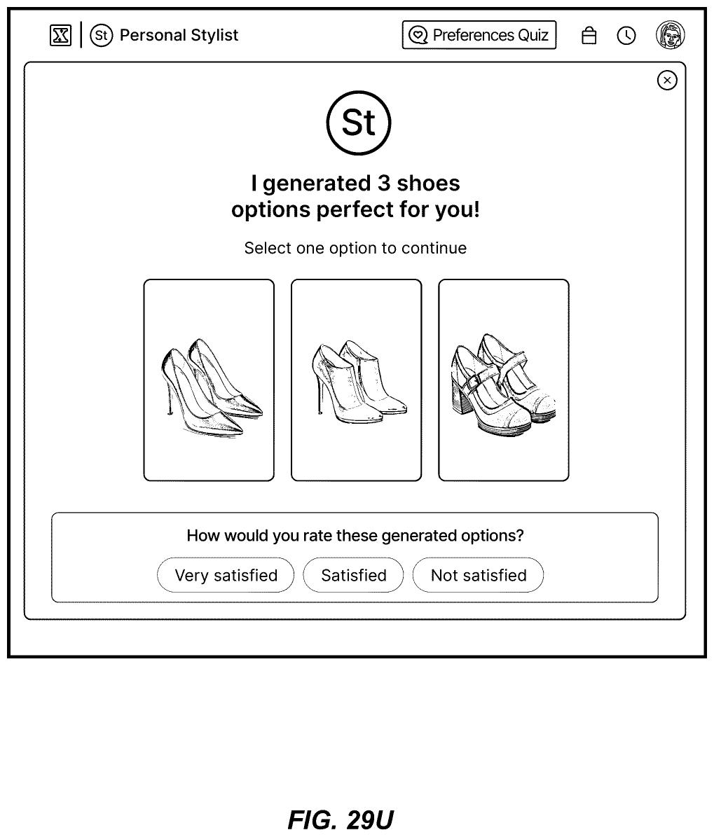

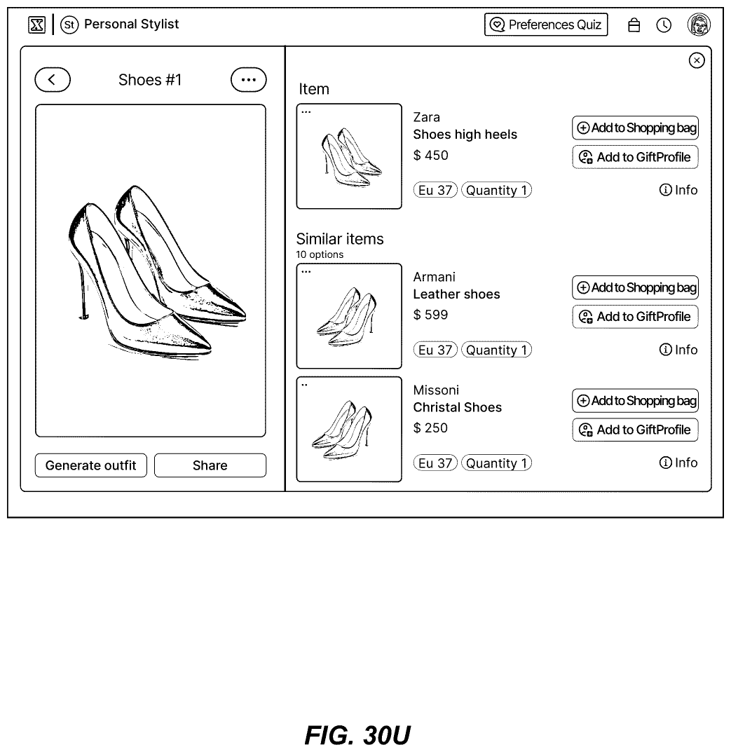

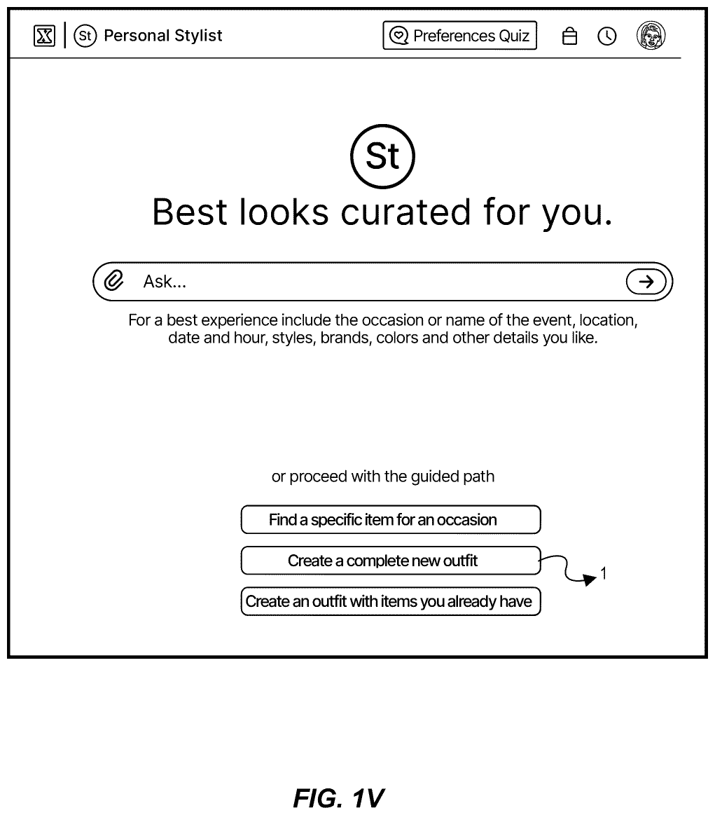

FIG. 1 illustrates components for customizing interactive shopping environments, according to some implementations of the present disclosure.

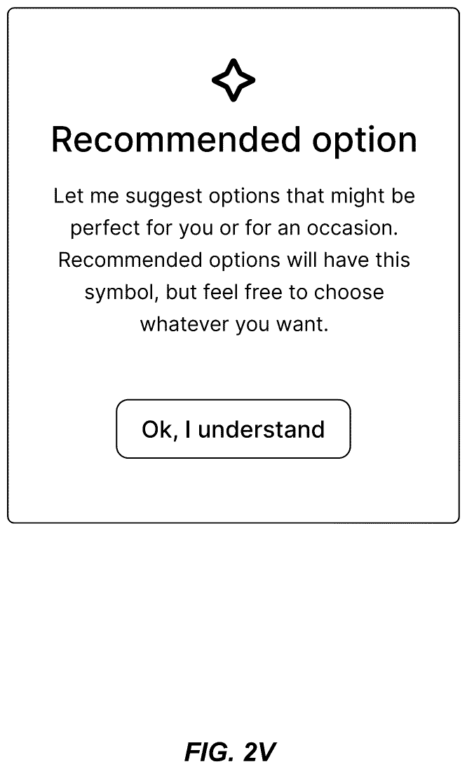

FIG. 2 illustrates an exemplary method for enhancing interactive shopping using dynamic design elements and user feedback, according to some implementations of the present disclosure.

### Personal Stylist

FIGS. 1A-12A illustrate exemplary screen captures of a login or registration process for an exemplary personal stylist interactive shopping environment, which includes entering personal information, a scan of a user's face, and an avatar for the user, according to some implementations of the present disclosure.

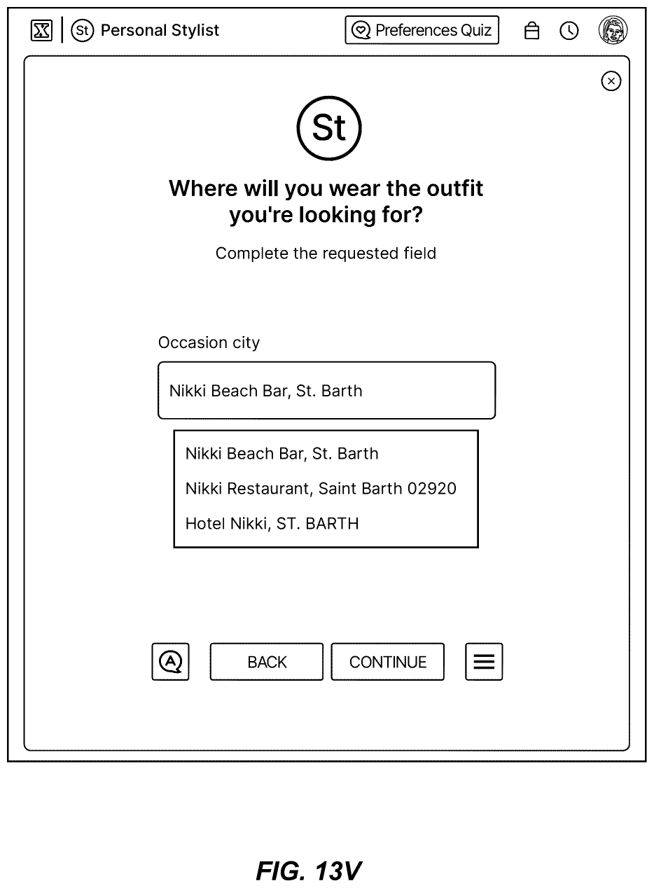

FIGS. 13A-19A illustrate exemplary screen captures of a preference quiz that collects contextual information from a user of exemplary personal stylist interactive shopping environment, according to some implementations of the present disclosure.

### Shopping Bag

FIGS. 1B-6B illustrate exemplary screen captures of various aspects of a shopping bag that shows a list of items for purchase in an exemplary personal stylist interactive shopping environment, according to some implementations of the present disclosure.

### Homepage

FIGS. 1C-3C illustrate exemplary screen captures of a home screen that shows access buttons to a preference quiz and a profile and preferences manager of an exemplary personal stylist interactive shopping environment, according to some implementations of the present disclosure.

### History

FIGS. 1D-3D illustrate exemplary screen captures of a history page of an exemplary personal stylist interactive shopping environment, according to some implementations of the present disclosure.

### Preferences Quiz

FIGS. 1F-17F illustrate exemplary screen captures of steps in a preferences quiz directed to shoes, shirts, and bags as part of an exemplary personal stylist interactive shopping environment, according to some implementations of the present disclosure.

### Manage Profile

FIG. 1G illustrates an exemplary screen capture of a manage profile page of an exemplary personal stylist interactive shopping environment, according to some implementations of the present disclosure.

### Preferences Manager

FIGS. 1H-3H illustrate exemplary screen captures of a preferences manager page of an exemplary personal stylist interactive shopping environment, according to some implementations of the present disclosure.

### Settings

FIGS. 1K-3K illustrate exemplary screen captures of a settings page including a manage account page and a notifications settings page of an exemplary personal stylist interactive shopping environment, according to some implementations of the present disclosure.

### Single Item

FIGS. 1U-30U illustrate exemplary screen captures of a single item page directed to an exemplary purchase of shoes using an exemplary personal stylist interactive shopping environment, according to some implementations of the present disclosure.

### Complete Outfit

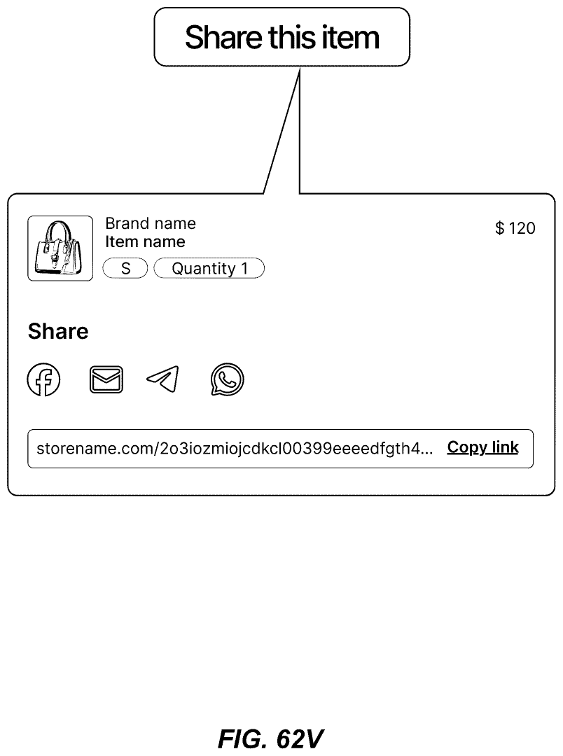

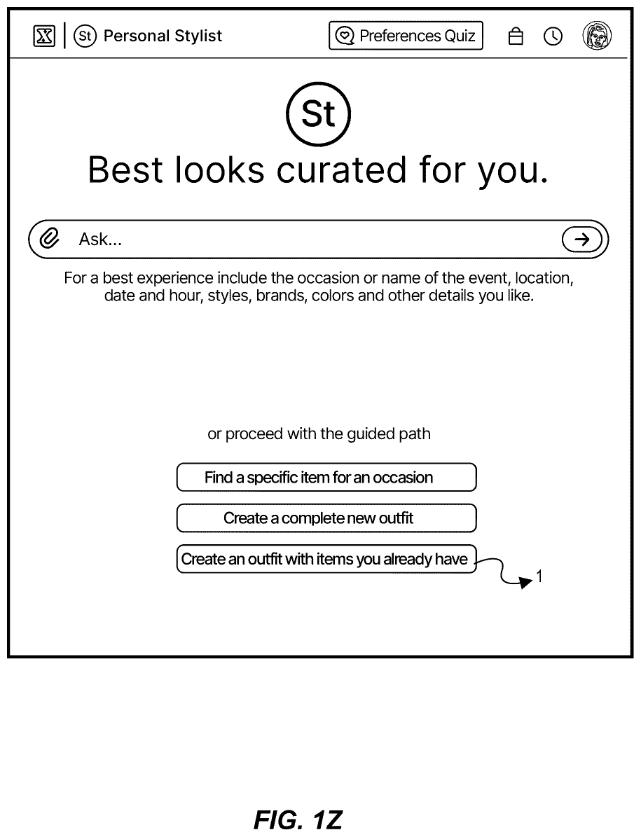

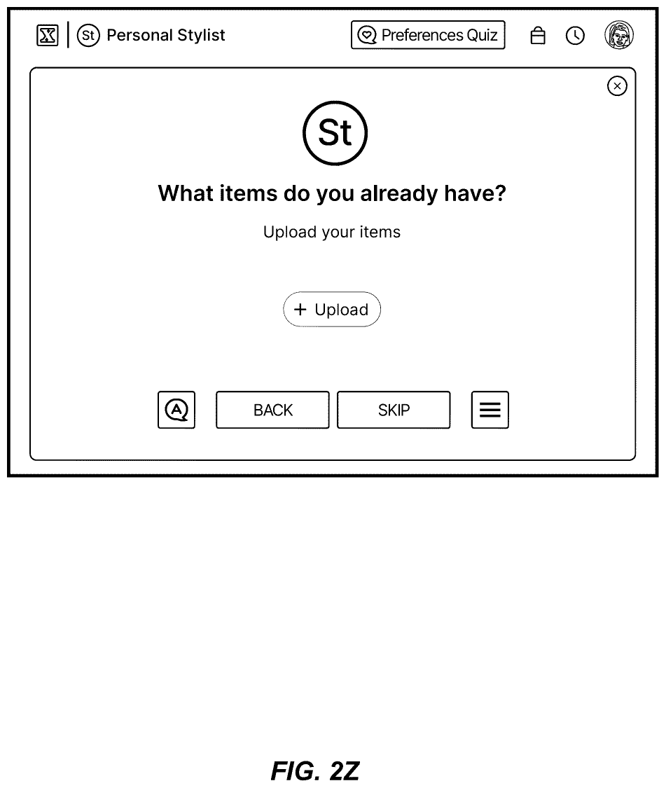

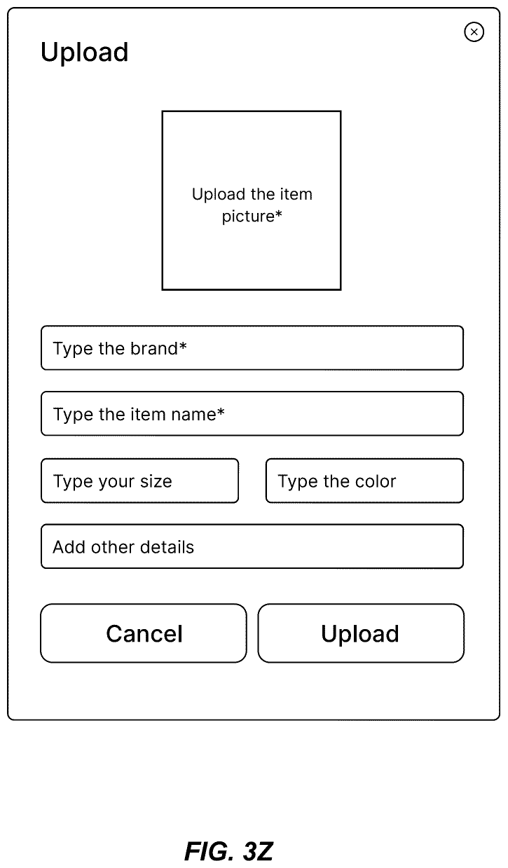

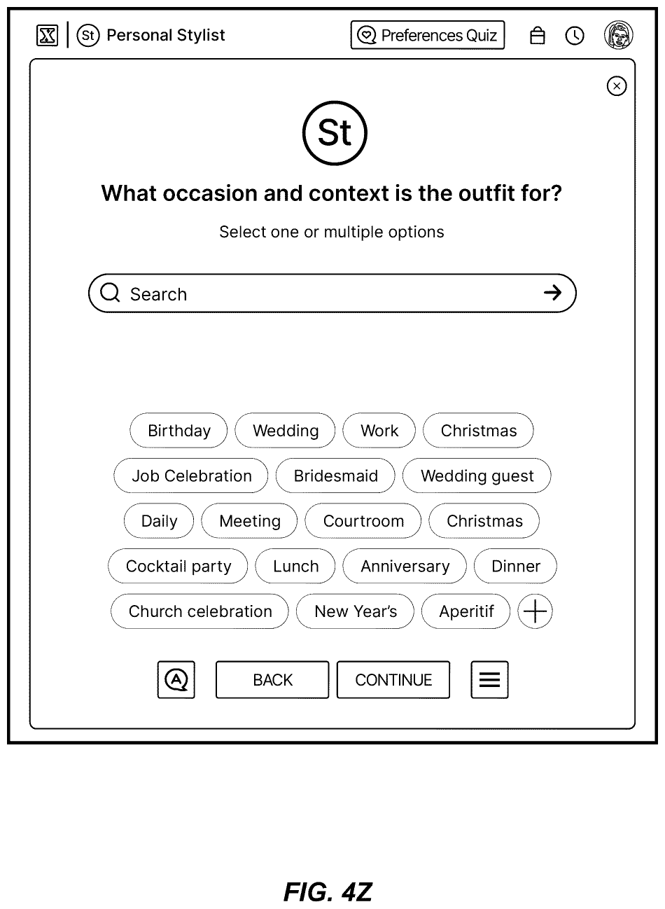

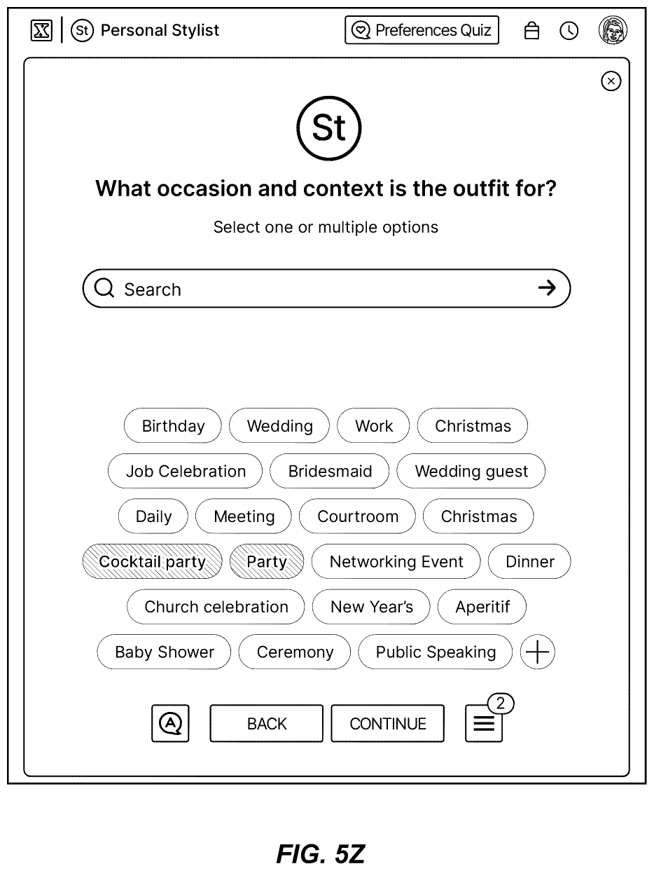

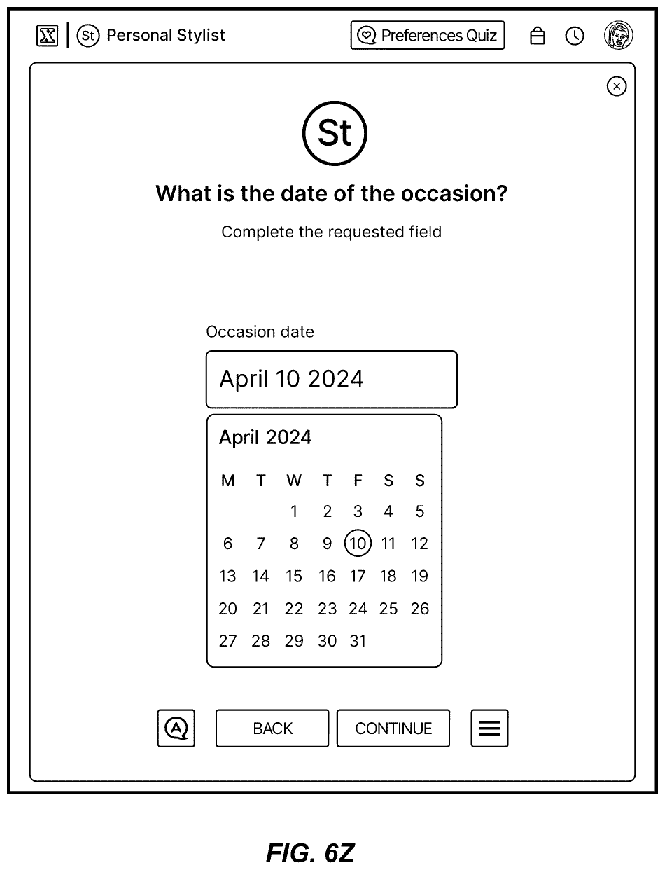

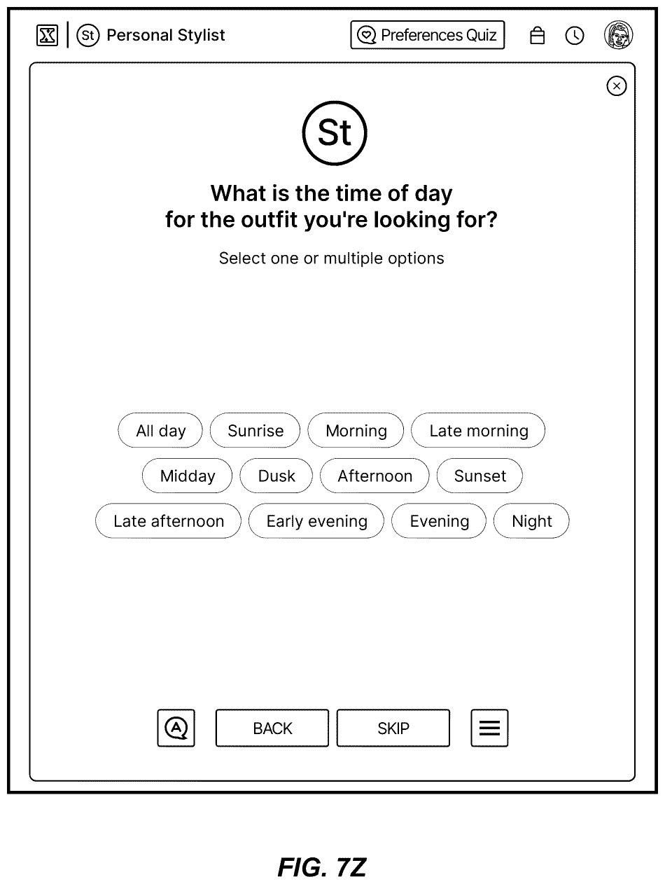

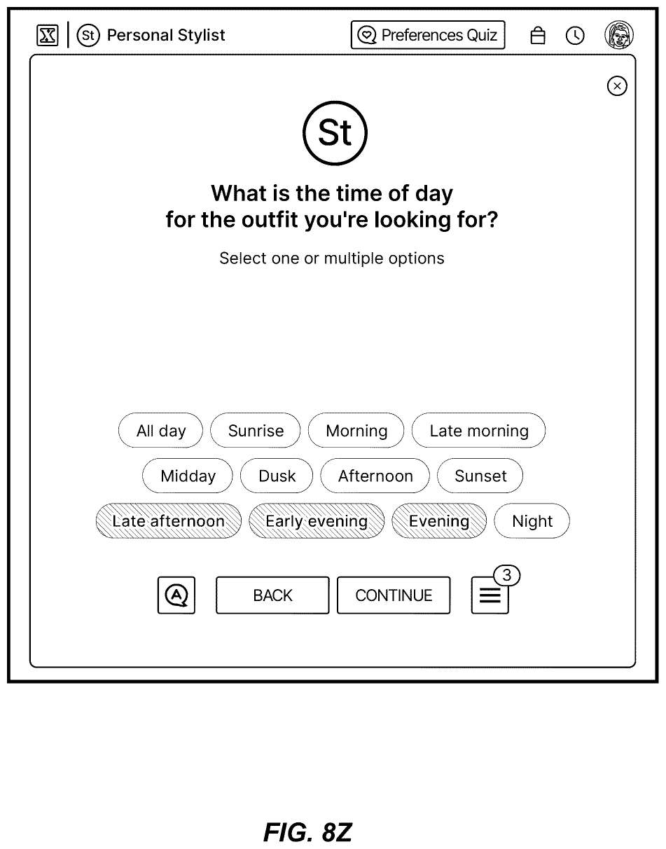

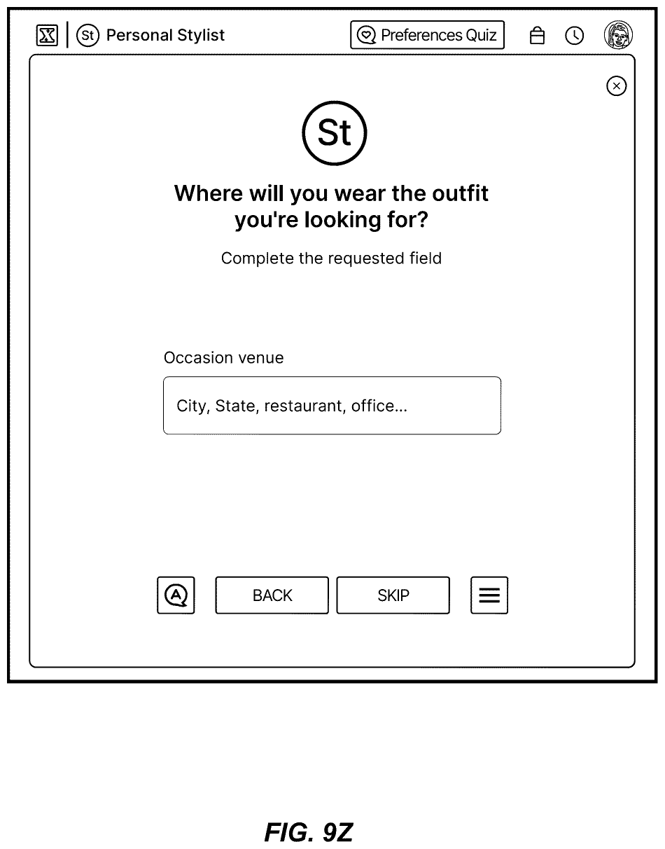

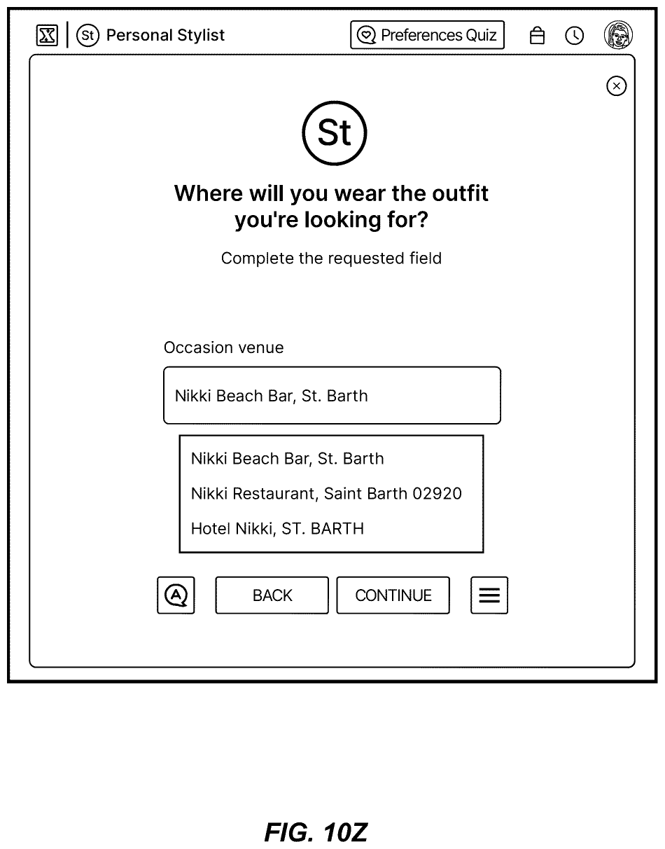

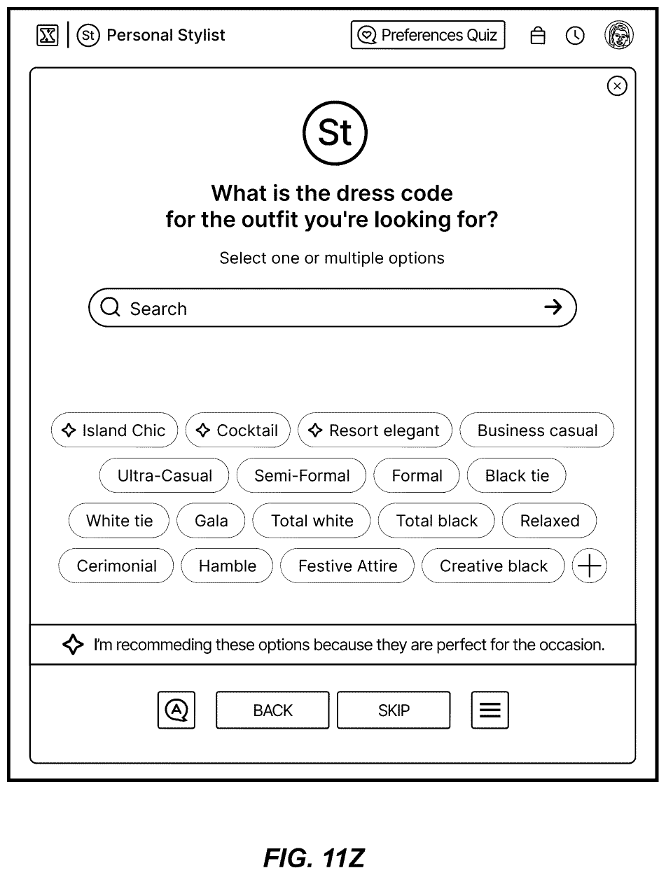

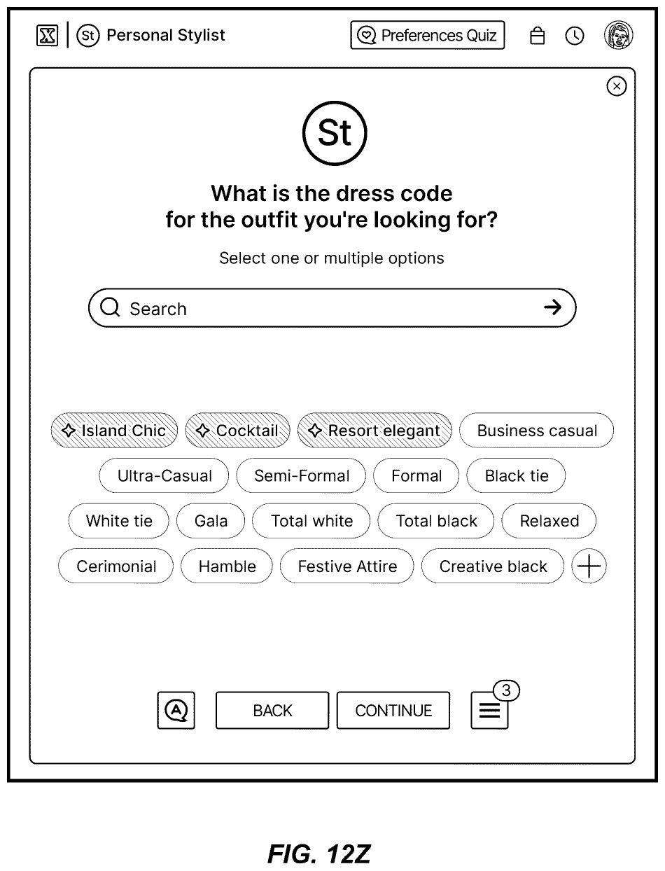

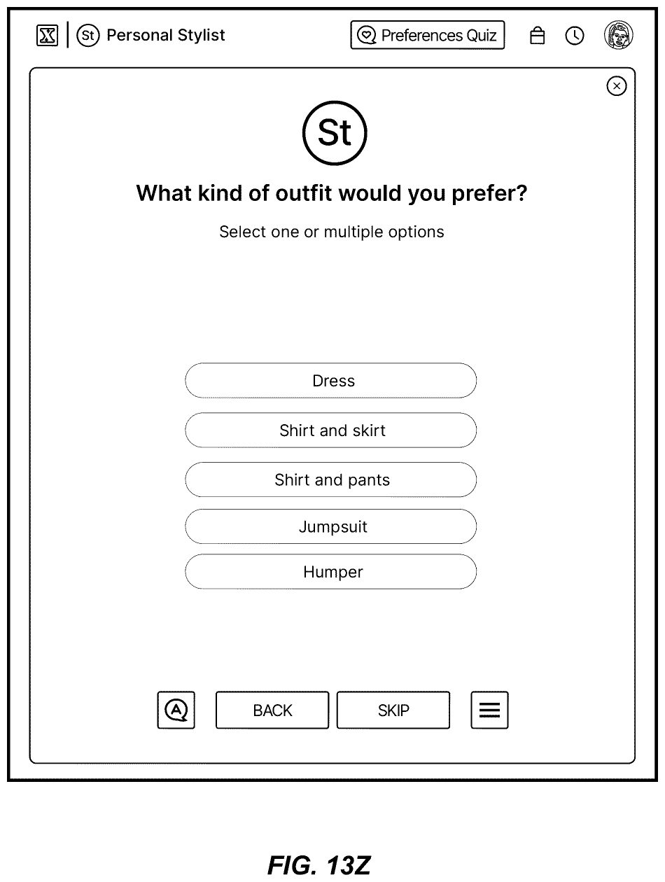

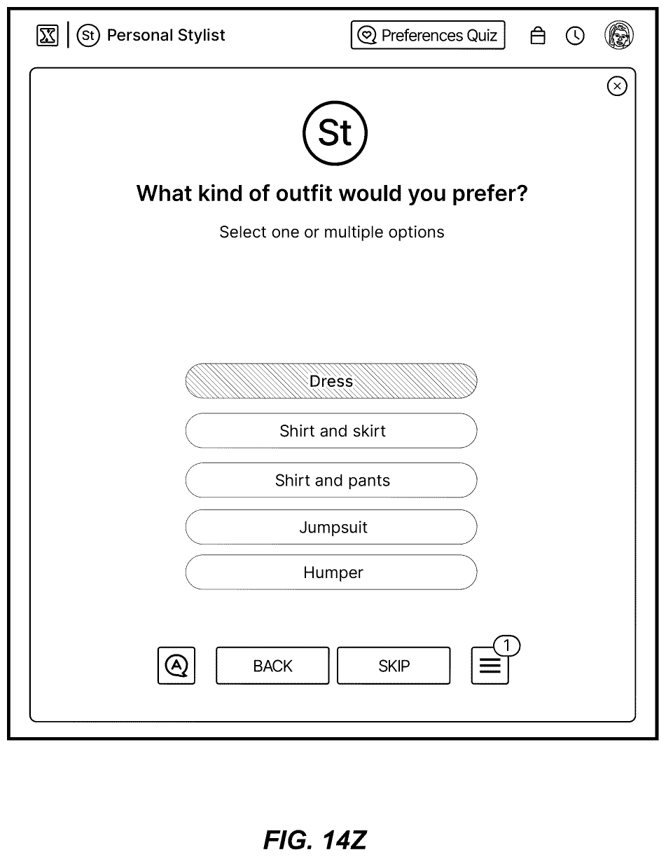

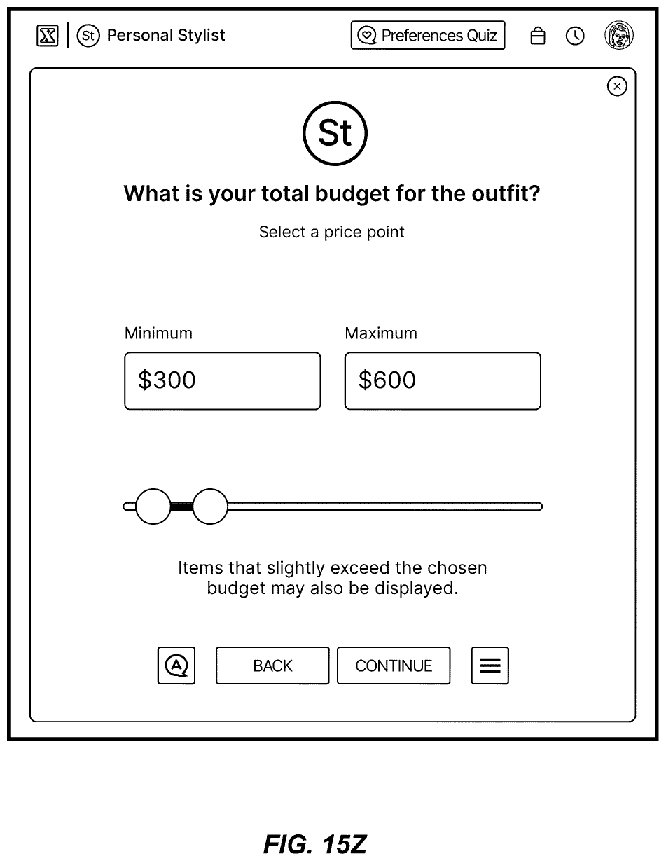

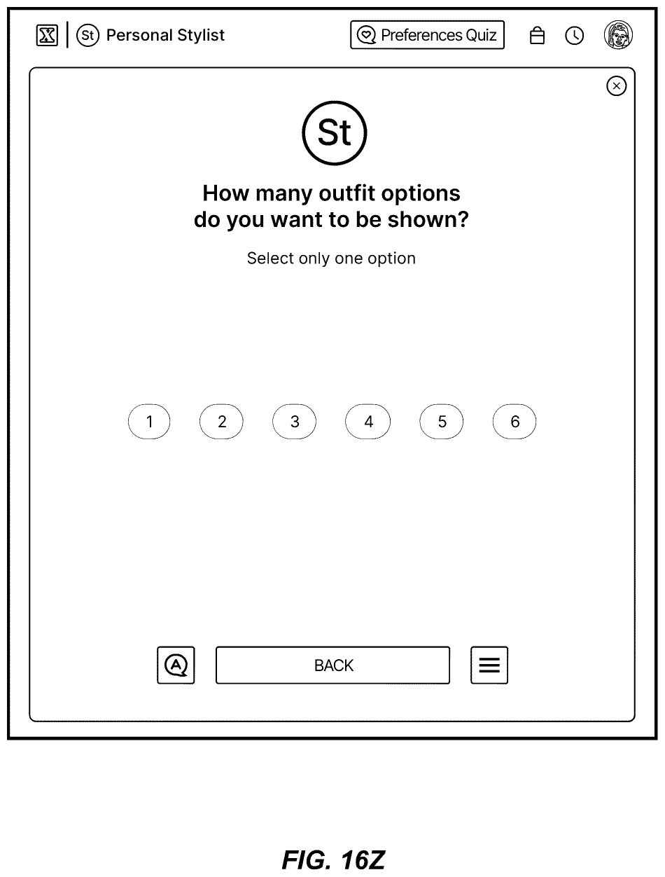

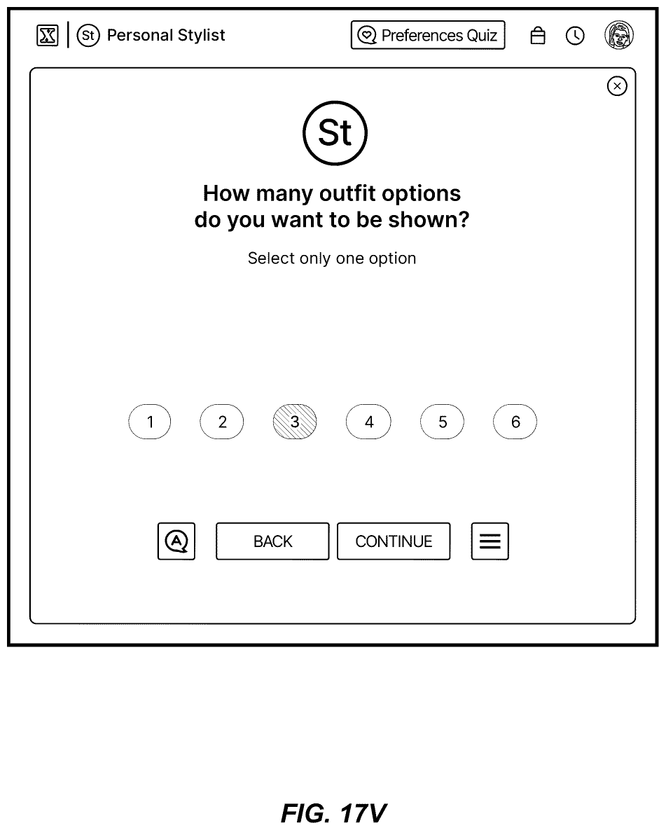

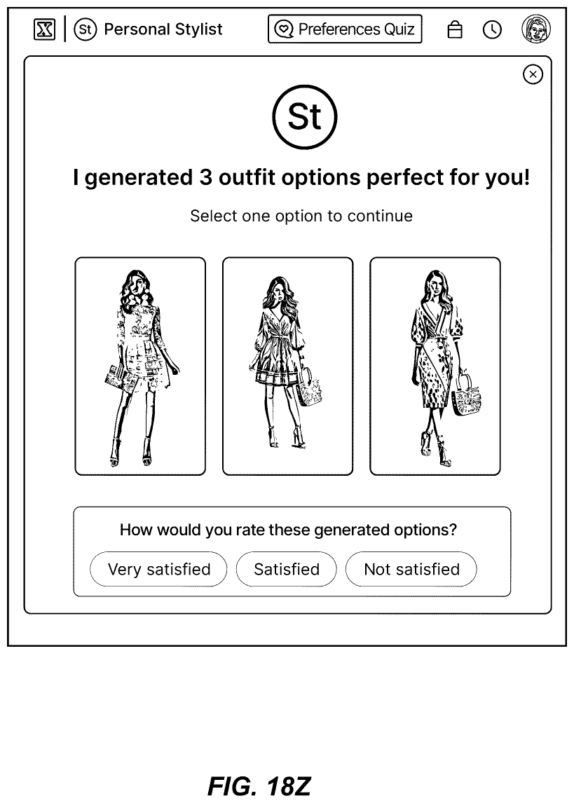

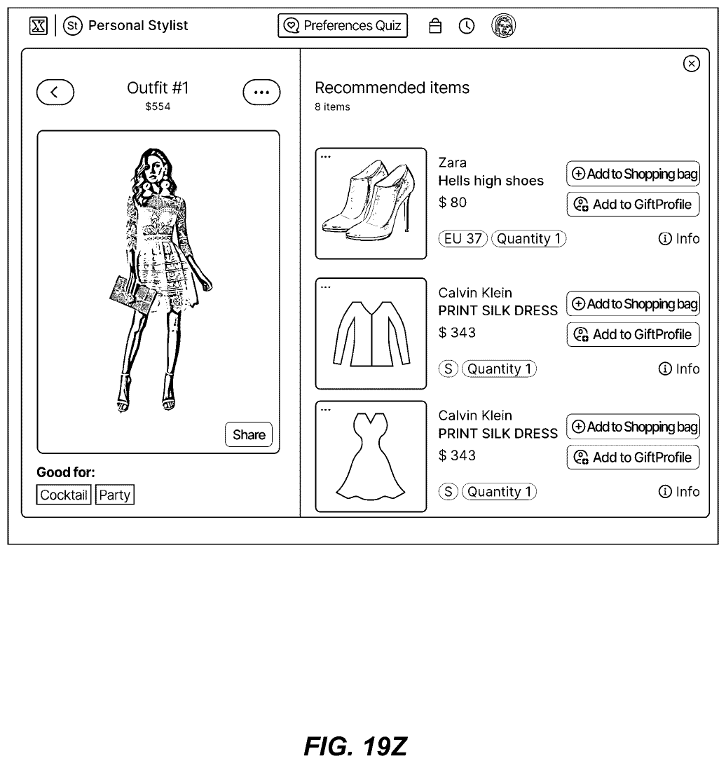

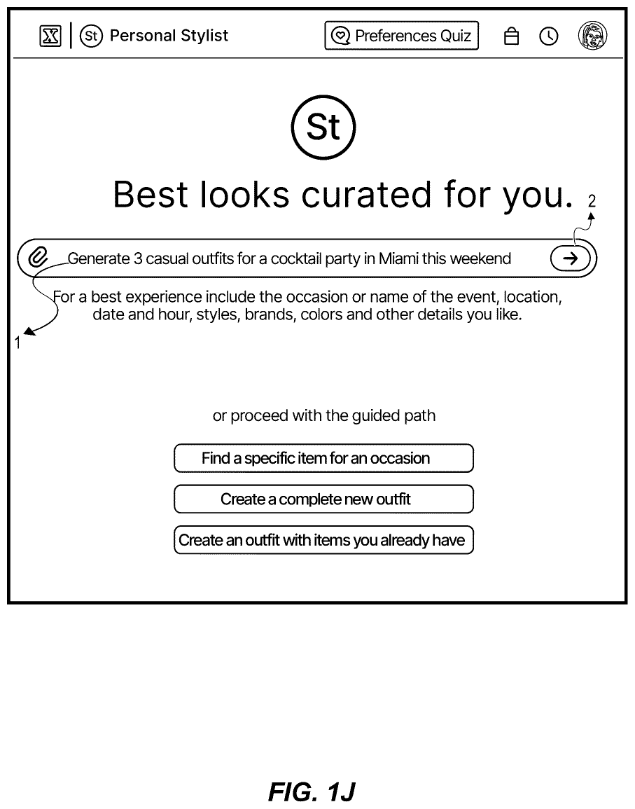

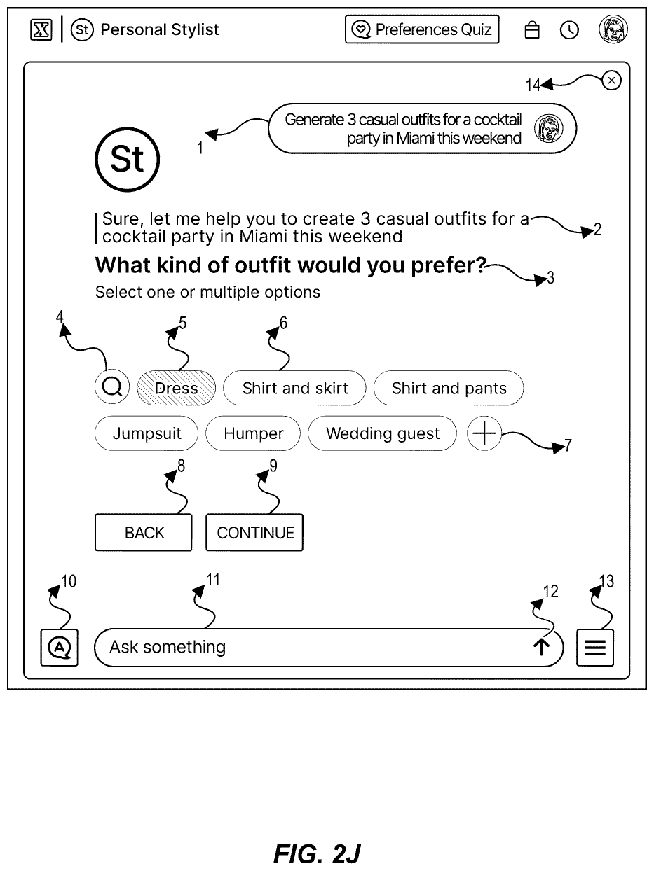

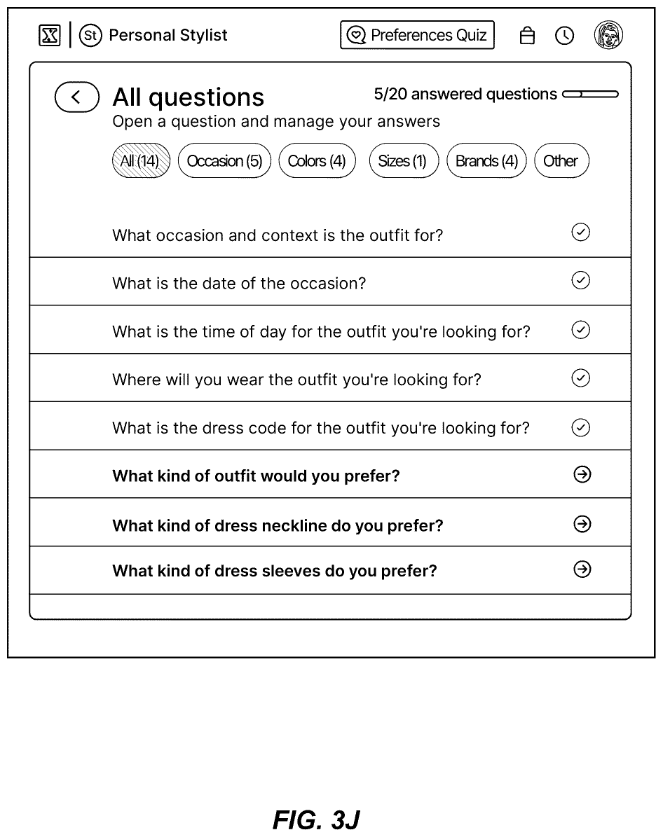

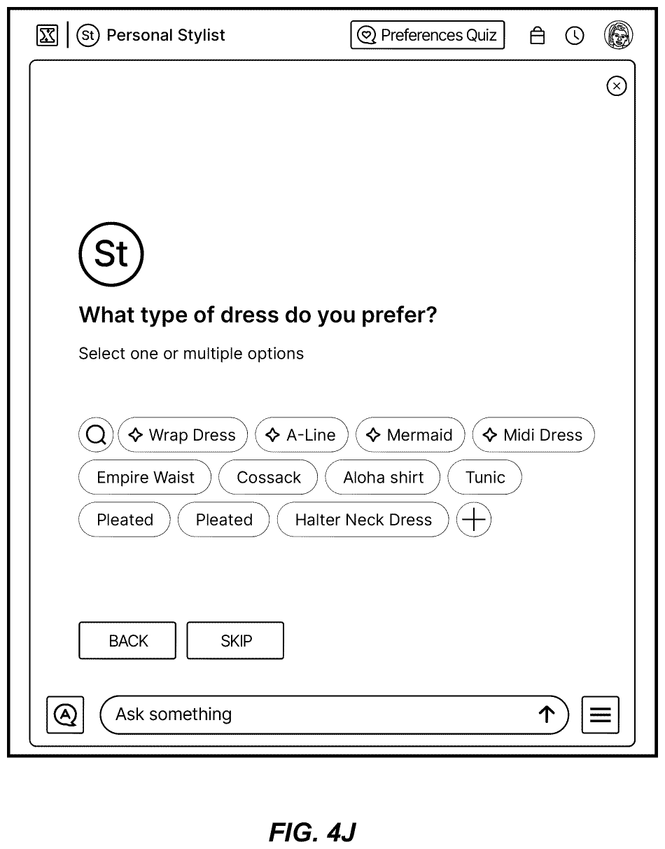

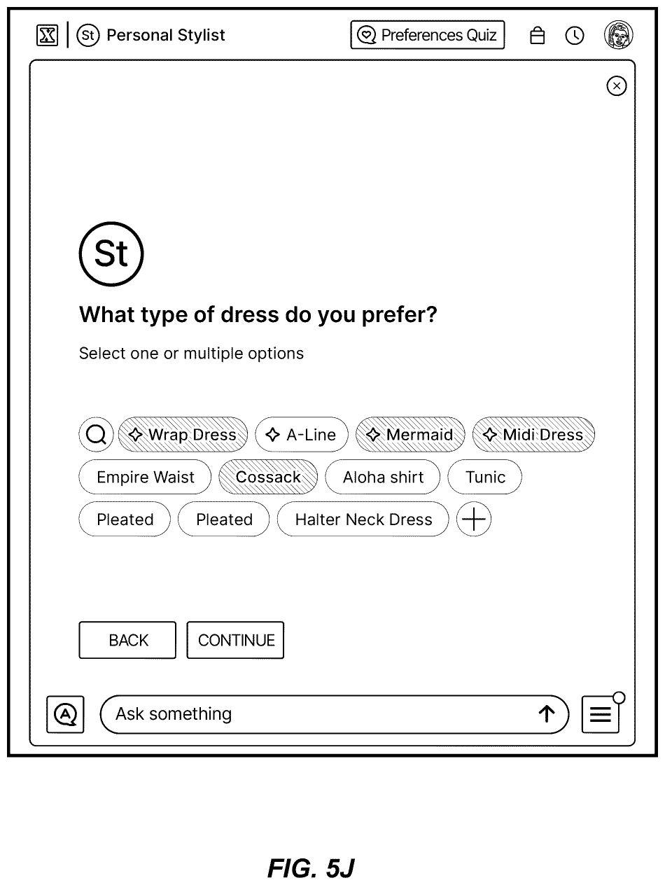

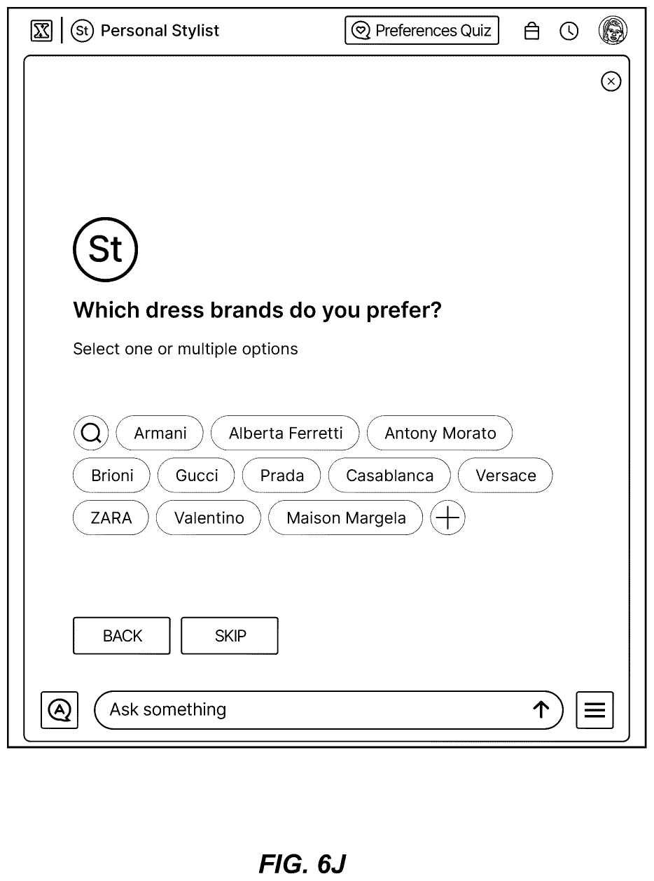

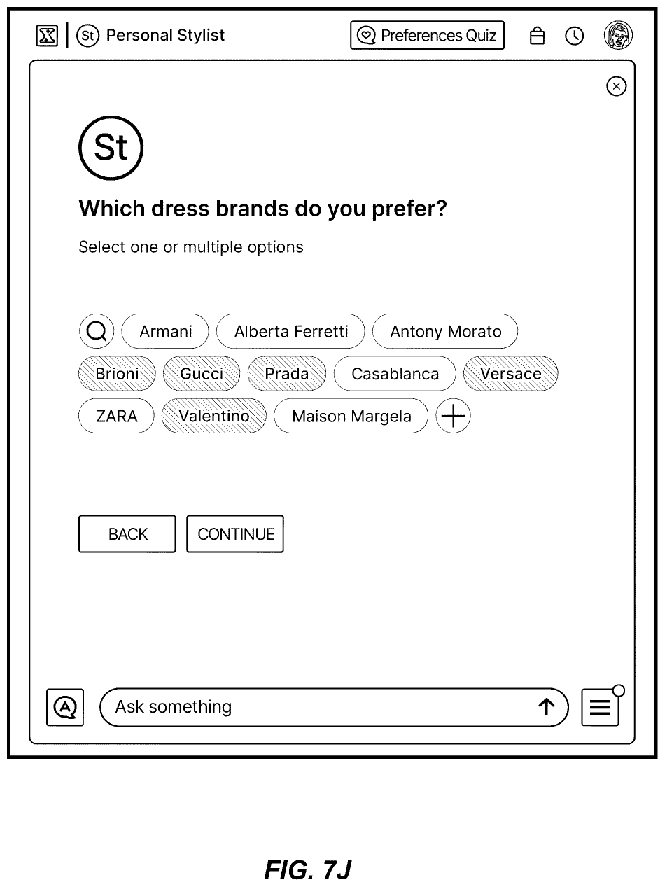

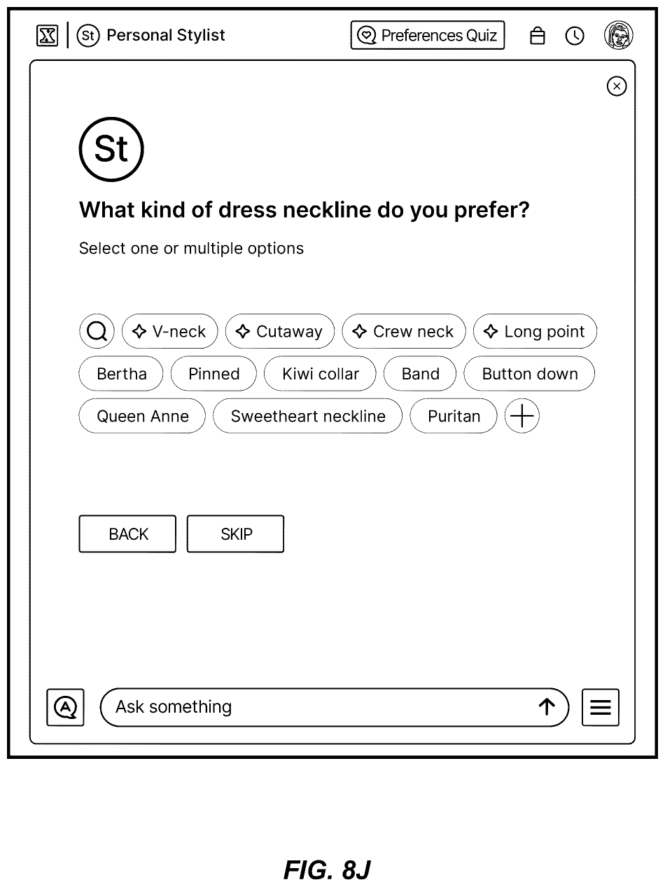

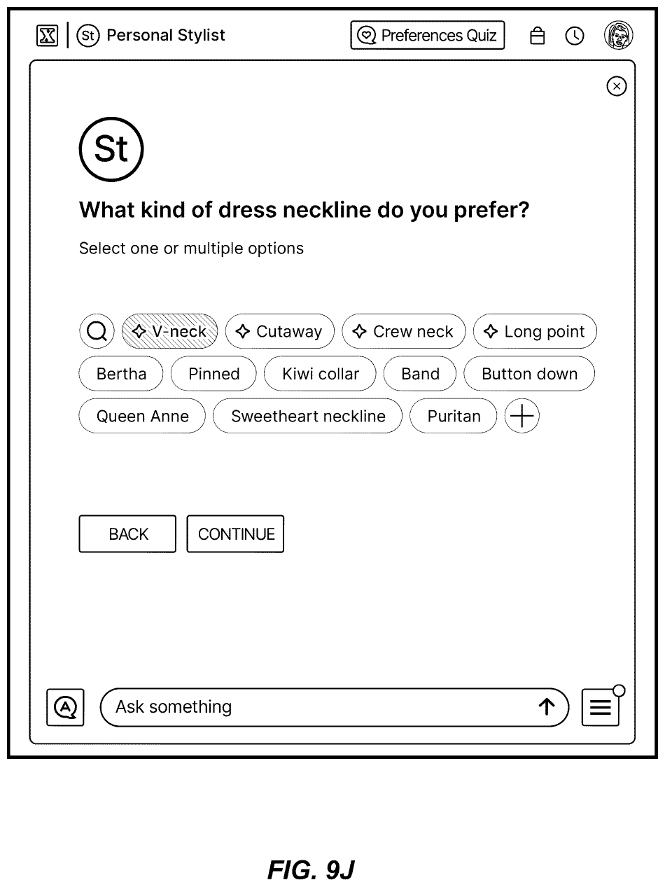

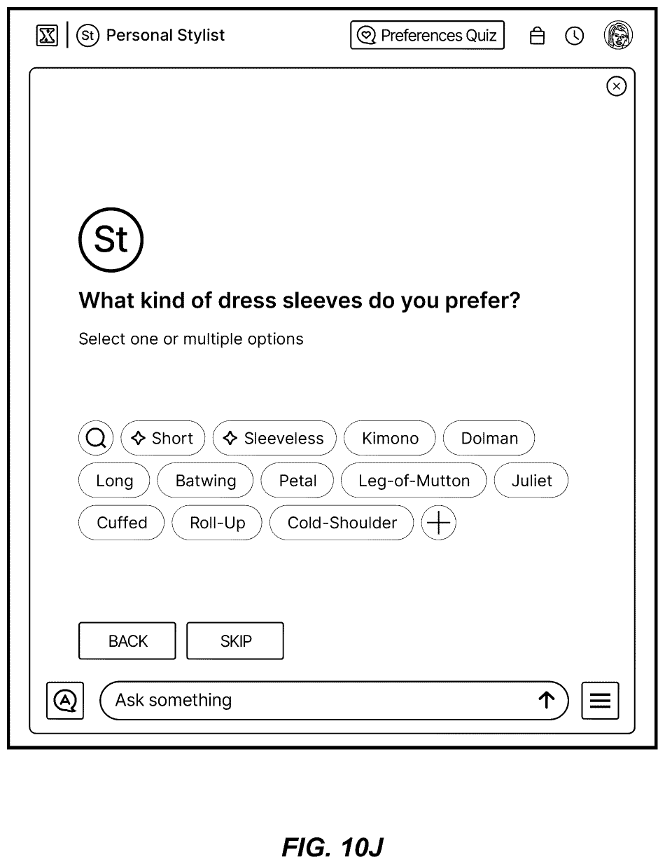

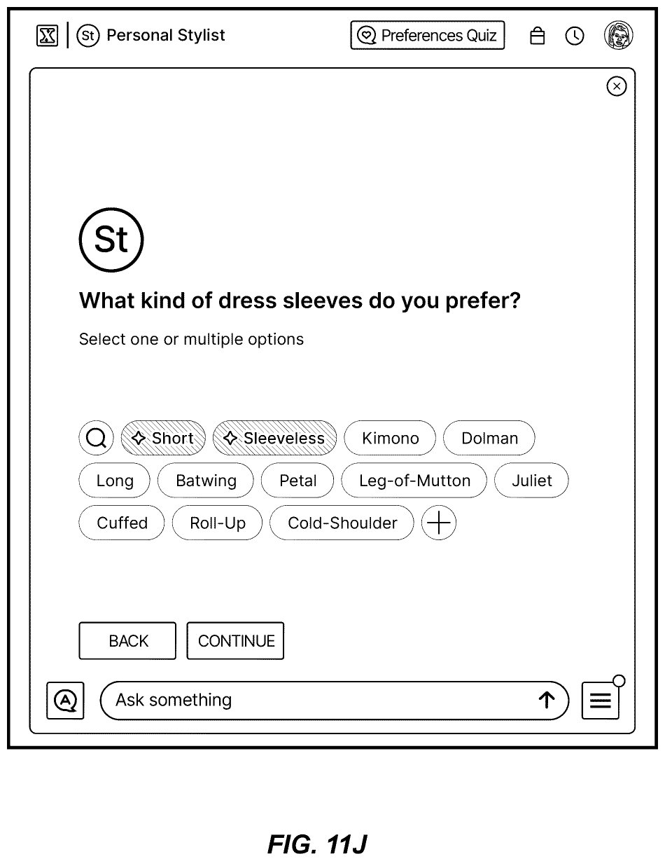

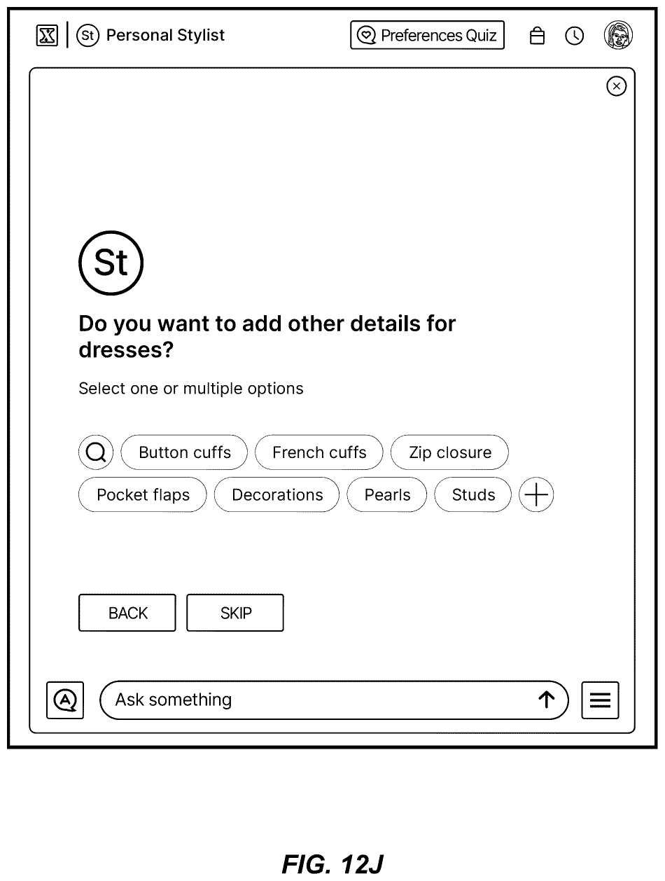

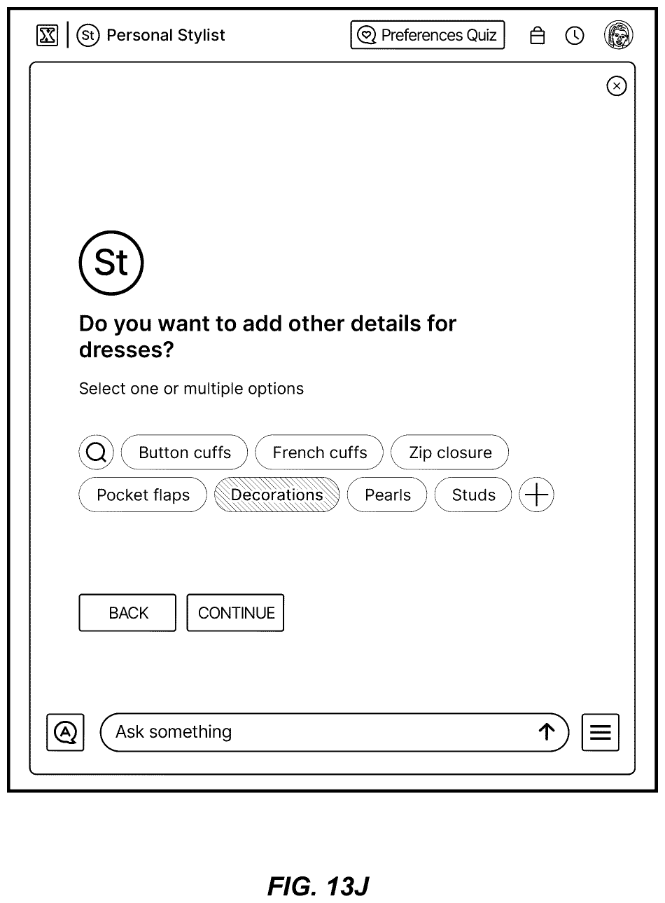

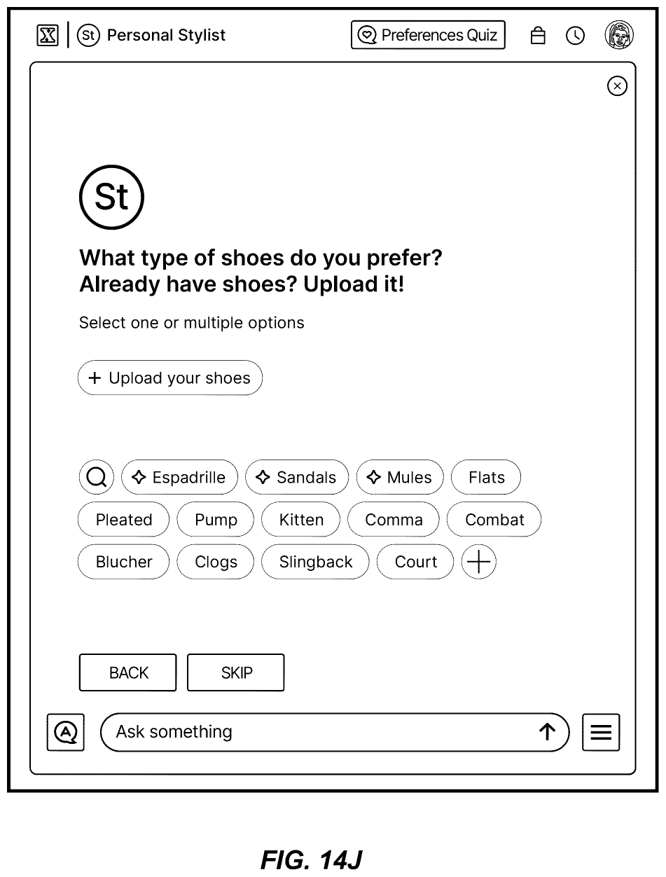

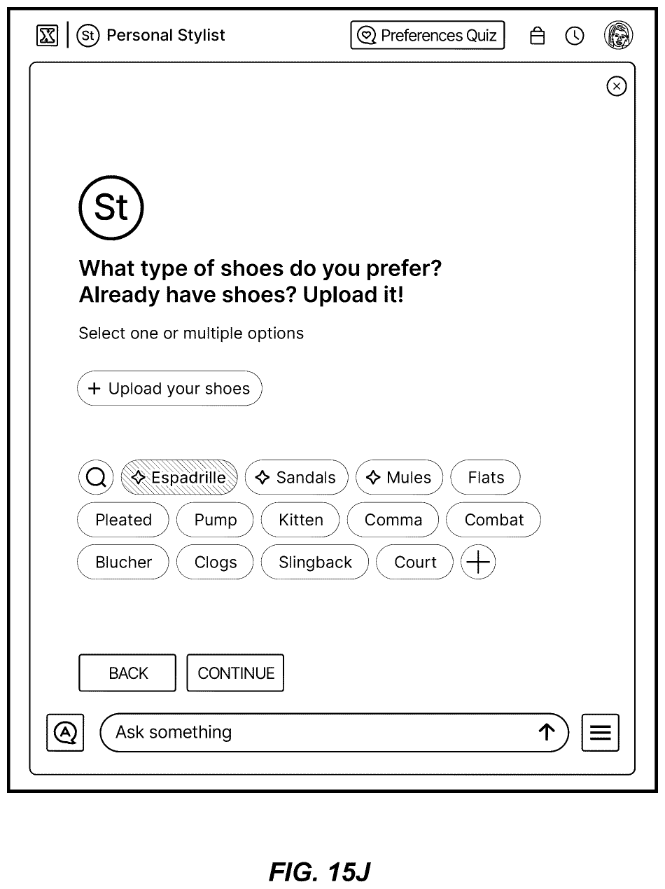

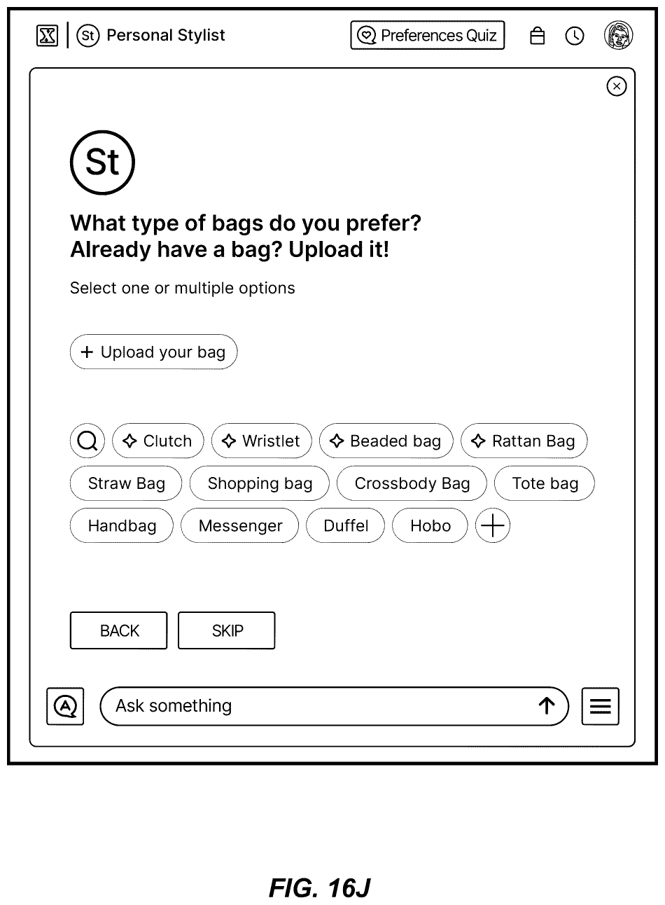

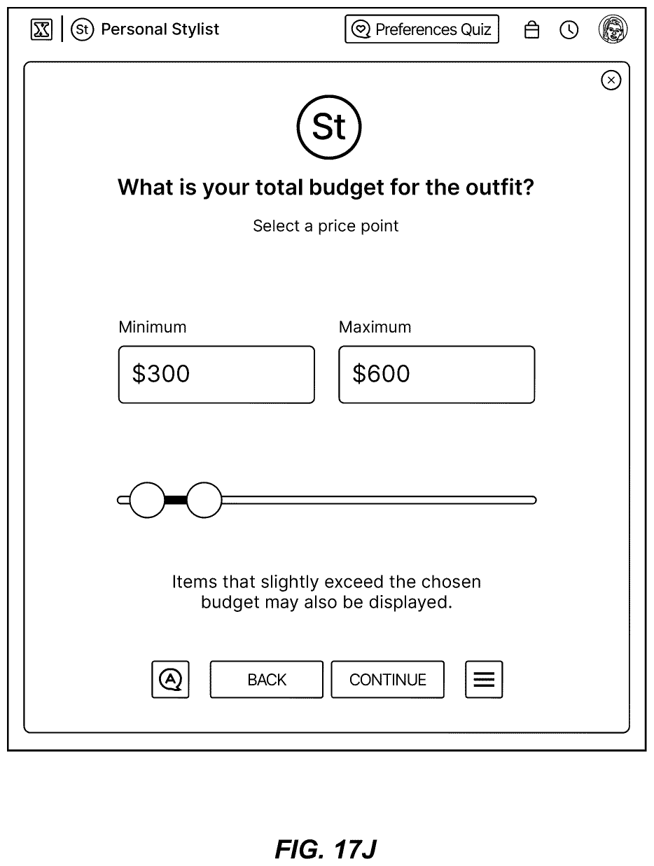

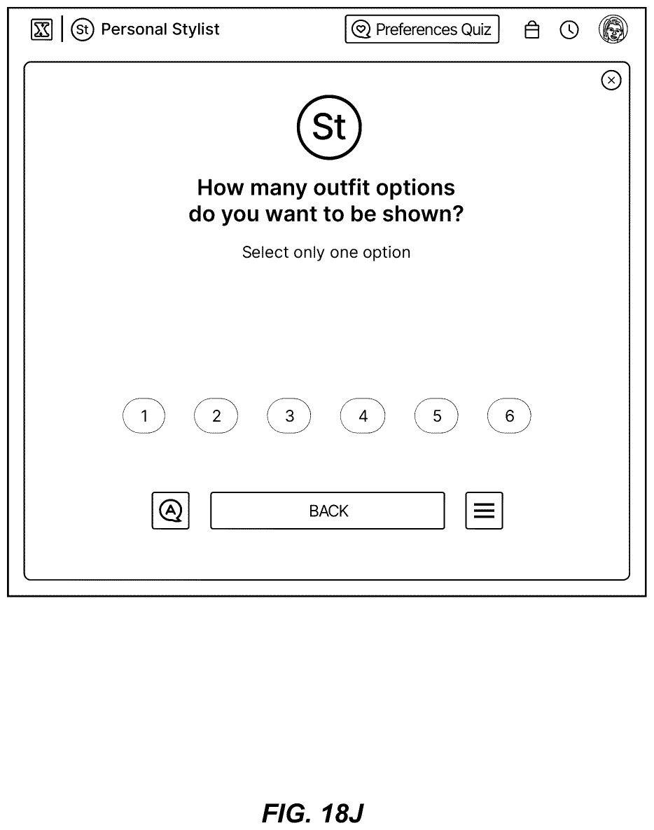

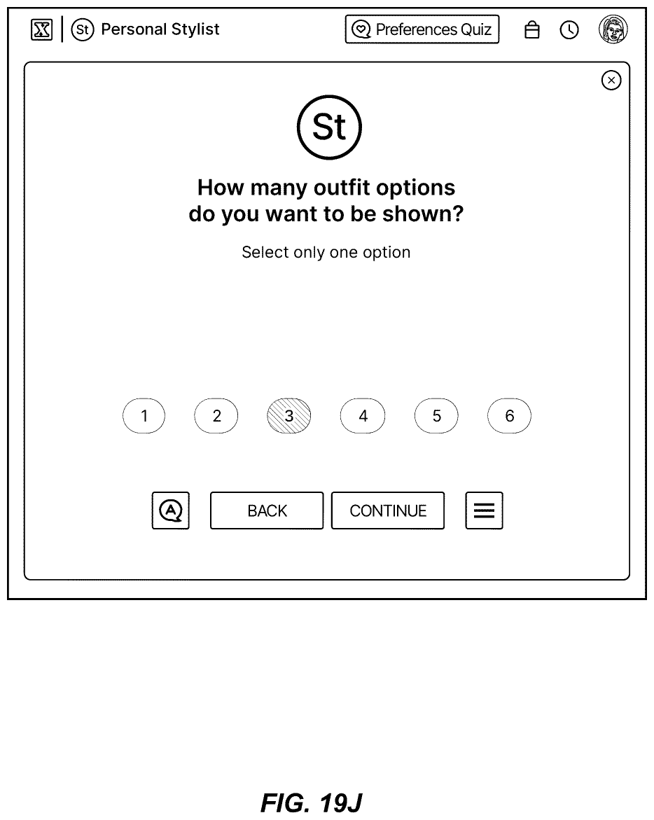

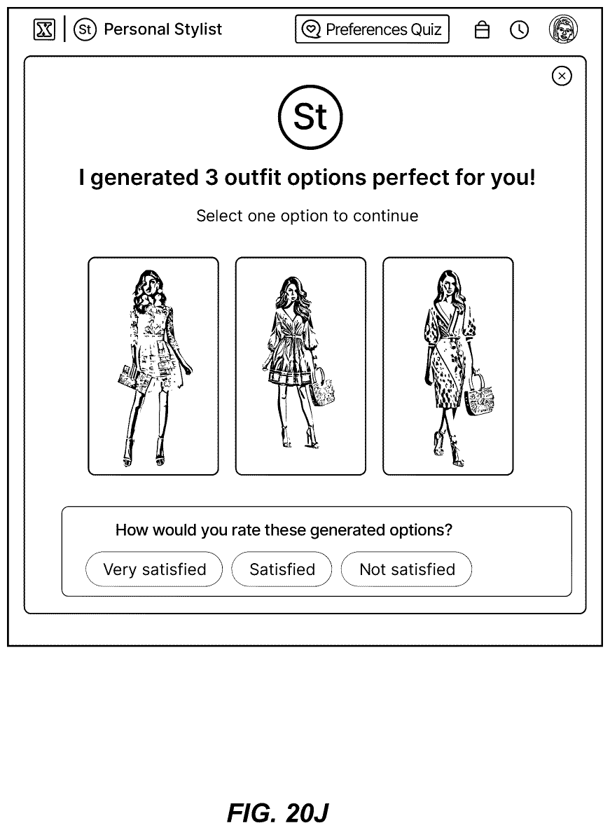

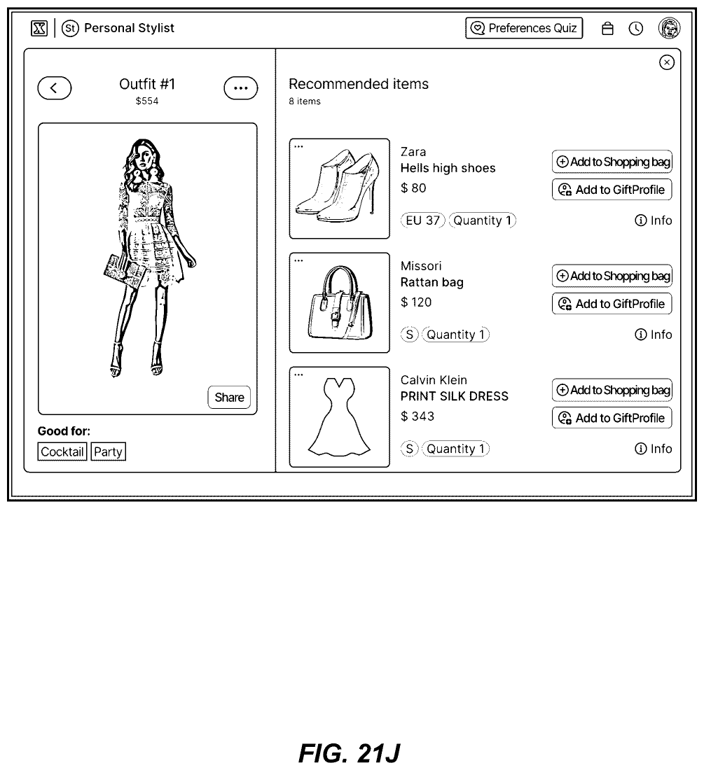

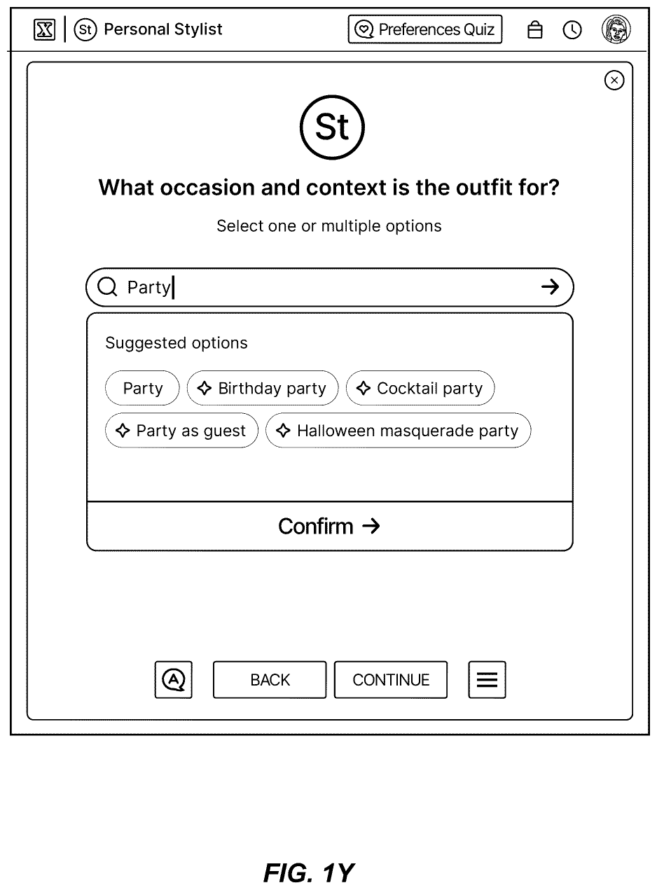

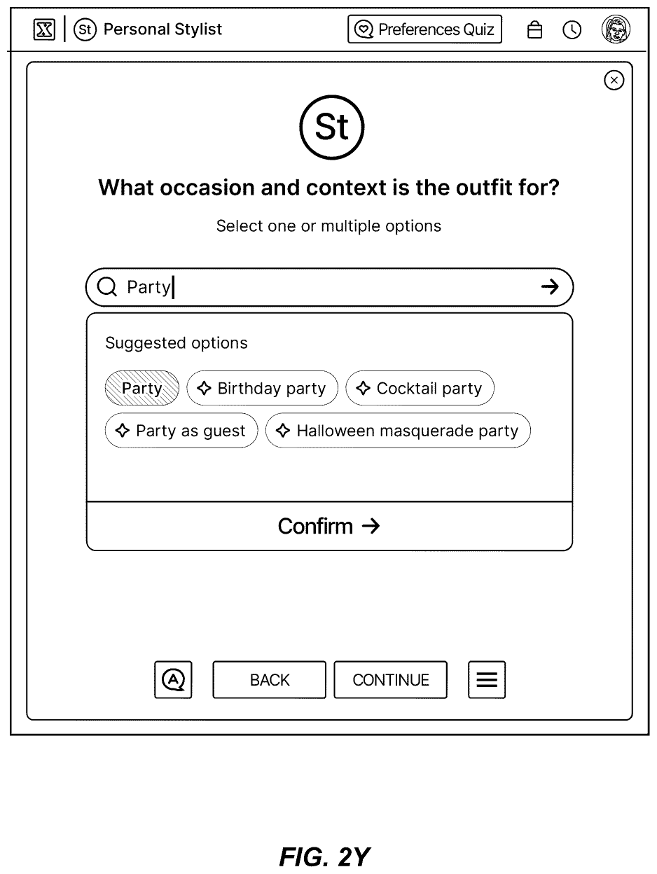

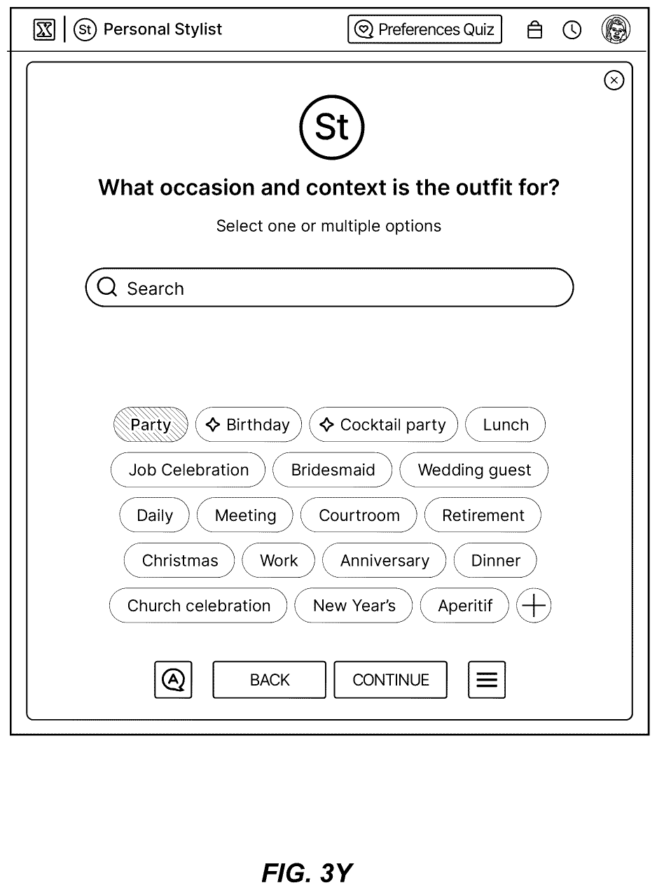

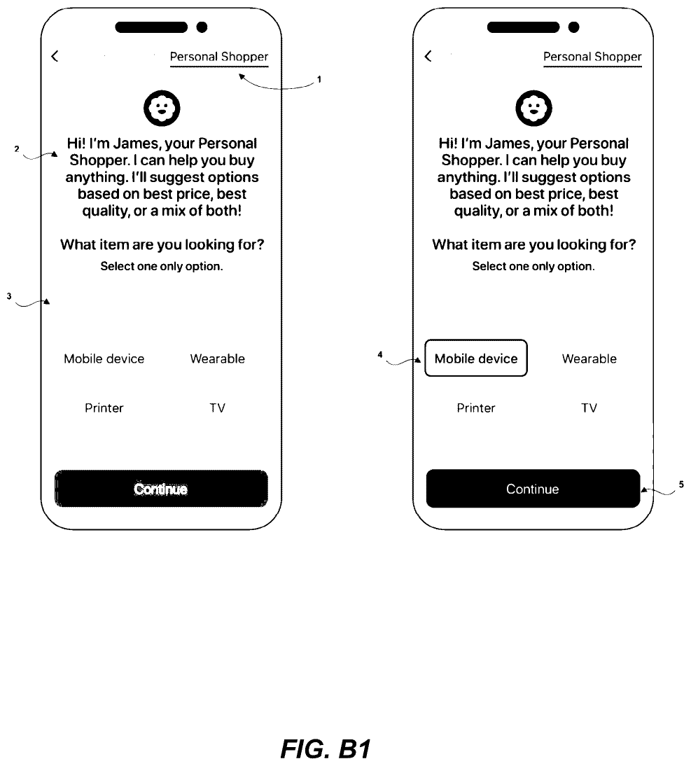

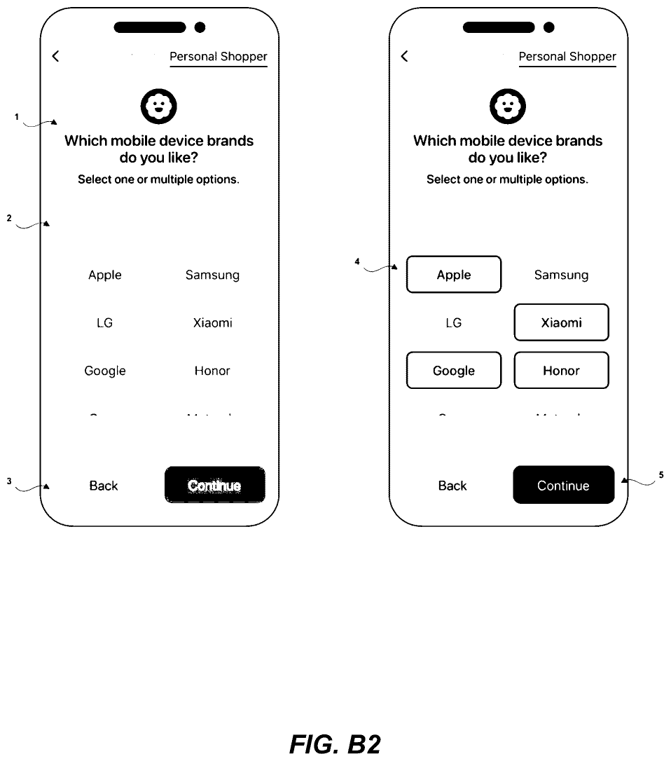

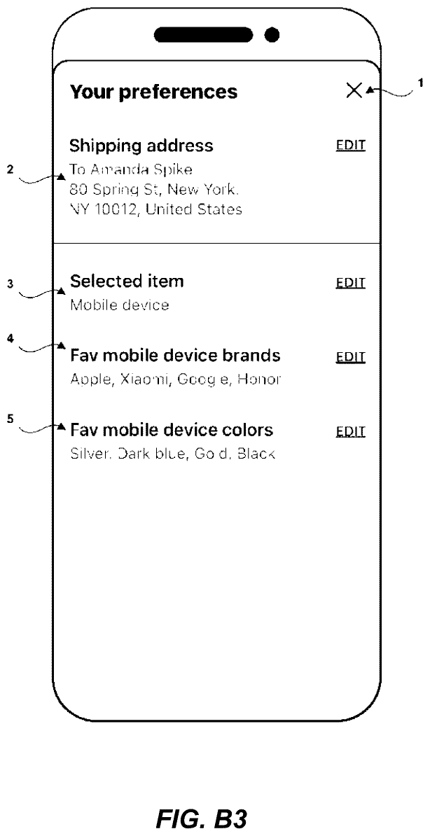

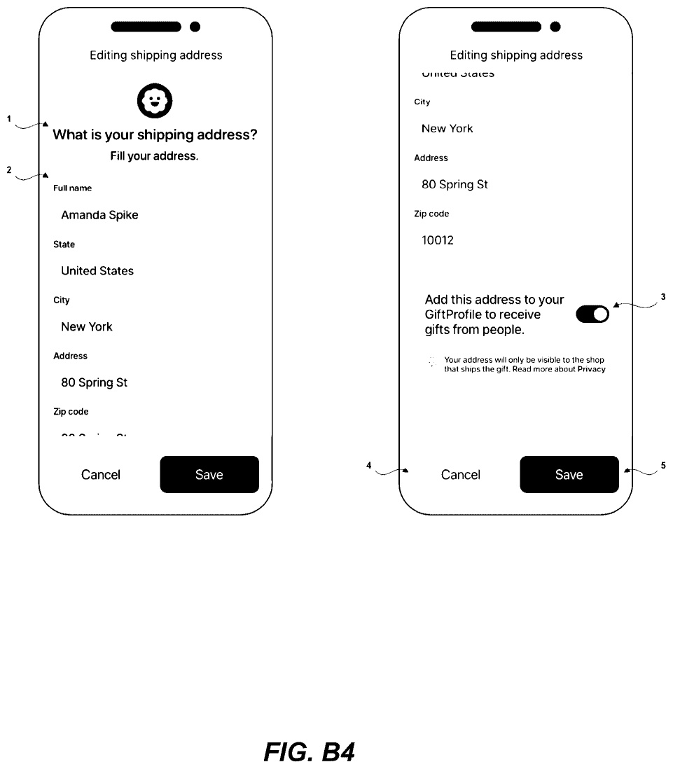

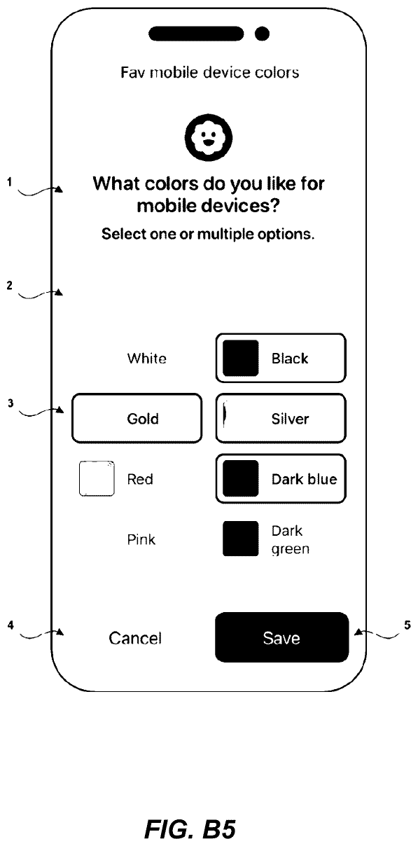

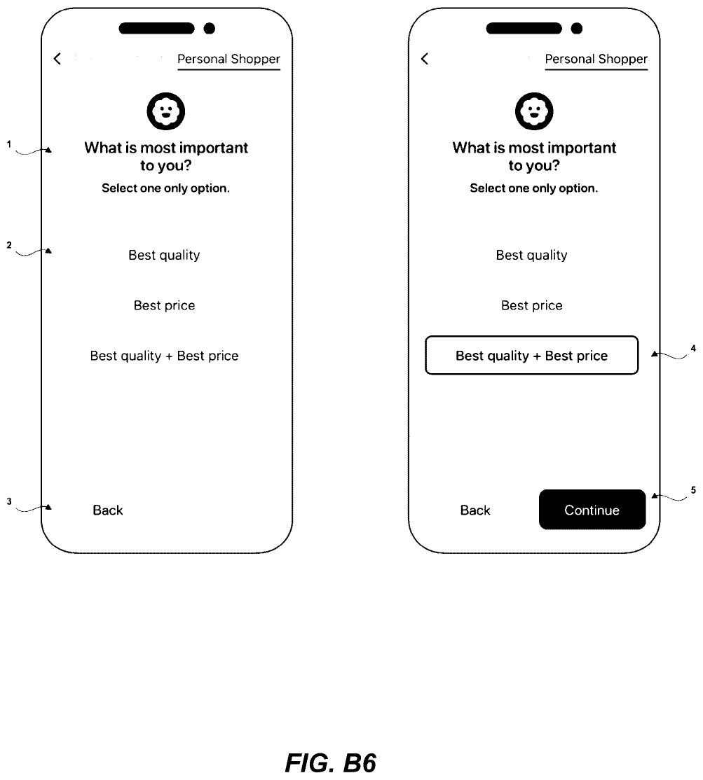

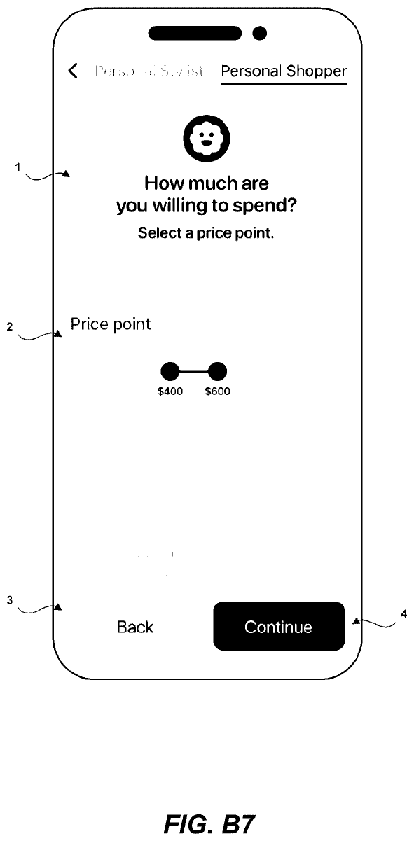

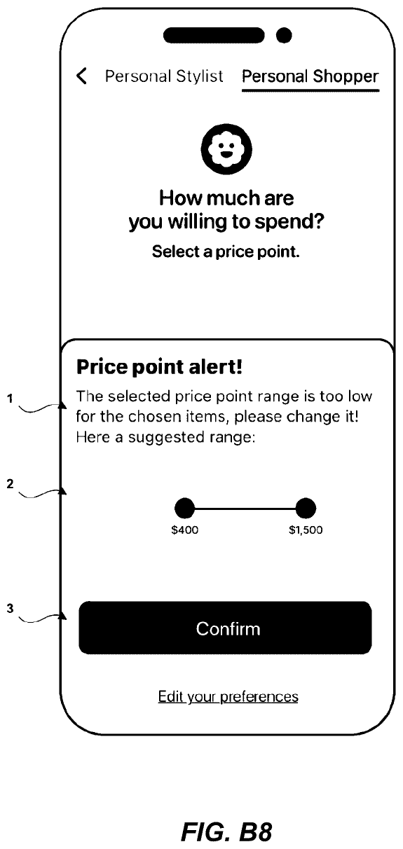

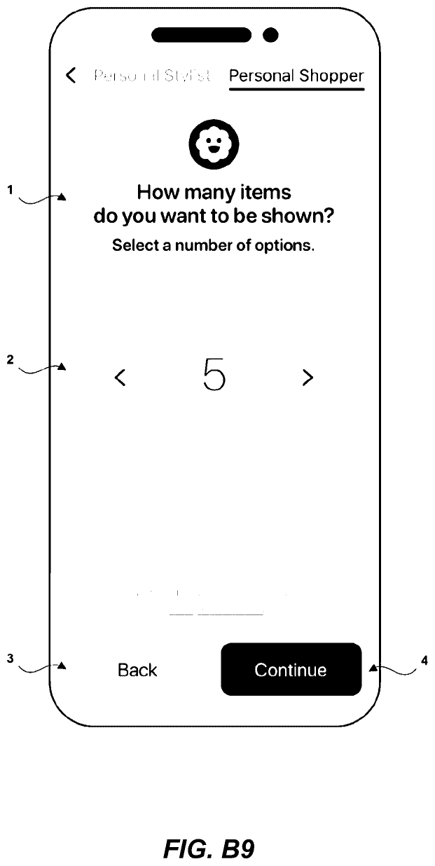

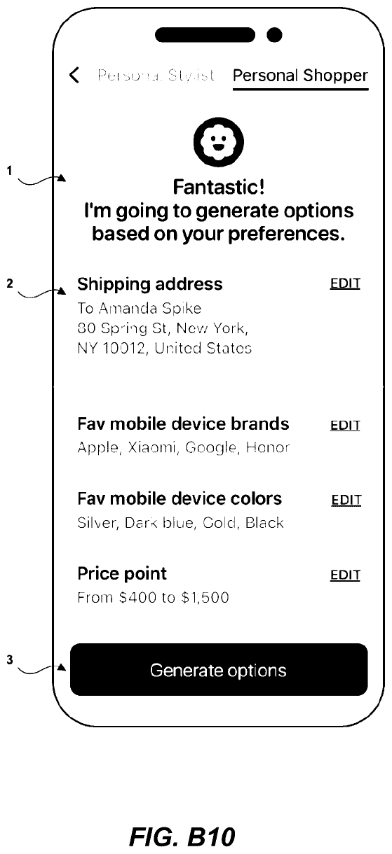

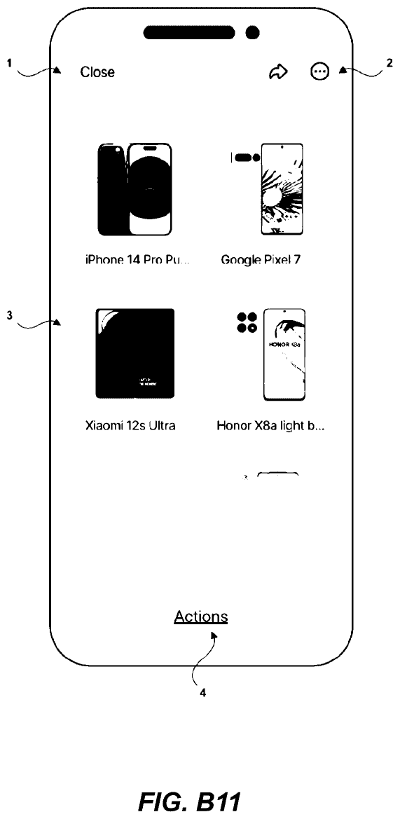

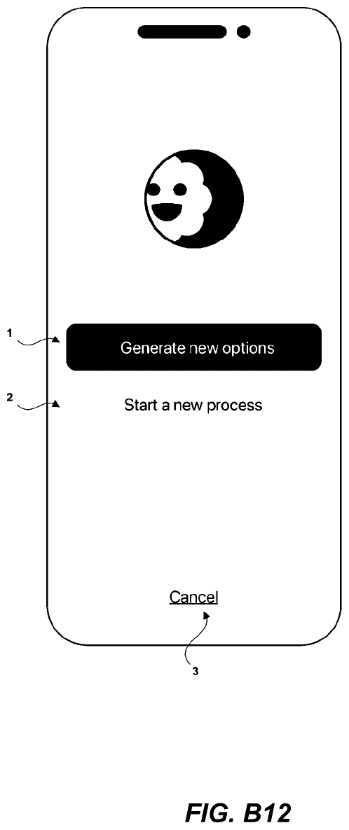

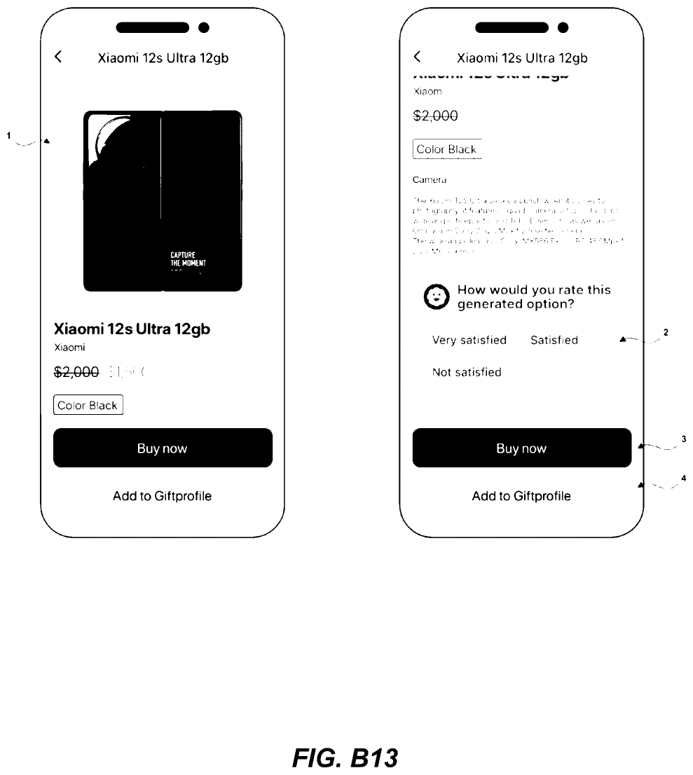

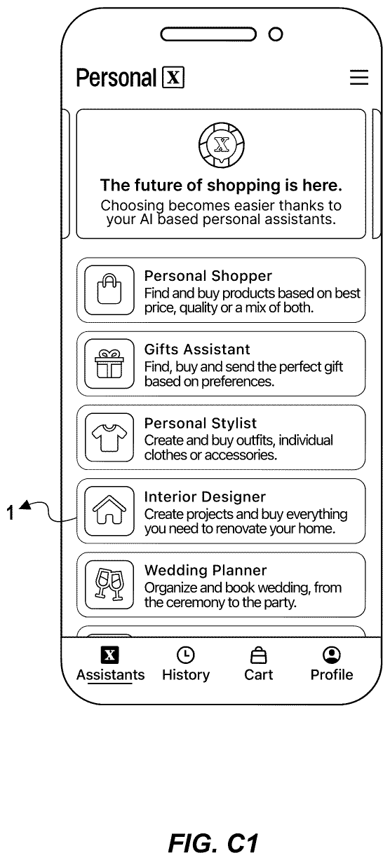

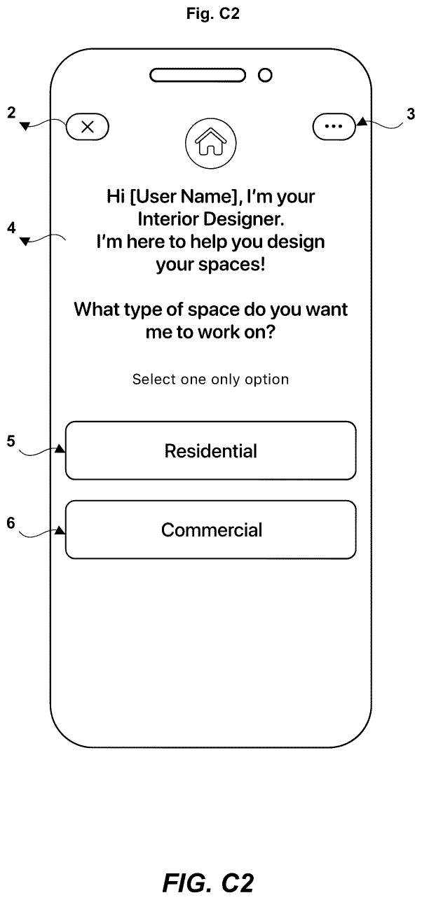

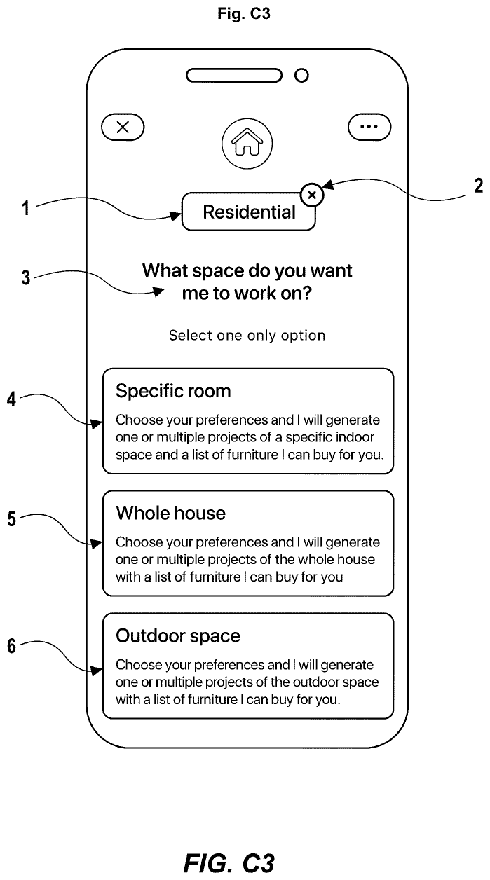

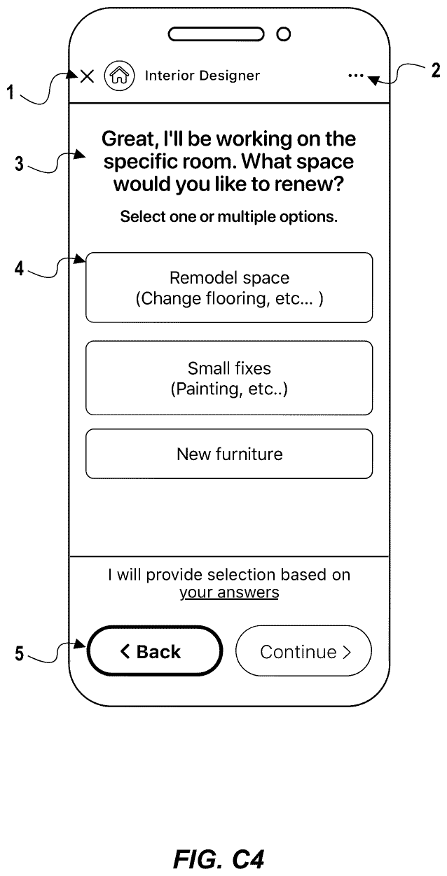

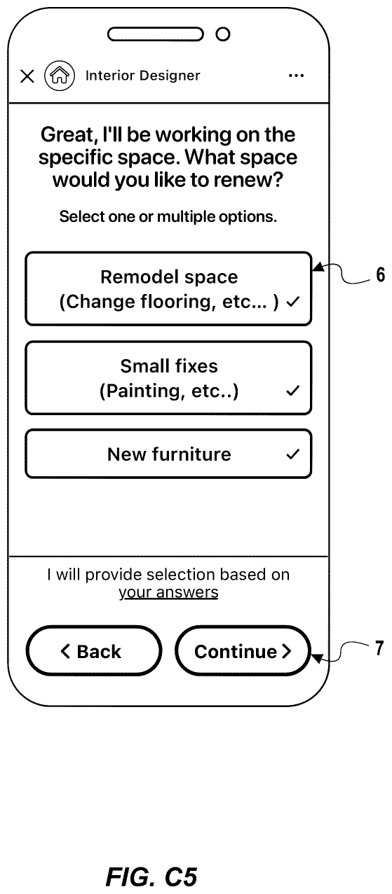

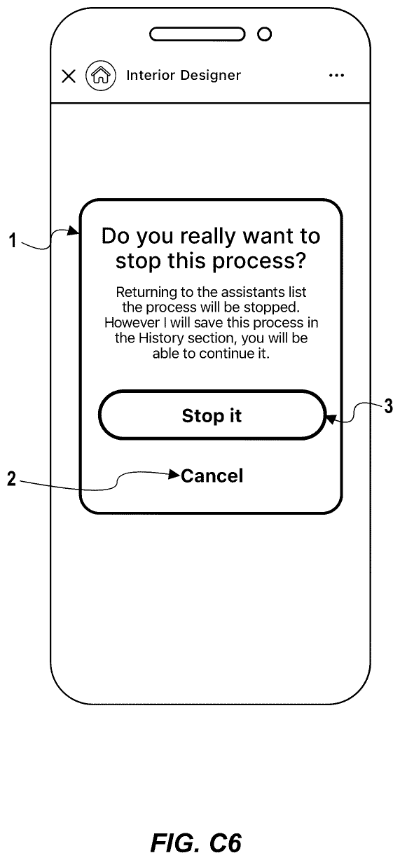

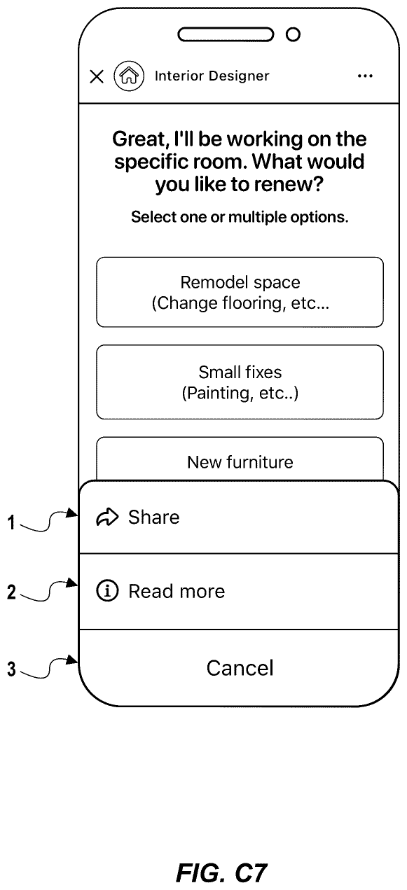

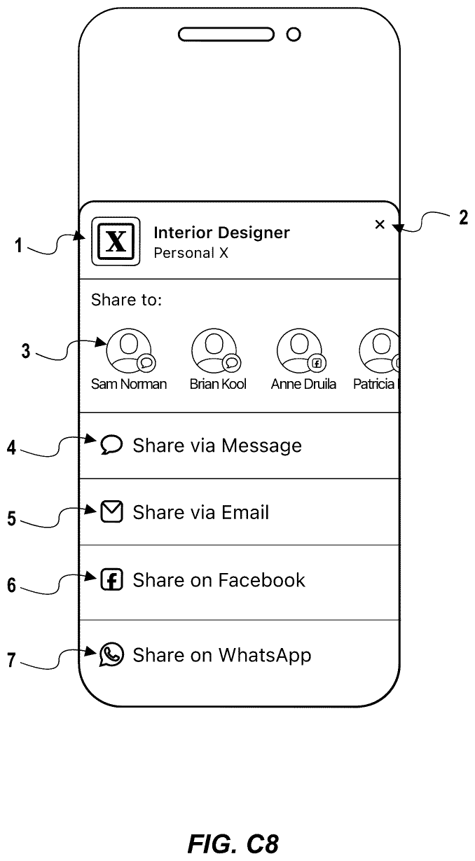

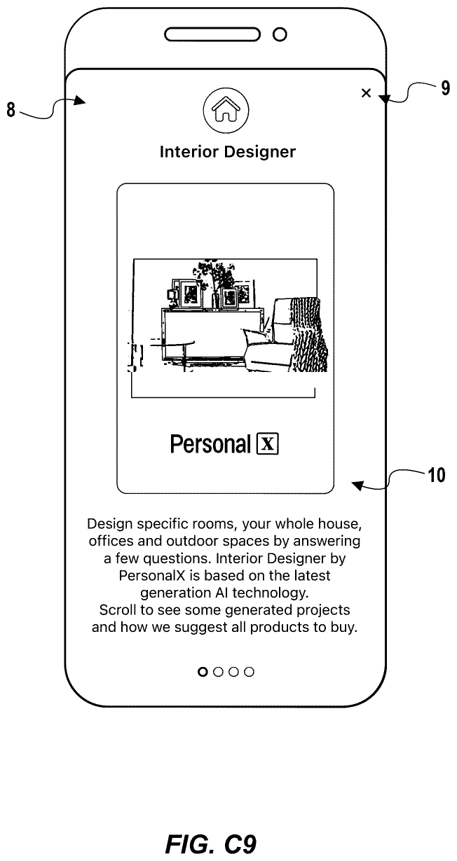

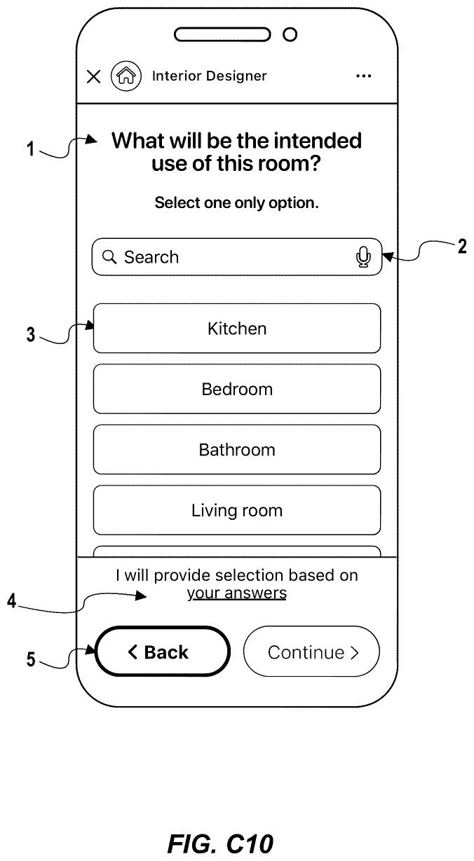

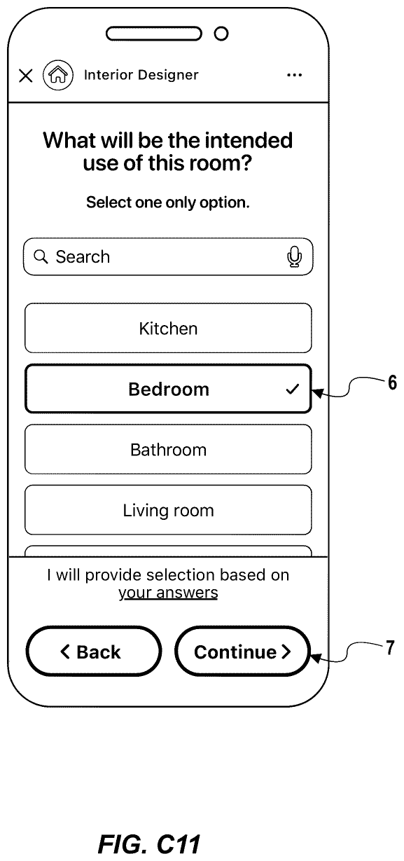

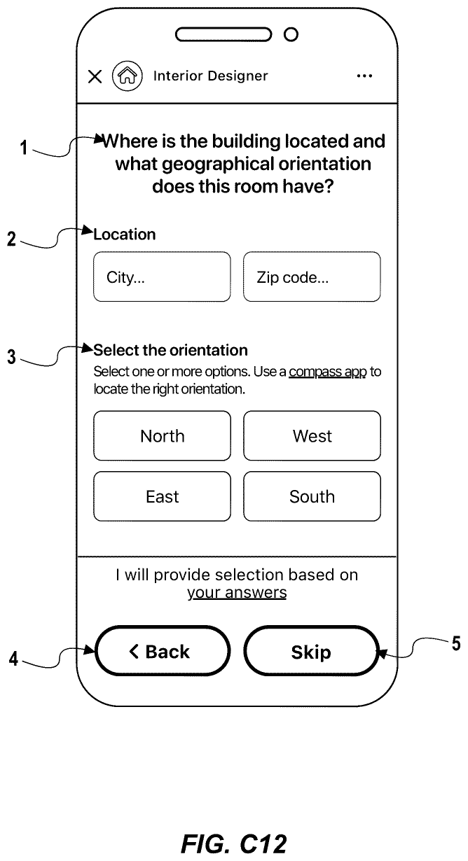

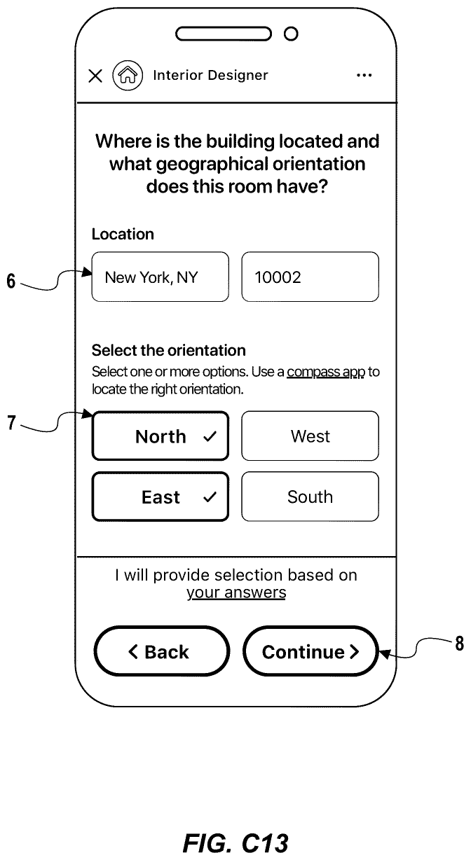

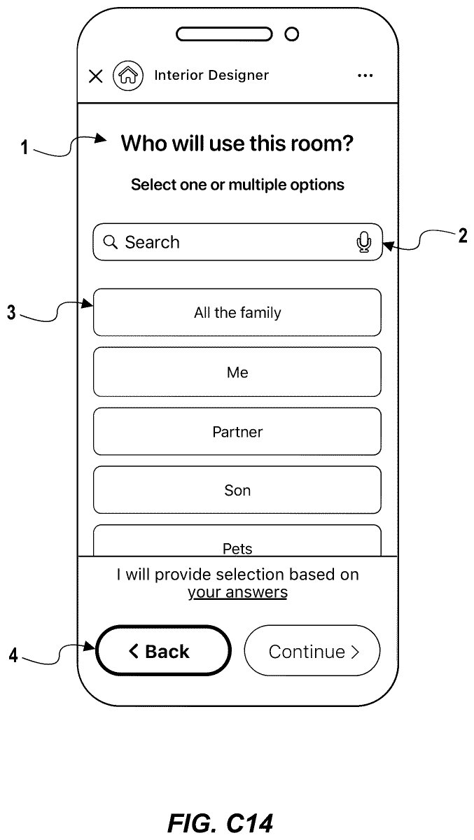

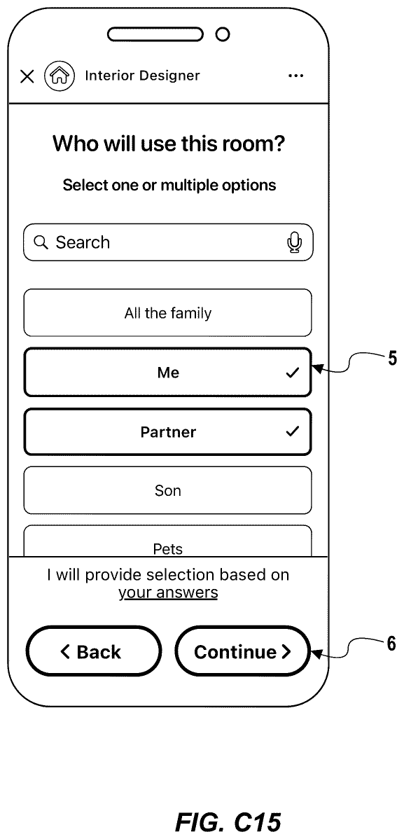

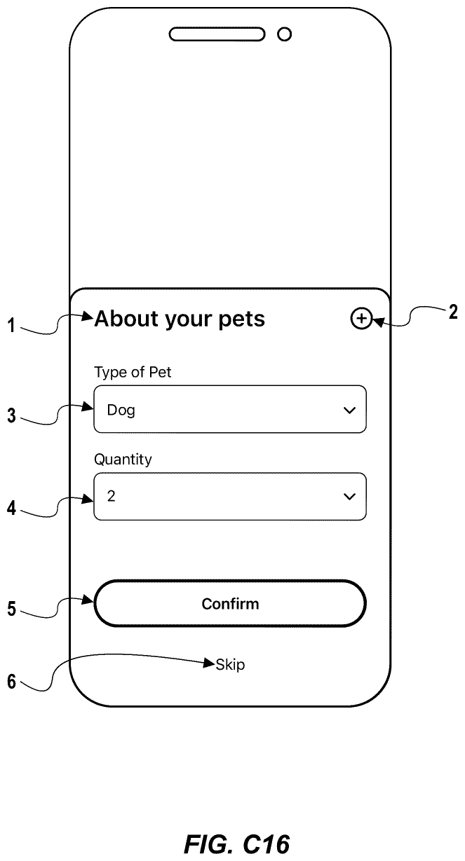

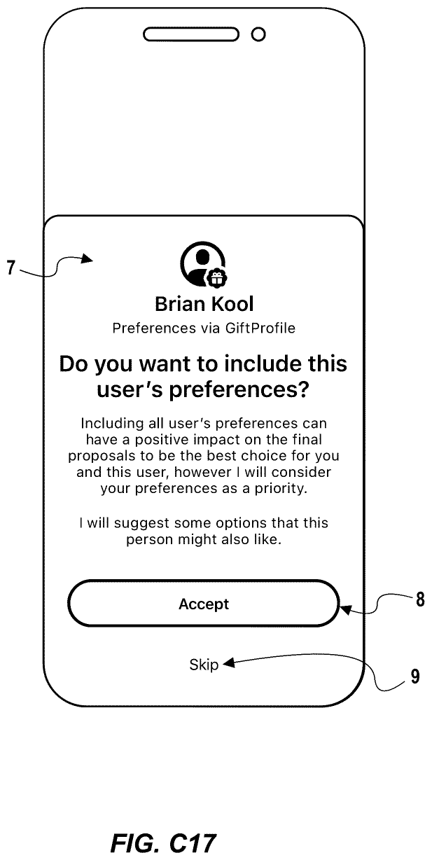

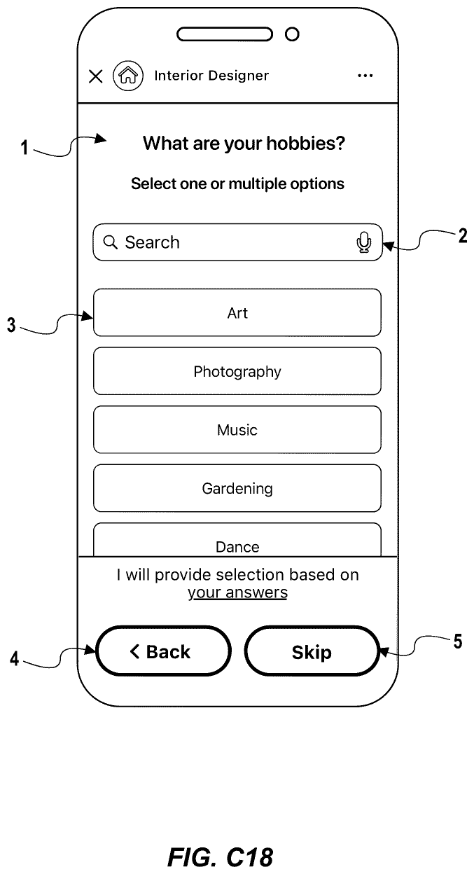

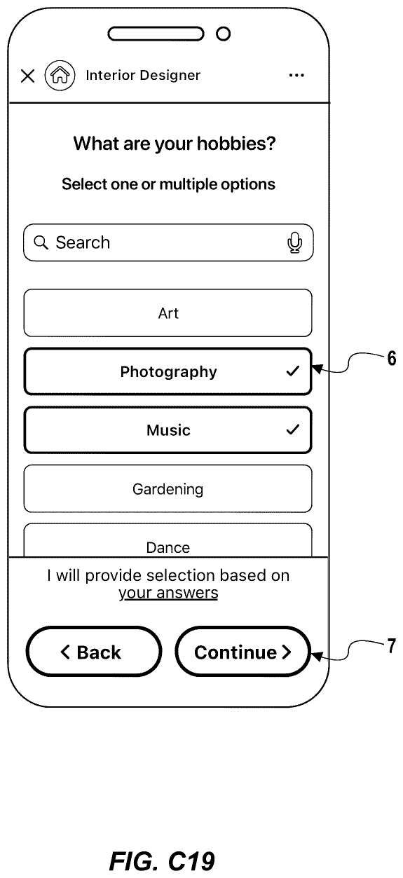

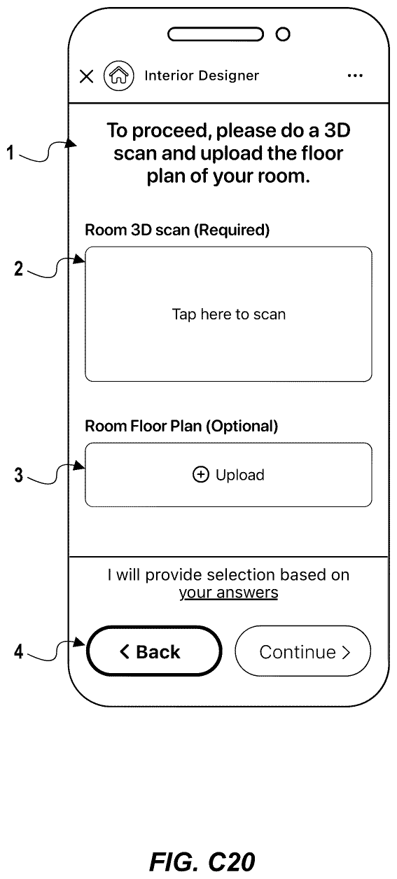

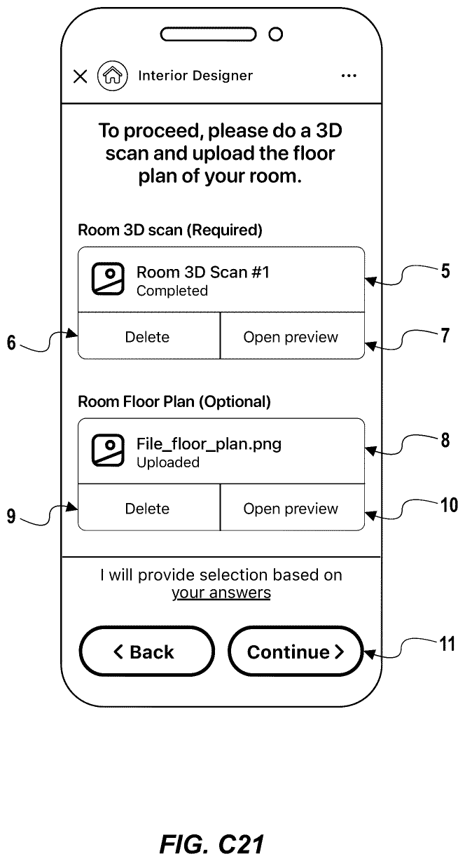

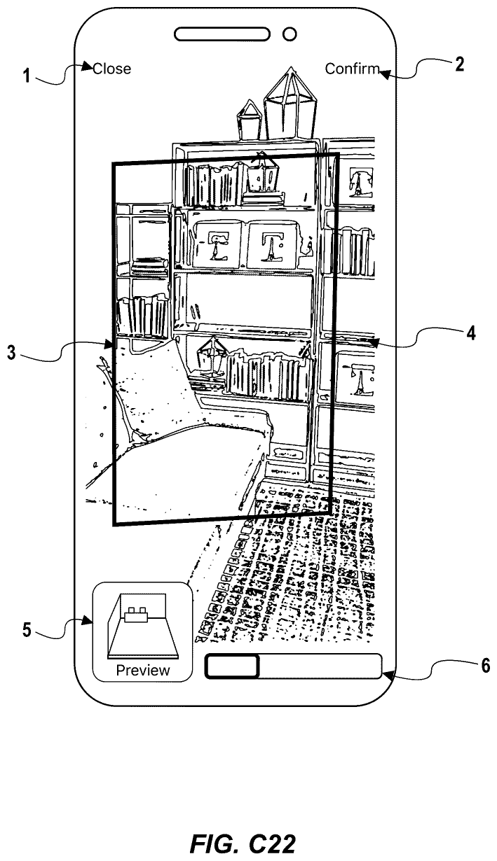

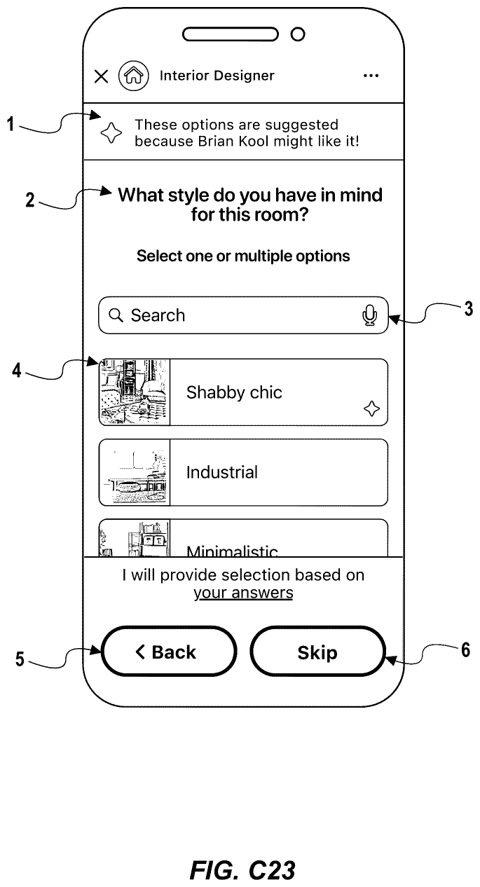

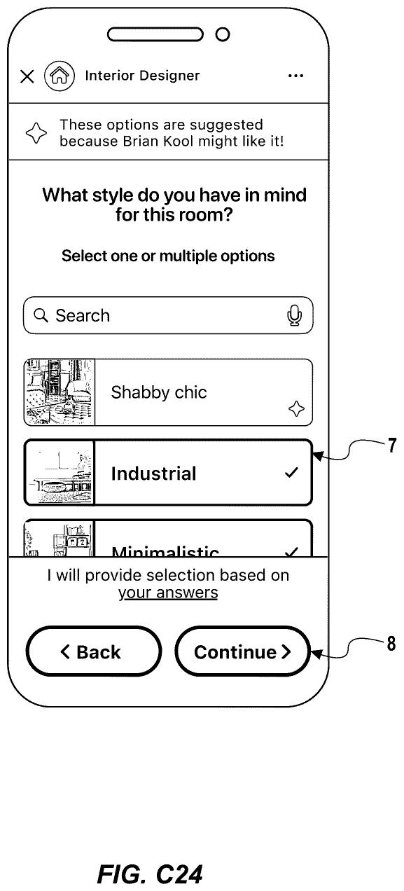

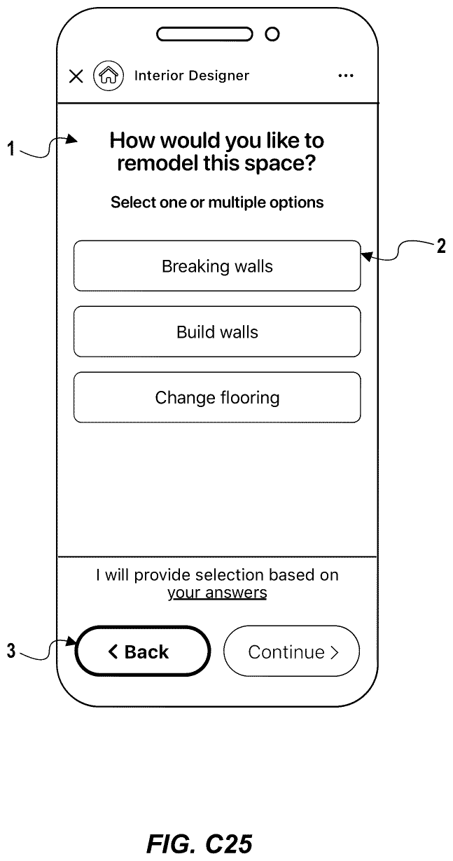

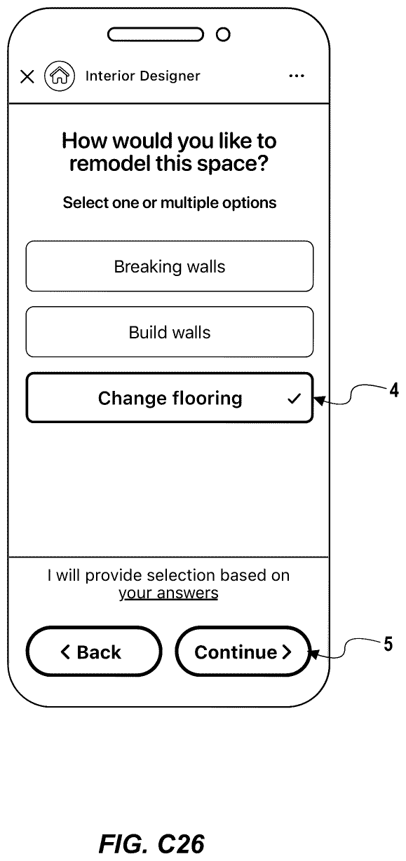

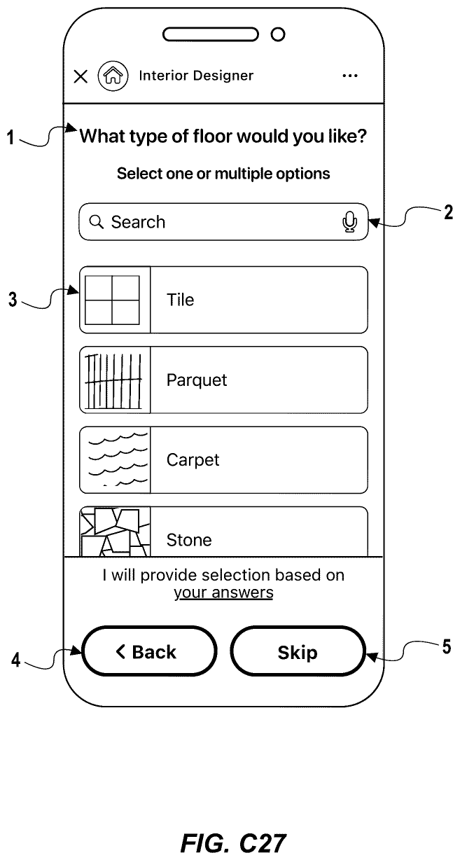

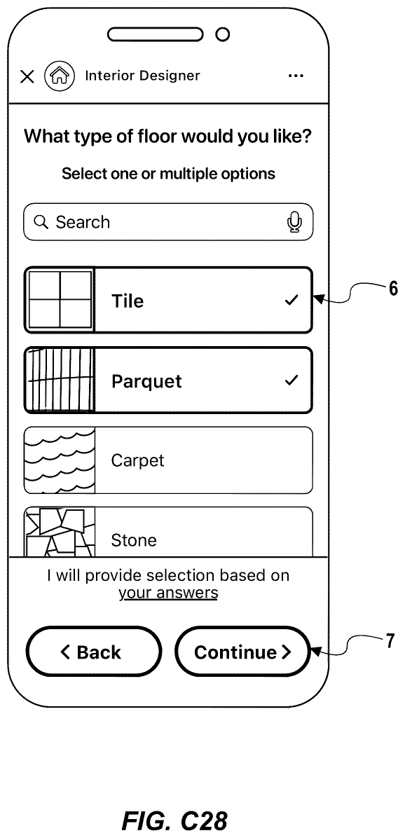

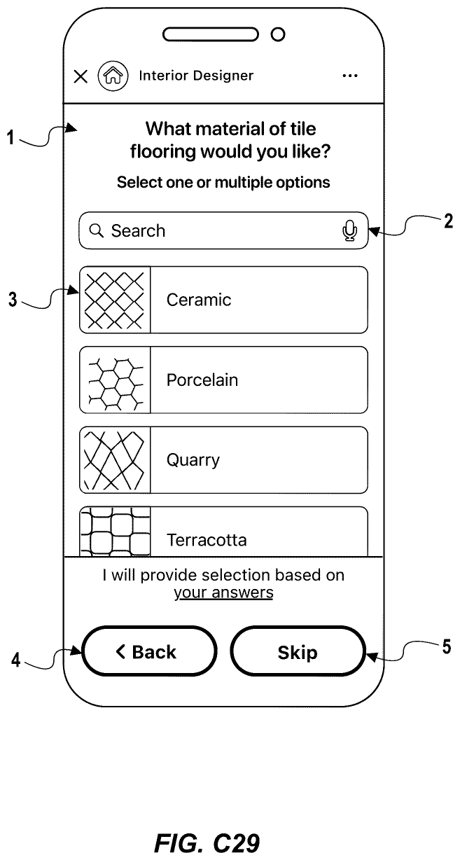

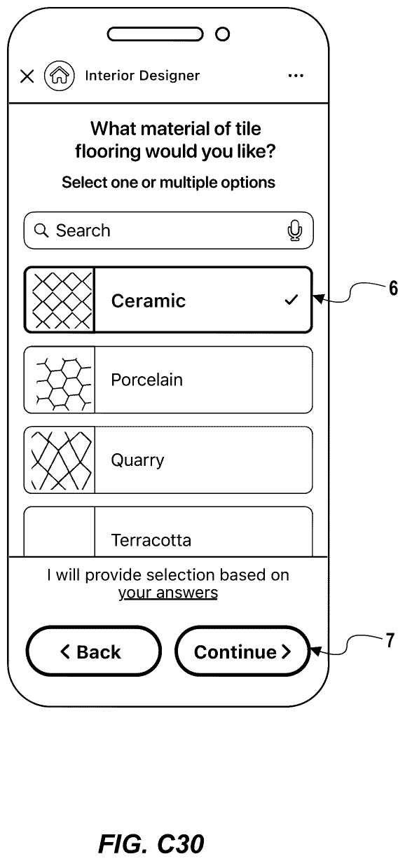

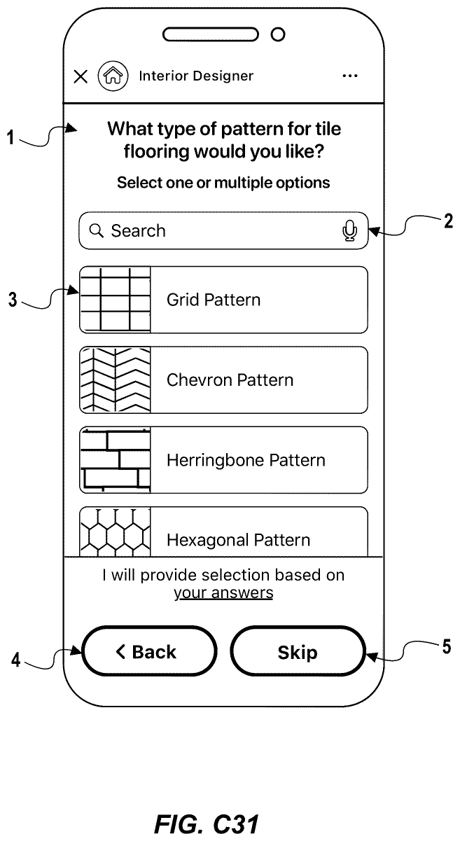

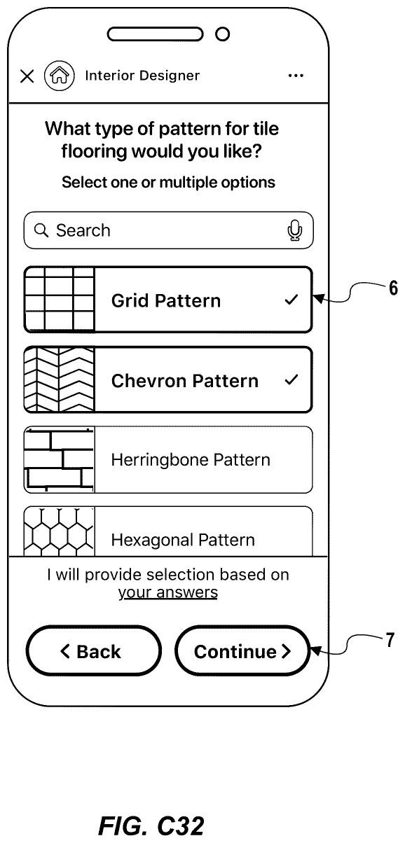

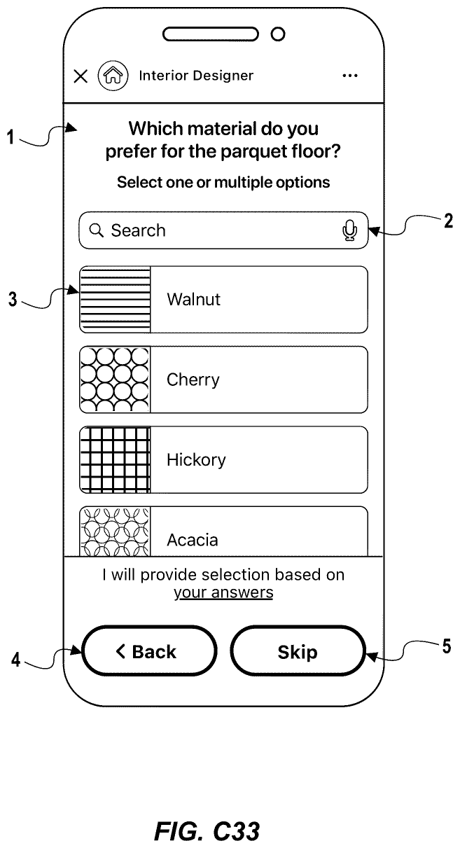

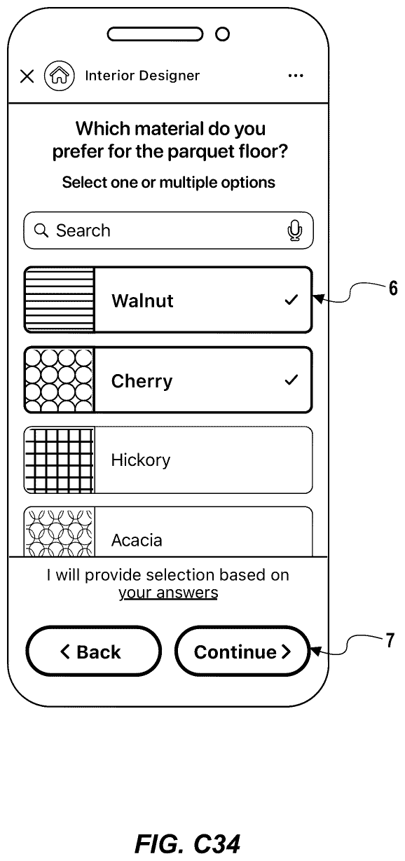

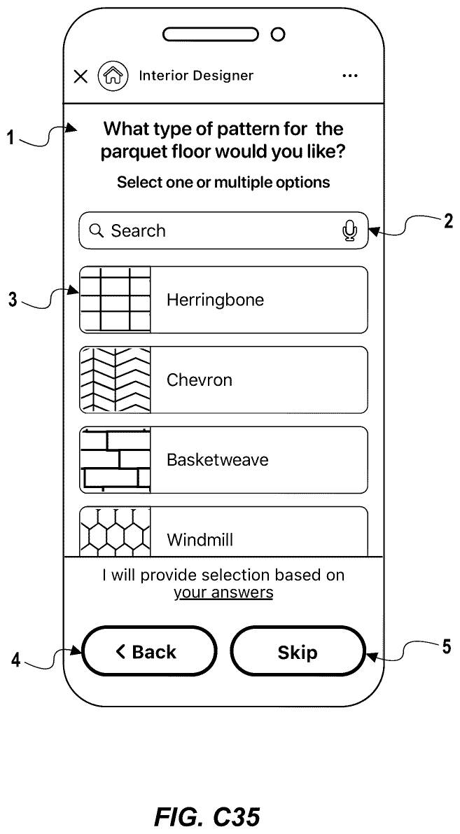

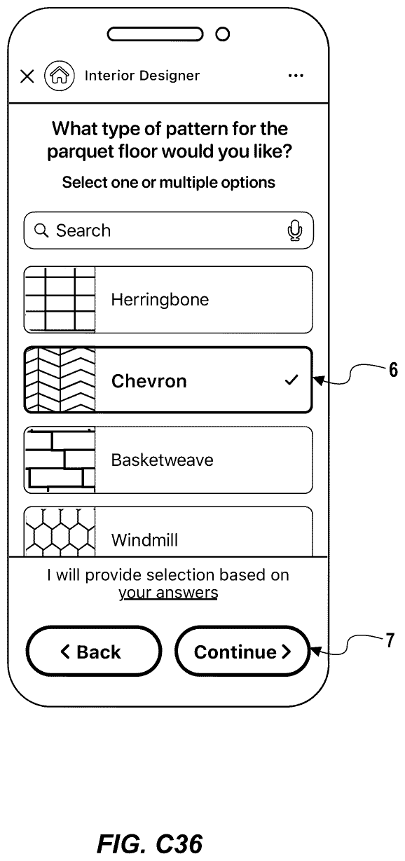

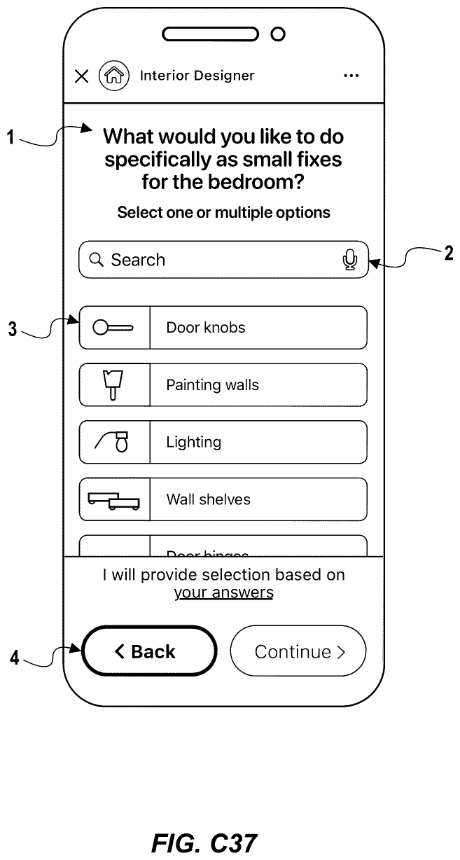

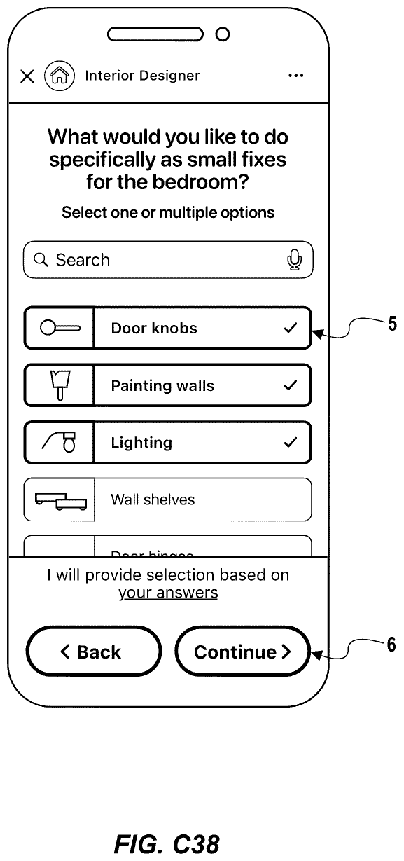

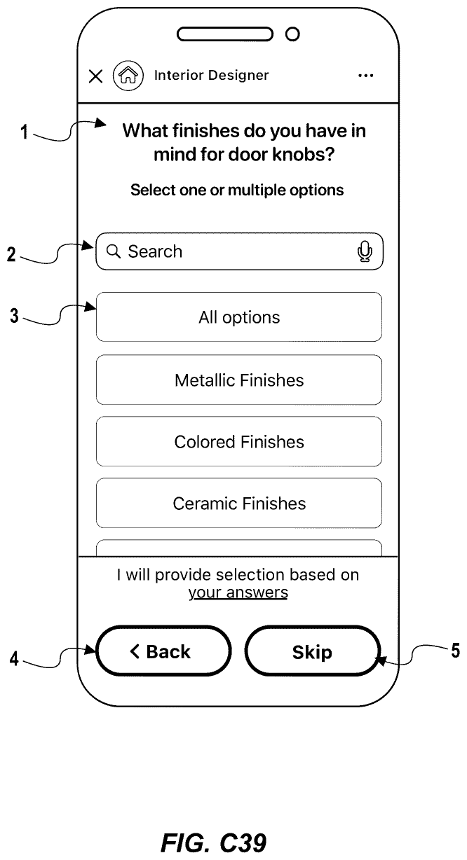

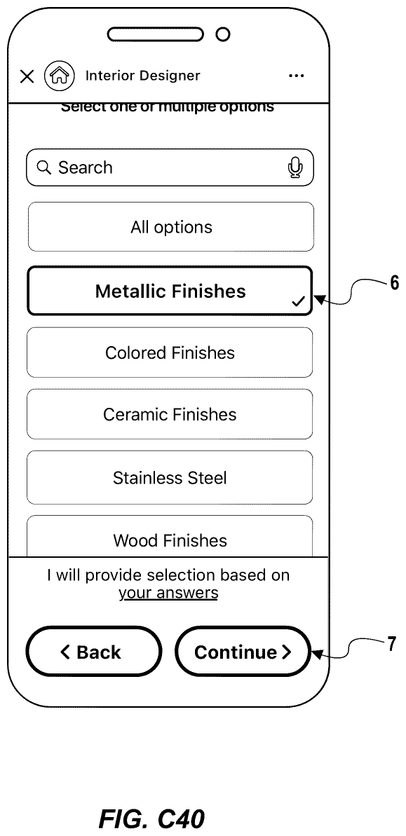

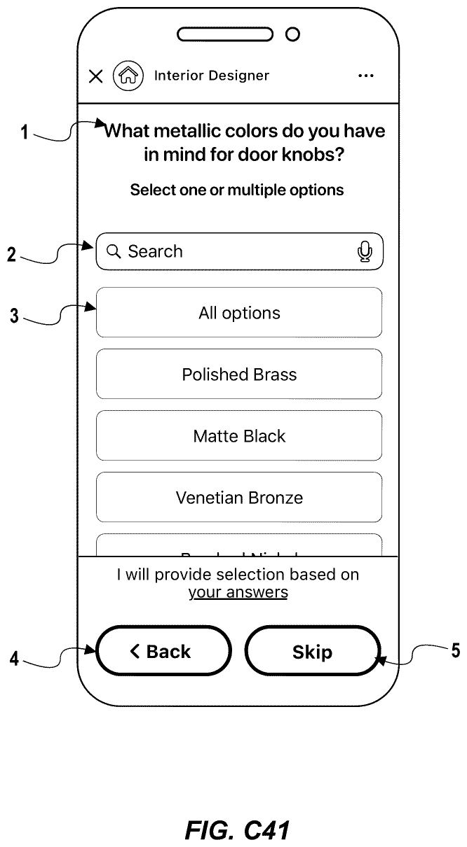

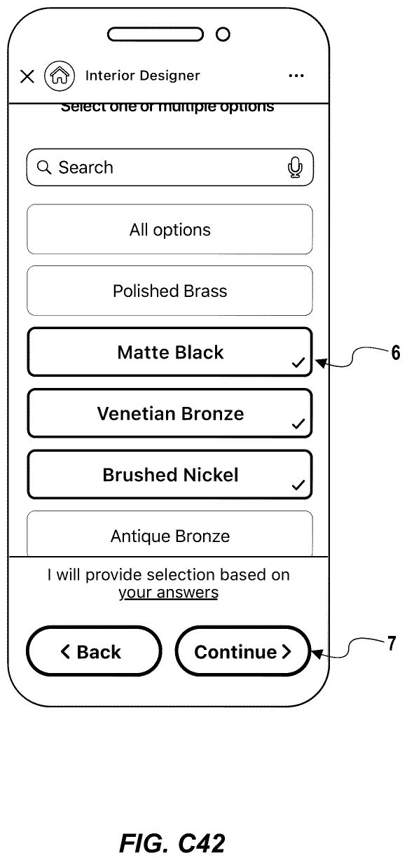

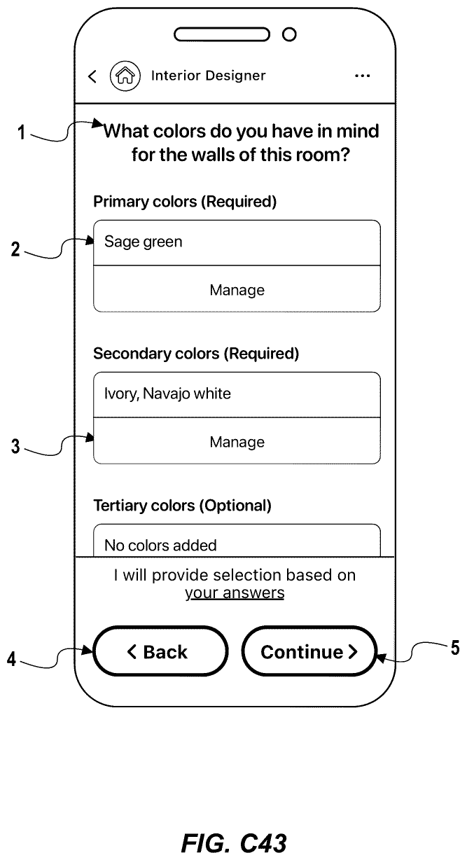

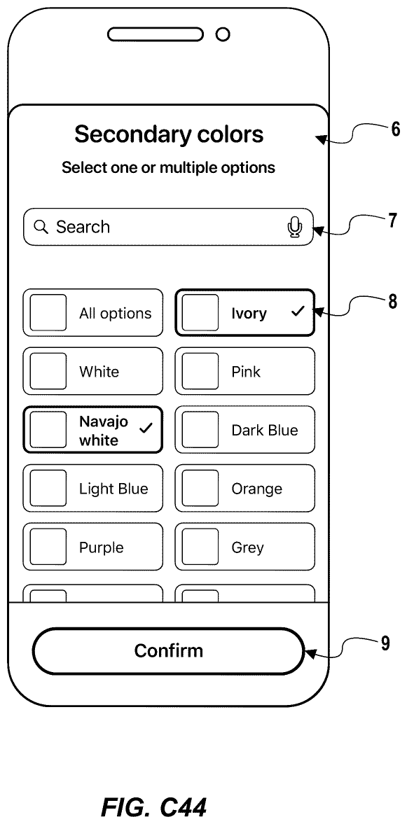

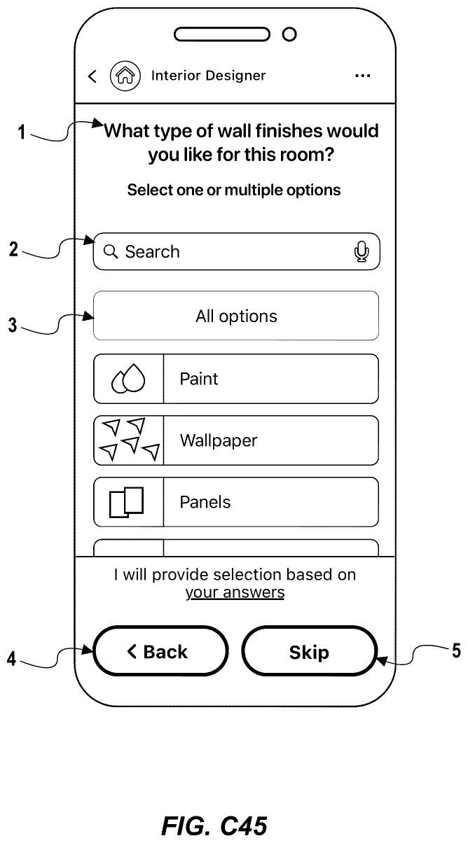

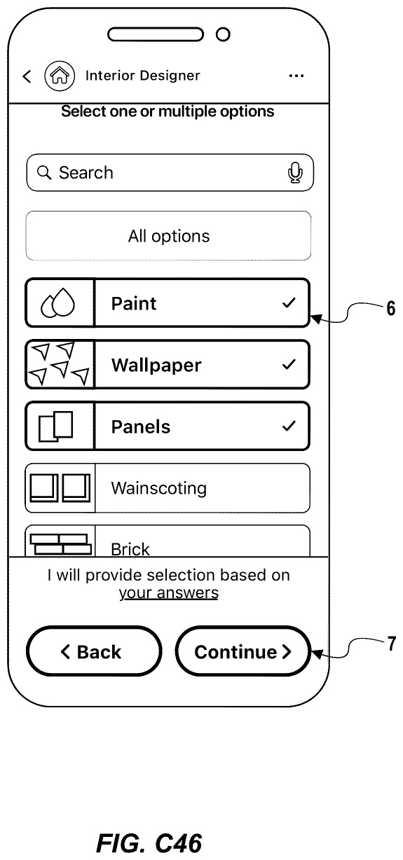

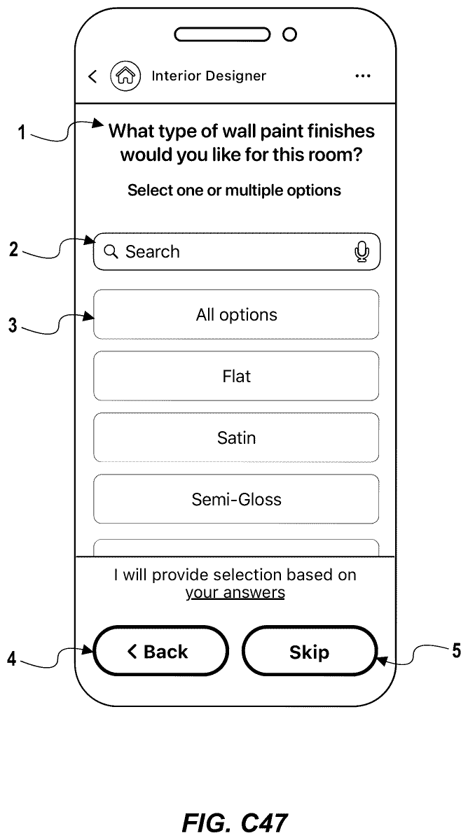

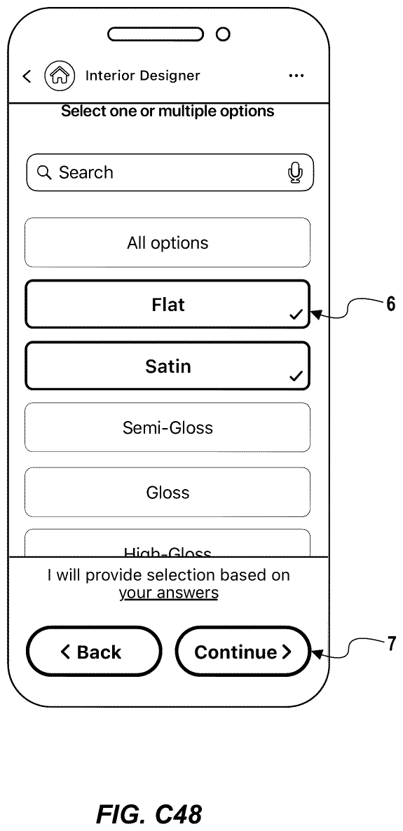

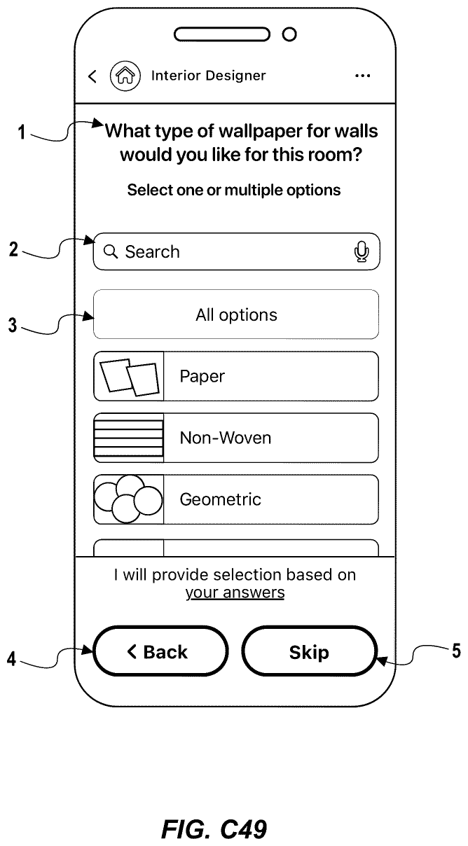

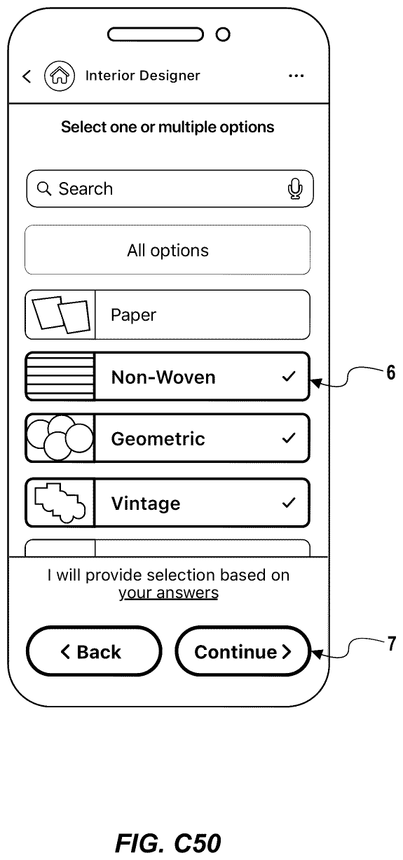

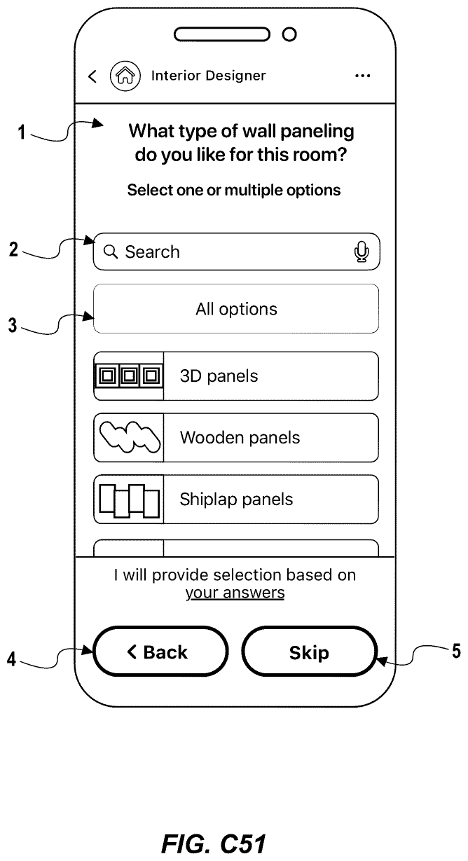

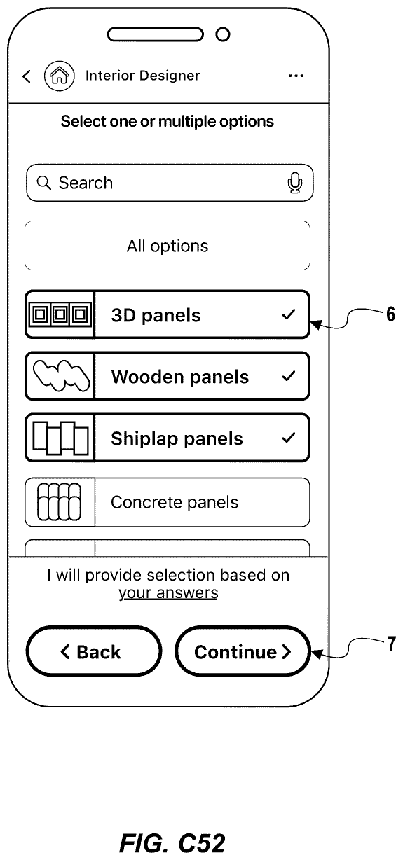

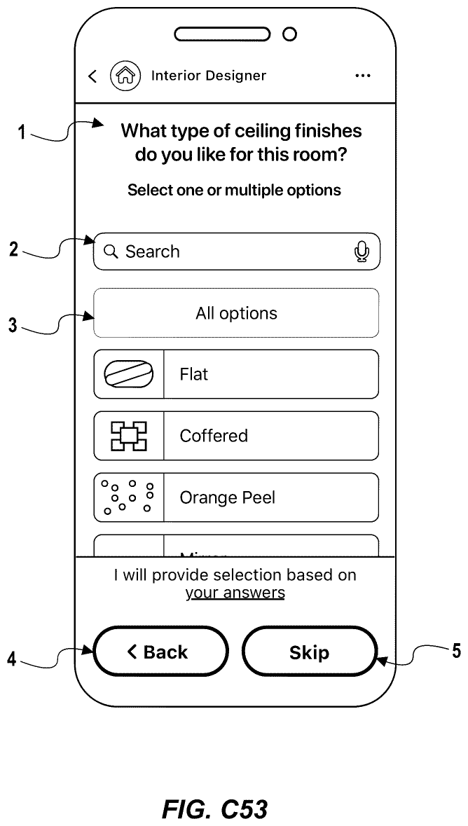

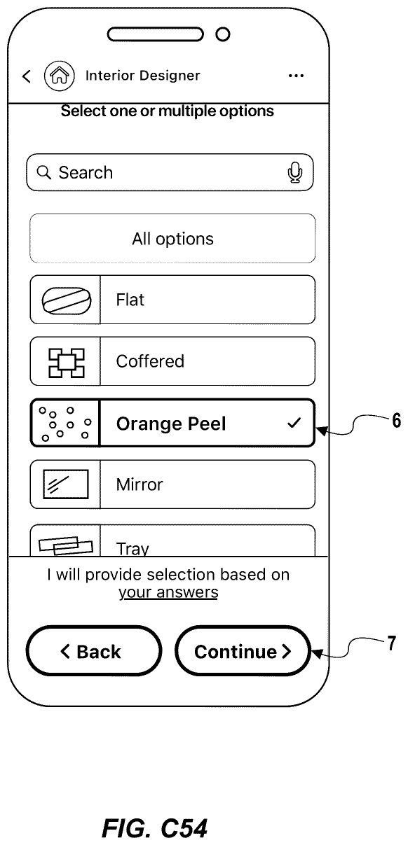

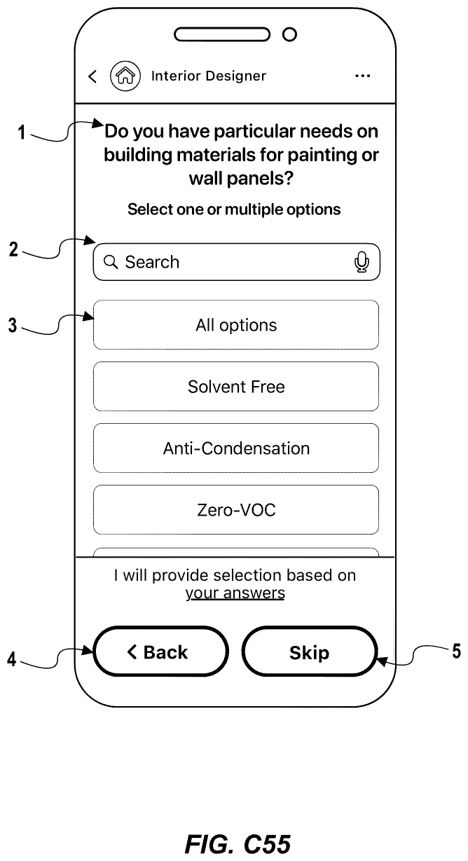

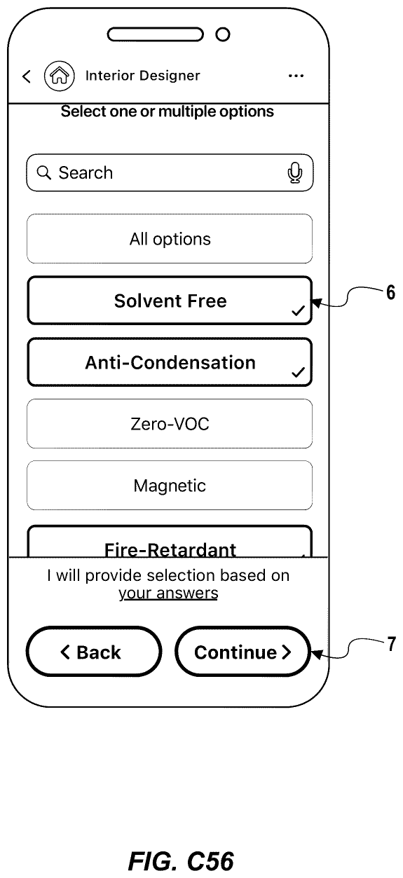

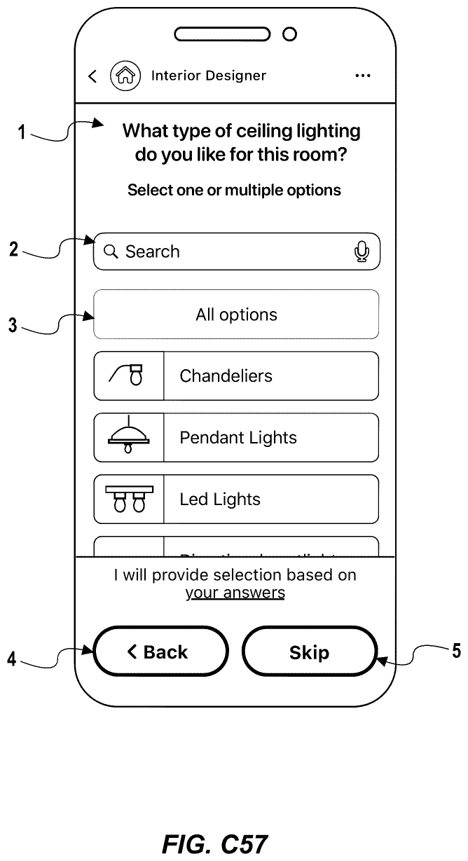

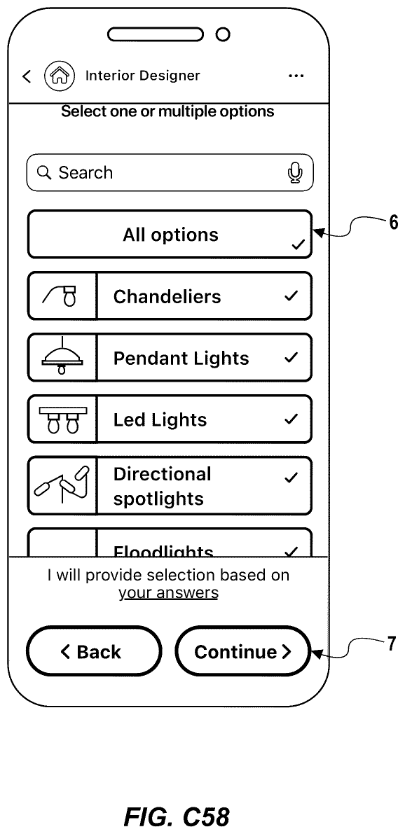

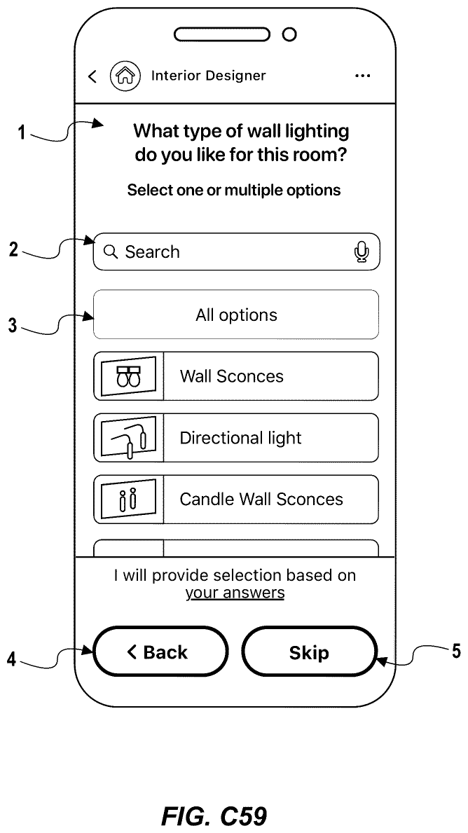

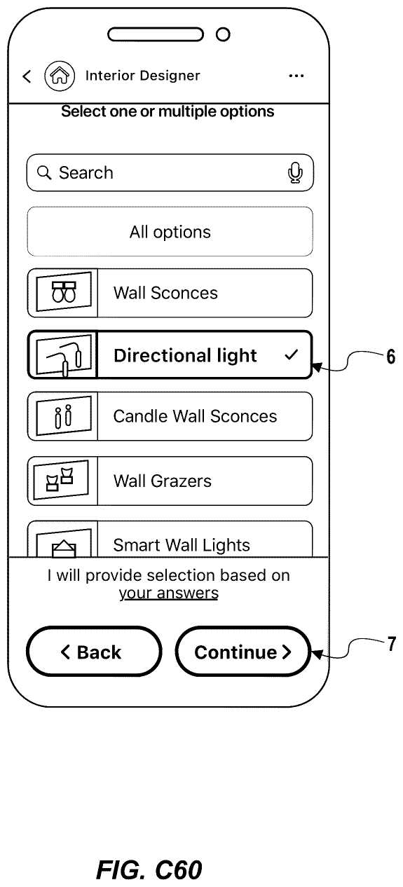

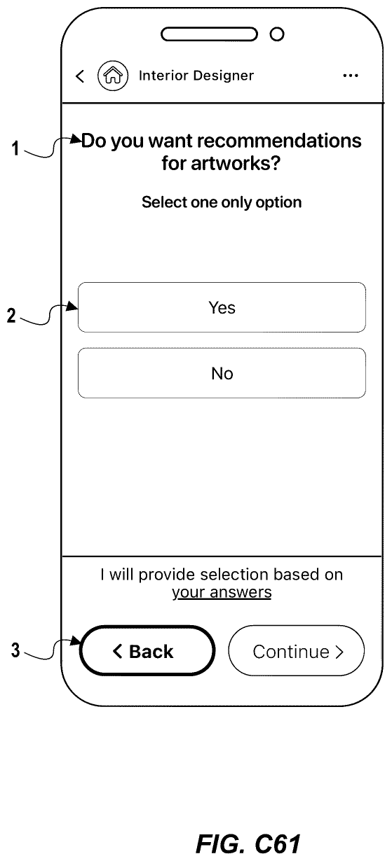

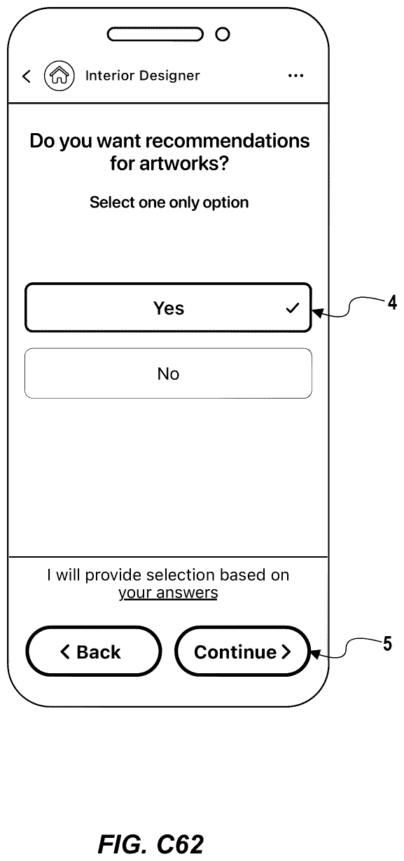

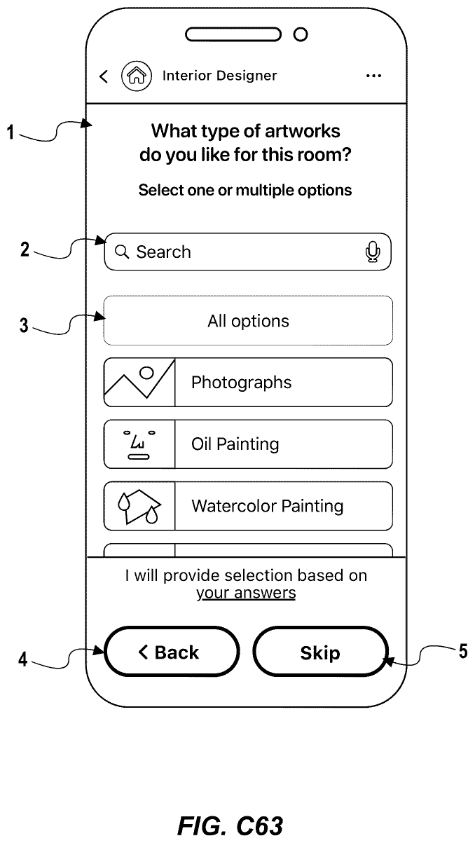

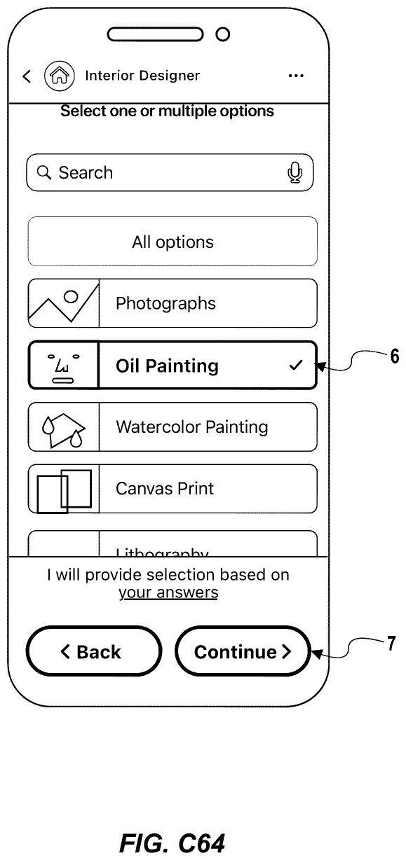

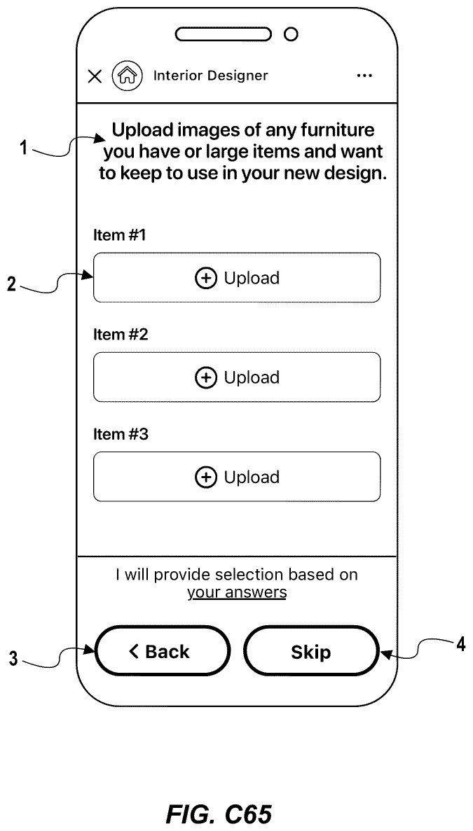

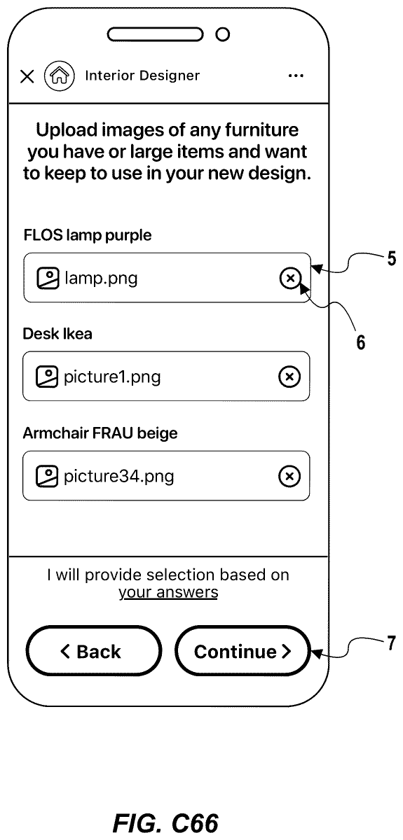

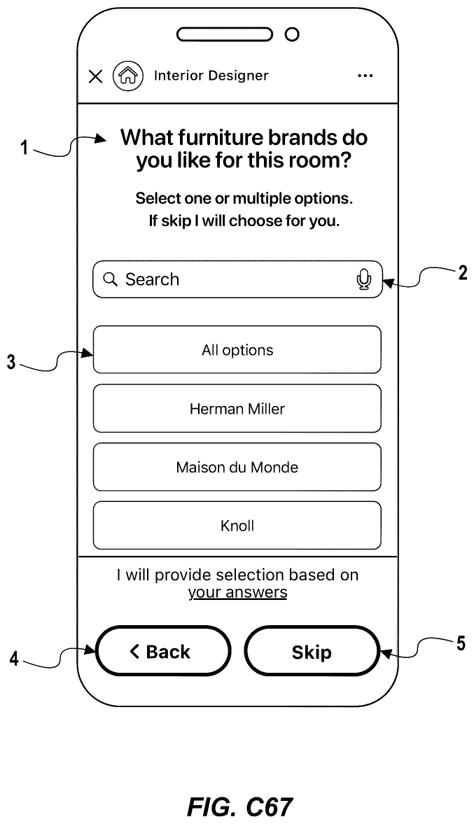

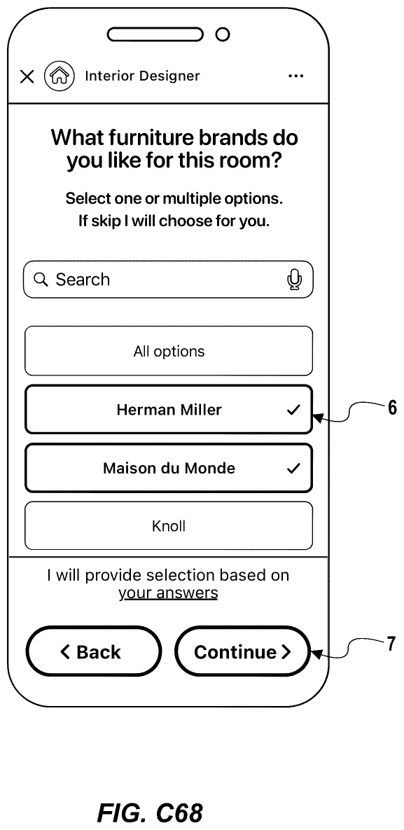

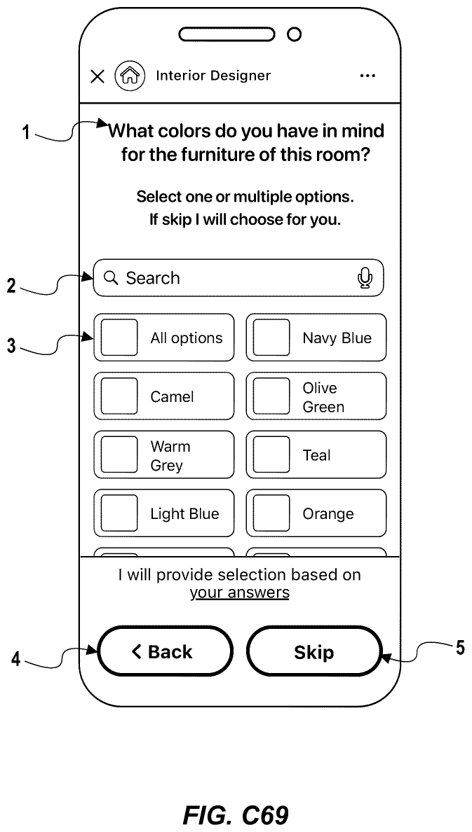

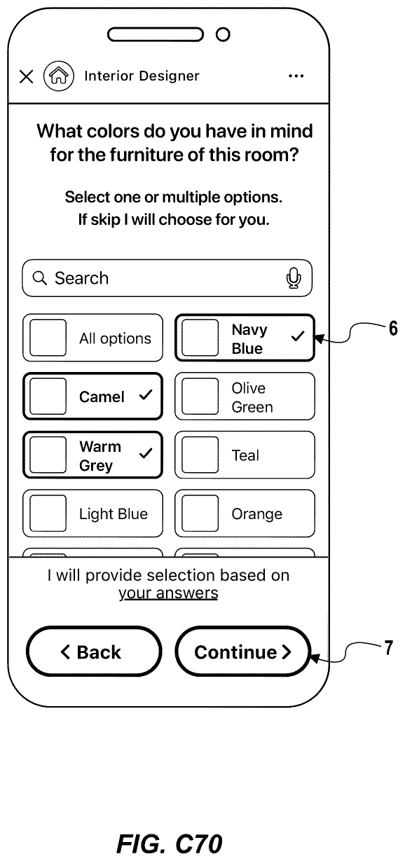

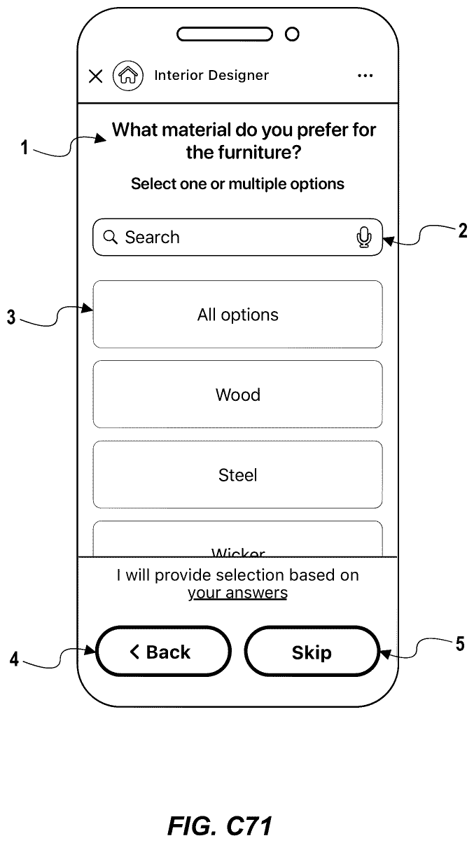

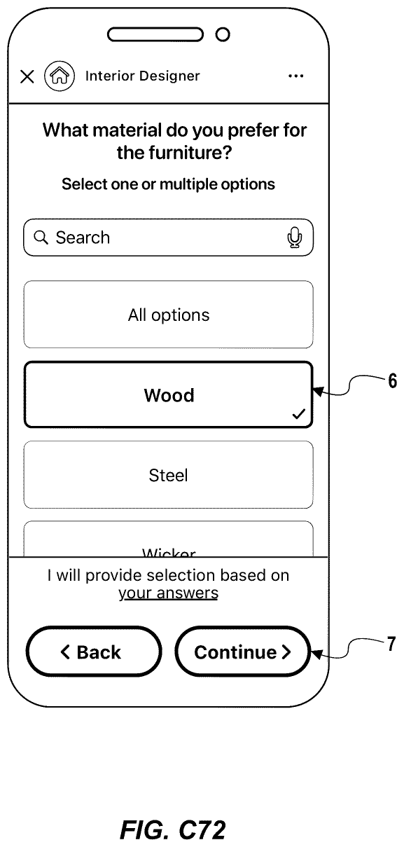

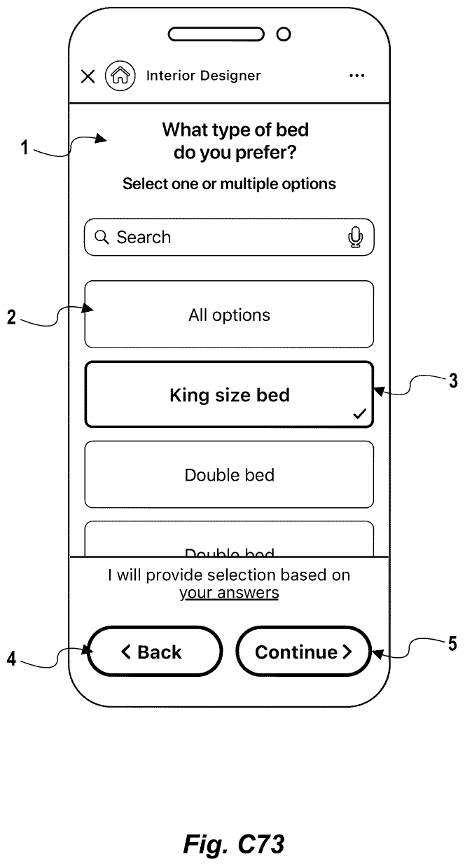

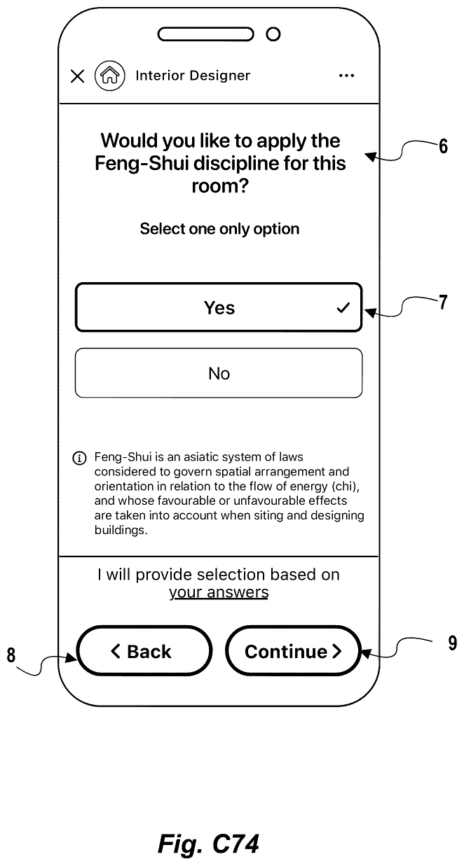

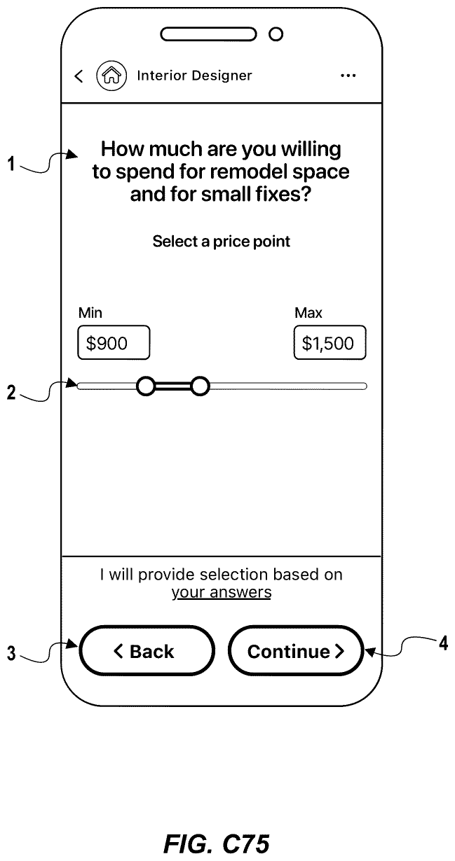

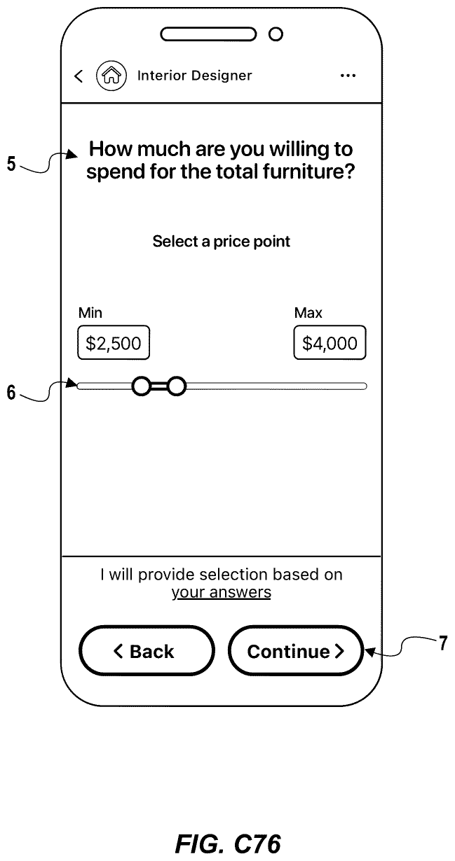

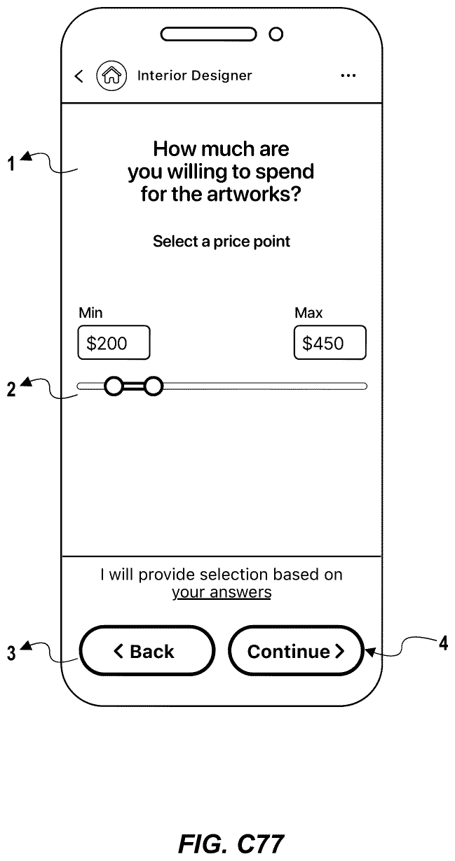

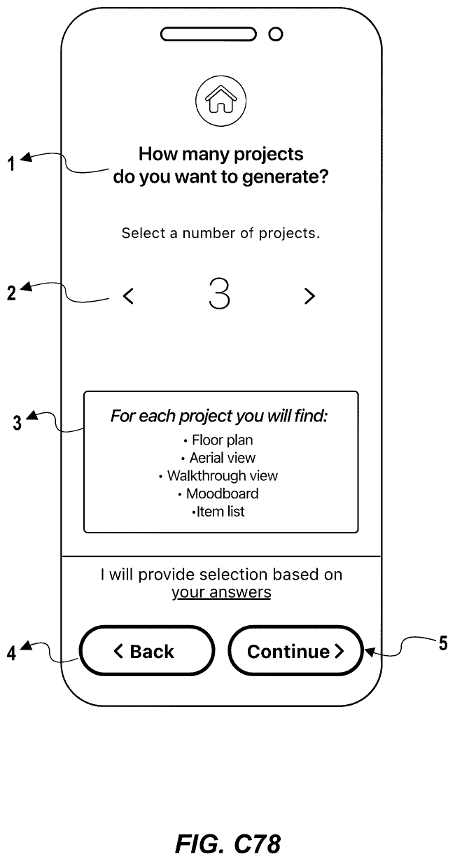

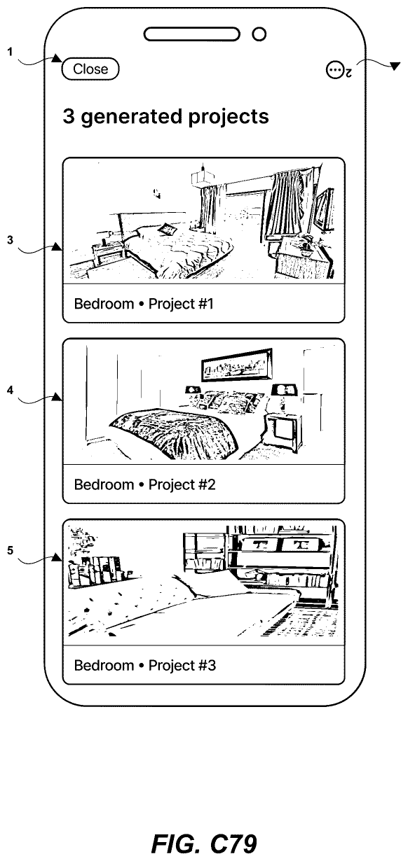

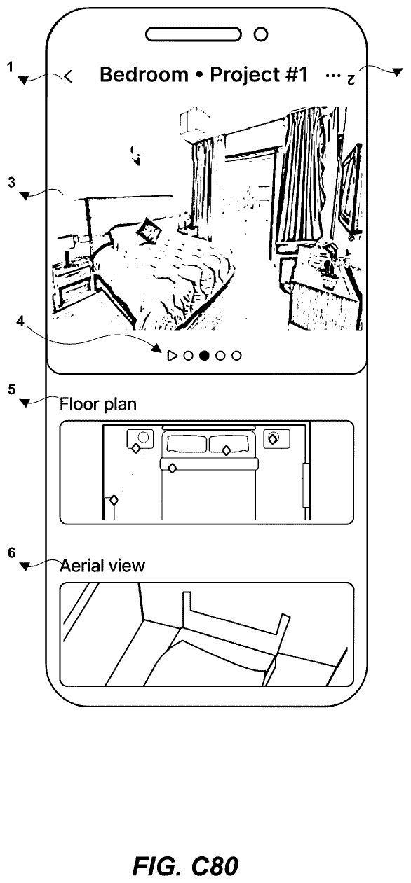

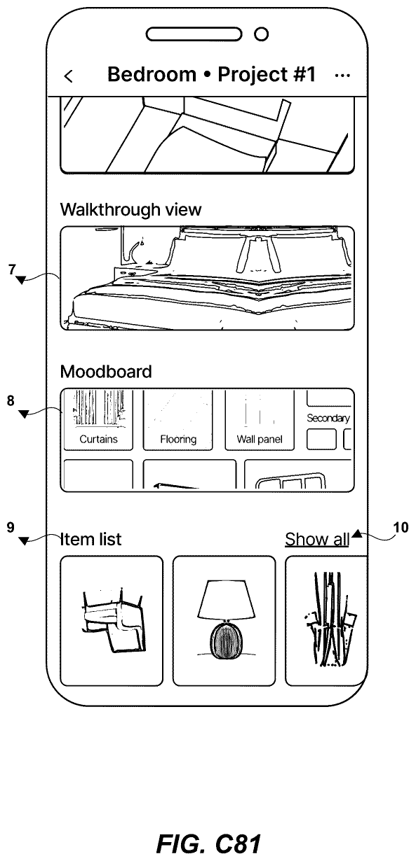

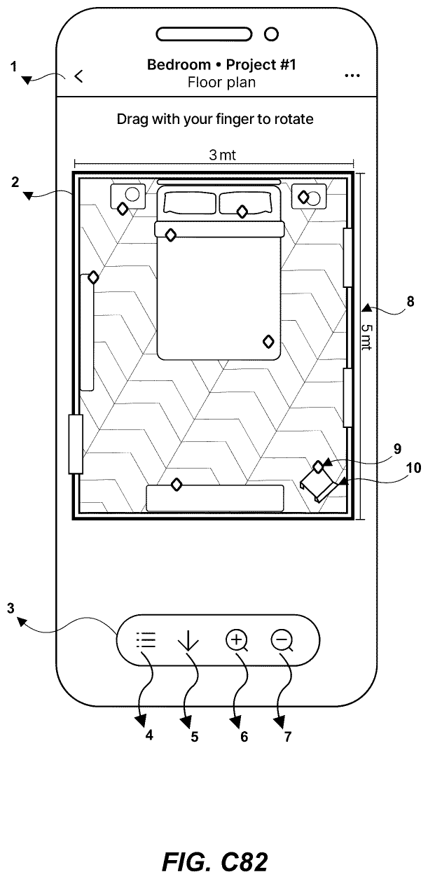

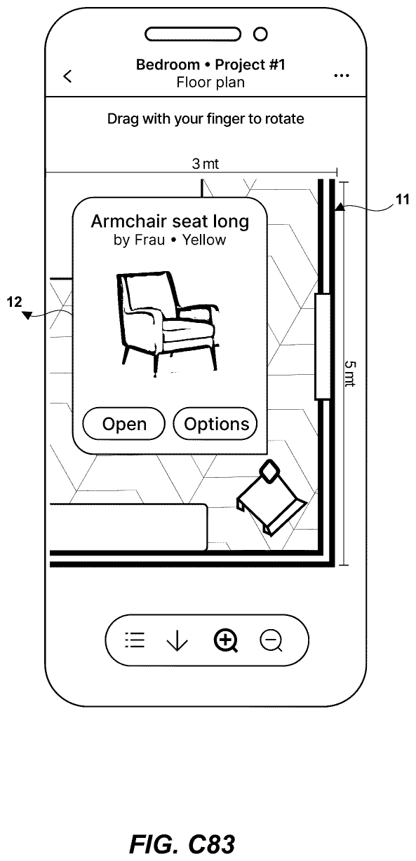

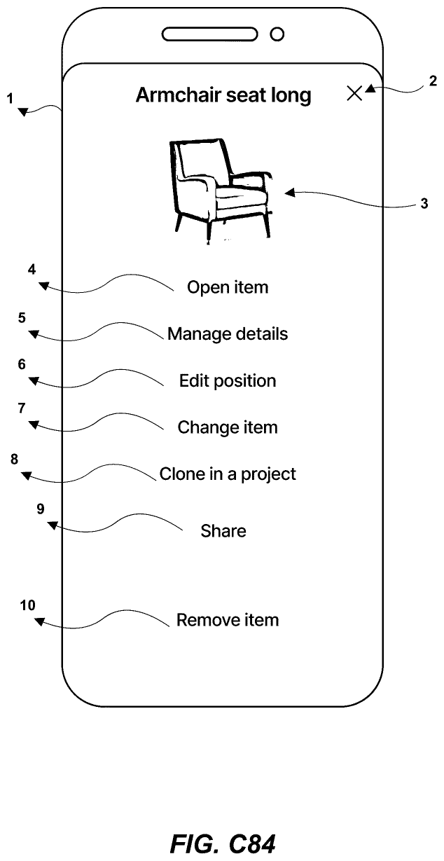

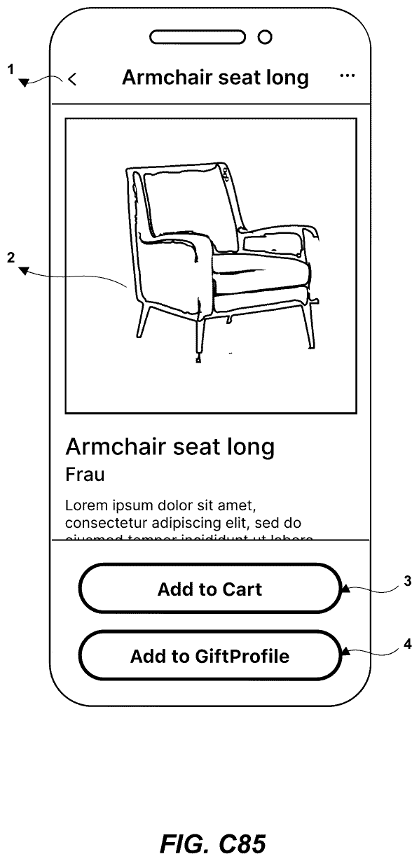

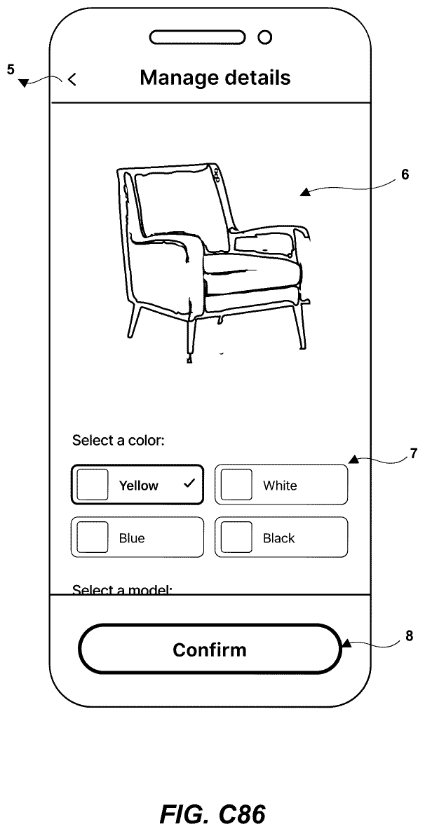

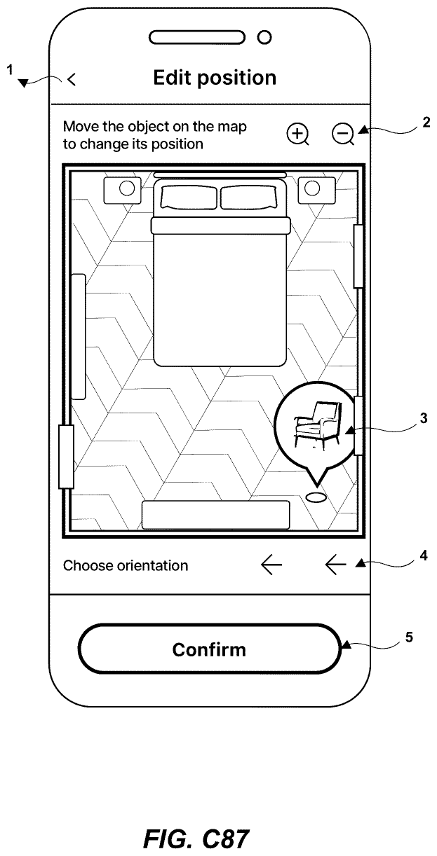

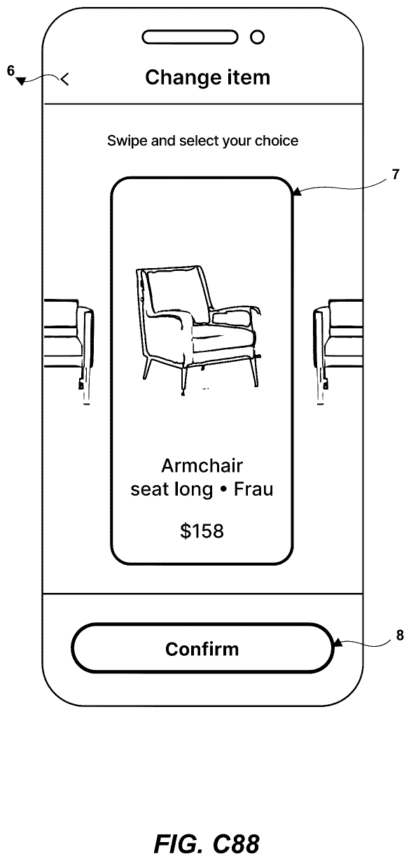

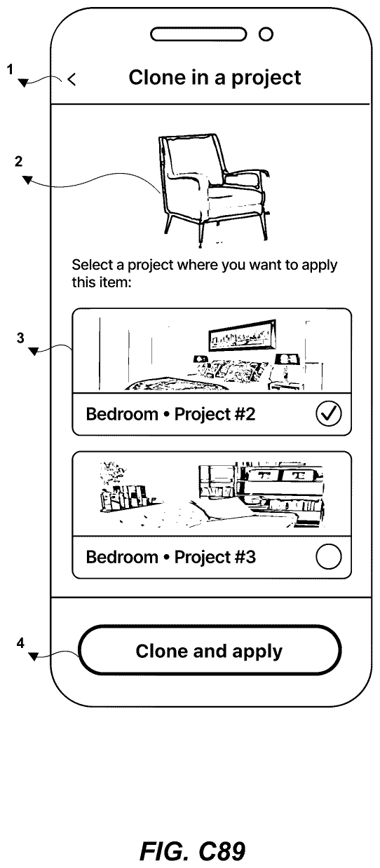

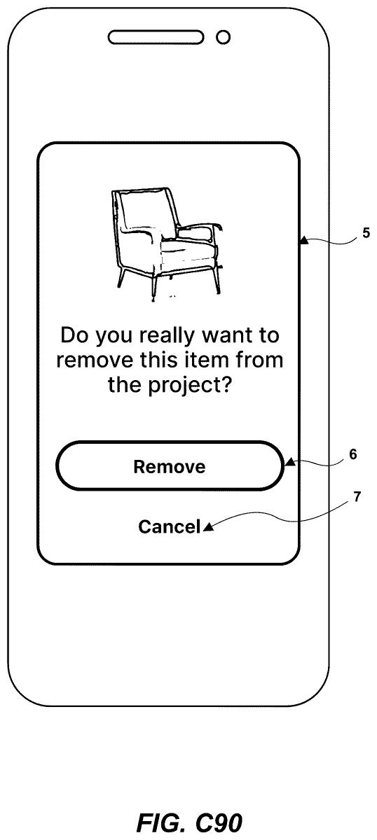

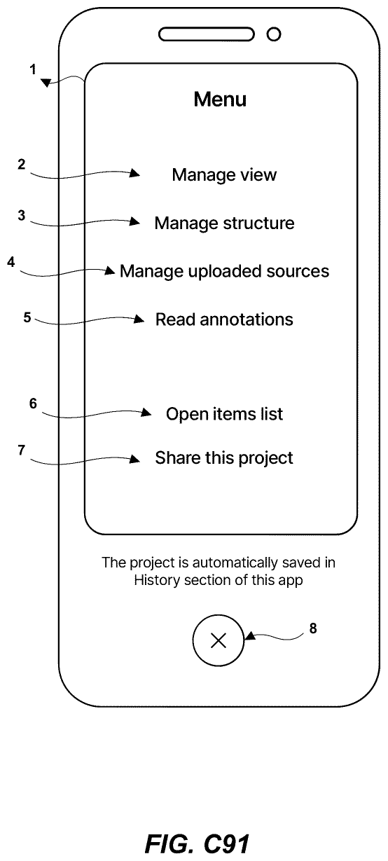

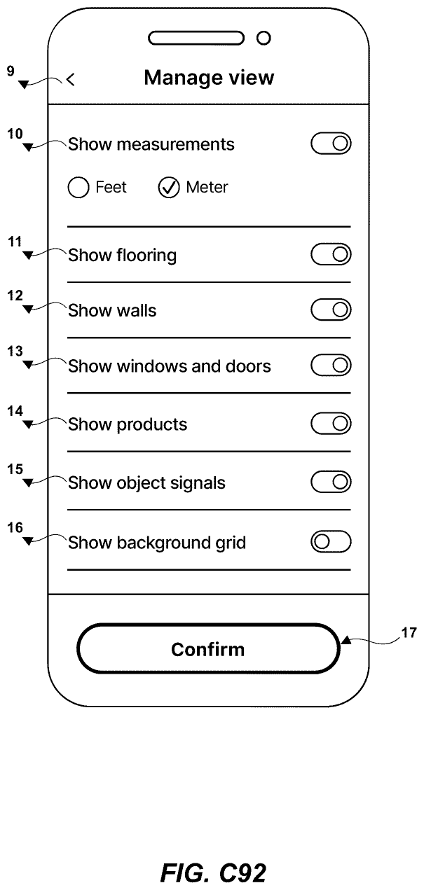

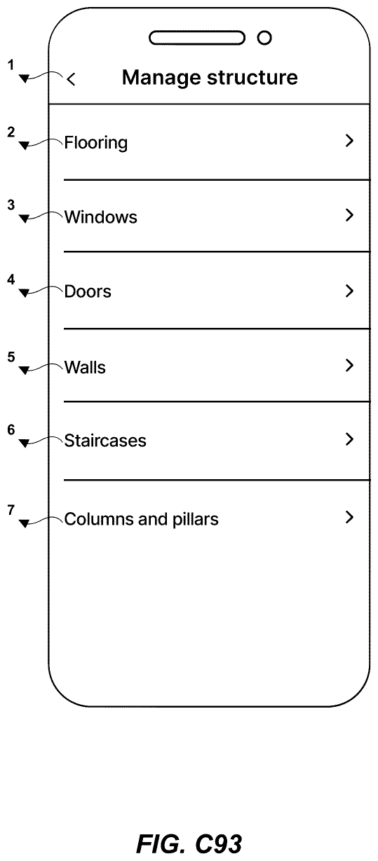

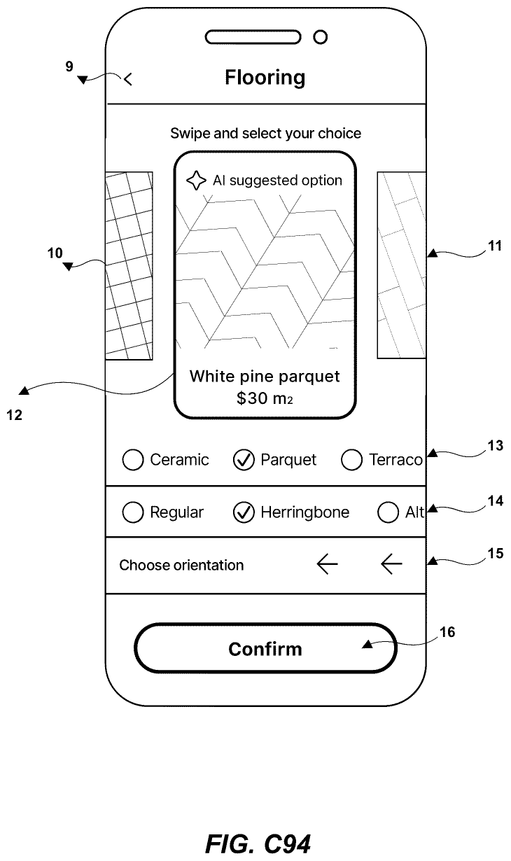

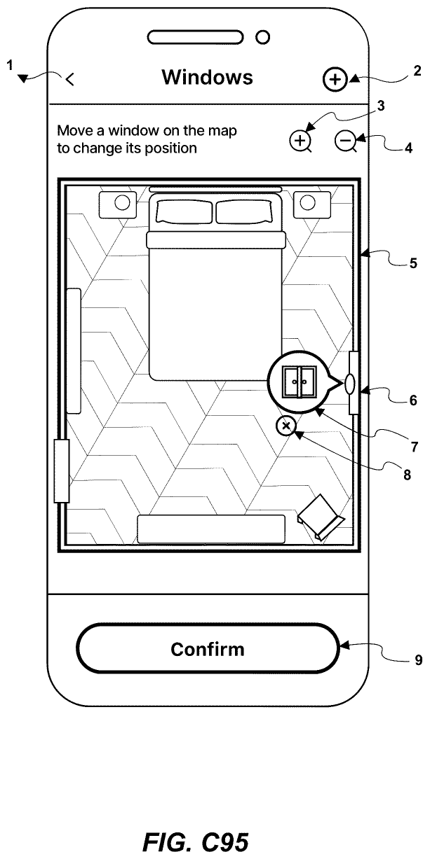

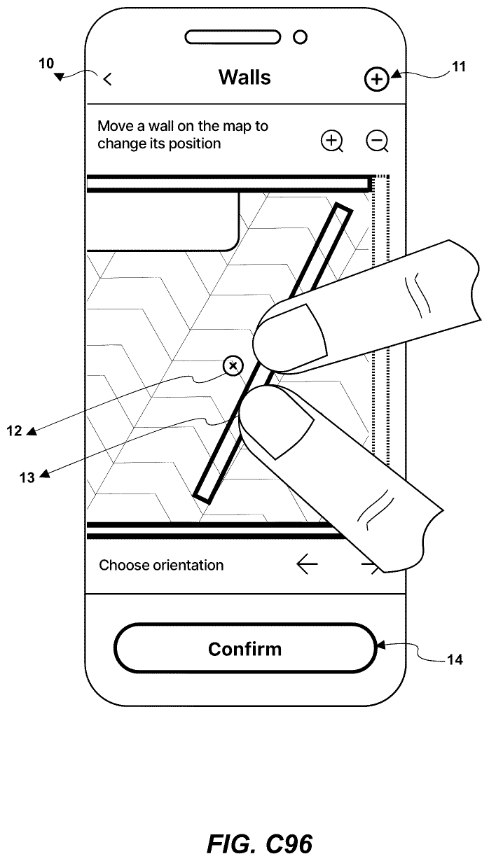

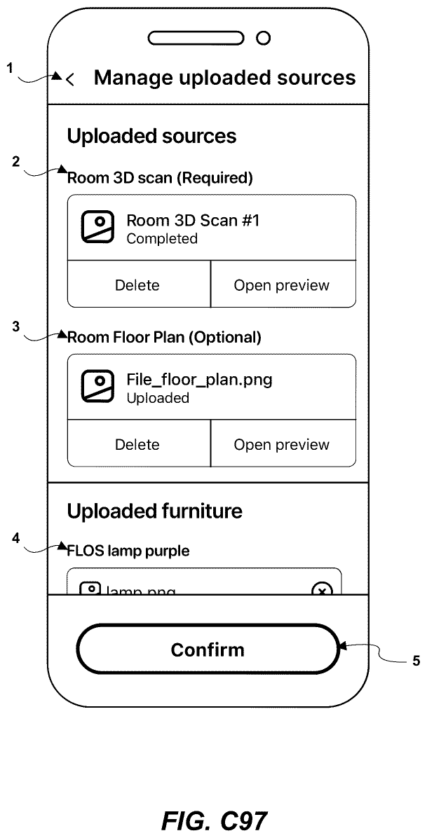

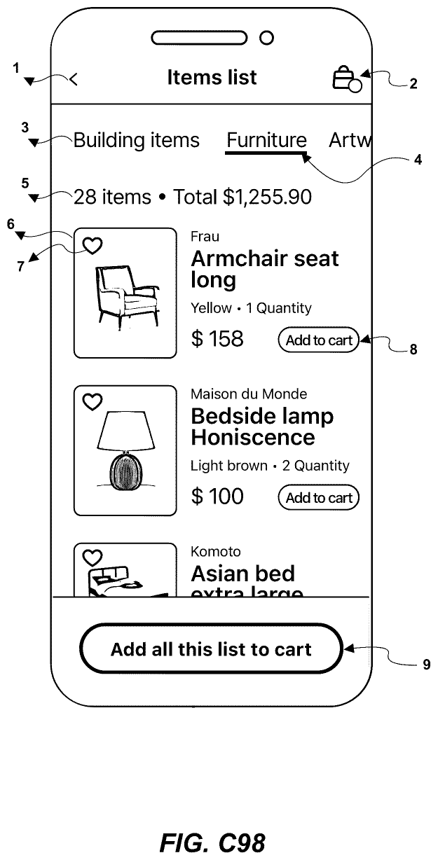

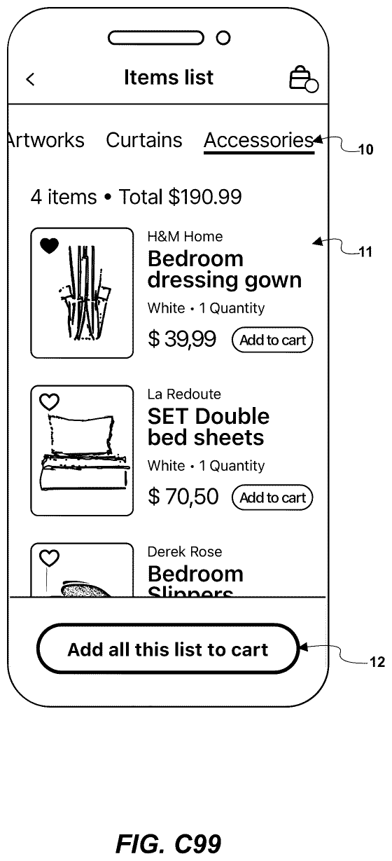

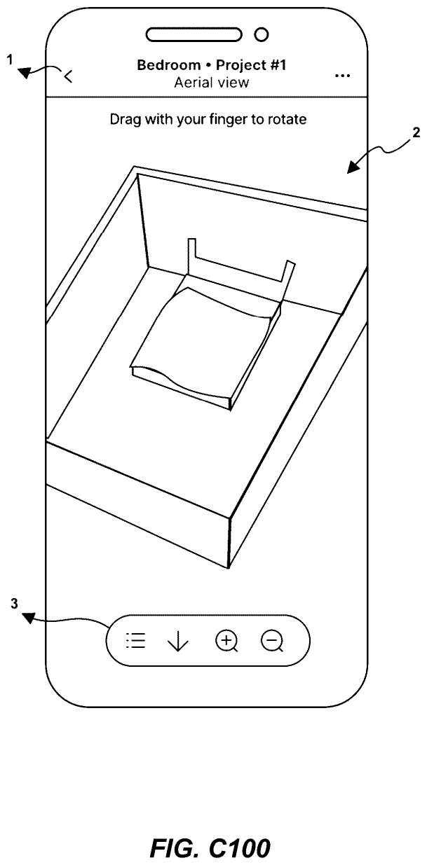

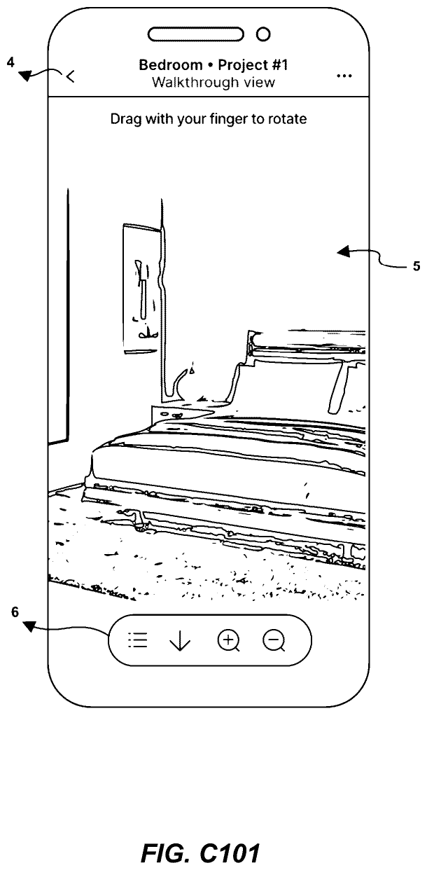

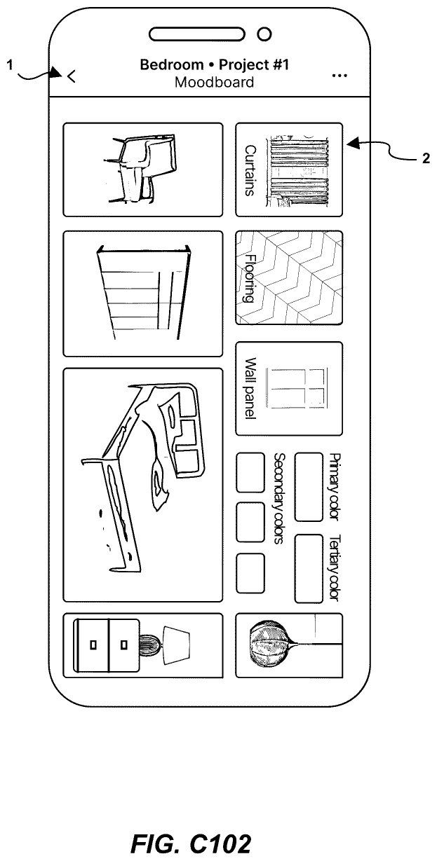

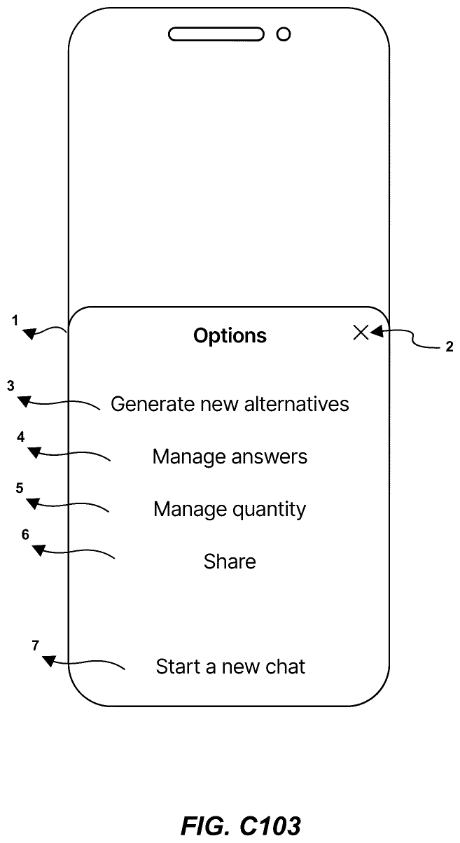

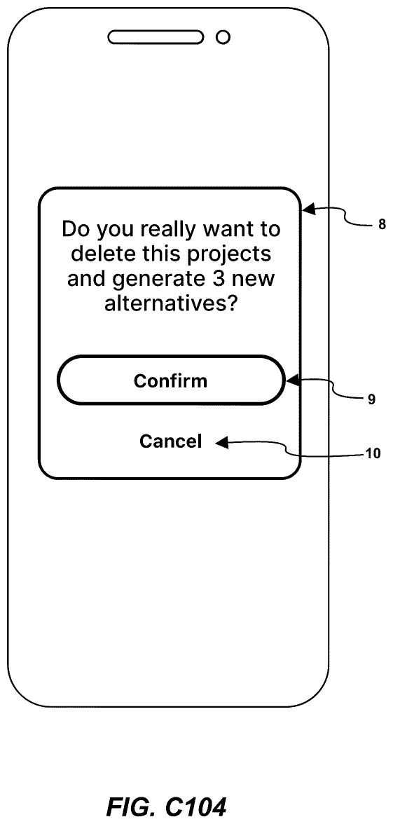

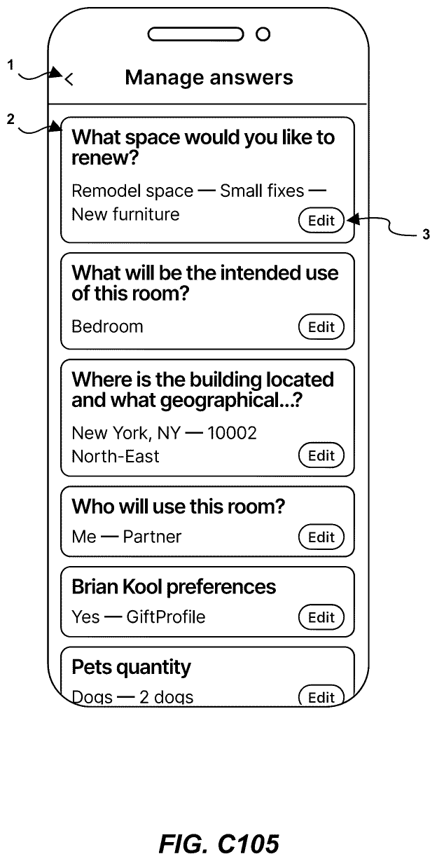

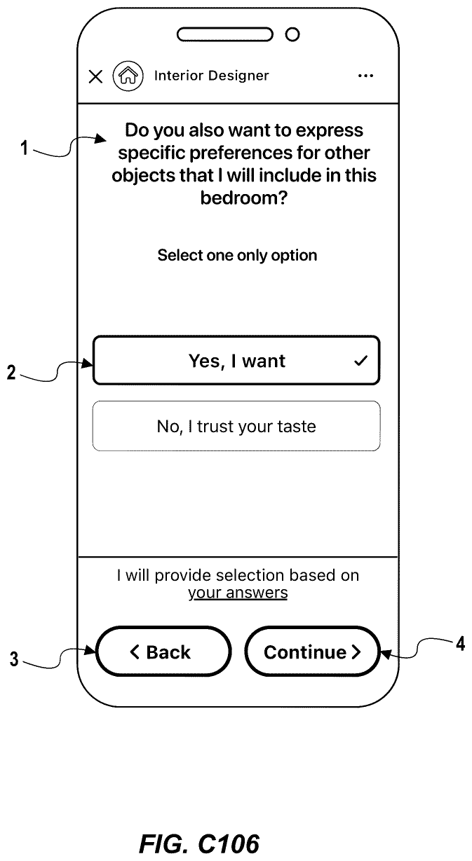

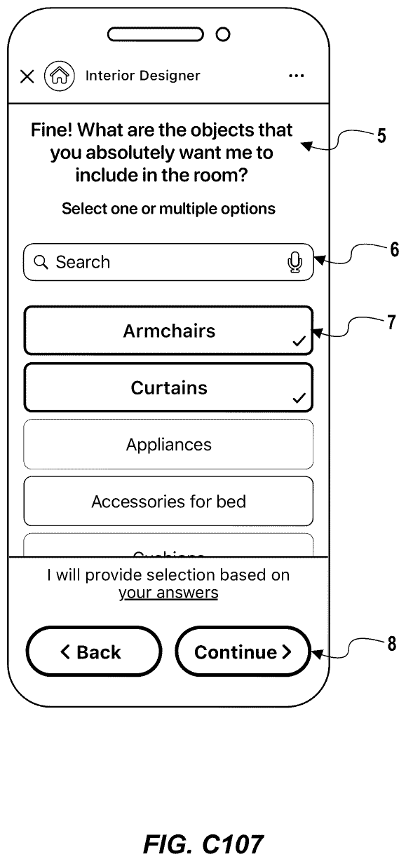

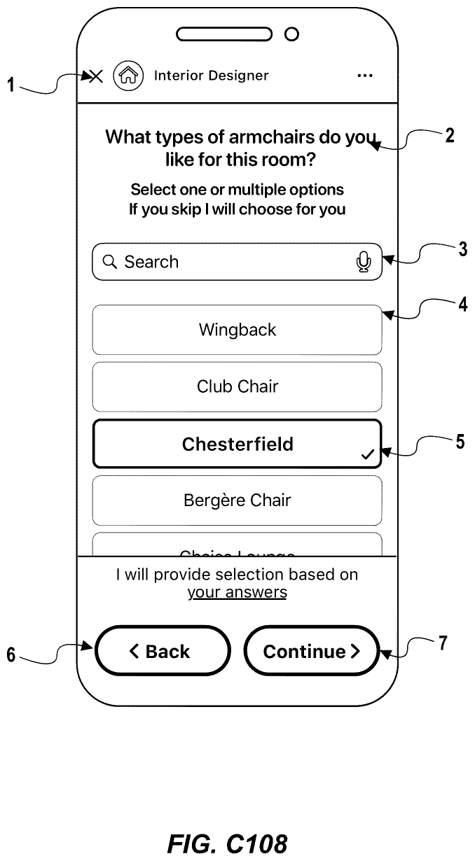

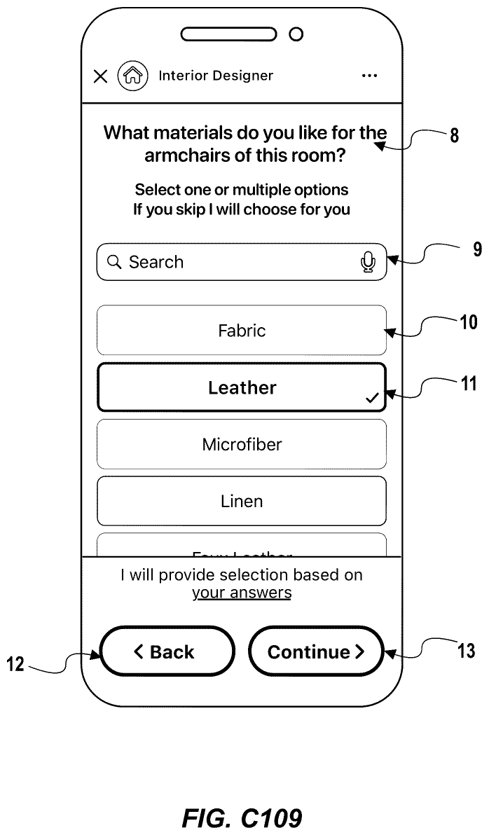

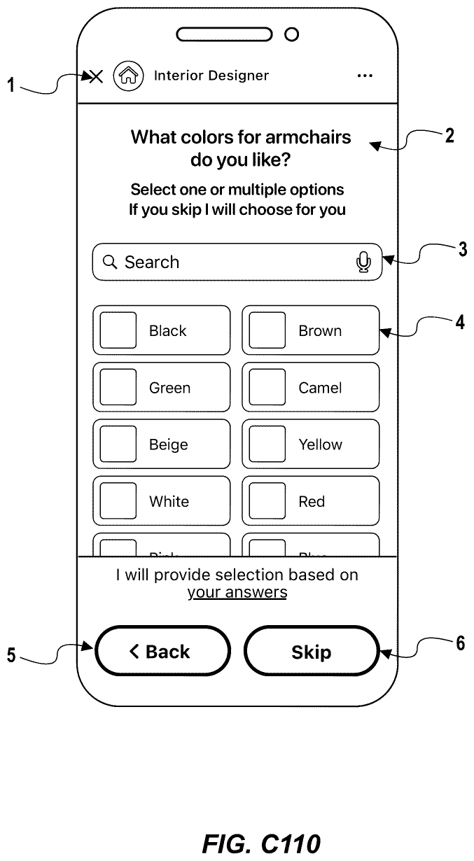

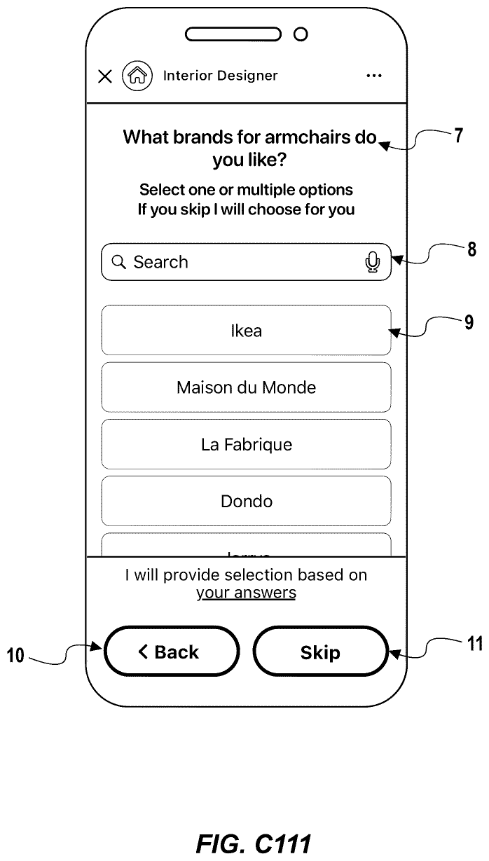

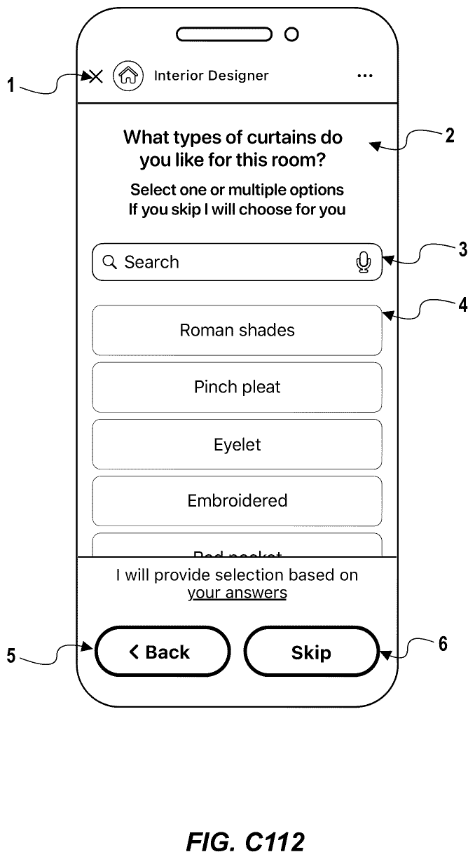

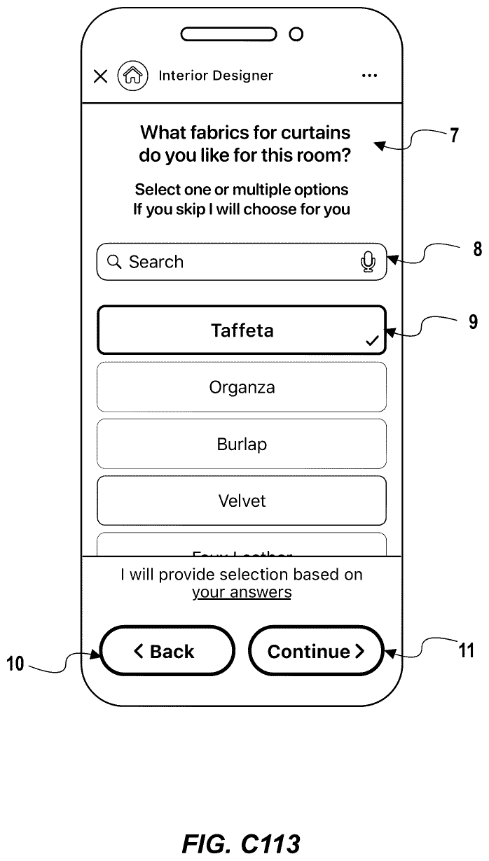

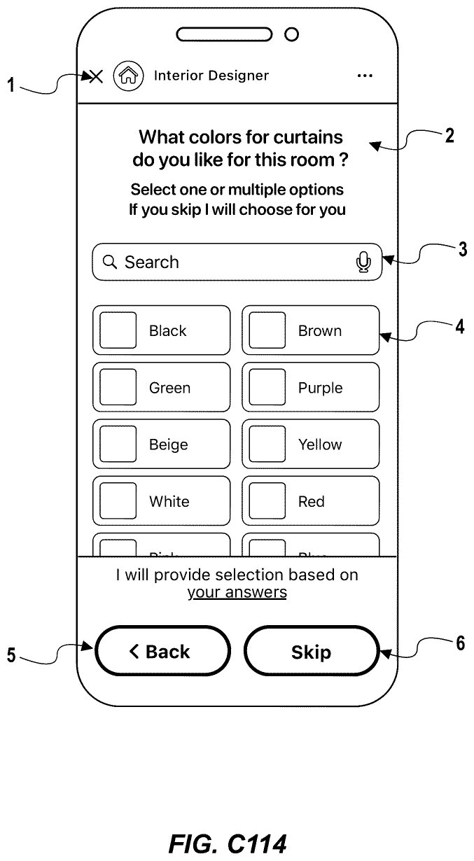

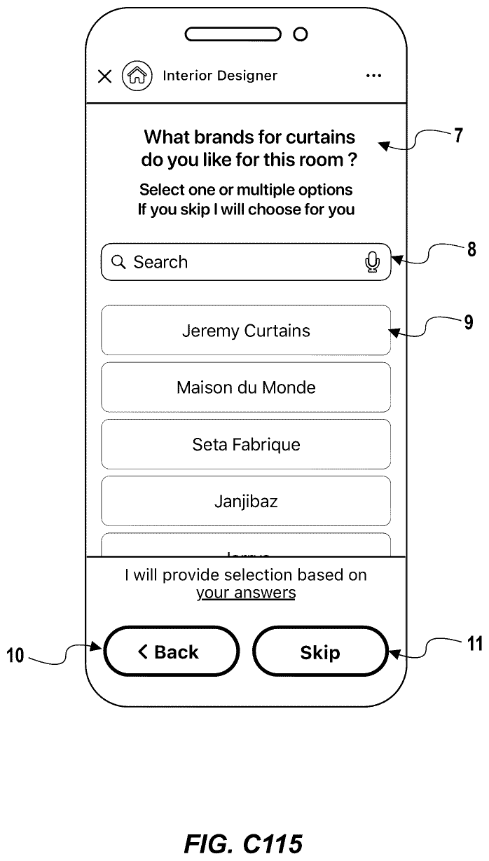

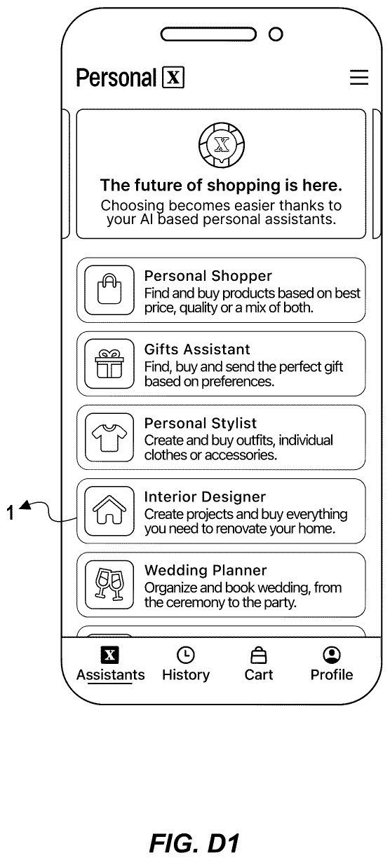

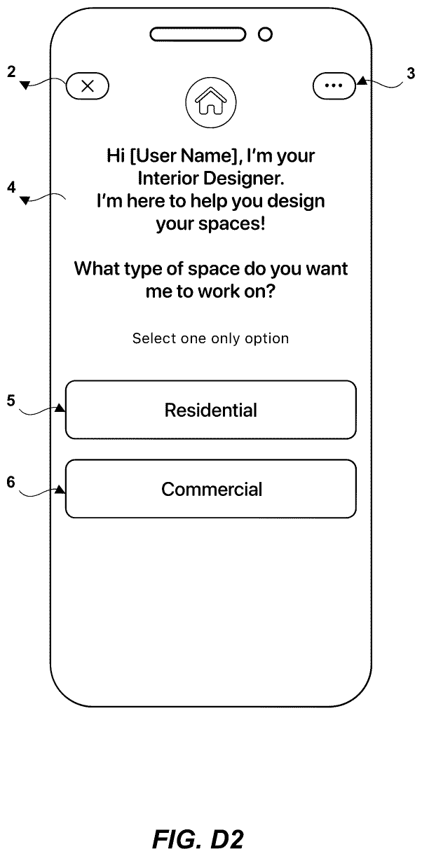

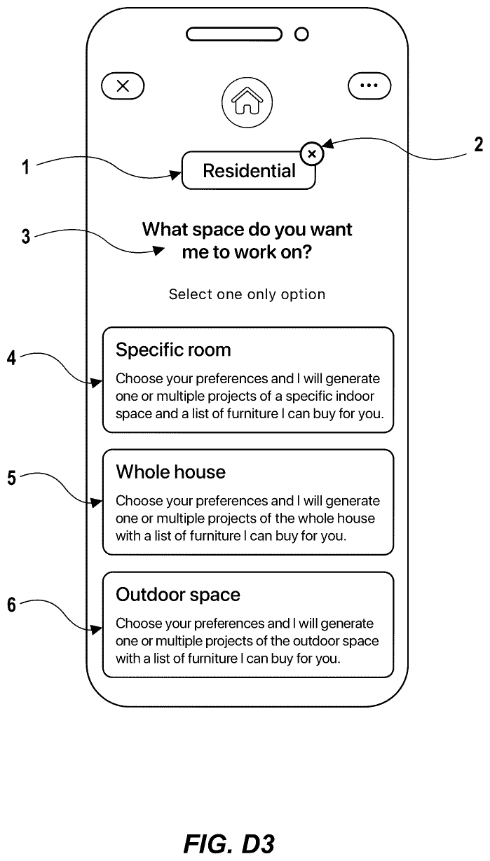

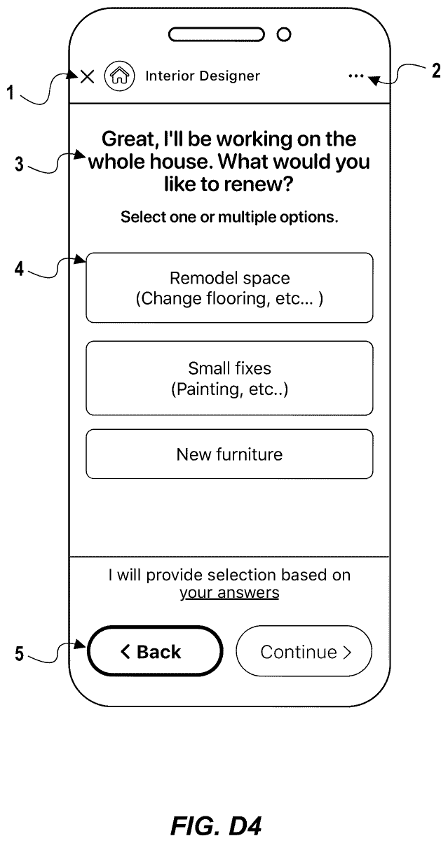

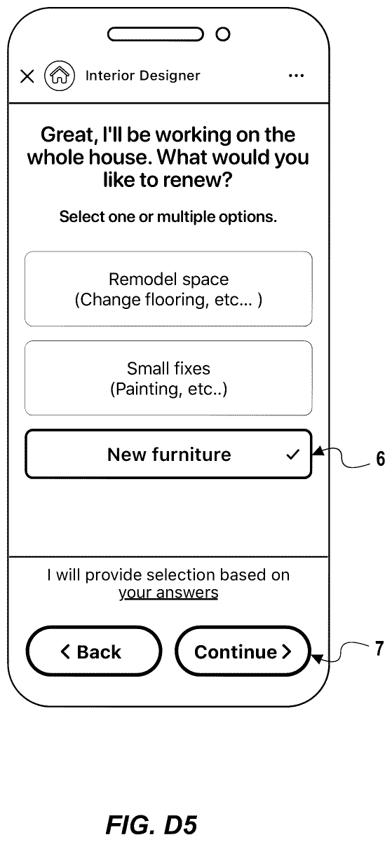

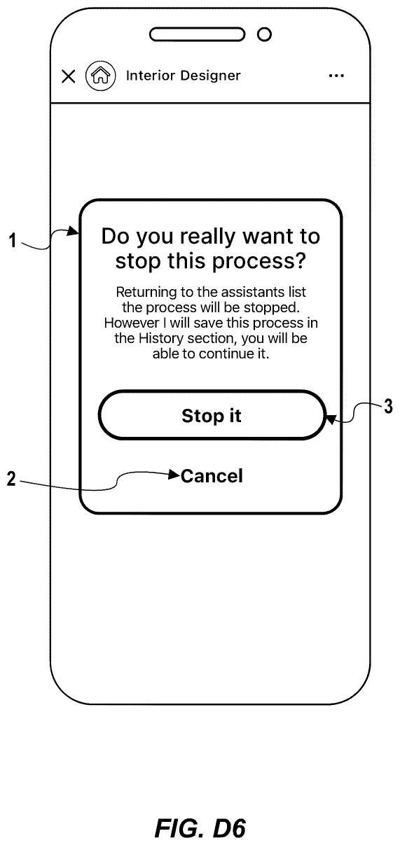

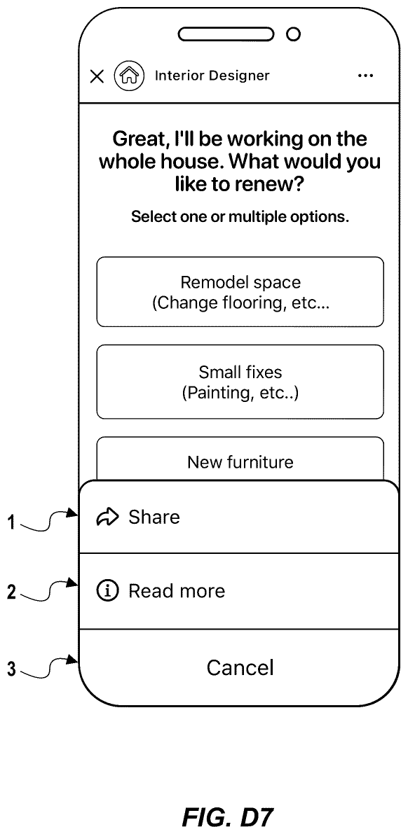

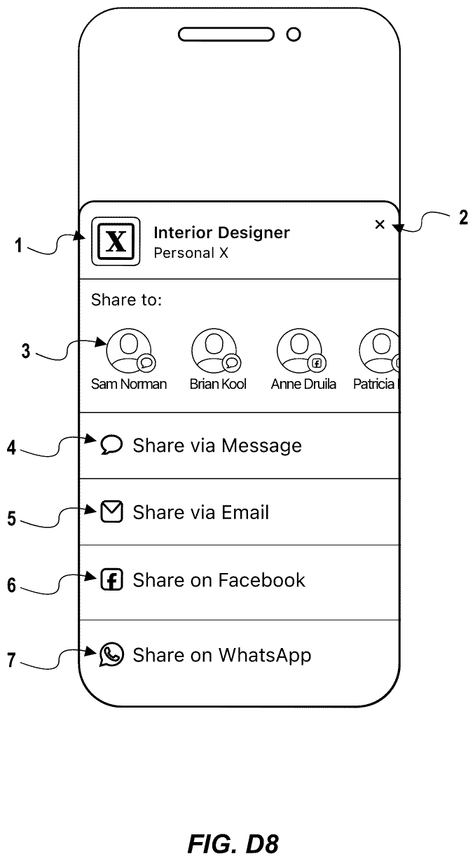

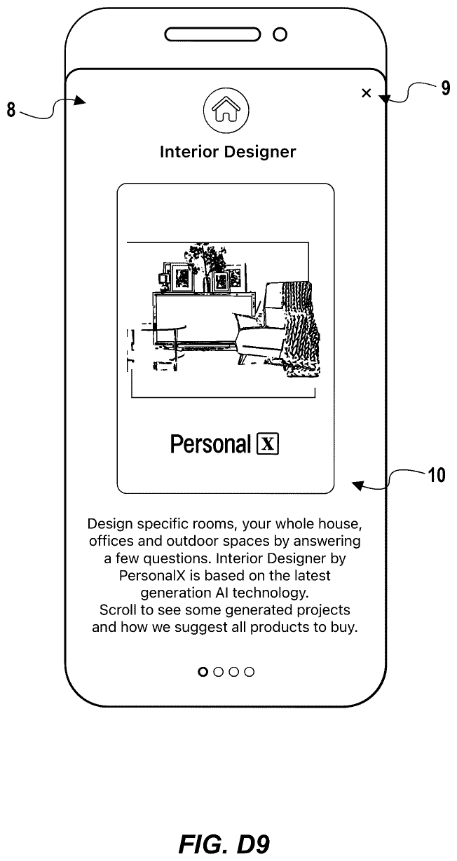

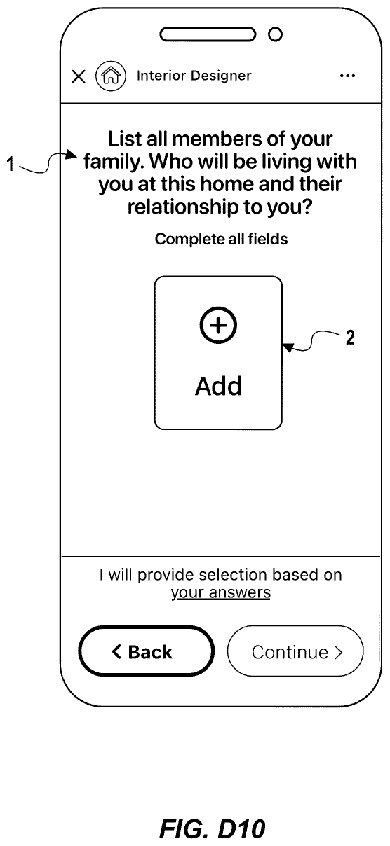

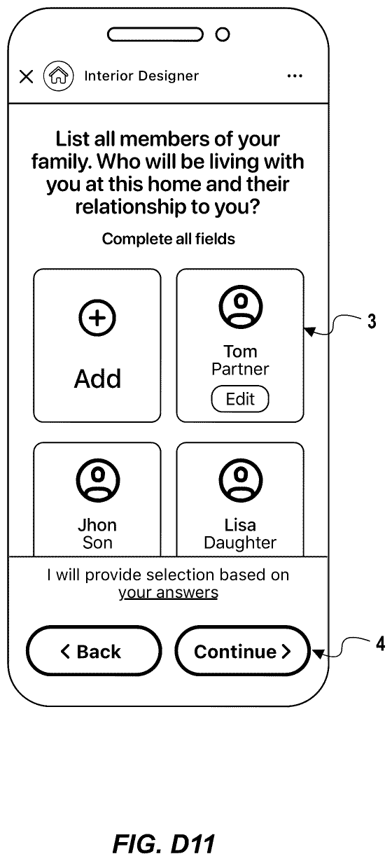

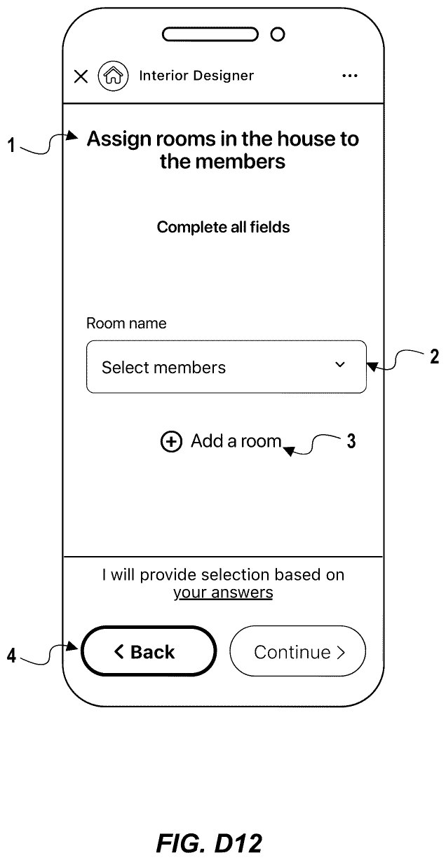

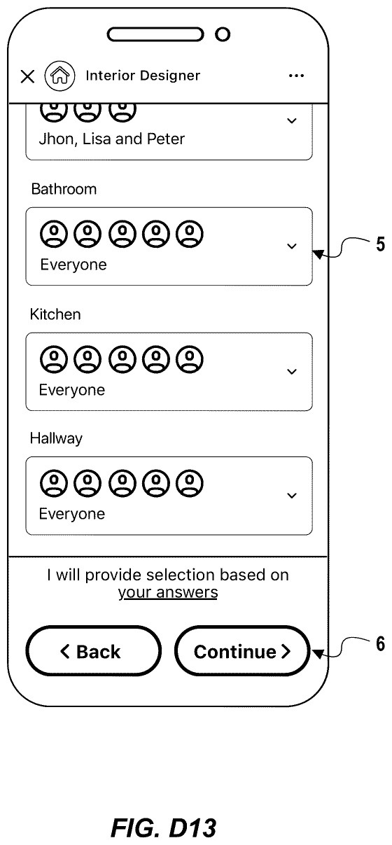

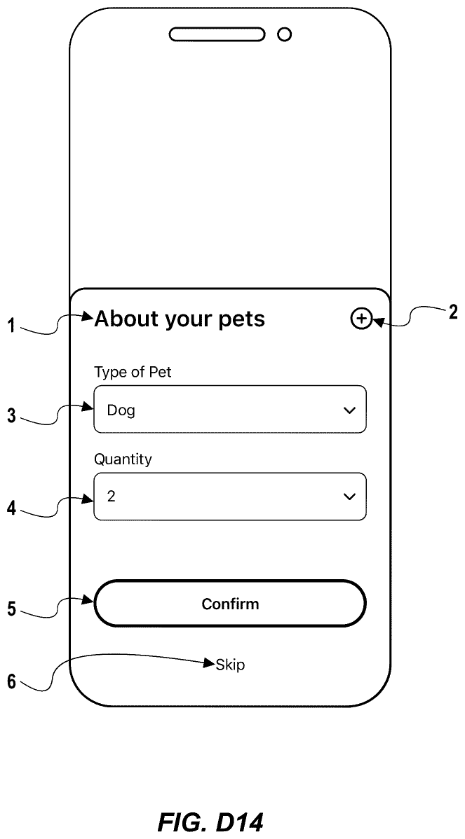

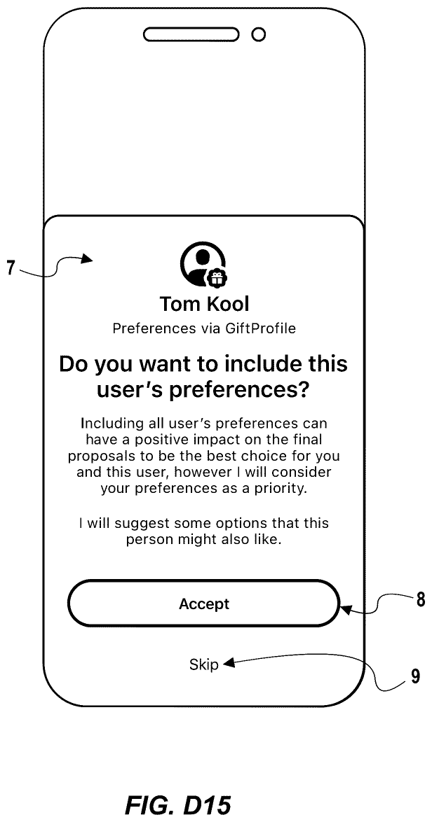

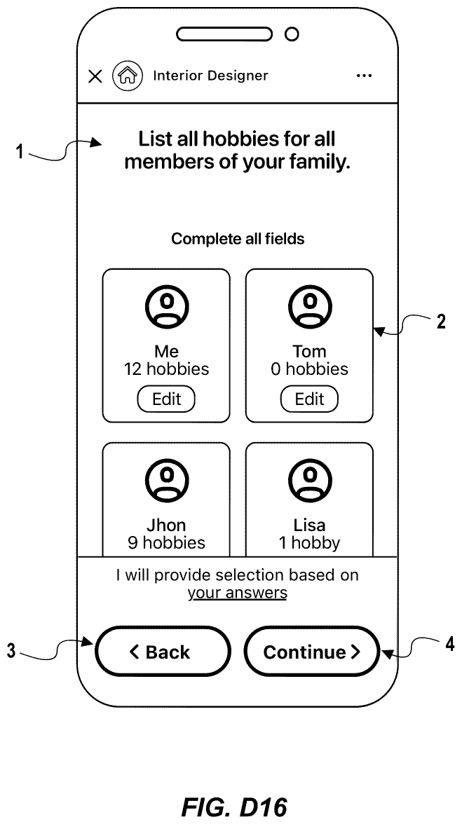

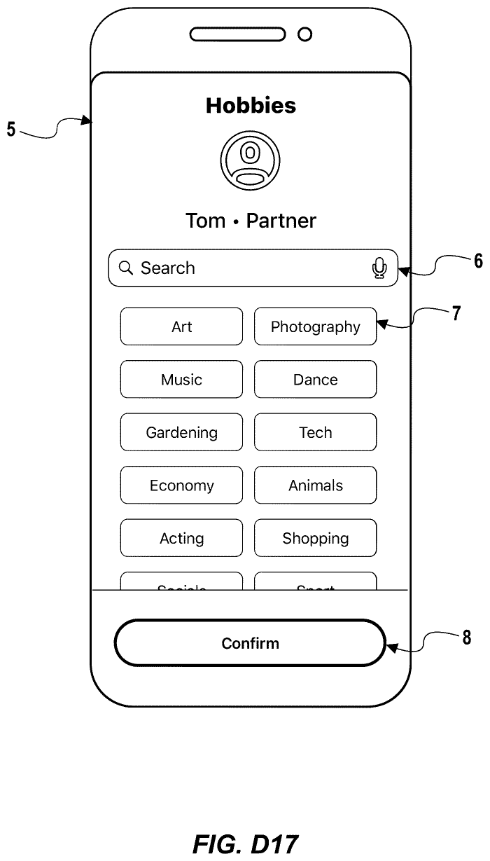

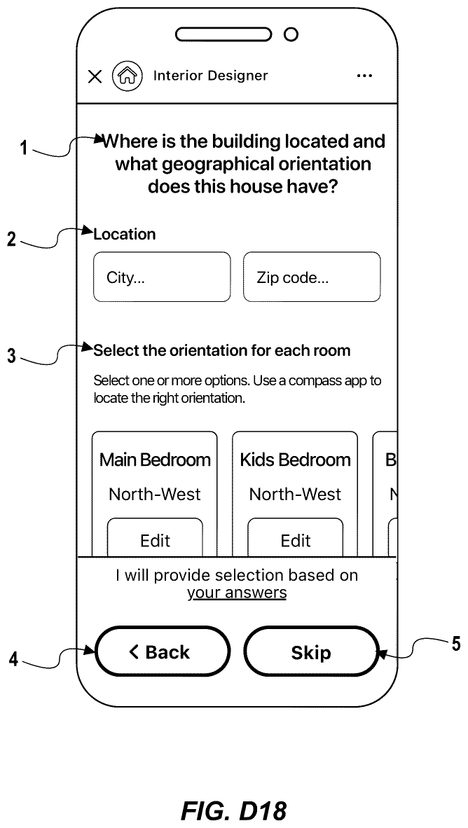

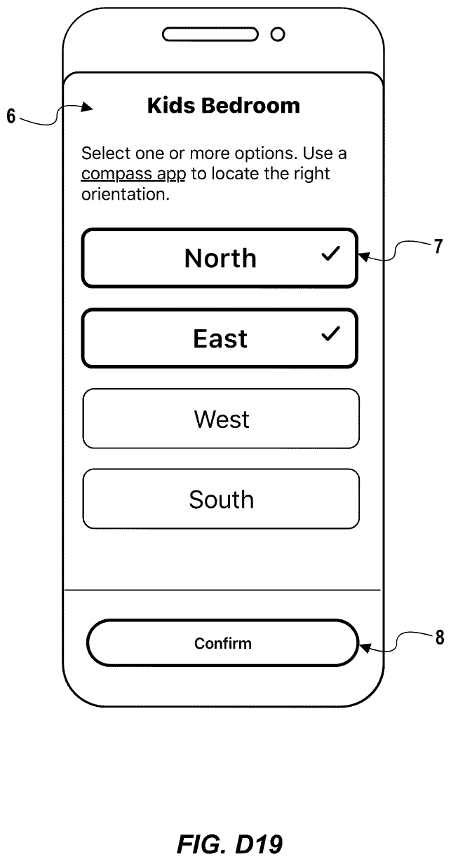

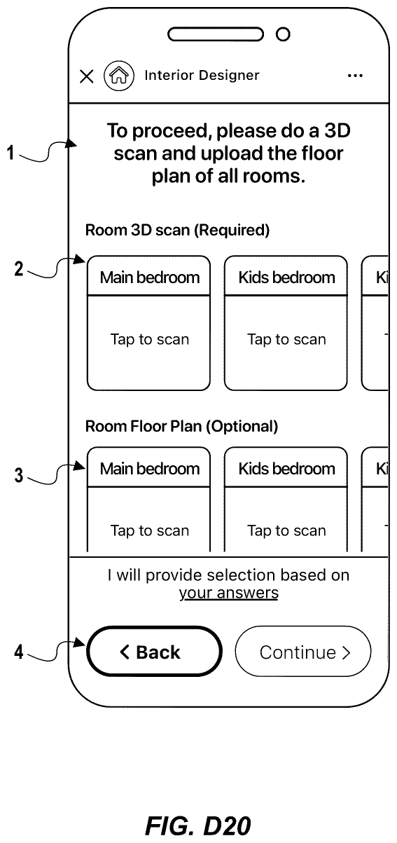

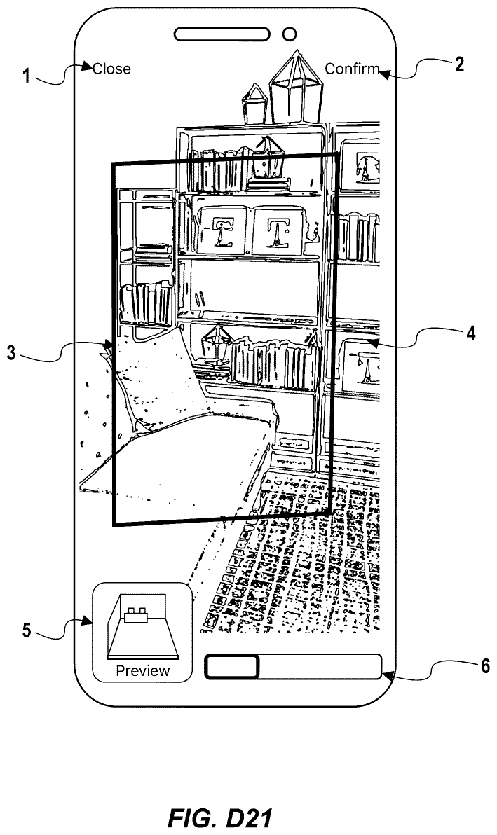

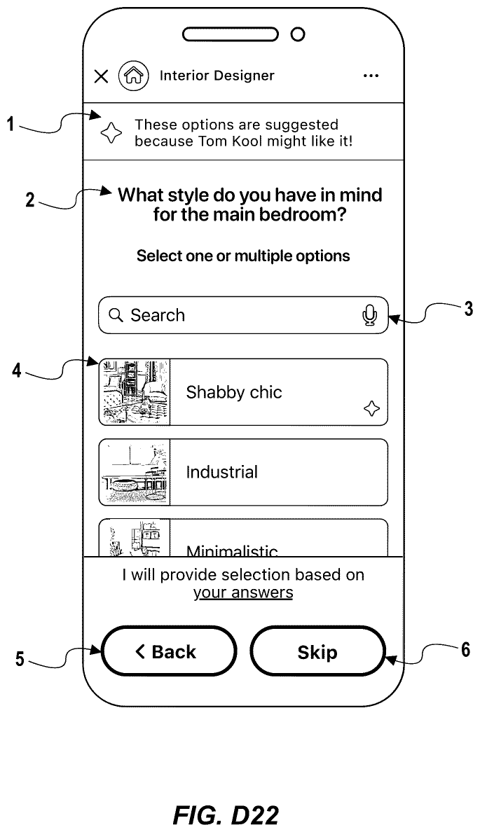

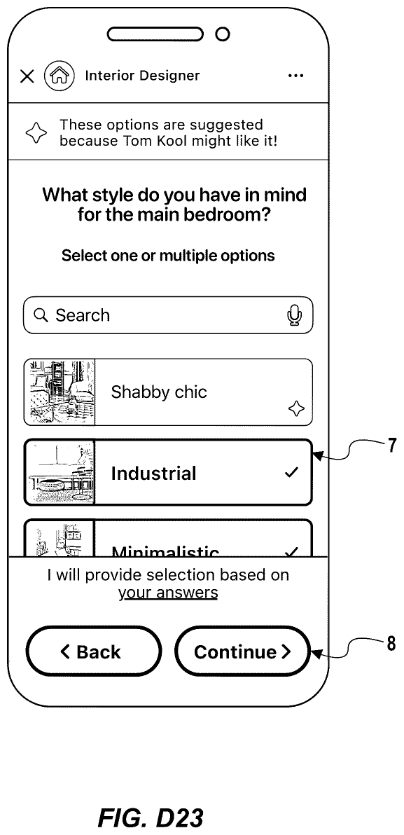

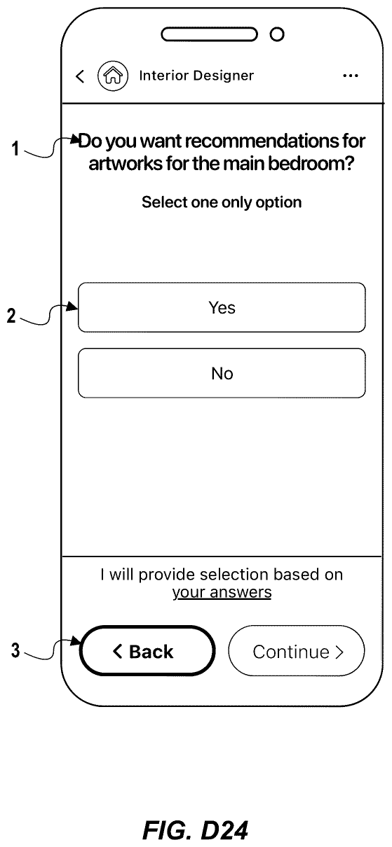

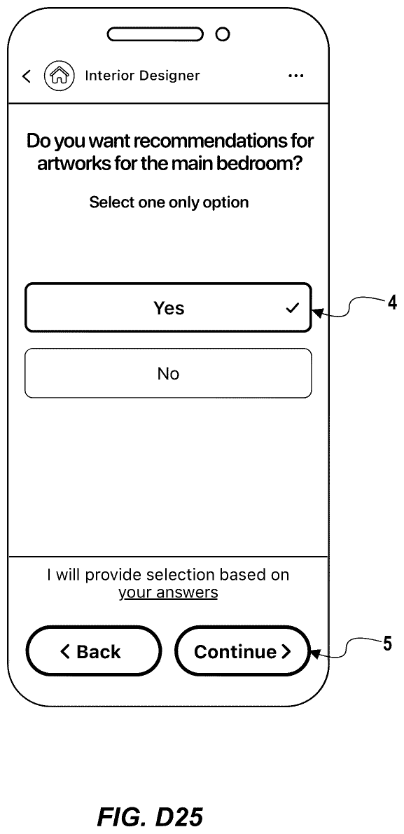

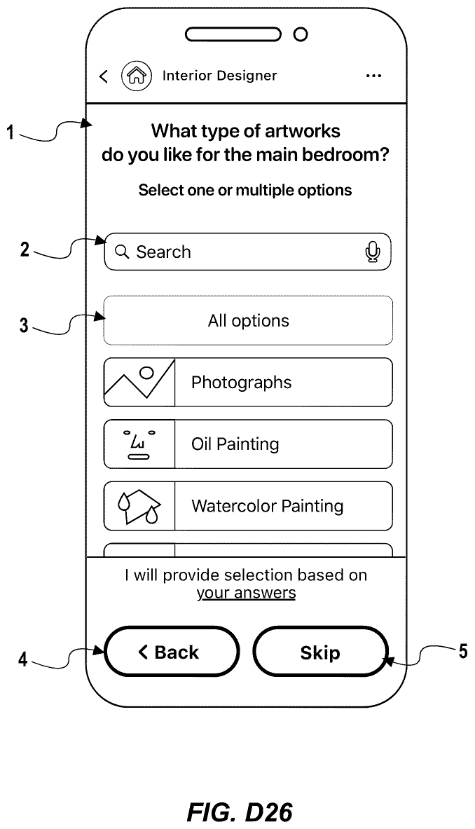

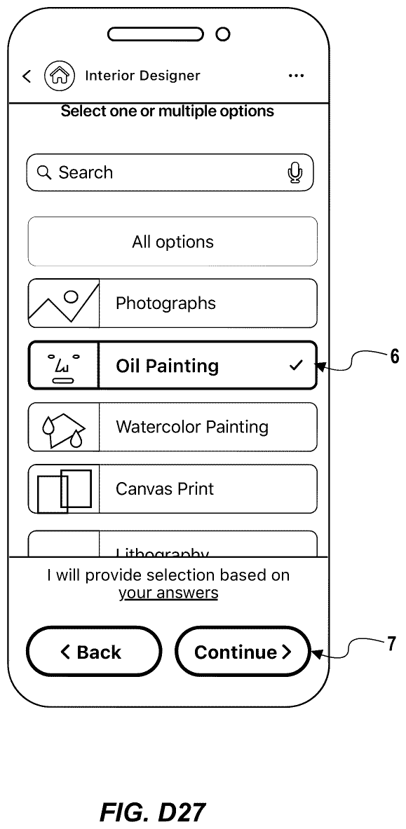

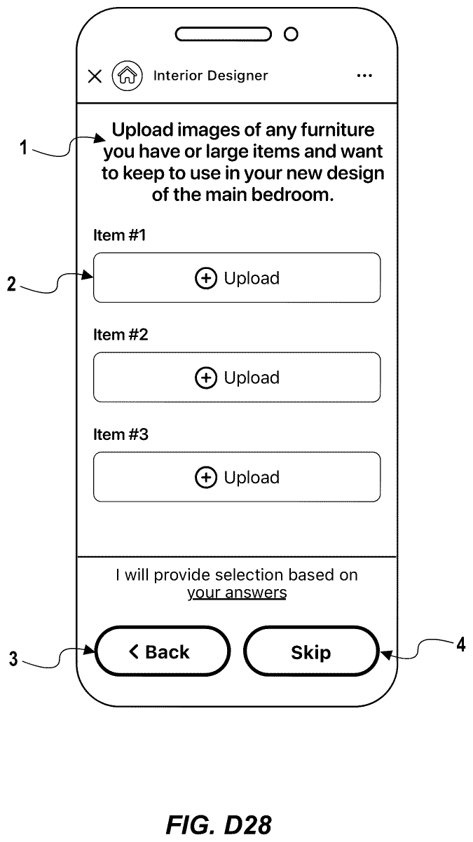

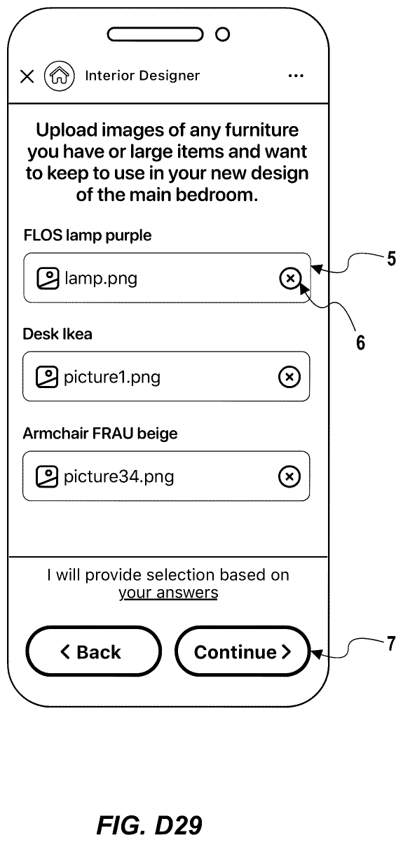

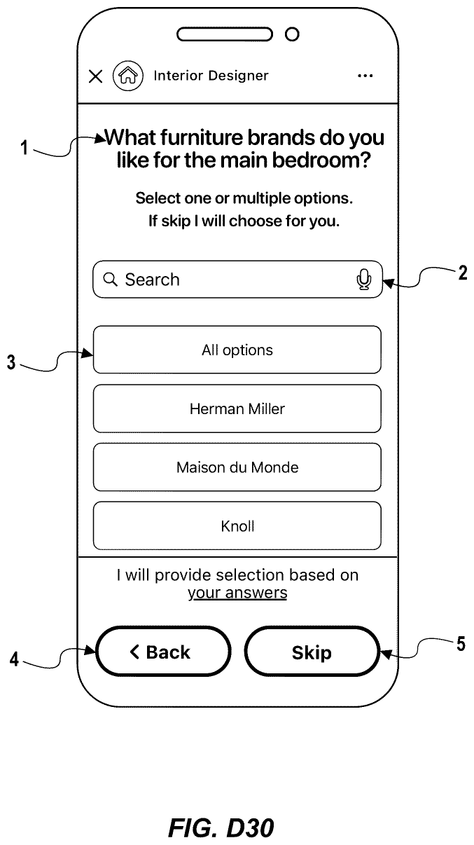

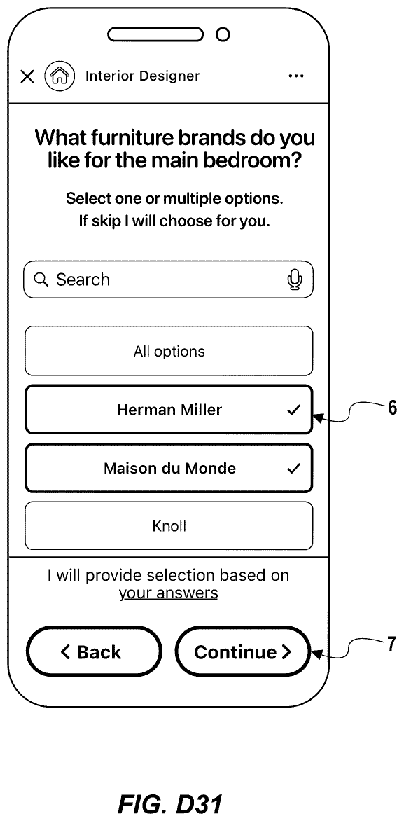

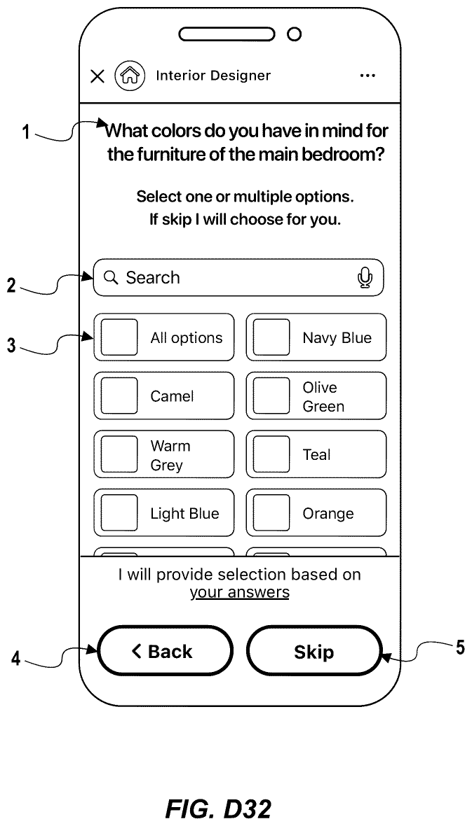

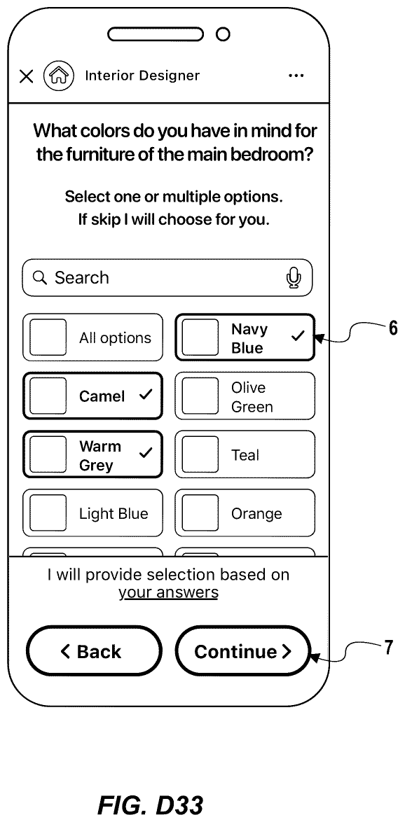

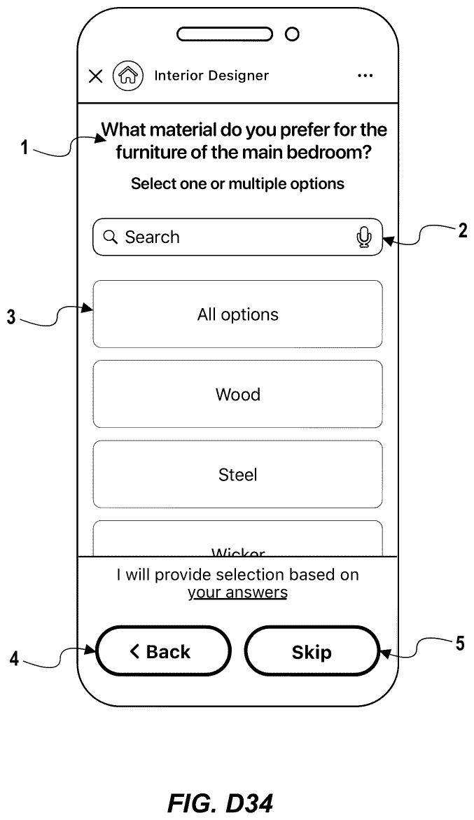

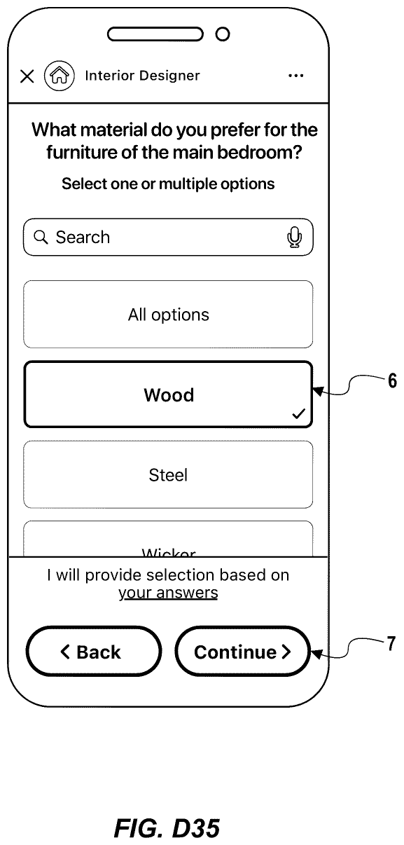

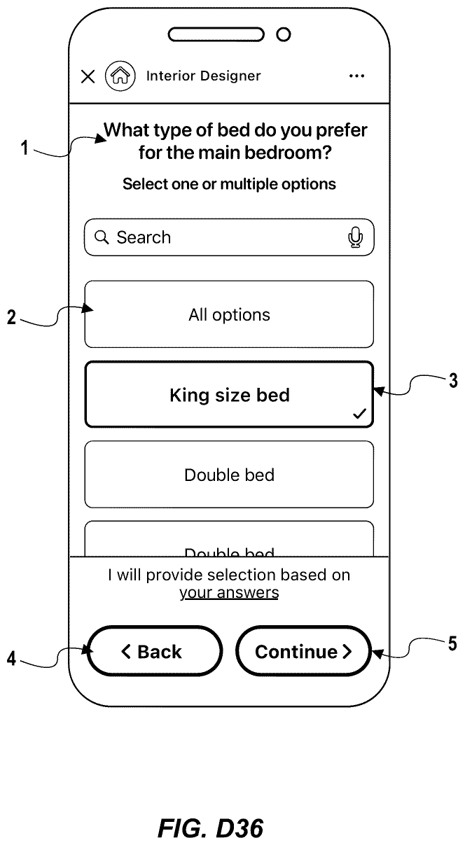

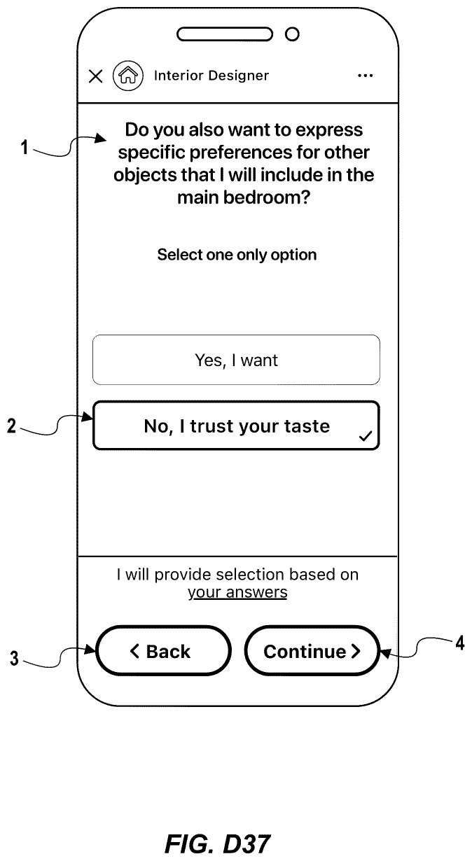

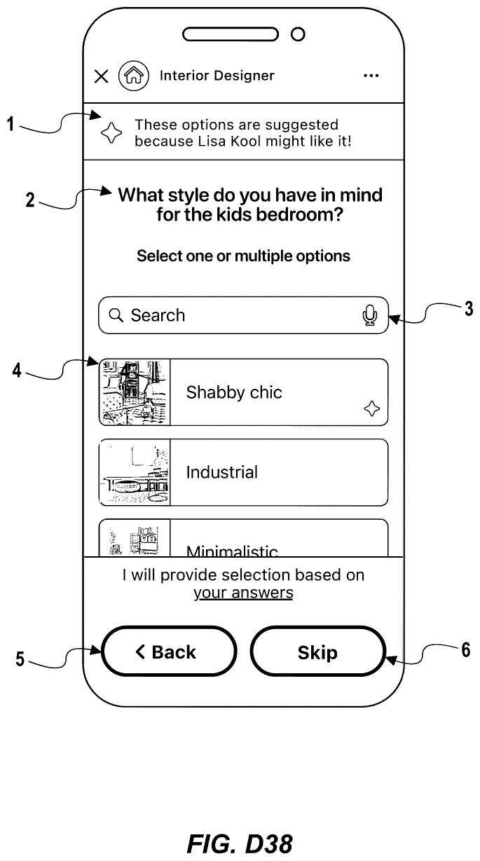

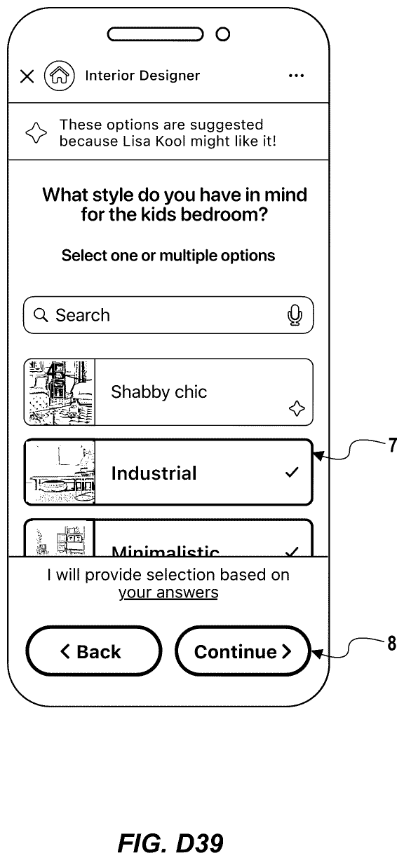

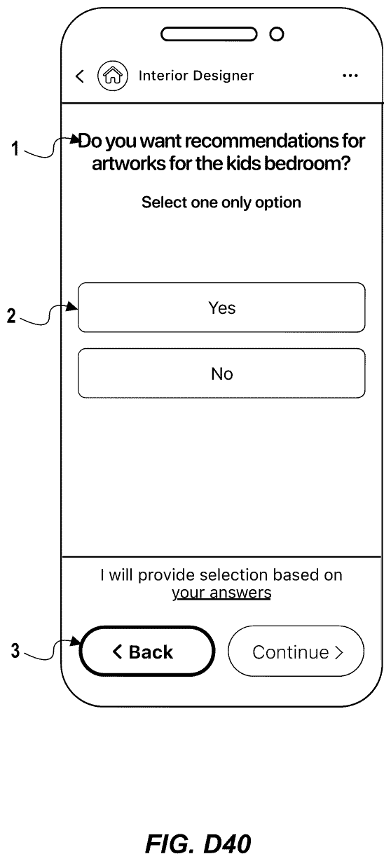

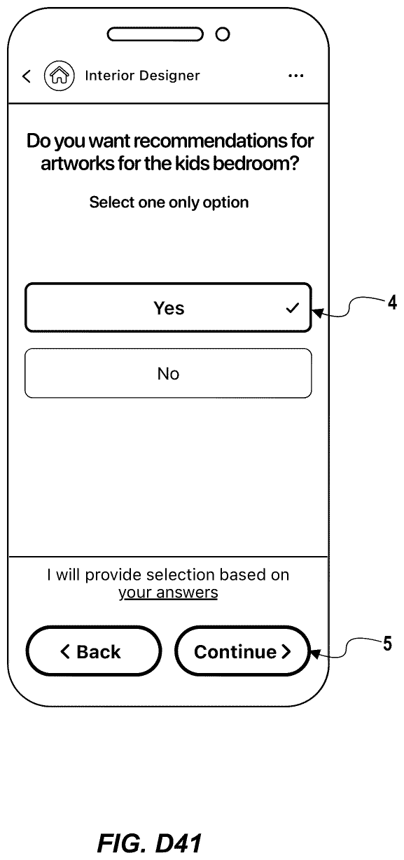

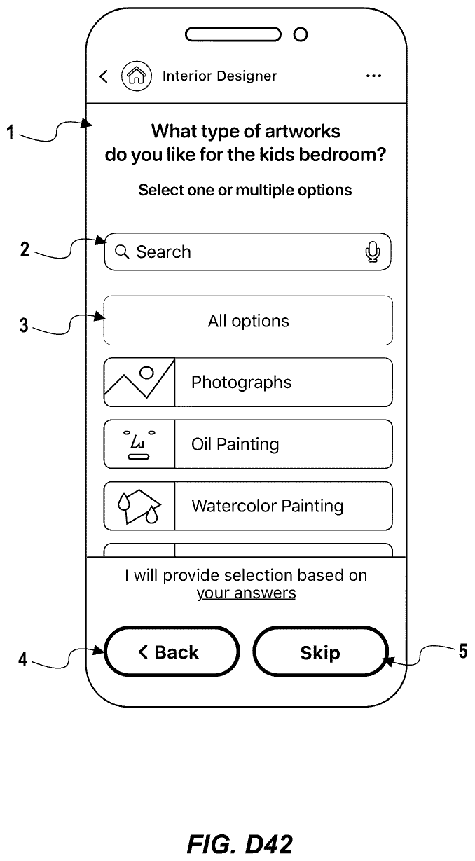

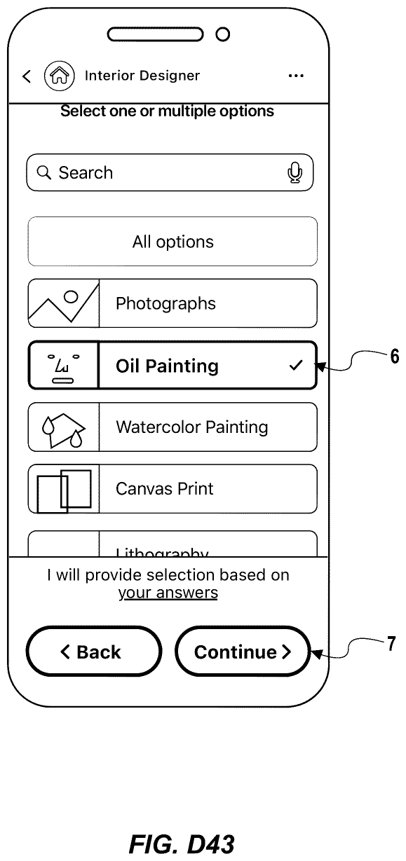

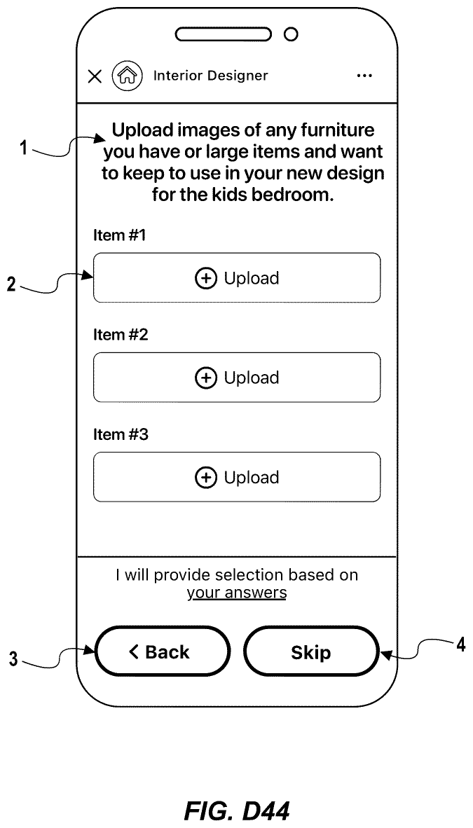

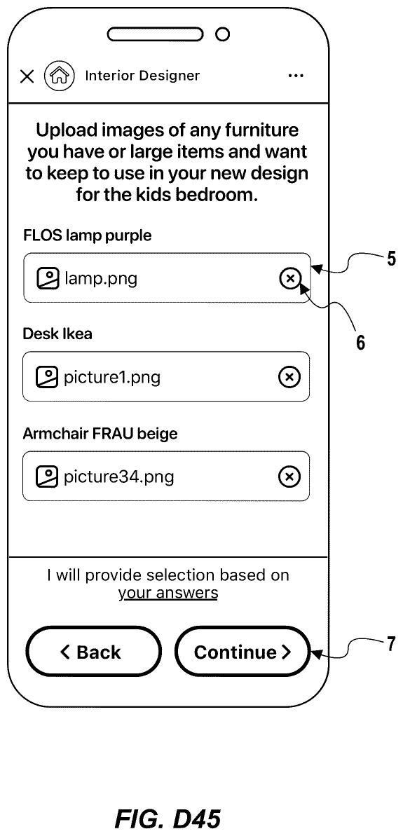

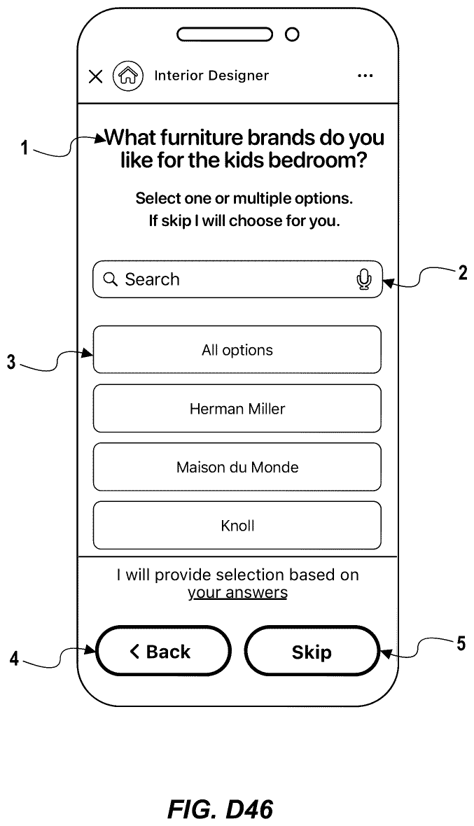

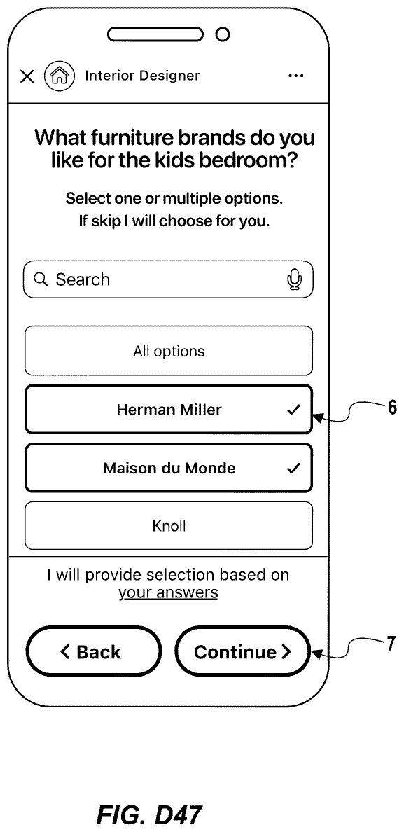

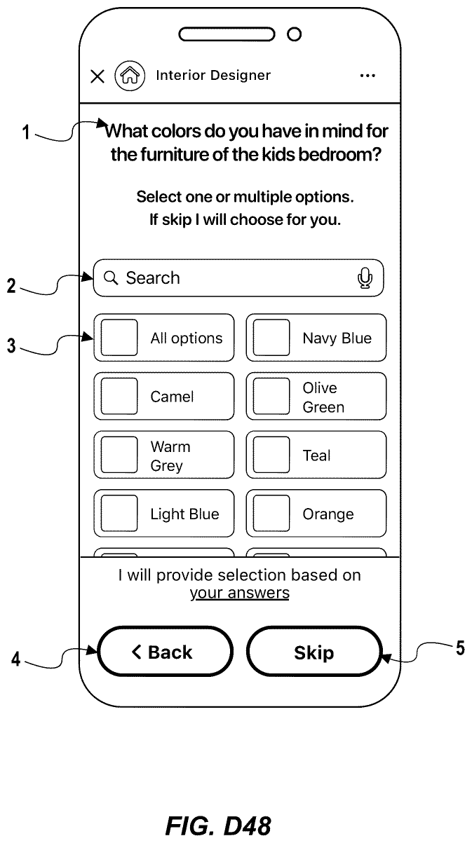

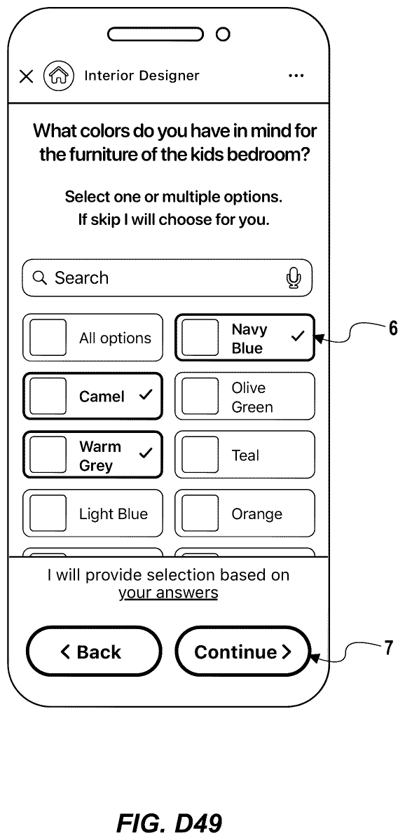

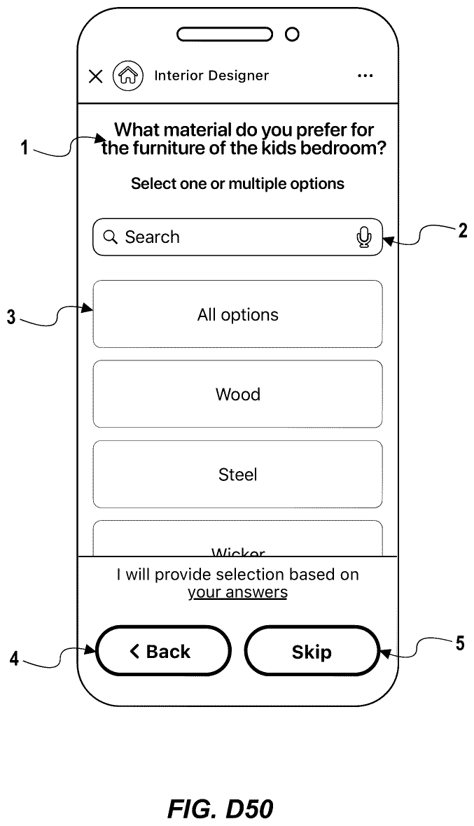

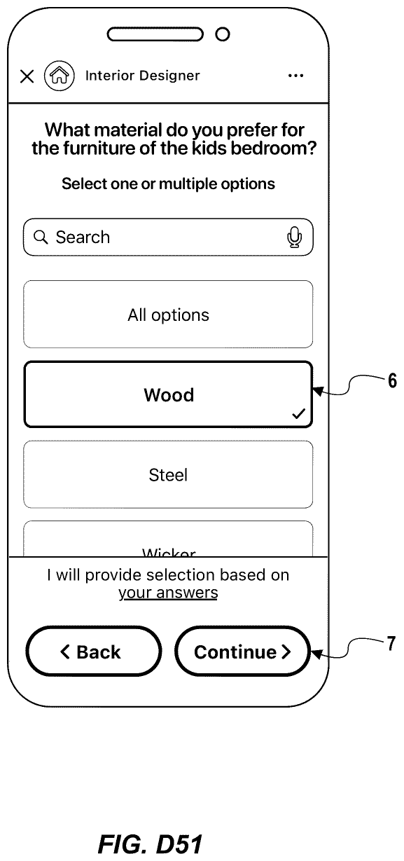

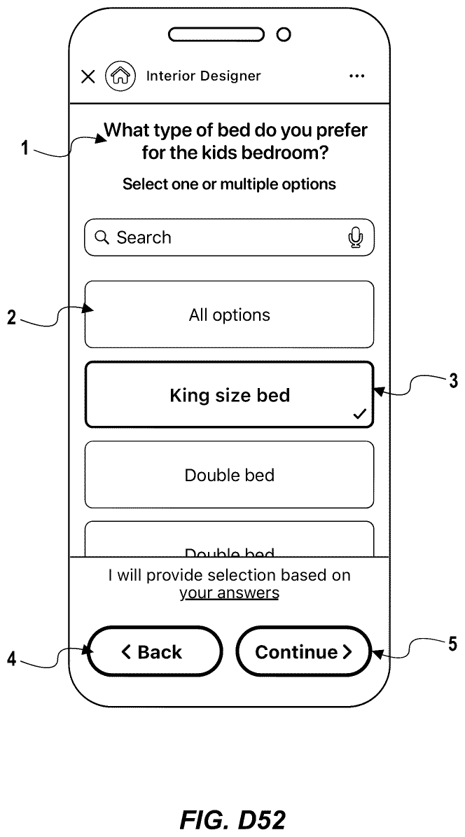

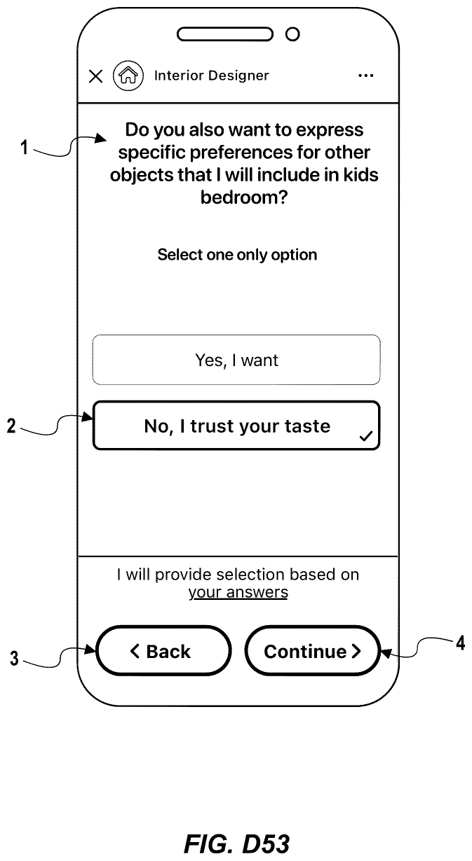

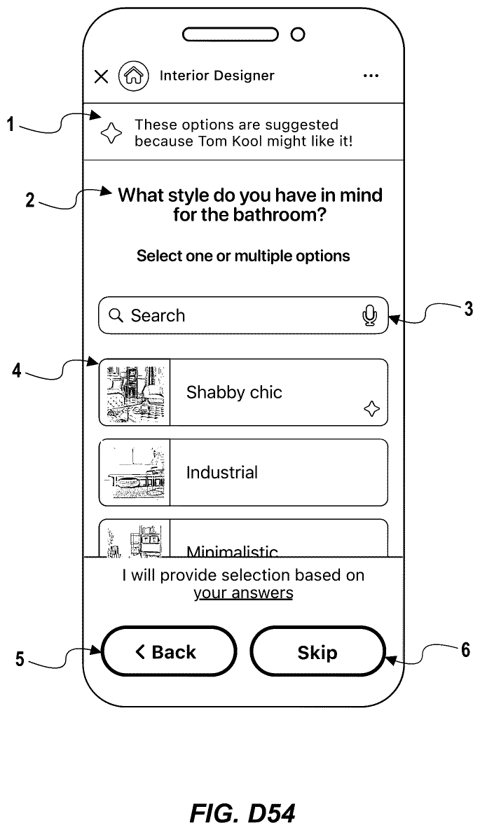

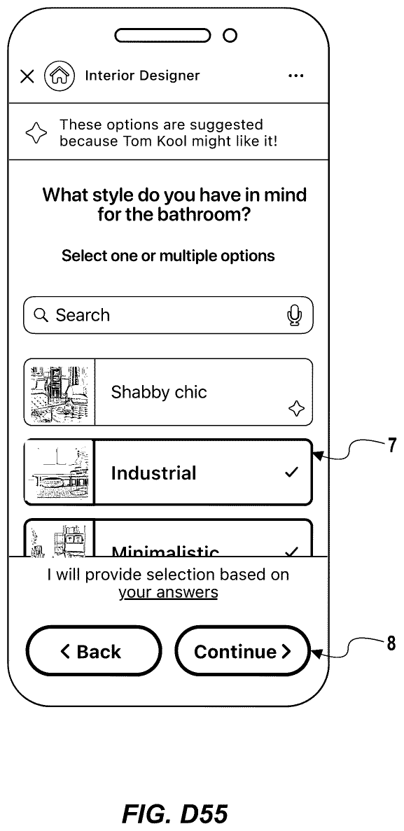

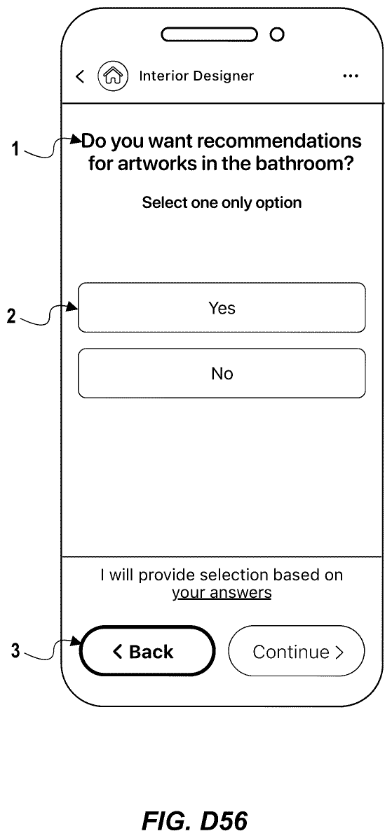

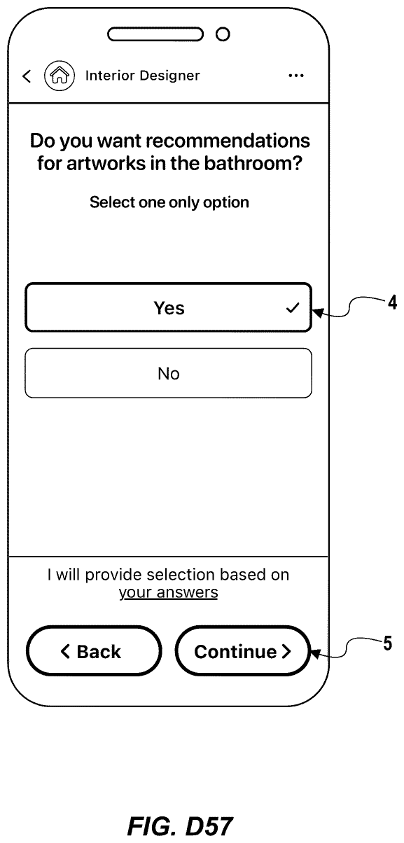

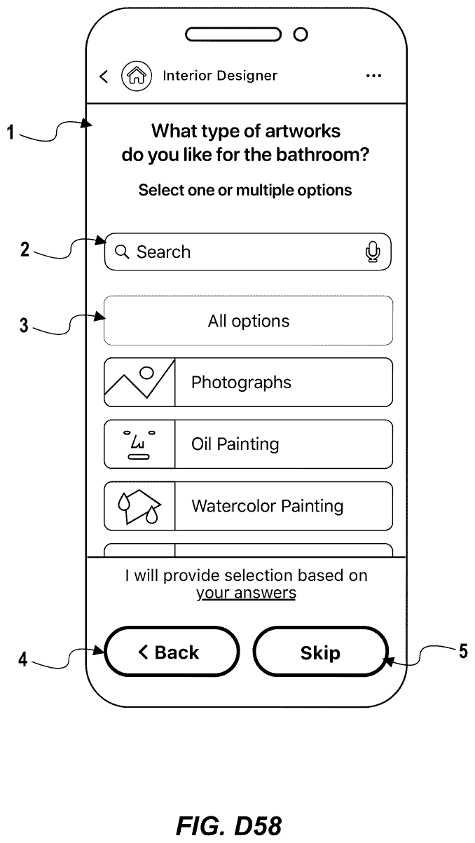

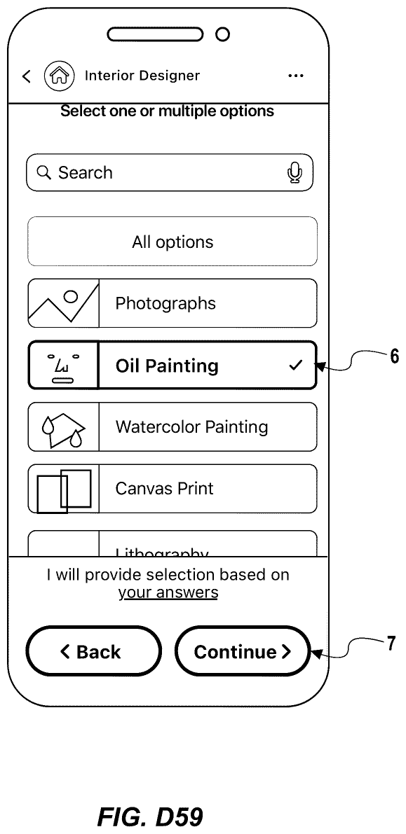

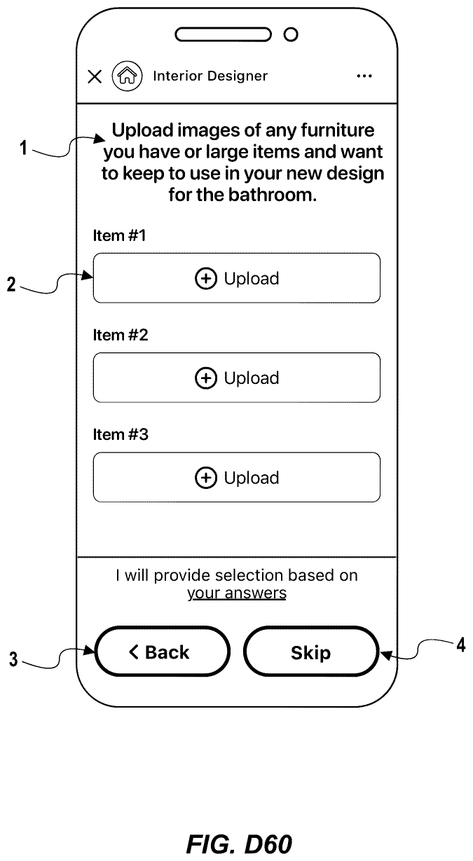

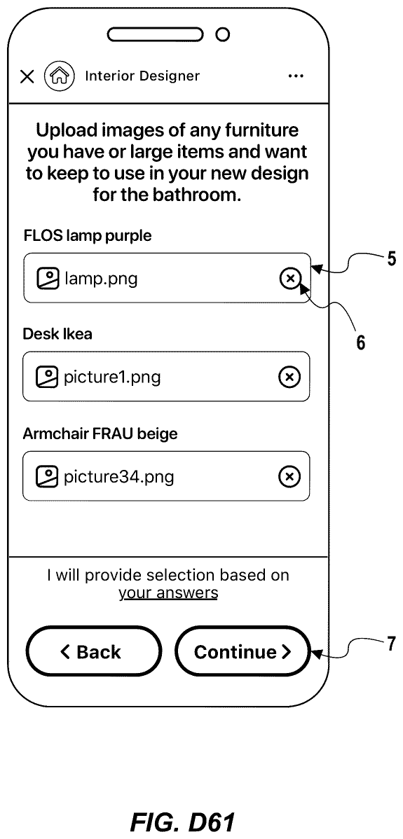

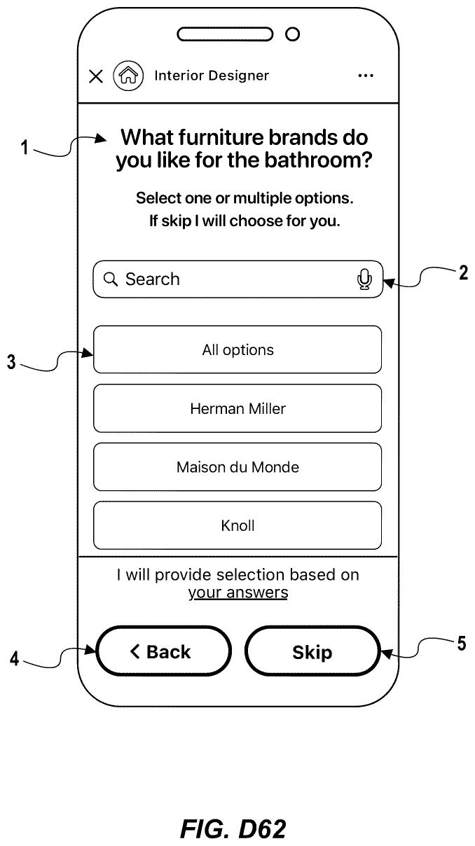

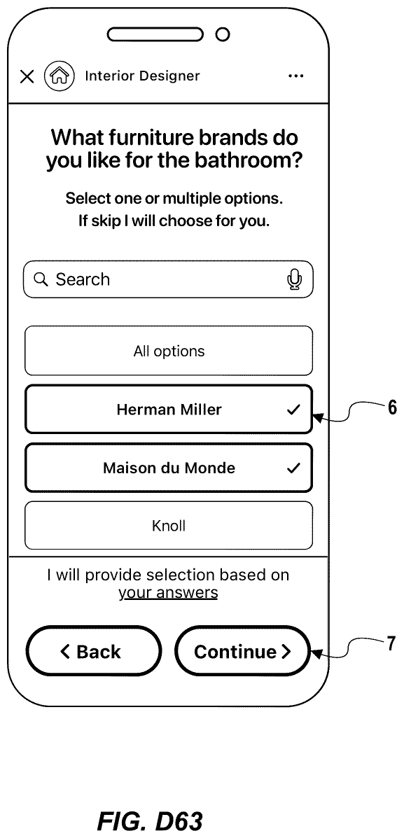

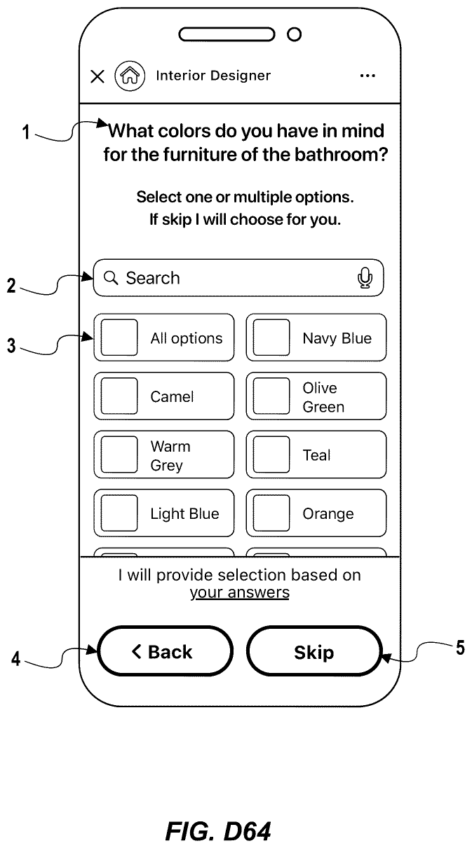

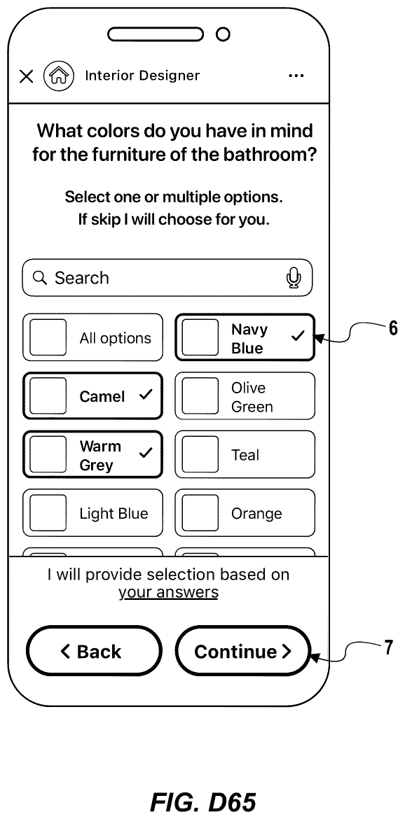

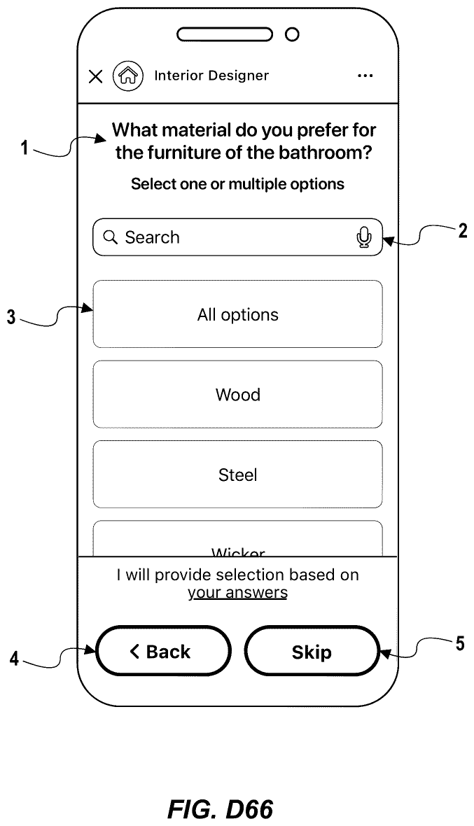

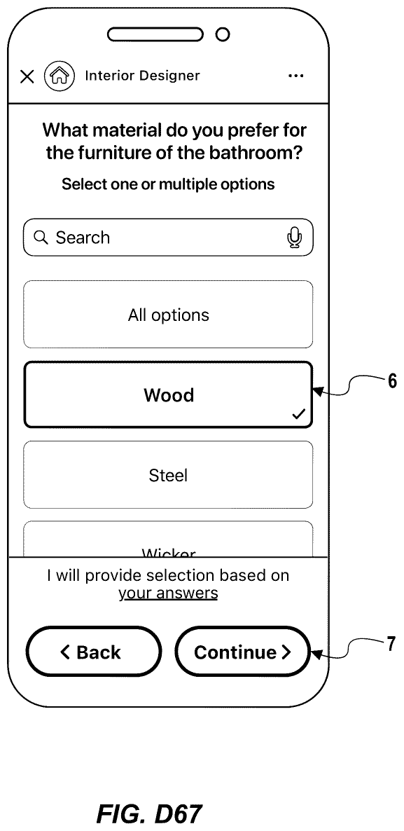

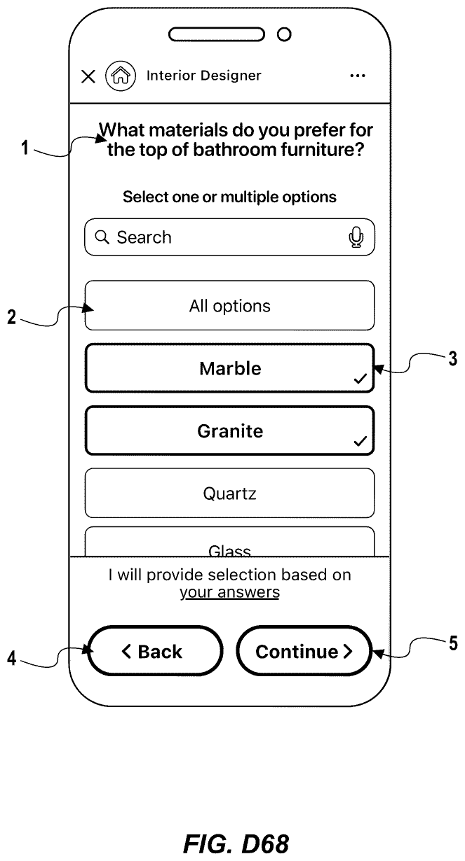

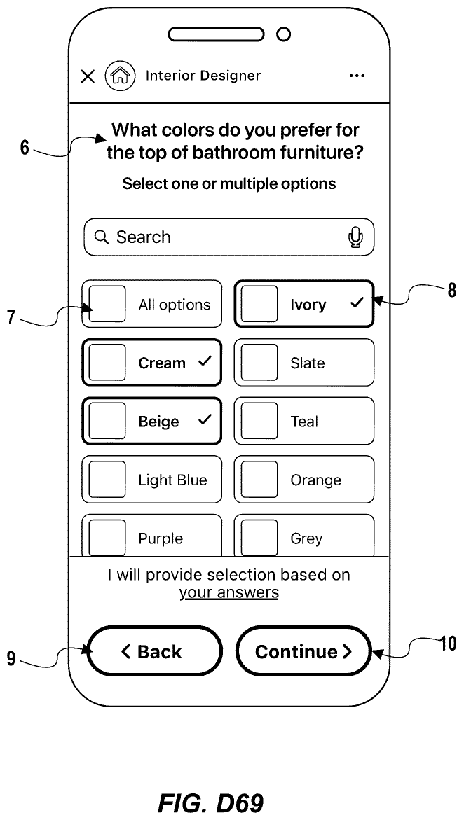

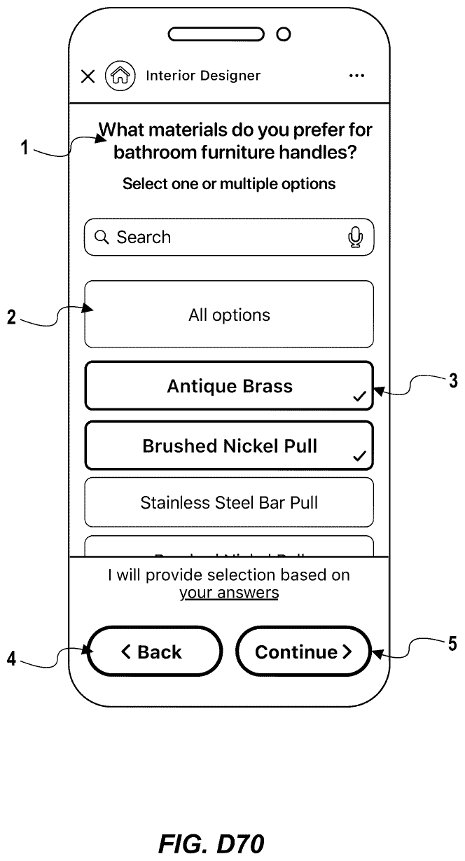

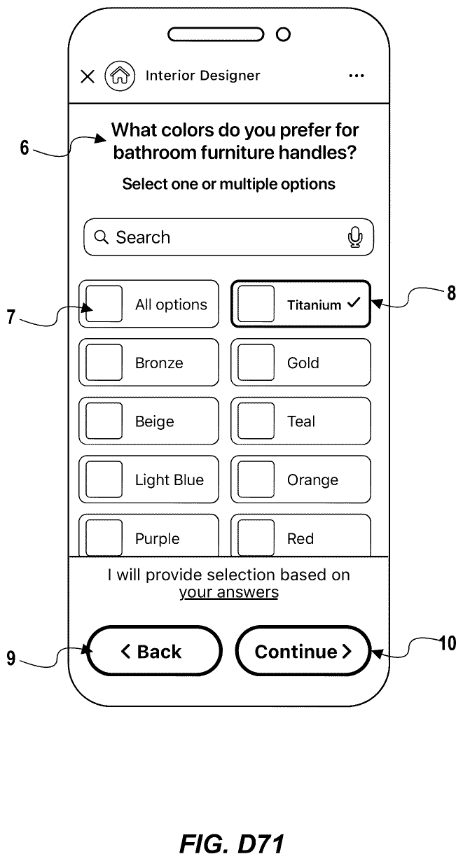

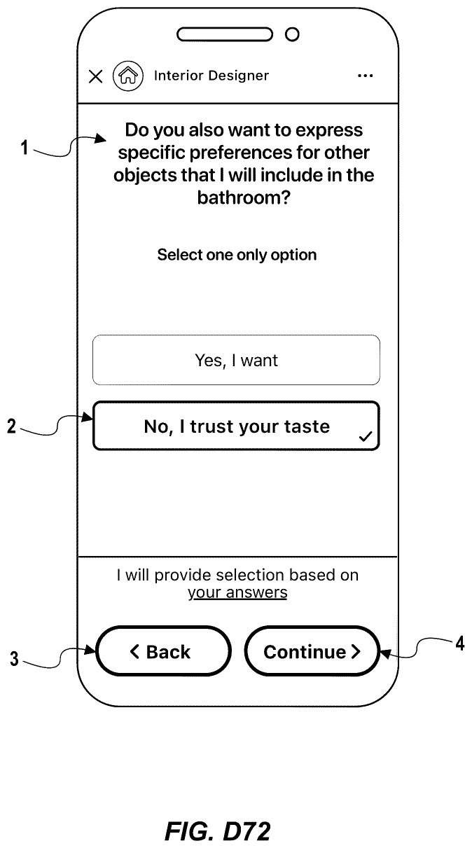

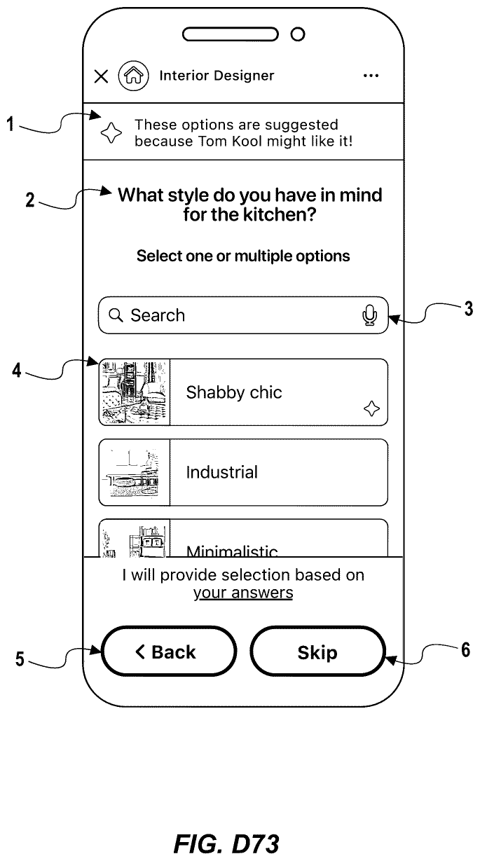

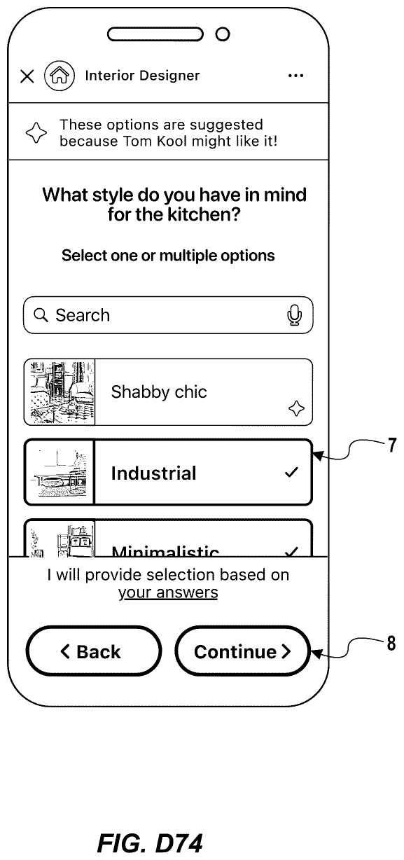

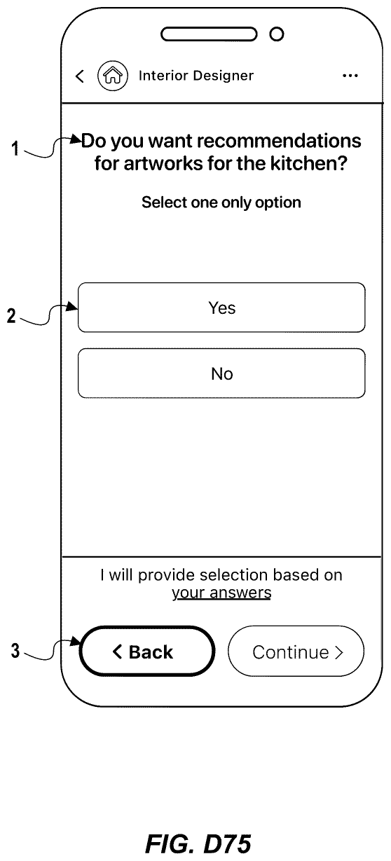

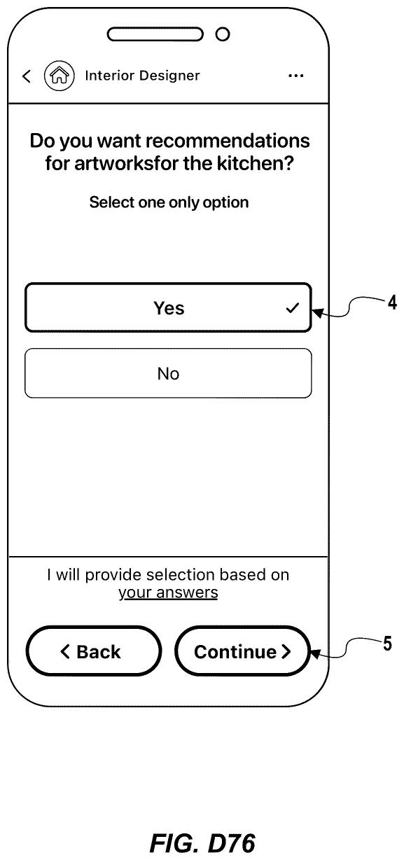

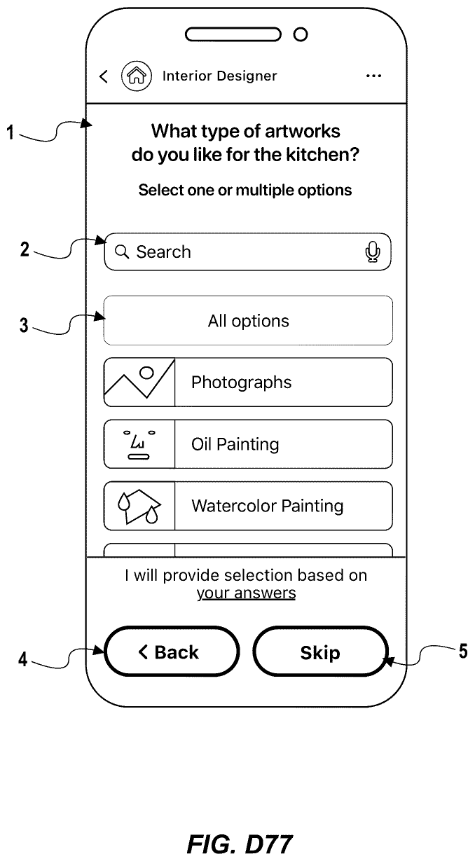

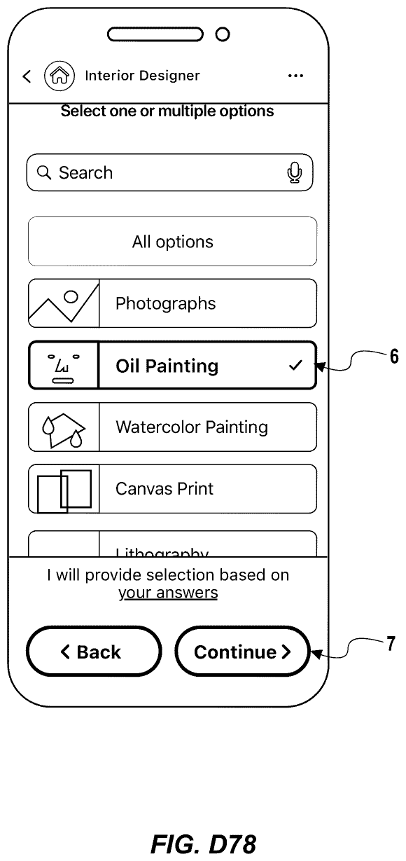

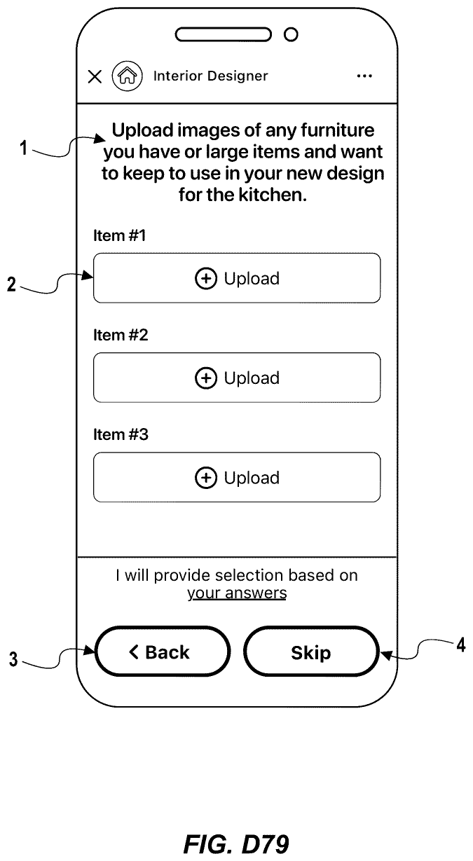

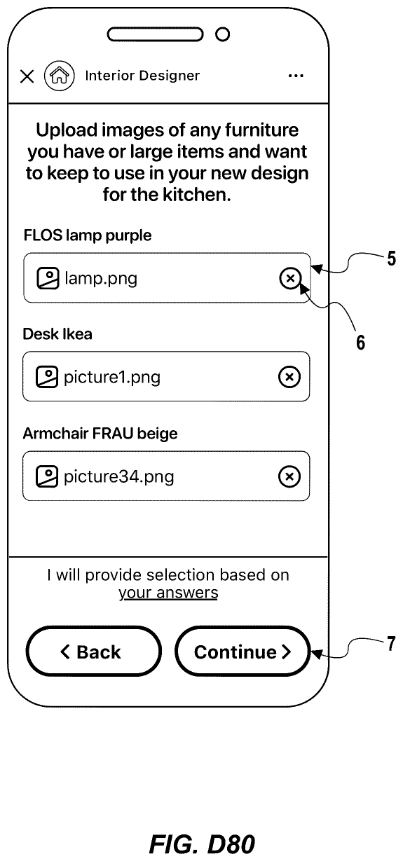

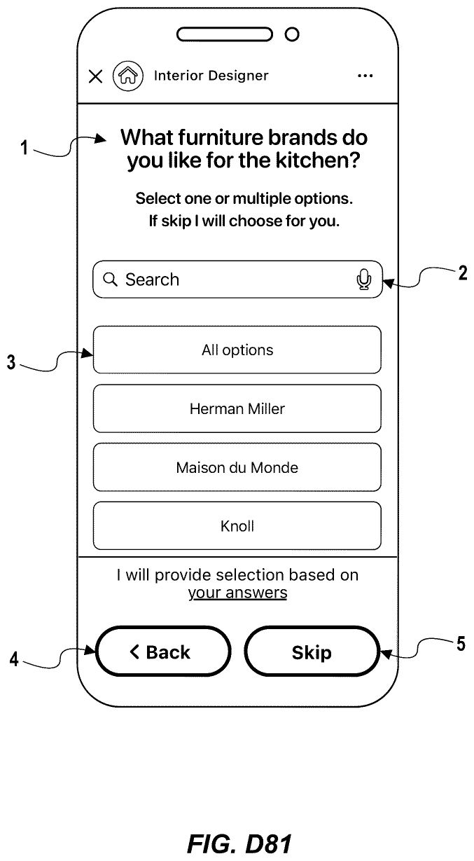

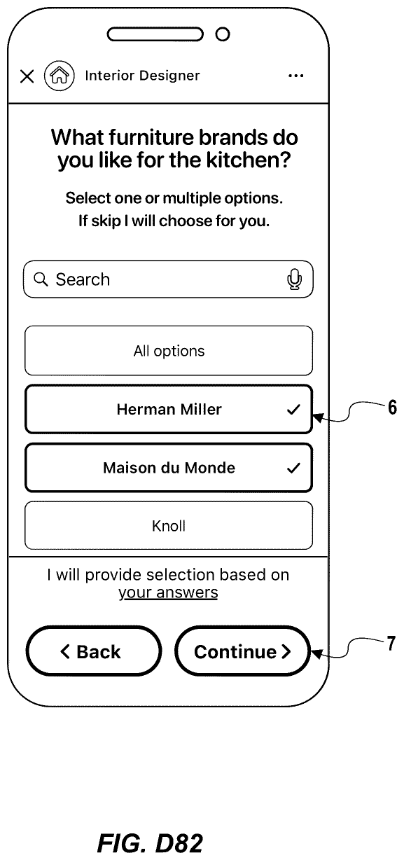

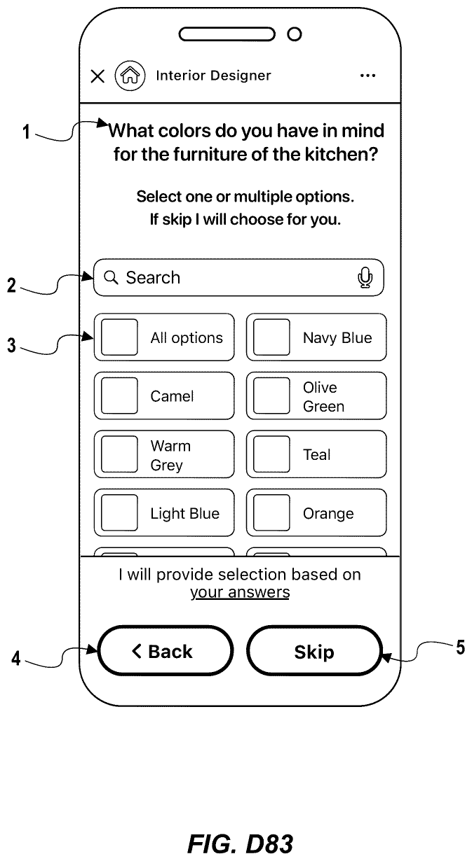

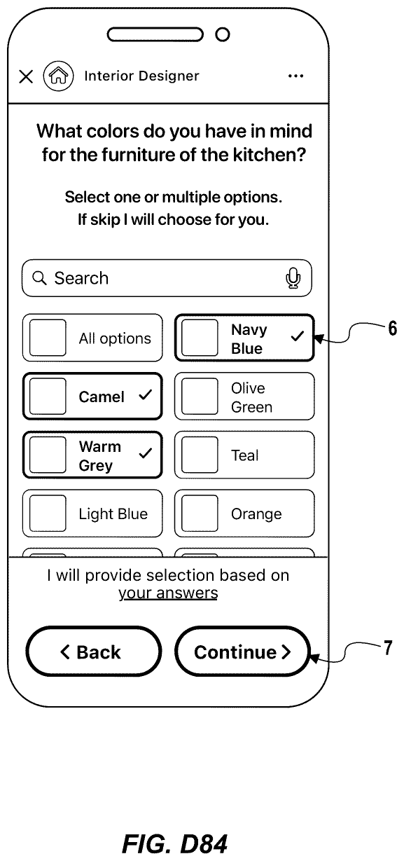

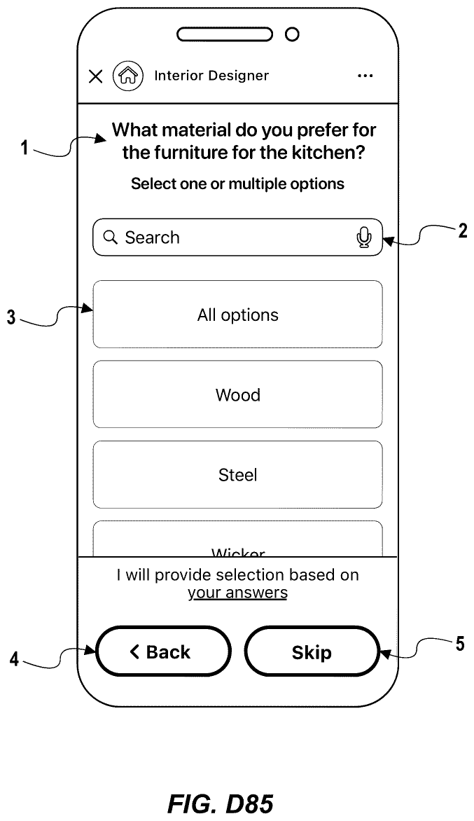

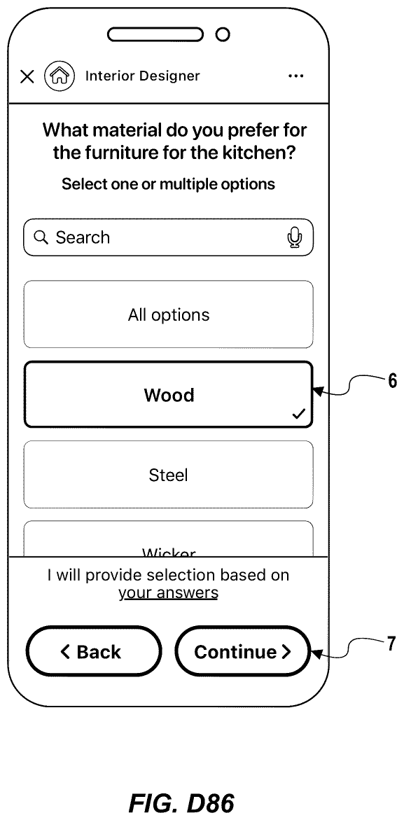

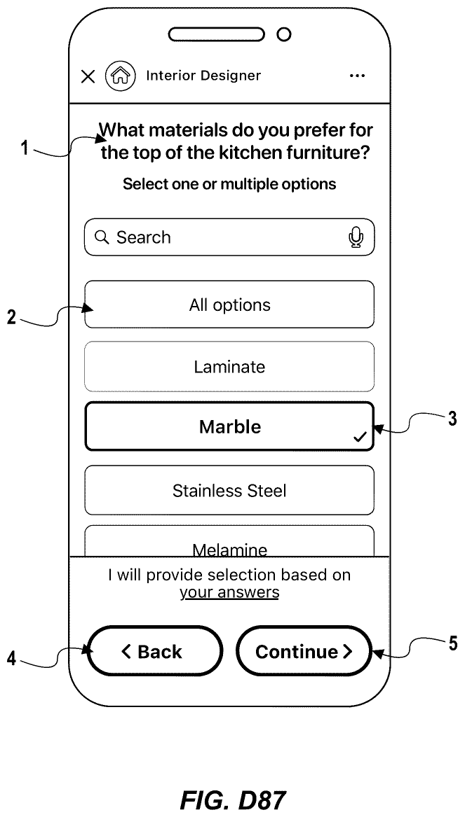

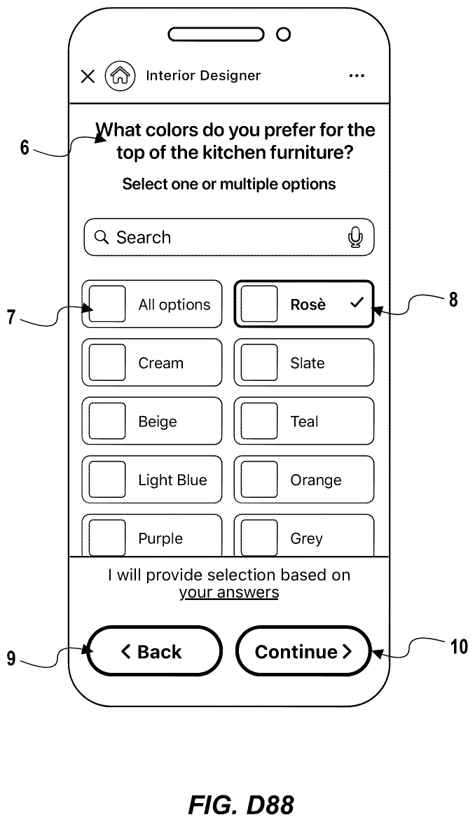

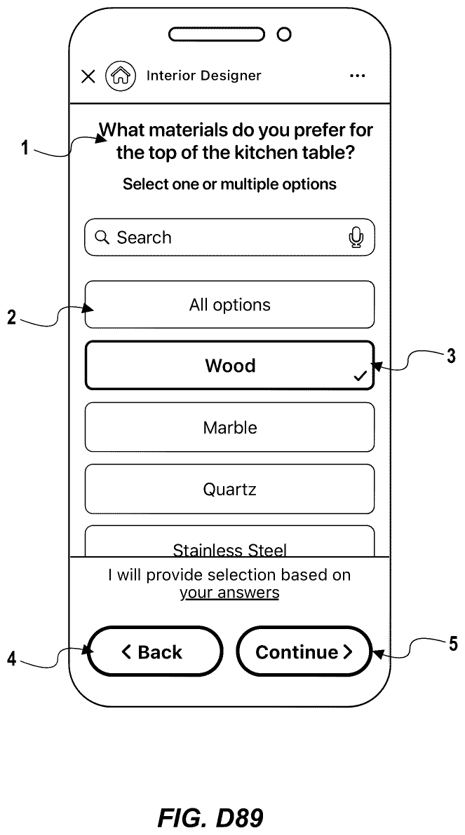

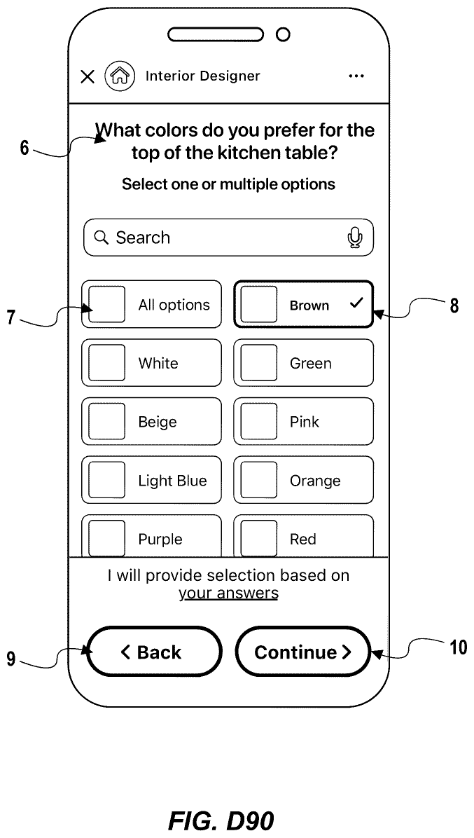

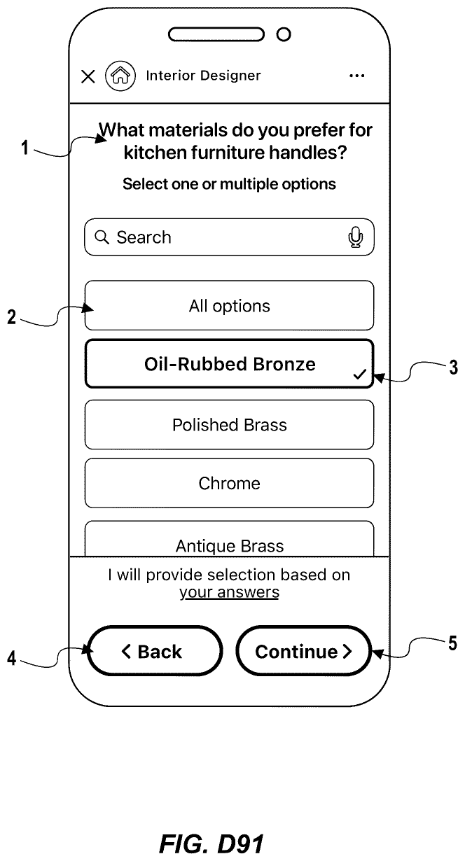

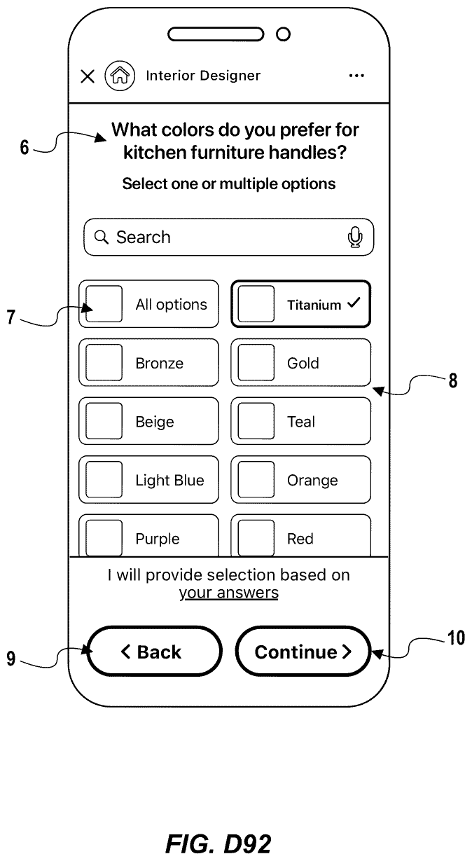

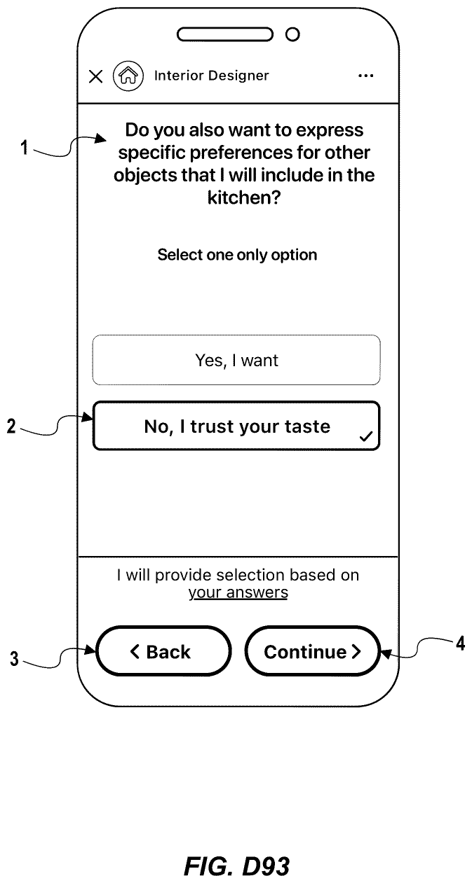

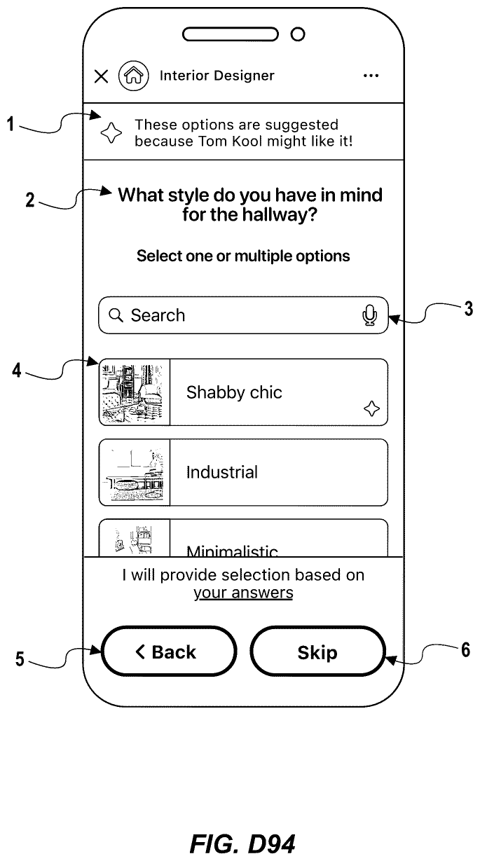

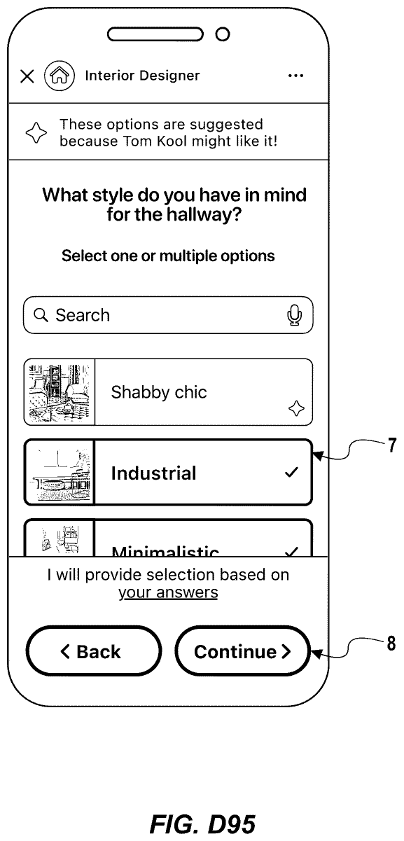

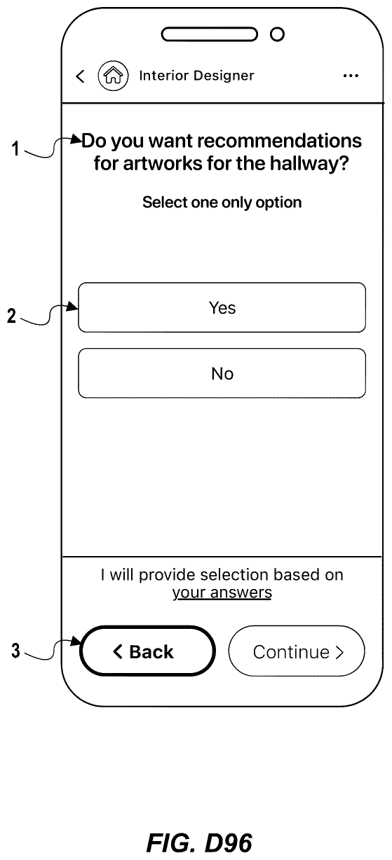

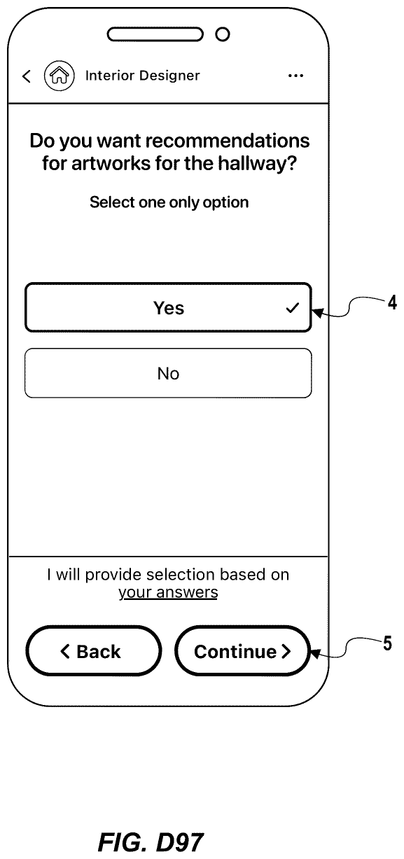

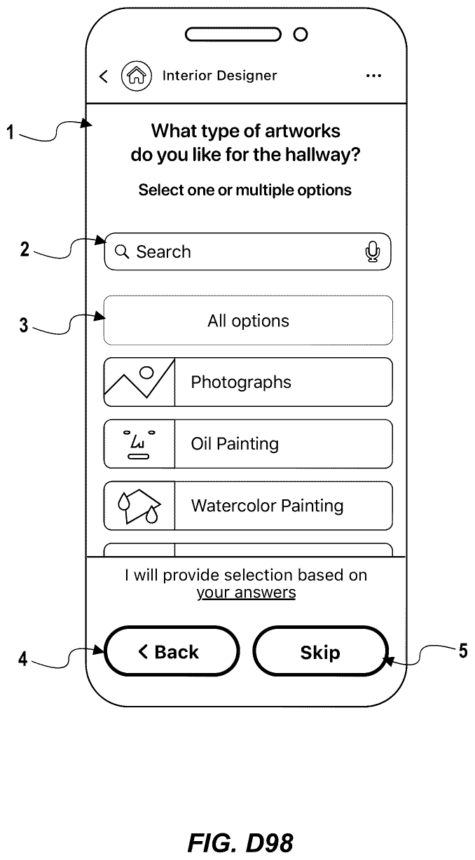

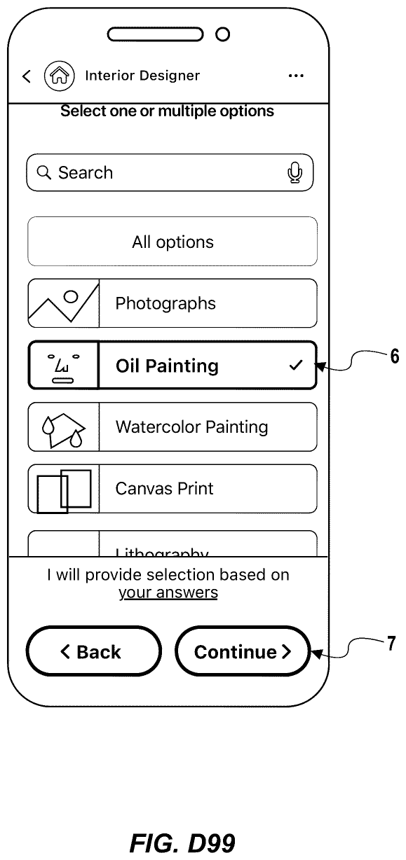

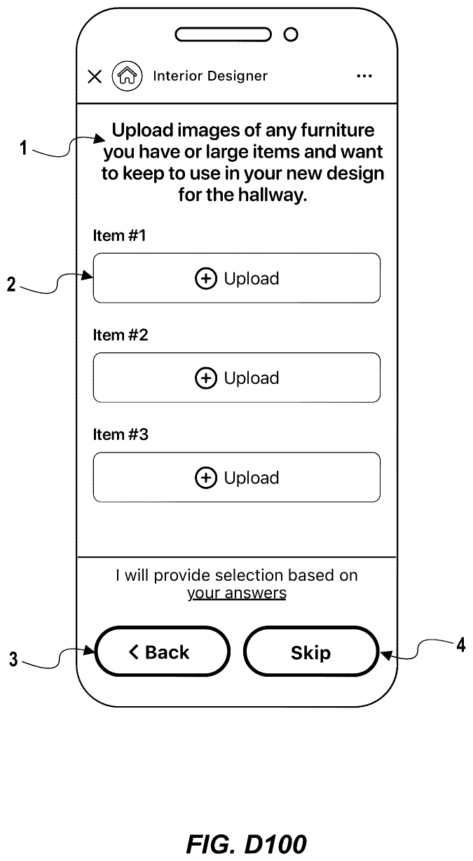

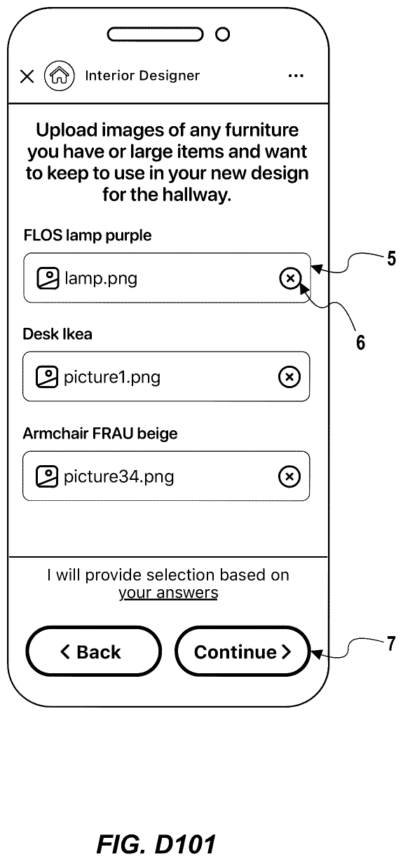

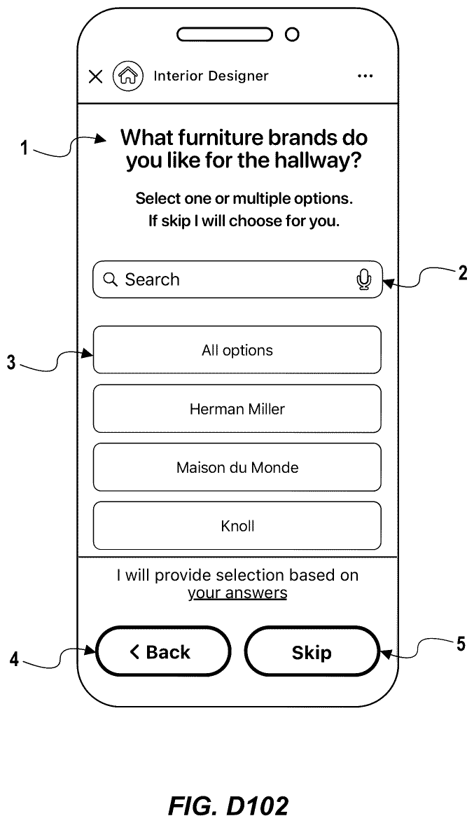

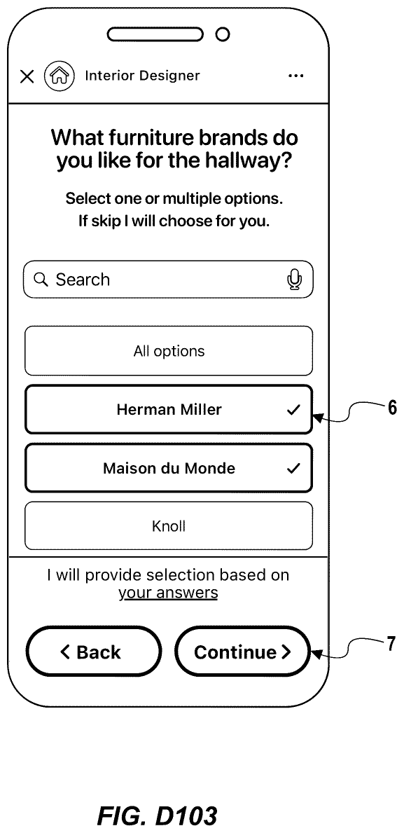

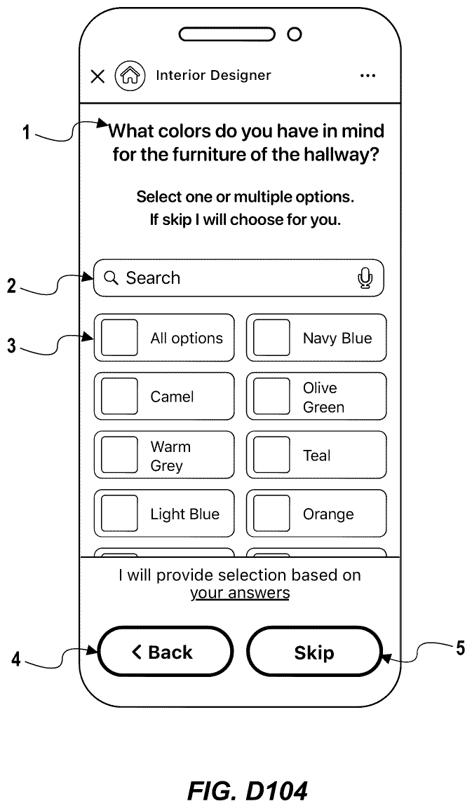

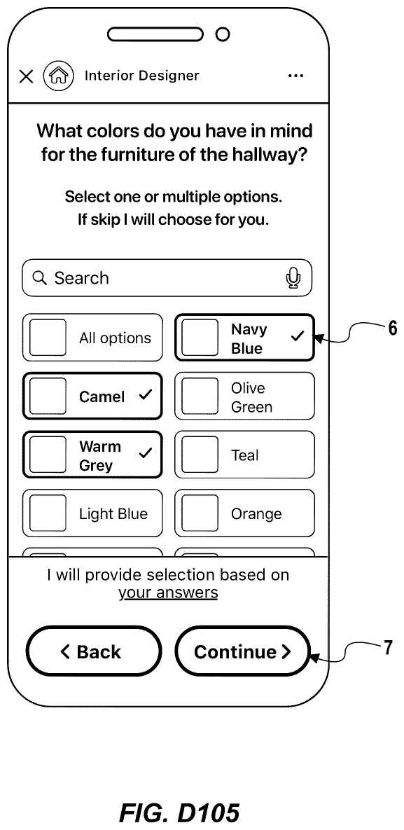

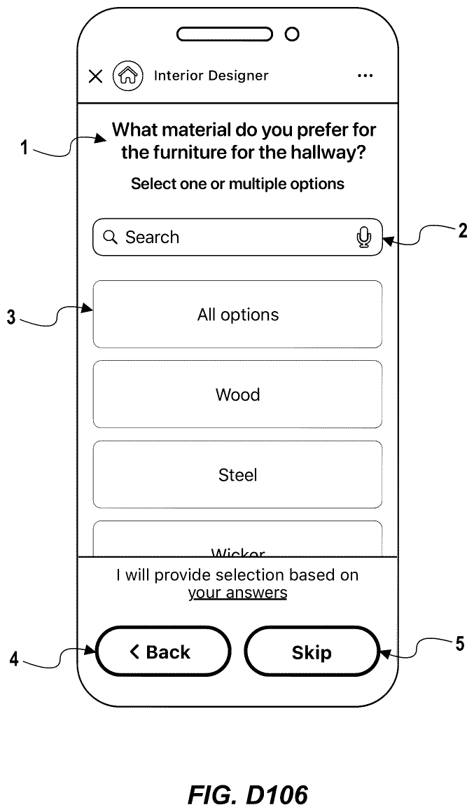

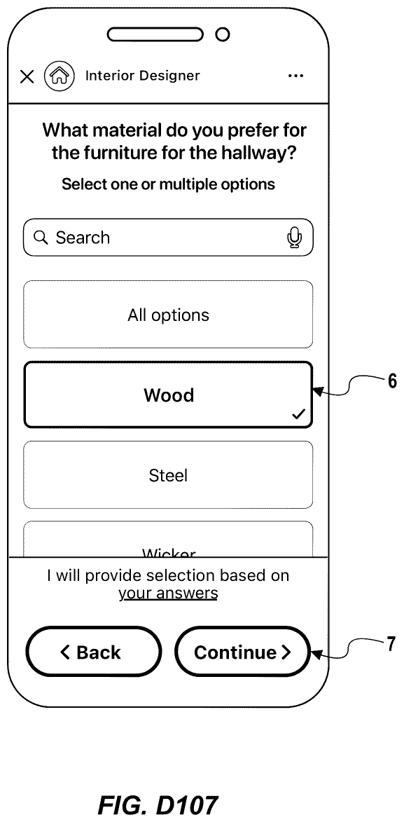

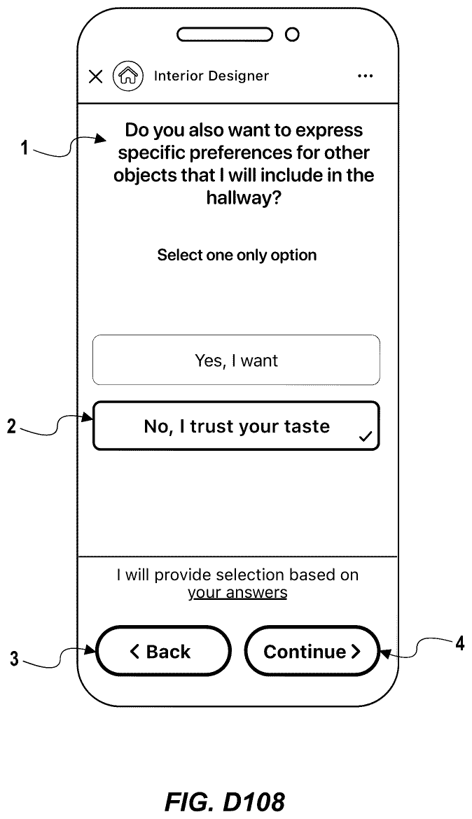

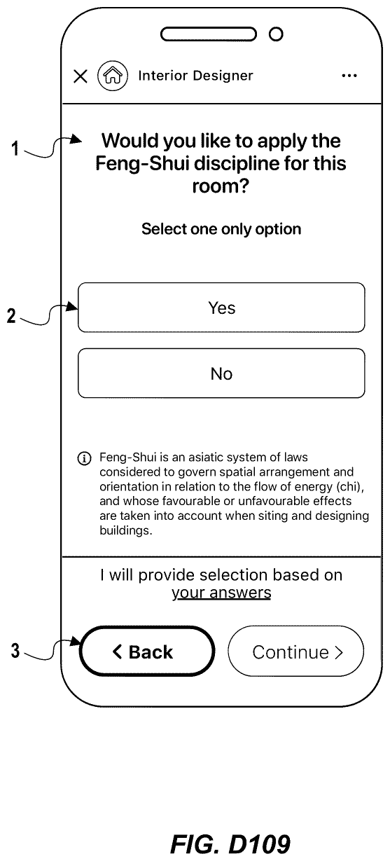

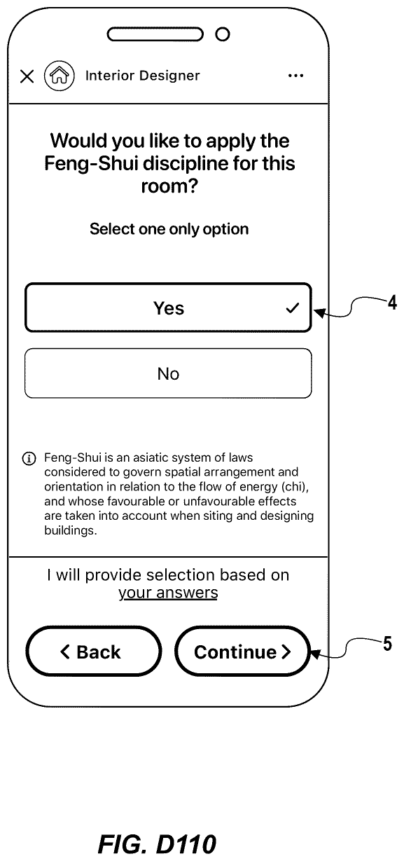

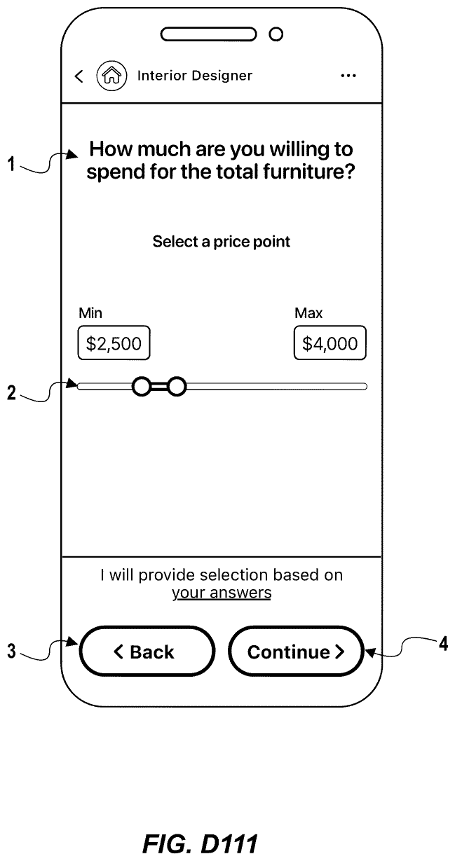

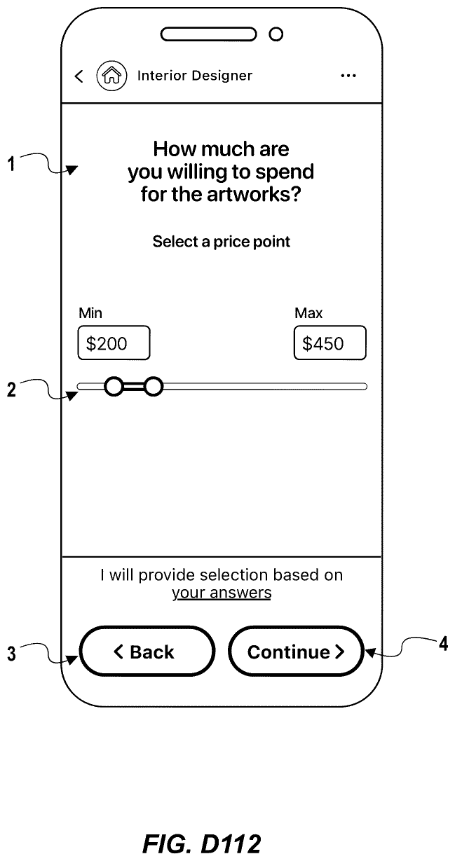

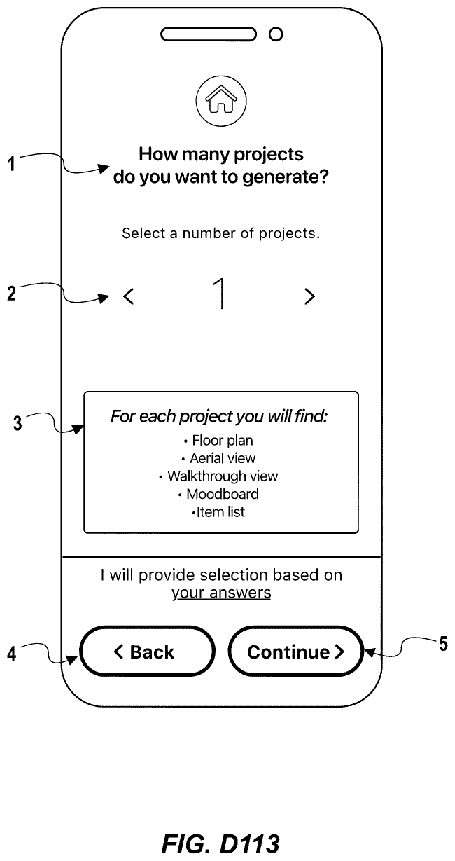

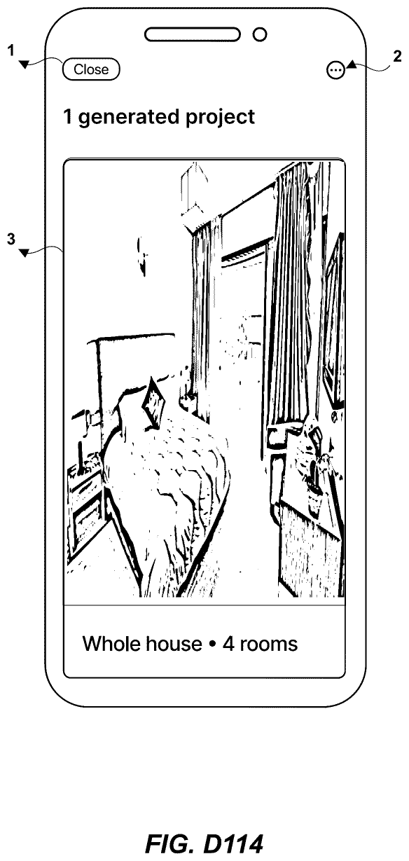

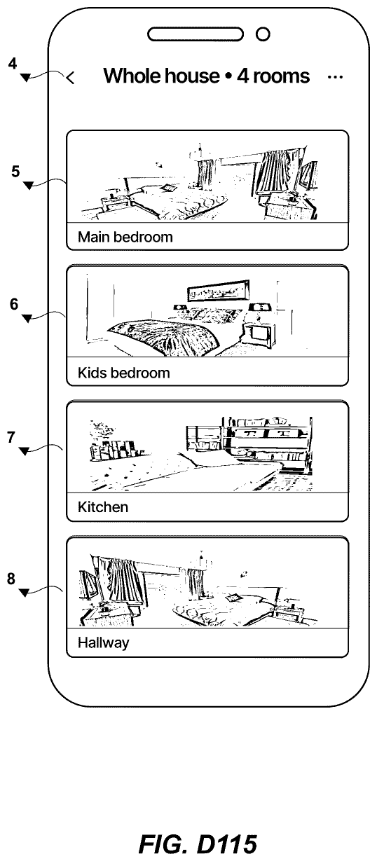

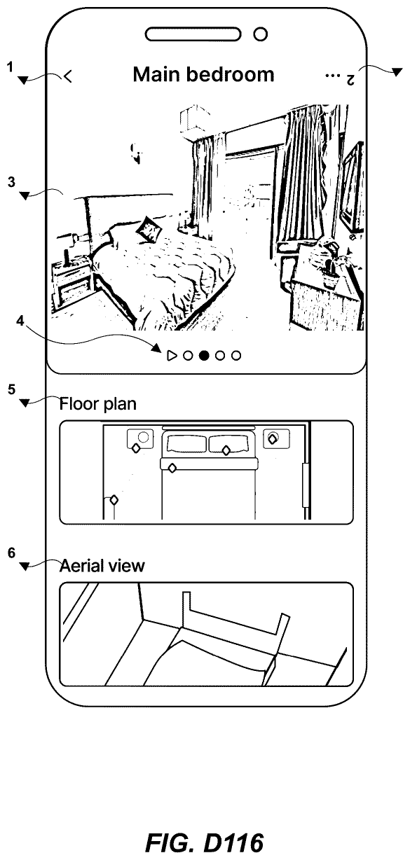

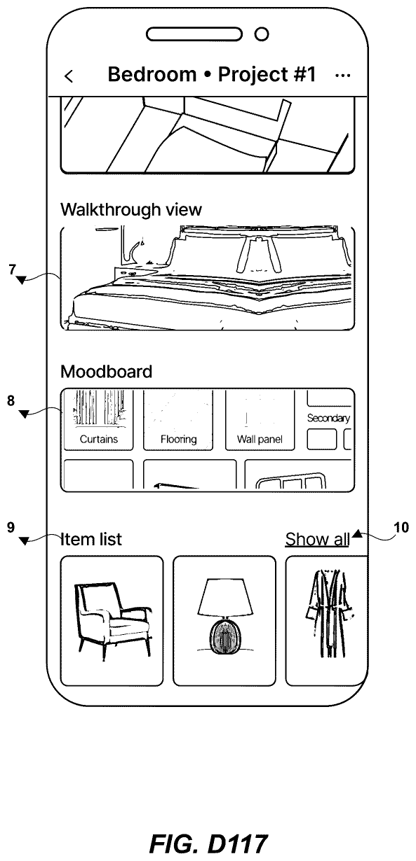

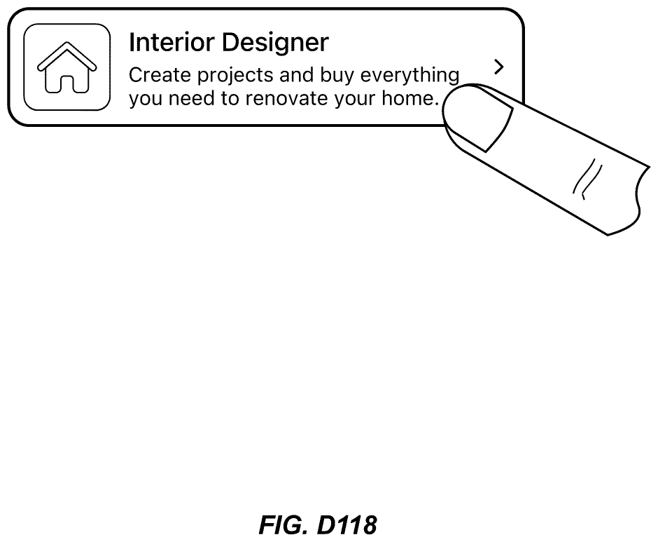

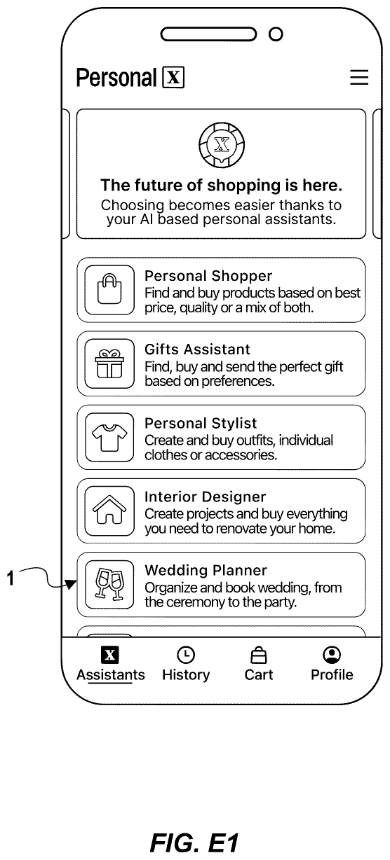

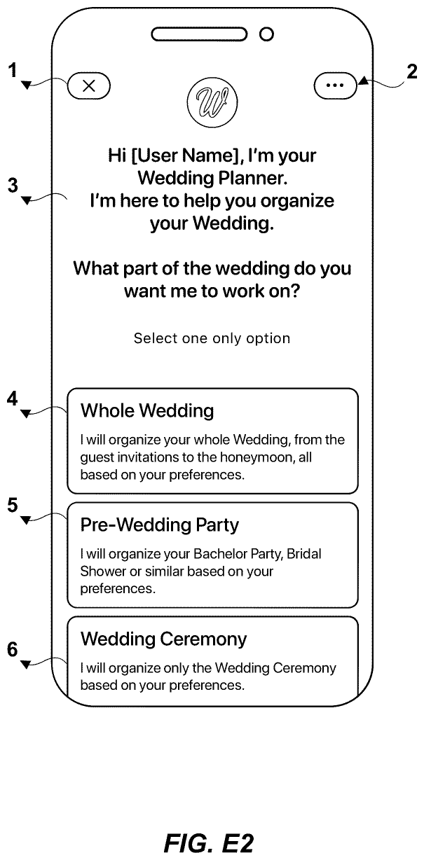

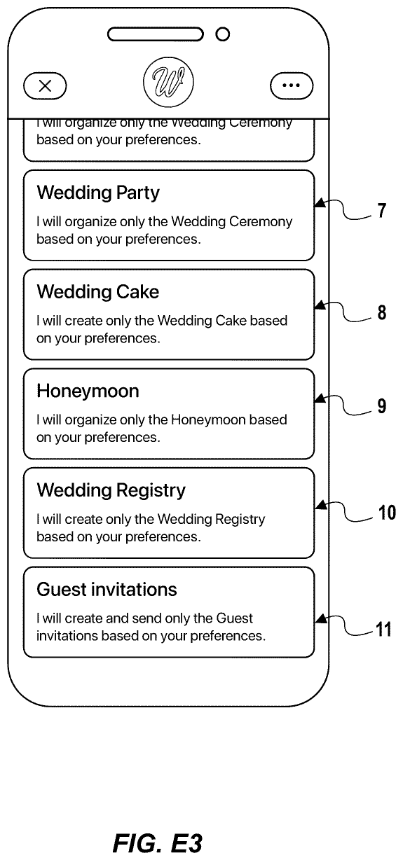

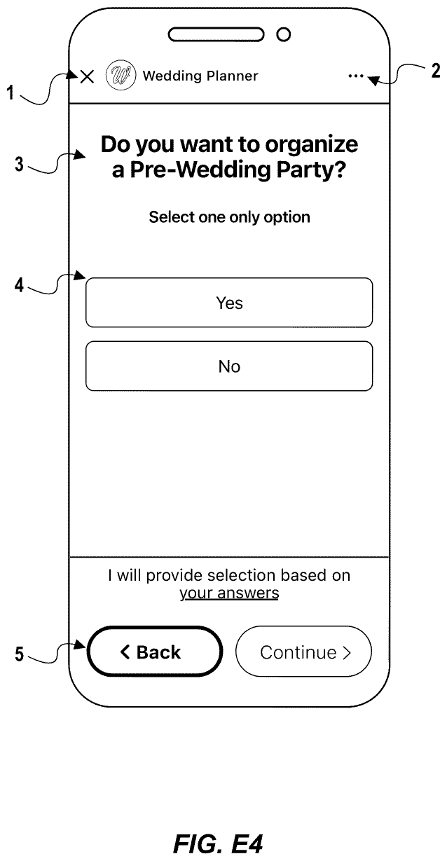

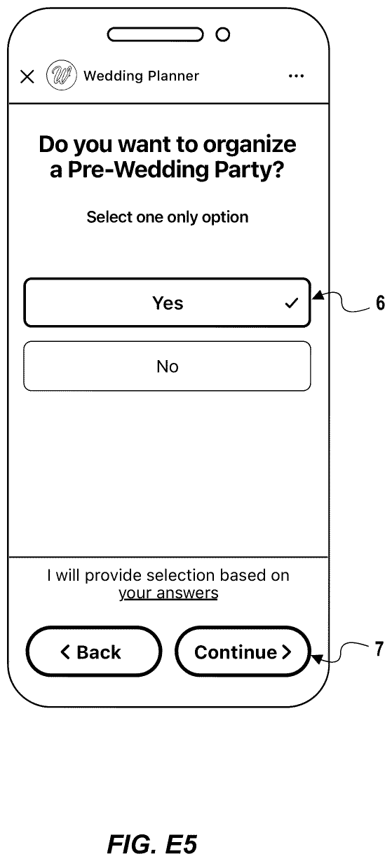

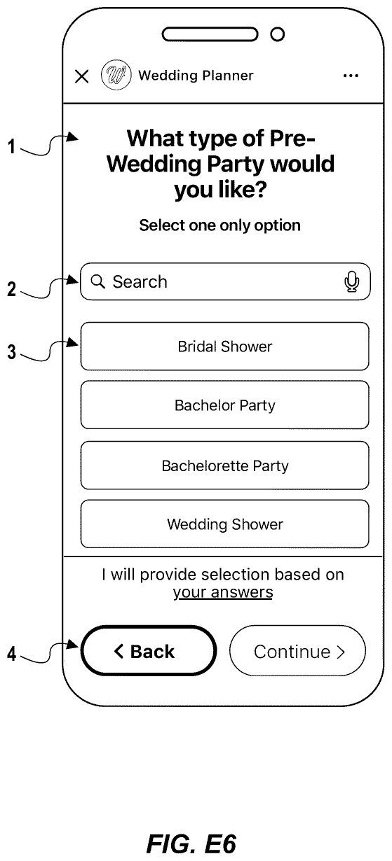

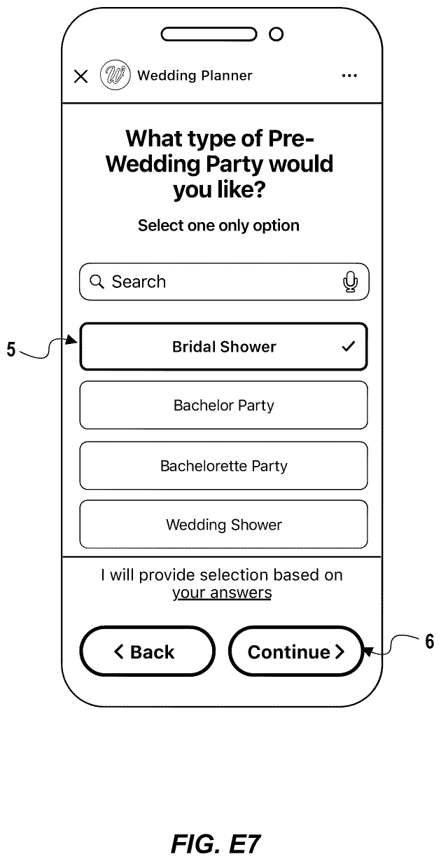

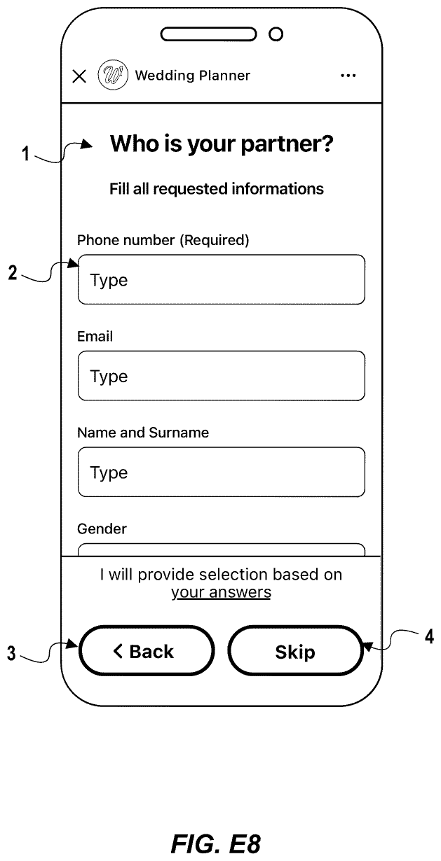

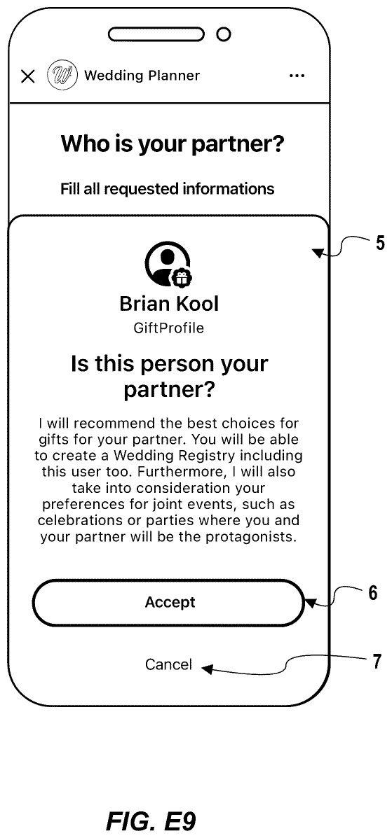

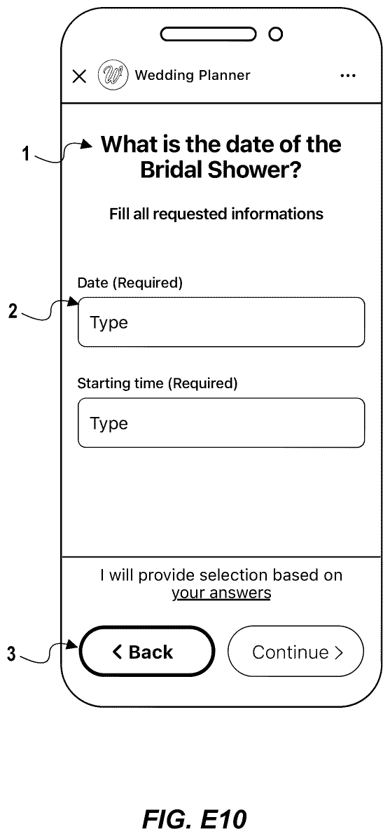

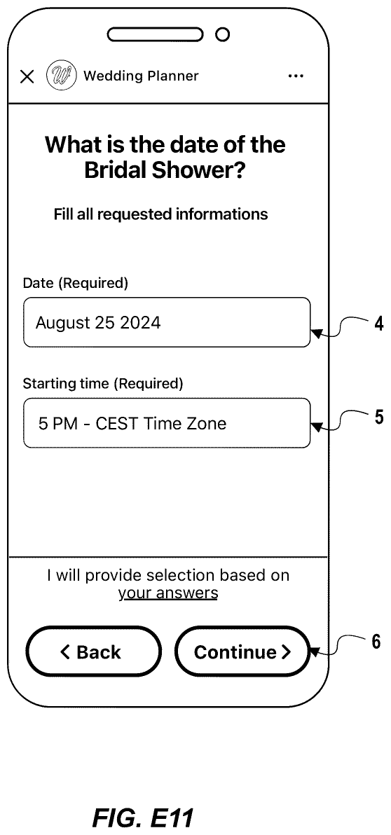

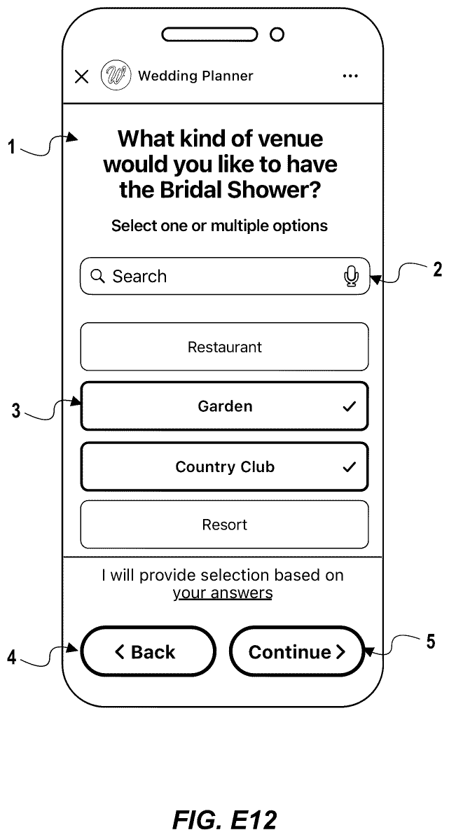

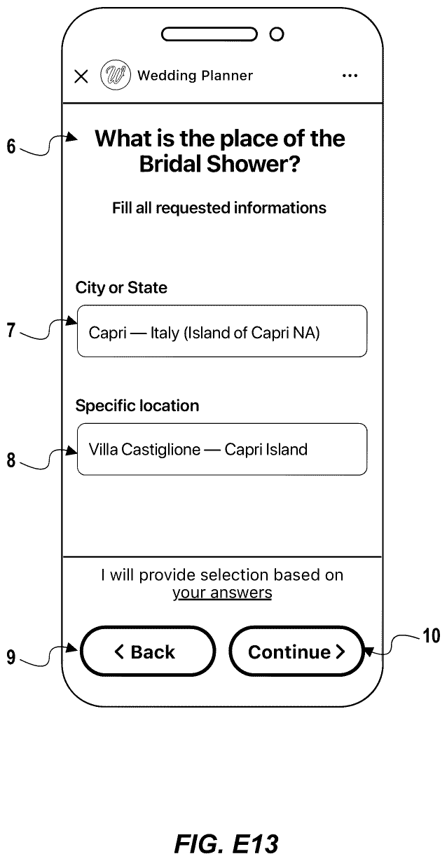

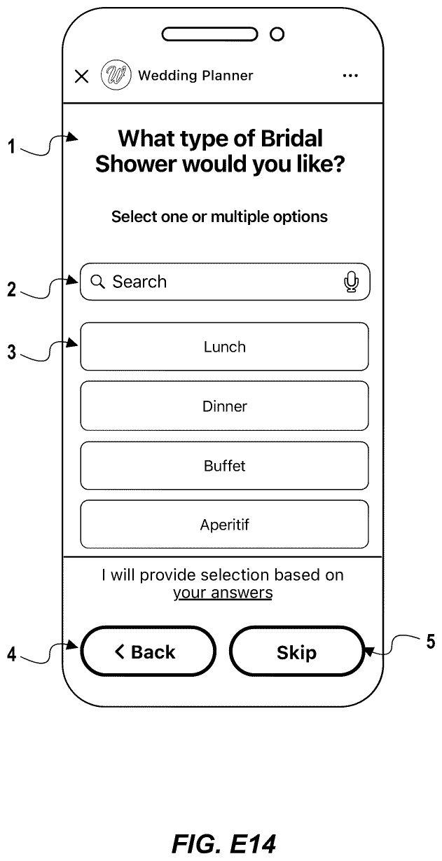

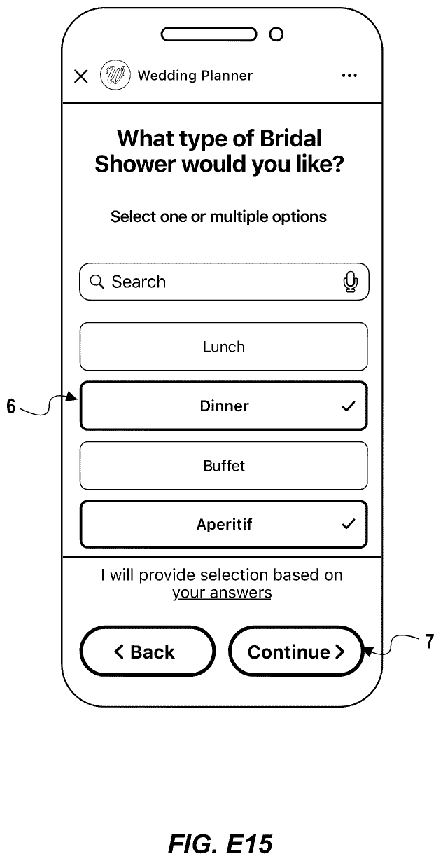

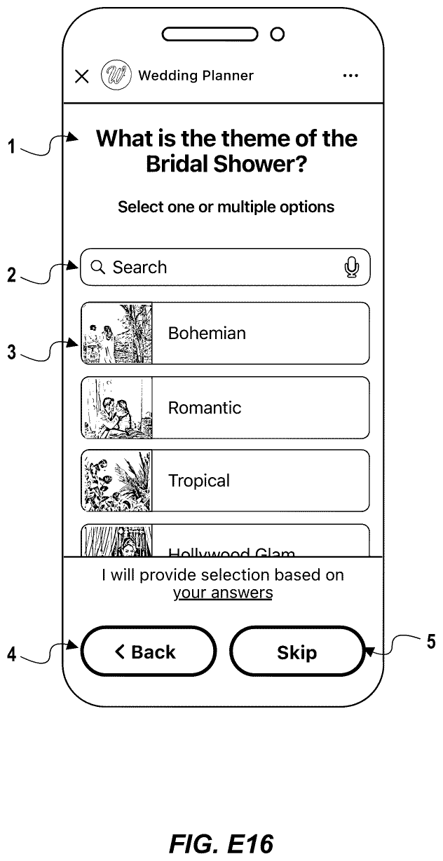

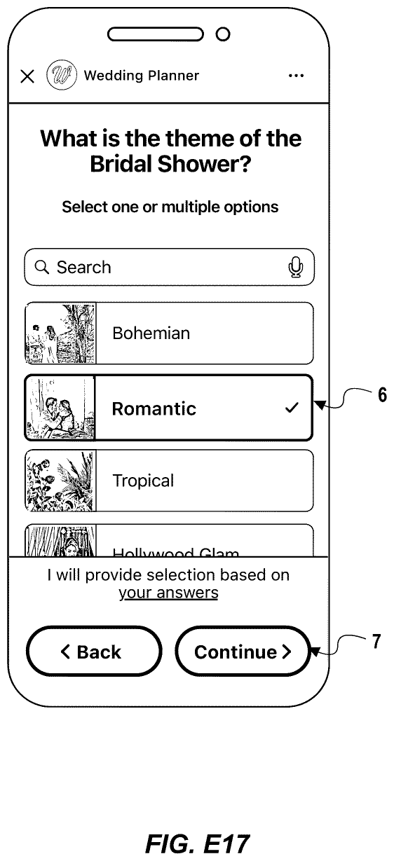

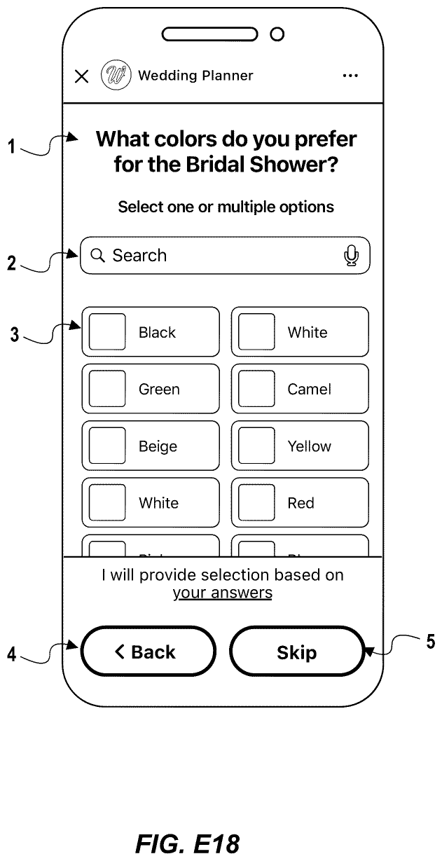

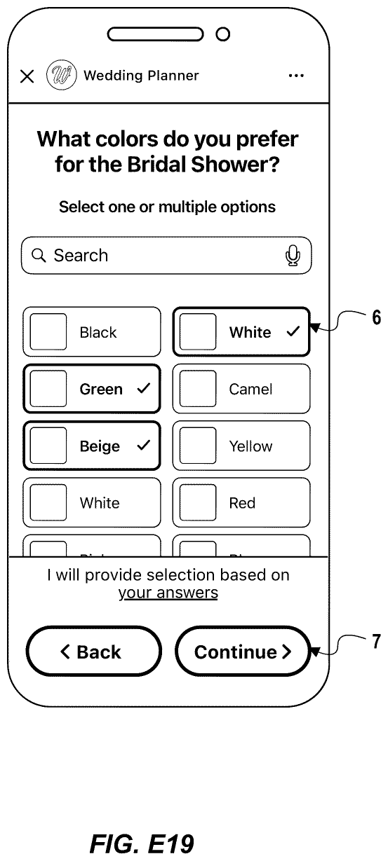

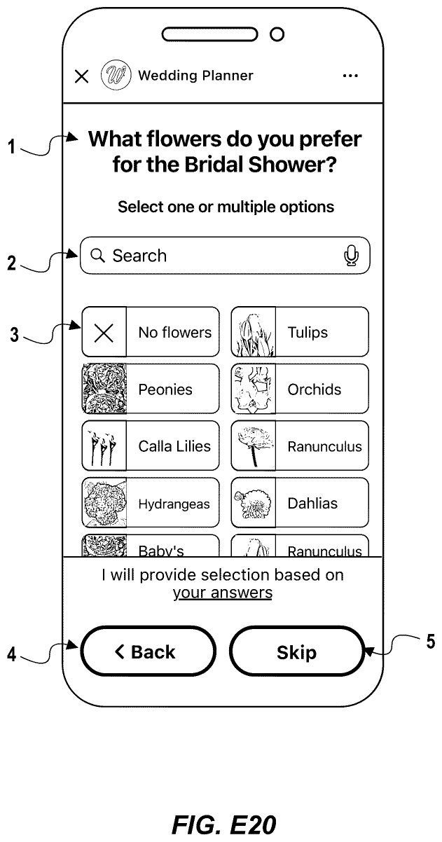

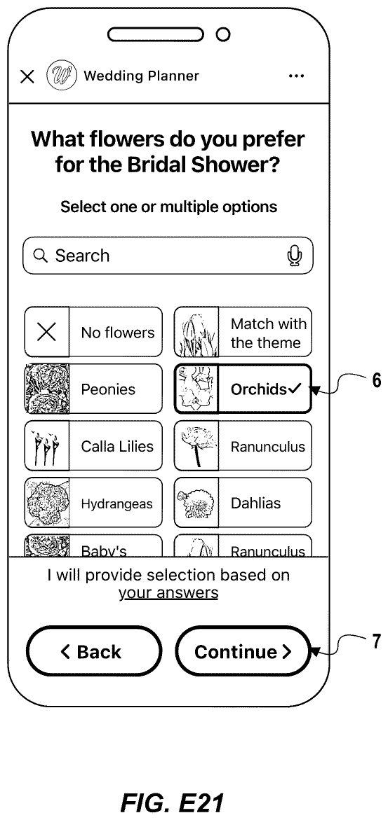

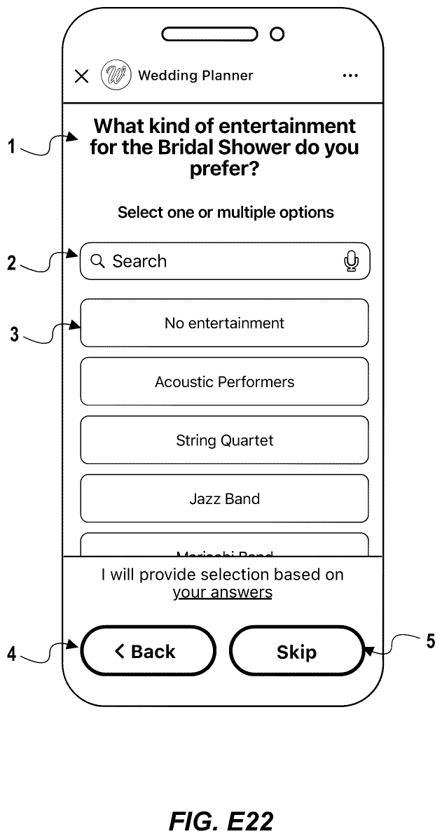

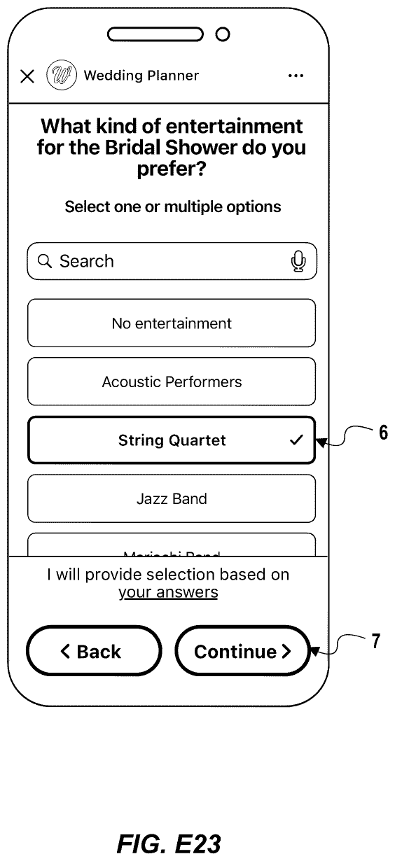

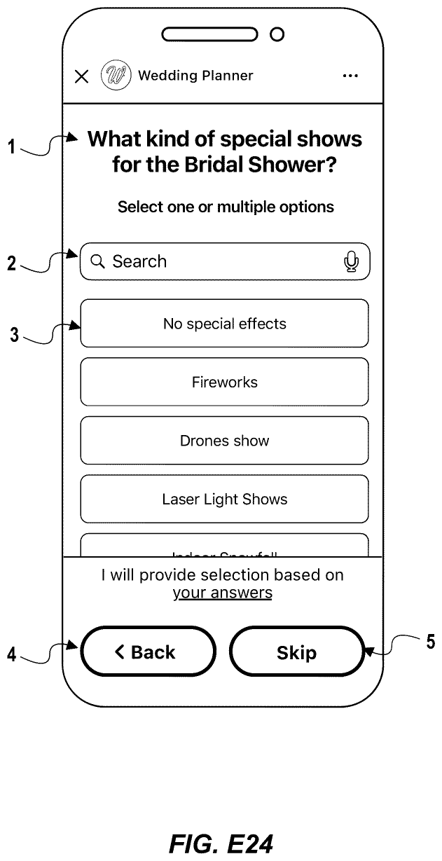

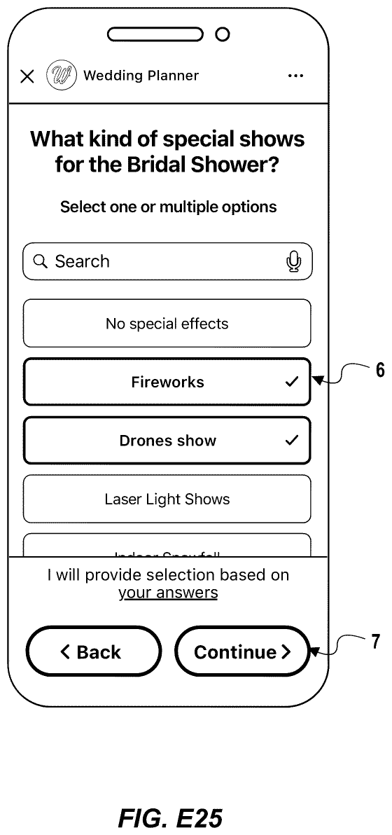

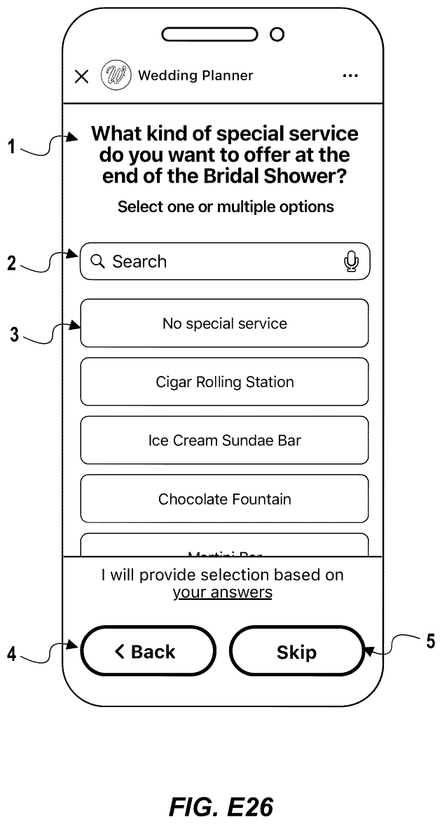

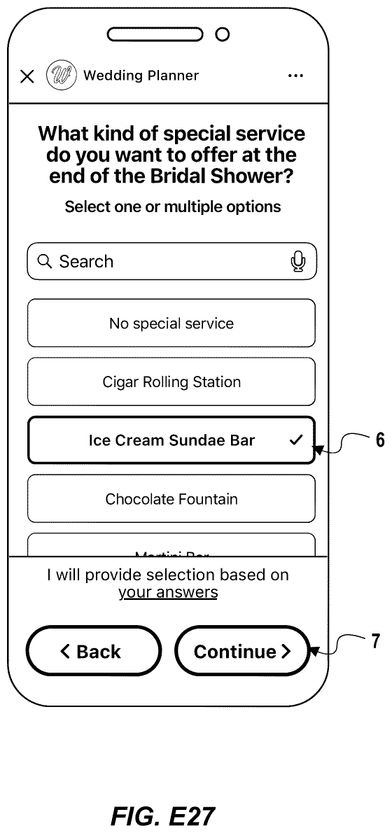

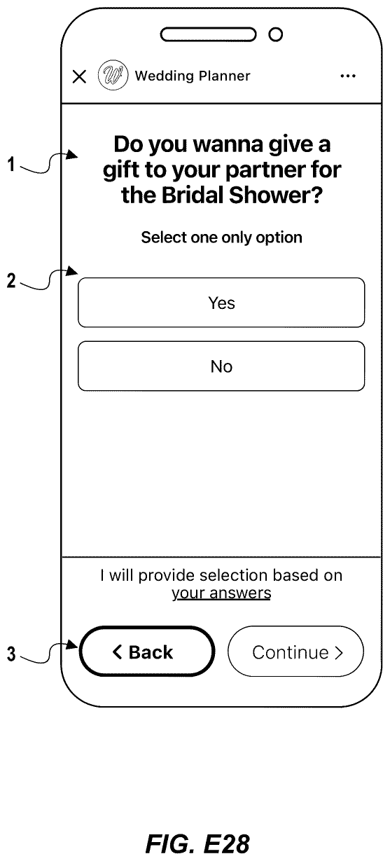

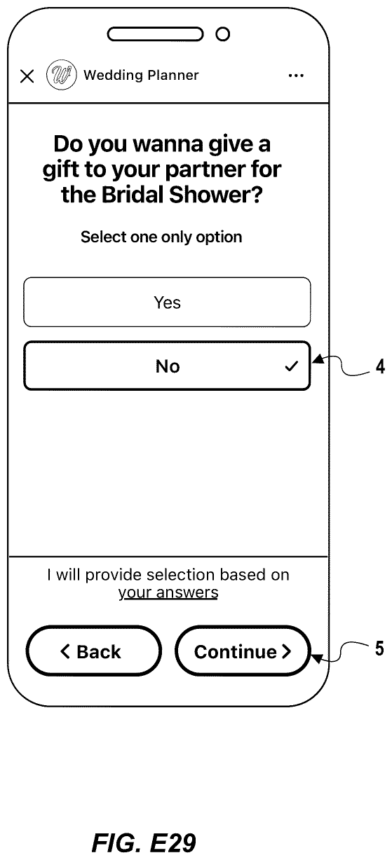

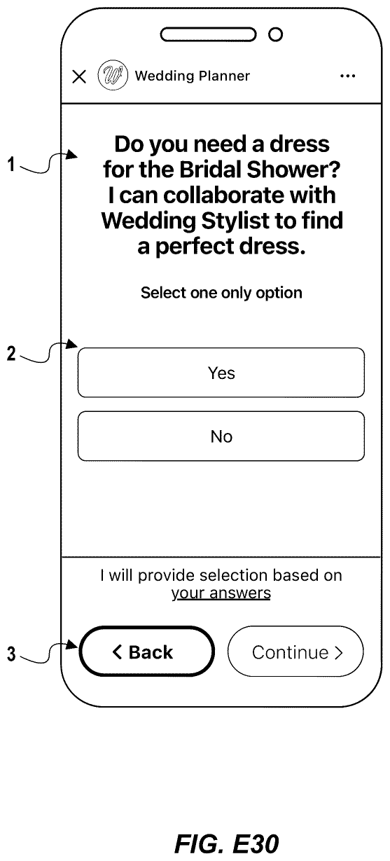

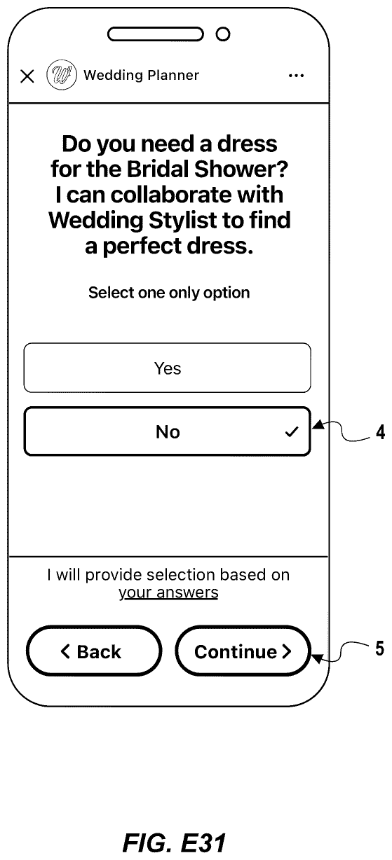

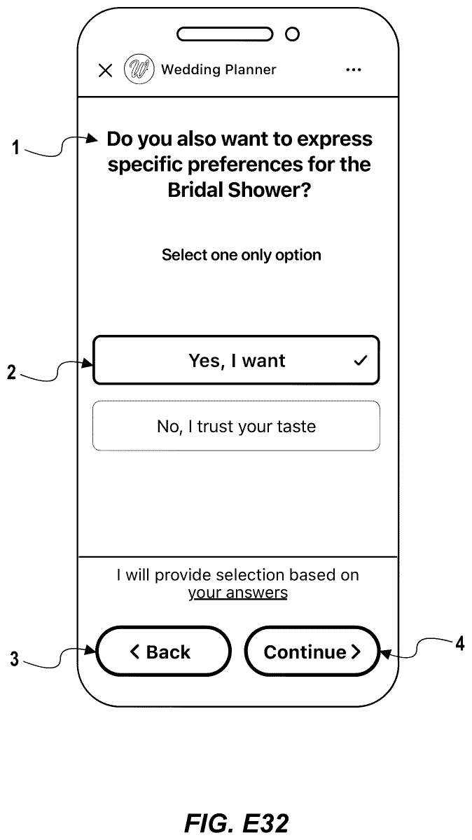

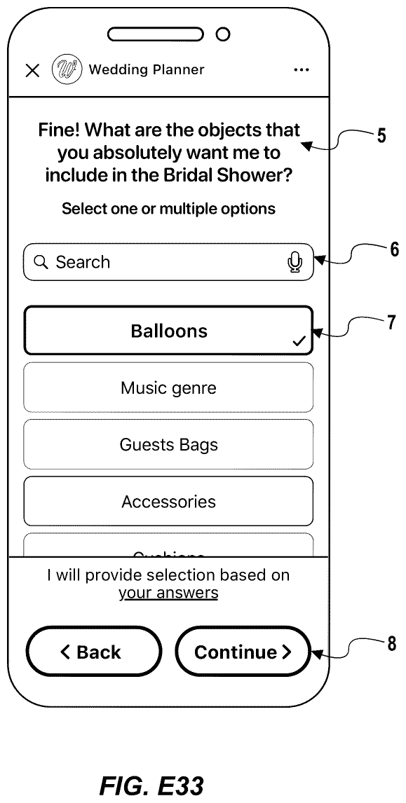

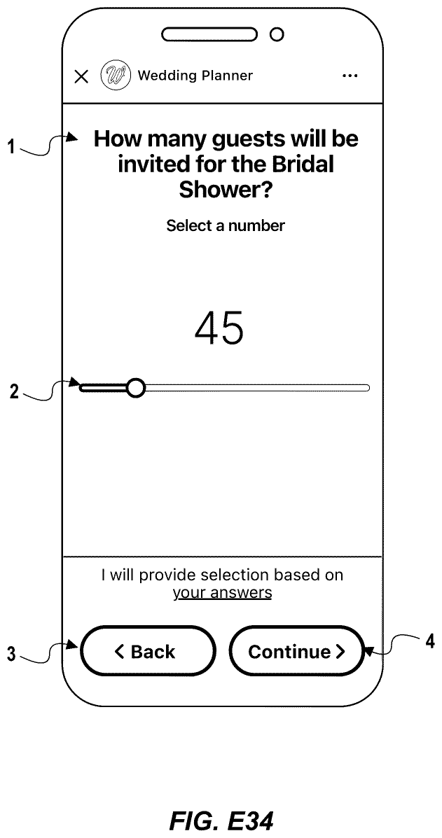

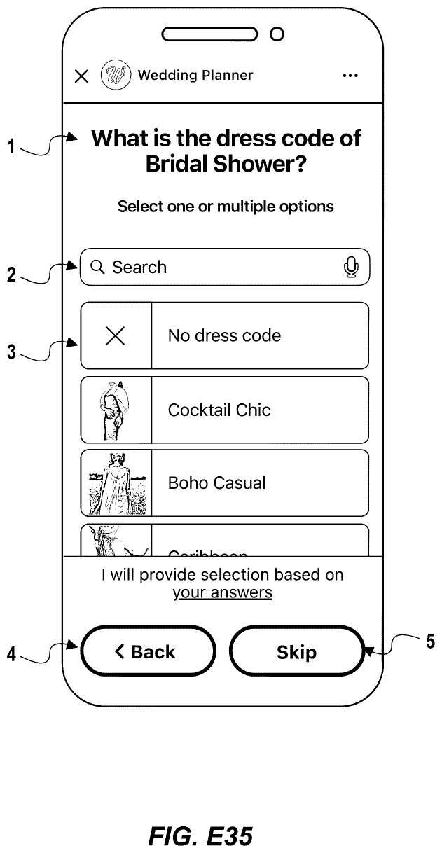

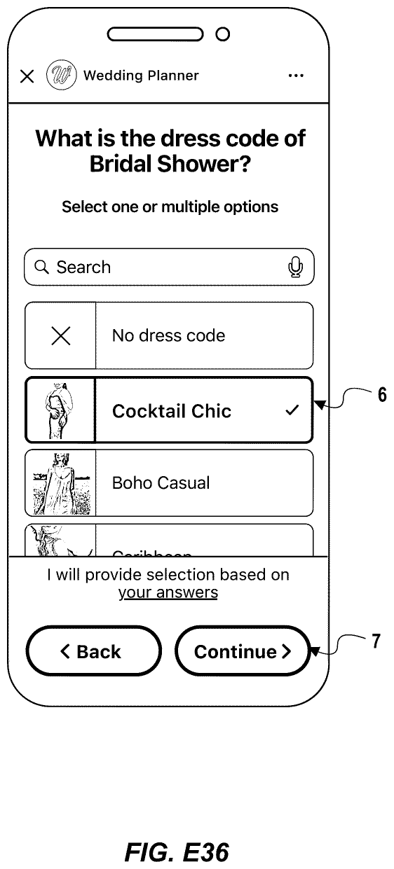

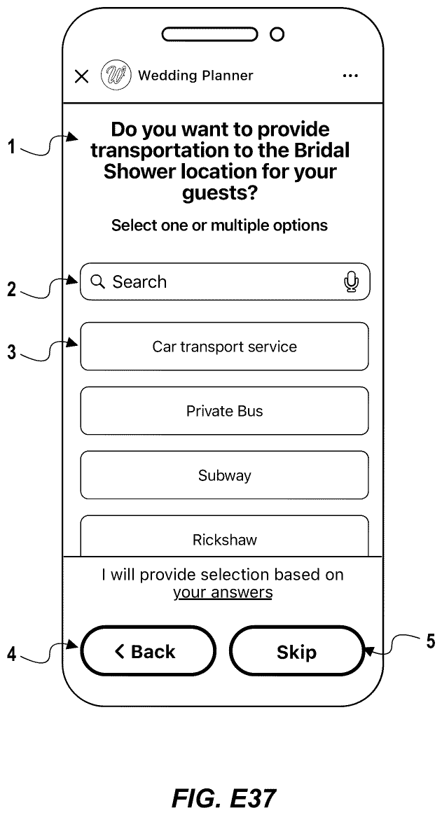

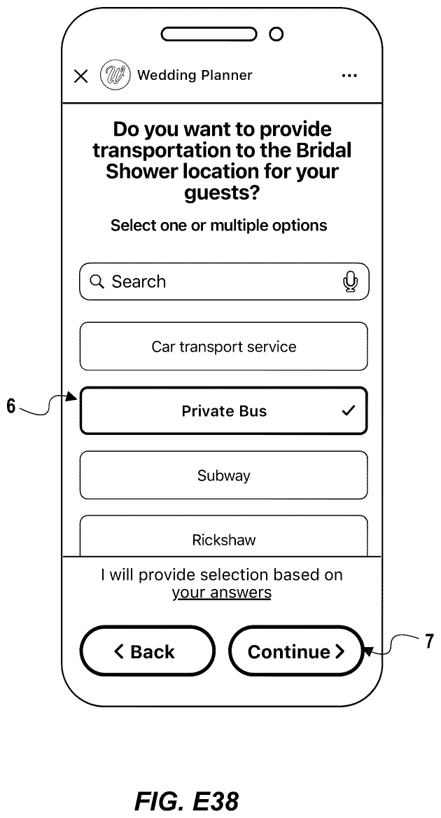

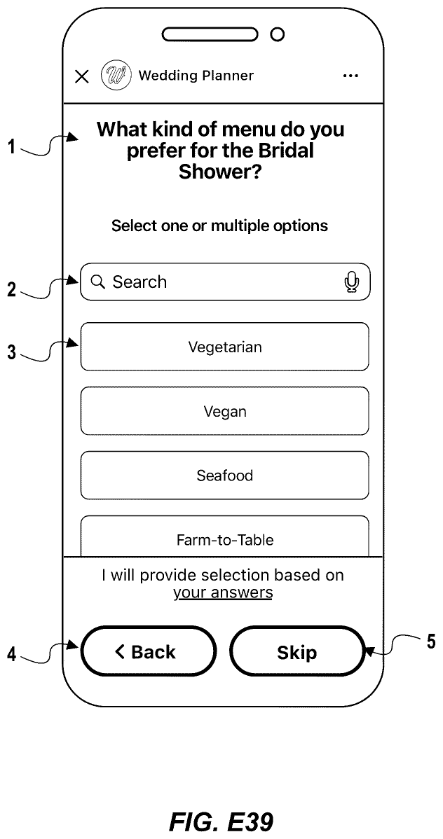

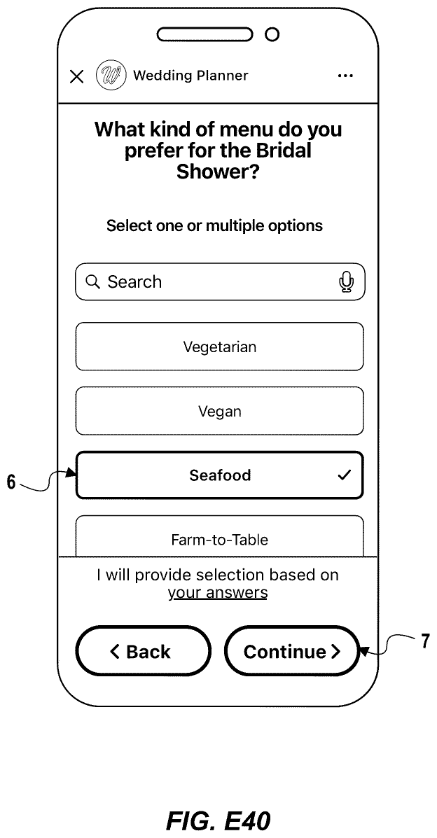

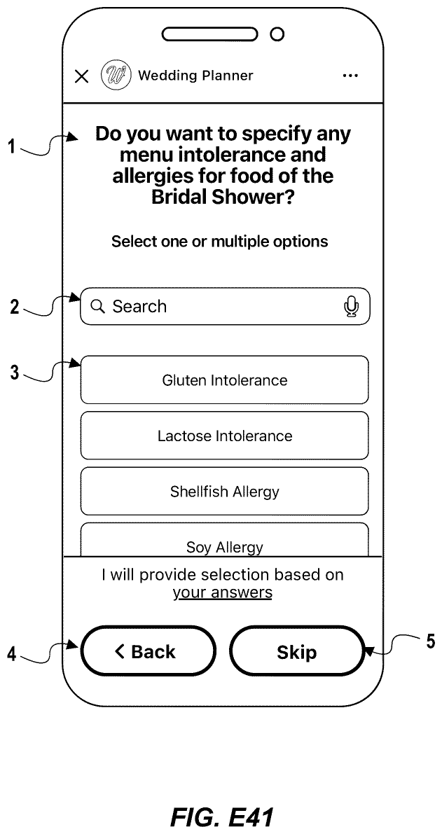

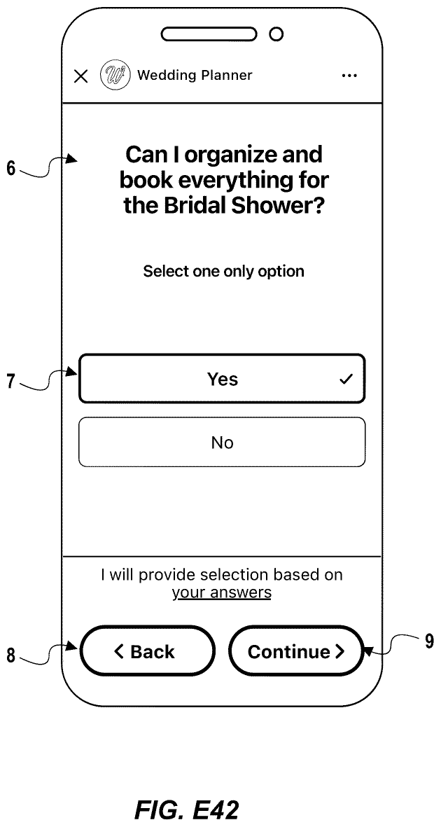

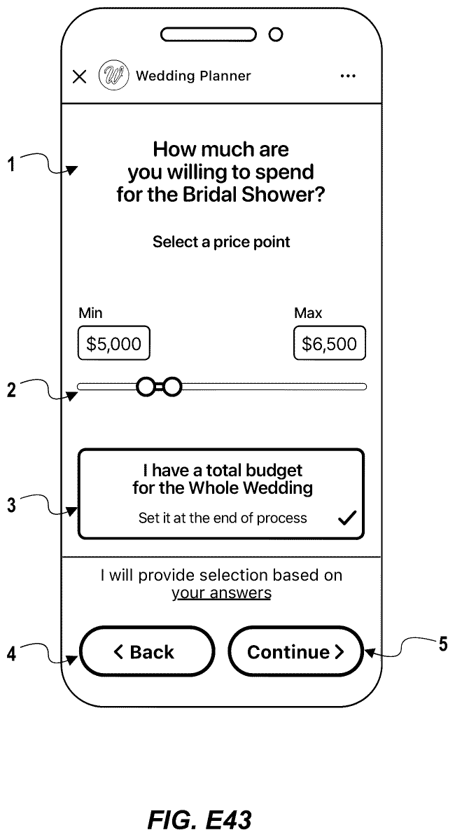

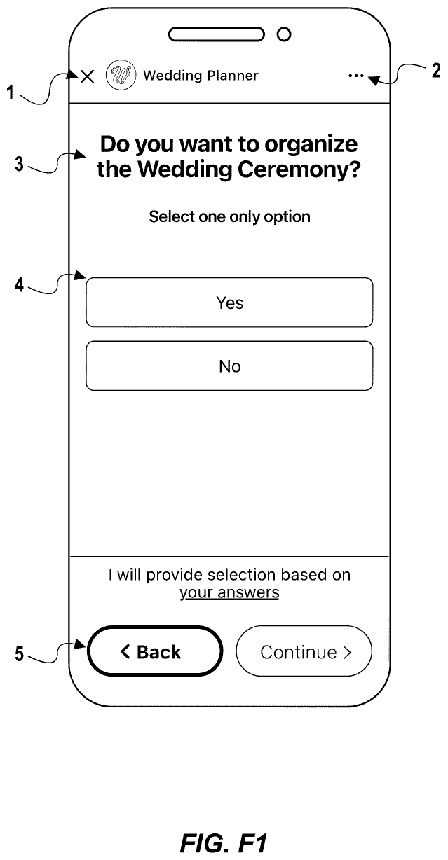

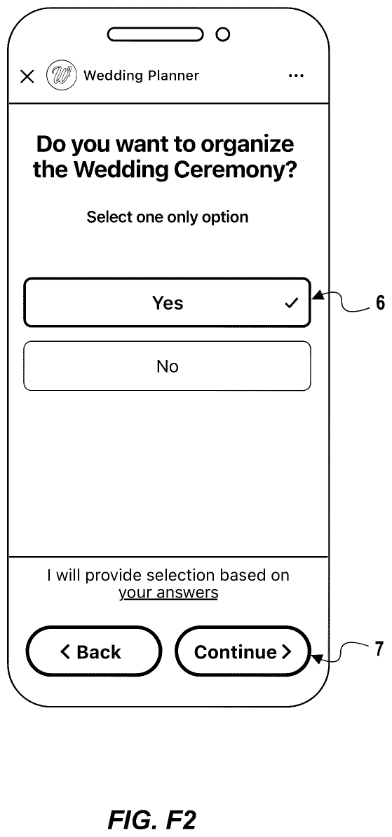

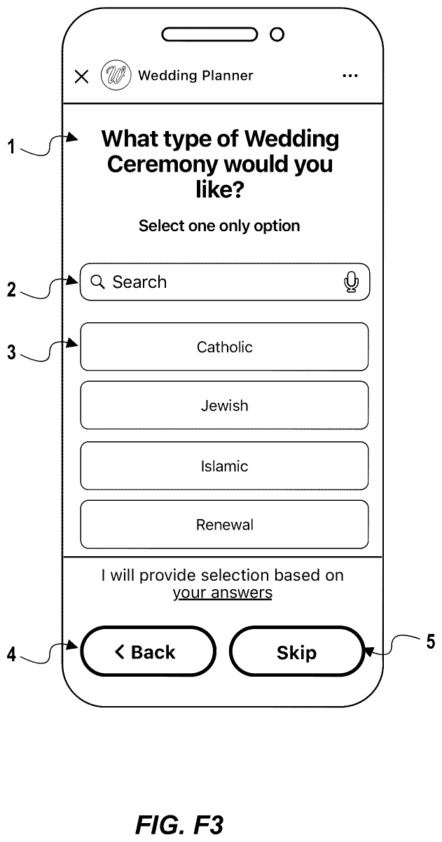

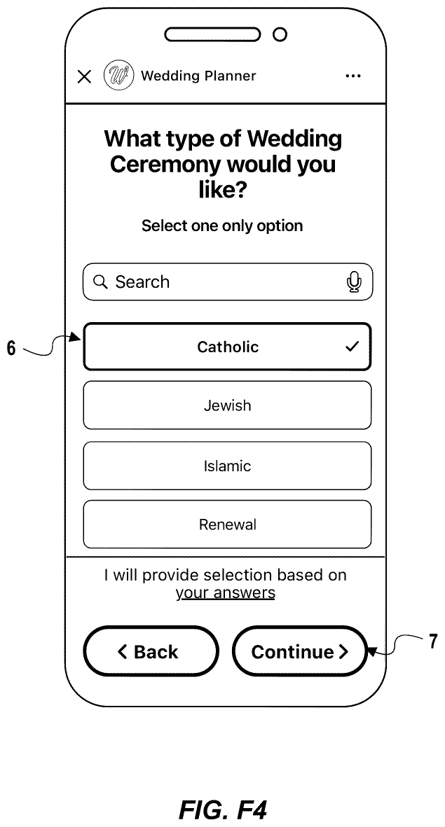

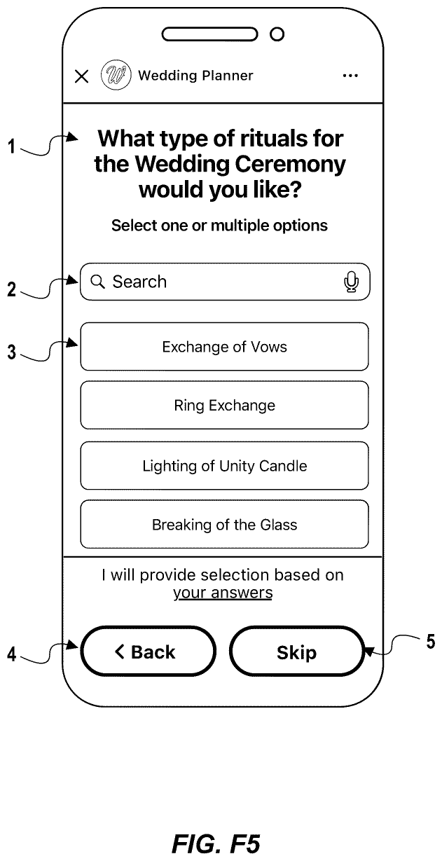

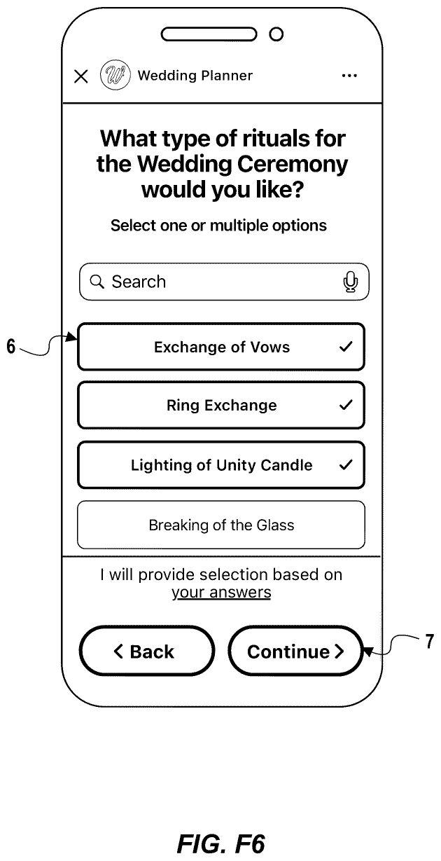

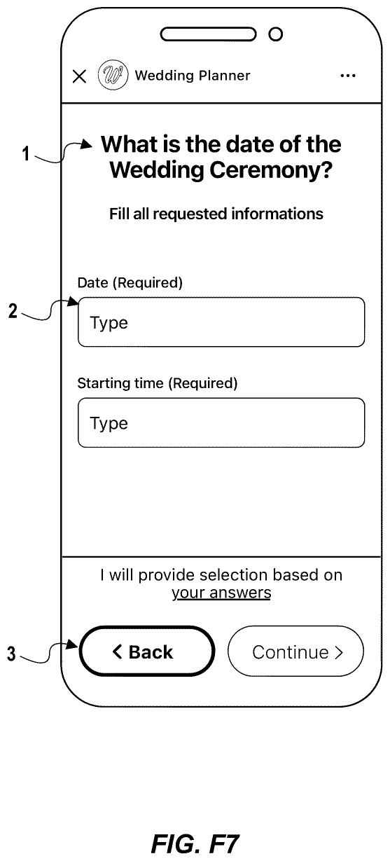

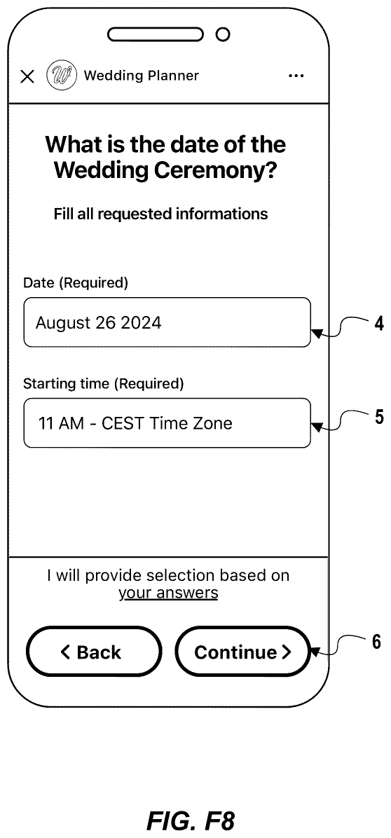

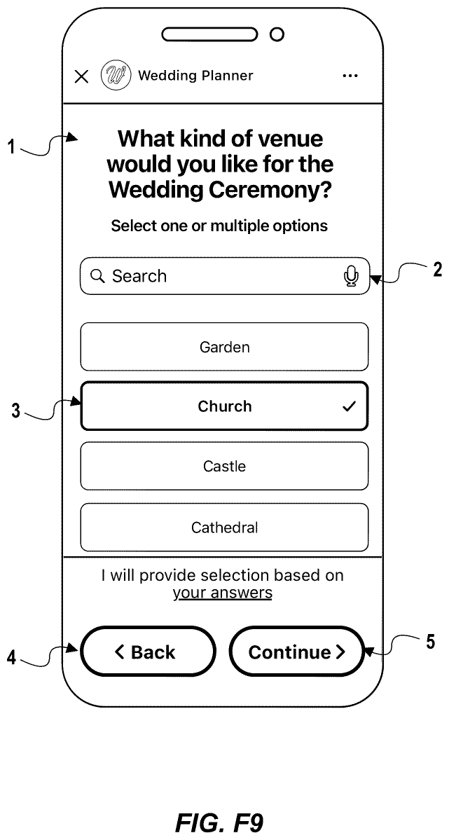

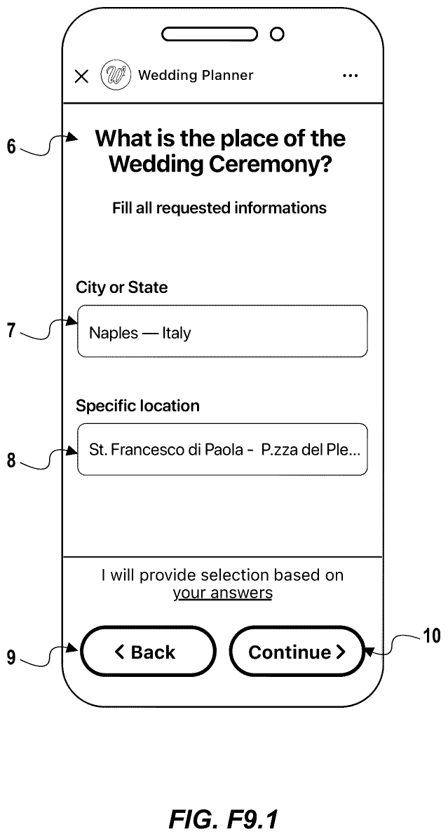

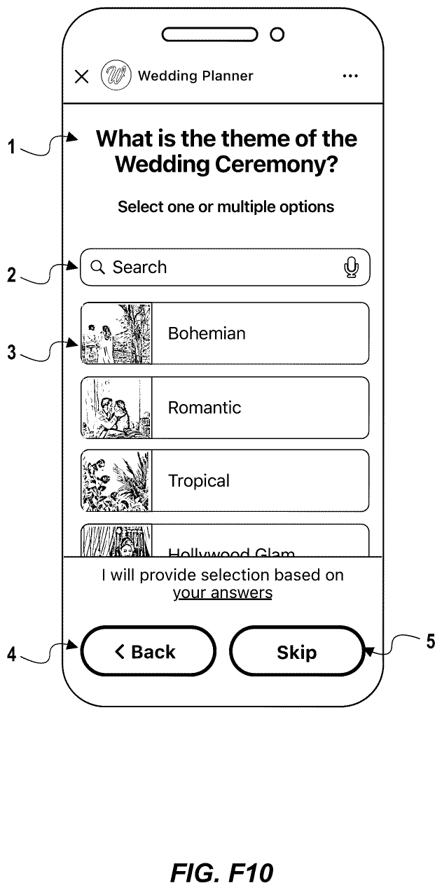

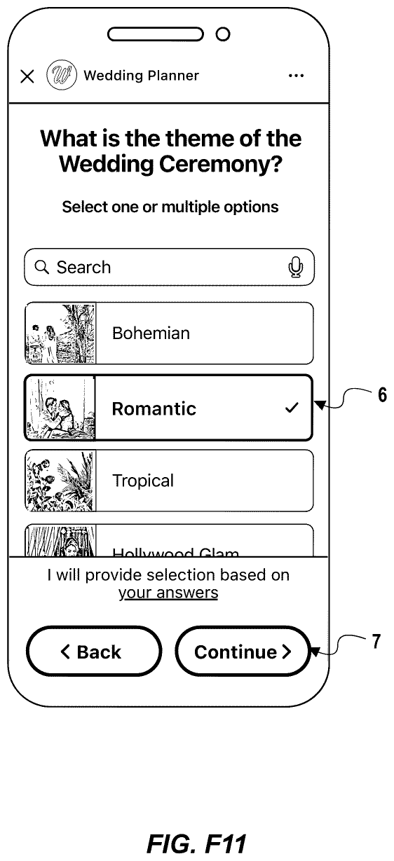

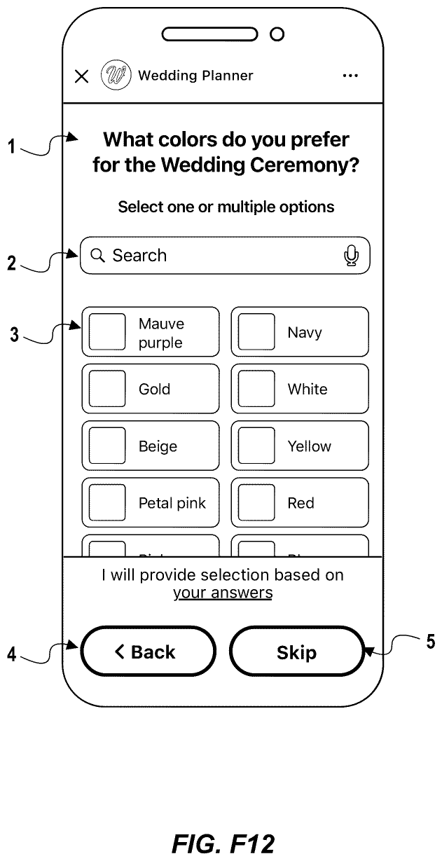

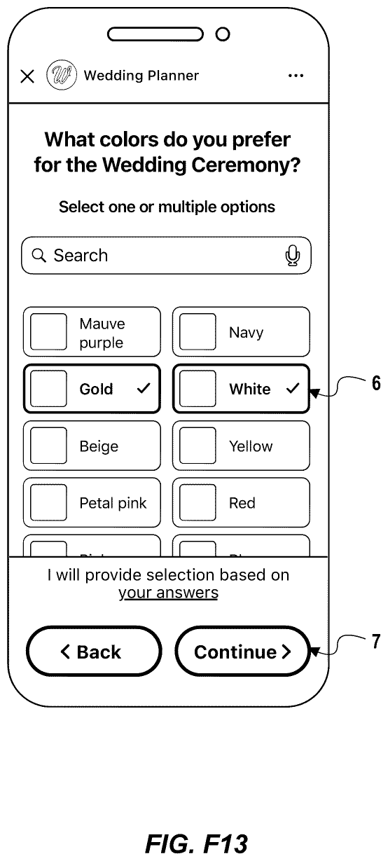

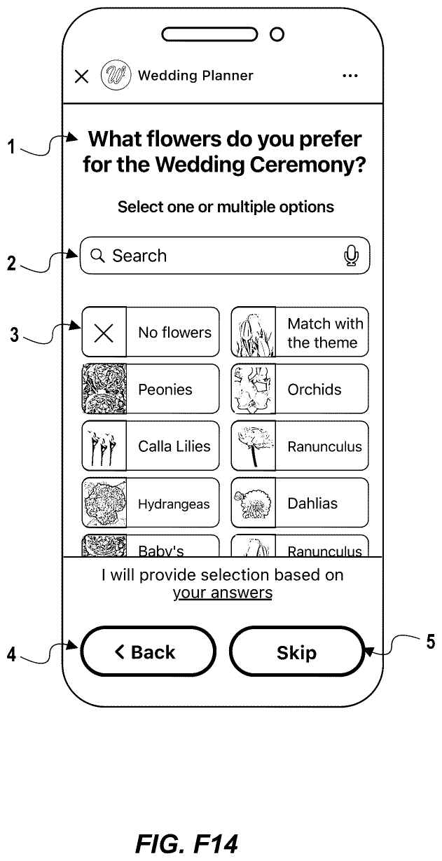

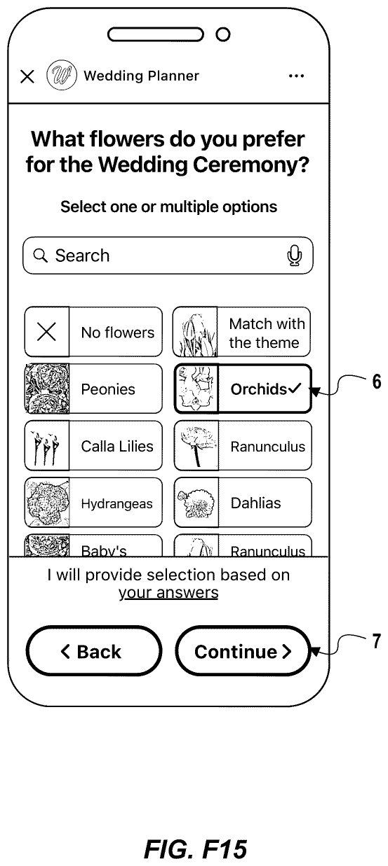

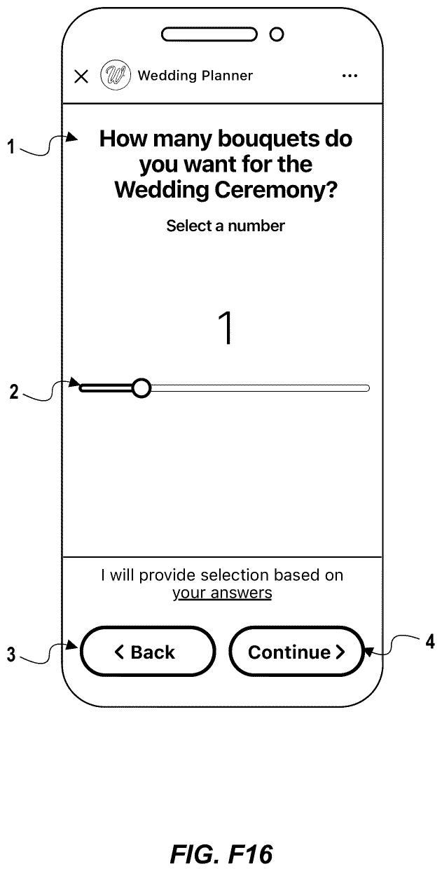

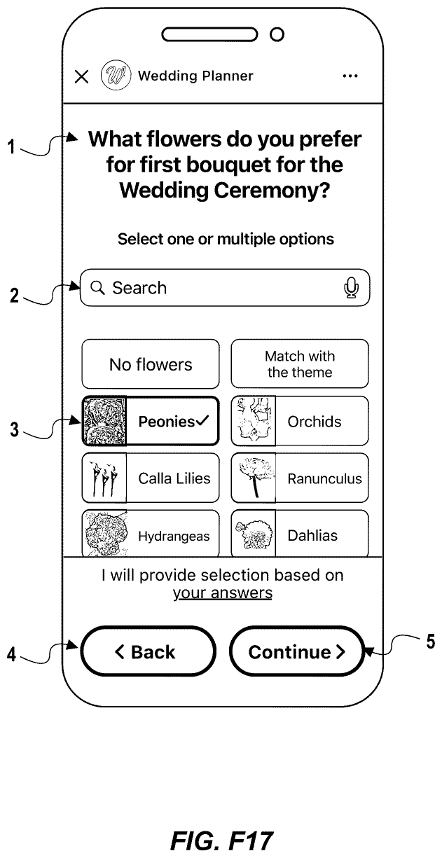

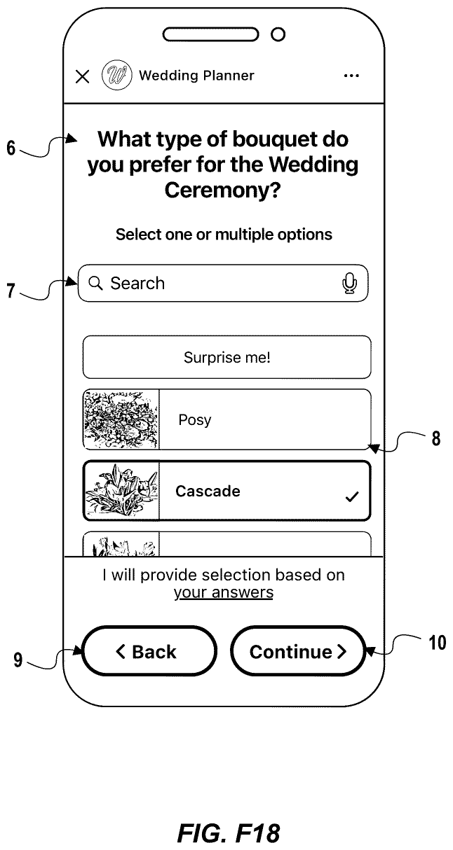

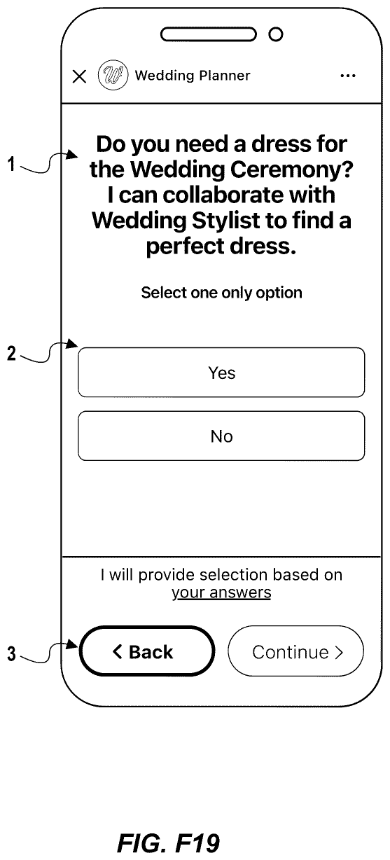

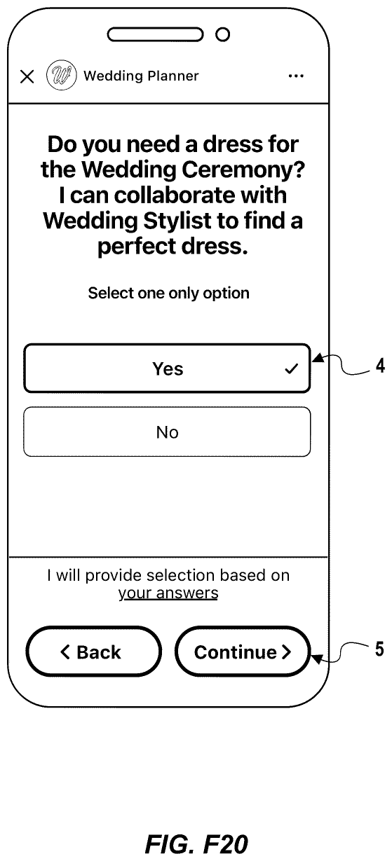

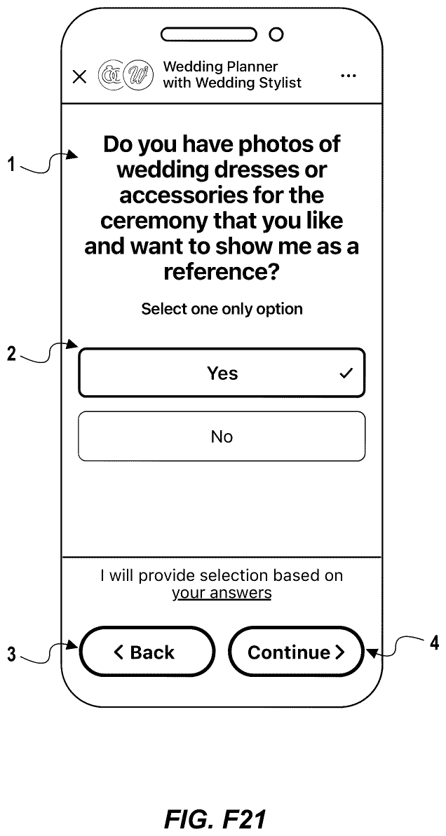

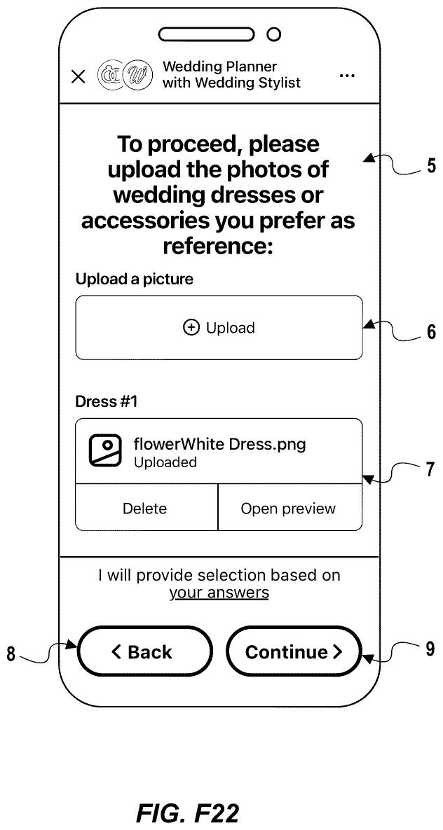

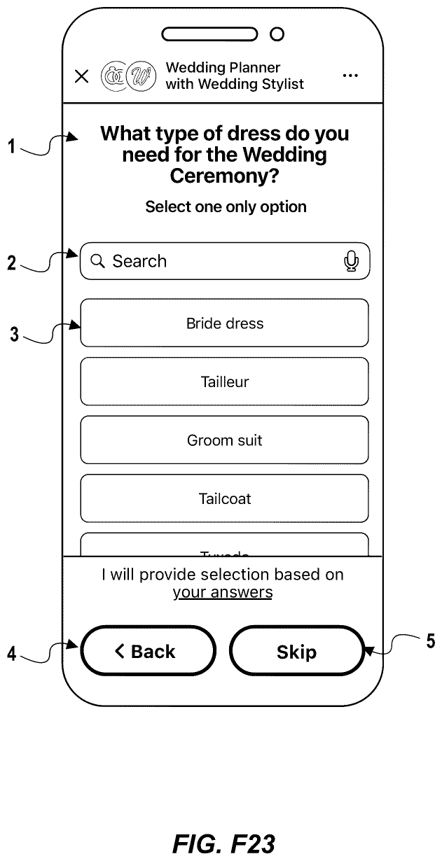

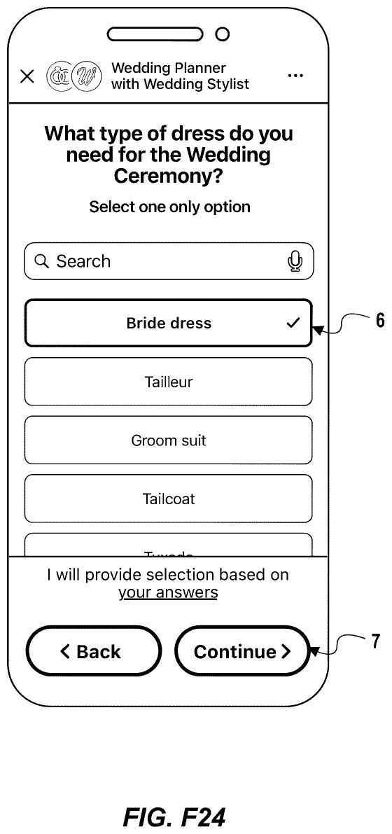

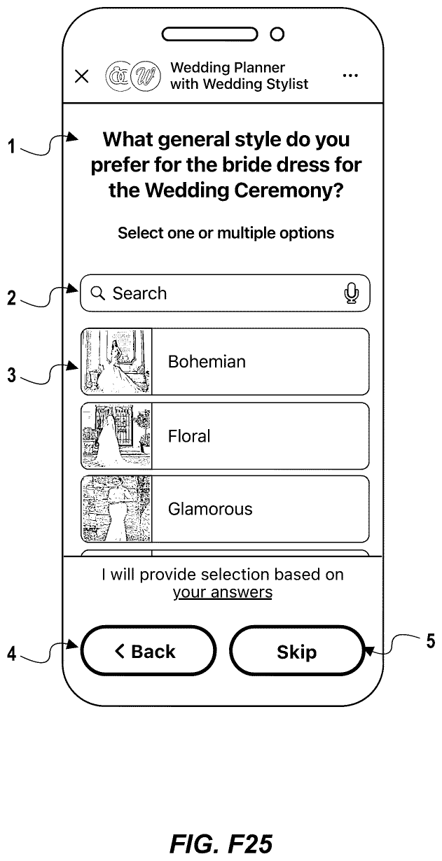

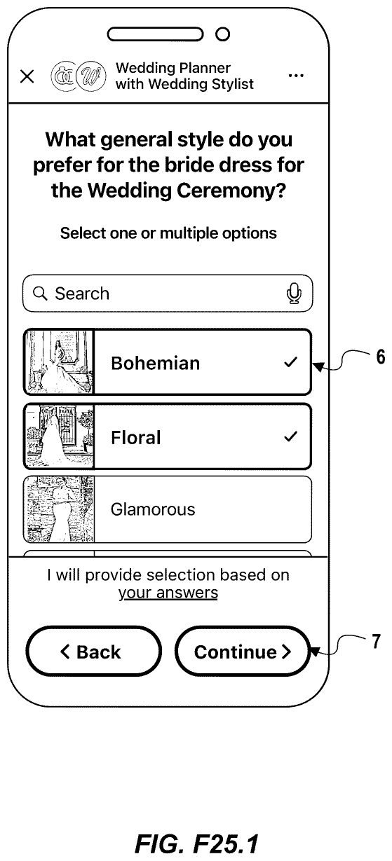

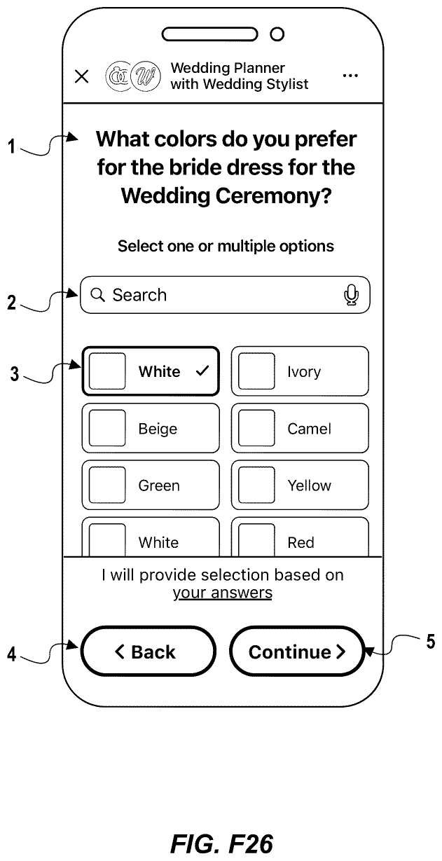

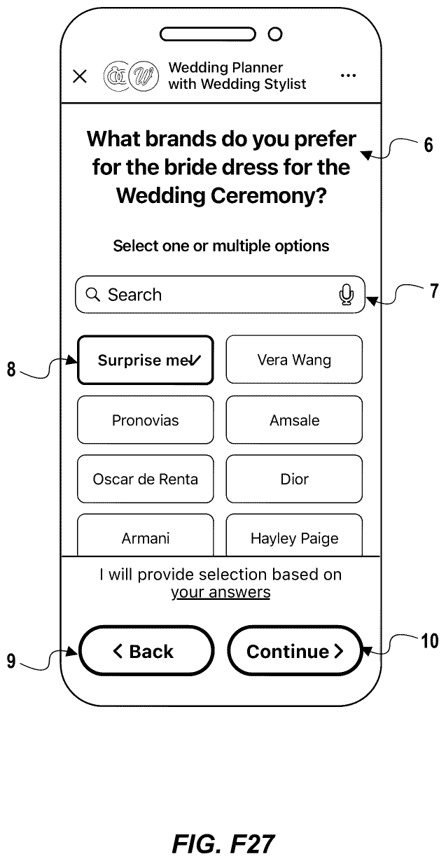

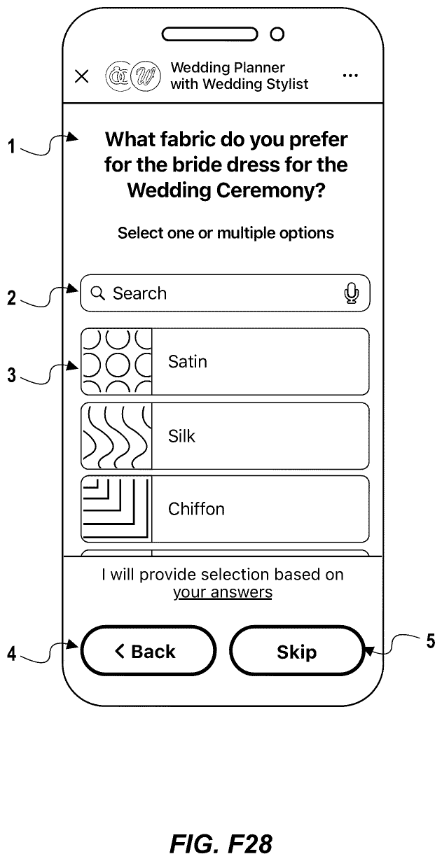

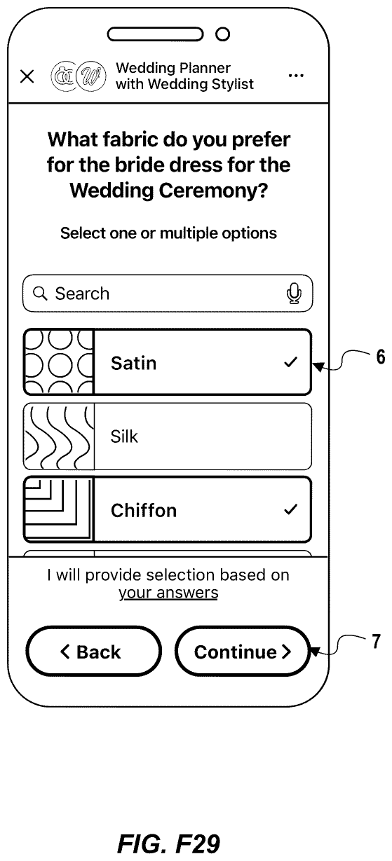

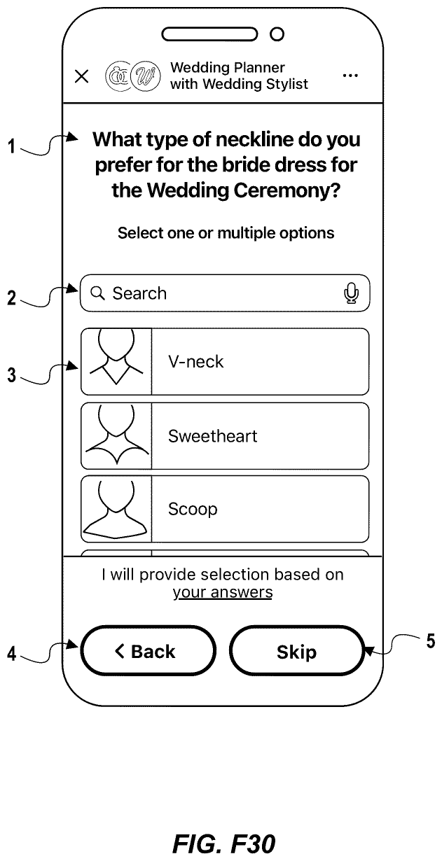

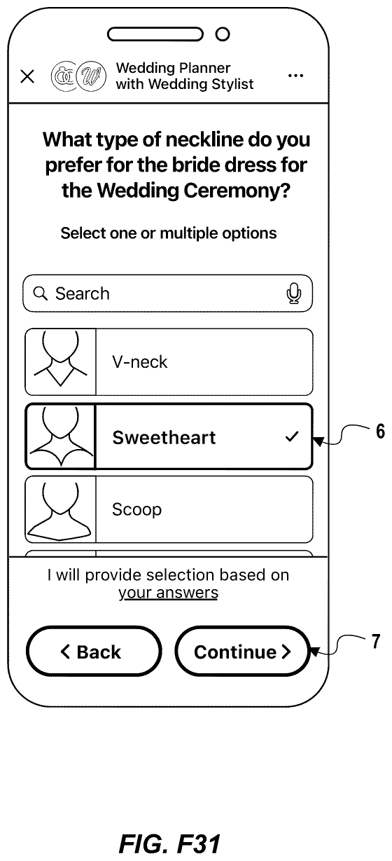

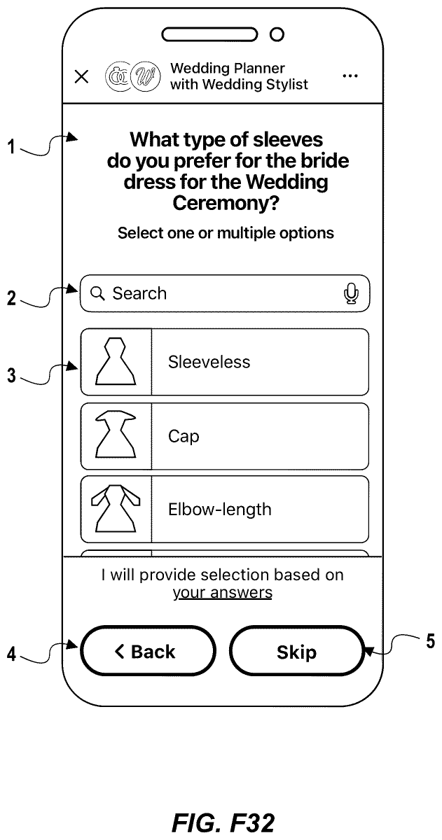

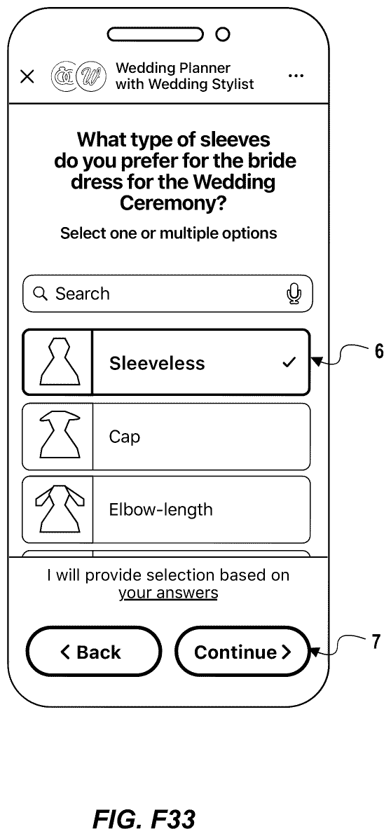

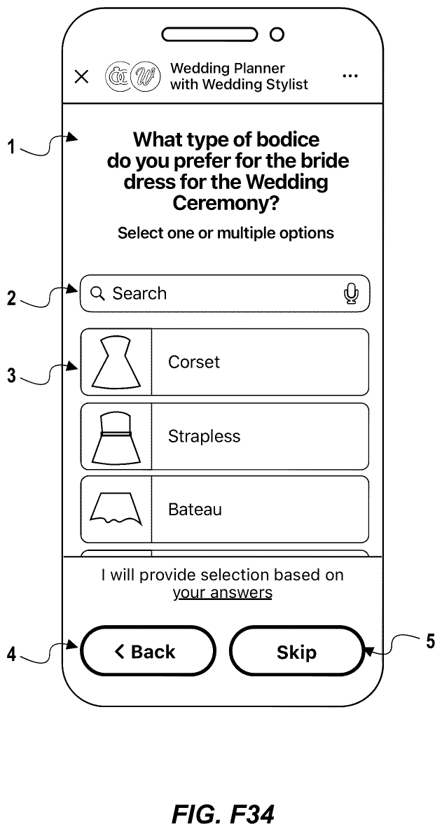

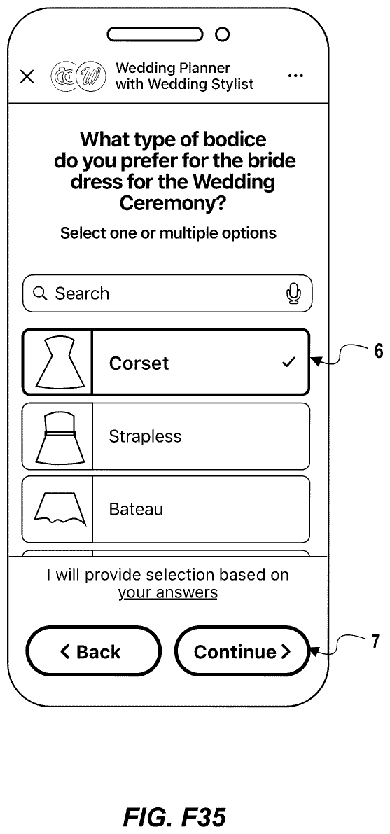

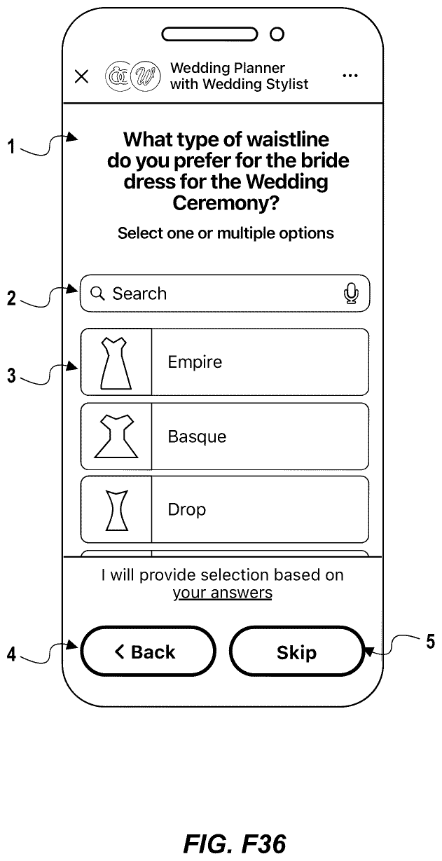

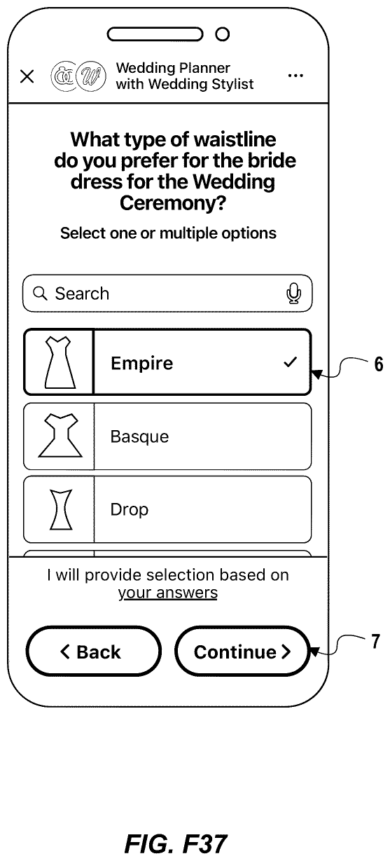

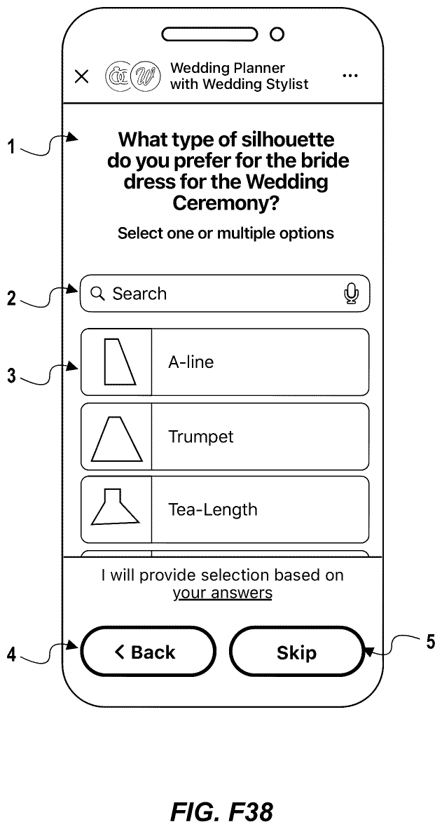

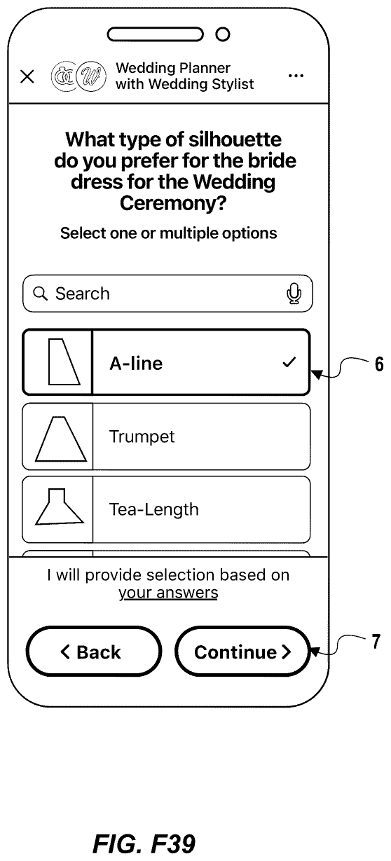

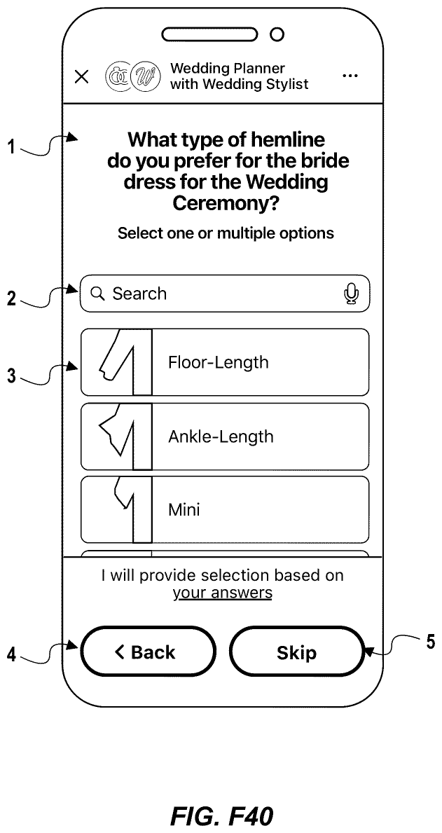

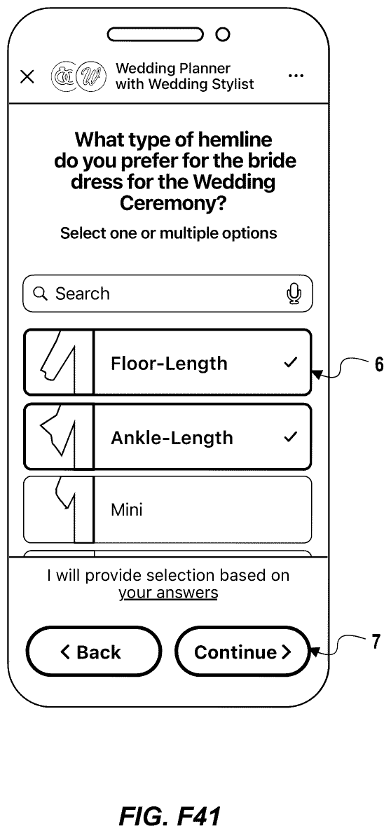

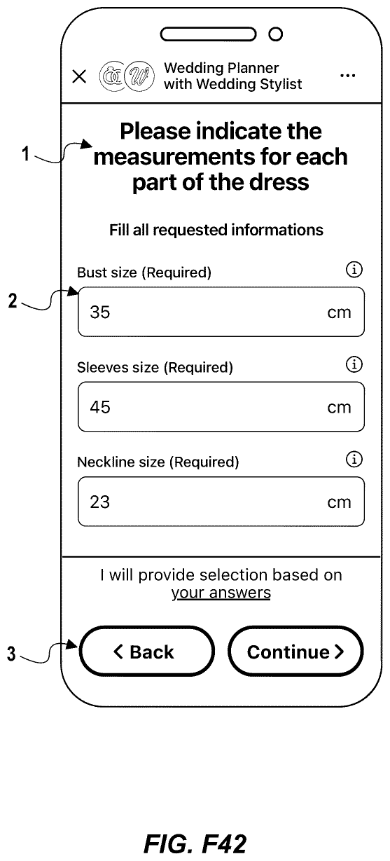

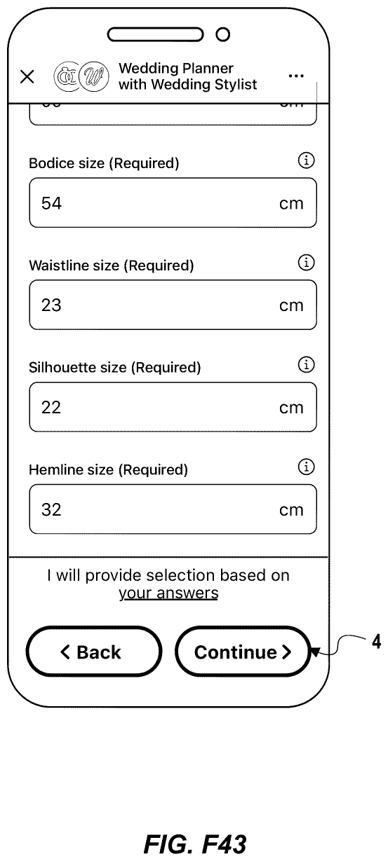

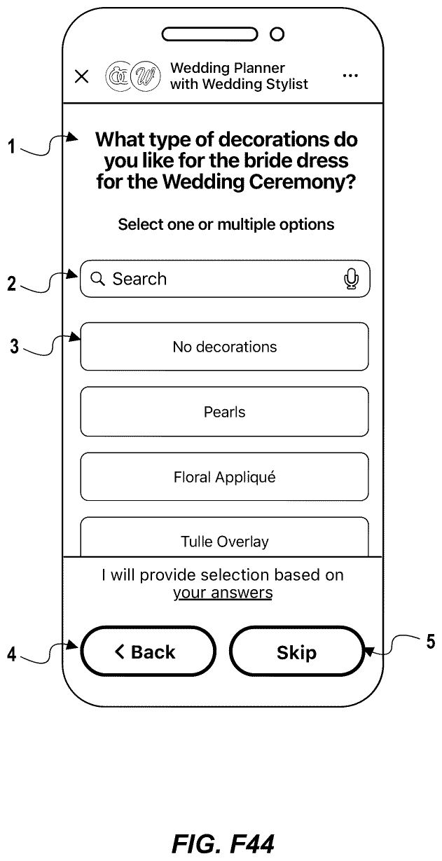

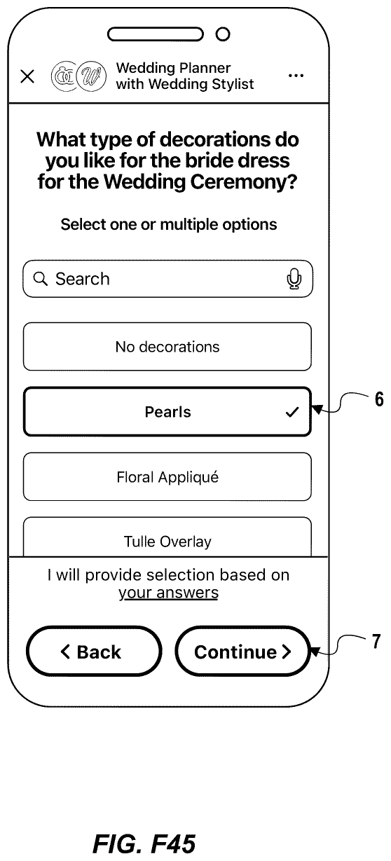

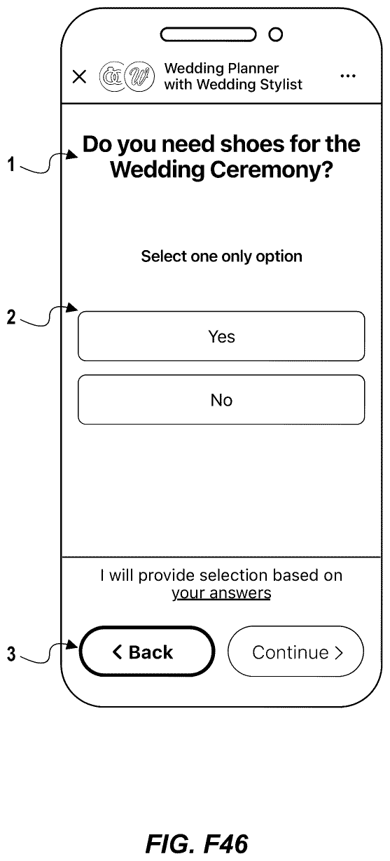

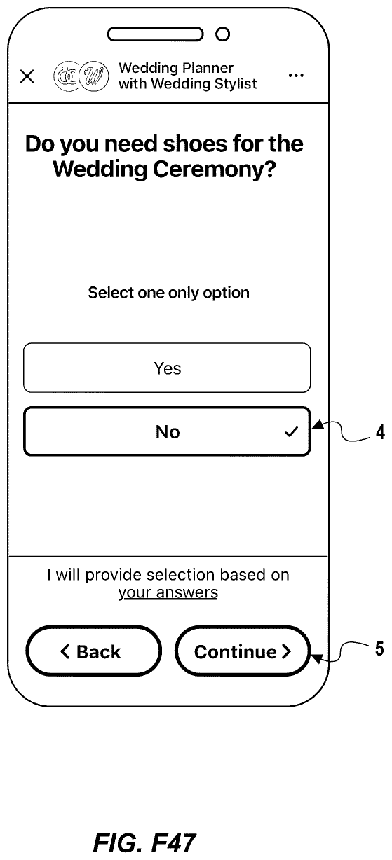

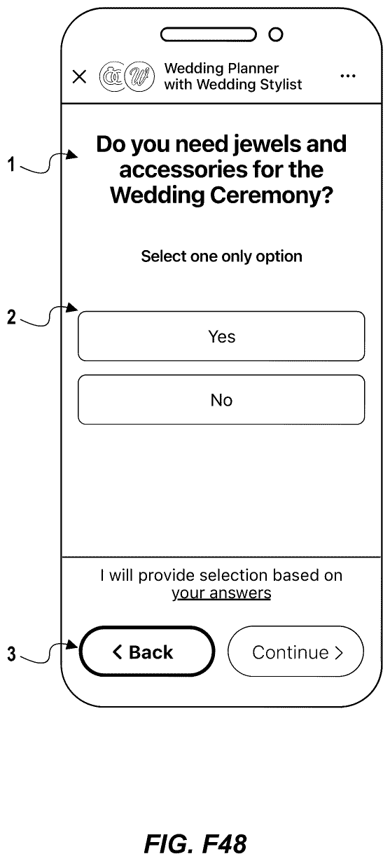

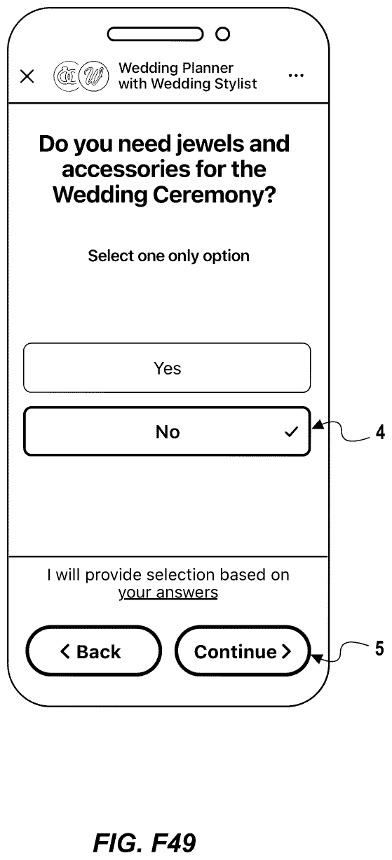

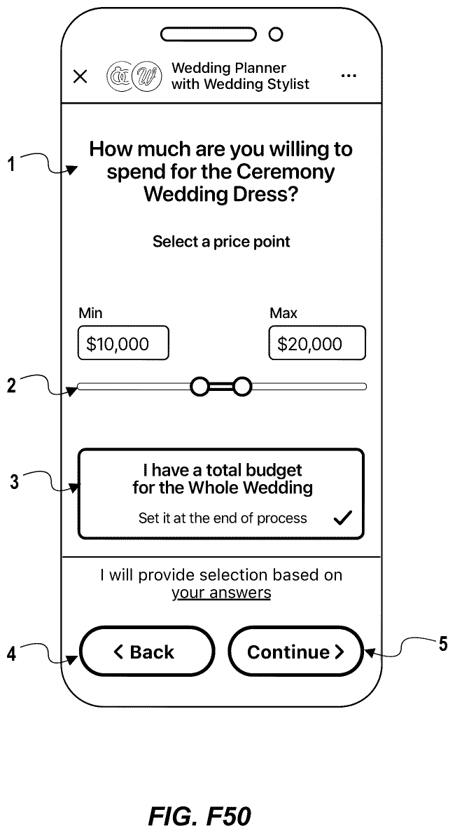

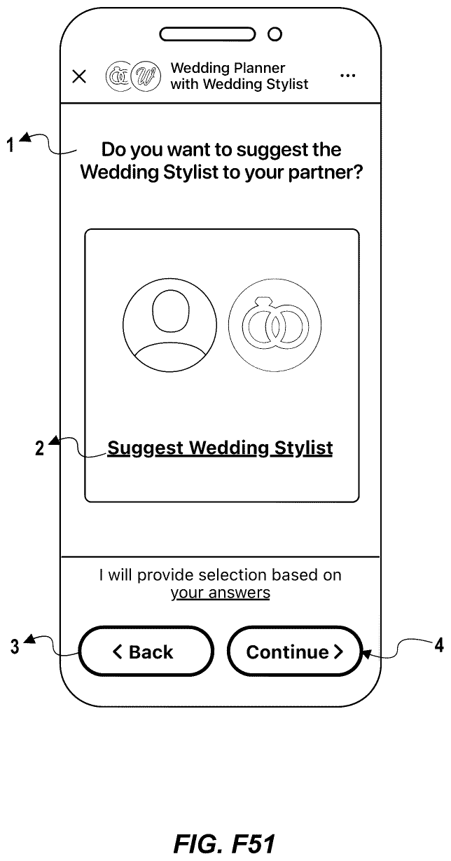

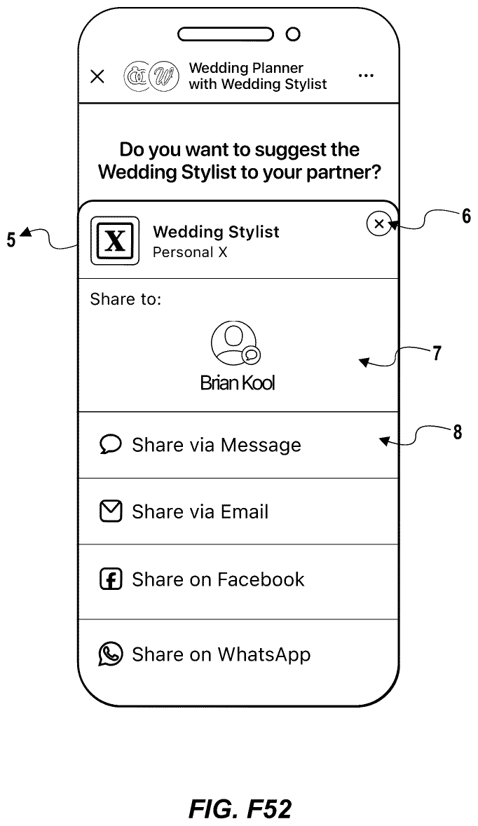

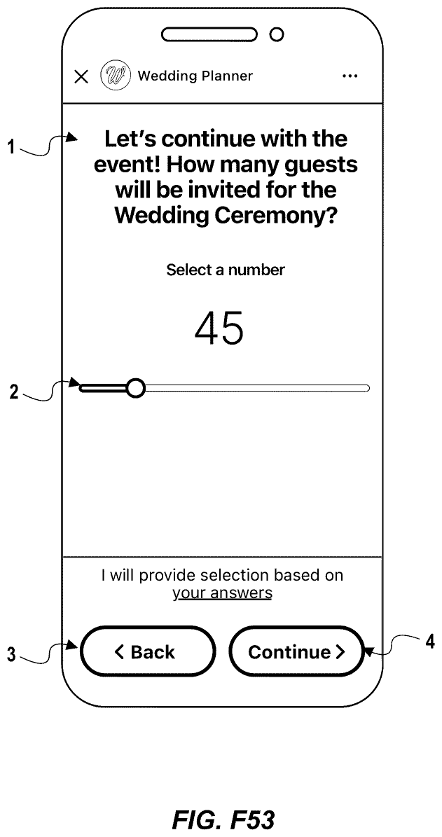

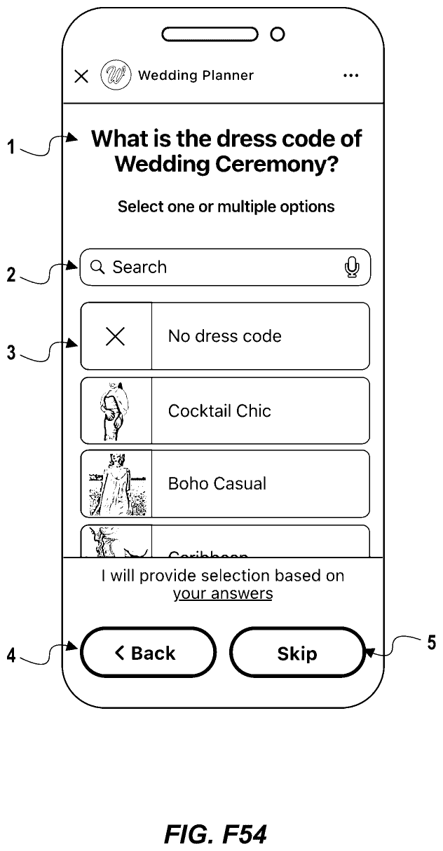

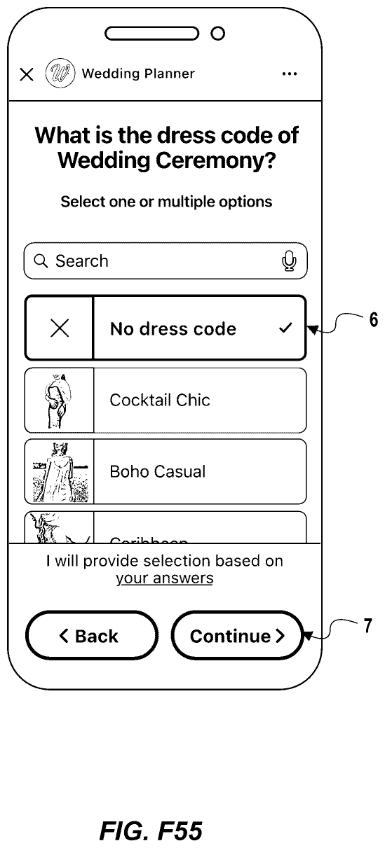

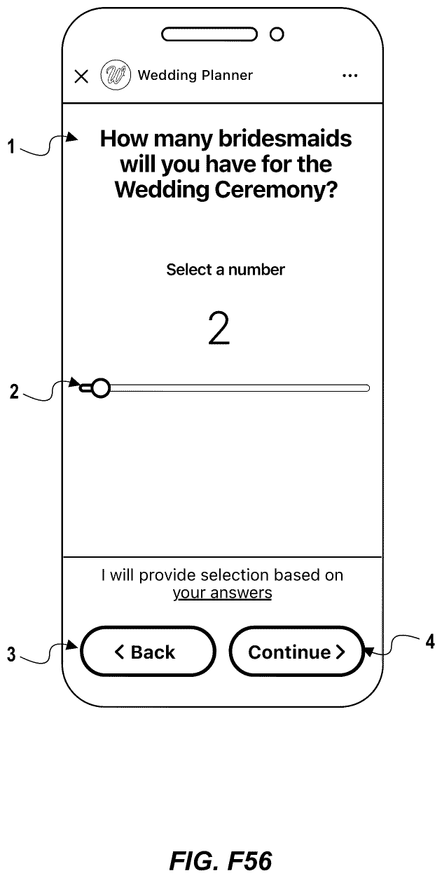

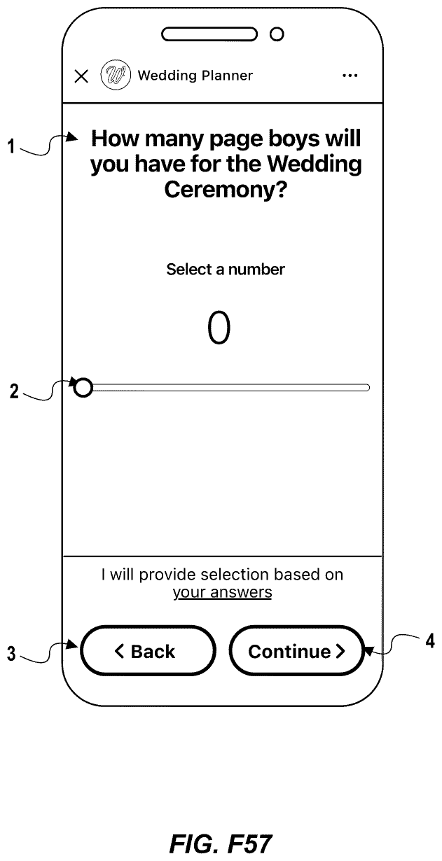

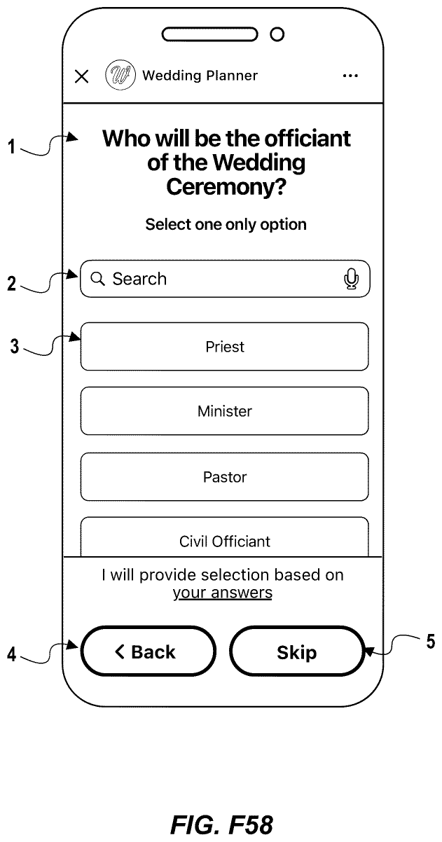

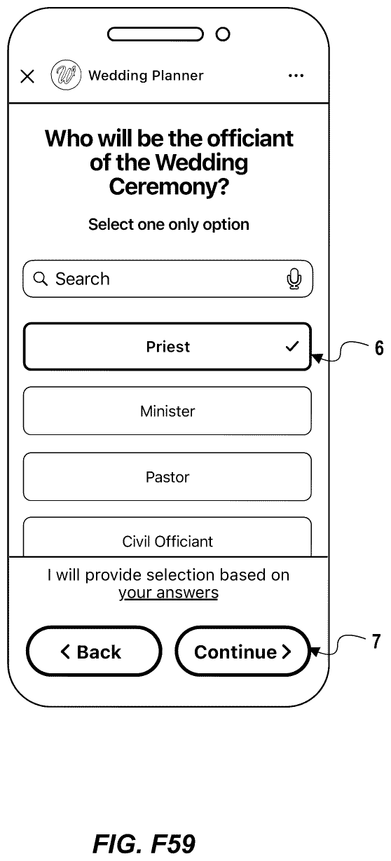

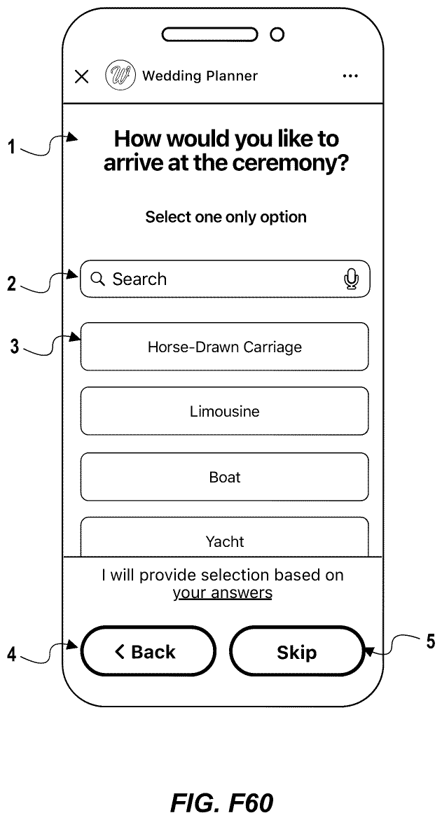

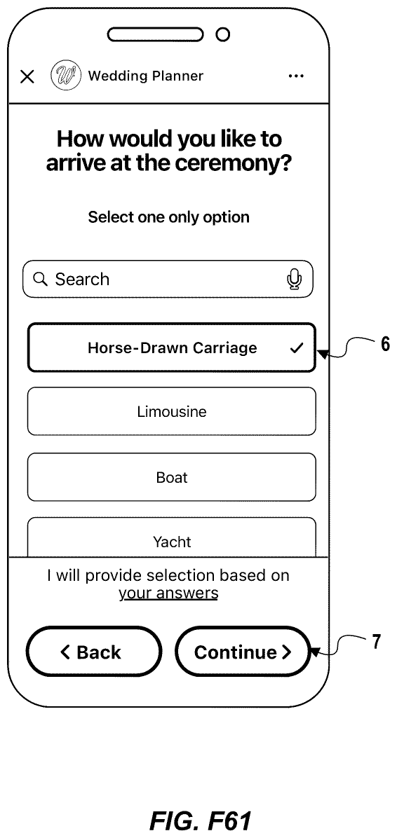

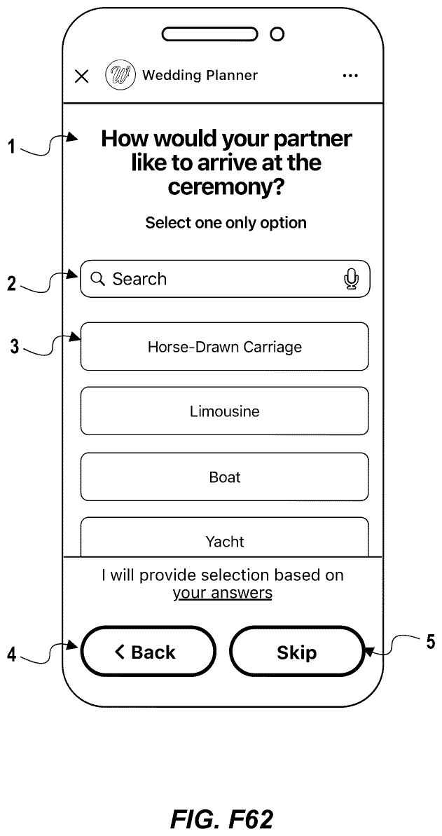

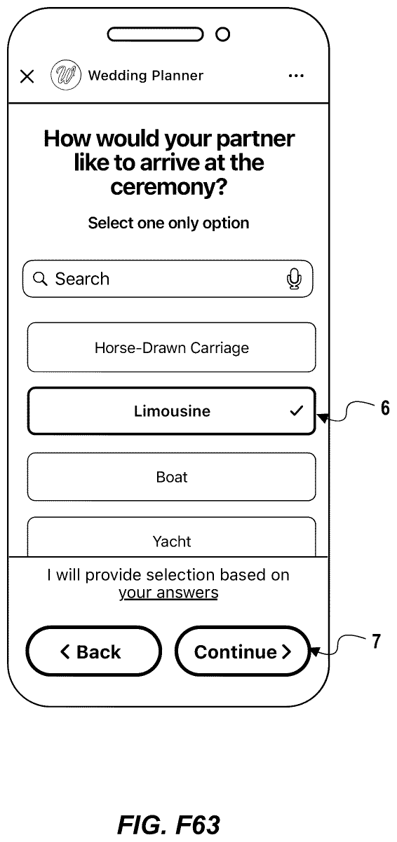

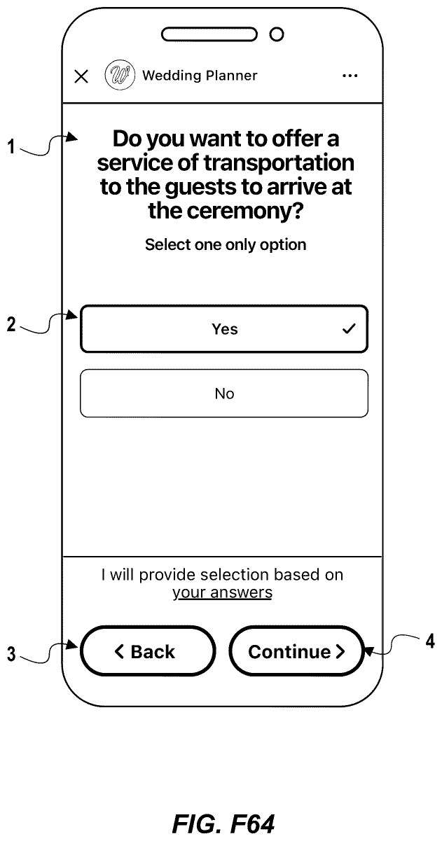

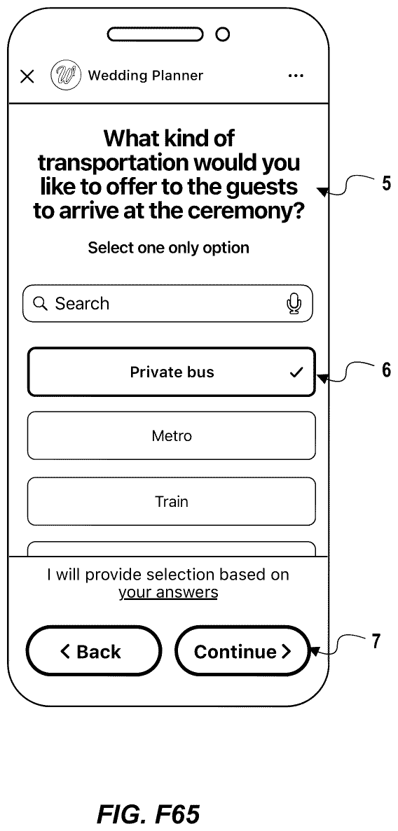

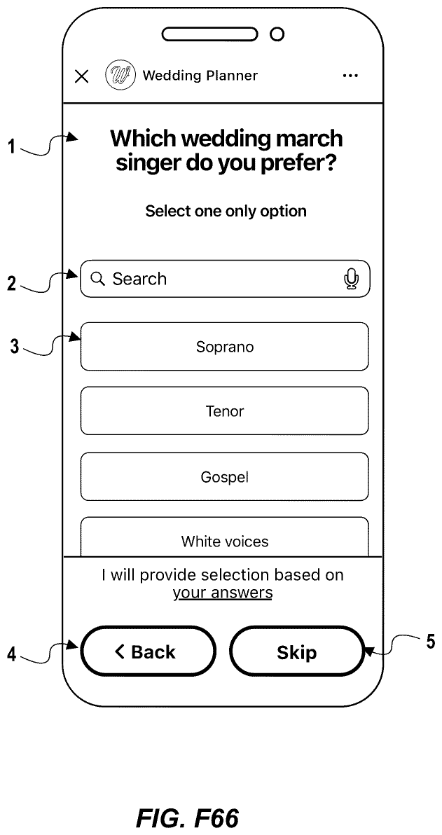

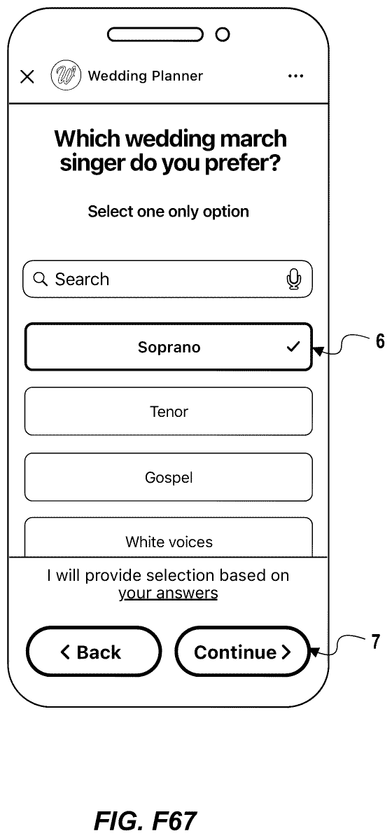

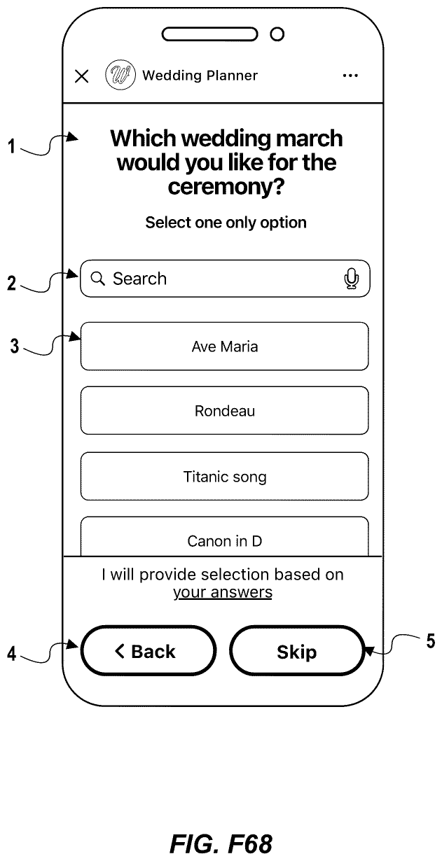

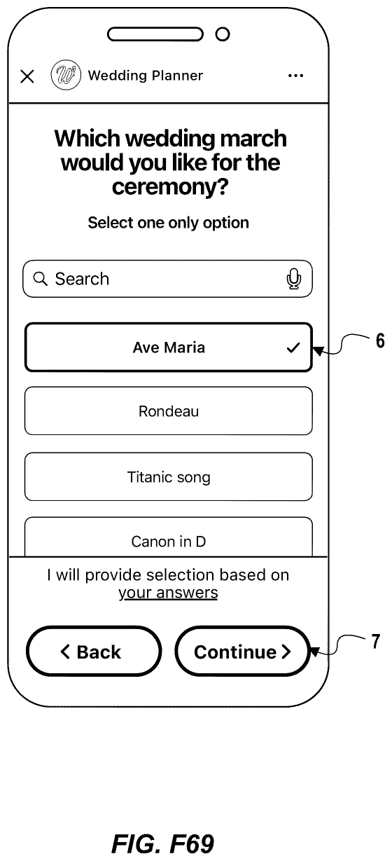

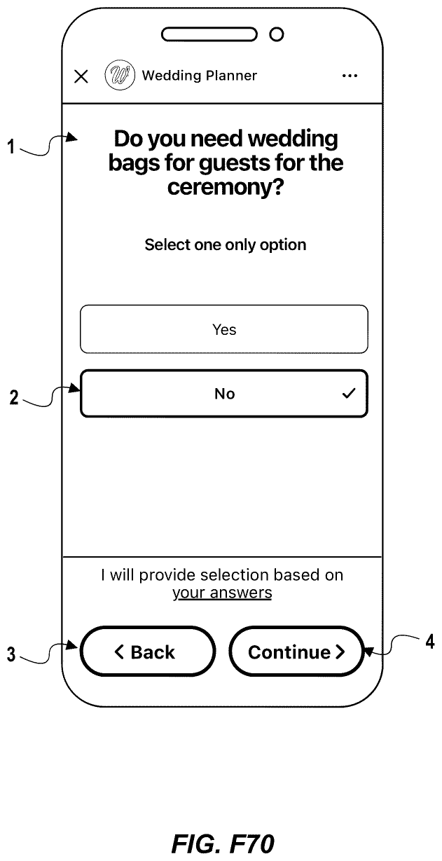

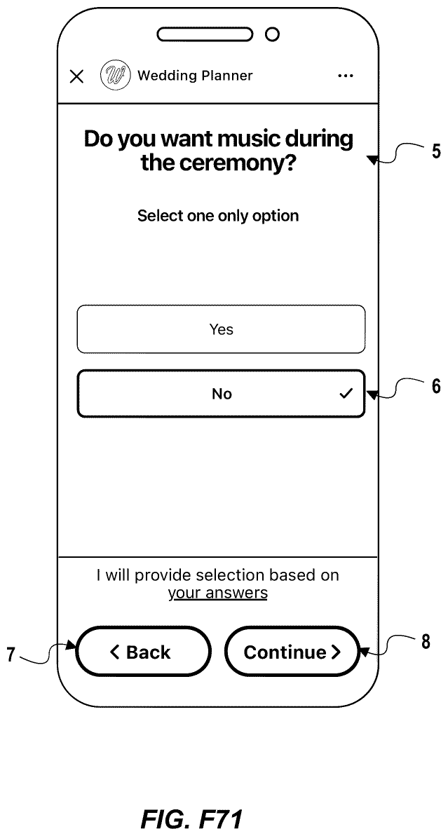

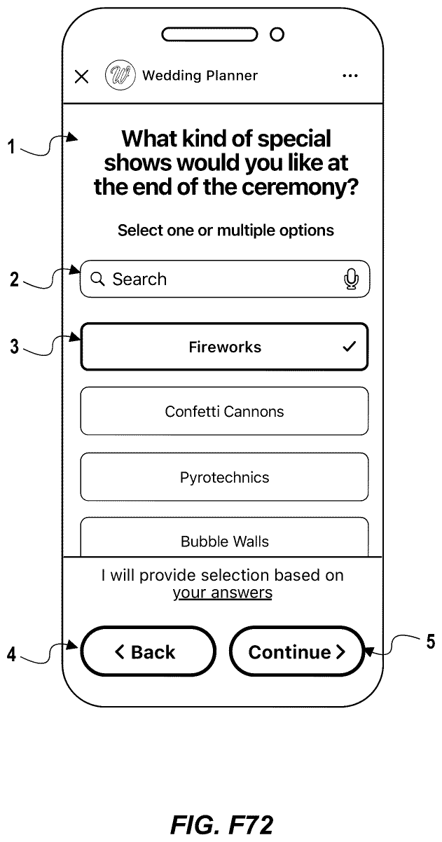

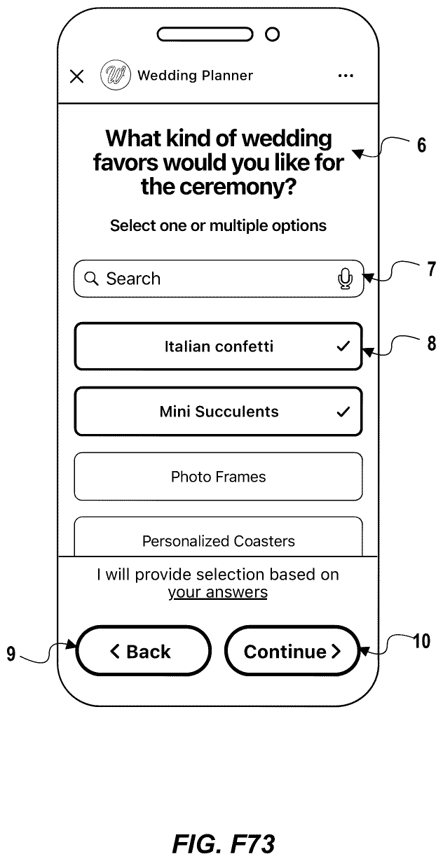

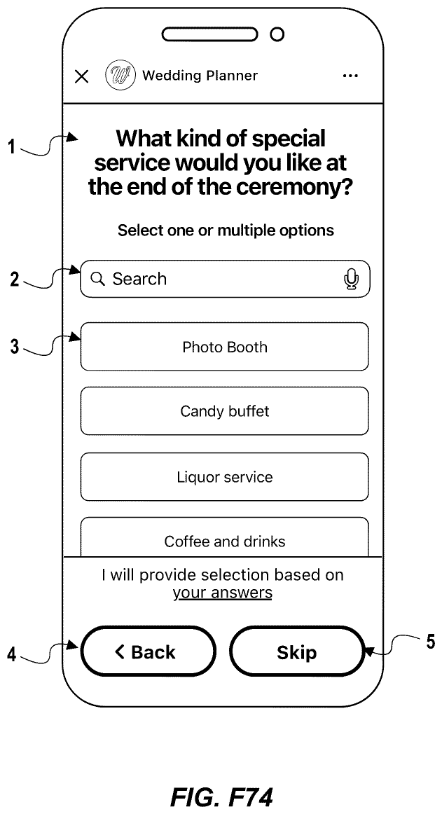

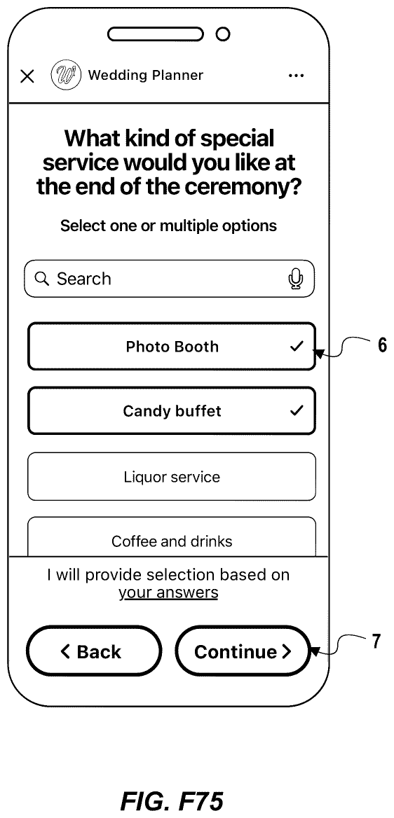

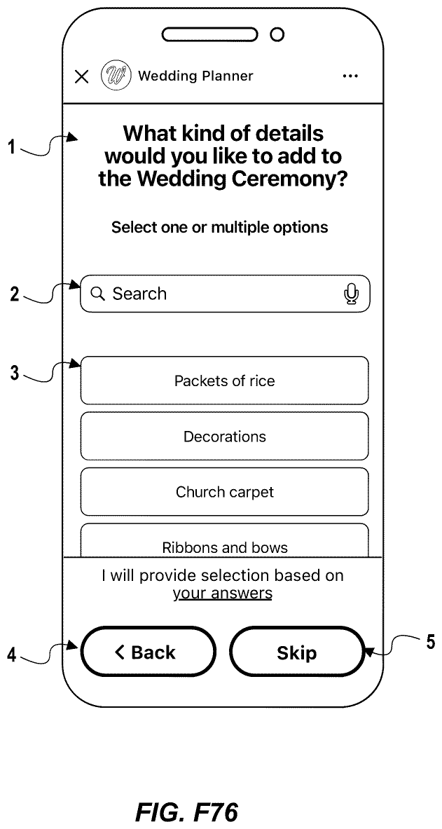

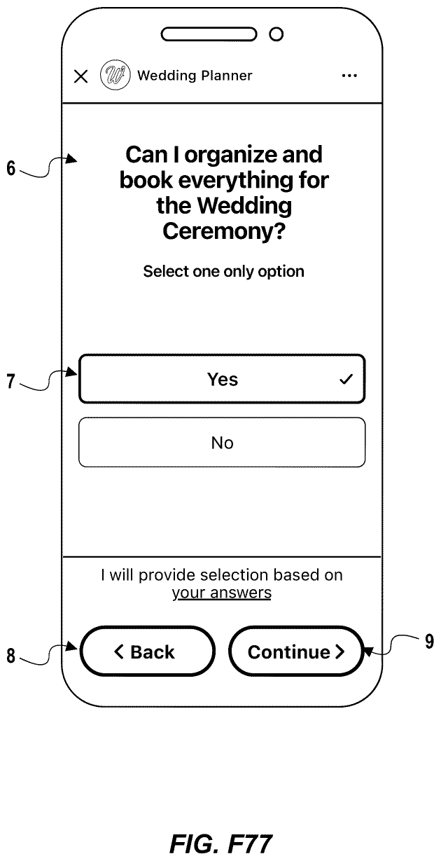

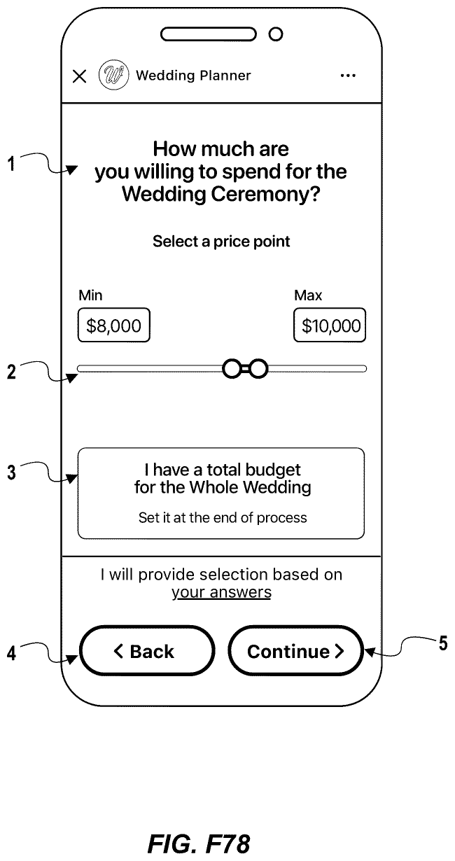

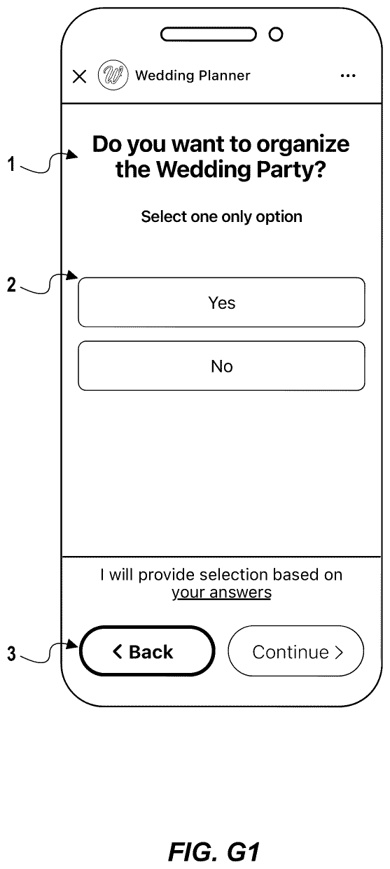

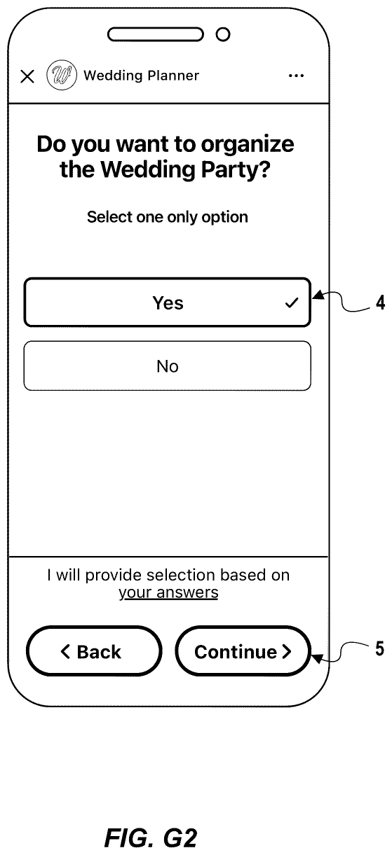

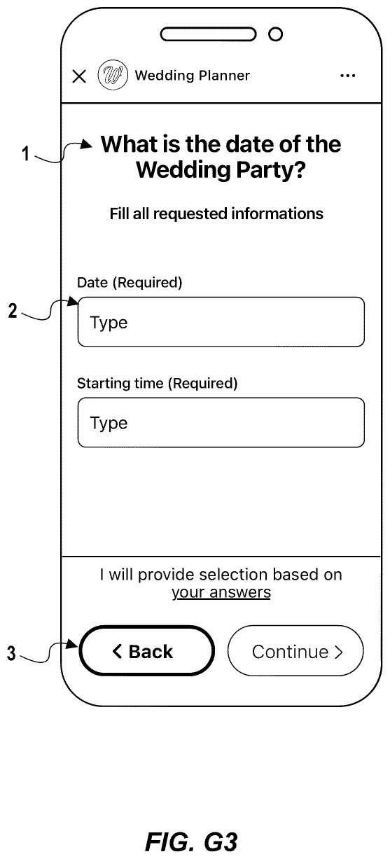

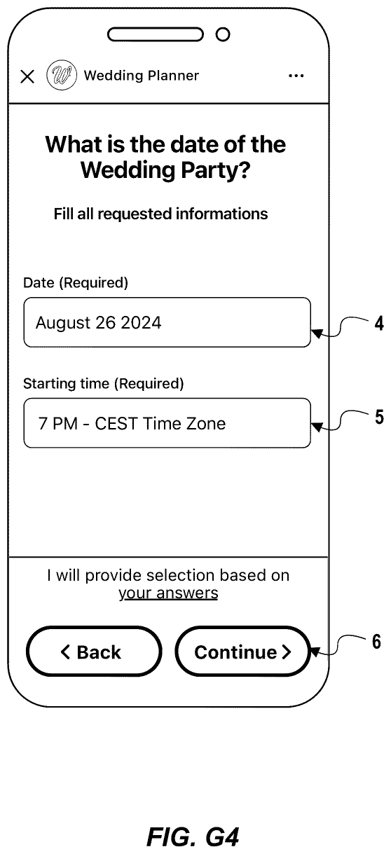

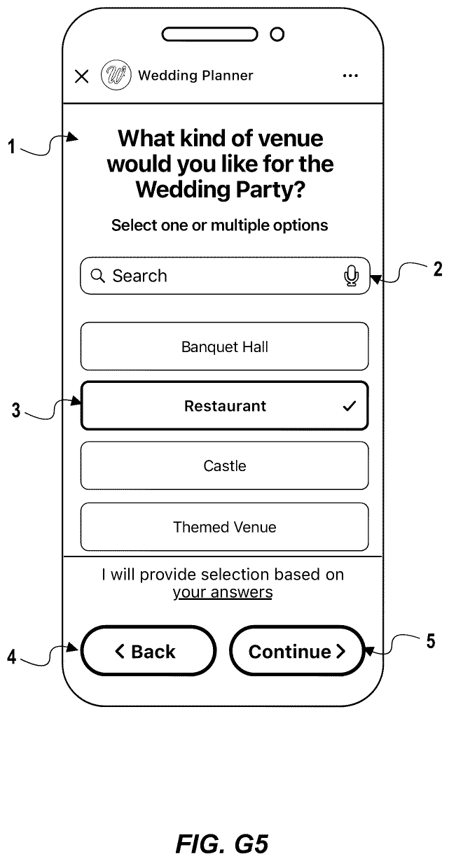

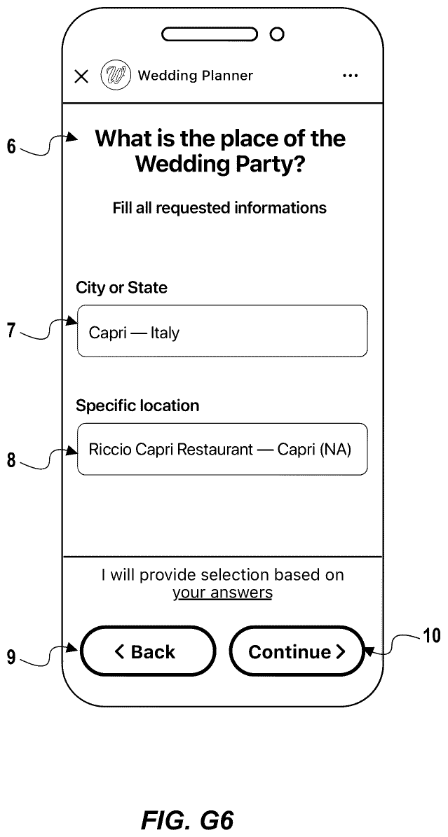

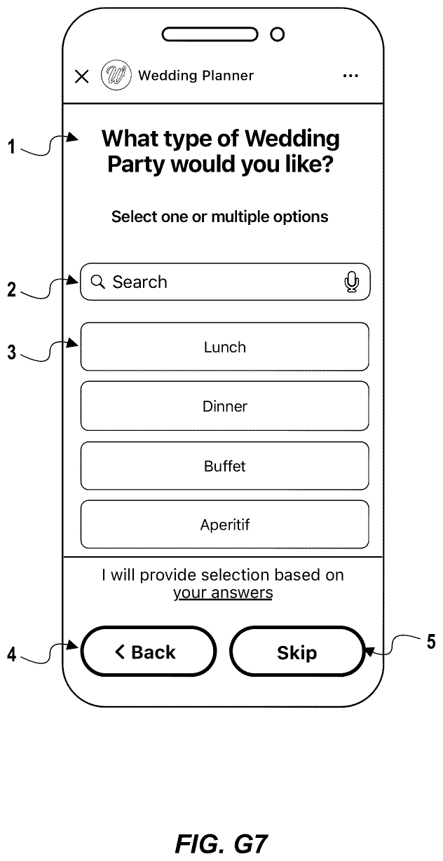

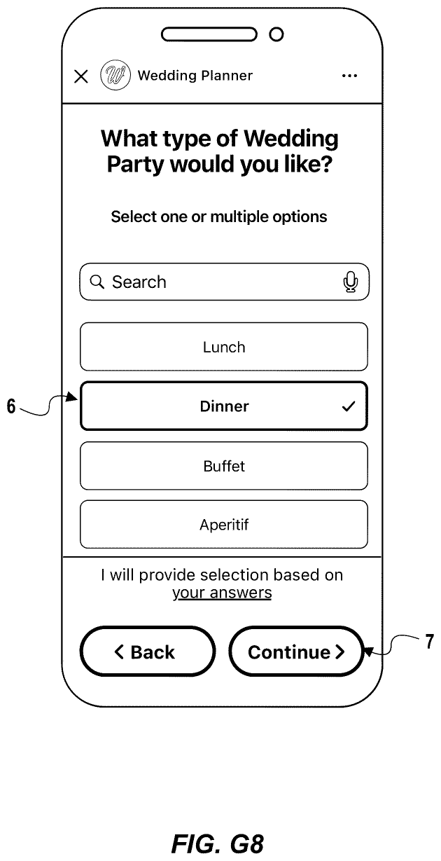

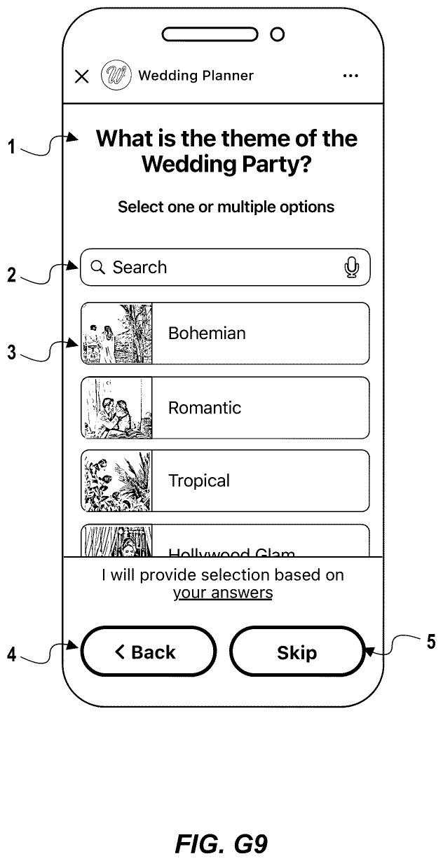

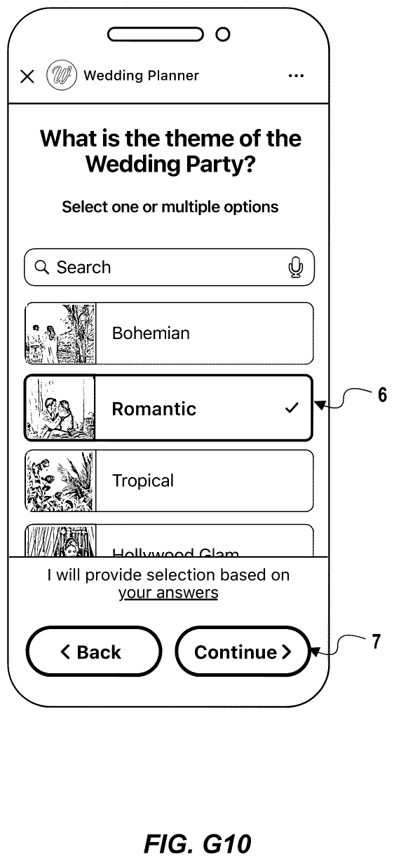

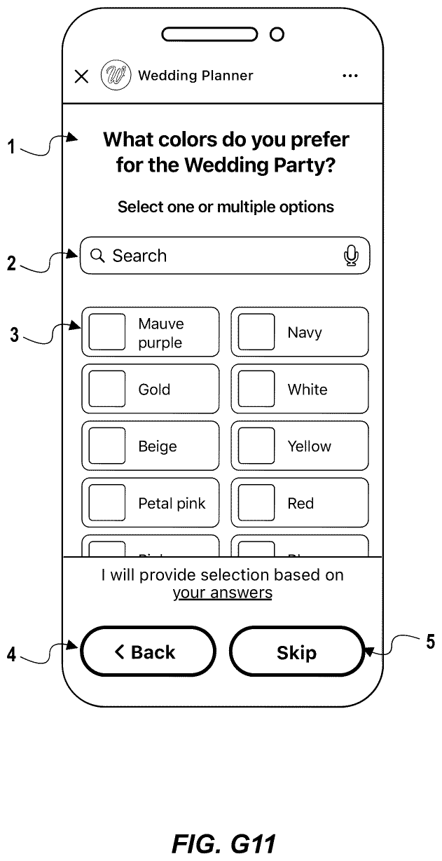

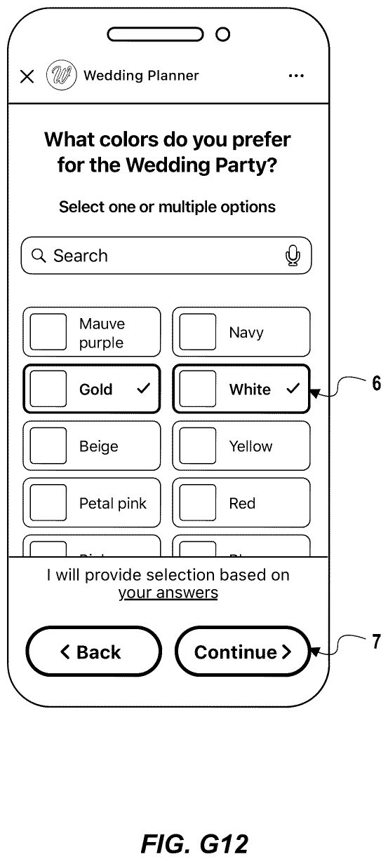

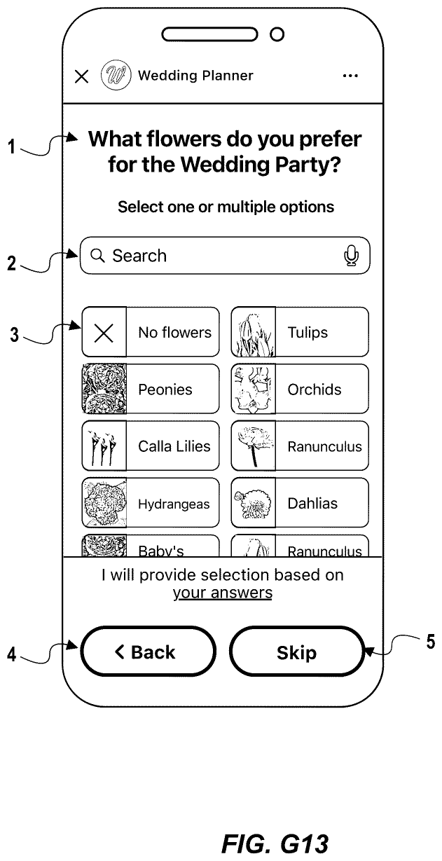

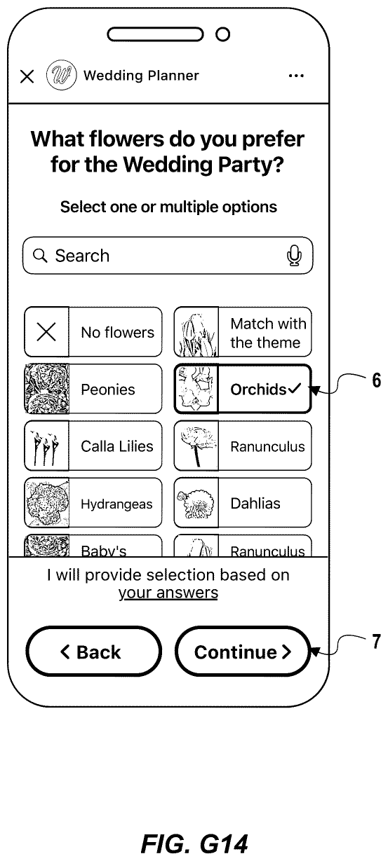

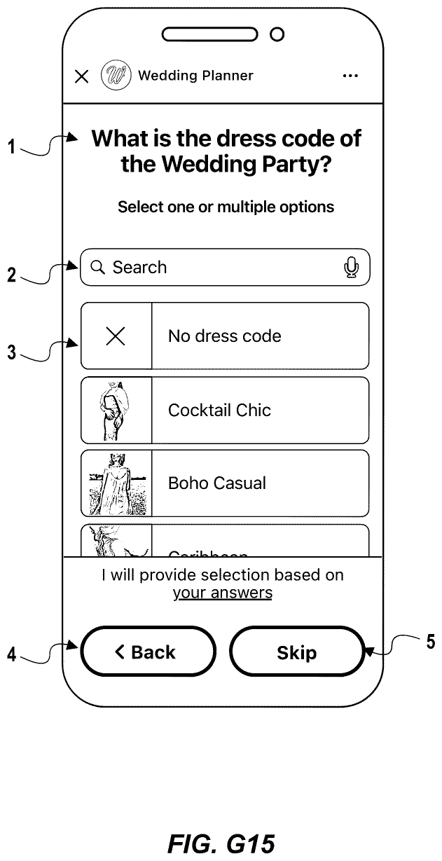

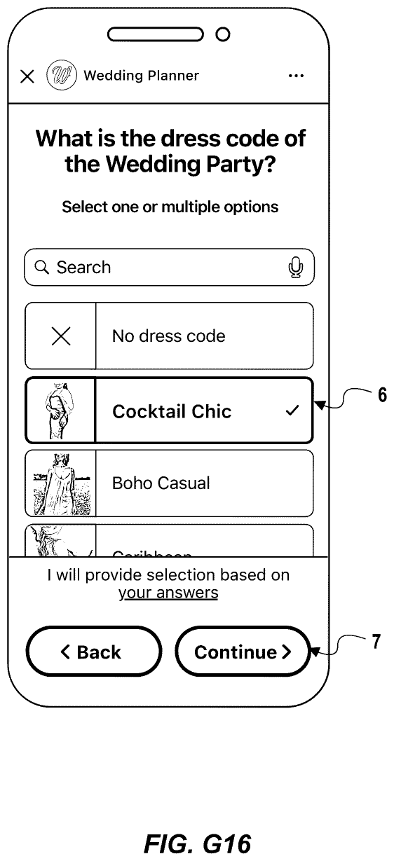

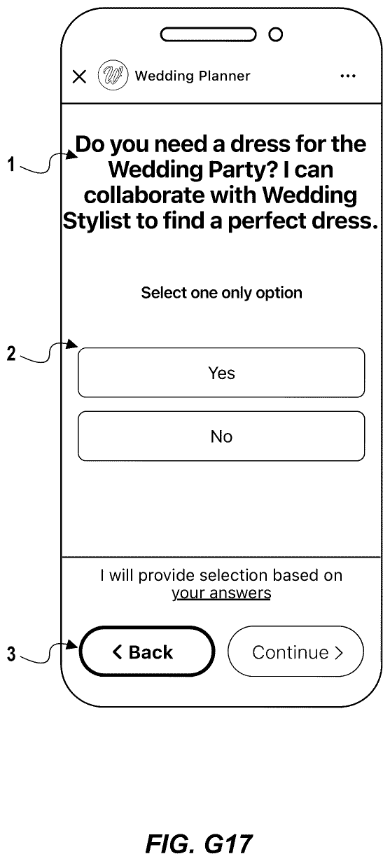

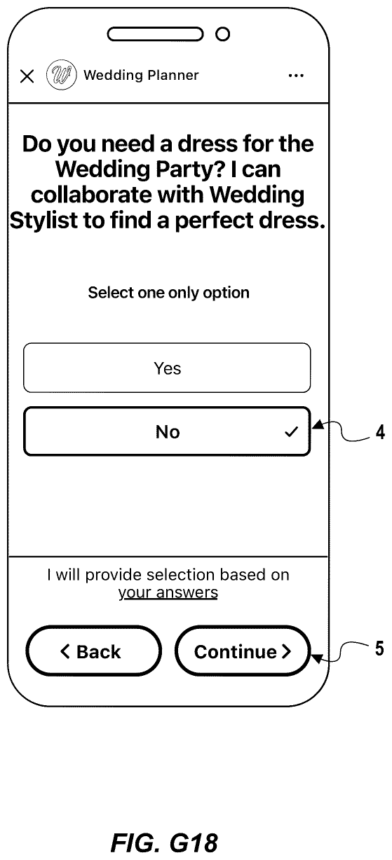

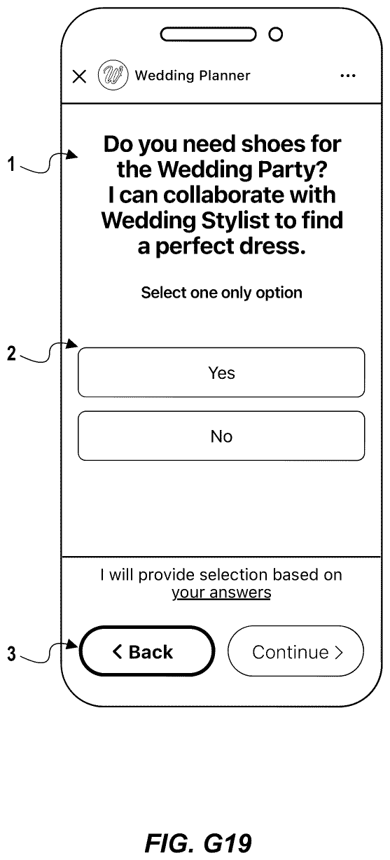

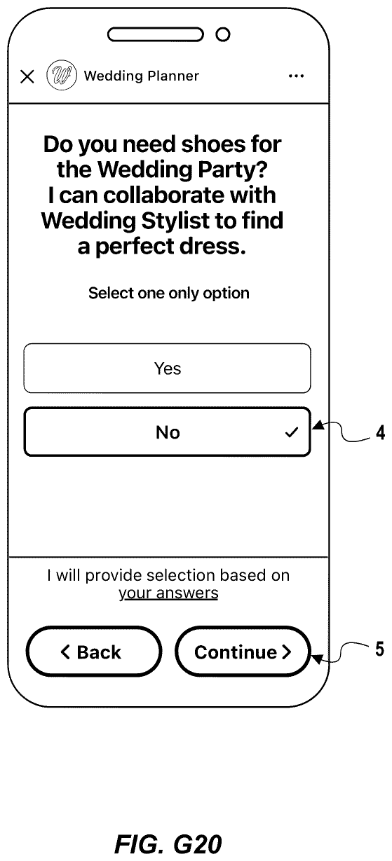

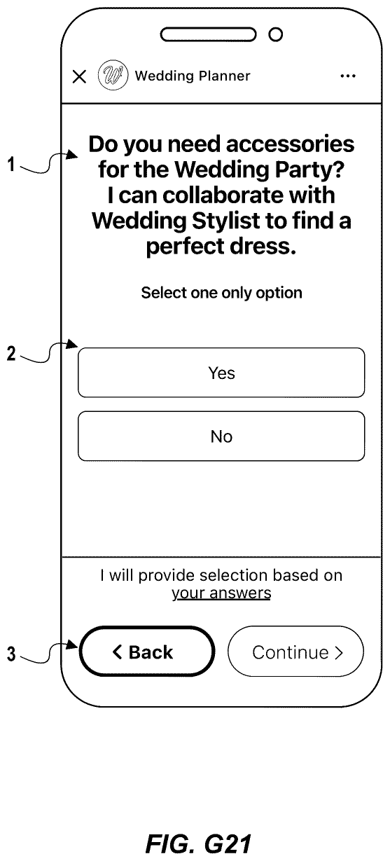

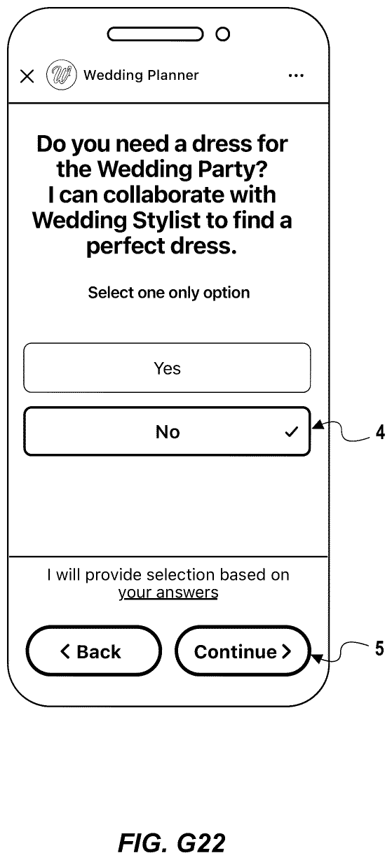

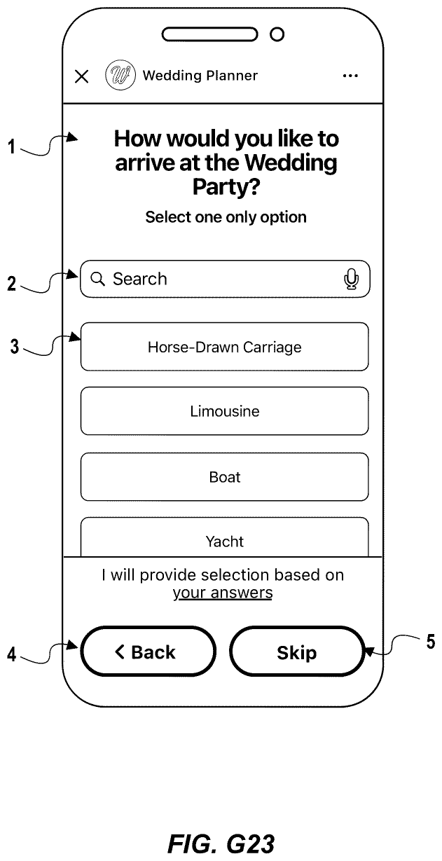

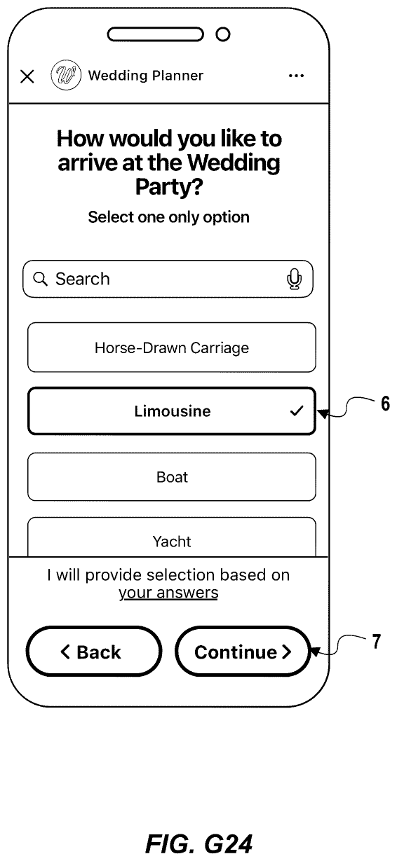

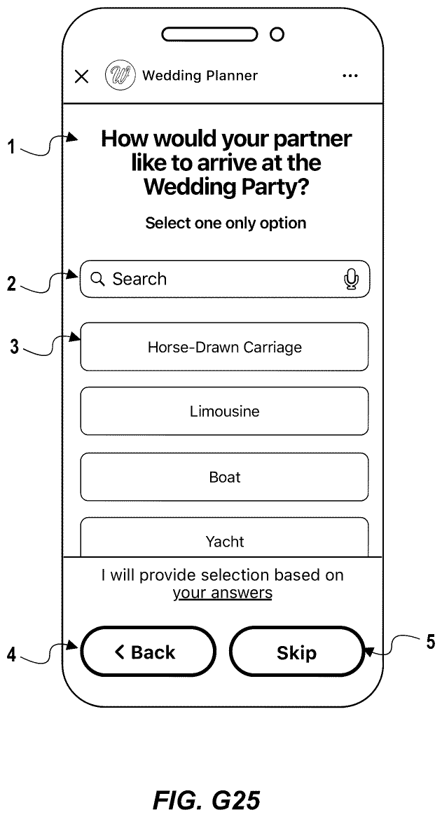

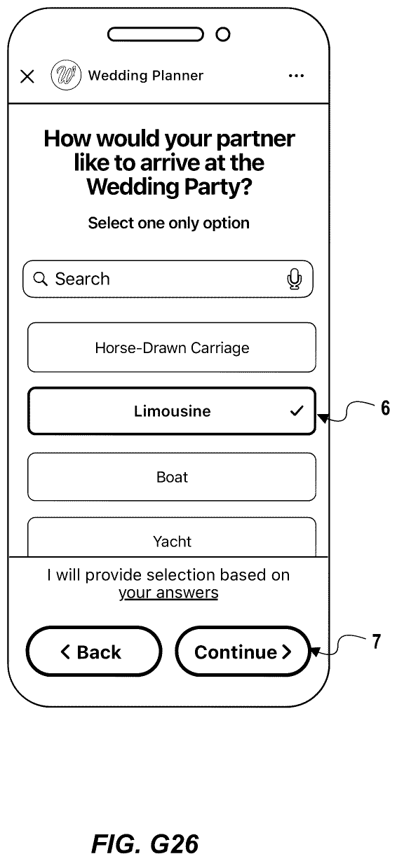

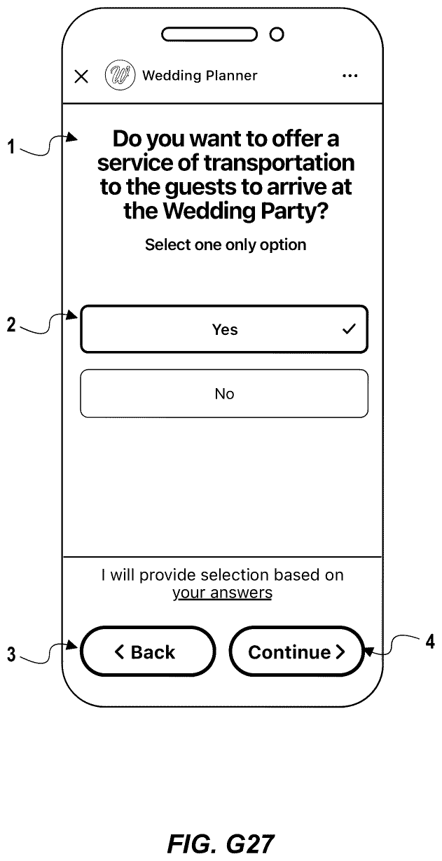

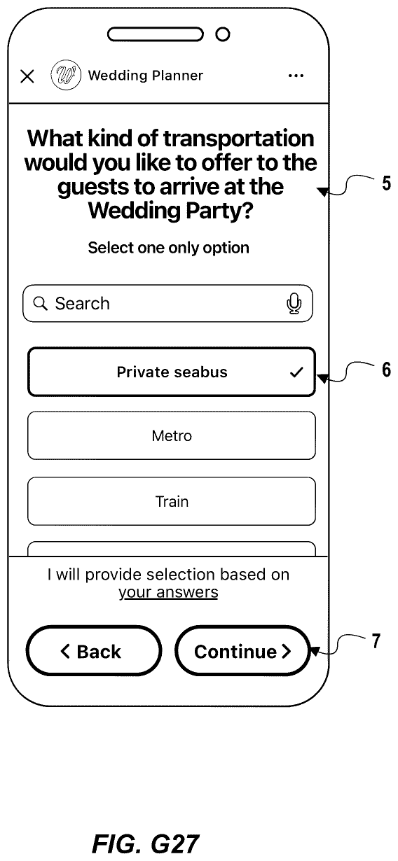

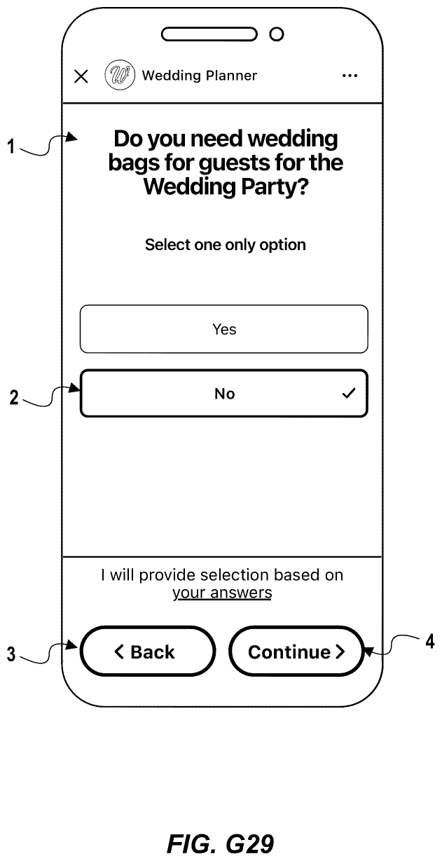

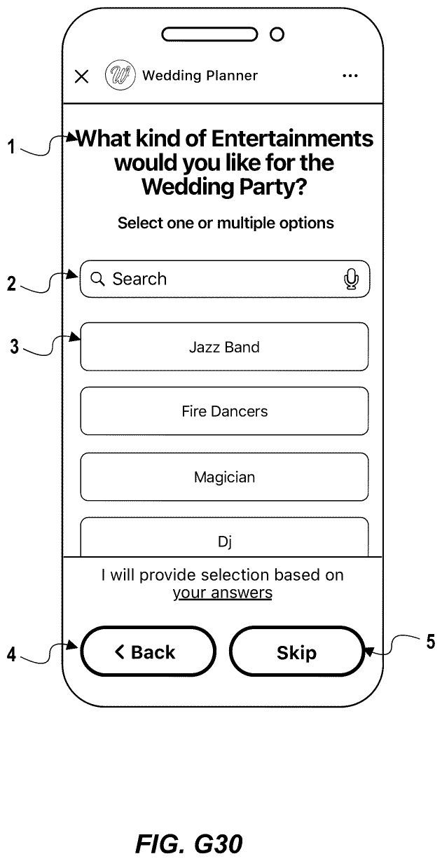

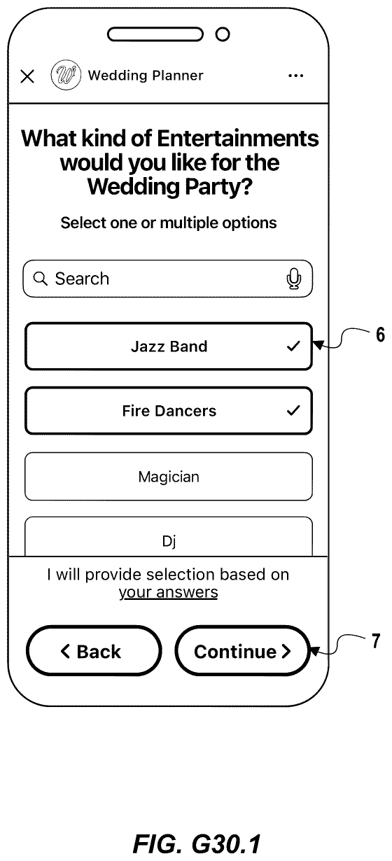

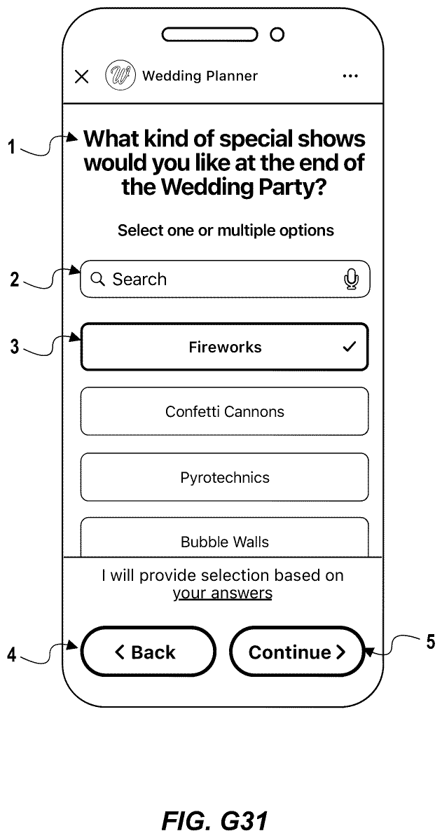

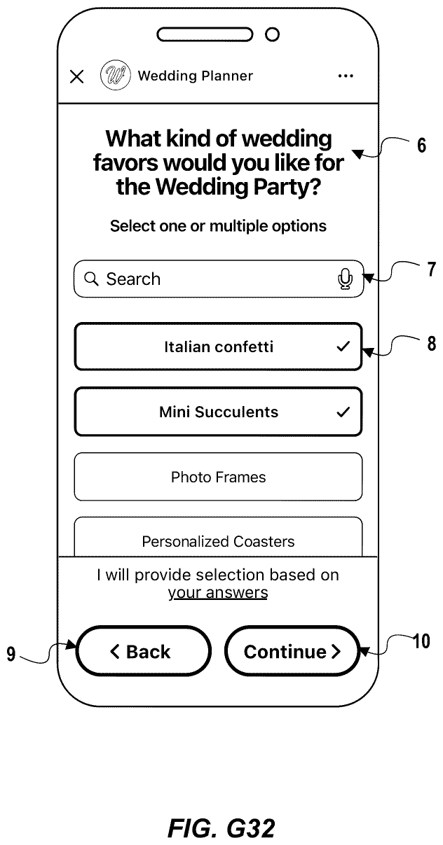

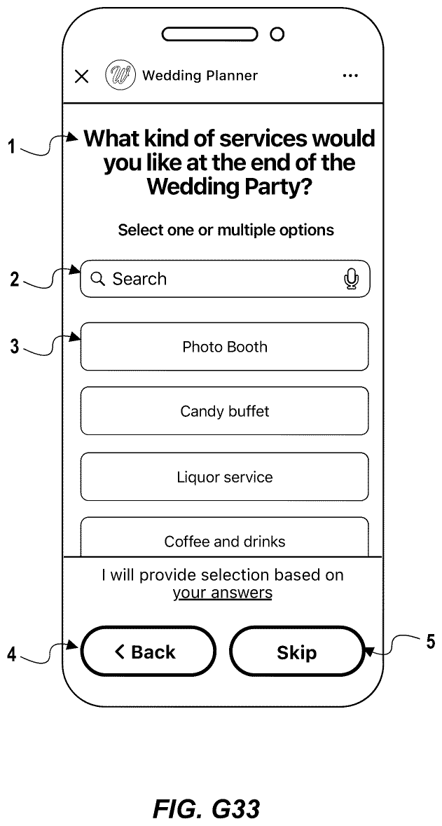

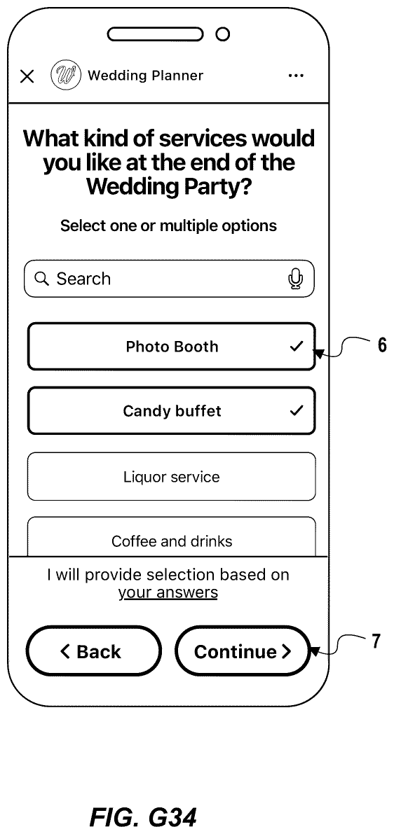

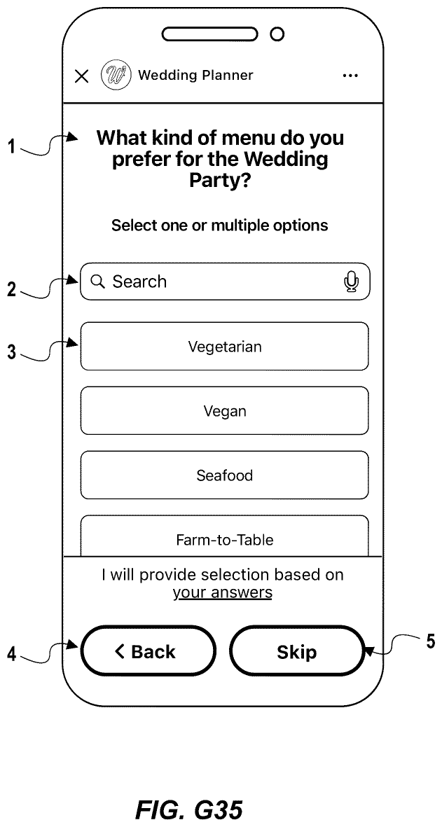

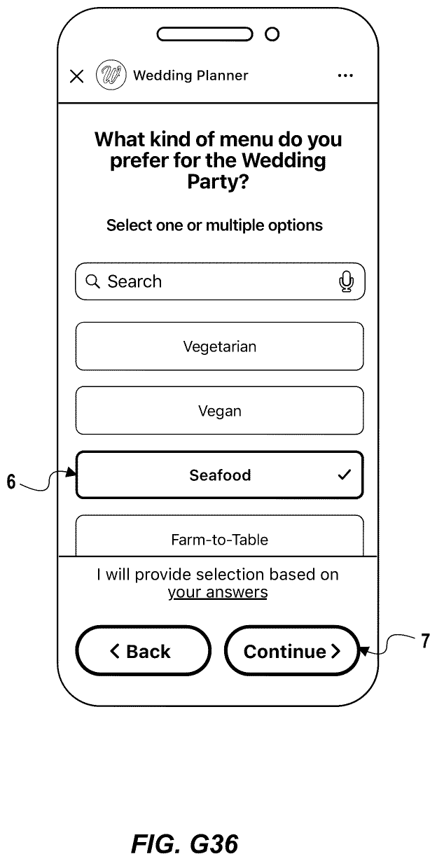

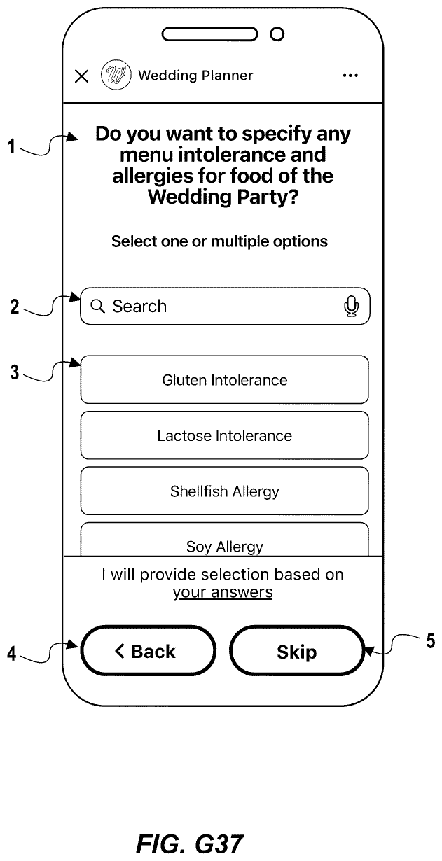

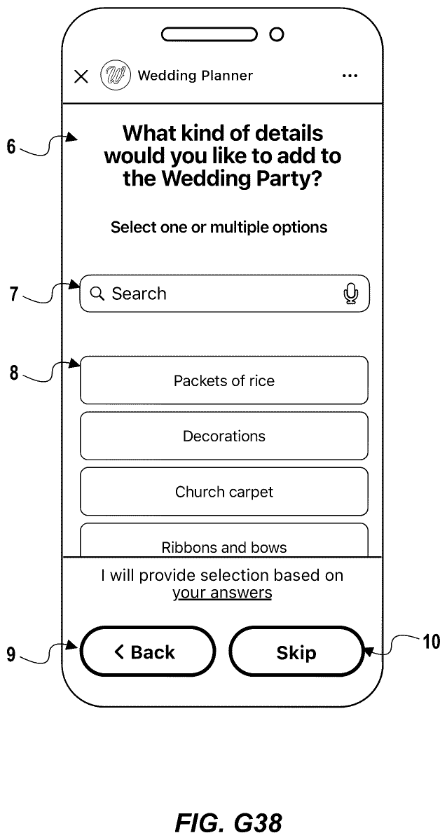

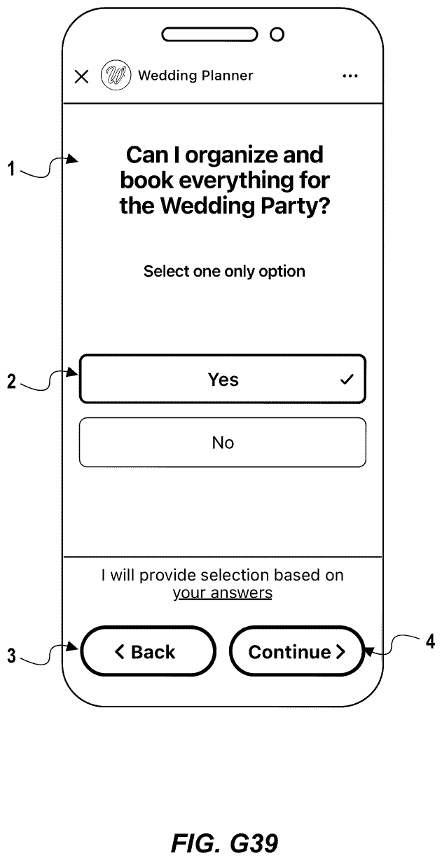

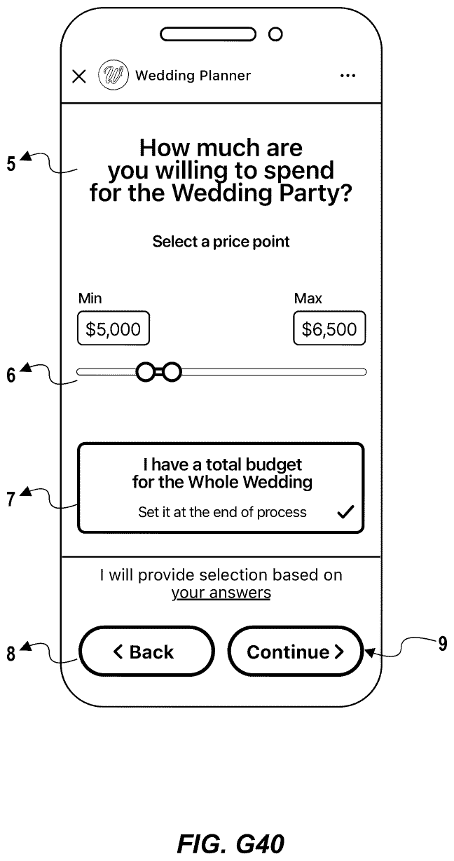

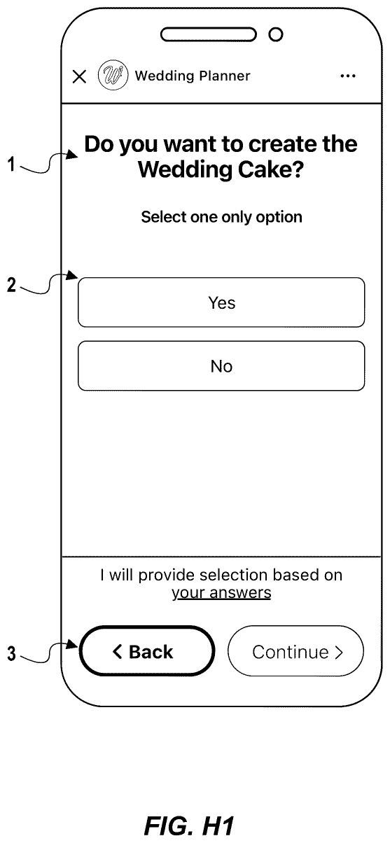

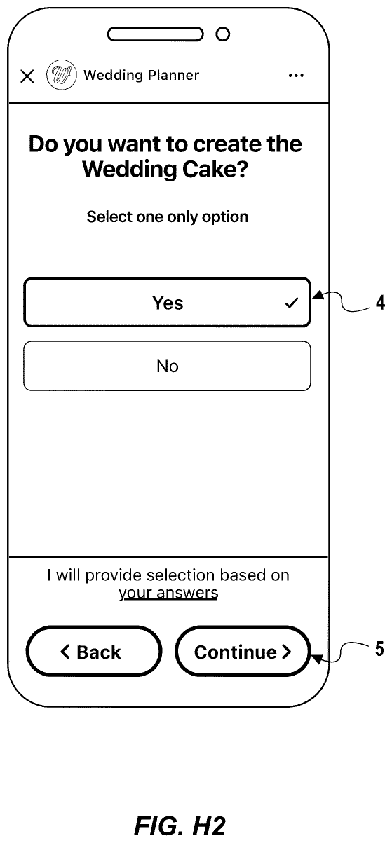

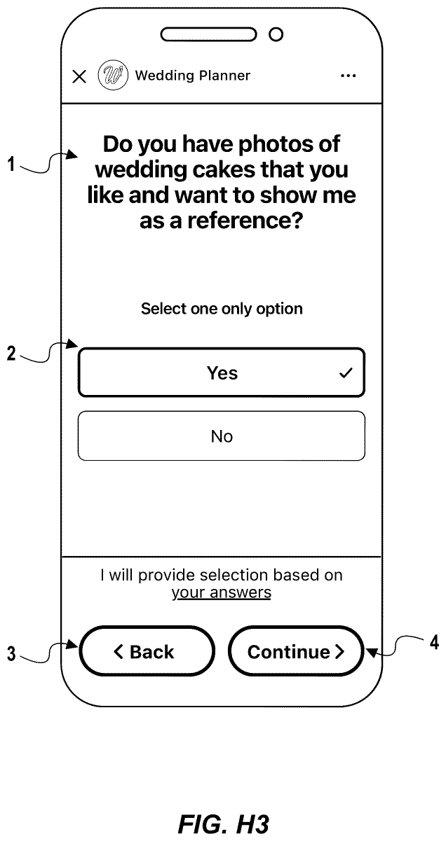

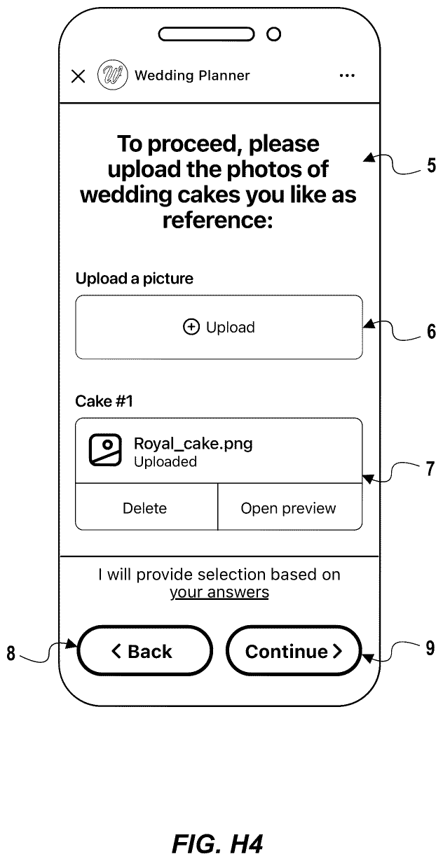

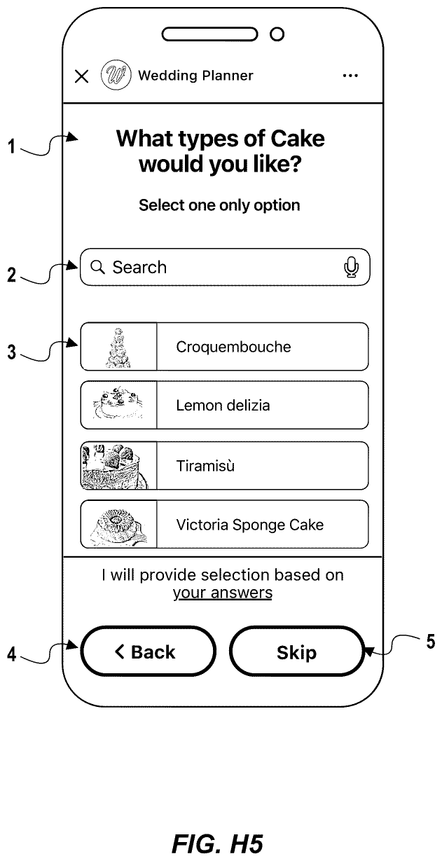

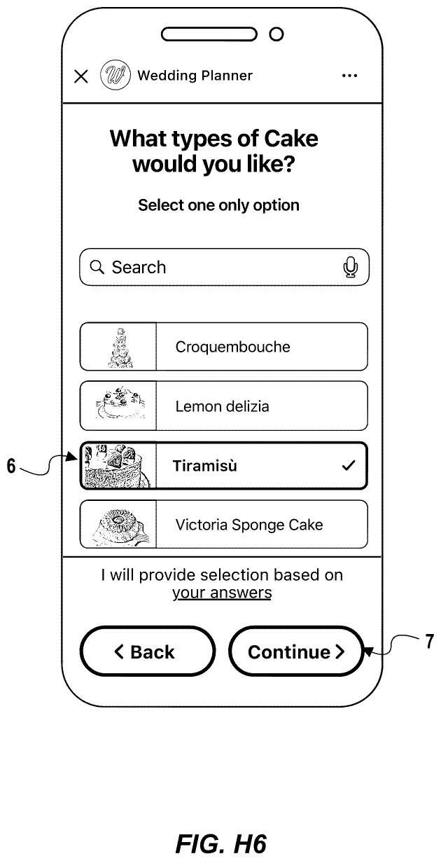

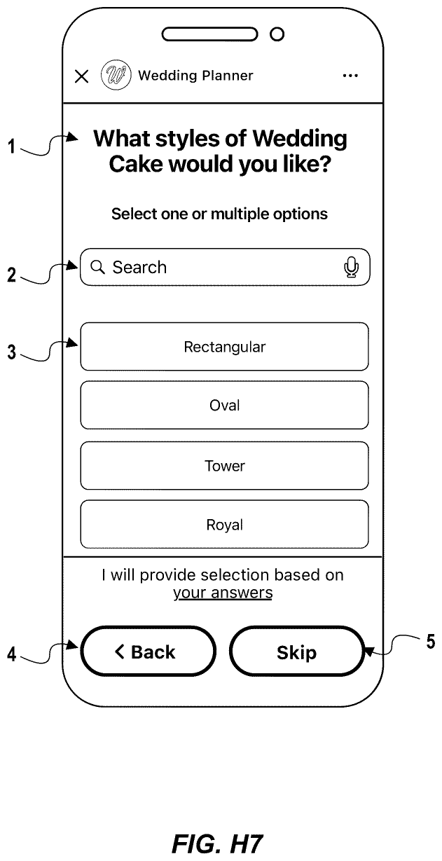

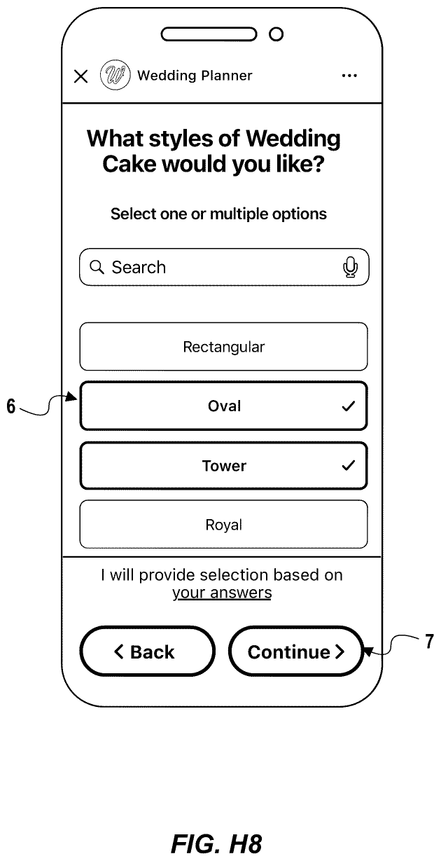

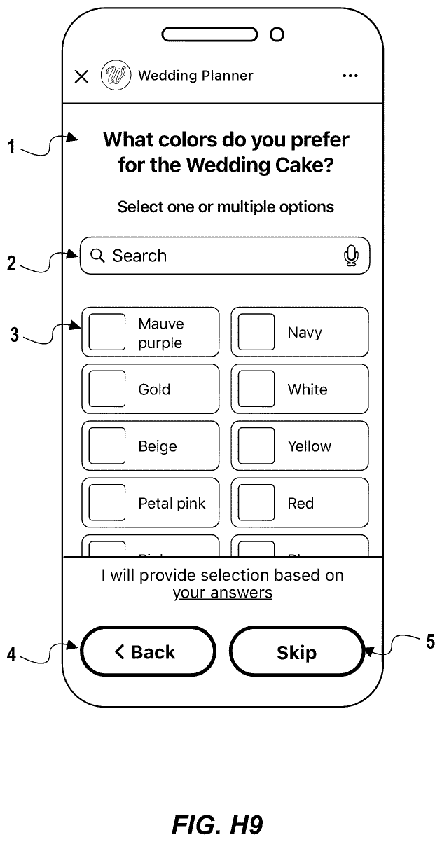

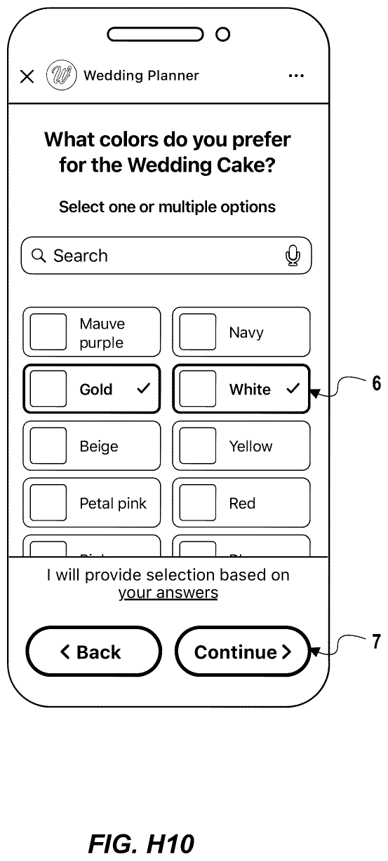

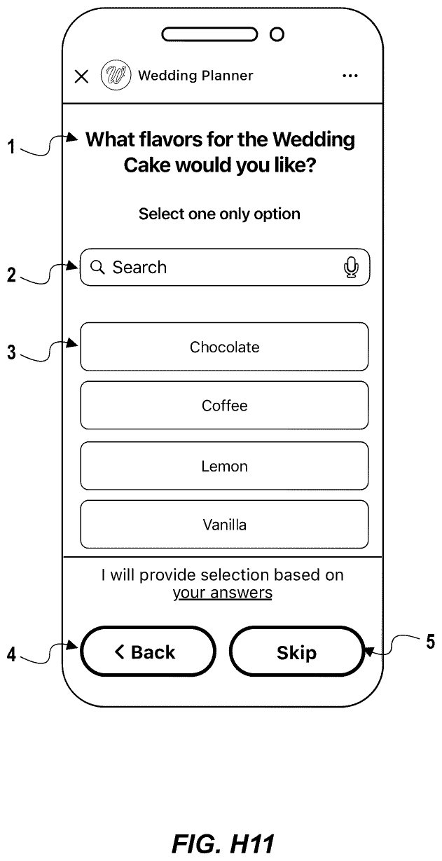

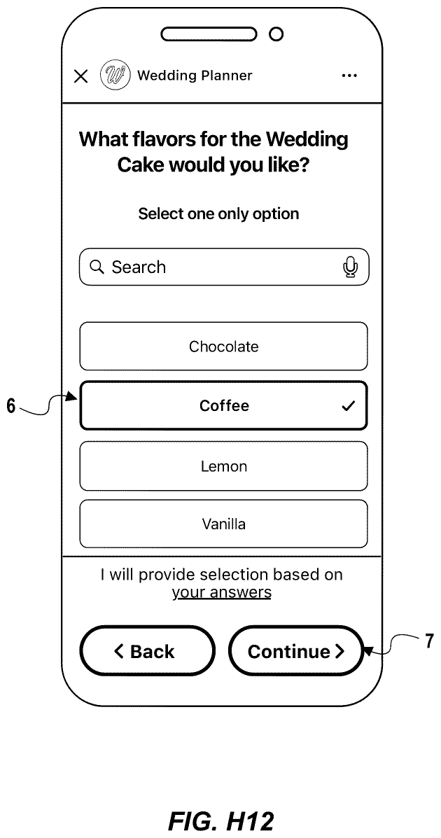

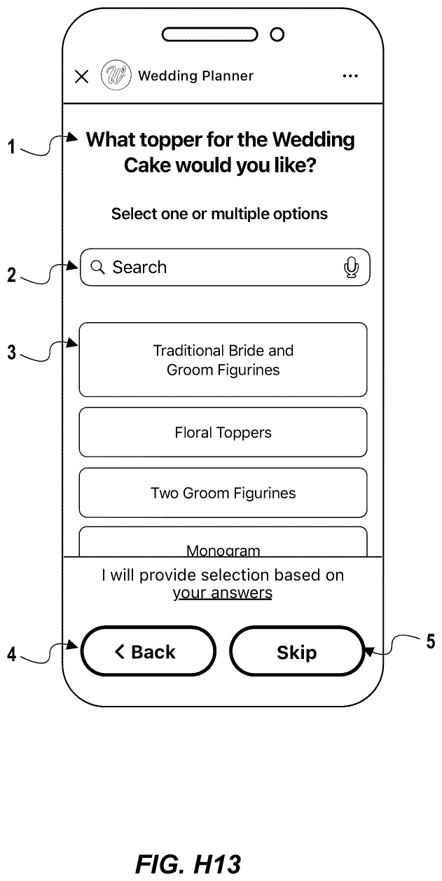

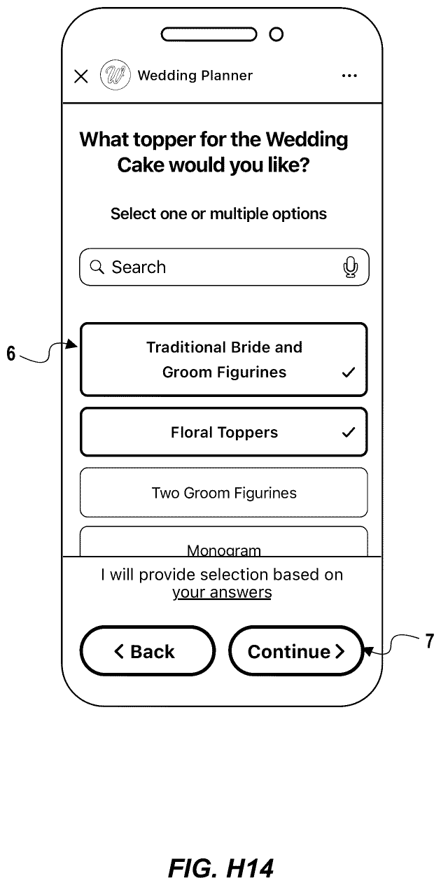

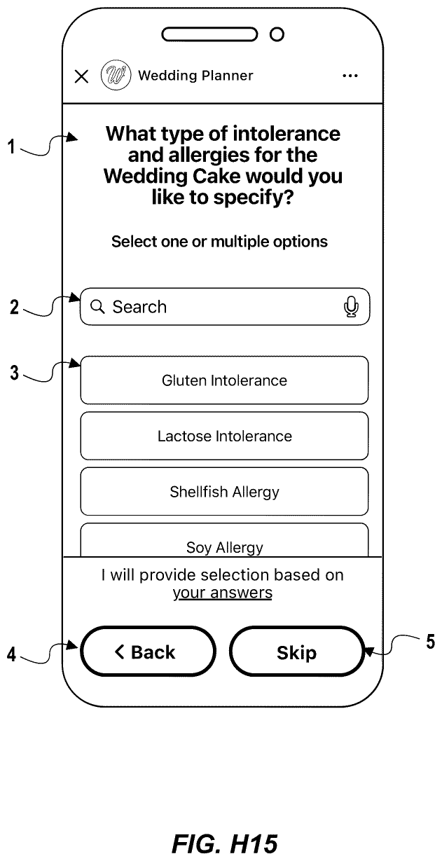

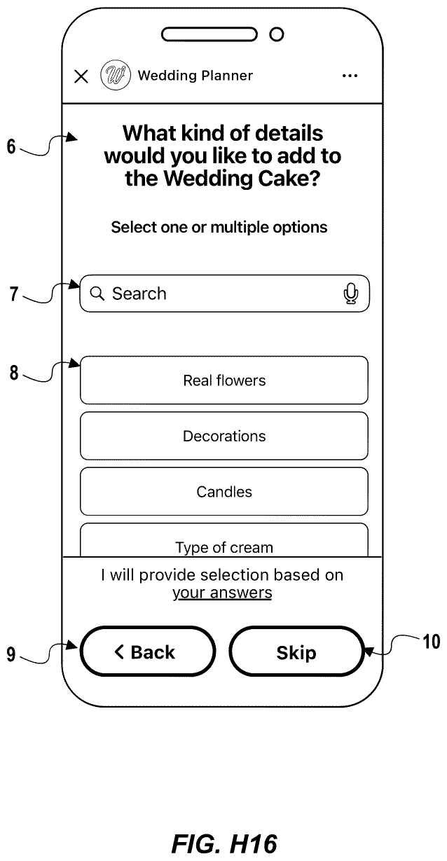

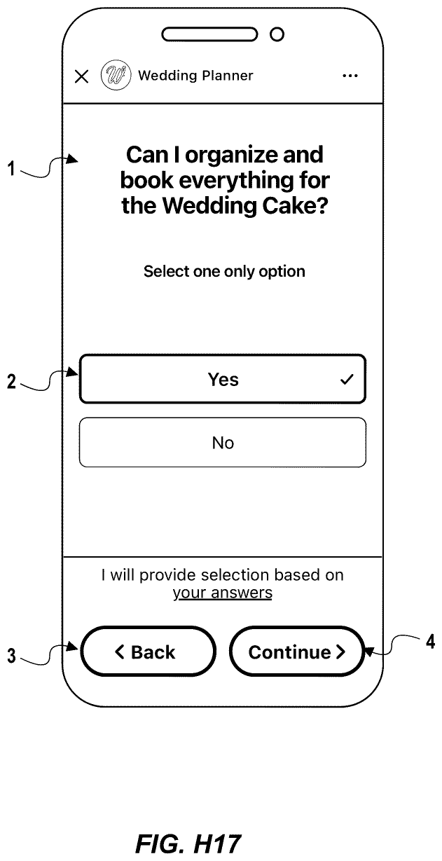

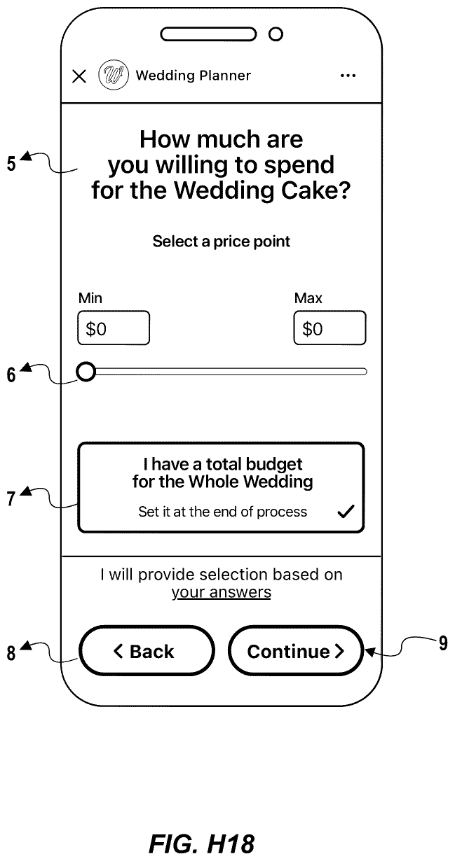

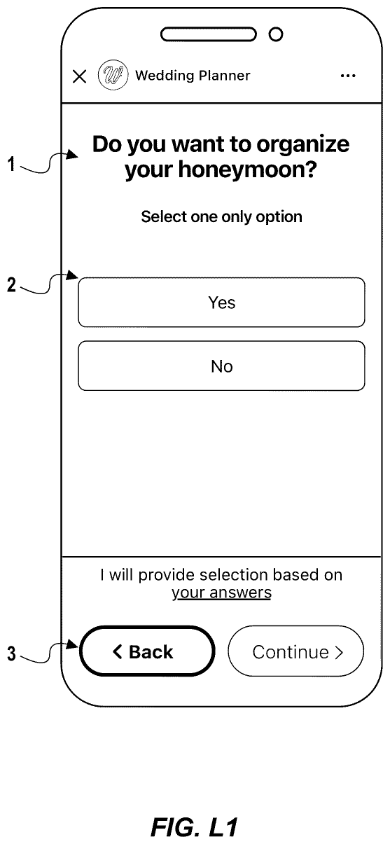

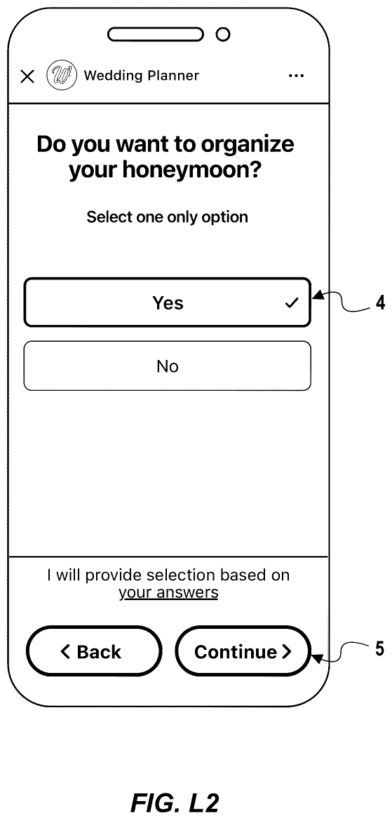

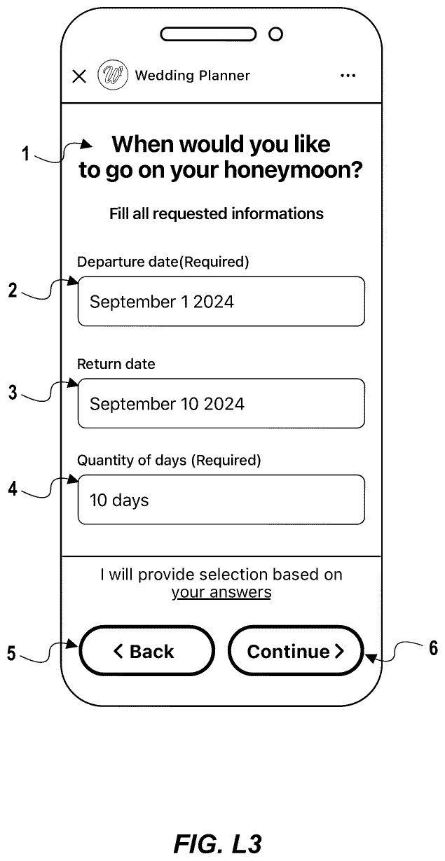

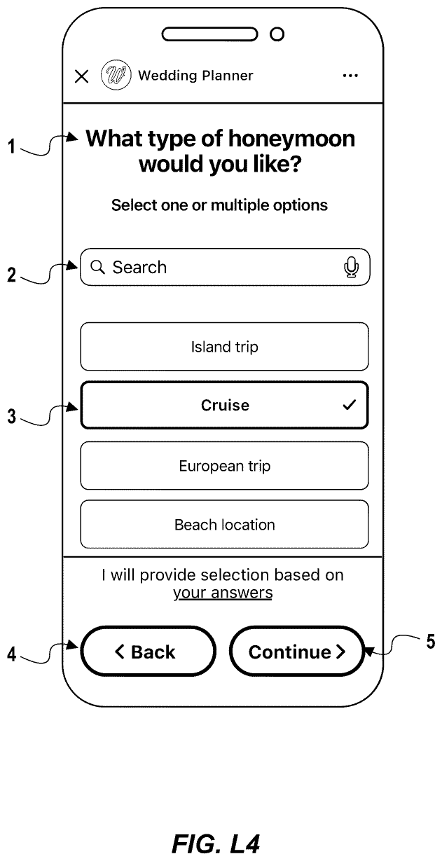

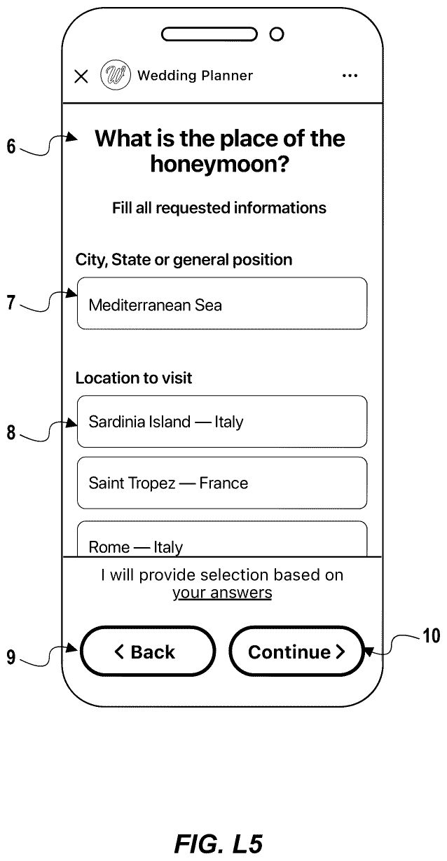

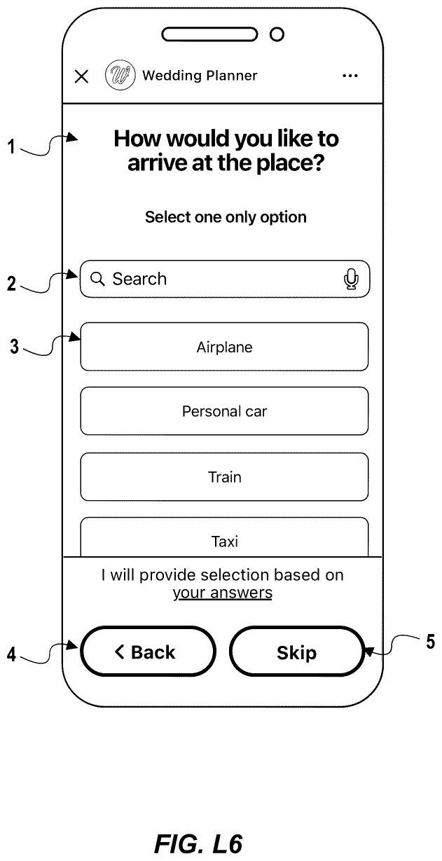

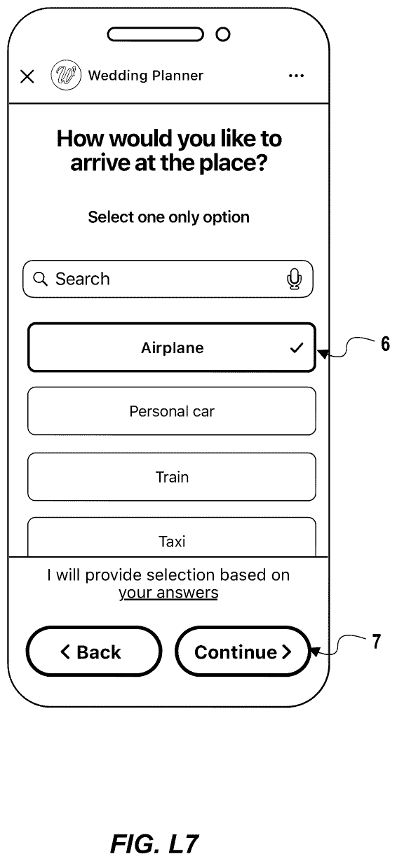

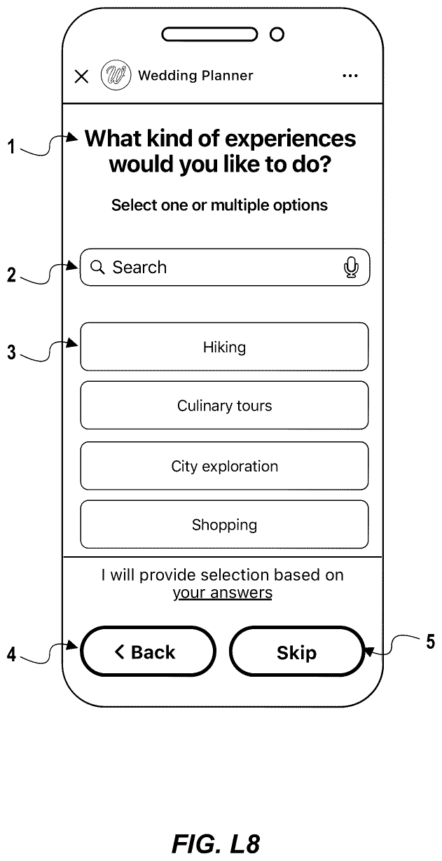

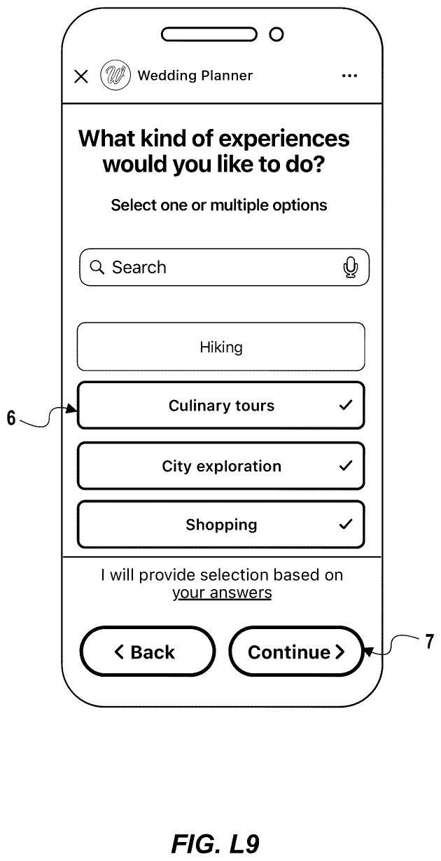

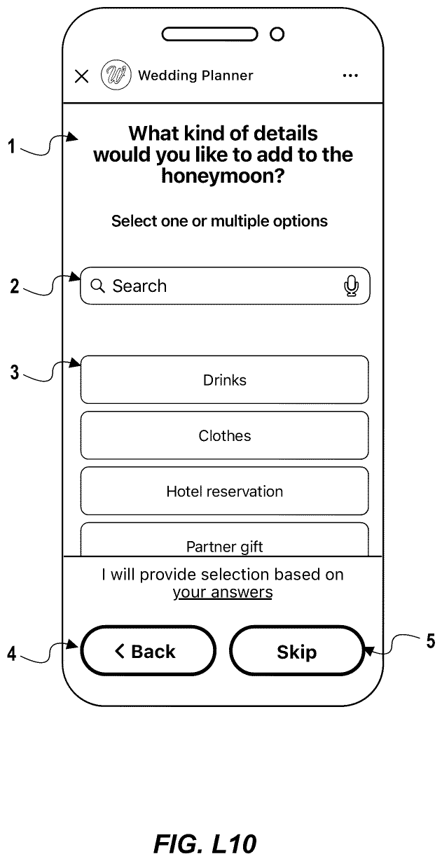

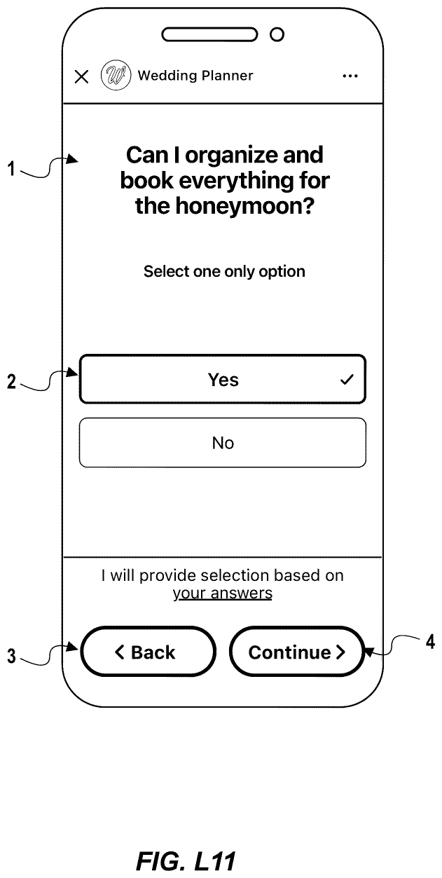

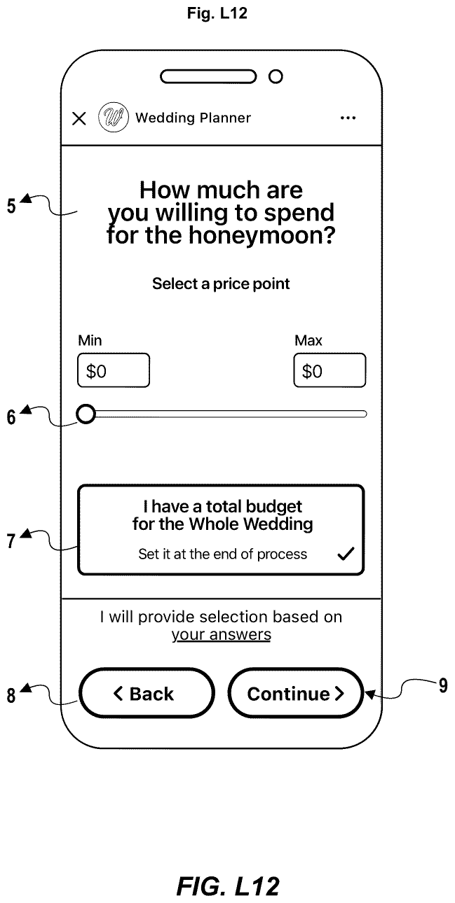

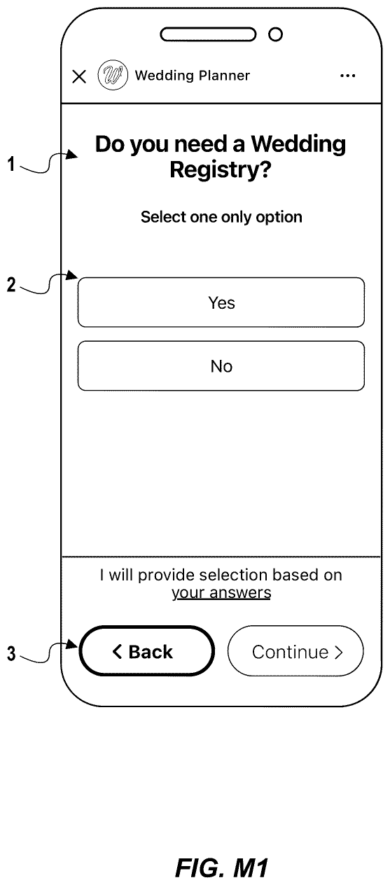

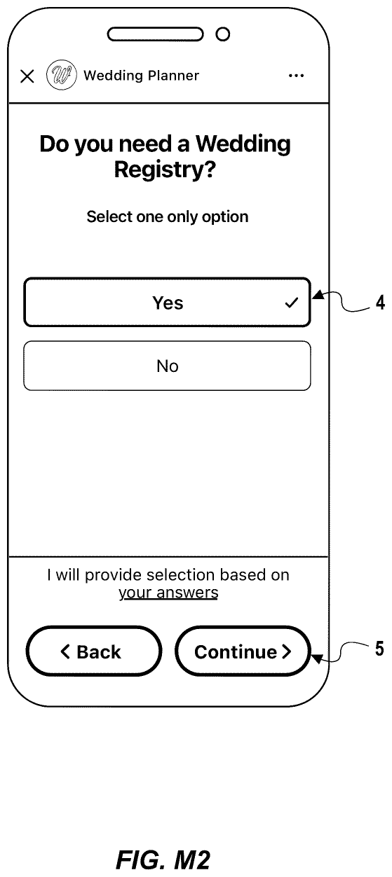

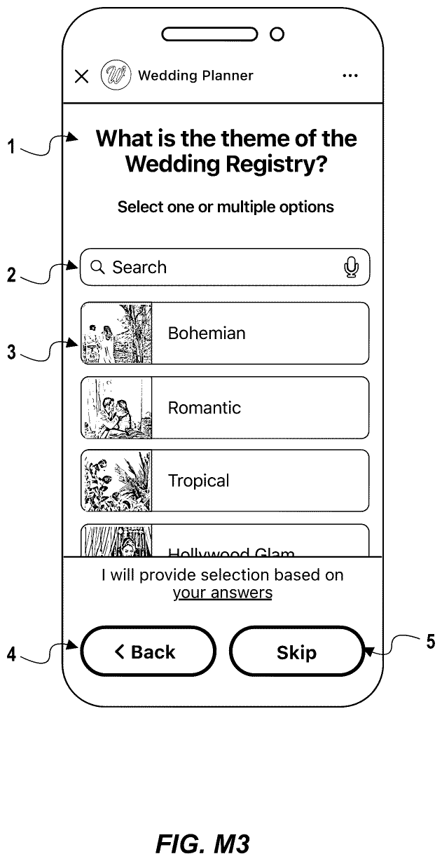

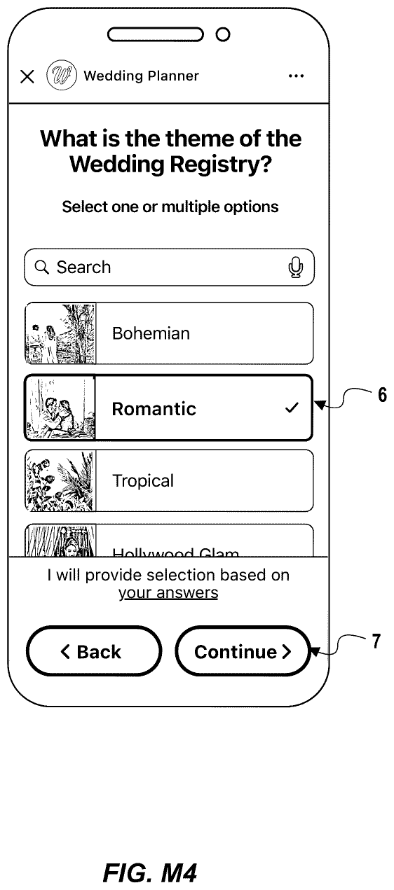

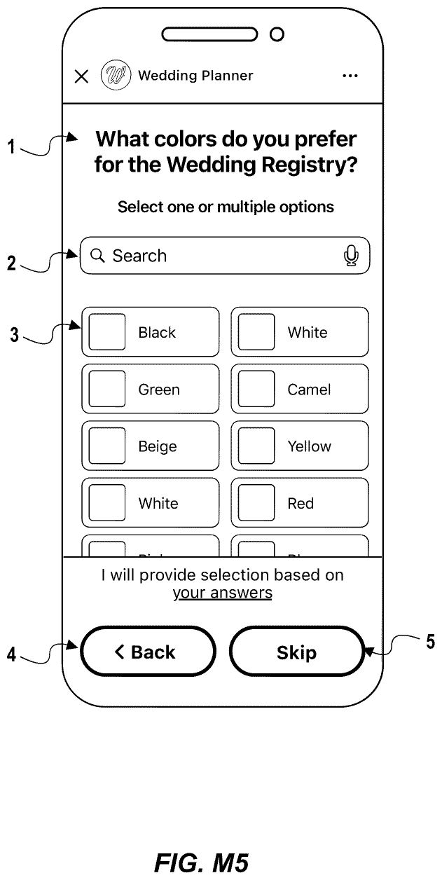

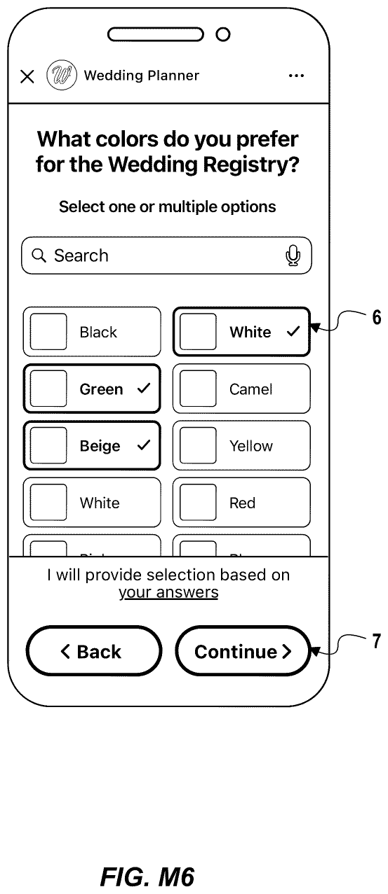

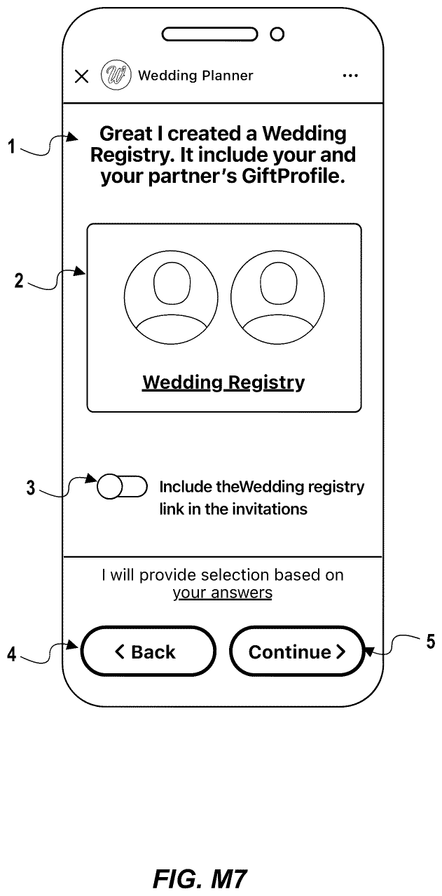

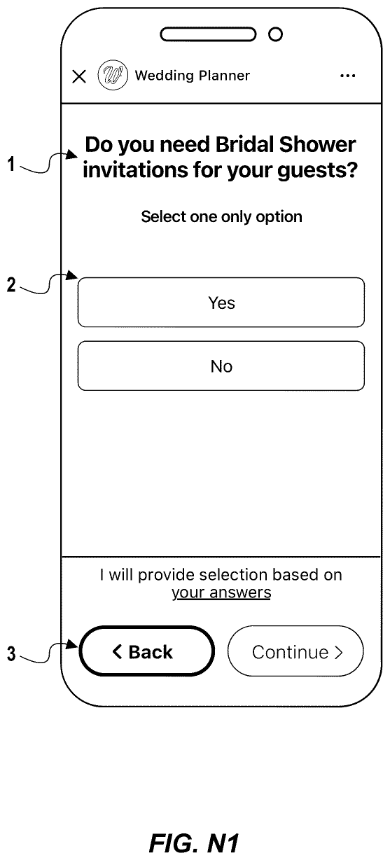

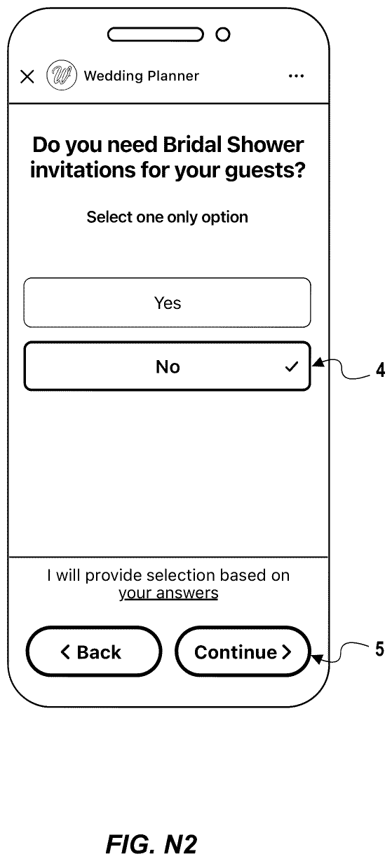

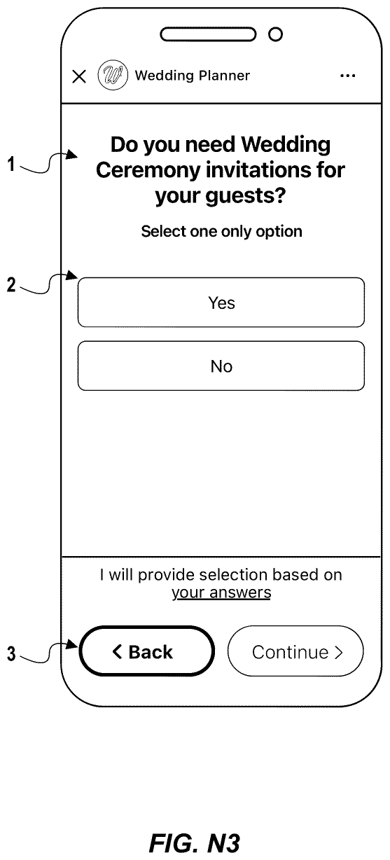

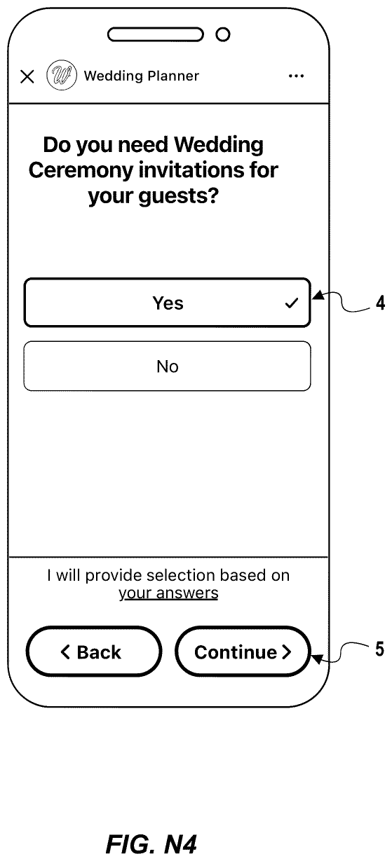

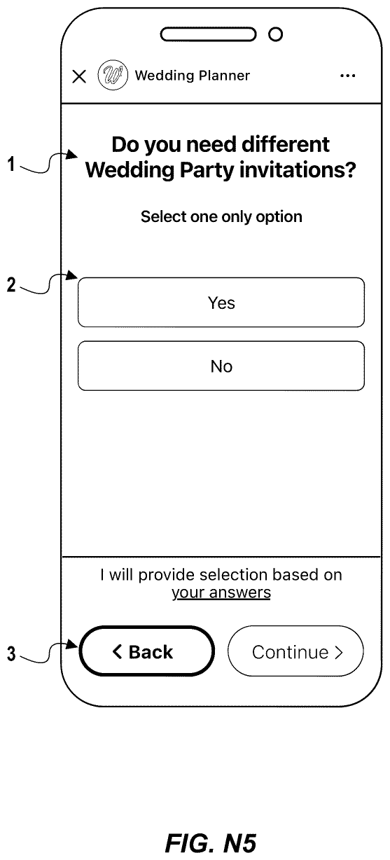

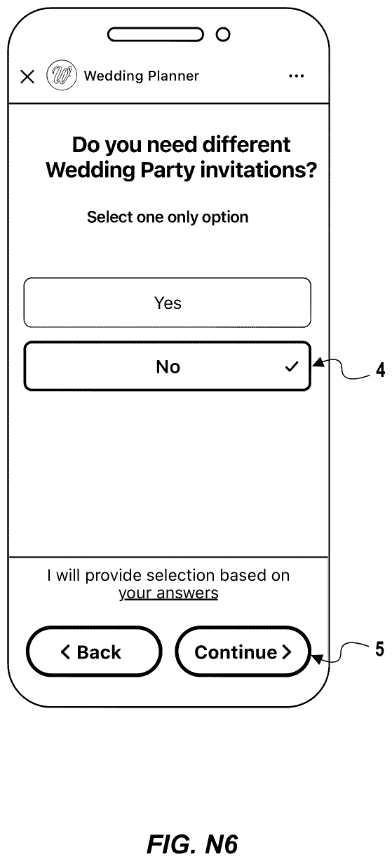

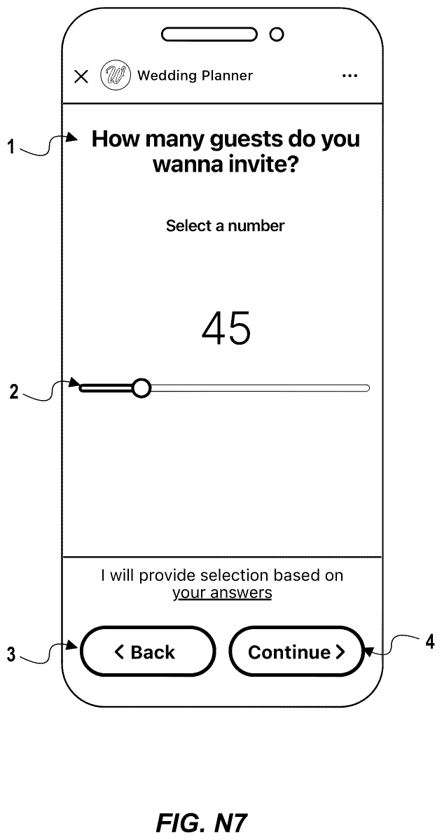

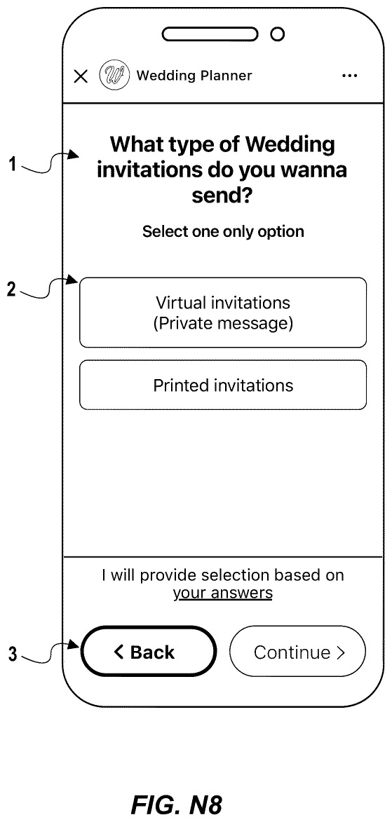

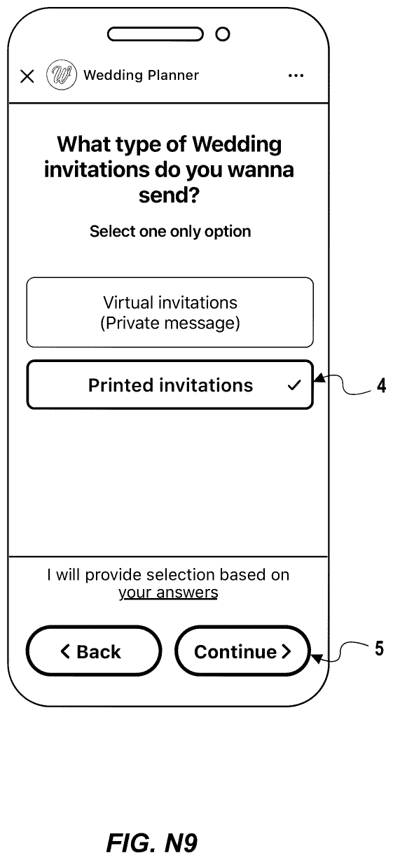

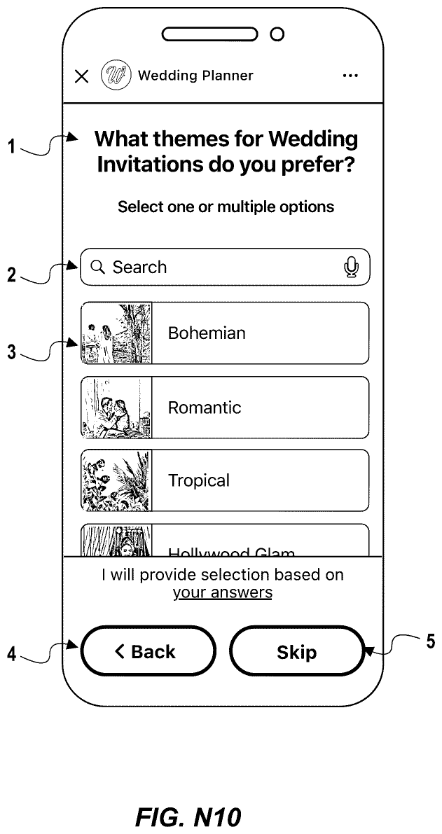

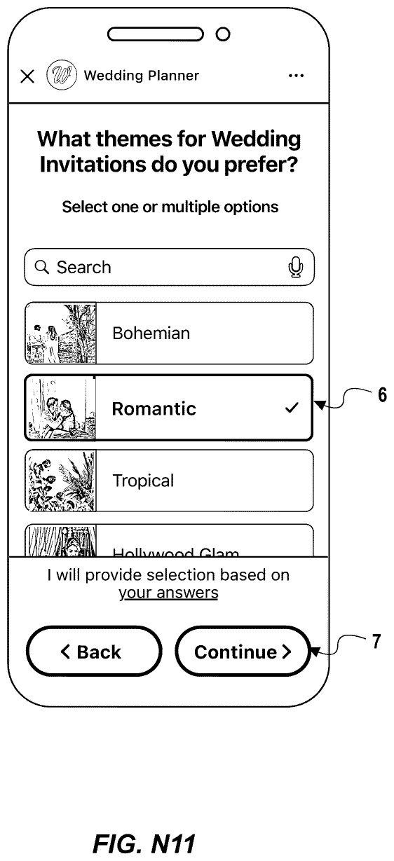

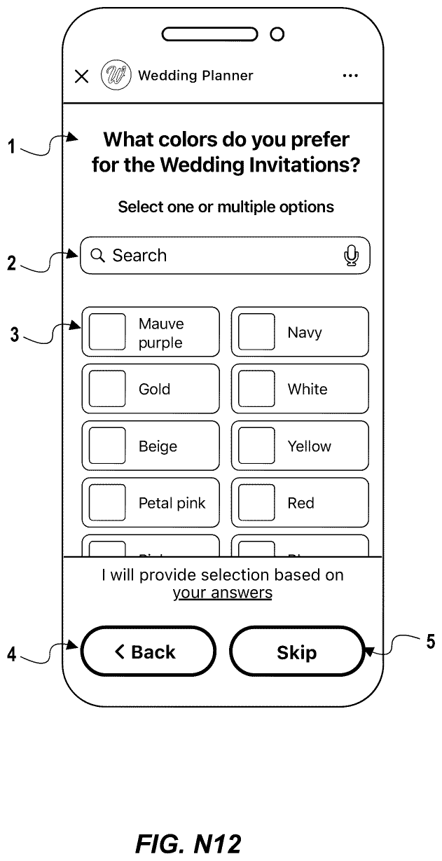

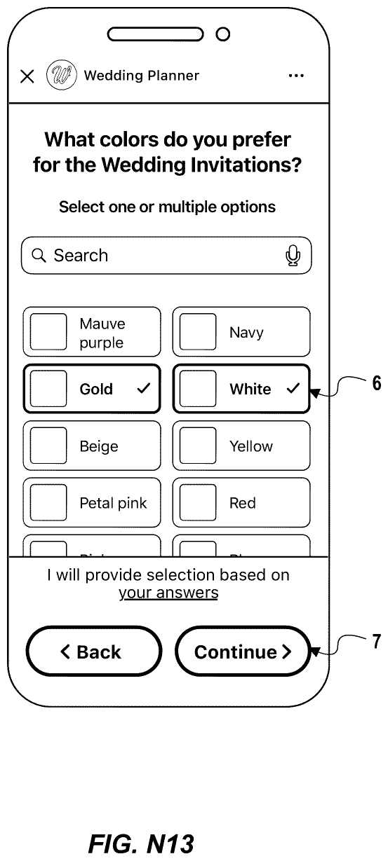

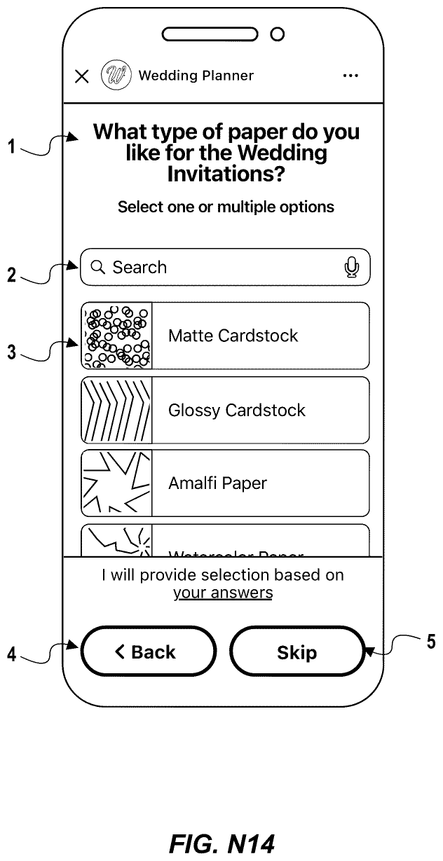

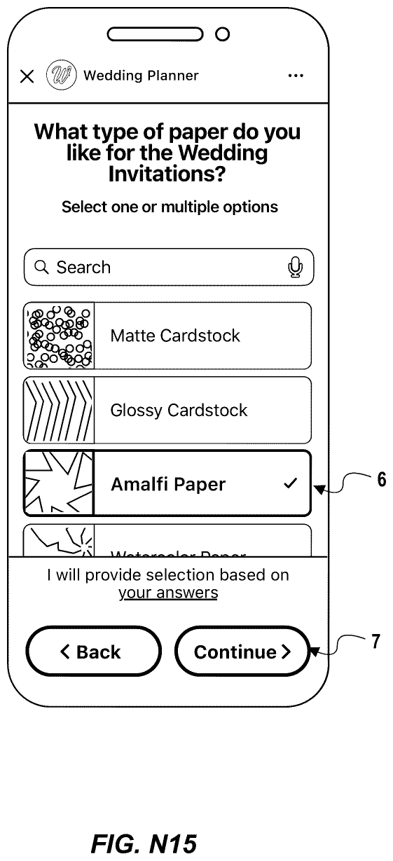

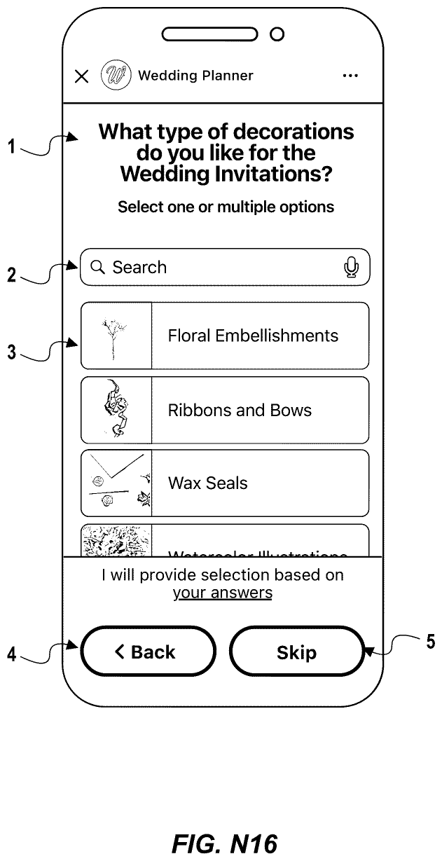

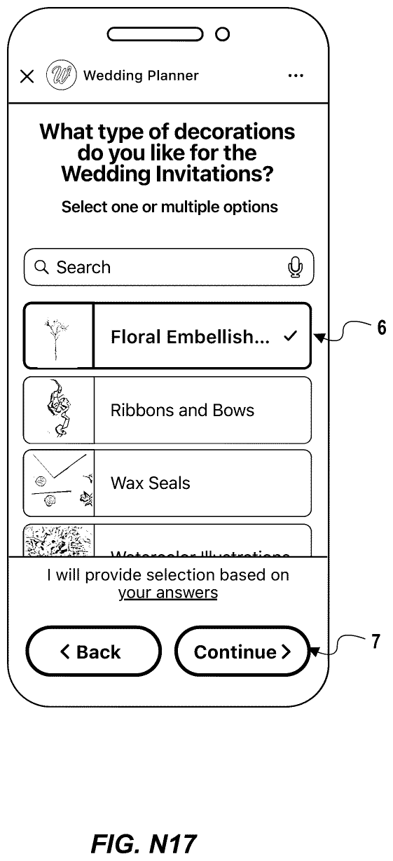

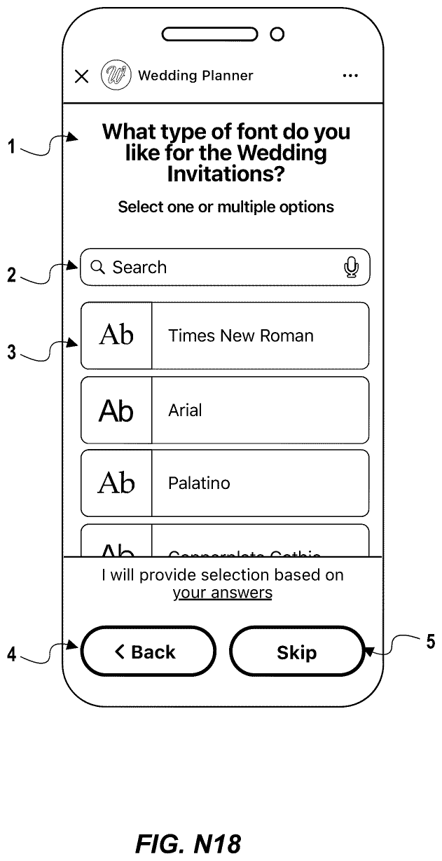

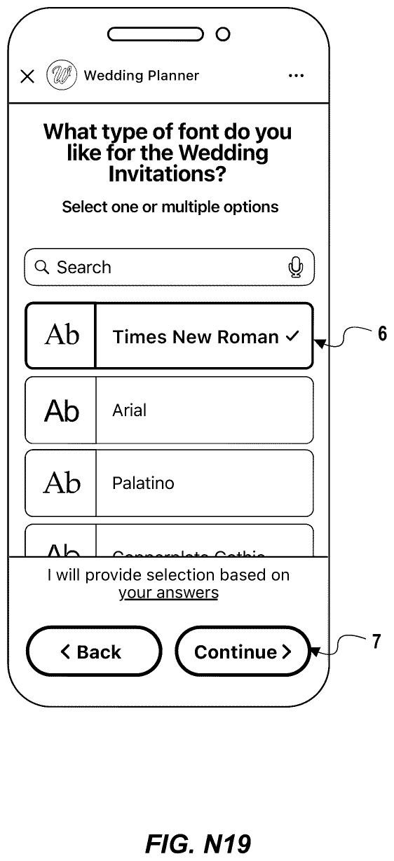

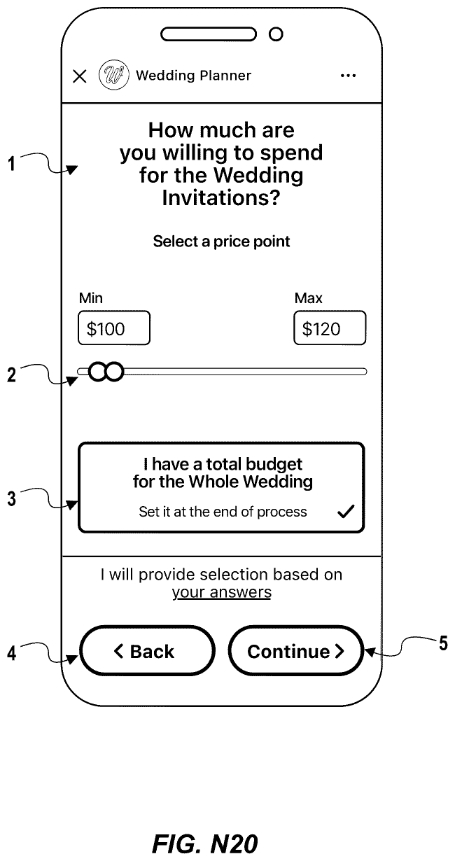

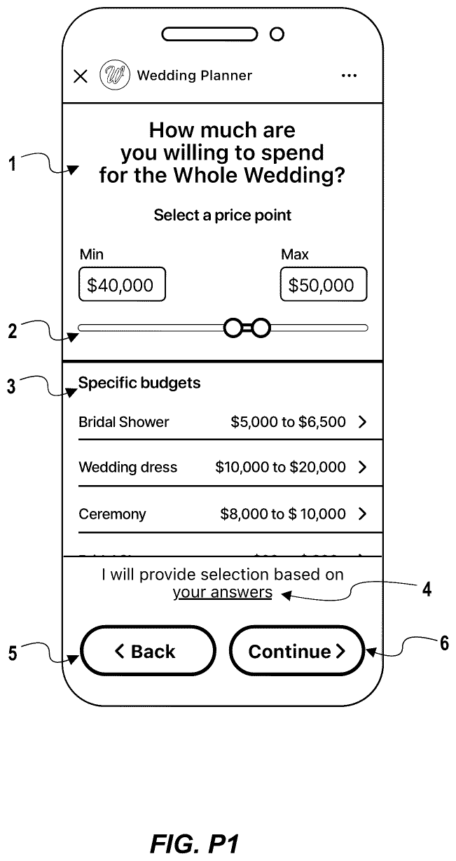

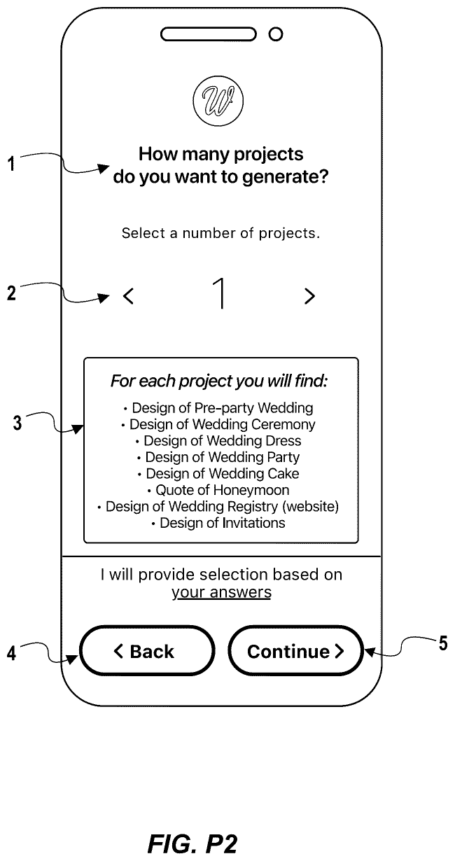

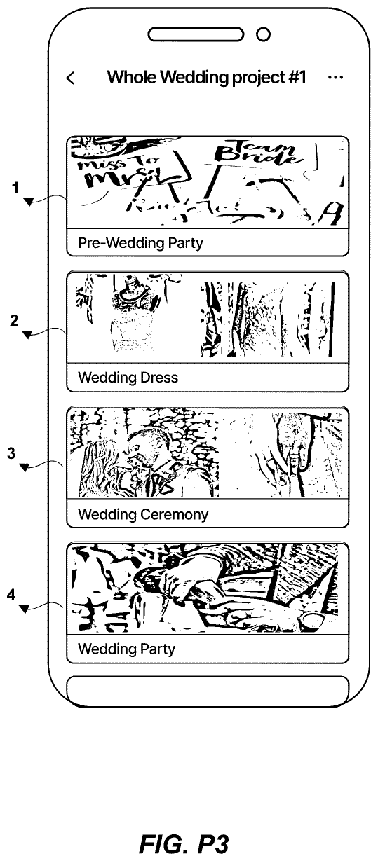

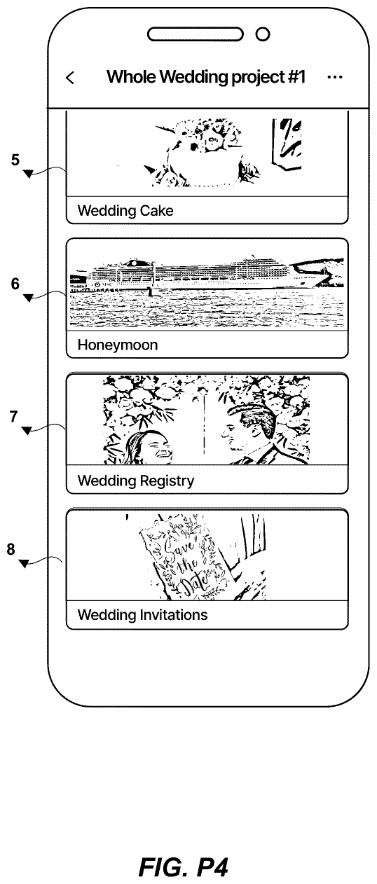

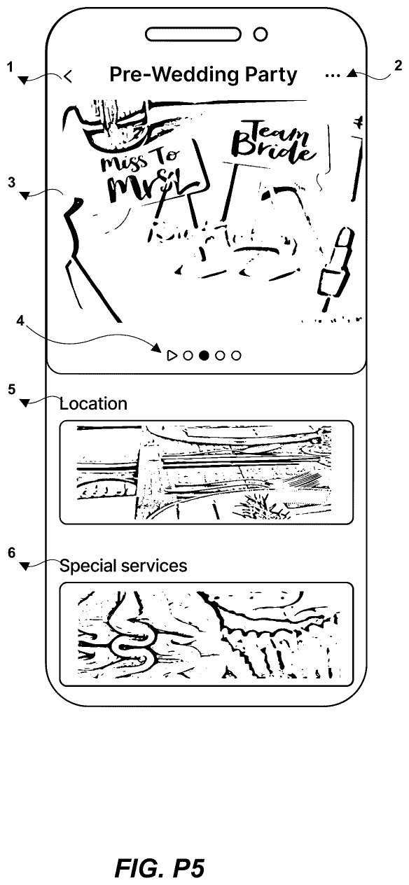

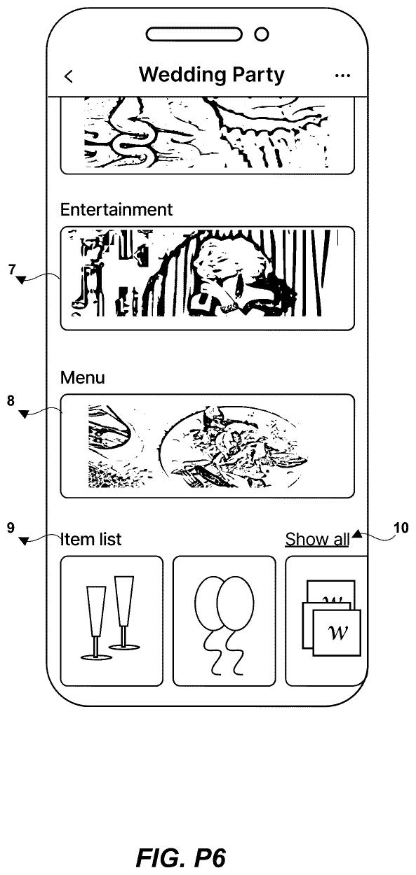

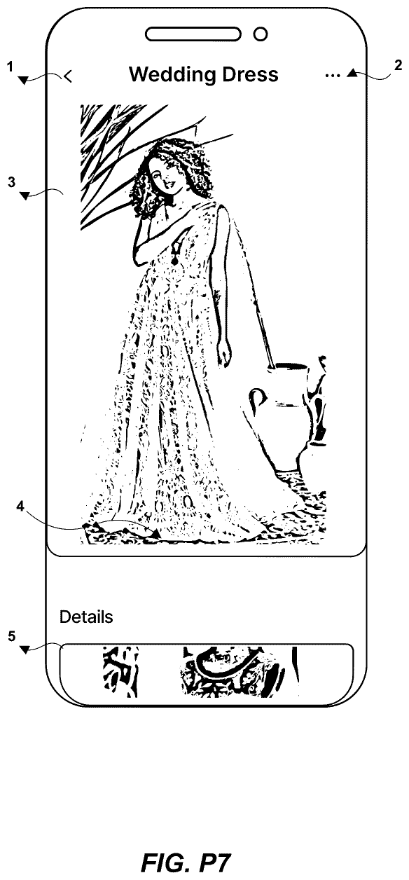

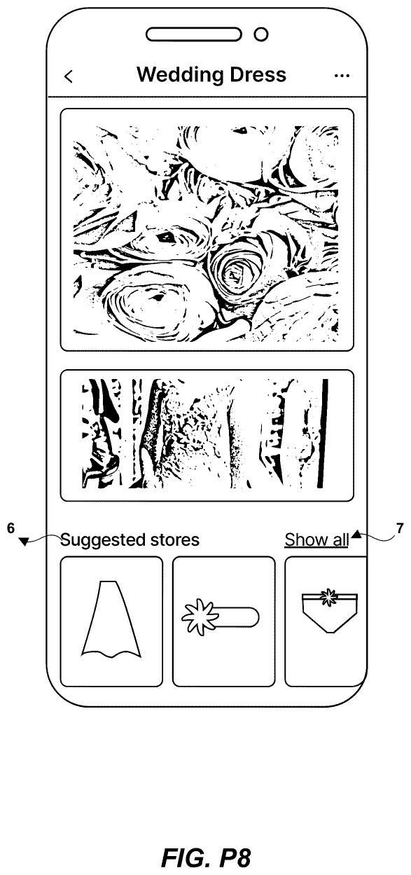

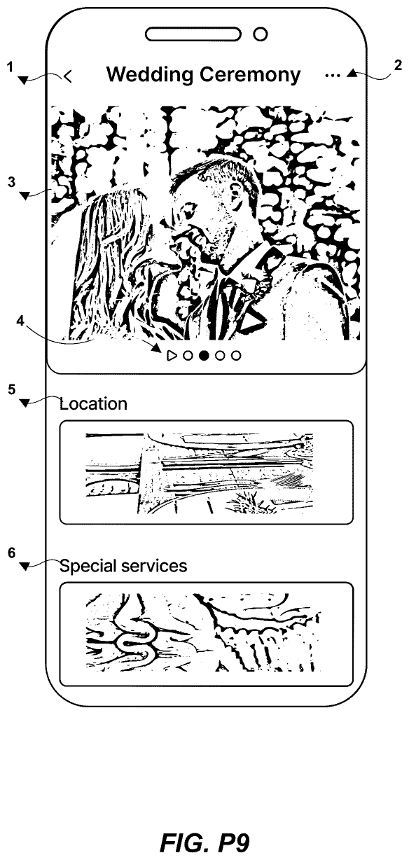

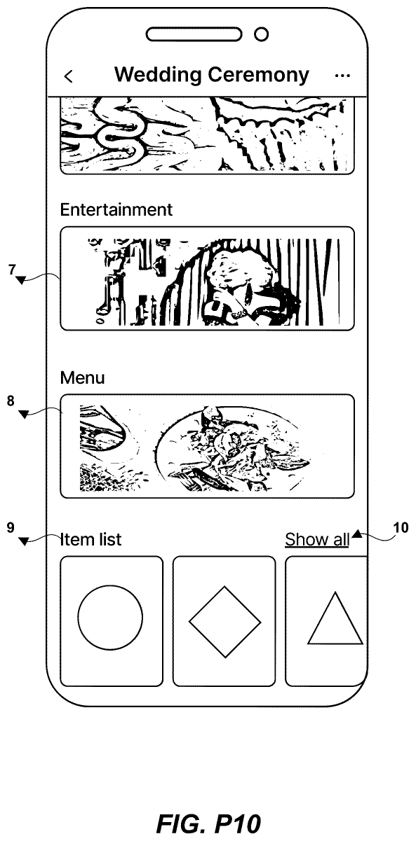

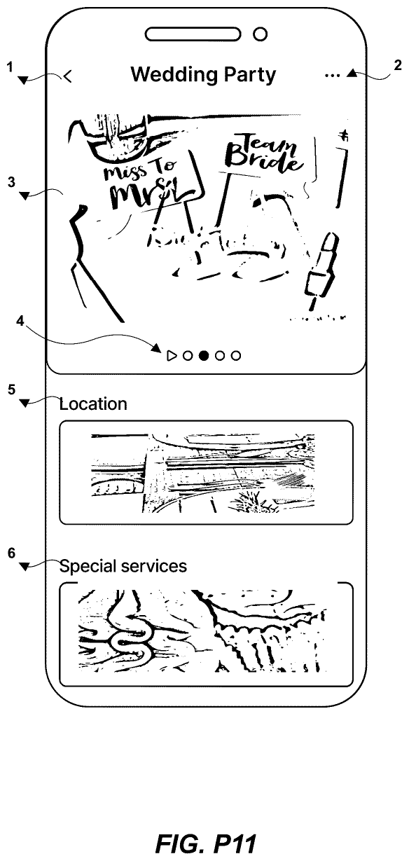

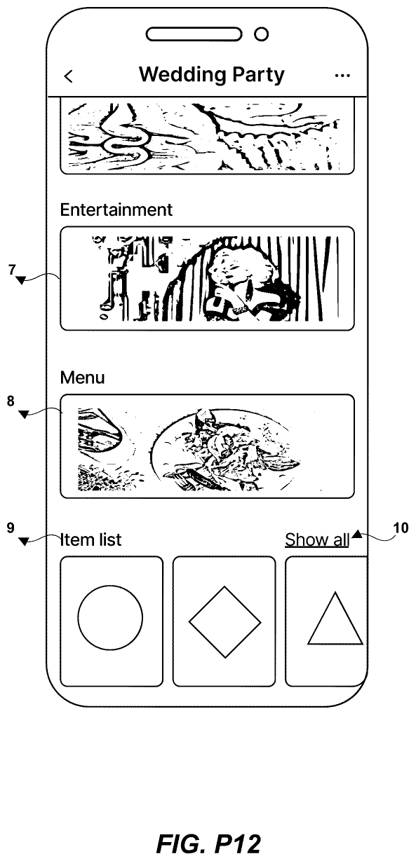

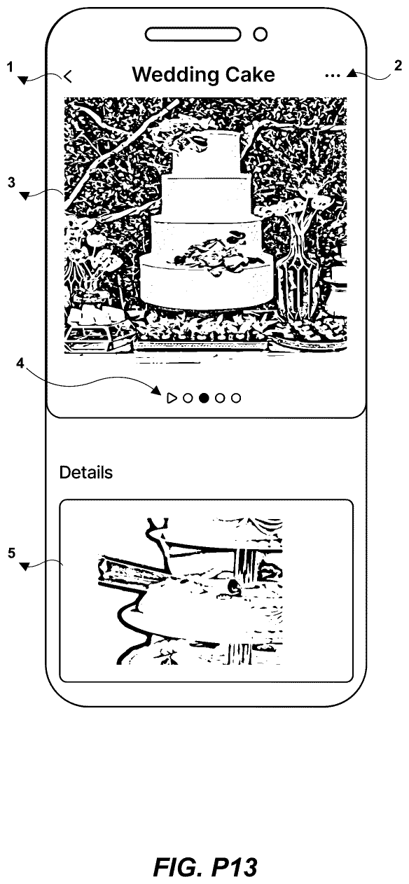

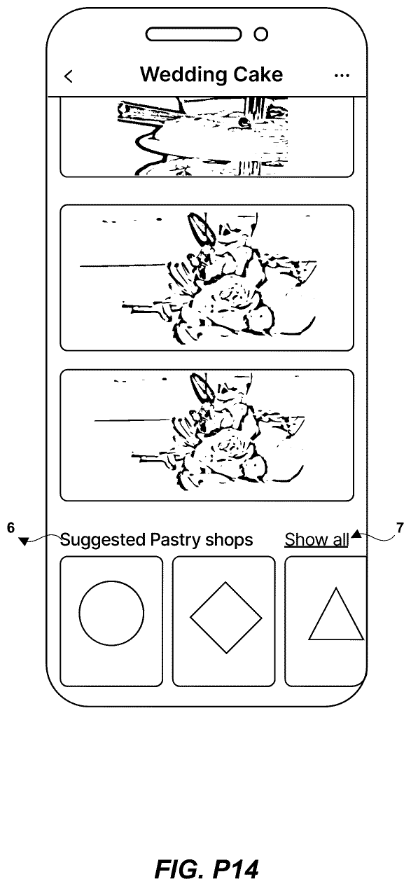

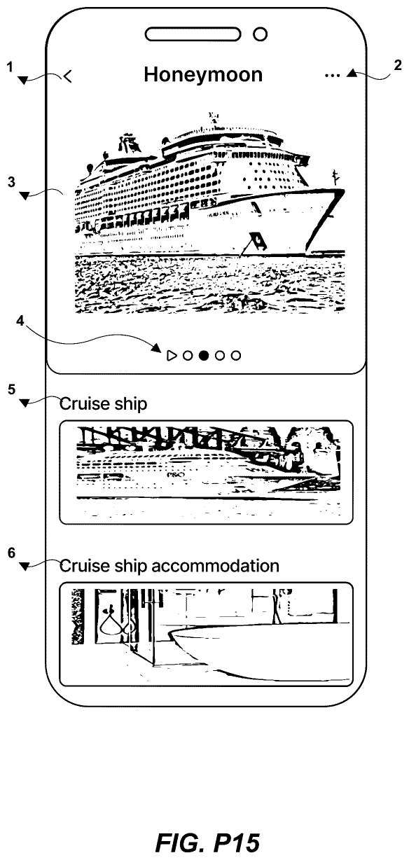

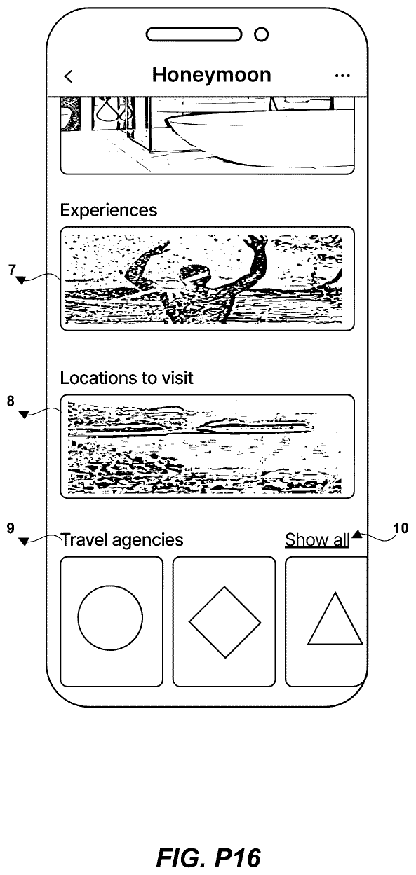

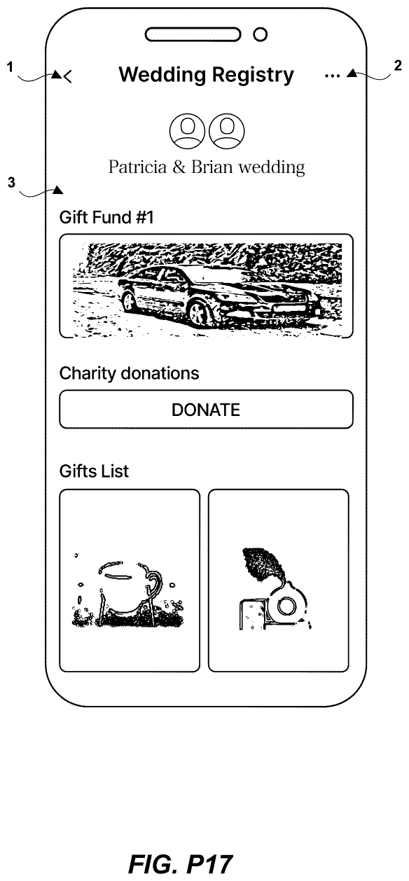

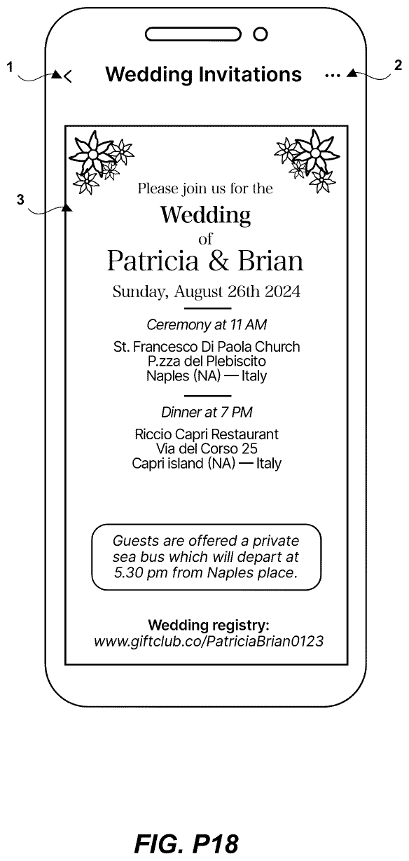

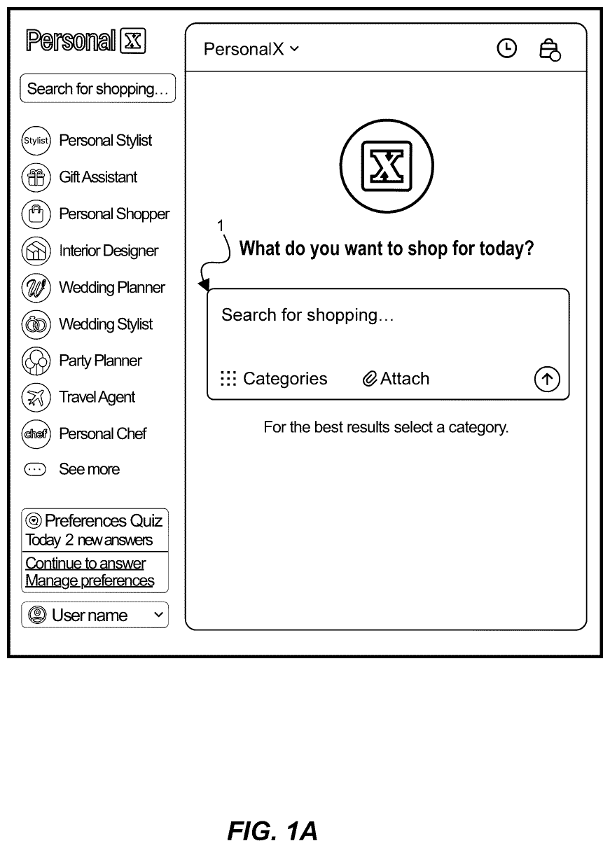

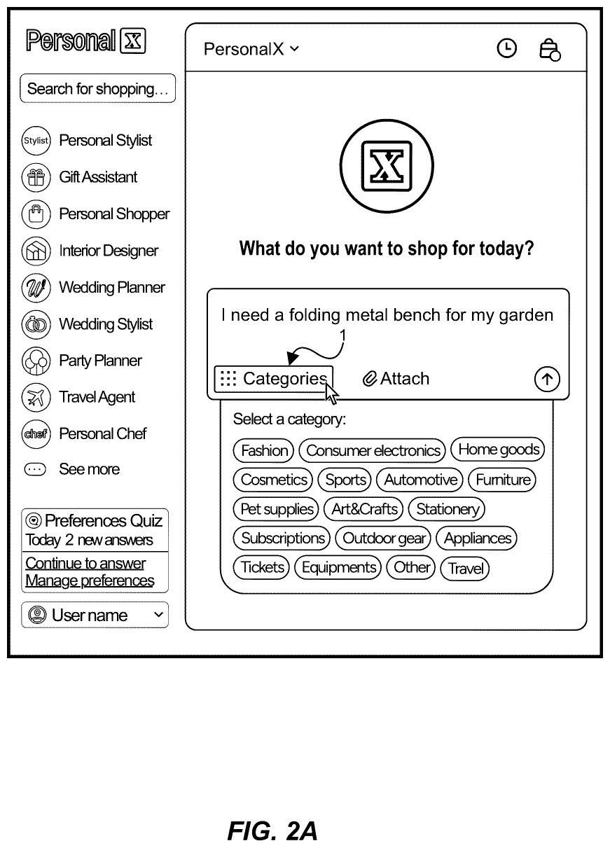

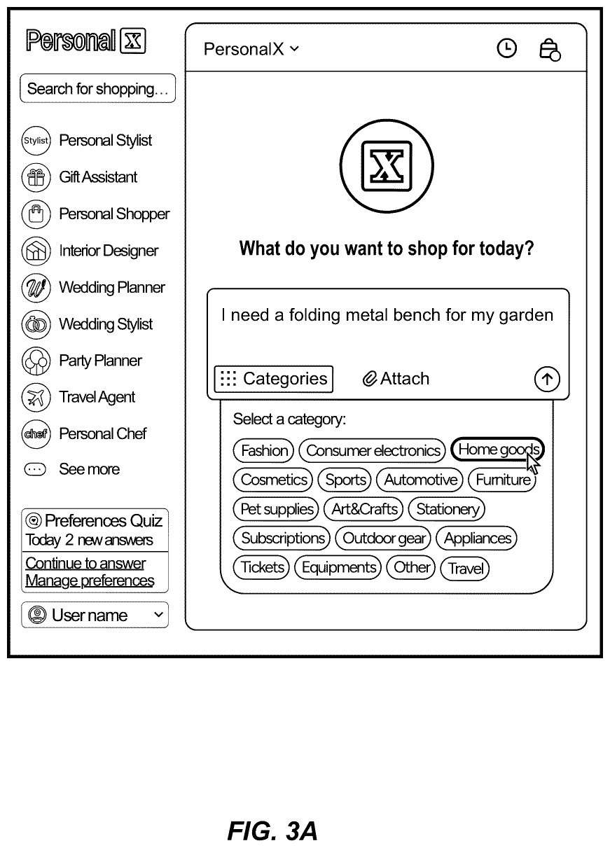

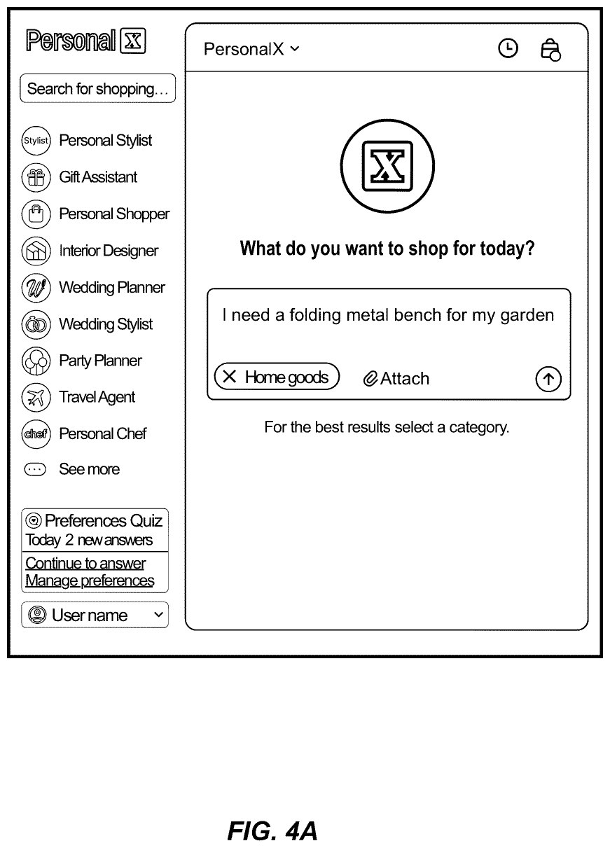

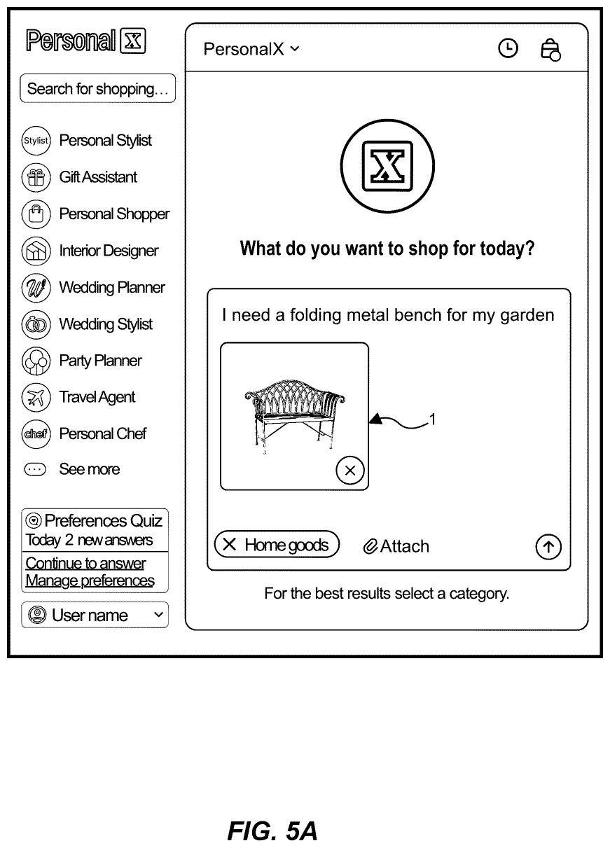

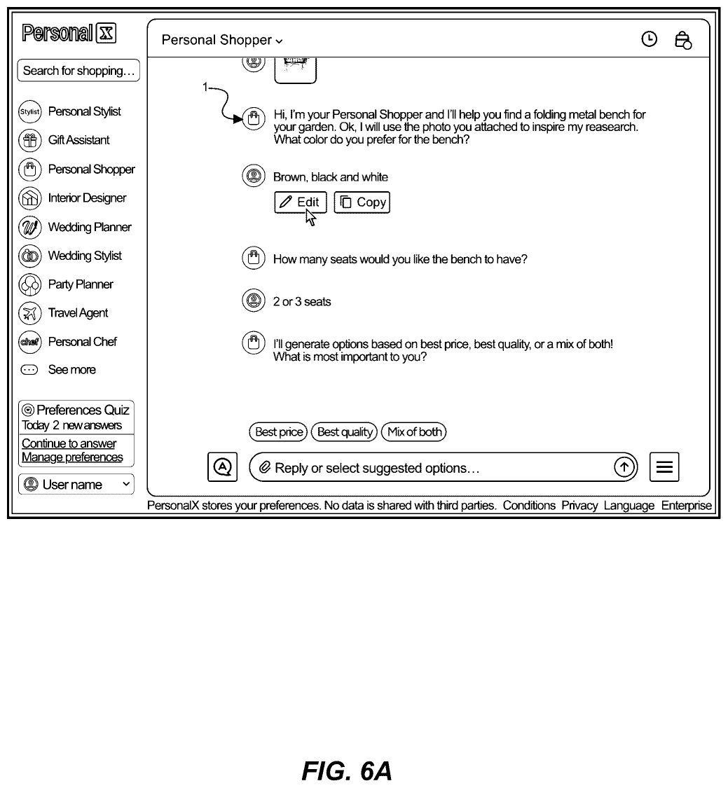

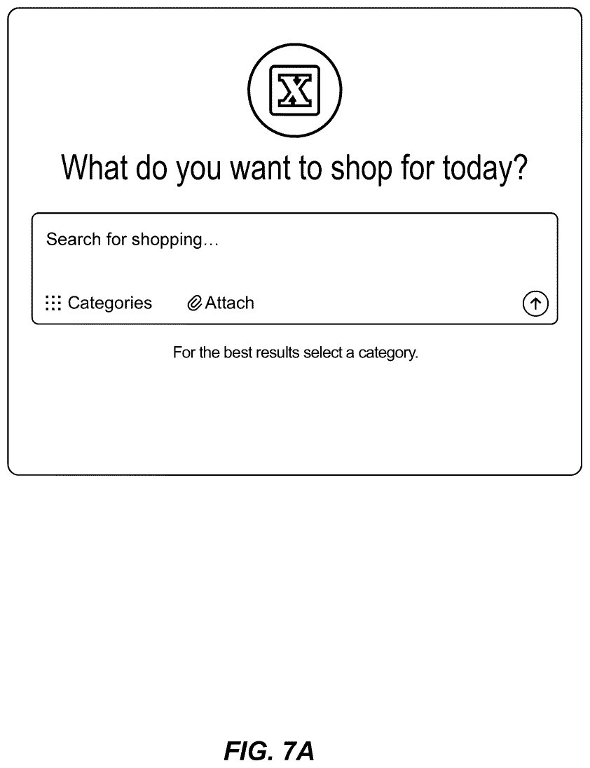

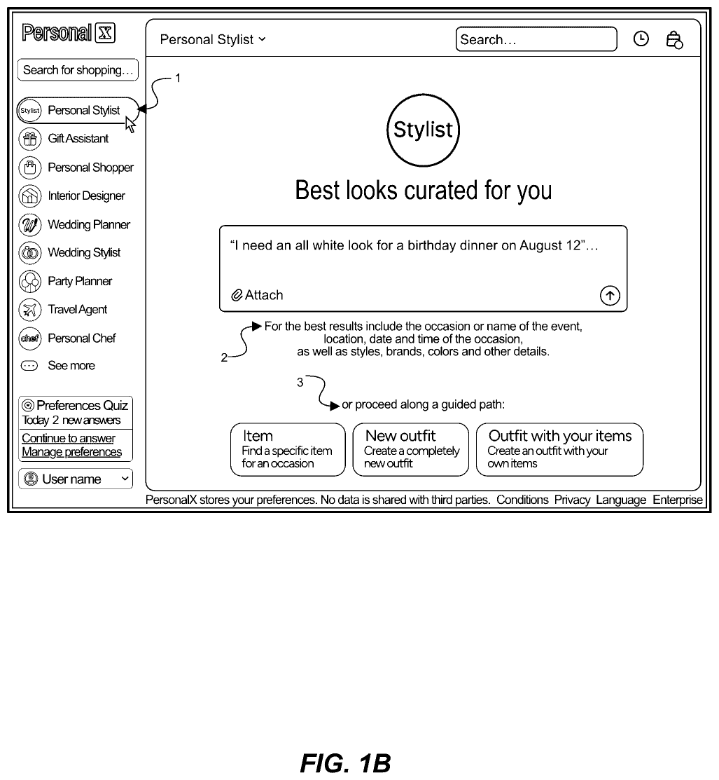

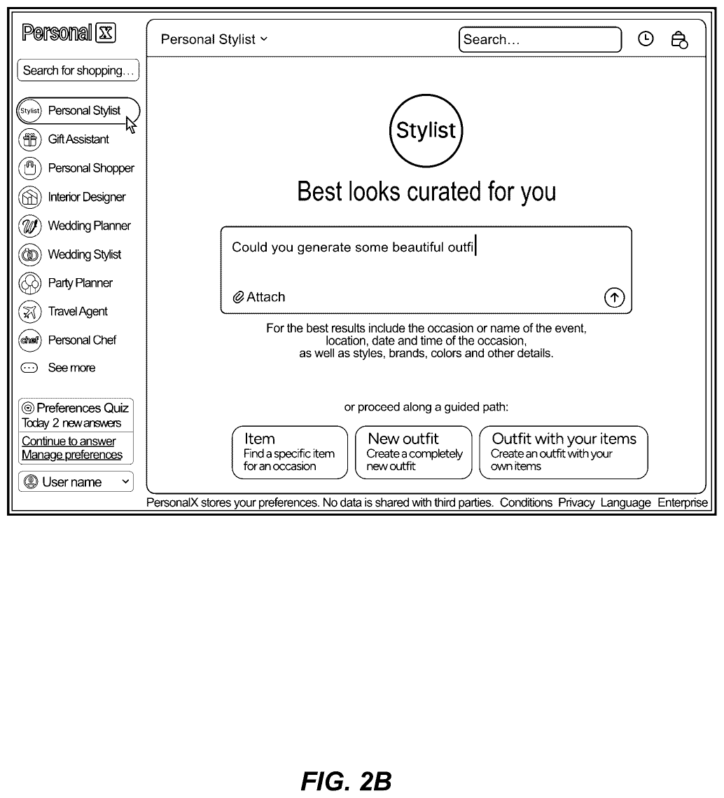

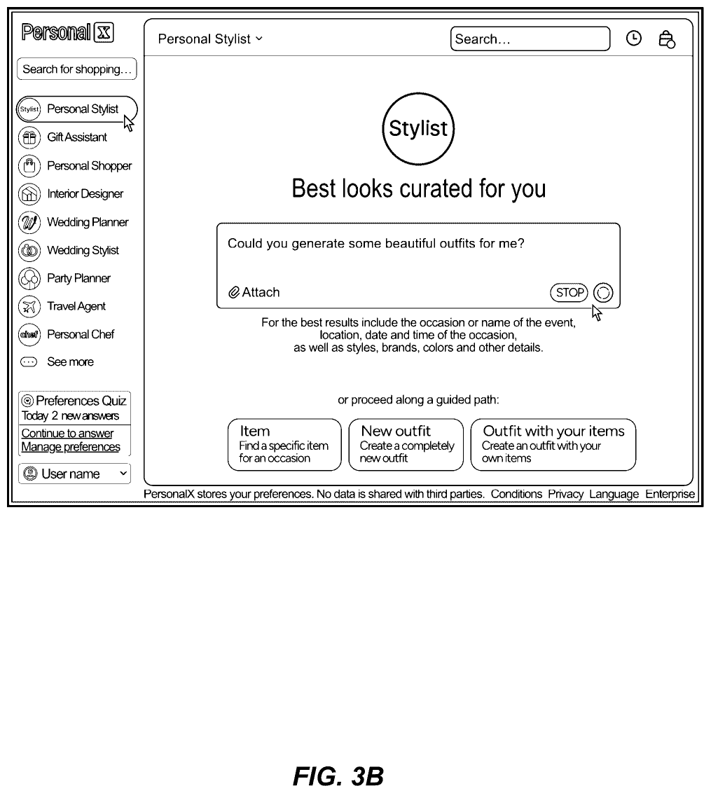

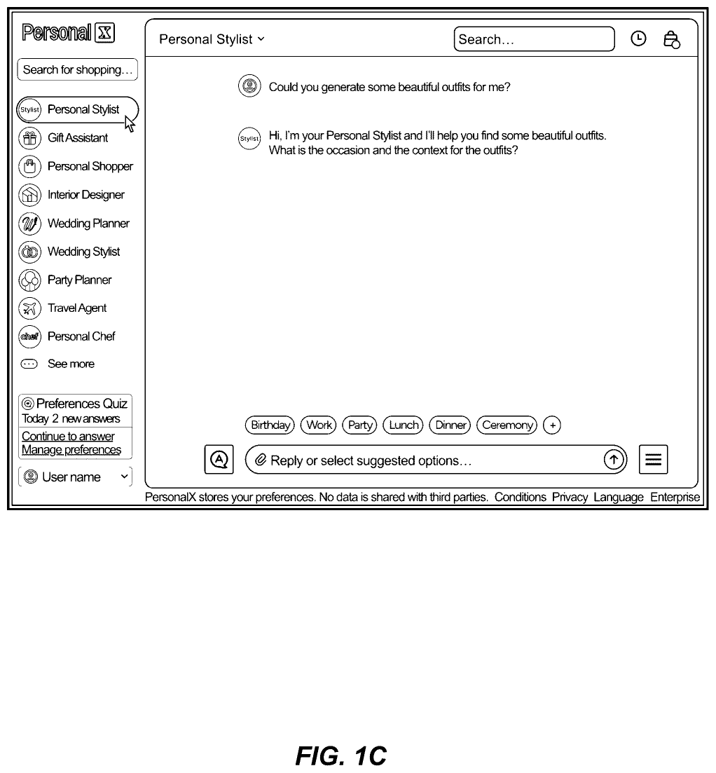

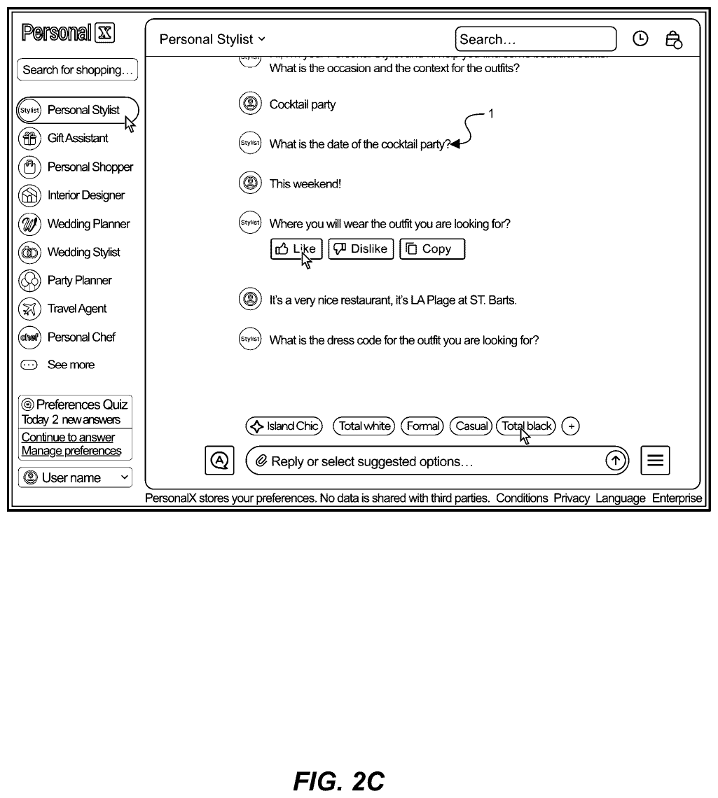

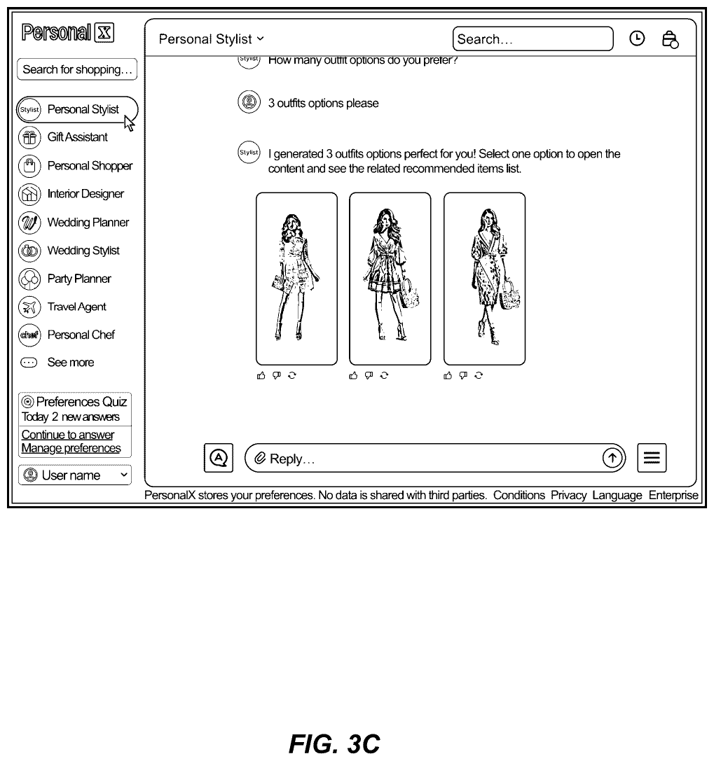

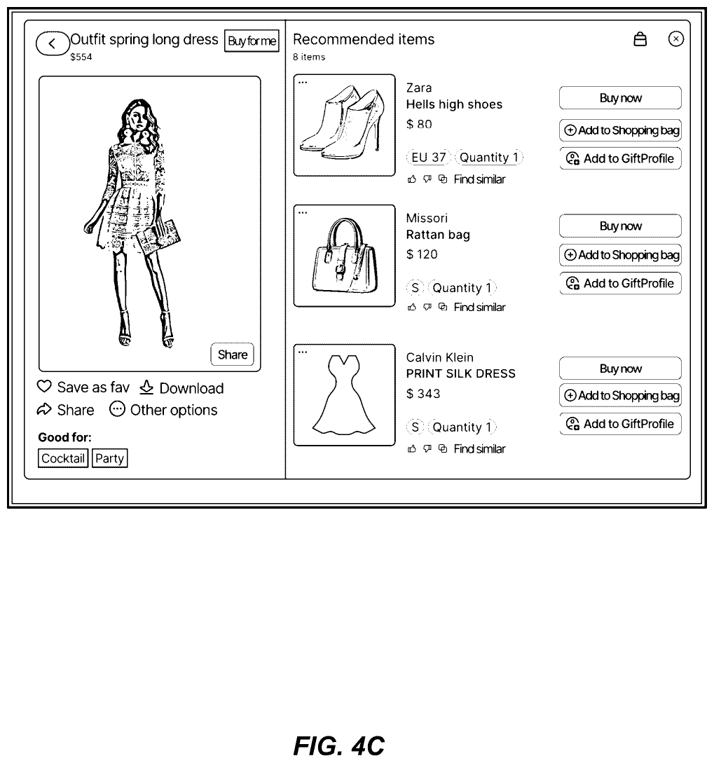

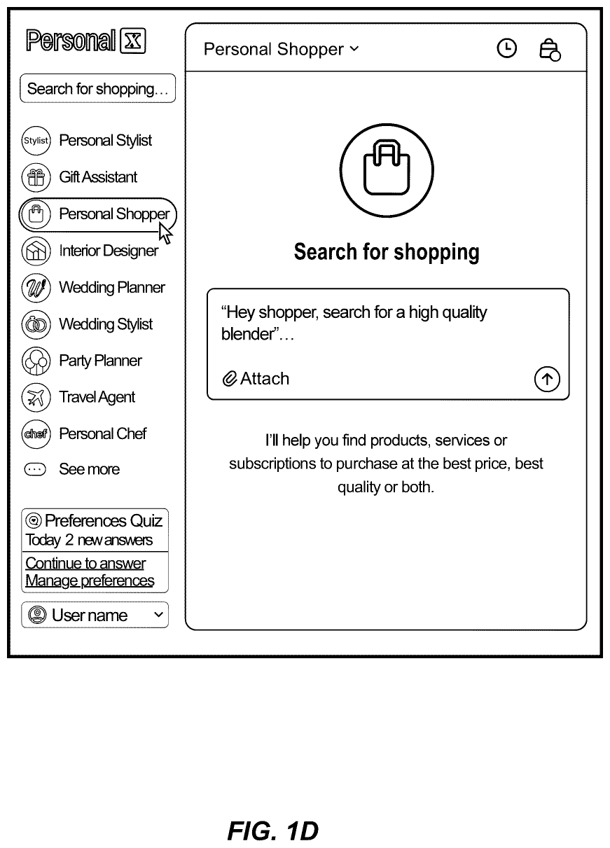

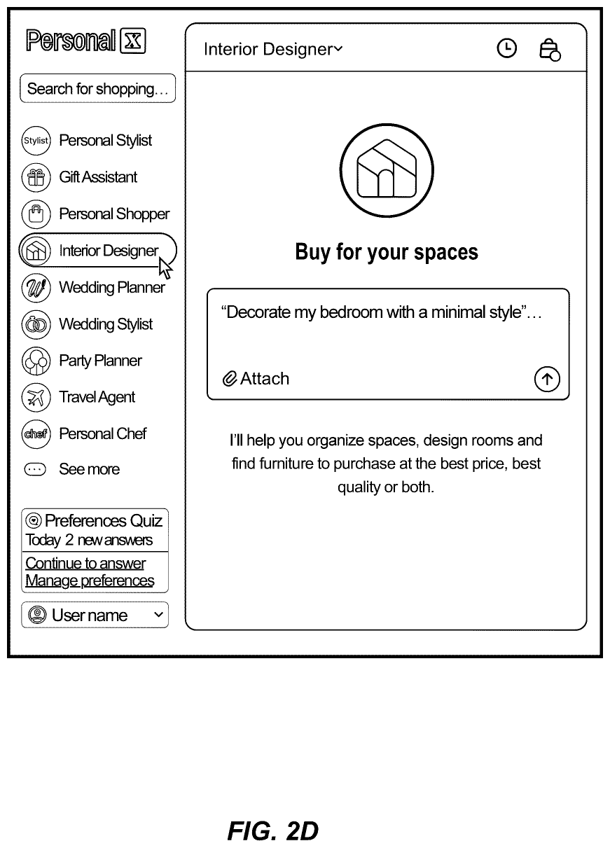

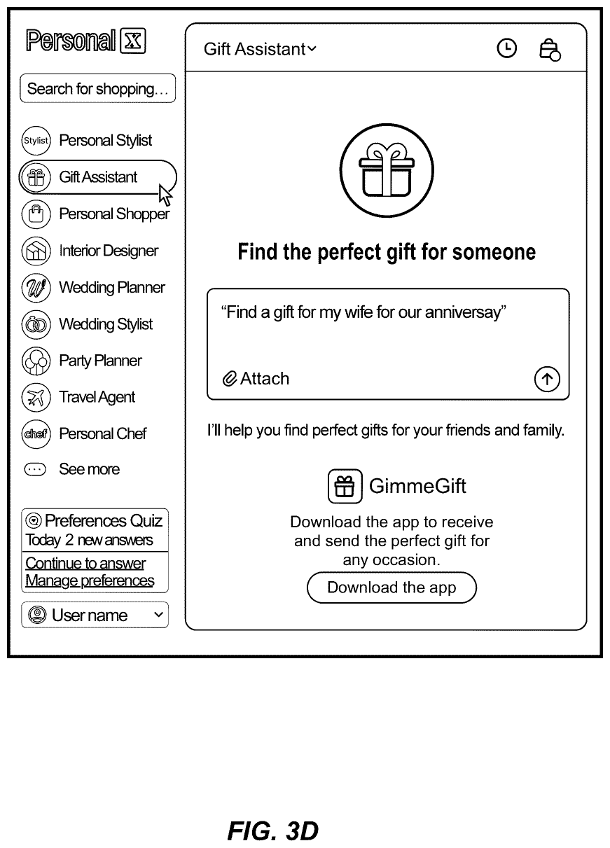

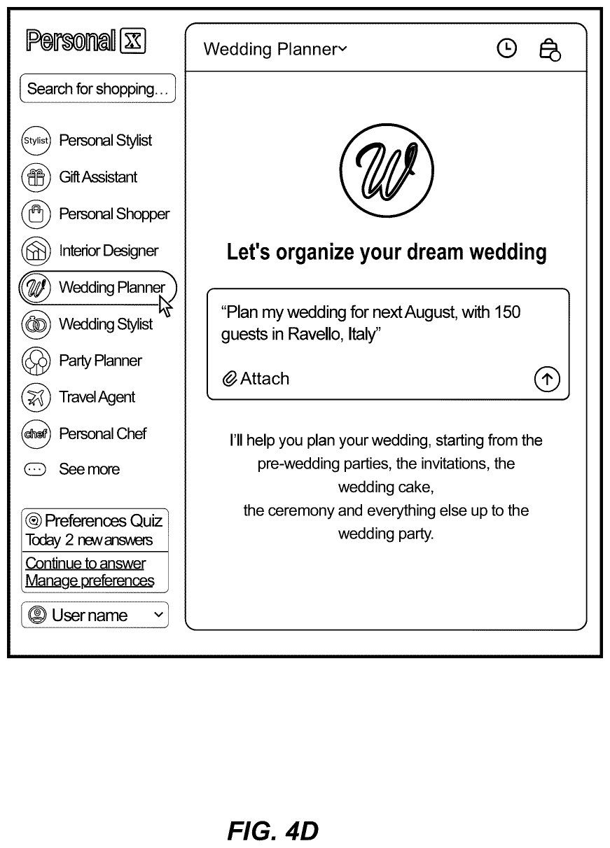

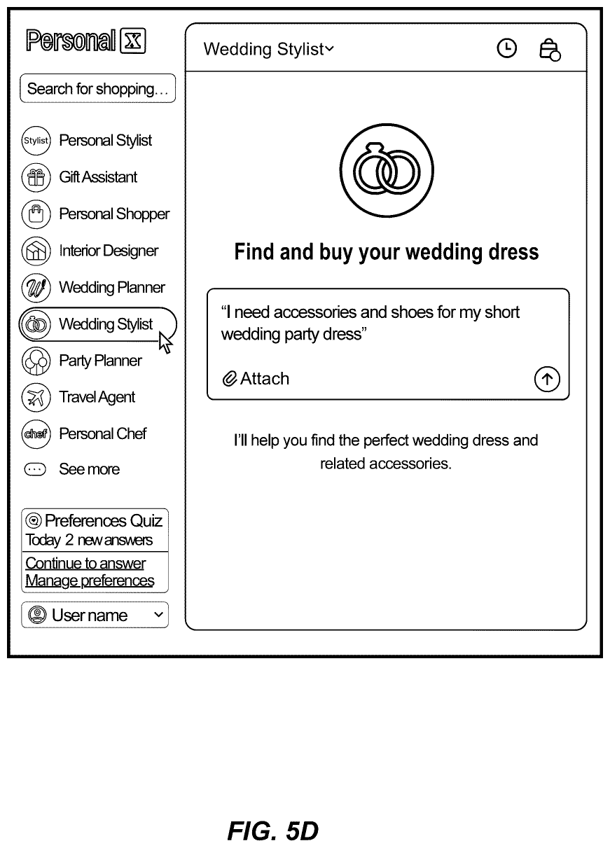

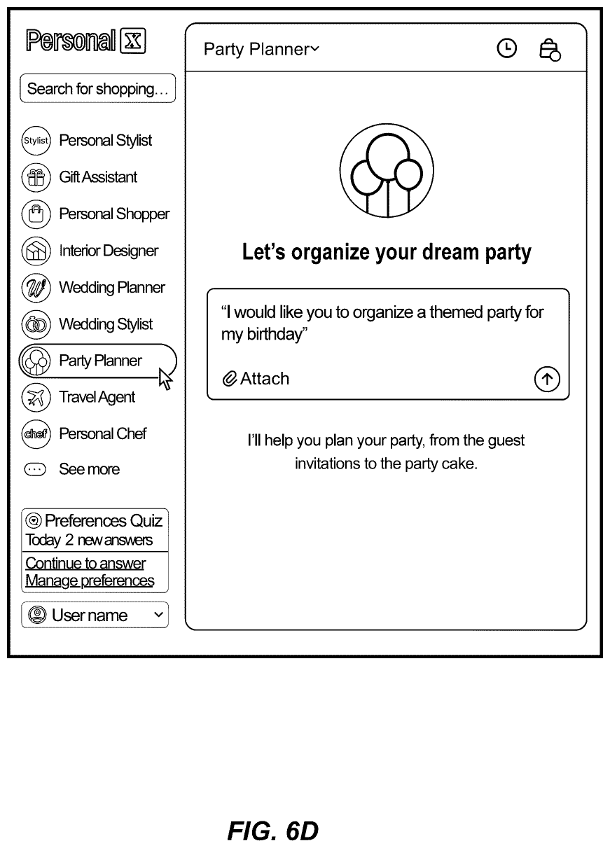

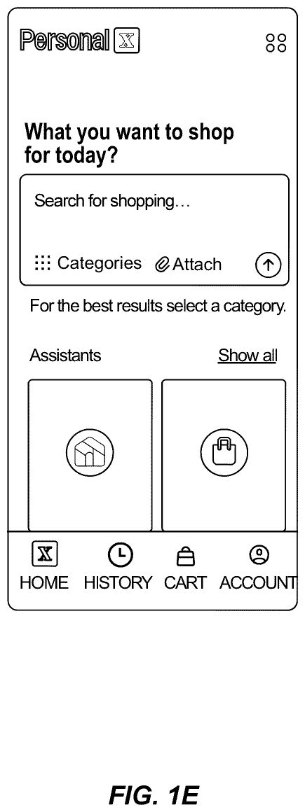

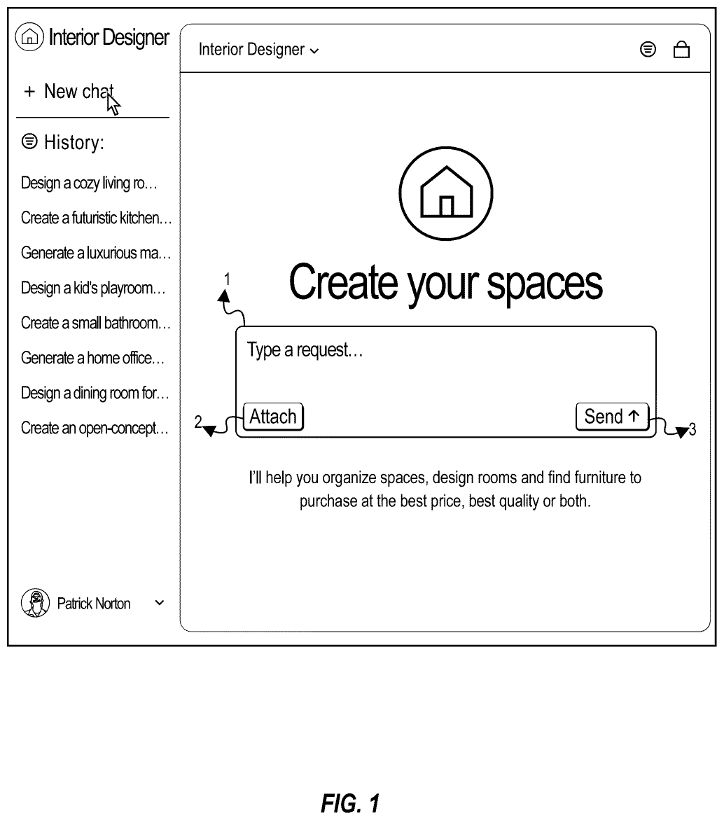

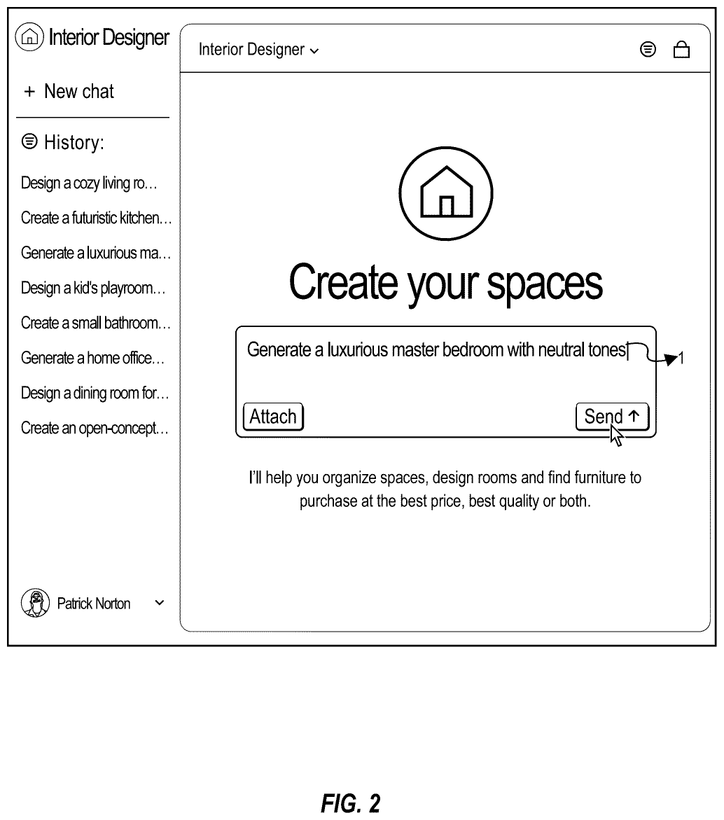

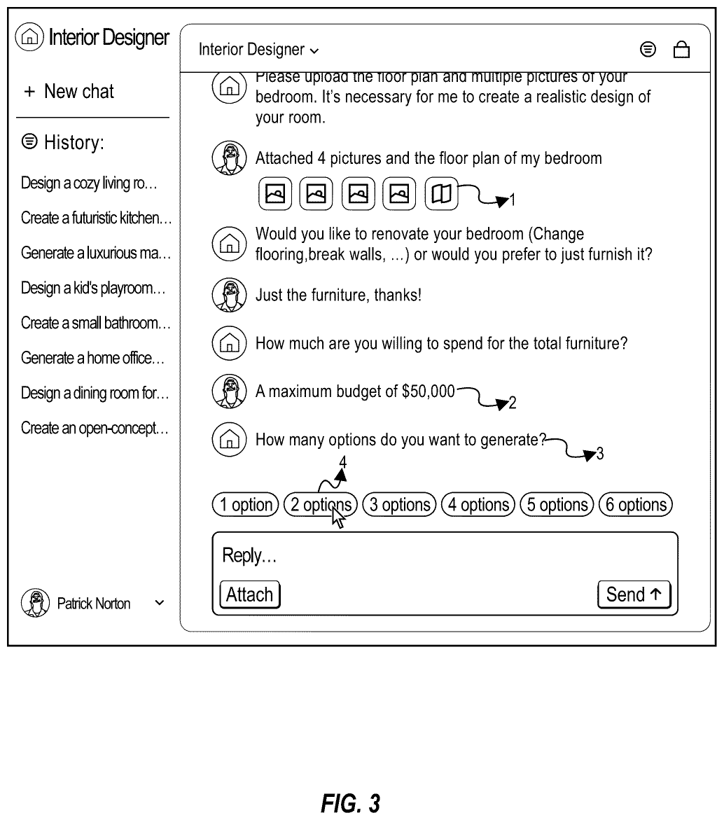

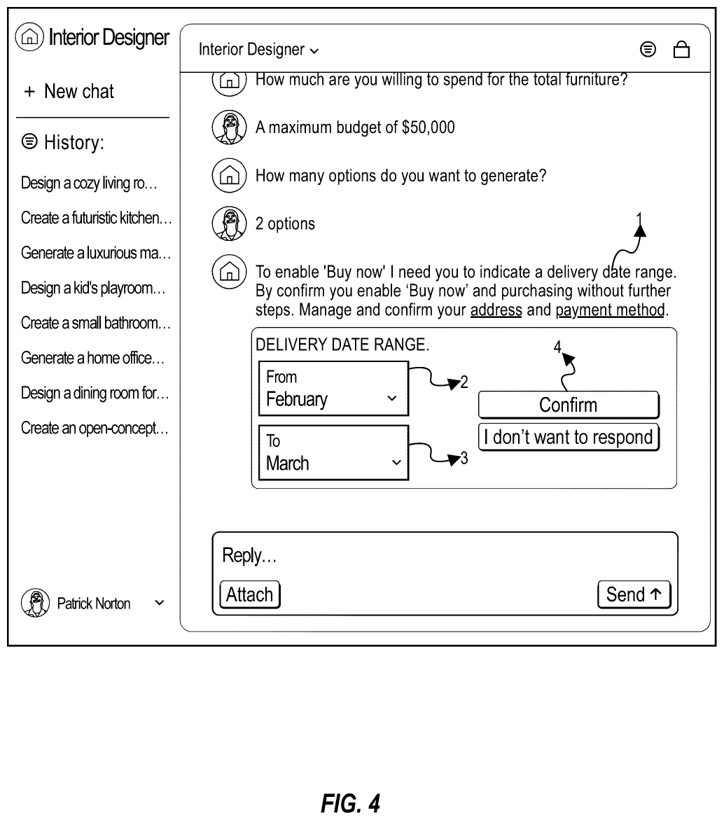

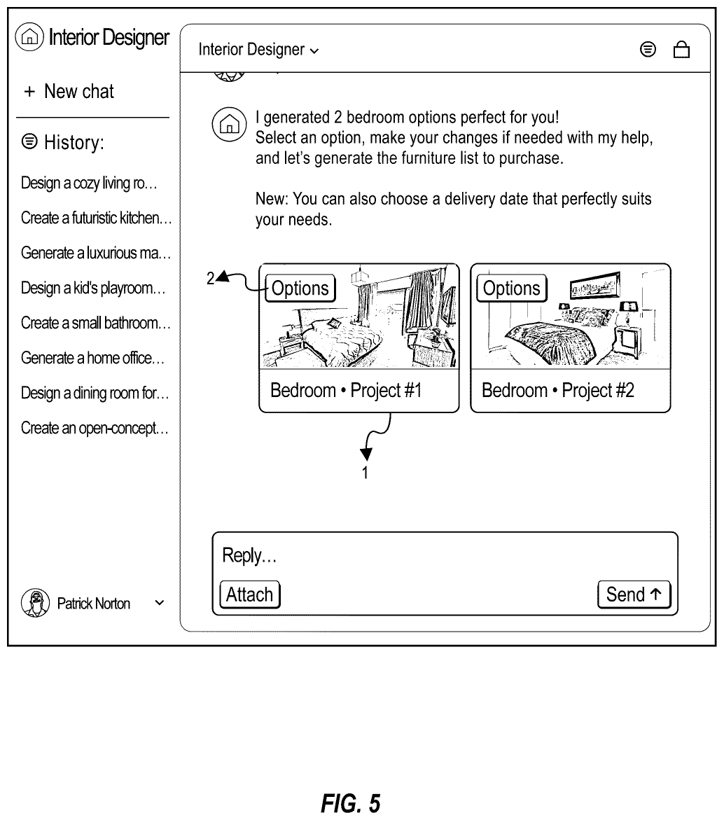

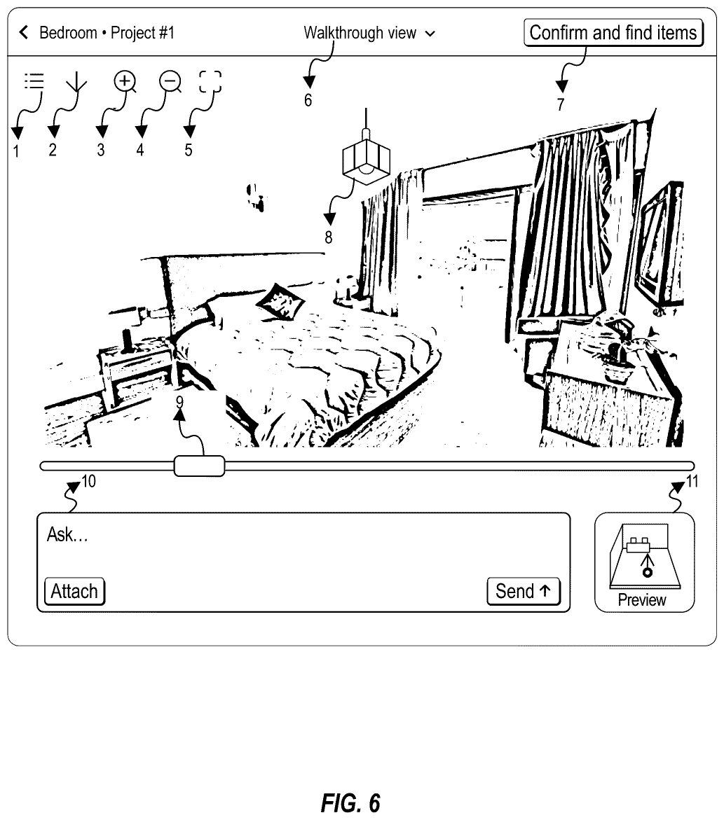

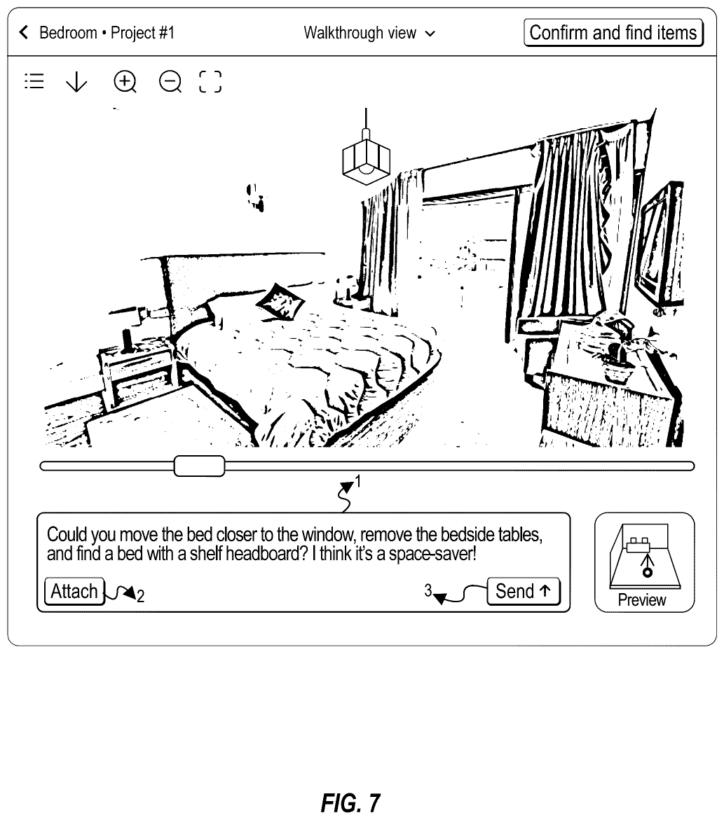

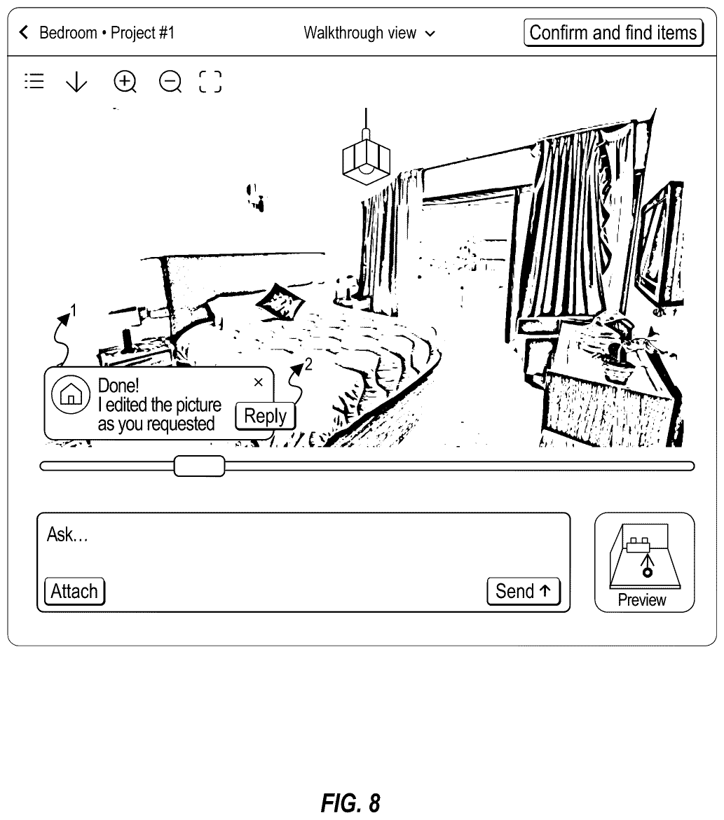

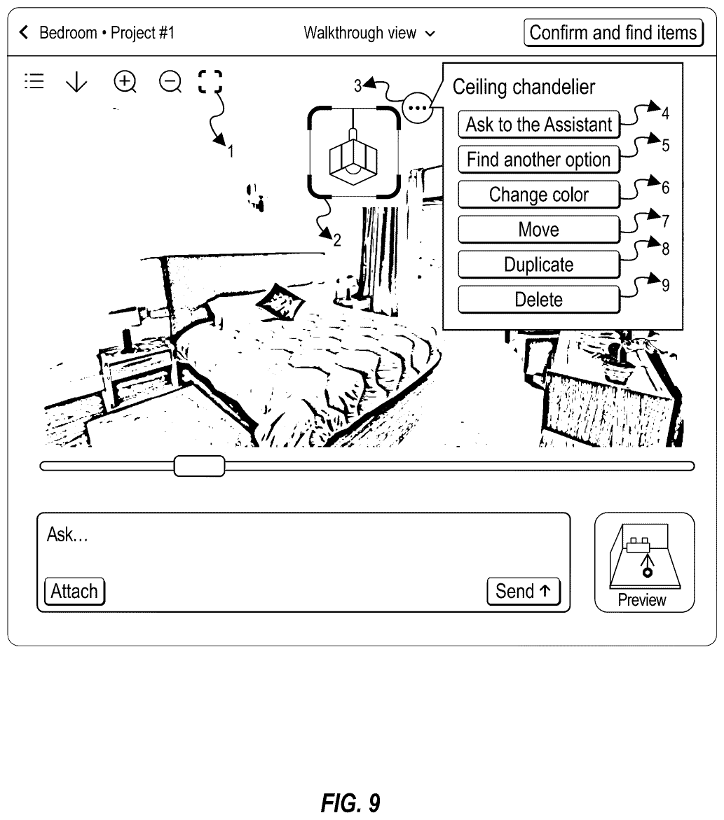

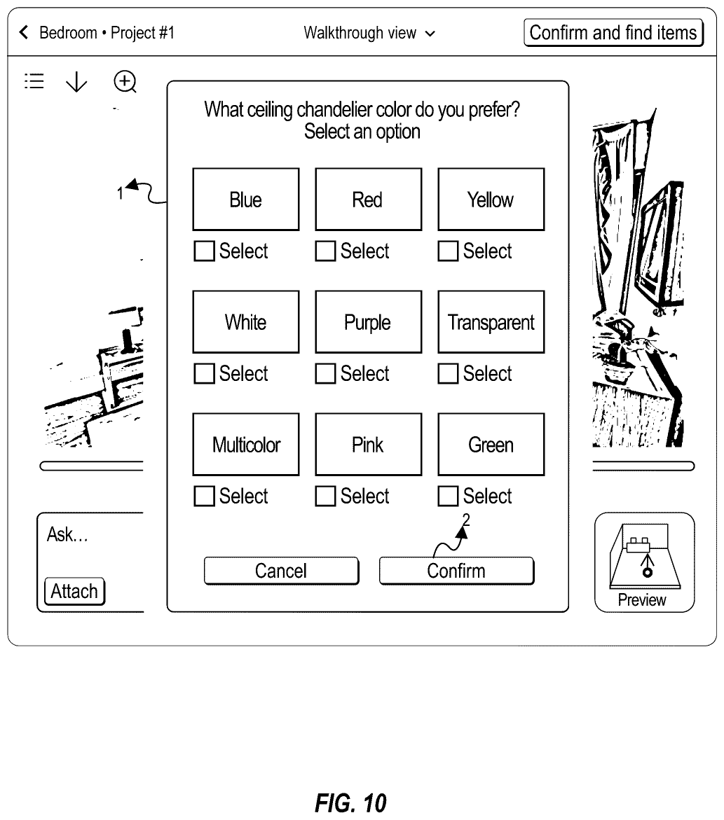

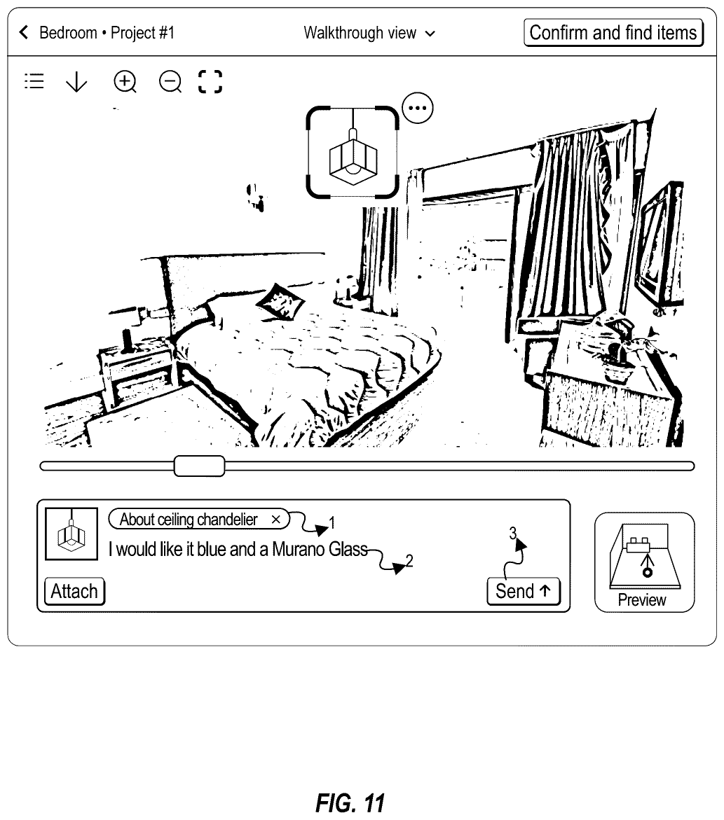

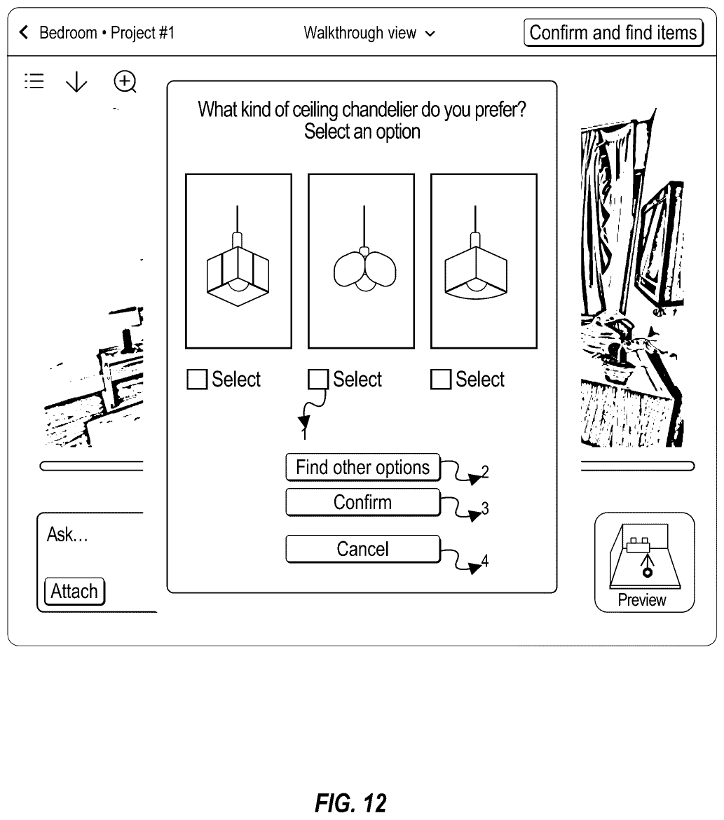

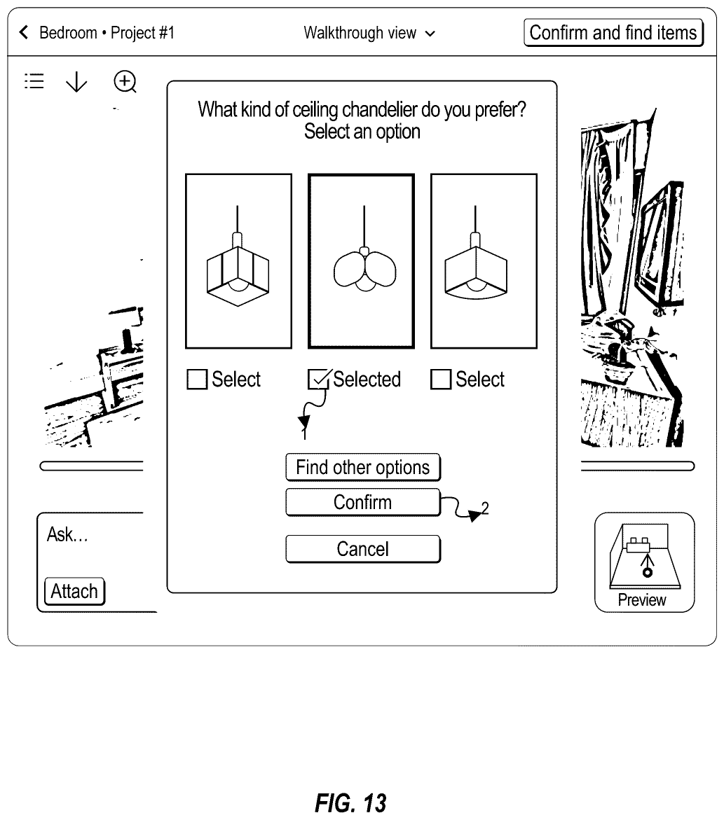

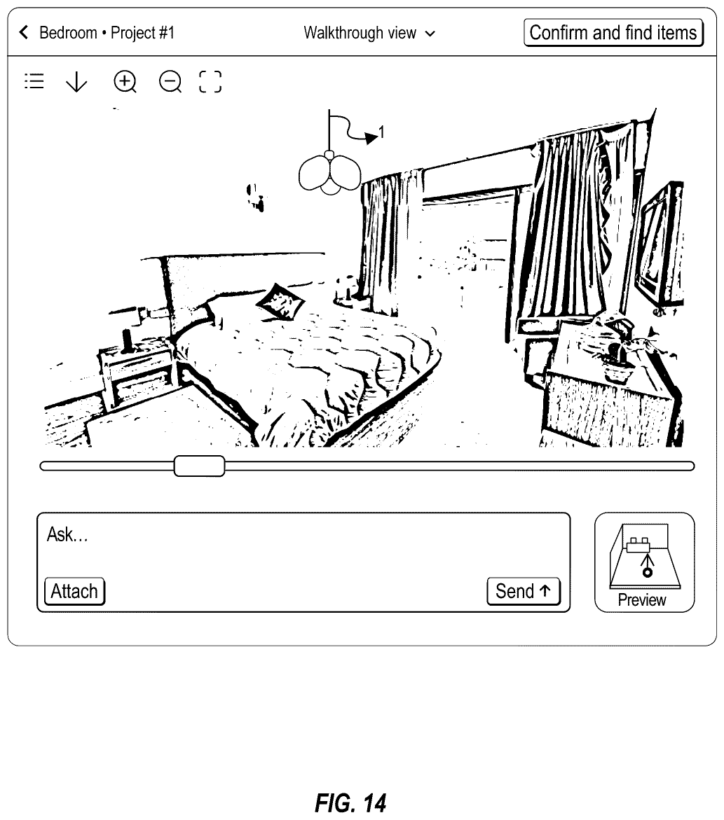

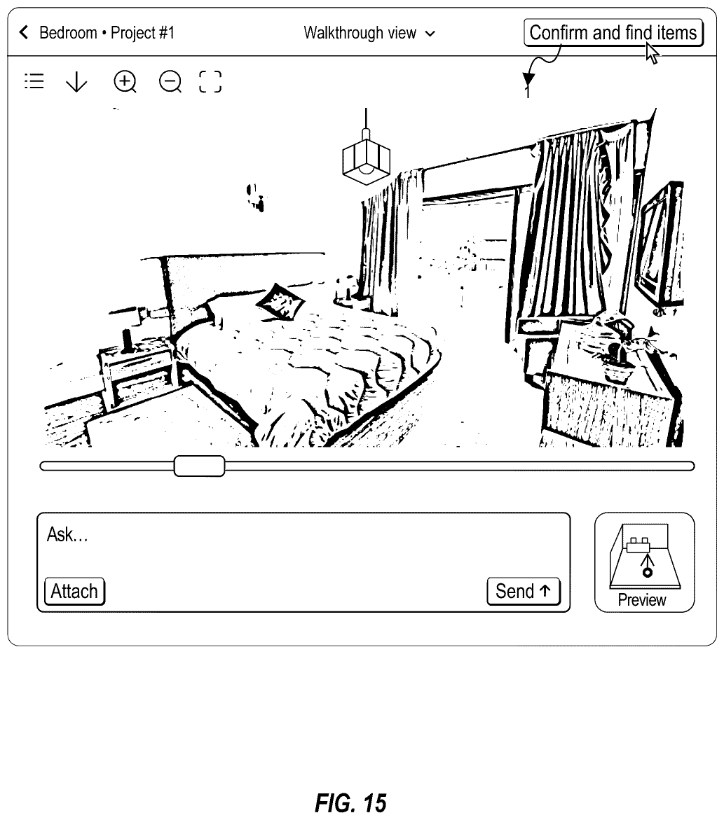

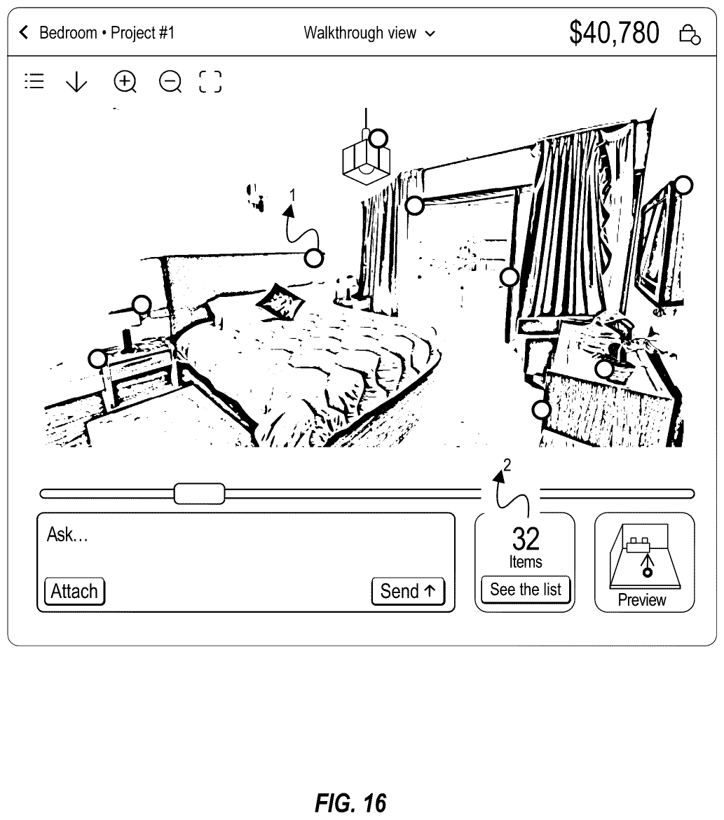

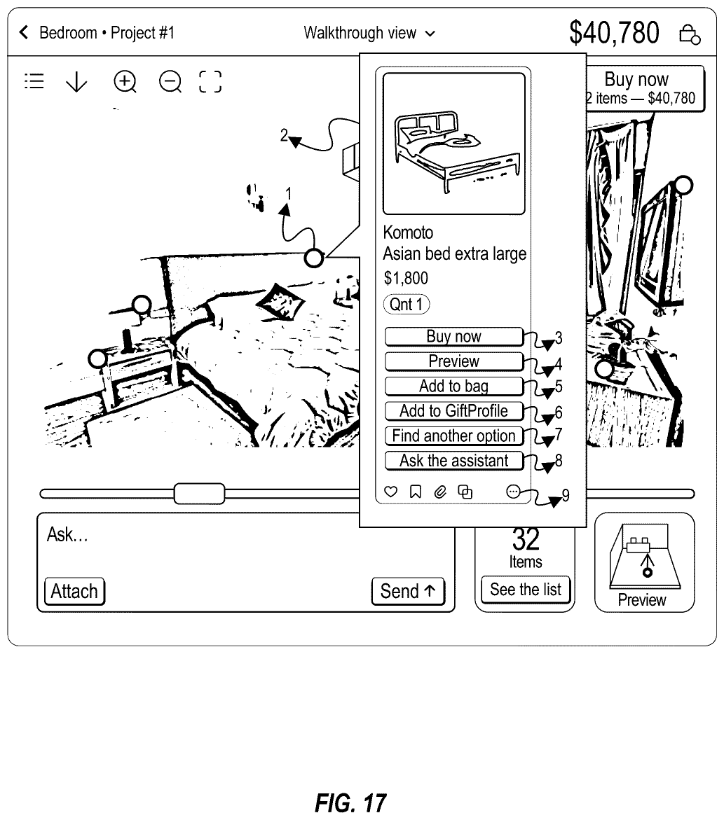

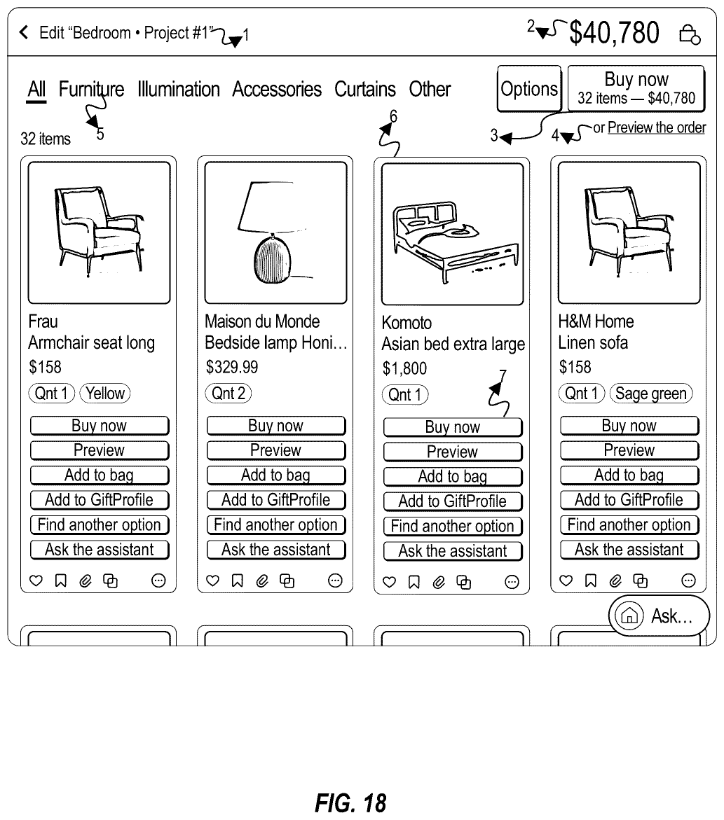

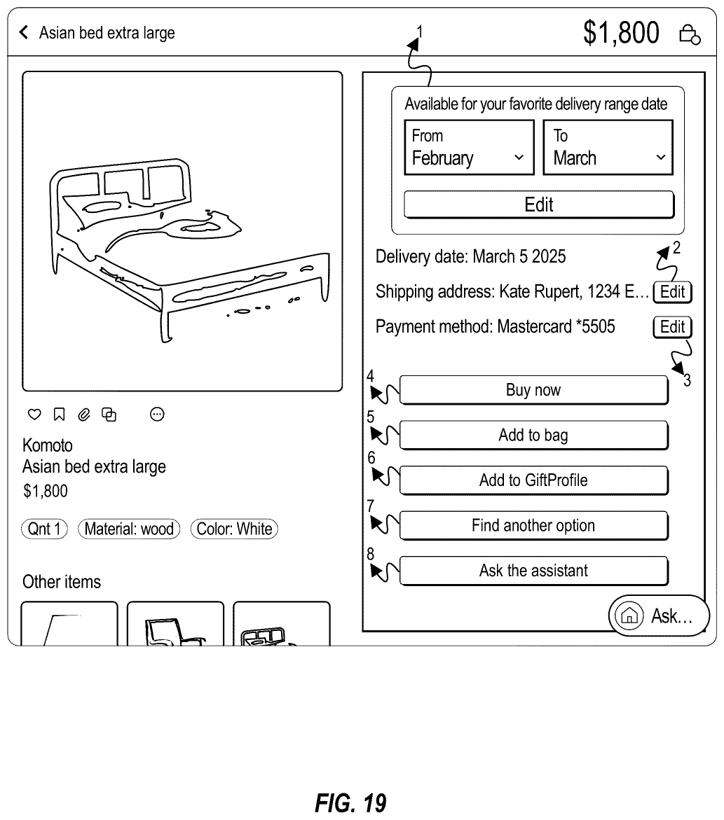

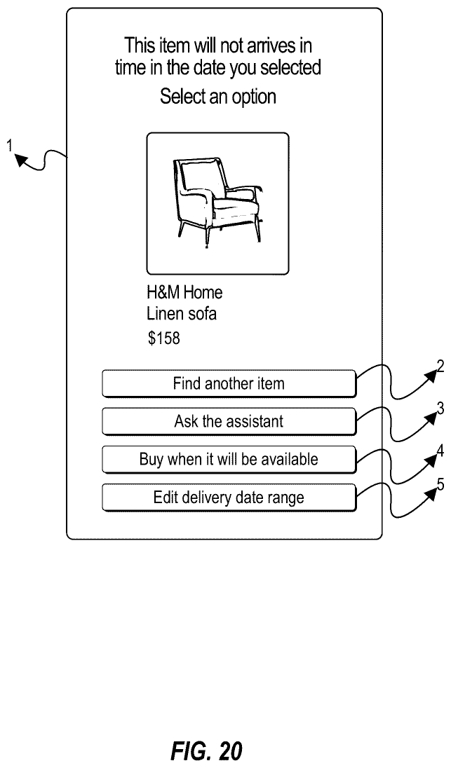

FIGS. 1V-62V illustrate exemplary screen captures of pages directed to an exemplary purchase of a complete outfit using an exemplary personal stylist interactive shopping environment, according to some implementations of the present disclosure.

Outfit with Personal Items

FIGS. 1Z-19Z illustrate exemplary screen captures of pages directed to an exemplary purchase of an outfit with personal items using an exemplary personal stylist interactive shopping environment, according to some implementations of the present disclosure.

Complete Outfit with Prompt

FIGS. 1J-21J illustrate exemplary screen captures of pages directed to an exemplary purchase of a complete outfit generated by a prompt from a user on the home page of an exemplary personal stylist interactive shopping environment, according to some implementations of the present disclosure.

### Searching Options

FIGS. 1Y-3Y illustrate exemplary screen captures of pages directed to various searching options of an exemplary personal stylist interactive shopping environment, according to some implementations of the present disclosure.

### Personal Shopper Description

FIGS. B1-B13 illustrate exemplary screen captures of pages directed to selecting and purchasing a mobile device as part of an exemplary personal shopper interactive shopping environment, according to some implementations of the present disclosure.

### Interior Designer Description Specific Room

FIGS. C1-C115 illustrate exemplary screen captures of pages directed to remodeling a single room as part of an exemplary interior designer interactive shopping environment, according to some implementations of the present disclosure.

### Whole House

FIGS. D1-D118 illustrate exemplary screen captures of pages directed to remodeling a whole house as part of an exemplary interior designer interactive shopping environment, according to some implementations of the present disclosure.

### Wedding Planner—Pre-Wedding Party

FIGS. E1-E43 illustrate exemplary screen captures of pages directed to planning a pre-wedding party as part of an exemplary wedding planner interactive shopping environment, according to some implementations of the present disclosure.

### Wedding Ceremony

FIGS. F1-F78 illustrate exemplary screen captures of pages directed to planning a wedding ceremony as part of an exemplary wedding planner interactive shopping environment, according to some implementations of the present disclosure.

### Wedding Party

FIGS. G1-G40 illustrate exemplary screen captures of pages directed to planning a wedding party as part of an exemplary wedding planner interactive shopping environment, according to some implementations of the present disclosure.

### Wedding Cake

FIGS. H1-H18 illustrate exemplary screen captures of pages directed to planning a wedding cake as part of an exemplary wedding planner interactive shopping environment, according to some implementations of the present disclosure.

### Honeymoon

FIGS. L1-L12 illustrate exemplary screen captures of pages directed to planning a honeymoon as part of an exemplary wedding planner interactive shopping environment, according to some implementations of the present disclosure.

### Wedding Registry

FIGS. M1-M7 illustrate exemplary screen captures of pages directed to planning a wedding registry as part of an exemplary wedding planner interactive shopping environment, according to some implementations of the present disclosure.

### Invitations

FIGS. N1-N20 illustrate exemplary screen captures of pages directed to planning wedding invitations as part of an exemplary wedding planner interactive shopping environment, according to some implementations of the present disclosure.

### Final Steps

FIGS. P1-P18 illustrate exemplary screen captures of pages directed to planning the final steps of a wedding including a summary of all the parts already planned as part of an exemplary wedding planner interactive shopping environment, according to some implementations of the present disclosure.

### Multi-Agent Search System

FIGS. 1A-7A, 1B-3B, 1C-4C, 1D-6D, and 1E illustrate exemplary screen captures of pages of an exemplary multi-agent interactive shopping environment, according to some implementations of the present disclosure.

### Interior Designer

FIGS. 1-20 illustrate exemplary screen captures of pages directed to planning a master bedroom as part of an exemplary interior designer interactive shopping environment, according to some implementations of the present disclosure.

### DETAILED DESCRIPTION

### Customization of Shopping Environment

FIG. 1 illustrates an exemplary implementation of an Interactive Shopping Environment Customization System 100 that includes several components. For example, an Image Data Processing Component 102 is integral to the customization of an interactive shopping environment. The Image Data Processing Component 102 processes image data associated with environmental aspects, including elements such as, for example, a room, a building, or a landscape. The processing of image data gathers visual information that can be used to tailor the interactive shopping environment to the user's preferences. The Image Data Processing Component 102 receives image data, which can be in the form of photographs, videos, or 2D or 3D scans, to capture the environmental aspect accurately. The image data can be utilized to generate a design element, which may be a visual component within the interactive shopping environment. The design element is created using artificial intelligence (AI) or machine learning (ML) algorithms that analyze the image data to produce a representation that aligns with the user's vision. The generated design element is incorporated into a 2D or 3D visual representation, allowing the user to interact with it within the interactive shopping environment. This interaction provides the user with a more immersive and personalized experience.

In an implementation, the Image Data Processing Component 102 works in conjunction with other components, such as a Contextual Information Processing Component 104 and a Design Element Generation Component 106, to ensure that the interactive shopping environment is customized to meet the user's needs. The processing of image data provides the foundation upon which the rest of the customization process is built.

The Contextual Information Processing Component 104 processes contextual information to facilitate the customization of the interactive shopping environment. The Contextual Information Processing Component 104 receives contextual information associated with the interactive shopping environment, which can include user preferences, profiles, histories, or locations. The processing of the contextual information facilitates understanding the context in which the customization is to occur. The Contextual Information Processing Component 104 correlates this information with the design elements generated by other components, ensuring that the customization aligns with the user's specific needs and preferences. The contextual information is used to tailor the interactive shopping environment, allowing for a more personalized and engaging user experience.

The Contextual Information Processing Component 104 can work in conjunction with other components to ensure that the interactive shopping environment is updated and refined based on user feedback, ultimately leading to a more effective and user-friendly system. The processing of contextual information can also involve the use of AI and ML algorithms to analyze and interpret the data, providing insights that may enhance the customization process. The Contextual Information Processing Component 104 thus plays a role in the overall functionality and effectiveness of the interactive shopping environment, ensuring that it meets the user's expectations and requirements.

In an implementation, the Design Element Generation Component 106 is responsible for generating design elements using AI and ML algorithms. The Design Element Generation Component 106 utilizes the received image data and contextual information to create visual components that are integral to the interactive shopping environment. The design elements are generated to align with the user's preferences and the environmental aspects captured in the image data. The process can involve analyzing the visual information and contextual data to produce a design element that can be represented in either 2D or 3D visual form. This representation allows users to interact with the design element within the shopping environment, enhancing the customization experience. The generation of design elements is a step in creating a personalized and engaging shopping environment, as it directly influences the visual appeal and functionality of the interactive space. The Design Element Generation Component 106 can work in conjunction with other components to ensure that the design elements are seamlessly integrated into the overall shopping environment, providing a cohesive and user-friendly experience.

The Interactive Environment Generation Component 108 can generate 2D or 3D visual representations for user interaction within the interactive shopping environment. The Interactive Environment Generation Component 108 utilizes the design element generated by the Design Element Generation Component 106, which is based on the received image data and contextual information. The 2D or 3D visual representation allows users to interact with the design element, providing a visual and interactive experience. The generation of these representations involves the use of advanced rendering techniques to ensure that the visual components are accurately depicted within the virtual or augmented reality environment. The Interactive Environment Generation Component 108 also ensures that the representations are adaptable to various user inputs and preferences, allowing for a personalized shopping experience.

The Interactive Environment Generation Component 108 can work in conjunction with other components, such as the User Feedback Processing Component 110, to refine the representations based on user feedback. This feedback may be used to update the interactive shopping environment, ensuring that the 2D or 3D visual representations remain relevant and engaging for the user. The Interactive Environment Generation Component 108 also facilitates the conversion of these representations into user-selectable elements, aiding in the purchasing process. By integrating these functionalities, the Interactive Environment Generation Component 108 enhances the overall user experience within the interactive shopping environment, providing a seamless and intuitive platform for users to explore and interact with design elements.

The User Feedback Processing Component 110 processes user feedback to refine the interactive shopping environment. This component receives user feedback, which can include user ratings, comments, or interactions with the 2D or 3D visual representation. The feedback is analyzed to understand user preferences and areas for improvement. The User Feedback Processing Component 110 correlates this feedback with the design elements and visual representations generated by other components, such as the Design Element Generation Component 106 and the Interactive Environment Generation Component 108. By processing this feedback, the User Feedback Processing Component 110 facilitates the updating of the interactive shopping environment, ensuring that it aligns more closely with user expectations and preferences. The processed feedback is used by the Environment Update Component 112 to modify aspects of the environment, such as color, texture, size, or shape of the design elements. This iterative feedback process enhances the user experience by continuously adapting the environment based on user input. The User Feedback Processing Component 110 plays a role in maintaining the dynamic and responsive nature of the interactive shopping environment, ultimately aiding in the creation of a more personalized and engaging user experience.

The Environment Update Component 112 serves a role in the interactive shopping environment by updating the environment based on user feedback. This component is responsible for incorporating user feedback to refine the interactive shopping environment, ensuring that the environment aligns with user preferences and expectations. The interactive shopping environment can be updated by modifying elements such as color, texture, size, or shape of the design element, which enhance the user's experience and satisfaction. The Environment Update Component 112 can work in conjunction with other components, such as the User Feedback Processing Component 110, to receive and process user feedback effectively. This feedback can be used to generate a revised interactive shopping environment, which can include a revised 2D or 3D visual representation of the design element. The updated environment can provide a more personalized and engaging experience for the user, potentially leading to increased user interaction and satisfaction. The Environment Update Component 112 also facilitates the seamless integration of new design elements and representations, ensuring that the interactive shopping environment remains dynamic and responsive to user input. By continuously updating the environment based on user feedback, the Environment Update Component 112 can contribute to the overall effectiveness and appeal of the interactive shopping environment.

The Selectable Element Conversion Component 114 facilitates the transformation of 2D or 3D visual representations into user-selectable elements, which can aid in purchasing decisions. The Selectable Element Conversion Component 114 is responsible for converting the visual representations generated within the interactive shopping environment into elements that users can select to initiate a purchase process. The conversion process involves generating hyperlinks or buttons associated with the items depicted in the representations, thereby enabling users to seamlessly transition from viewing to purchasing. The Selectable Element Conversion Component 114 also ensures that the selectable elements are integrated into the interactive shopping environment in a manner that aligns with user feedback and preferences, as processed by the User Feedback Processing Component 110. This integration may be achieved by updating the environment to reflect the revised representations, which have been refined based on user interactions and feedback. The Selectable Element Conversion Component 114 may work in conjunction with other components, such as the Item Segmentation and Search Component 116, to ensure that the items represented are accurately identified and linked to purchasable options. By doing so, the Selectable Element Conversion Component 114 enhances the overall user experience by providing a streamlined and intuitive pathway from interaction to purchase within the interactive shopping environment.

The Item Segmentation and Search Component 116 is responsible for segmenting specific items within the interactive shopping environment. The Item Segmentation and Search Component 116 utilizes a recommended system and a database to perform a reverse image search. The segmentation of specific items is achieved by analyzing the visual data to identify distinct elements that can be individually recognized. The reverse image search is then conducted to match these segmented items with entries in a database, potentially identifying purchasable items. The recommended system assists in refining the search results by suggesting items that align with user preferences or previous interactions. This process involves the integration of ML algorithms to enhance the accuracy and relevance of the search outcomes. The actions associated with the Item Segmentation and Search Component 116 include segmenting specific items and performing a reverse image search, which can correlate with the actions of receiving image data and contextual information, generating design elements, and updating the interactive shopping environment. The Item Segmentation and Search Component 116 works in conjunction with other components to ensure that the interactive shopping environment is continuously refined and updated based on user feedback and preferences. The ultimate goal of the Item Segmentation and Search Component 116 is to facilitate a seamless and personalized shopping experience by enabling users to easily identify and purchase items of interest within the interactive environment.

FIG. 2 is a flowchart illustrating an exemplary method 199 of customizing an interactive shopping environment for a user. At step 200 image data associated with an environmental aspect is received, according to an implementation. The received image data can include various forms such as photographs, videos, or 2D or 3D scans. The image data can be associated with an environmental aspect, which can encompass a range of elements such as a room, building, landscape, calendar, or vehicle. The purpose of receiving the image data is to gather visual information that can be used for customization within the interactive shopping environment. The environmental aspect provides context for tailoring the shopping experience to the user's surroundings or preferences. The image data, once received, serves as a foundational element in generating a design element that aligns with the user's environment. This process can involve the use of AI or ML algorithms to analyze the image data and extract relevant features that can be incorporated into the design element. The design element can then be used to create a 2D or 3D visual representation within the interactive shopping environment, allowing the user to interact with the design in a meaningful way. This interaction may be facilitated by the virtual or augmented reality capabilities of the shopping environment, providing an immersive experience for the user. The image data and environmental aspect, therefore, play a role in the initial stages of customizing the interactive shopping environment, setting the stage for subsequent steps that involve user feedback and further refinement of the design.

At step 202, contextual information associated with the interactive shopping environment is received. This step involves gathering data that provides insight into the user's preferences, profile, history, or location, which can be for tailoring the shopping experience. The contextual information serves as a foundation for understanding the user's needs and expectations within the interactive shopping environment. This information is used to customize the environment, ensuring that the design elements and interactions align with the user's specific context. The process can involve analyzing various aspects of the user's interaction history and preferences to create a more personalized and engaging shopping experience. The contextual information can be integrated with other data inputs to generate a cohesive and interactive environment that resonates with the user. This step is pivotal in setting the stage for subsequent actions, such as generating design elements and updating the shopping environment based on user feedback. The receipt of contextual information is facilitated by advanced algorithms and data processing techniques, which enable the system to adapt to the user's unique context dynamically.

At step 204, the method 199 generates a design element based at least in part on the received image data and contextual information. This step is in creating a visual component that aligns with the user's preferences and the environmental context. The design element is generated using advanced technologies such as AI or ML algorithms, which can analyze the input data to produce a design that is both relevant and personalized. The use of these technologies allows for the design element to be tailored to the specific needs and desires of the user, enhancing the overall interactive shopping experience. The design element serves as a foundational component in the interactive shopping environment, potentially influencing the user's engagement and satisfaction. The generation of the design element may be a dynamic process, adapting to changes in user input or environmental factors to maintain relevance and appeal.

At step 206, the method 199 generates the interactive shopping environment including a 2D or 3D visual representation of the design element. This representation is integral to the interactive shopping environment, allowing users to engage with the design element in a virtual space. The interactive shopping environment is realized through either a virtual reality environment or an augmented reality environment, providing users with an immersive experience. The generation of the 2D or 3D visual representation is facilitated by the integration of image data and contextual information, which can be processed to create a design element that aligns with user preferences and environmental aspects. The design element can then be rendered in a format that supports user interaction, potentially enhancing the customization and personalization of the shopping experience. The interactive shopping environment can serve as a platform for users to explore and interact with the design element, which may be for refining the shopping environment based on user feedback and preferences.

In an implementation, at step 208, user feedback associated with the 2D or 3D visual representation is received. This feedback can potentially include a user rating, a user comment, or a user interaction with the 2D or 3D visual representation. The process of receiving user feedback serves to refine and improve the interactive shopping environment. The feedback is utilized to assess the user's experience and satisfaction with the design element's representation. This step involves collecting data on how users interact with the design element, which can include their preferences, comments, and ratings. The feedback can then be analyzed to identify areas for enhancement or modification within the interactive shopping environment. This process can be for ensuring that the environment aligns with user expectations and preferences, thereby enhancing the overall user experience. The integration of user feedback into the system allows for a dynamic and responsive shopping environment that can adapt to user needs and preferences over time.

In an implementation, at step 210 the method 199 updates the interactive shopping environment based at least in part on the received user feedback to enhance the overall experience. This step may include modifying various attributes of the design element, such as color, texture, size, or shape, to better align with user preferences and feedback. The interactive shopping environment may be dynamically adjusted to reflect these changes, potentially improving user satisfaction and engagement. The system may utilize advanced algorithms to analyze the feedback and determine the most effective modifications to implement. This approach may ensure that the interactive shopping environment remains relevant and appealing to the user, ultimately facilitating a more personalized and enjoyable shopping experience.

At step 212, in an implementation, the conversion of the 2D or 3D representation into a user-selectable element is initiated. This conversion process involves generating a hyperlink or a button associated with the item, which can be selected by the user. The user-selectable element can serve as an interactive feature within the shopping environment, potentially aiding the user in making purchasing decisions. The conversion can be facilitated by the system's ability to transform the visual representation into an actionable element, allowing for seamless integration into the user's shopping experience. The user-selectable element may be designed to enhance user engagement by providing a direct link to further information or purchasing options for the item represented. This step may be in bridging the gap between visual representation and user interaction, ultimately supporting the user's journey from exploration to purchase within the interactive shopping environment.

At step 214, the process directs the user to a purchase page for the item upon the user's selection of the user-selectable element. This step is in facilitating the transition from browsing to purchasing within the interactive shopping environment. The user-selectable element, which may have been generated from a 2D or 3D visual representation of a design element, can serve as a link or button that, when selected, guides the user to a dedicated purchase page. This purchase page may provide detailed information about the item, including pricing, specifications, and purchasing options, thereby aiding the user in making an informed purchasing decision. The integration of this step within the interactive shopping environment may enhance the user's shopping experience by streamlining the process of item selection and purchase. The method 199 can utilize various technologies, such as hyperlinks or buttons, to ensure that the transition to the purchase page is seamless and intuitive for the user. This step can also involve the use of ML algorithms to personalize the purchase page based on the user's preferences and previous interactions within the shopping environment. By directing the user to a purchase page, the method effectively bridges the gap between virtual interaction and purchasing, thereby enhancing the overall functionality and user experience of the interactive shopping environment.

In other implementations, the method 199 presents items for purchase without receiving feedback from the user. In such implementations the method executes without steps 208 and 210. Further, in such implementations, the step 206 of generating the interactive shopping environment is executed concurrently with step 212 such that the generated design element presented to the user is a user selectable element.

### Personal Stylist

### Login/Register

Referring to FIG. 1A, the user entered his phone number, and clicks on the continue button to continue. The user decides on a fast registration process, continuing with the Google button. The user decides on a fast registration process, continuing with the Facebook button. The user decides on a fast registration process, continuing with the Apple button. The user clicks on Log in because already has an account.

Referring to FIG. 2A, clicking on “Login” the user accesses the login process and enters his email (or phone number). The user clicks on the button to continue. The user decides on a fast login process, continuing with the Google button. The user decides on a fast login process, continuing with the Facebook button. The user decides on a fast login process, continuing with the Apple button. The user clicks on Register because he doesn't have an account yet.

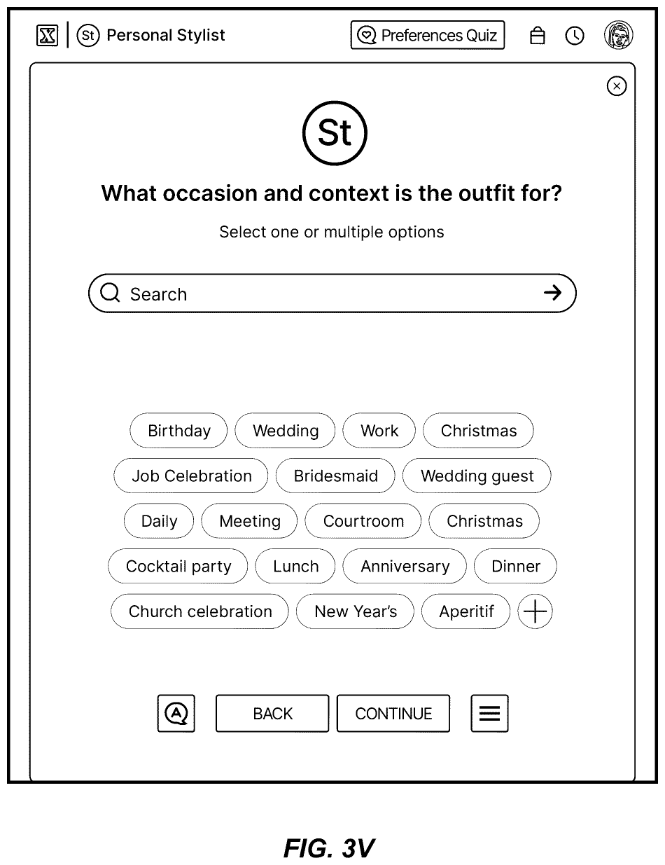

Referring to FIG. 3A, the user on the registration flow (Clicking on ‘Continue’ in the FIG. 1A) will access the page to enter an OTP code, received via email or via text message on the chosen phone number. Same page if the user is in a Login process. Receiving an OTP code is the only password he can have, and to access or register he needs that unique number to enter. The OTP code never arrived, and when the countdown ends it will be possible to ask for a new code (duration approximately 1 minute or 2 minutes to enable the button to send a new request) by clicking on ‘Send to new OTP code’. The user returns back (Registration page or login page). The user clicks on ‘Continue’ to access the next page. If the user is in the Login process, entering the received OTP code he will be redirected to the homepage and in the nav bar will appear the picture of the user account.

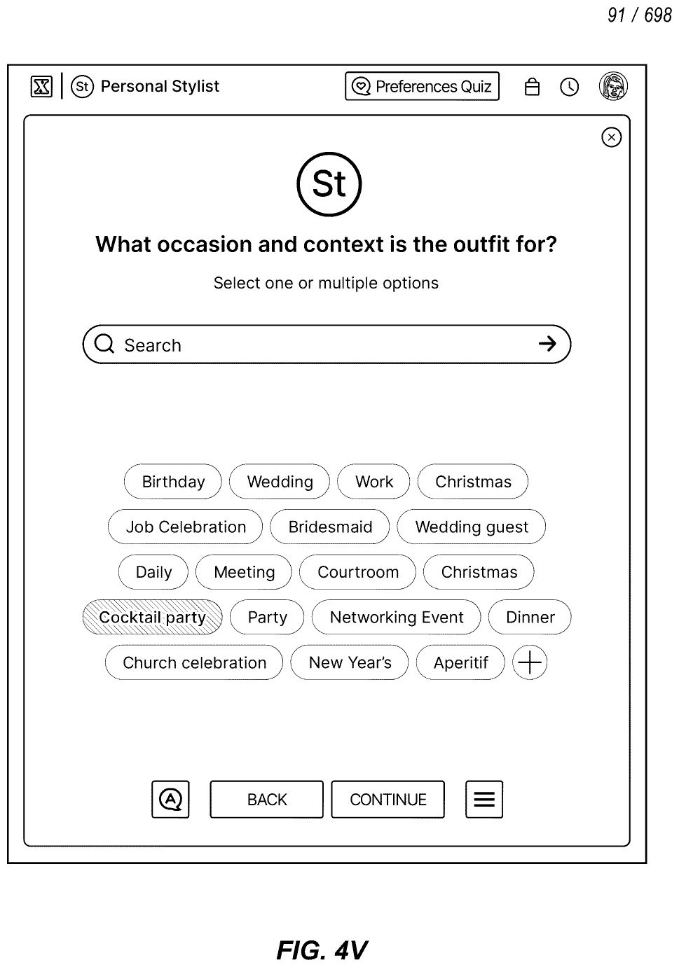

Referring to FIG. 4A, the user accesses the page to create a new account, to enter his name and his surname. The user clicks on ‘Continue’ to access the next page. The user clicks on the ‘Back’ button. The Personal Stylist shows the progress bar, currently empty because nothing is already completed.

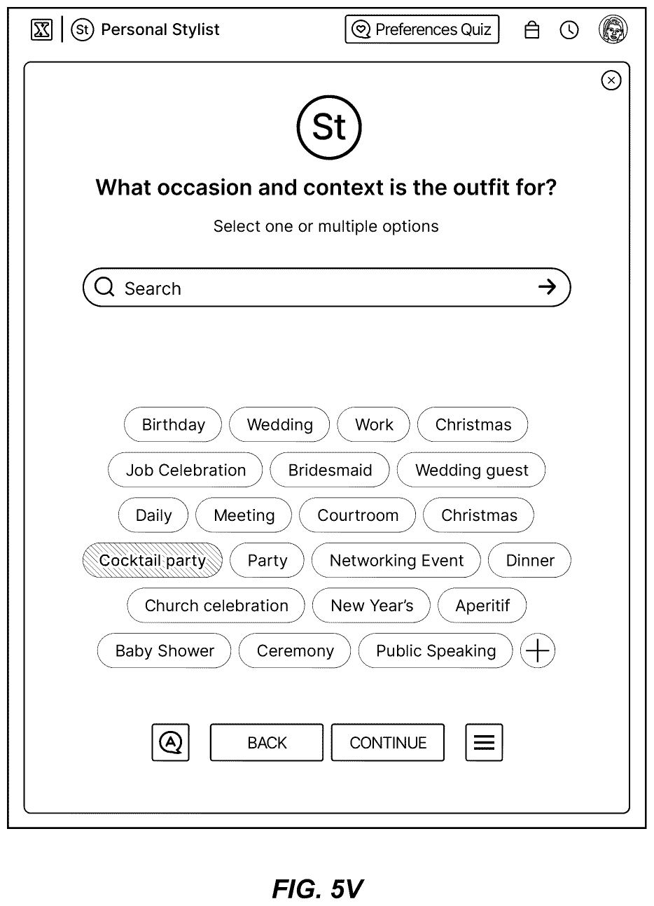

Referring to FIG. 5A, the user accesses the page to enter his email. The Personal Stylist will ask to enable or disable the option “Subscribe to our newsletter and stay updated” to allow PersonalX to send the newsletter. The user clicks on ‘Continue’ to access the next page.

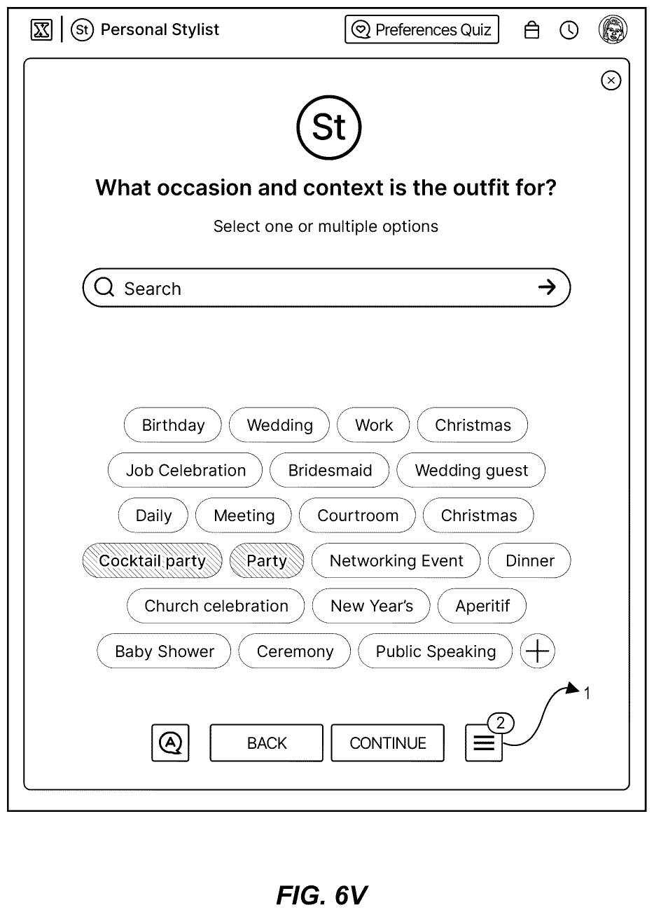

Referring to FIG. 6A, the user accesses the page to enter his age. The user clicks on ‘Continue’ to access the next page.

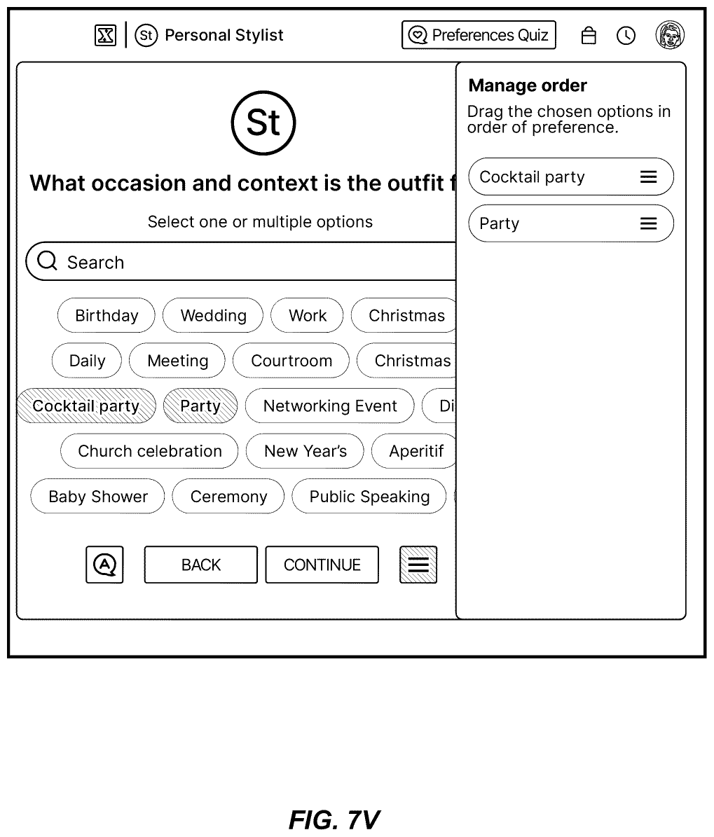

Referring to FIG. 7A, the user accesses the page to select his gender. The user selects the gender ‘Female’ and the Personal Stylist will be able to address the user as feminine. The Personal Stylist will suggest clothes and accessories for females, sizes for females, styles for females, recommendations for females and other similar. The user clicks on ‘Continue’ to access the next page.

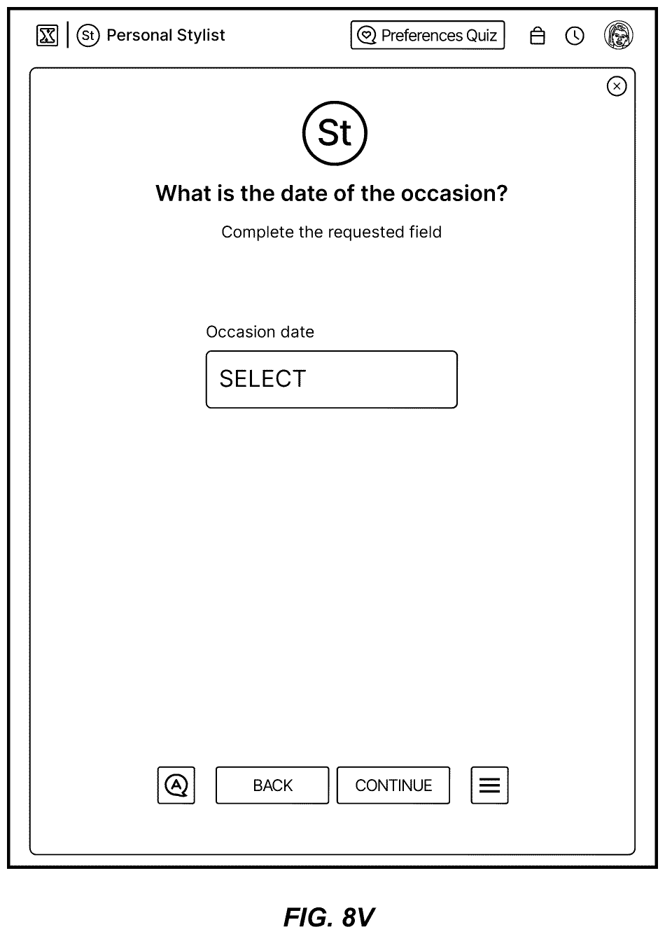

Referring to FIG. 8A, the user accesses the page to scan and upload her face picture. The user clicks on ‘Scan’ to scan her face (or upload the face picture). The user clicks on ‘Skip’ to access the next page avoiding the request. It will be used in that case a generic face picture for the avatar.

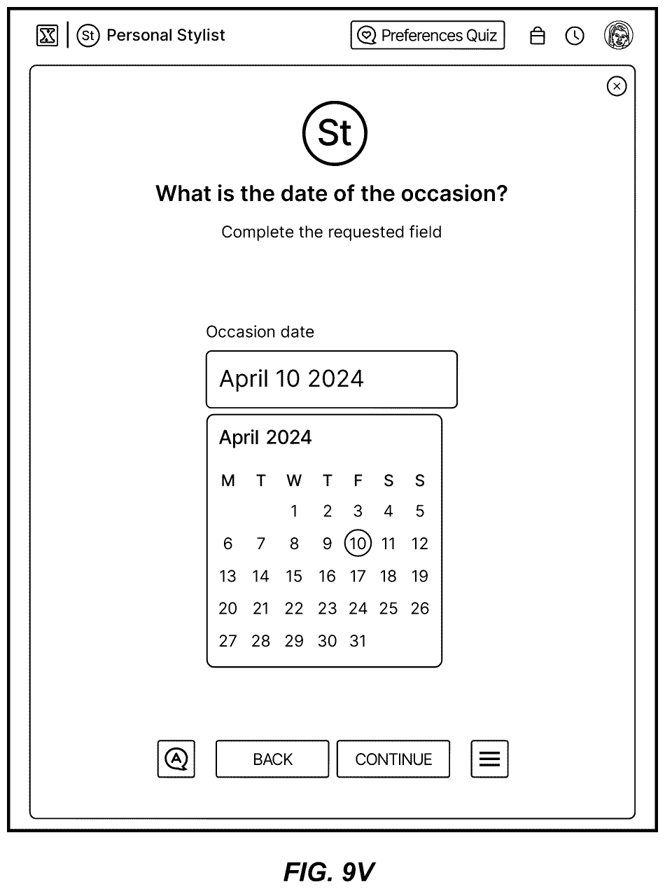

Referring to FIG. 9A, the user scanned and uploaded her face. The Personal Stylist will be able to suggest outfits and items based on face colors (Armochromie). The Personal Stylist will use the face picture to create a Personal Avatar that will virtually wear the outfits or single items. The user clicks the button ‘Continue’ to proceed with the next step. The user clicks the button ‘Delete pic’ to delete the uploaded picture and upload it again. The user clicks on ‘Skip’ to access the next page avoiding the request.

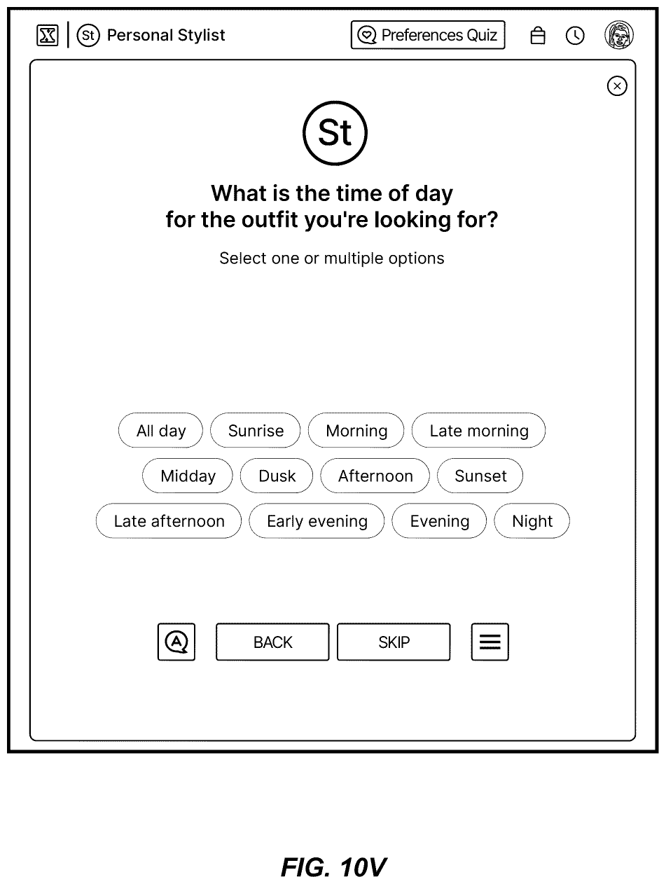

Referring to FIG. 10A, the user accesses the page to scan and upload her body picture. The user clicks on ‘Scan’ to scan her face (or upload the body picture). The user clicks on ‘Skip’ to access the next page avoiding the request. It will be used in that case a generic body picture for the avatar.

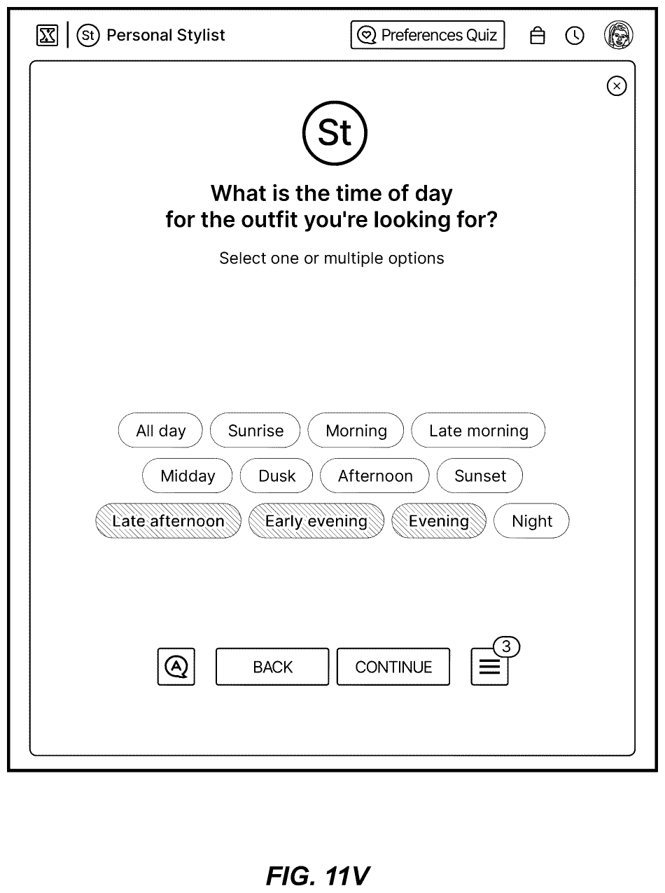

Referring to FIG. 11A, the user scanned and uploaded her body. The Personal Stylist will be able to suggest outfits and items based on body measurements and body shape. The Personal Stylist will use the body picture to create a Personal Avatar that will virtually wear the outfits or single items. The user clicks the button ‘Continue’ to proceed with the next step. The user clicks the button ‘Delete pic’ to delete the uploaded picture and upload it again. The user clicks on ‘Skip’ to access the next page avoiding the request.

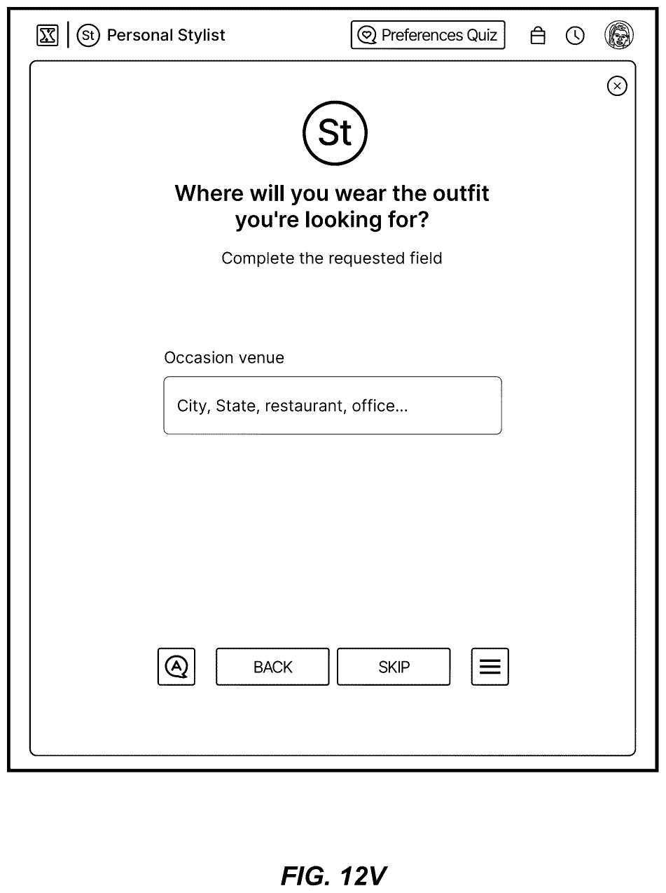

Referring to FIG. 12A, the user completed the account creation and clicks on the button ‘Start Preferences Quiz’ to access a questionnaire about her preferences. The user clicks the button ‘Skip’ to skip and access the homepage. The user can access the preferences Quiz when she wants by clicking on the button on the Nav bar.

Referring to FIG. 13A, the user accesses the Preferences Quiz. It appears the Personal Stylist picture (logo), the question “What is your job?” The textual element that explains the user the action to do. It could be ‘Select one or multiple options’ or ‘Select only one option’ or ‘Upload a picture/item/outfit’ or ‘Complete all requested fields’. The search bar to search an option or to type the prompt to directly ask what the user want like ‘I need an outfit for a birthday party in August in Milan, they asked for a total white dress code). The user clicks that button to close the process and return to the homepage. An available option to select (Unselected option). The possibility to extend the row of options, showing a new row of options. The user opens the tab ‘Answered Questions’ to see the total list of all answered questions in that specific process. The user clicks the button ‘Back’ to return back. The user clicks the button ‘Skip’ to skip the question. The user opens the tab ‘Manage order’ to manage all selected options for that question in preferences order.

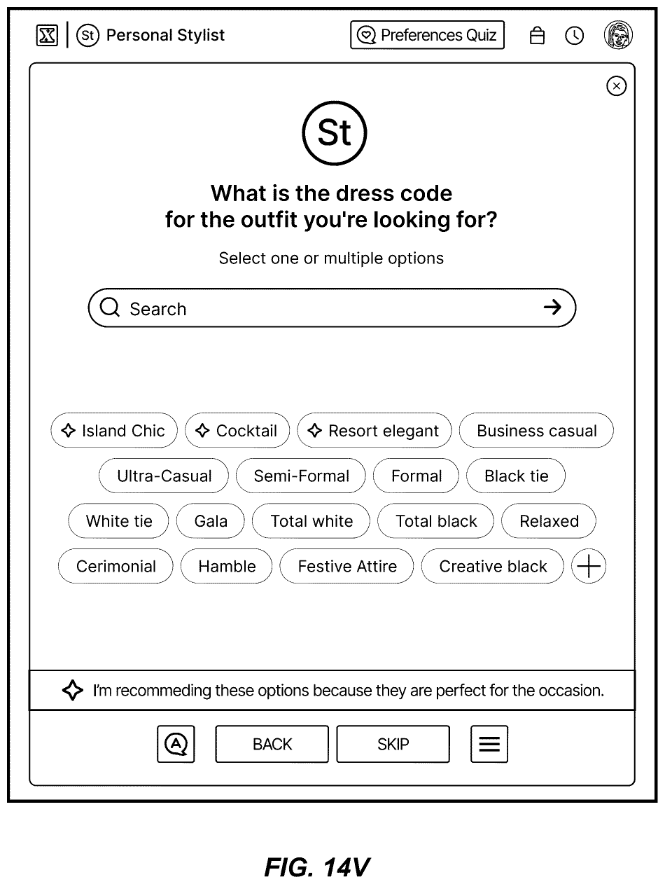

Referring to FIG. 14A, the user selects the option ‘Nurse.’ The user clicks the button ‘Continue’ to proceed.

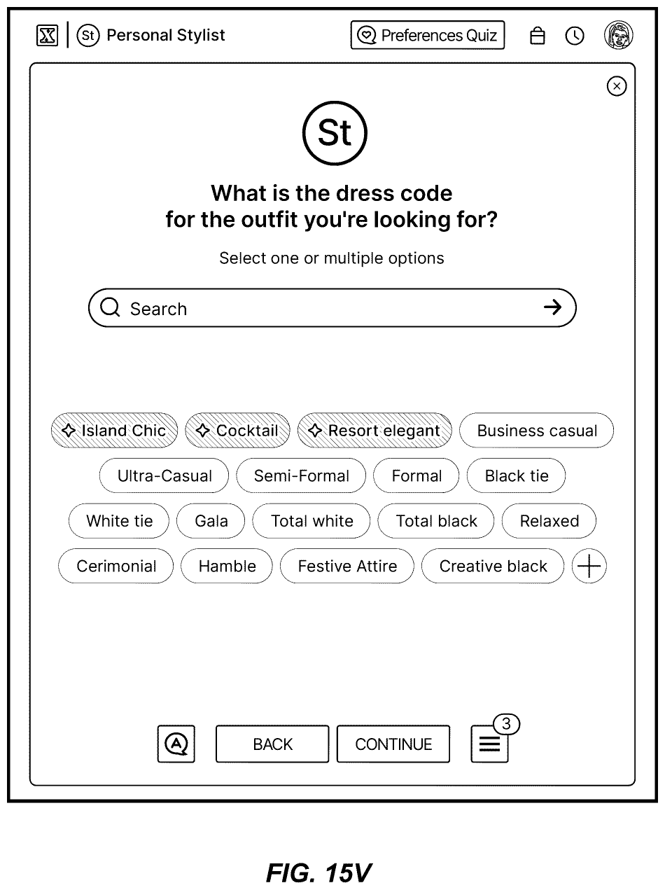

Referring to FIG. 15A, the Personal Stylist asks the next question ‘What style do you prefer to wear at work?’ The Personal Stylist shows some possible options to select.

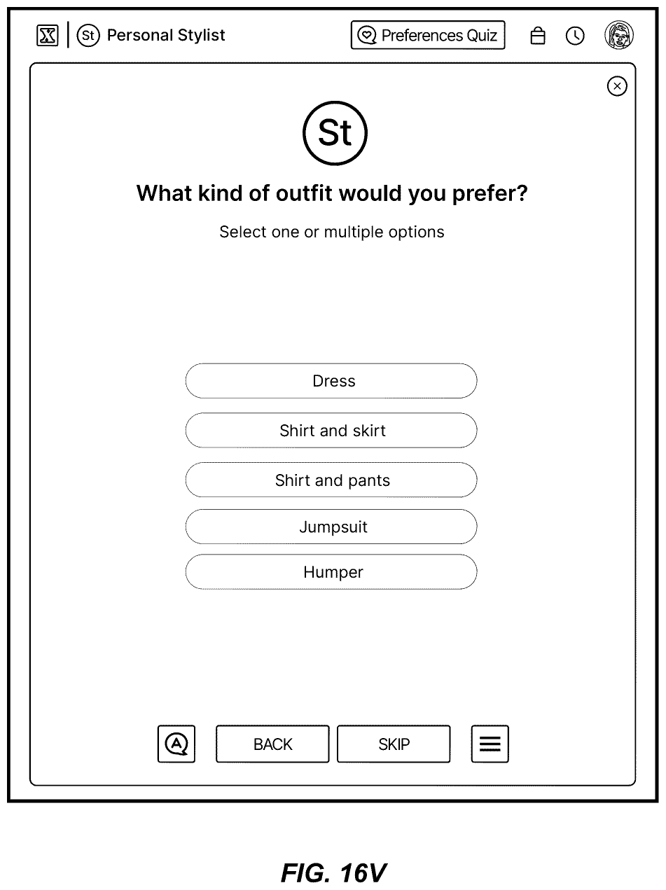

Referring to FIG. 16A, the user selects the option ‘Casual.’ The user clicks the button ‘Continue’ to proceed.

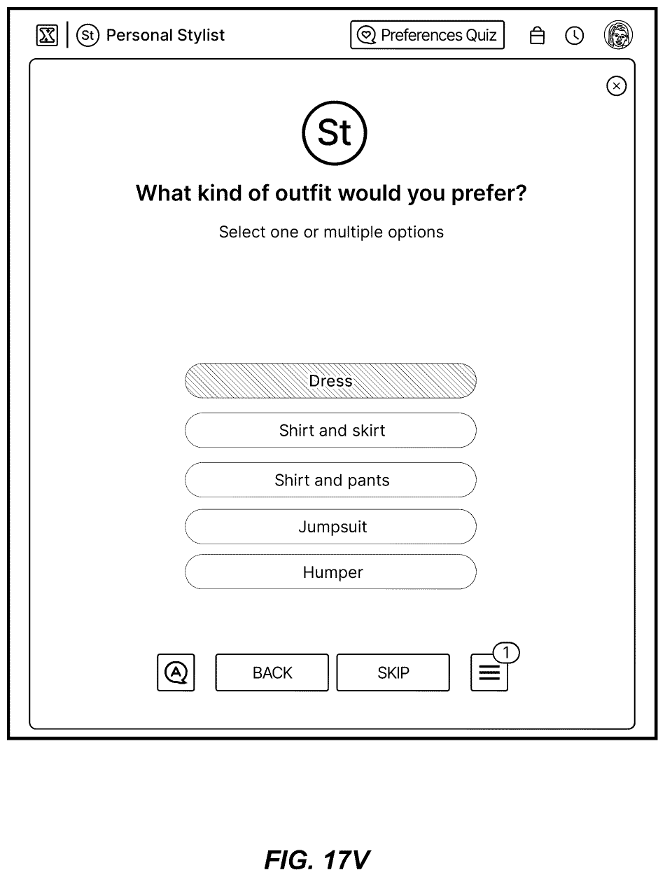

Referring to FIG. 17A, the user accesses the next question ‘What are your favorite colors to wear in general?’ The Personal Stylist shows some possible options to select. The user can skip the question.

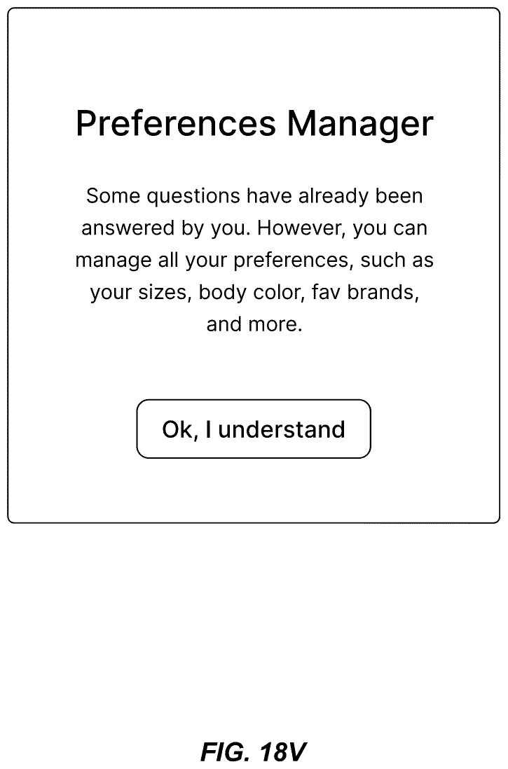

Referring to FIG. 18A, the user selects some options. The user clicks the button ‘Continue’ to proceed.

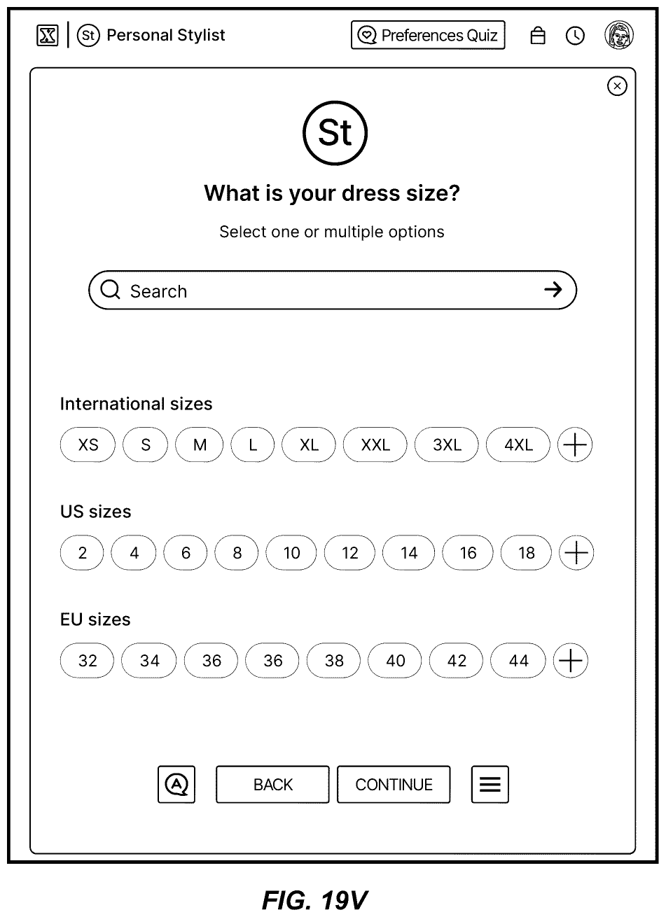

Referring to FIG. 19A, the Personal Stylist shows a popup to ask the user ‘Do you want to continue?’ The user can skip the process of ‘Preferences Quiz’.

### Shopping Bag

Referring to FIG. 1B, the user accesses the shopping bag. The Personal Stylist shows the list of items added in the shopping bag, ready to be purchased. Filters available appear for each item. The user can select the number of quantity and manage other variables like colors or sizes offered by the store that is selling the item. The user clicks the button ‘Buy now’ to open the online webstore and complete the purchase on that affiliate link. Some info can appear like return rules or other information useful for the user. The user selects the button ‘Add to GiftProfile’ to add the item in the GiftProfile (See GimmeGift app). The user shares the item on social networks or via message to someone. The user saves the item in the ‘Saved for later’ list, to postpone the purchase. The user removes the item from the Shopping Bag. The user, after the purchase of the item, confirms about the purchase. Confirming the item will be automatically saved and never recommended again in the future. The user manages the list ‘Saved for later,’ the list of postponed purchases.

Referring to FIG. 2B, scrolling the user sees the list of ‘Saved for later’ items. The user clicks on the button ‘Add to Shopping bag’ to add again the item in the shopping bag.

Referring to FIG. 3B, the detail of the item added in the shopping bag (To purchase) is shown. The detail of the item added in the shopping bag (Marked as purchased) is shown.

Referring to FIG. 4B, the detail of the item in the ‘Saved for later’ is shown.

Referring to FIG. 5B, the user clicks on the button ‘Info.’ Some options appear about the price (Best price online—item store link), about shipping (Store name) and about returns (Timing and modalities).

Referring to FIG. 6B, the user clicks on the button ‘Share’ and a popup to share the item appears. It is possible to select a social or message service to share the link of this item. The user can also copy the URL of the online item page (Copy link).

### Homepage

Referring to FIG. 1C, the user will be redirected to the homepage. The Personal Stylist is ready to offer the ‘Best looks curated for you’. The user can prompt a request, typing a phrase in the main field of the homepage. A text appears under the field suggesting to ‘For a best experience include the occasion or name of the event, location, date and hour, styles, brands, colors and other details you like.’ The Personal Stylist shows 3 possible options to select if the user prefers a wizard process, it's a complete questionnaire. The first is ‘Find a specific item for an occasion’ to find a single item based on the user preferences, and ‘Create a complete new outfit’ to find a complete outfit with items to purchase, and ‘Create an outfit with items you already have’ to create a complete outfit with items the user already has.

Referring to FIG. 2C, the user clicks on the profile picture. A dropdown is opened with a list of available options. The user selects ‘Manage profile’ to manage her profile. The user clicks on ‘Preferences Manager’ to manage the answered questions and related preferences. The user clicks on ‘Settings’ to visit the settings page. The user clicks on ‘Logout’ to logout the service and return to the register/login page.

Referring to FIG. 3C, the detail of the Nav bar with to the left the logo PersonalX is shown. The user clicking on the logo will visit the company website. The Personal Stylist logo is shown. The button ‘Personal Quiz’ to access the questionnaire about personal preferences, a series of questions with options to select and manage in order of preference. The shopping bag is the list of items the user listed to purchase on the external affiliated links. The history page is the list of all processes the user started to find an item or create an outfit. Each time the user starts a process and then clicks on the ‘Close’ button in the top of the process page, that process will be saved in ‘History’ to easily continue in a next time that process. The profile picture is shown. Clicking here the user opens a dropdown with a series of options.

### History

Referring to FIG. 1D, the user accesses the ‘History’ page, the list of all started and closed processes (The user selected in the homepage an option and started a process to find an item or complete outfit, and then closed that process).

Referring to FIG. 2D, the details about the processes in the history page are shown. The first one was a completed process to find a complete outfit. Clicking on the user will be redirected to the page with all 2 generated complete outfits and related date. It's not a completed process to create an outfit with a personal item. Clicking the user will be redirected to the question ‘What kind of shoe heels do you prefer?’ and related date. It's not a completed process to create a complete outfit. Clicking the user will be redirected to the prompt ‘I need an for an elegant dinner party in Milan’ and related date. The user selects the ‘More button’ to open some options.

Referring to FIG. 3D, the details of the ‘More’ button (See FIG. 2E—arrow 4) are shown. It will be possible to open the process again or delete it.

### Preferences Quiz

Referring to FIG. 1F, the user clicks on the nav bar the button ‘Preferences Quiz’ to access the questionnaire about her preferences.

Referring to FIG. 2F, the user accesses the Preferences Quiz, and the Personal Stylist starts to answer questions. In that case the question is ‘What is your shoe size?’ The user clicks on the ‘Close’ button to close the process. When the user returns, the Preferences Quiz will start with this last question. Nothing will be saved in ‘History’ page because it's not related to generating an outfit or finding an item. The Personal Stylist shows some options to select. The user searches for an option to select. The user opens the ‘Answered questions’ list, a space with all questions already answered to easily navigate and edit. The user clicks on the ‘Back’ button to return to the previous question. When no options are selected the user can ‘Skip’ the question. When the user selects one or multiple options the button becomes ‘Continue’. The user opens the ‘Manage order’ to manage the list of selected options in order of preference. FIGS. 3F-17F are very similar, they are questions with unselected or selected options, just to show what kind of questions the Personal Stylist will show.

### Manage Profile

Referring to FIG. 1G, the user accesses the page ‘Manage profile’ to manage her profile. The user clicks the button ‘Back’ to return back. The user enters her name, her surname, age and she selects her gender. The personal avatar appears as a preview, it will be used by the Personal Stylist to show outfits it will generate. The preview of the uploaded face picture appears. The user clicks the button ‘Delete face picture’ to delete it. Deleting the picture the Personal Stylist will use a generic and random face. It will appear a button to upload a new face picture. The preview of the uploaded body picture appears. The user clicks the button ‘Delete face body’ to delete it. Deleting the picture the Personal Stylist will use a generic and random body. It will appear a button to upload a new face body.

### Preferences Manager

Referring to FIG. 1H, the user selects the ‘Preferences Manager’ page to manage all preferences she shared in the preferences quiz or during a process of outfit creation. The user selects the ‘Close’ button to close the process and return to the homepage. The user selects the section ‘Answered’ to see the list of all answers. Some filters appear on the top of the page. The user selects ‘All’ to see the total list. There are some groups of questions, like ‘Sizes’ with the number of questions related to the sizes, ‘Brands, ‘Colors’, and ‘Styles.’ They work like folders where inside there are related answered questions. The Personal Stylist shows the list of answered questions. The first of this list is ‘What brands do you prefer for shirts?’ with related selected options (like Armani, Alberta Ferretti, etc.).

Referring to FIG. 2H, the user selects the page ‘Skipped’ to have the list of all questions she skipped and so that not have an answer. The Personal Stylist shows the list of all questions that don't have an answer. It could be filter that list with some button-filter on the top of the page, they are some categories.

Referring to FIG. 3H, the user selects from the page Preferences Quiz page the group of questions related to the ‘Sizes’ that have inside all questions about sizes of everything. The user clicks the button ‘Back’ to return to the previous page. Some filters appear on the top of the page. The user selects ‘All’ to see the total list. The Personal Stylist shows in a list all questions she answered about sizes like ‘What is your sizes for shirts?’ selecting the option ‘S’. When the Personal Stylist already has an answer for a question it will be able to consider that info also for the next processes, so it will not be asked again in future, however here the user is able to edit or delete it.

### Settings

Referring to FIG. 1K, the user visits the page ‘Settings.’ The user clicks the button ‘Close’ to close the page. The user clicks the section ‘Account’ to manage all related options. The user clicks the section ‘Notifications’ to manage all related options.

Referring to FIG. 2K, the user visits the section ‘Manage account.’ The user clicks the button ‘Back’ to return to the previous page. The user manages her phone number. The user manages her email. The user unable/disables the option to ‘Subscribe to our newsletter and stay updated.’ The user connects her Facebook account to access. The user connects her Google account to access. The user clicks the button ‘Delete account’ to delete her account. The user clicks the button ‘Save’ to save all changes.

Referring to FIG. 3K, the user visits the page ‘Notifications.’ The user clicks the button ‘Back’ to return to the previous page. The user enable/disable the option ‘Send me email notifications.’ The user enable/disable the option ‘Send me notifications via text message.’ The user enable/disable the option ‘Send me notifications regarding my purchases.’ The user enable/disable the option ‘Send me a notification about new fashion suggestions.’ The user enable/disable the option ‘Send me a notification about Personal Stylist or PersonalX news.’ The user clicks the button ‘Save’ to save all changes.

### Single Item

Referring to FIG. 1U, from the homepage the user selects the option ‘Find a specific item for an occasion’ to find a single item.

Referring to FIG. 2U, the figure shows the detail of a popup that will appear at first accesses and informs the user about the ‘Recommended options,’ when the user find the ‘Star’ symbol for some options it will means that these options are recommended for some reasons, like because they are perfect for the user or for the occasion: ‘Let me suggest options that might be perfect for you or for an occasion. Recommended options will have this symbol, but feel free to choose whatever you want.’

Referring to FIG. 3U, the user has access to a series of questions (questionnaire or wizard process) where she could select some options available, search other options not in the list or directly write a request. The Personal Stylist asks ‘What item are you looking for?’ The user can select one only option. The user clicks on ‘Close’ to close the process and return to the homepage. The process in any case will be saved in the ‘History’ page accessible from the icon in navbar. The user searches other options to select or types a prompt. For each categories (like Clothing) will appear a list of options that the user could select and a button ‘Plus’ to extend in a new row the list of these options. The user selects the button ‘Answered Questions’ to manage the list of all questions answered in that specific process. It's a way to navigate all the questions she answered to edit or delete them. The user selects the button ‘Back’ to return to the previous page. The user selects the button ‘Skip’ to skip the question. This button will appear when it is possible to skip and when no options are selected. When the user selects one or more options or fill a field or upload something, this button will change in ‘Continue’ or ‘Confirm.’ The user clicks the button ‘Manage order’ to manage the order of selected options, in the specific questions, in order of preference.

Referring to FIG. 4U, the user selects the option ‘Shoes’ in the accessories category. The user clicks the button ‘Continue’ to proceed.

Referring to FIG. 5U, the Personal Stylist asks ‘Do you already have shoes similar to the ones you are looking for?’ and the user can upload a picture of her shoes. The user clicks the ‘Upload your shoes’ button to upload the shoes picture and info.

Referring to FIG. 6U, the figure shows in detail how the user, clicking the button ‘Upload your shoes’ is able to upload the item. It will appear as a form to complete. The user can upload the item picture, brand name, item name, size, color and confirm.

Referring to FIG. 7U, the figure shows how the Personal Stylist asks other questions in the wizard process to find the item perfect for the occasion. The question is ‘What occasion and context are the shoes for?’ with a list of options.

Referring to FIG. 8U, the user selects some options and clicks on the button ‘Continue’ to proceed.

Referring to FIG. 9U, the figure shows how the Personal Stylist asks other questions in the wizard process to find the item perfect for the occasion. The question is ‘What is the date of the occasion?’ with a field to fill.

Referring to FIG. 10U, the figure shows how the Personal Stylist asks other questions in the wizard process to find the item perfect for the occasion. The question is ‘What is the time of day for the shoes you're looking for?’ with a list of options.

Referring to FIG. 11U, the user selects some options and clicks on the button ‘Continue’ to proceed.

Referring to FIG. 12U, the figure shows how the Personal Stylist asks other questions in the wizard process to find the item perfect for the occasion. The question is ‘Where will you wear the shoes you're looking for?’ with a field to fill.

Referring to FIG. 13U, the user types a venue and selects an option in the dropdown. The user clicks on the button ‘Continue’ to proceed.

Referring to FIG. 14U, the figure shows how the Personal Stylist asks other questions in the wizard process to find the item perfect for the occasion. The question is ‘What is your shoe size?’ with a list of options. This question will only be asked once. However the user will be able to edit that data.

Referring to FIG. 15U, the user selects an option and clicks on the button ‘Continue’ to proceed.

Referring to FIG. 16U, the figure shows how the Personal Stylist asks other questions in the wizard process to find the item perfect for the occasion. The question is ‘What type of shoes do you prefer?’ with a list of options. Some options are recommended because they are perfect for the selected occasion.

Referring to FIG. 17U, the user selects some options and clicks on the button ‘Continue’ to proceed.

Referring to FIG. 18U, the figure shows how the Personal Stylist asks other questions in the wizard process to find the item perfect for the occasion. The question is ‘What shoe styles do you prefer?’ with a list of options. Some options are recommended because they are perfect for the selected occasion.

Referring to FIG. 19U, the user selects some options and clicks on the button ‘Continue’ to proceed.

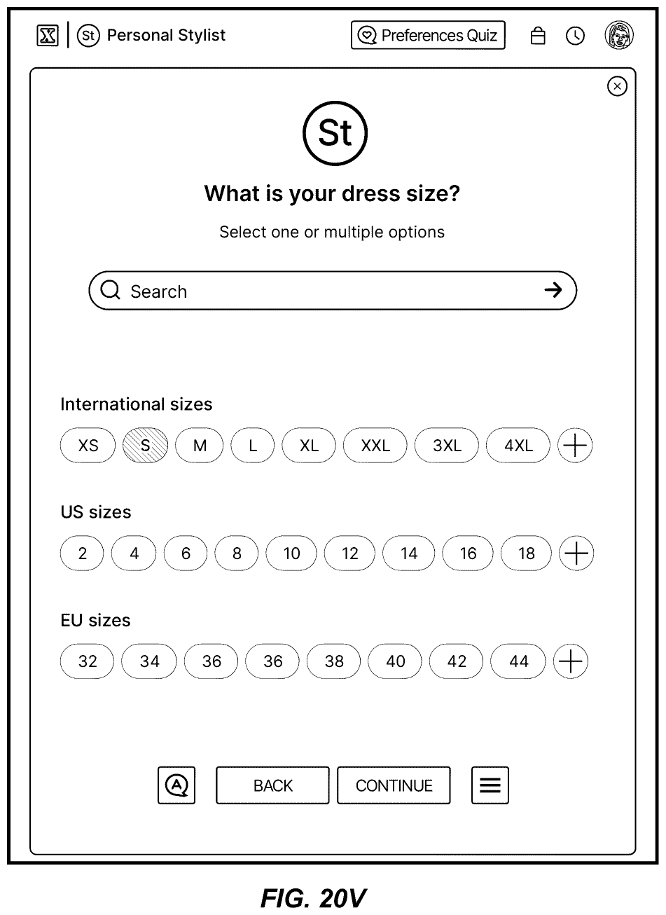

Referring to FIG. 20U, the figure shows how the Personal Stylist asks other questions in the wizard process to find the item perfect for the occasion. The question is ‘Which shoe brands do you prefer?’ with a list of options. Some options are recommended because they are perfect for the selected occasion.

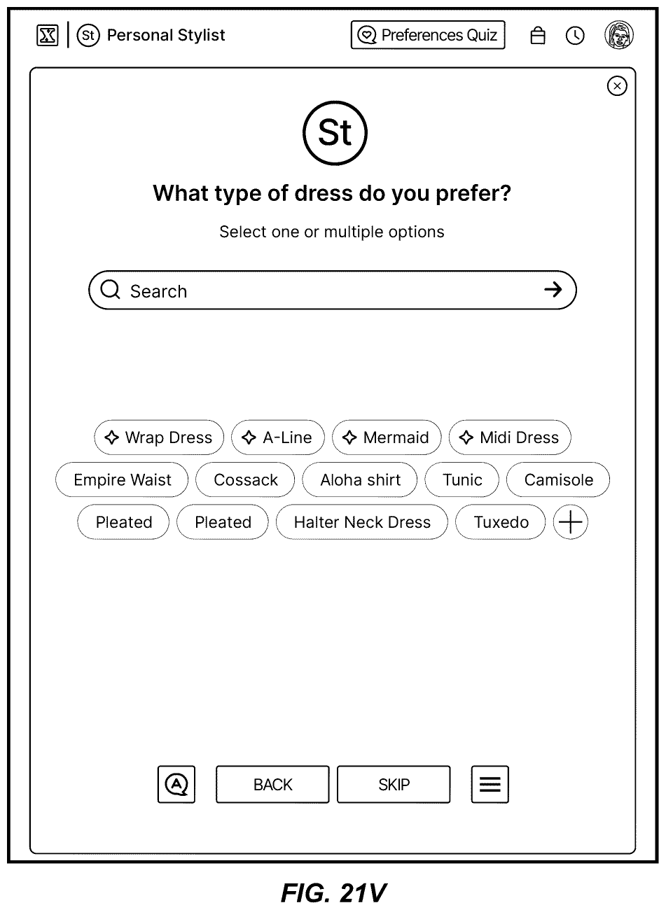

Referring to FIG. 21U, the user selects some options and clicks on the button ‘Continue’ to proceed.

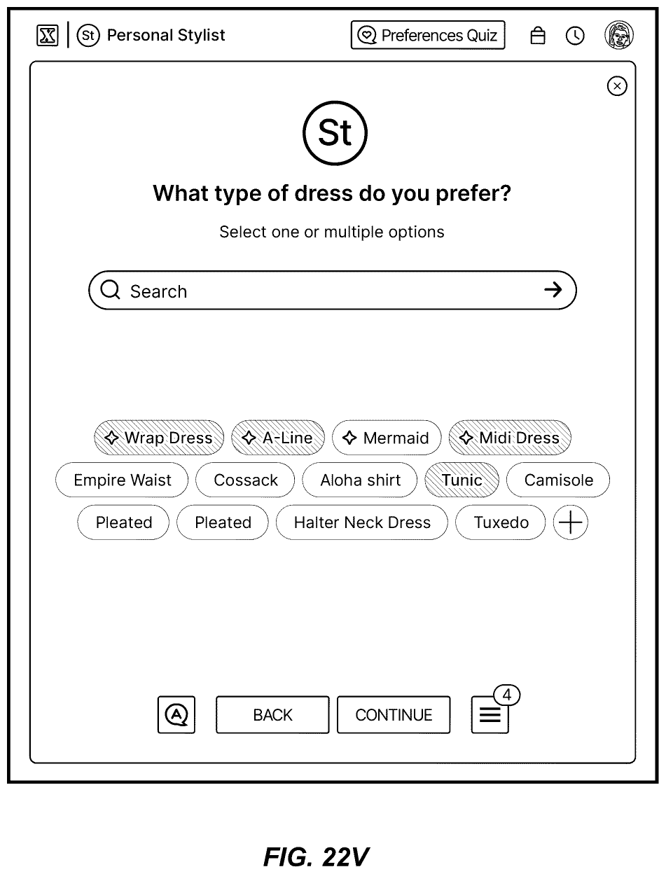

Referring to FIG. 22U, the figure shows how the Personal Stylist asks other questions in the wizard process to find the item perfect for the occasion. The question is ‘What kind of shoes heels do you prefer?’ with a list of options. Some options are recommended because they are perfect for the selected occasion.

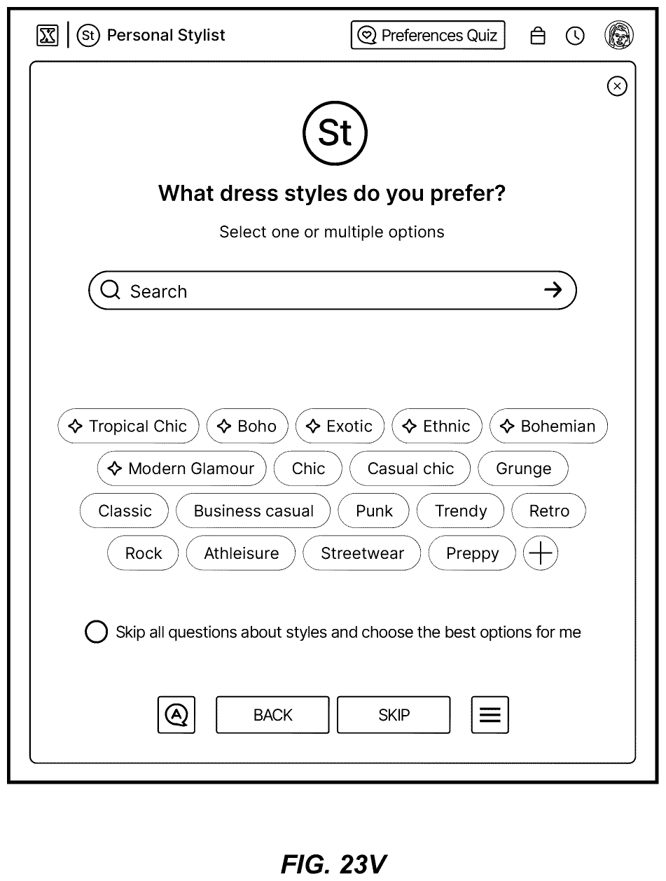

Referring to FIG. 23U, the user selects some options and clicks on the button ‘Continue’ to proceed.

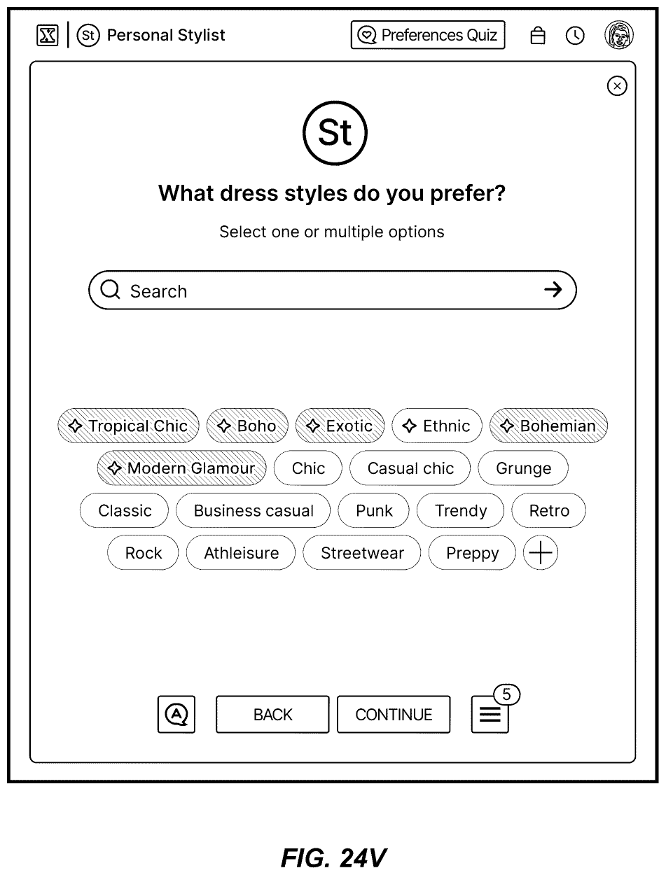

Referring to FIG. 24U, the figure shows how the Personal Stylist asks other questions in the wizard process to find the item perfect for the occasion. The question is ‘Do you want to add other details for shoes?’ with a list of options. Some options are recommended because they are perfect for the selected occasion.

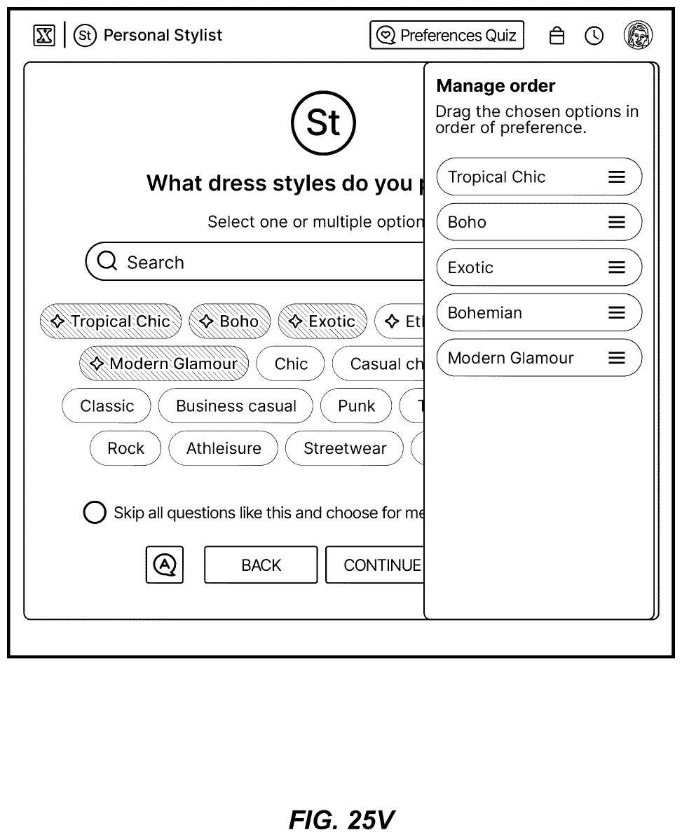

Referring to FIG. 25U, the user selects some options and clicks on the button ‘Continue’ to proceed.

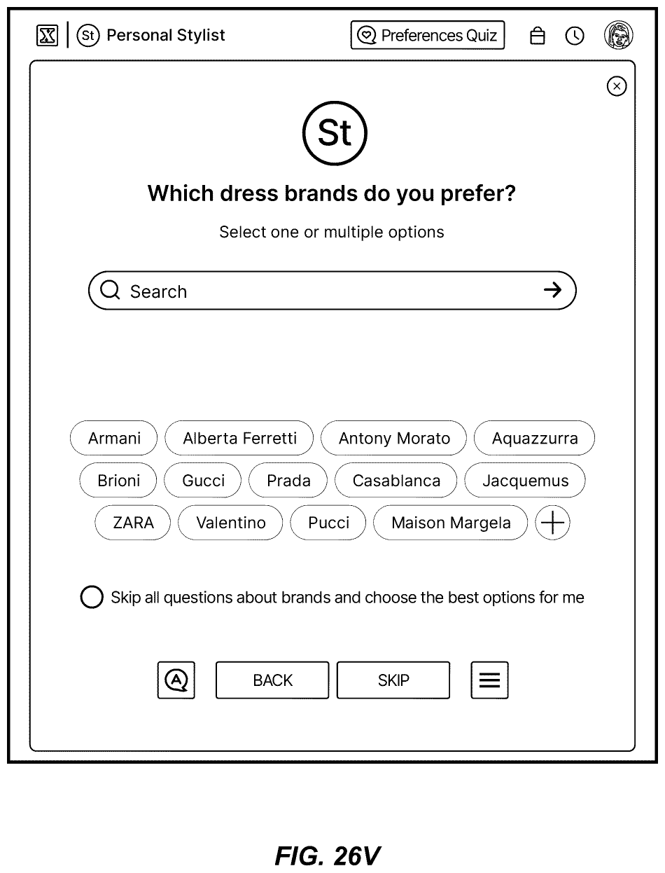

Referring to FIG. 26U, the Personal Stylist asks ‘What is your total budget for the shoes?’ The user selects the range of her budget.

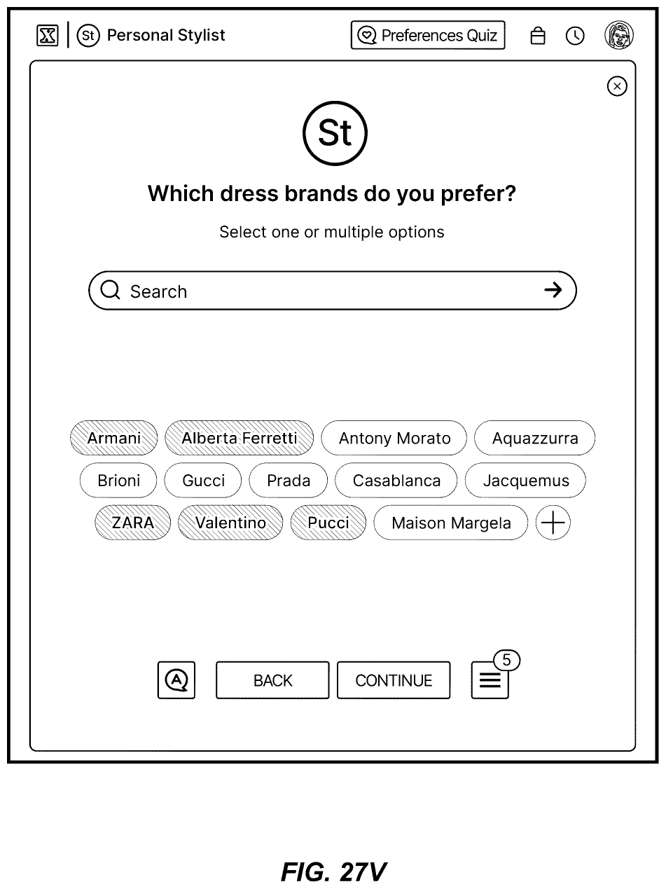

Referring to FIG. 27U, the Personal Stylist asks ‘How many shoes options do you want to be shown?’

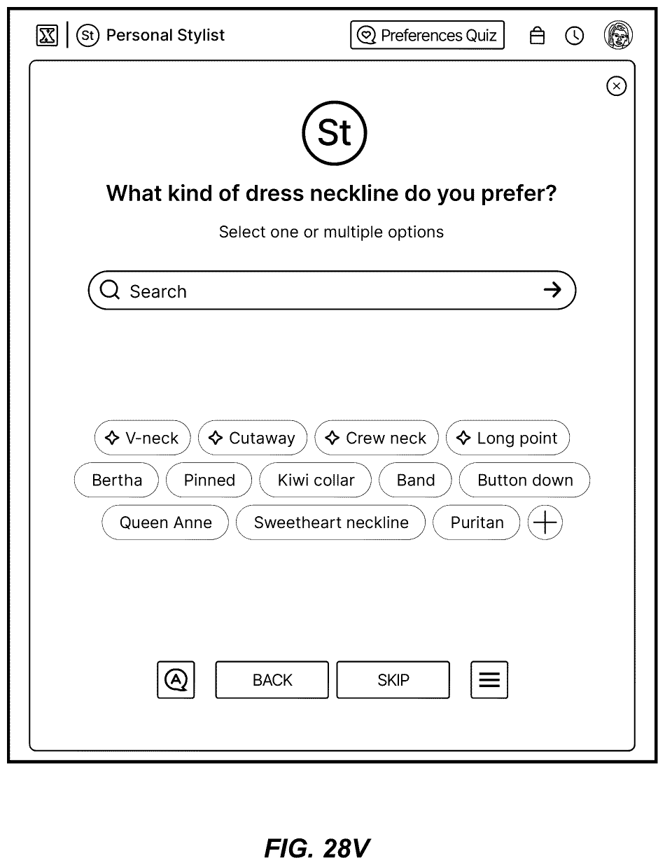

Referring to FIG. 28U, the user selects the option ‘3 shoe options’ and clicks on the button ‘Continue’ to proceed.

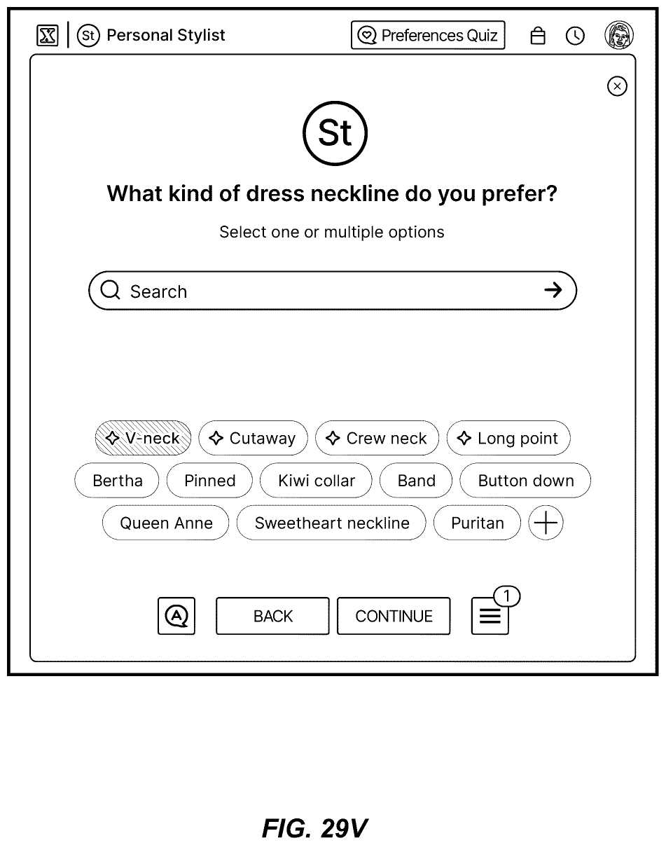

Referring to FIG. 29U, the Personal Stylist generates 3 options of items.

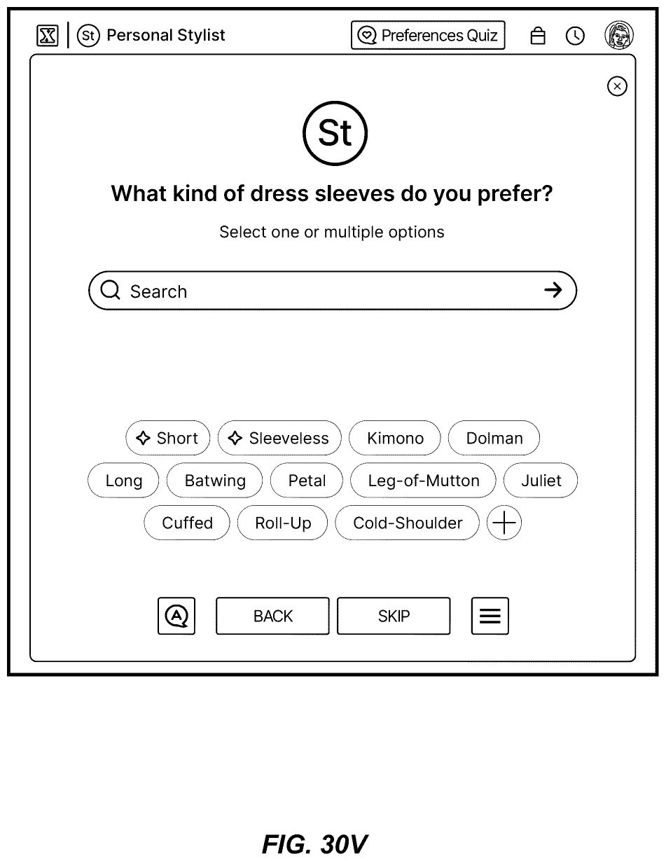

Referring to FIG. 30U, the user clicking on a generated shoes picture opens the dedicated page with the item, the button ‘Share,’ the button ‘Generate outfit’ to generate an outfit based on the generated picture (Shoes). On the right side of the screen there is the list of the item Personal Stylist selected for the user based on the generate picture and a list of other similar items with related information and the buttons ‘Add to shopping cart’ and ‘Add to GiftProfile.’

### Complete Outfit

Referring to FIG. 1V, from the homepage the user selects the option ‘Create a complete new outfit’ to create a new complete outfit with items to purchase.

Referring to FIG. 2V, the figure shows the detail of a popup that will appear at first accesses and informs the user about the ‘Recommended options’, when the user find the ‘Star’ symbol for some options it will means that these options are recommended for some reasons, like because they are perfect for the user or for the occasion: ‘Let me suggest options that might be perfect for you or for an occasion. Recommended options will have this symbol, but feel free to choose whatever you want.’

Referring to FIG. 3V, the Personal Stylist asks ‘What occasion and context is the outfit for?’

Referring to FIG. 4V, the user selects an option and clicks on the button ‘Continue’ to proceed.

Referring to FIG. 5V, the user selects a first option.

Referring to FIG. 6V, the user selects another option and clicks on the button ‘Continue’ to proceed. The user clicks the button ‘Manage order’ to manage the selected options in order of preference.

Referring to FIG. 7V, the Personal Stylist opens the tab ‘Manage order’ and the user can drag up and down each option in order of preference.

Referring to FIG. 8V, the Personal Stylist asks ‘What is the date of the occasion?’ and the user can select a date.

Referring to FIG. 9V, the user clicks on the field and a calendar appears. The user selects a date and clicks on the button ‘Continue’ to proceed.

Referring to FIG. 10V, the Personal Stylist asks ‘What is the time of day for the outfit you're looking for?’

Referring to FIG. 11V, the user selects some options and clicks on the button ‘Continue’ to proceed.

Referring to FIG. 12V, the Personal Stylist asks ‘Where will you wear the outfit you're looking for?’

Referring to FIG. 13V, the user types a venue and selects the option she needs. The user clicks on the button ‘Continue’ to proceed.

Referring to FIG. 14V, the Personal Stylist asks ‘What is the dress code for the outfit you're looking for?’

Referring to FIG. 15V, the user selects some options and clicks on the button ‘Continue’ to proceed.

Referring to FIG. 16V, the Personal Stylist asks ‘What kind of outfit would you prefer?’

Referring to FIG. 17V, the user selects an option and clicks on the button ‘Continue’ to proceed.

Referring to FIG. 18V, the Personal Stylist shows a popup that explains the feature ‘Preferences Manager’ (Some questions have already been answered by you. However, you can manage all your preferences, such as your sizes, body color, fav brands, and more.)

Referring to FIG. 19V, the Personal Stylist asks ‘What is your dress size?’

Referring to FIG. 20V, the user selects some options and clicks on the button ‘Continue’ to proceed.

Referring to FIG. 21V, the Personal Stylist asks ‘What type of dress do you prefer?’

Referring to FIG. 22V, the user selects some options and clicks on the button ‘Continue’ to proceed.

Referring to FIG. 23V, the Personal Stylist asks ‘What dress styles do you prefer?’

Referring to FIG. 24V, the user selects some options and clicks on the button ‘Continue’ to proceed.

Referring to FIG. 25V, the user selects the ‘Manage order’ list.

Referring to FIG. 26V, the Personal Stylist asks ‘Which dress brands do you prefer?’

Referring to FIG. 27V, the user selects some options and clicks on the button ‘Continue’ to proceed.

Referring to FIG. 28V, the Personal Stylist asks ‘What kind of dress neckline do you prefer?’

Referring to FIG. 29V, the user selects some options and clicks on the button ‘Continue’ to proceed.

Referring to FIG. 30V, the Personal Stylist asks ‘What kind of dress sleeves do you prefer?’

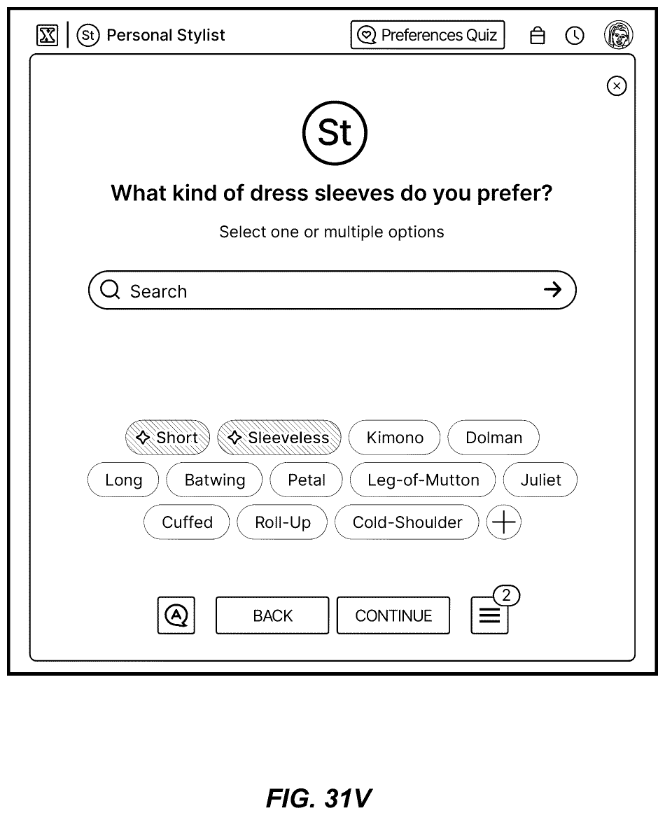

Referring to FIG. 31V, the user selects some options and clicks on the button ‘Continue’ to proceed.

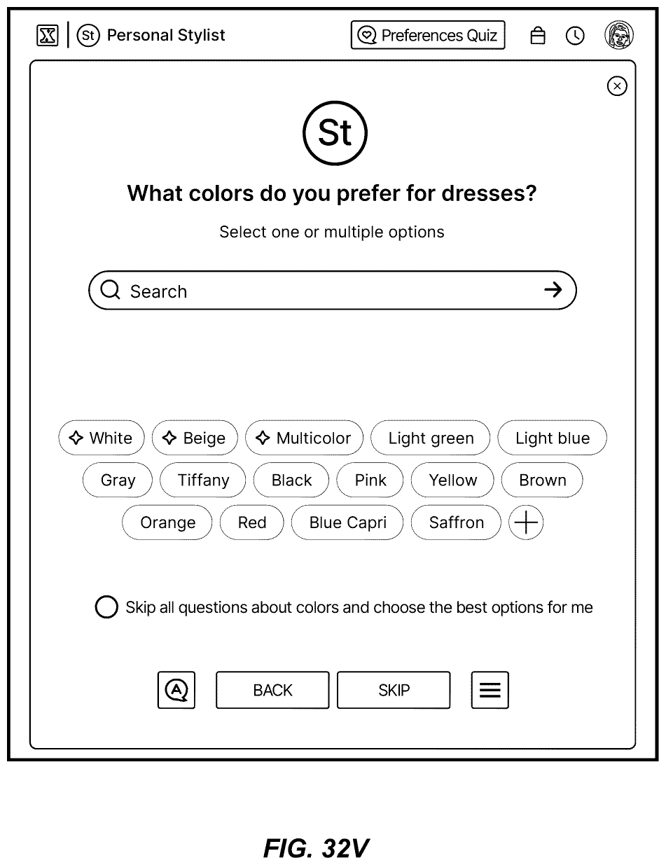

Referring to FIG. 32V, the Personal Stylist asks ‘What colors do you prefer for dresses?’

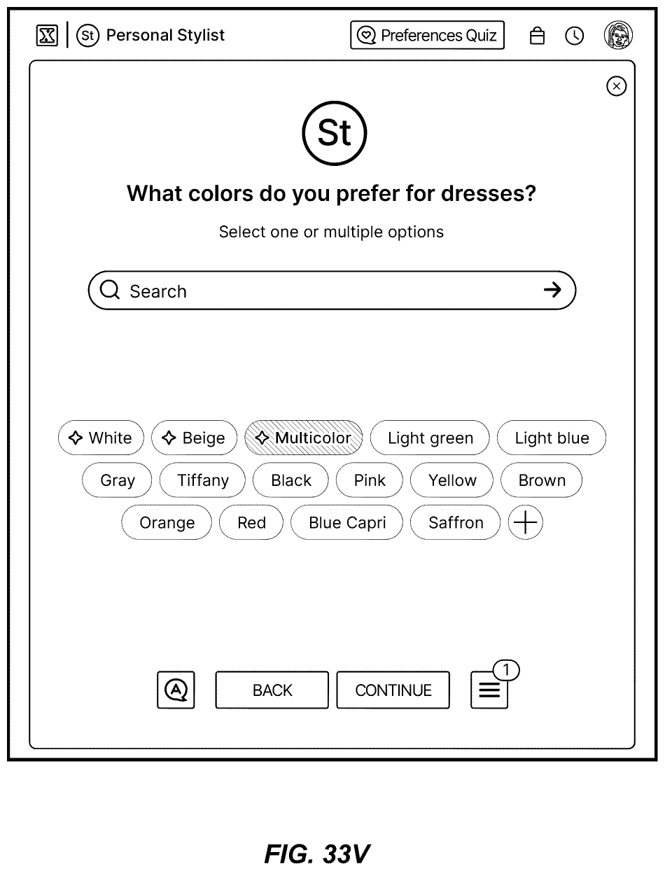

Referring to FIG. 33V, the user selects some options and clicks on the button ‘Continue’ to proceed.

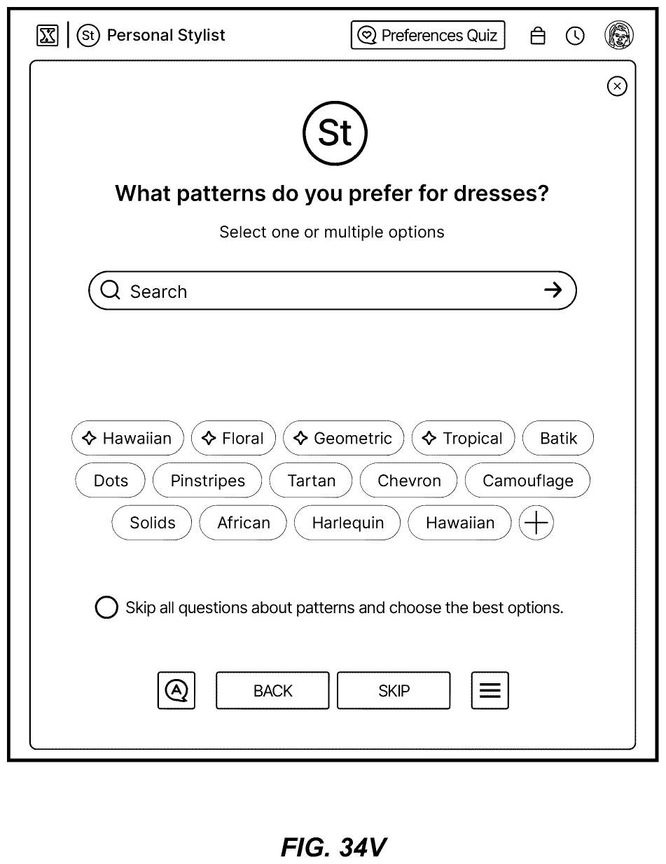

Referring to FIG. 34V, the Personal Stylist asks ‘What patterns do you prefer for dresses?’

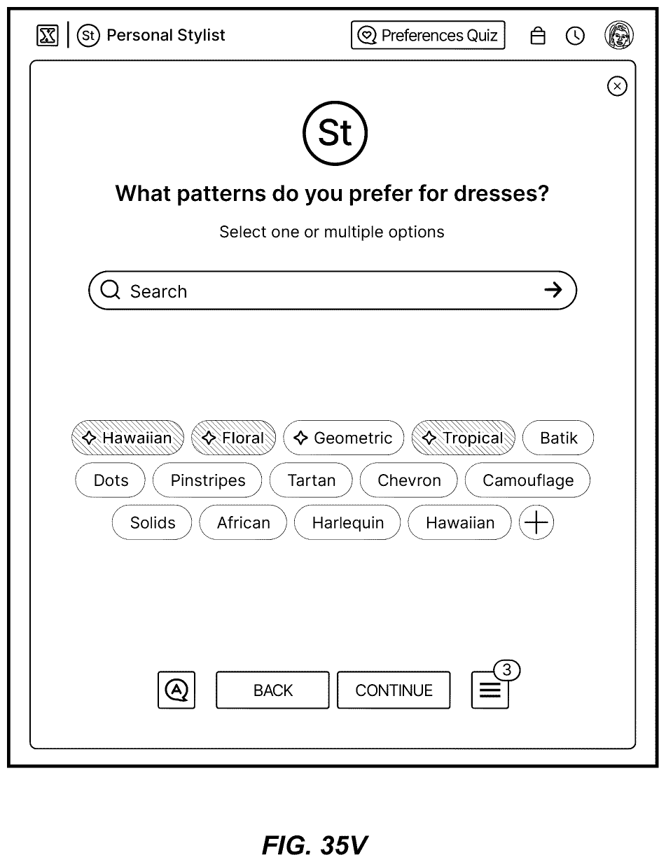

Referring to FIG. 35V, the user selects some options and clicks on the button ‘Continue’ to proceed.

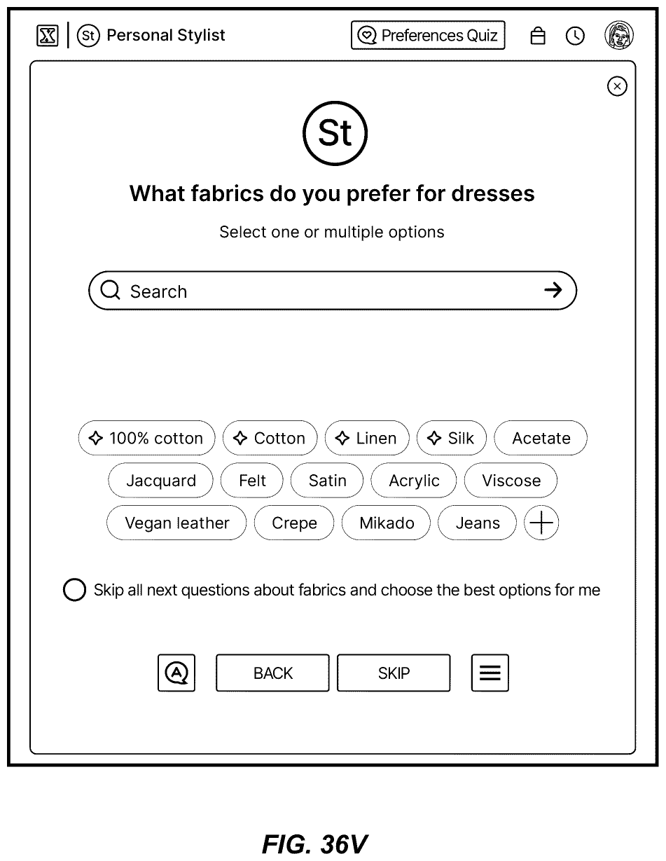

Referring to FIG. 36V, the Personal Stylist asks ‘What fabrics do you prefer for dresses?’

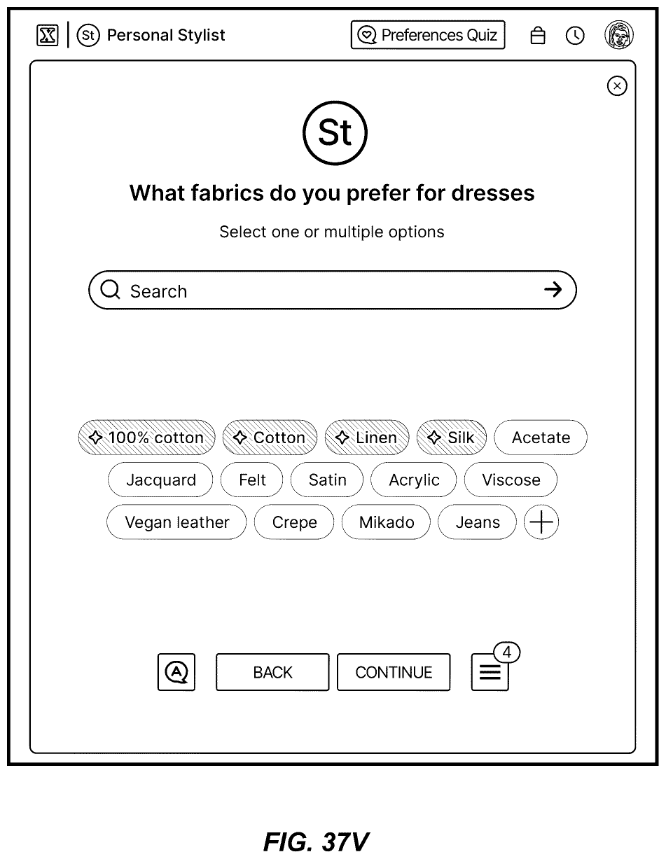

Referring to FIG. 37V, the user selects some options and clicks on the button ‘Continue’ to proceed.

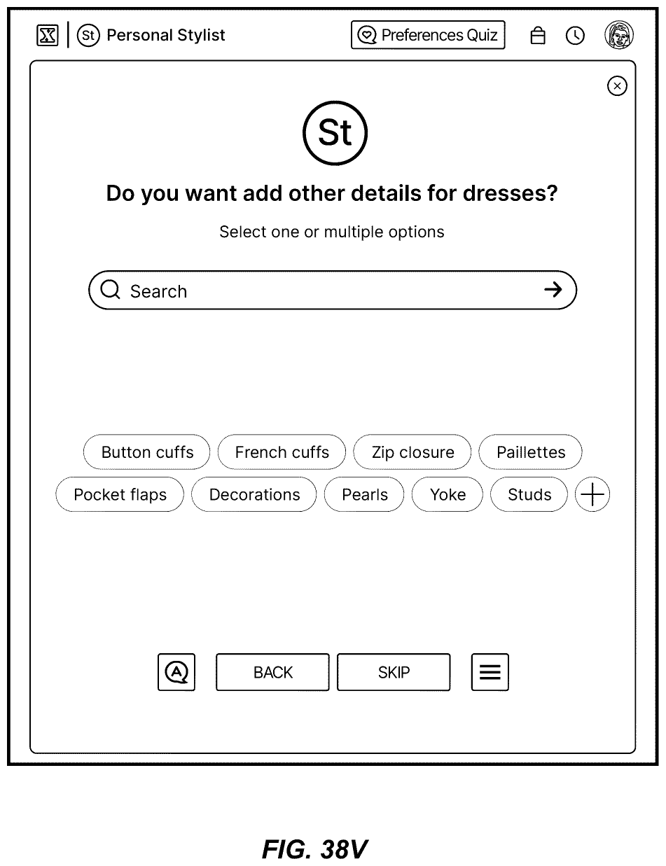

Referring to FIG. 38V, the Personal Stylist asks ‘Do you want to add other details for dresses?’

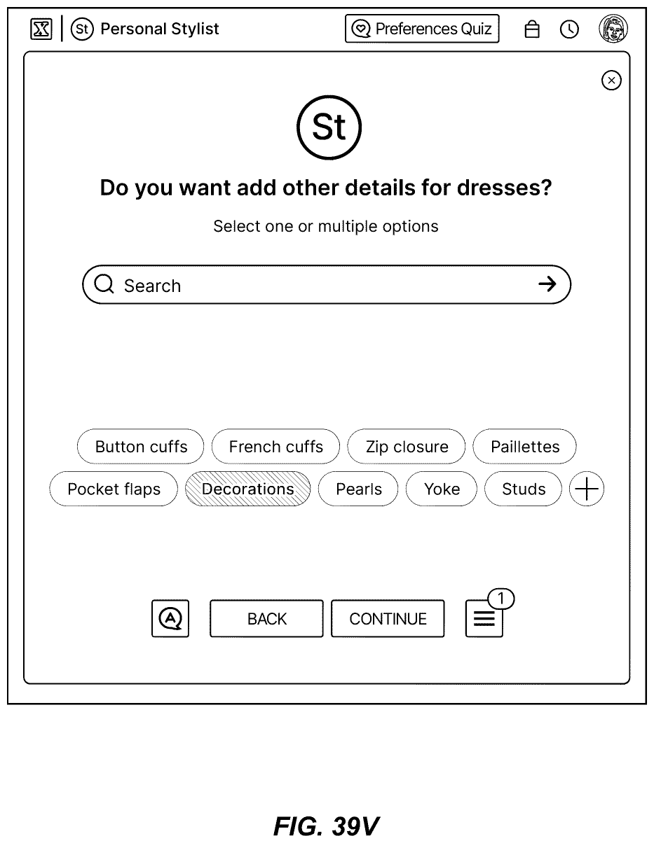

Referring to FIG. 39V, the user selects some options and clicks on the button ‘Continue’ to proceed.

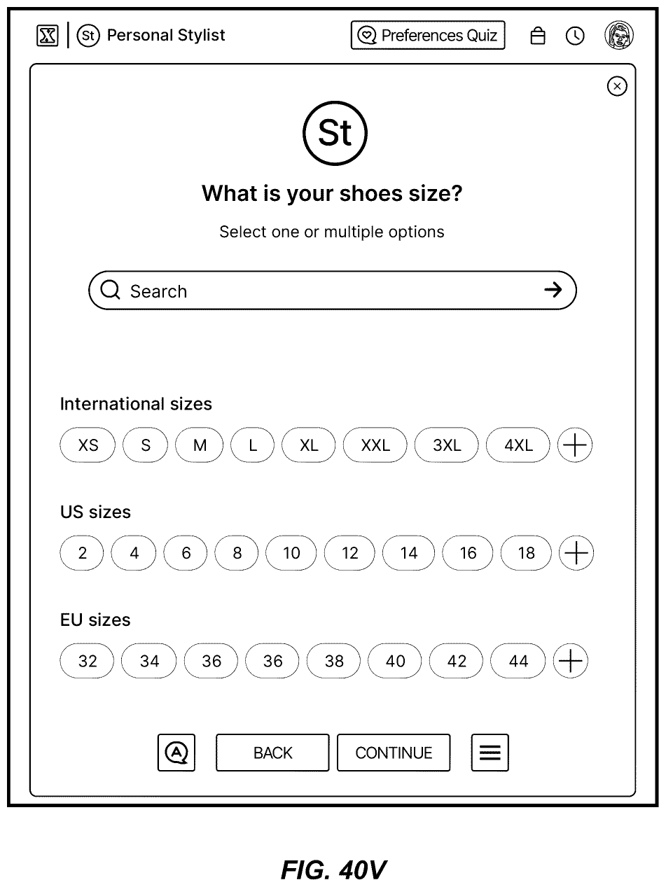

Referring to FIG. 40V, the Personal Stylist asks ‘What is your shoe size?’

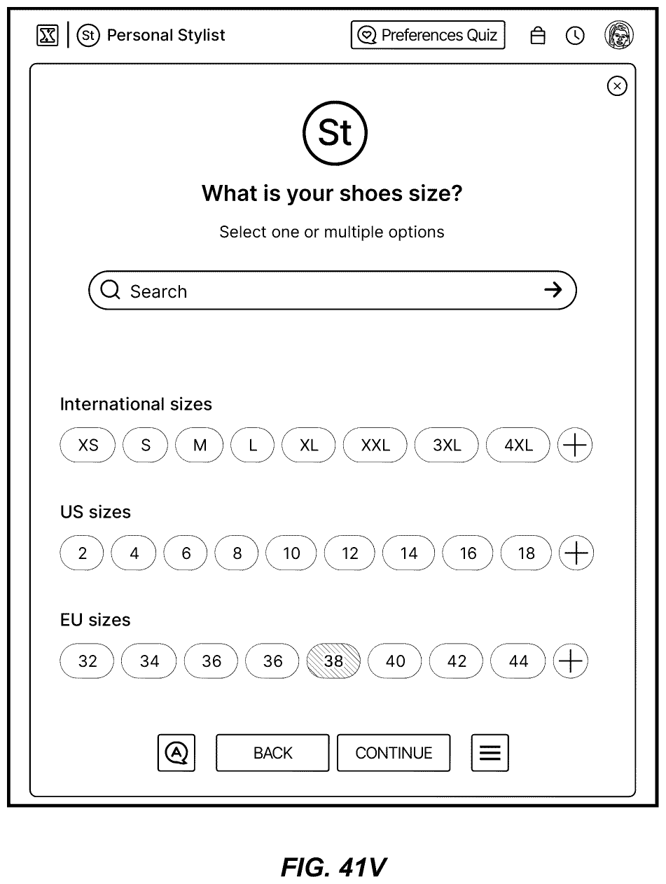

Referring to FIG. 41V, the user selects an option and clicks on the button ‘Continue’ to proceed. The Personal Stylist will ask about the sizes once and the user will be able to manage it in ‘Preferences Manager.’

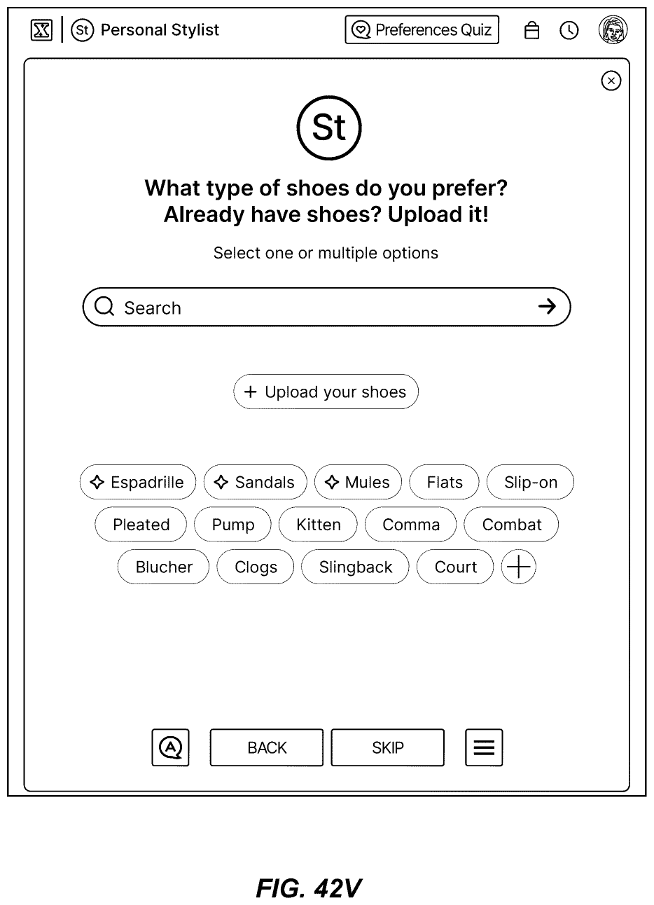

Referring to FIG. 42V, the Personal Stylist asks ‘What type of shoes do you prefer?Already have shoes?Upload it!’

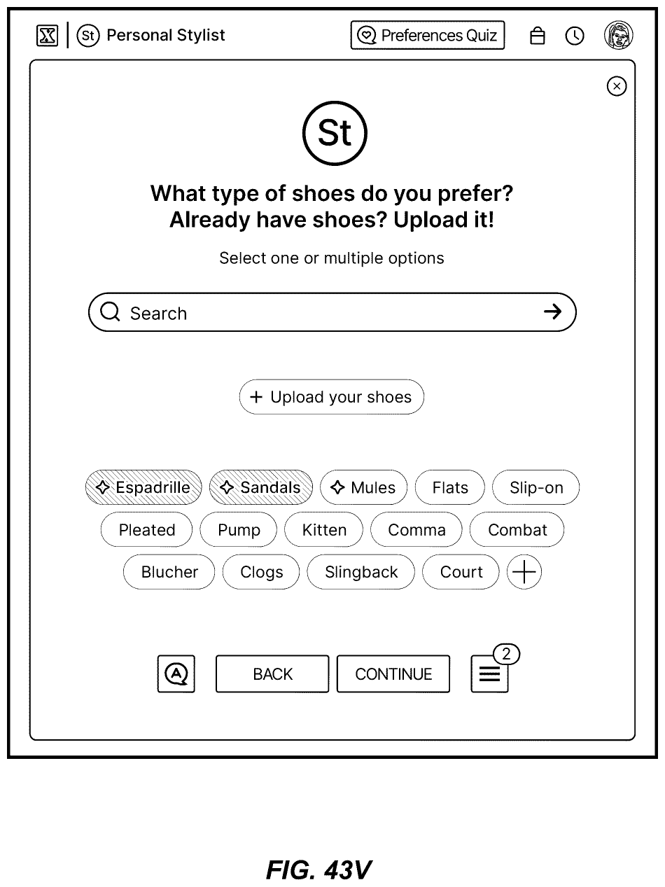

Referring to FIG. 43V, the user selects some options and clicks on the button ‘Continue’ to proceed.

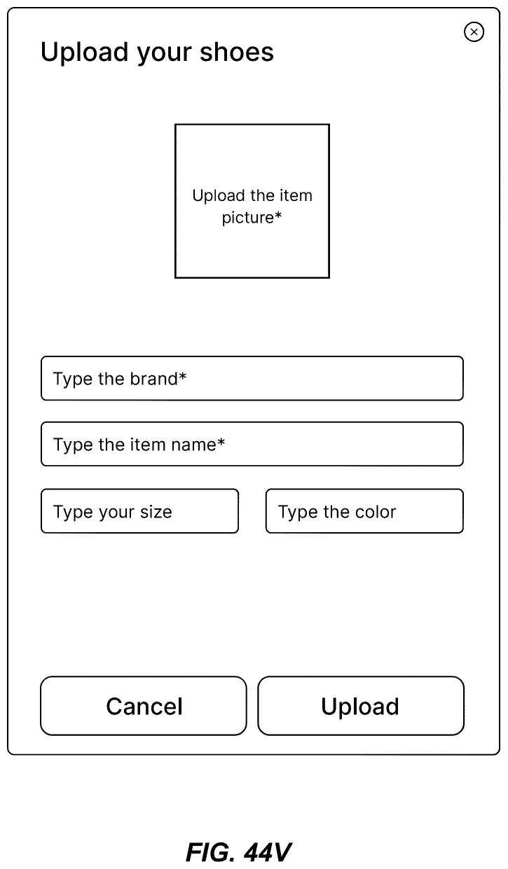

Referring to FIG. 44V, the figure shows in detail how the user, clicking the button ‘Upload your shoes’ is able to upload the item. It will appear as a form to complete. She can upload the item picture, brand name, item name, size, color and confirm.

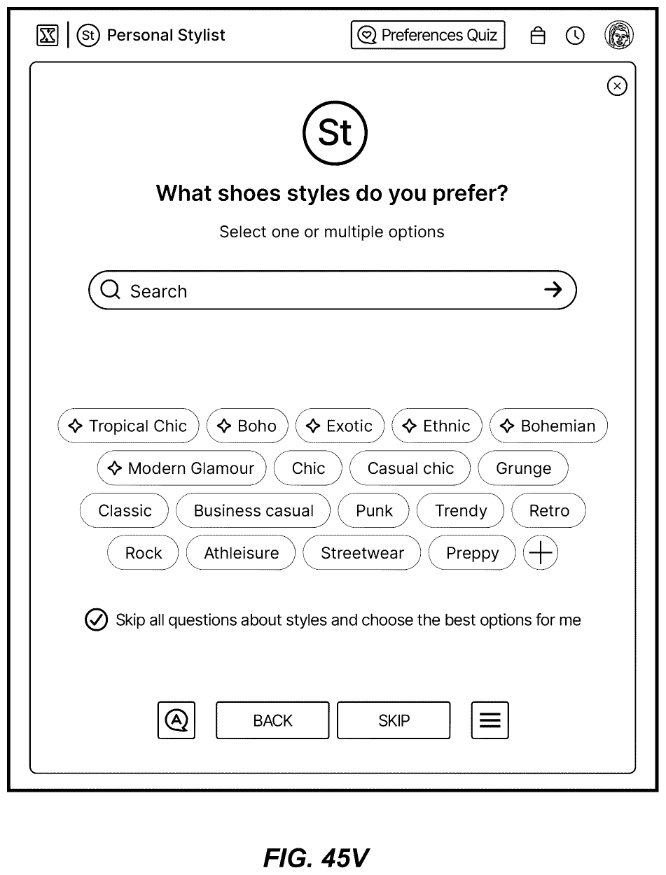

Referring to FIG. 45V, the Personal Stylist asks ‘What shoe styles do you prefer?’ She skipped the question and decided to enable the option ‘Skip all questions about styles and choose the best options.’

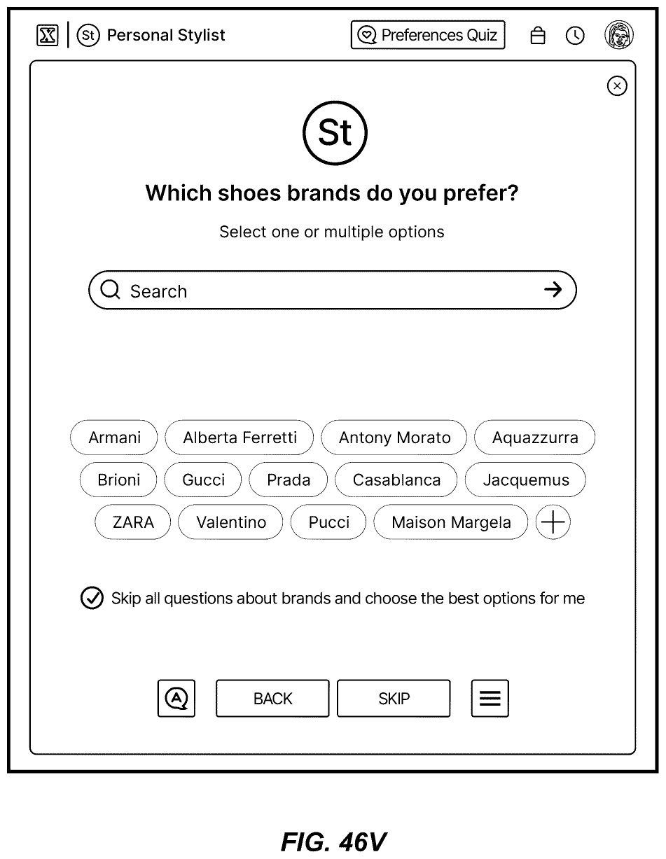

Referring to FIG. 46V, the Personal Stylist asks ‘Which shoe brands do you prefer?’ She skipped the question and decided to enable the option ‘Skip all questions about brands and choose the best options.’

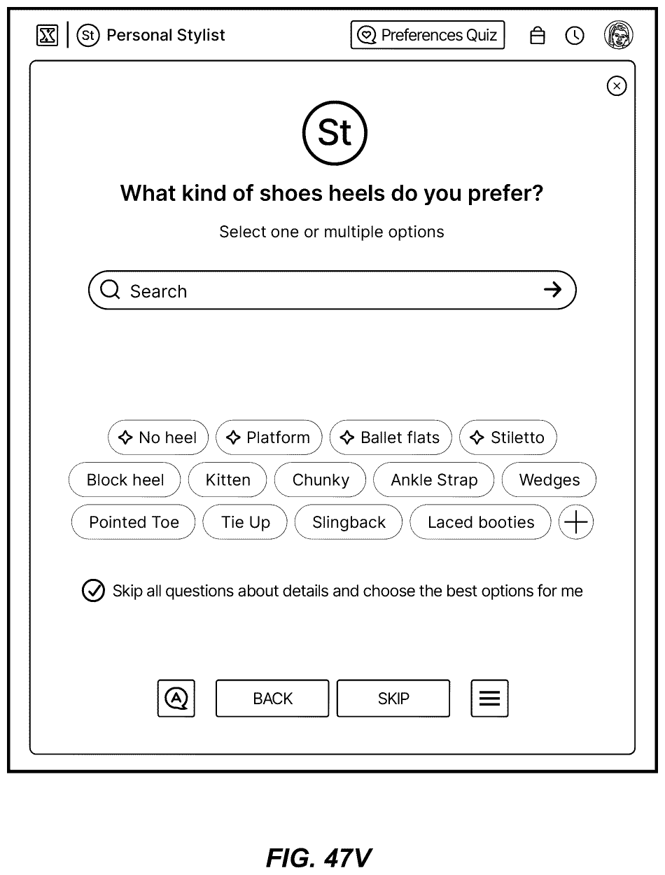

Referring to FIG. 47V, the Personal Stylist asks ‘What kind of shoe heels do you prefer?’ She skipped the question and decided to enable the option ‘Skip all questions about details and choose the best options.’

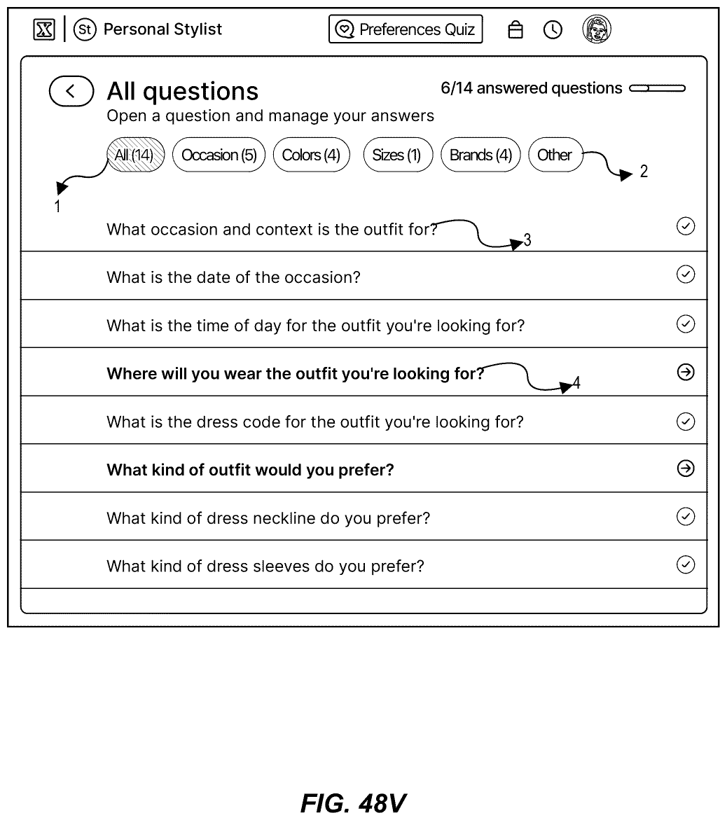

Referring to FIG. 48V, the user selects the button ‘All questions’ (or named ‘Answered questions’) to open the list of all questions related to the specific process. The user selects a filter on the top side of the page ‘All’ to see all questions list. Other filters are available to be selected based on the argument of the question. The user answered the first question. The user can click on it again to edit the answer or skip it. The user never answered the fourth question. The user can click on it to answer or skip it.

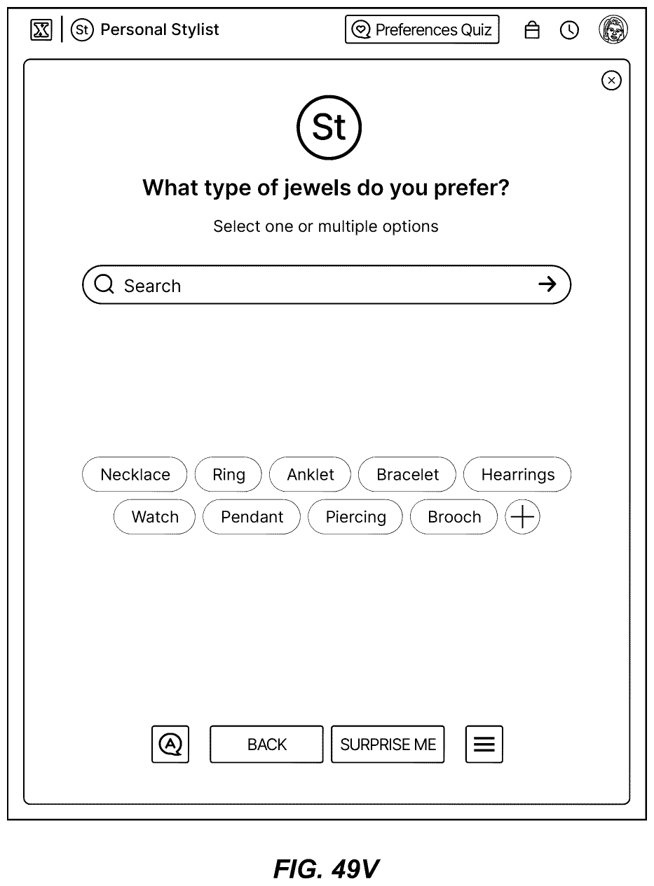

Referring to FIG. 49V, the Personal Stylist asks ‘What type of jewels do you prefer?’ She clicks the button ‘Surprise me’ to give the Personal Stylist the ability to choose for her the item.

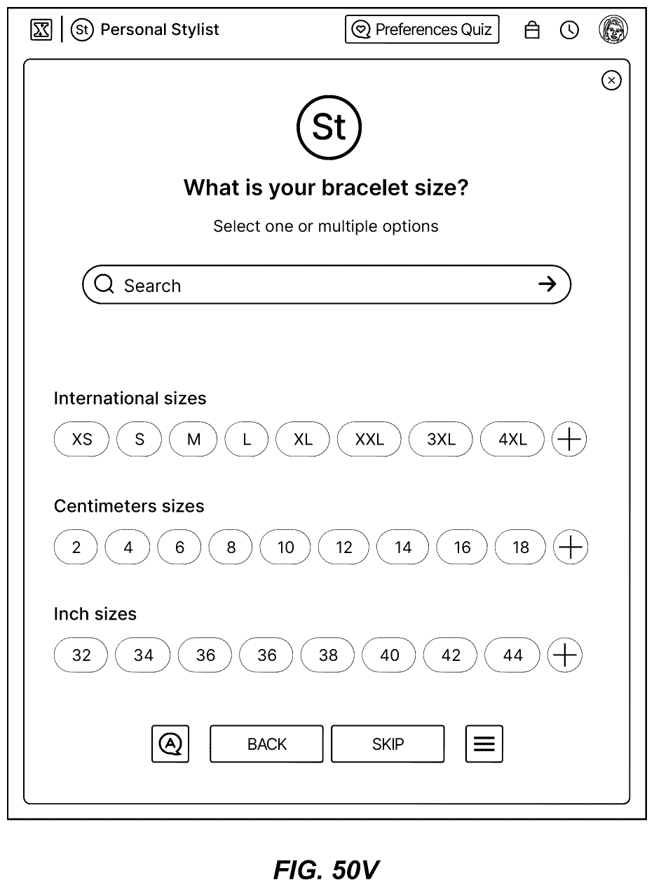

Referring to FIG. 50V, the Personal Stylist asks ‘What is your bracelet size?’

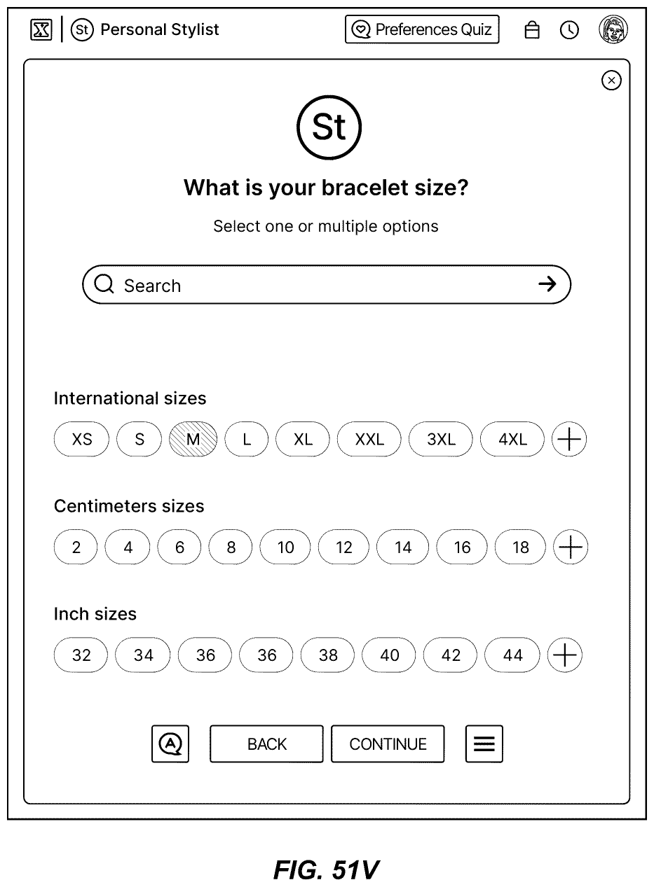

Referring to FIG. 51V, the user selects an option and clicks on the button ‘Continue’ to proceed.

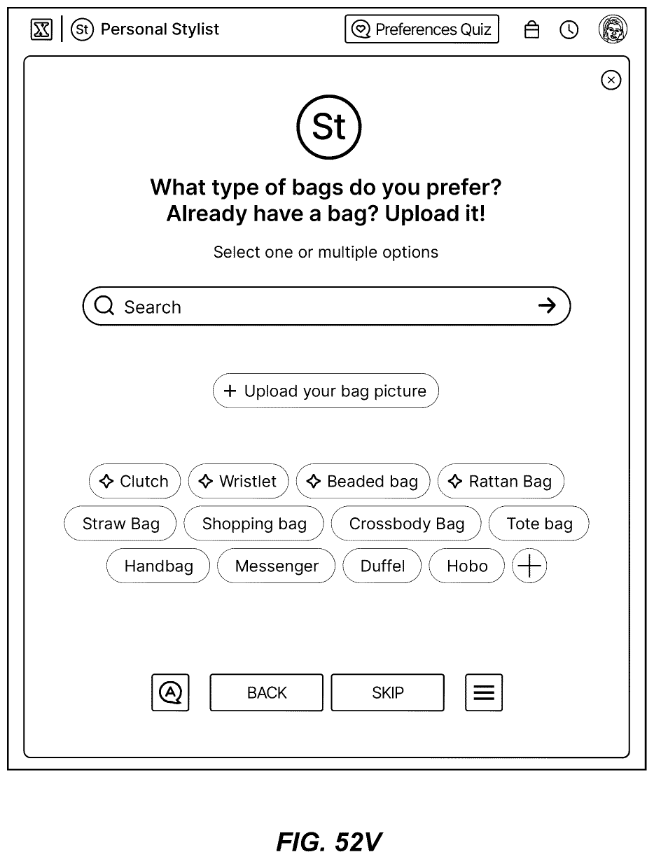

Referring to FIG. 52V, the Personal Stylist asks ‘What type of bags do you prefer?Already have a bag?Upload it!’

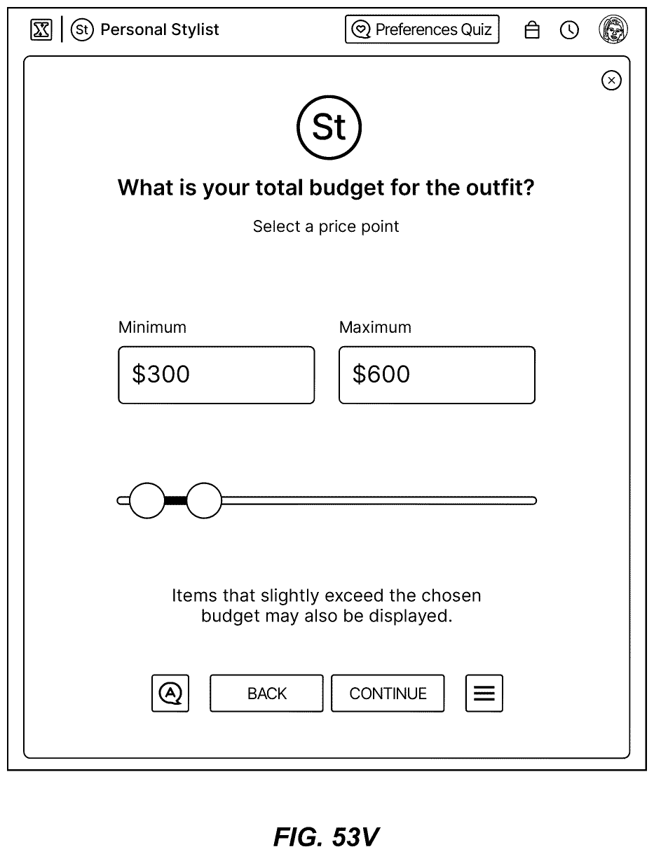

Referring to FIG. 53V, the Personal Stylist asks ‘What is your total budget for the outfit?’ The user selects the range of her budget.

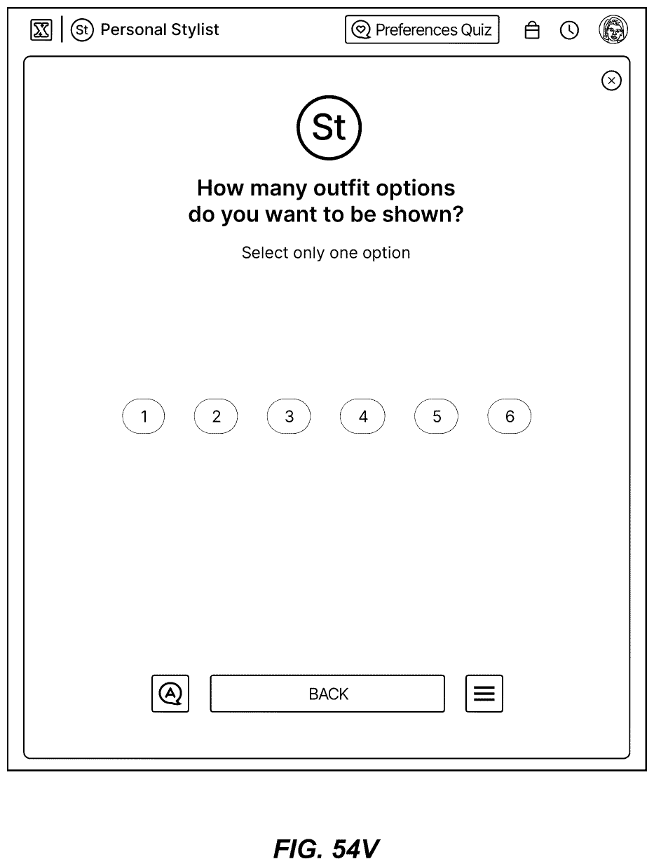

Referring to FIG. 54V, the Personal Stylist asks ‘How many outfit options do you want to be shown?’

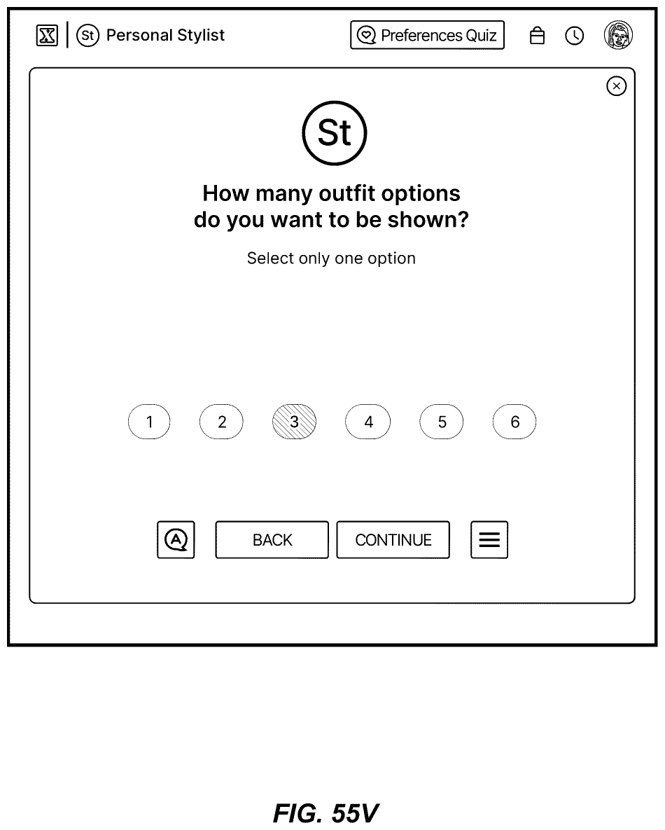

Referring to FIG. 55V, the user selects the option ‘3 outfit options’ and clicks on the button ‘Continue’ to proceed.

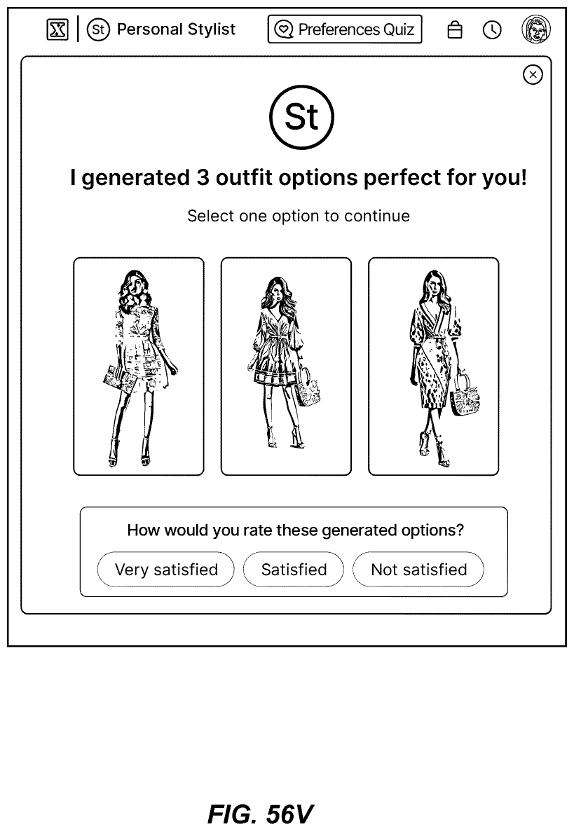

Referring to FIG. 56V, the Personal Stylist generates 3 options of outfits.

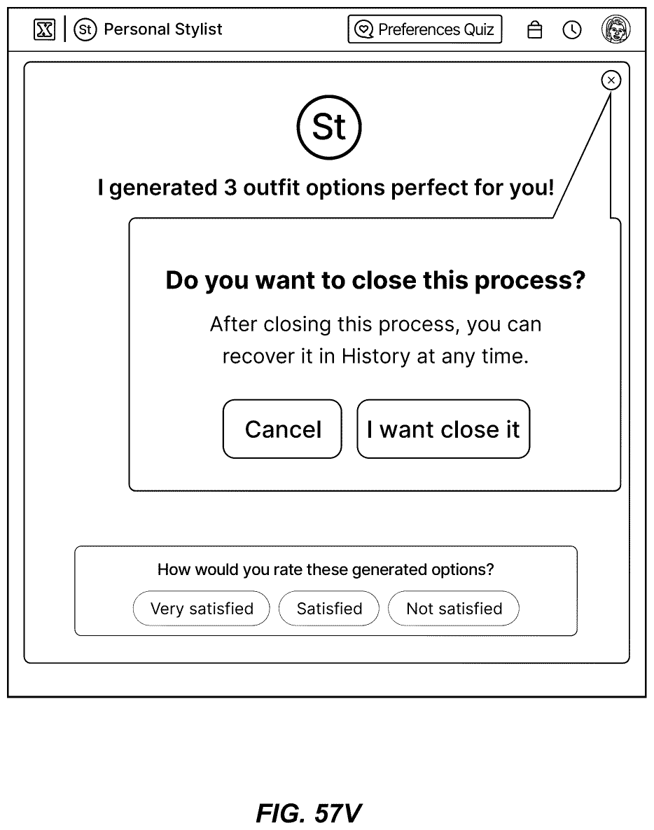

Referring to FIG. 57V, the user clicks the button ‘Close process’ and appears in the detail of a popup to confirm the action.

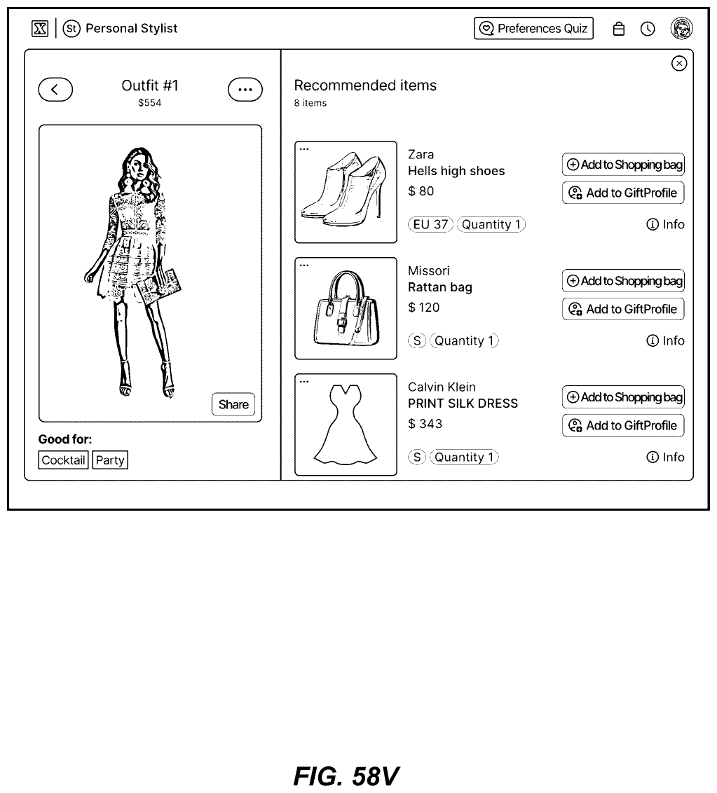

Referring to FIG. 58V, the user clicking on a generated outfits picture opens the dedicated page with the first outfits, the button ‘Share,’ and the label ‘Good for’ that explain for what occasions or context this outfit is great for. On the right side of the screen there is the list of all recommended items with related information and the buttons ‘Add to shopping cart’ and ‘Add to GiftProfile.’

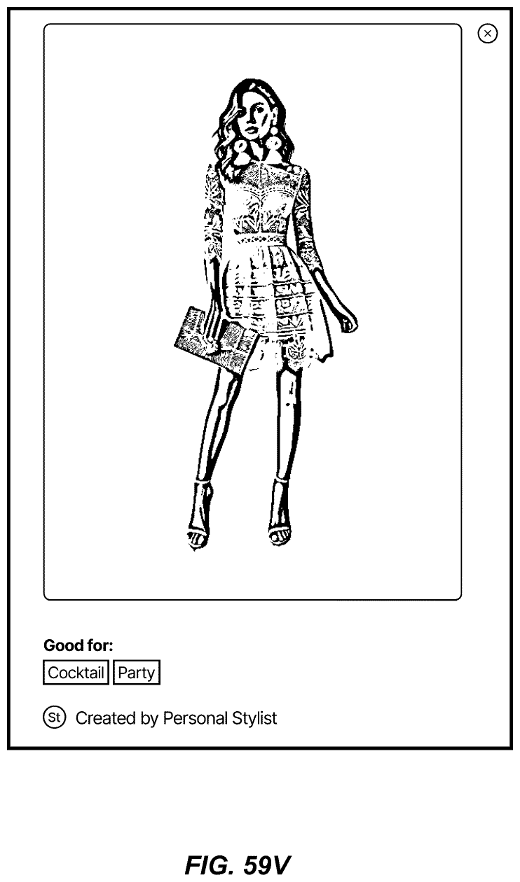

Referring to FIG. 59V, the figure shows the detail of the outfit.

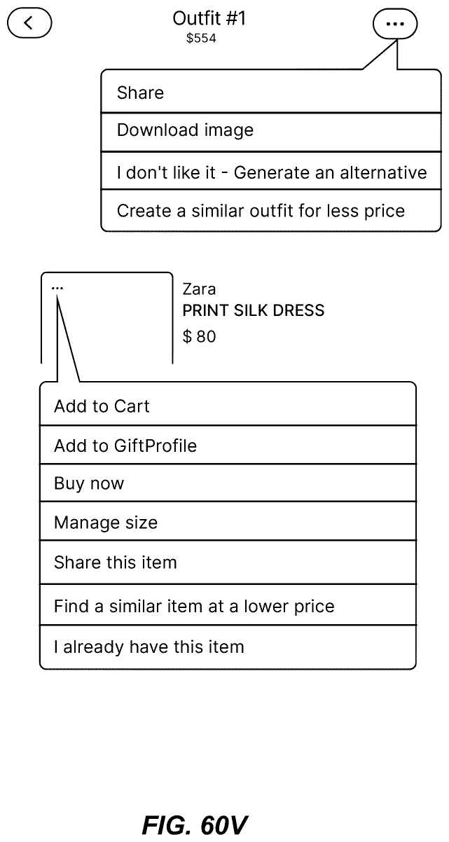

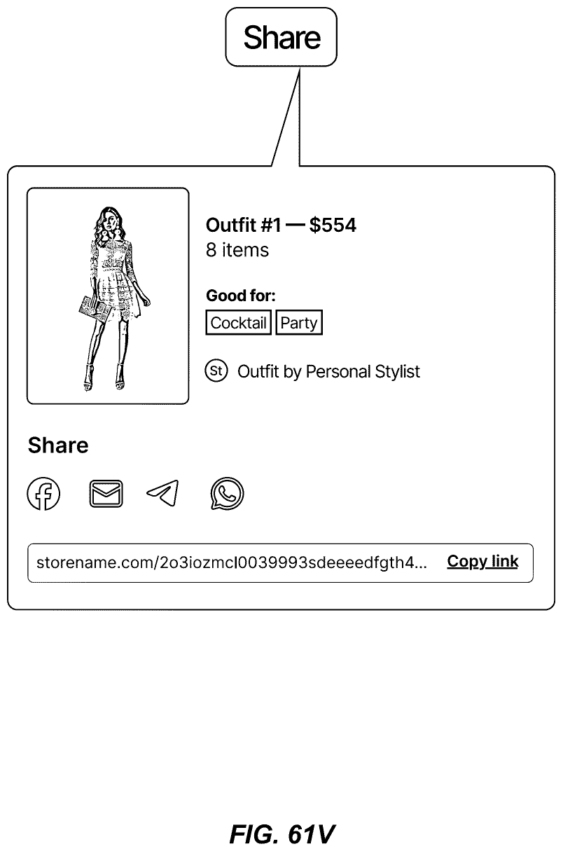

FIGS. 60V-62V show in detail some popup and dropdown with related options to choose.

Outfit with Personal Items

Referring to FIG. 1Z, from the homepage the user selects the option ‘Create an outfit with items you already have’ to create a complete outfit with items the user already has.

Referring to FIG. 2Z, the Personal Stylist asks ‘What items do you already have?’ The user can upload her items.

Referring to FIG. 3Z, the figure shows in detail how the user, clicking the button ‘Upload an item the user already has’ is able to upload the item. It will appear as a form to complete. She can upload the item picture, brand name, item name, size, color and confirm.

Referring to FIG. 4Z, the Personal Stylist asks ‘What occasion and context is the outfit for?’

Referring to FIG. 5Z, the user selects some options and clicks on the button ‘Continue’ to proceed.

Referring to FIG. 6Z, the Personal Stylist asks ‘What is the date of the occasion?’ She selects a date.

Referring to FIG. 7Z, the Personal Stylist asks ‘What is the time of day for the outfit you're looking for?’

Referring to FIG. 8Z, the user selects some options and clicks on the button ‘Continue’ to proceed.

Referring to FIG. 9Z, the Personal Stylist asks ‘Where will you wear the outfit you're looking for?’

Referring to FIG. 10Z, the user selects the venue of the occasion and clicks on the button ‘Continue’ to proceed.

Referring to FIG. 11Z, the Personal Stylist asks ‘What is the dress code for the outfit you're looking for?’

Referring to FIG. 12Z, the user selects some options and clicks on the button ‘Continue’ to proceed.

Referring to FIG. 13Z, the Personal Stylist asks ‘What kind of outfit would you prefer?’

Referring to FIG. 14Z, the user selects some options and clicks on the button ‘Continue’ to proceed.

Referring to FIG. 15Z, the Personal Stylist asks ‘What is your total budget for the outfit?’ The user selects the range of her budget and clicks on ‘Continue’ to proceed.

Referring to FIG. 16Z, the Personal Stylist asks ‘How many outfit options do you want to be shown?’

Referring to FIG. 17Z, the user selects the option ‘3 outfit options’ and clicks on the button ‘Continue’ to proceed.

Referring to FIG. 18Z, the Personal Stylist generates 3 options of outfits.

Referring to FIG. 19Z, the user clicking on a generated outfits picture opens the dedicated page with the first outfits, the button ‘Share,’ and the label ‘Good for’ that explain for what occasions or context this outfit is great for. On the right side of the screen there is the list of all recommended items with related information and the buttons ‘Add to shopping cart’ and ‘Add to GiftProfile.’

Complete Outfit with Prompt

Referring to FIG. 1J, from the homepage the user prompts a request in the main field ‘Generate 3 casual outfits for a cocktail party in Miami this weekend.’ The user clicks the button to send the request.

Referring to FIG. 2J, a process will be opened in a page with dedicated questions to answer or already answered (Sizes or other preferences). The prompt of the user appears on the top of the page. Clicking on that the user can edit the prompt. The Personal Stylist receives the request by the user and answers by mentioning it ‘Sure, let me help you to create 3 casual outfits for a cocktail party in Miami this weekend.’ The Personal Stylist asks ‘What kind of outfit would you prefer?’ The user clicks on the button ‘Search’ to search for an option.’ The user selects an option ‘Dress.’ The user can select other options. The user clicks on the ‘Plus’ button to show a new row of options. The user clicks on ‘Back’ to return back. The user clicks on ‘Continue’ to confirm her choice and proceed to the next question. The user opens the page ‘All questions’ (or named ‘Answered questions’) to open the list of all questions related to the process. Some questions are pre-filled if the Personal Stylist already knows the answer (The user already shared her preferences about sizes, brands, colors or other in previous questionnaires). The user asks something typing a request in the field. The user clicks the button to send the request. The user clicks the button ‘Manage order’ to manage the order of selected options in order of preferences. The user clicks the button ‘Close’ on the top-right side to close the process and return to the homepage. In that case she will be able to recover a continue the process visiting the page ‘History’ by the Nav bar.

Referring to FIG. 3J, the user opens the page ‘All questions’ (or named ‘Answered questions’) to open the list of all questions related to the process. Some questions are pre-filled if the Personal Stylist already knows the answer (The user already shared her preferences about sizes, brands, colors or other in previous questionnaires).

Referring to FIG. 4J, the Personal Stylist asks ‘What type of dress do you prefer?’

Referring to FIG. 5J, the user selects some options and clicks on the button ‘Continue’ to proceed.

Referring to FIG. 6J, the Personal Stylist asks ‘Which dress brands do you prefer?’

Referring to FIG. 7J, the user selects some options and clicks on the button ‘Continue’ to proceed.

Referring to FIG. 8J, the Personal Stylist asks ‘What kind of dress neckline do you prefer?’

Referring to FIG. 9J, the user selects some options and clicks on the button ‘Continue’ to proceed.

Referring to FIG. 10J, the Personal Stylist asks ‘What kind of dress sleeves do you prefer?’

Referring to FIG. 11J, the user selects some options and clicks on the button ‘Continue’ to proceed.

Referring to FIG. 12J, the Personal Stylist asks ‘Do you want to add other details for dresses?’

Referring to FIG. 13J, the user selects some options and clicks on the button ‘Continue’ to proceed.

Referring to FIG. 14J, the Personal Stylist asks ‘Do you want to add other details for dresses?’

Referring to FIG. 15J, the user selects an option and clicks on the button ‘Continue’ to proceed.

Referring to FIG. 16J, the Personal Stylist asks ‘What type of bags do you prefer?Already have a bag?Upload it!’ The user can select one or multiple options, upload a bag that she already has, type a prompt with the answer, or skip it. The user skips the question.

Referring to FIG. 17J, the Personal Stylist asks ‘What is your total budget for the outfit?’ The user selects the range of her budget and clicks on ‘Continue’ to proceed.

Referring to FIG. 18J, the Personal Stylist asks ‘How many outfit options do you want to be shown?’

Referring to FIG. 19J, the user selects the option ‘3 outfit options’ and clicks on the button ‘Continue’ to proceed.

Referring to FIG. 20J, the Personal Stylist generates 3 options of outfits.

Referring to FIG. 21J, the user clicking on a generated outfit picture opens the dedicated page with the first outfits, the button ‘Share’, and the label ‘Good for’ that explain for what occasions or context this outfit is great for. On the right side of the screen there is the list of all recommended items with related information and the buttons ‘Add to shopping cart’ and ‘Add to GiftProfile.’

### Searching Options

Referring to FIG. 1Y, the figure shows in detail that it is possible to search for an option in the field.

Referring to FIG. 2Y, the user selects an option in the dropdown.

Referring to FIG. 3Y, the option appears selected in the list of options.

### Personal Shopper Description

The Personal Shopper will help the user choose items. The user accesses the page to receive purchase assistance from our AI and selects the Personal Shopper for a guide to buying items that are not in the fashion category. The Personal Shopper will choose items that are perfect for the user, based on his/her preferences. The system will suggest the selected product, based on the user's choice, at the best price or with the best quality or both. The Personal Shopper will take into consideration all the above criteria and make suggestions based on them. The system will scrape websites for the selected items that fit the previously mentioned criteria. Users will be able to choose how many options they see. The minimum will be five options.

The requests of this process are basically of two types: primary questions and secondary questions. The primary questions are necessary to understand the user's specific needs (what kind of item the user is looking for), the secondary questions are related to the user's personal information, such as favorite colors for the specific item or delivery address. The secondary questions proposed in this process are related to the options selected in the primary questions. The secondary questions are those that we store in the user's GiftProfile and are basically the same that GiftClub could ask in the Preferences Quiz. Therefore, if the user has already answered a secondary question in the past, this question is no longer proposed because the system already has the answer, which does not tend to vary. However, it is possible to manage the answer by touching ‘Your preferences’, which appear on each process page. We will show on this page the primary preferences selected in the current process and the secondary preferences selected in that specific process+the preferences previously selected by the user and stored in the GiftProfile, which are useful for generating proposals for this specific process (such as favorite colors, favorite brands, etc. . . . ).

Referring to FIG. B1, the user arrives at the Personal Shopper page (FIG. B1). The user selects ‘Personal Shopper.’ The Personal Shopper welcomes the user with the phrase ‘Hi! I'm James, your Personal Shopper. I can help you buy anything. I'll suggest options based on best price, best quality, or a mix of both!—What item are you looking for?’ The user can select one only option, which is mandatory to continue. The user can search for an item. The user taps on the option ‘Mobile device,’ The user taps on the button ‘Continue’ to visit the next page.

Referring to FIG. B2, the user arrives at the next question. The Personal Shopper asks ‘Which mobile device brands do you like?’ The user can select one or more options, which is mandatory to continue the process. The user can search for a brand. The user taps ‘Back’ to visit the previous page. The user selects some brand options. The user taps ‘Continue’ to visit the next page.

Referring to FIG. B3, users can manage preferences chosen in that process and preferences that the system has already collected in the user's GiftProfile. So if the user selects the option ‘Mobile devices’ in that process and the system already knows the user's favorite colors for mobile devices, because in the past the user has already answered these questions, the system will take these preferences into consideration and insert them in the ‘Your preferences’ list of this process so the user can understand what is being taken into consideration and can therefore better manage his/her past preferences.

Users can manage this information by tapping the ‘Edit’ button. All changes are recorded in the GiftProfile. The user can close the page ‘Your preferences.’ The system shows in the list a previous choice, the shipping address (Data collected in GiftProfile). The user has already selected ‘Mobile device’ as an item for that process. The system shows the choice for the favorite brands for mobile devices. The system shows a previous choice, the favorite colors for mobile devices (Data collected in GiftProfile).

Referring to FIG. B4, users can edit the shipping address collected in the GiftProfile. The Personal Shopper asks ‘What is your shipping address?’ The user fills in all requested information-full name and shipping address. The user can add the chosen address to GiftProfile to receive gifts from people. The user taps ‘Cancel’ to close the editing. The user taps ‘Save’ to save the editing.

Referring to FIG. B5, users can select the colors he prefer for the mobile device. The Personal Shopper asks ‘What colors do you like for mobile devices?’ The user can select one or more options. The user can search for mobile devices colors. The user selects some color options. The user taps ‘Cancel’ to close the editing. The user taps ‘Save’ to save the editing.

Referring to FIG. B6, the user arrives at the next question after closing the page managing his/her preferences (see FIG. B3). The Personal Shopper asks ‘What is most important to you?’ The user can select one option, which is mandatory to continue. The user can select ‘Best quality’ or ‘Best price’ or ‘Best quality+Best price.’ The user taps ‘Back’ to visit the previous page. The user selects the option ‘Best quality’+Best price,’ The user taps ‘Continue’ to visit the next page. If the user should choose only ‘Best quality’ or only ‘Best price’ the flow will be the same, only the final results generated according to the options chosen by the user will change.

Referring to FIG. B7, the user arrives at the next question. The Personal Shopper asks ‘How much are you willing to spend?’ The user can select a price point range, which is mandatory to continue the process. The user selects a price point range. The user taps ‘Back’ to visit the previous page. The user taps ‘Continue’ to visit the next page.

Referring to FIG. B8, the Personal Shopper shows a popup alert to inform the user that the price point range is too low for the type of outfit requested. Then a new minimum price point range will be suggested which the user can accept or change. The Personal Shopper says ‘The selected price point range is too low for the chosen item—please change it! Here is a suggested range: A price point range will be suggested, which the user can edit. The user taps ‘Confirm’ to continue the process.

Referring to FIG. B9, the user arrives at the next question. The Personal Shopper asks ‘How many items do you want to be shown?’ The user can select the number, which is mandatory to continue the process. The user selects an option. The user taps ‘Back’ to visit the previous page. The user taps ‘Continue’ to visit the next page.

Referring to FIG. B10, the user arrives at the next page, which is a recap page with a list of all preferences answered in the process, as well as those that are already in the GiftProfile and that are taken into consideration by the AI to better define the options to be generated. The Personal Shopper says ‘Fantastic! I'm going to generate options based on your preferences.’ The chosen shipping address will appear at the top of the page, followed by all the other preferences with an ‘Edit’ button to manage them. The user taps on ‘Generate options’ to confirm the preferences and generate the item proposals.

Referring to FIG. B11, the user arrives at the next page with the list of generated items, which is a list of items chosen according to preferences and matched by the AI system. The user closes the process to return to the service. A confirmation dialog will appear to close the process. The user taps on the first icon ‘Share’ to share the generated proposals on social networks or taps on the circular icon ‘More’ have other options, like ‘Send to someone’ to send someone the items screen in a message/chat via external app. The user scrolls down and sees all the generated items, taps on one of these to open the outfit and visits the page of the singular items. The user taps on the button ‘Actions’ to open the action page. The user taps on the button ‘Actions’ at the bottom of the outfit page and visits the actions page (FIG. B12).

Referring to FIG. B12, the user taps on the button ‘Generate new options’ to generate new options different from those previously generated. The user taps on the button ‘Start a new process’ to delete the generated options and start a new process again. A confirmation dialog will appear to close the process and start a new one. The user taps on the button ‘Cancel’ to close the actions page.

Referring to FIG. B13, the user selects a generated item from the list (FIG. B11) and visits the item page. One or more pictures of the item will be shown with the name of the item, brand, price, options and all info. The Personal Shopper will ask ‘How would you rate this generated option?’ and the user can select one option: ‘Very satisfied’ or ‘Satisfied’ or ‘Not satisfied’. The user then participates in the improvement of the AI system. A periodic questionnaire may be submitted to the user or at the end of some purchases. The user taps ‘Buy now’ to buy the item. The user taps ‘Add to GiftProfile’ to add the item on personal GiftProfile.

### Interior Designer Description

A personal assistant for creating interior design projects for specific residential or commercial rooms, whole houses or whole commercial spaces, outdoor areas and similar is disclosed. The Interior Designer is based on AI and it will be able to create images, designs, videos, 3D content and other types of visual and interactive content with the inclusion of furniture and all other chosen decorative or structural elements. The information acquisition process is based on a series of questions that the user must answer. The Interior Designer AI will be able to process user preferences to create projects and lists of real products to purchase, products included in the generated projects. Purchases are managed by external stores or by Personal X. The company could be part of affiliate programs with third parties. Information acquisition processes generate images, designs and purchase proposals for products in store or on third-party websites, of which the company is part of affiliate programs.

An Interior Designer, as an AI assistant, will be able to create projects of selected spaces, generate projects and visual contents of the selected space and create a list of items to buy. The Personal Interior Designer will take into consideration all of the selected preferences and make suggestions based on them. The system will be able to have a good taste in interior design and create a list of products the user can purchase. Users will be able to choose how many options they see, decide a budget and clone styles, colors or items from one project to another.

### Specific Room

Referring to FIG. C1, the user opens the Personal X app and selects the Interior Designer from the list of all assistants available in the page ‘Assistants.’ From the app, the user arrives at the ‘Assistants’ page and selects ‘Interior Designer’ from the list. The Interior Designer welcome page is opened. A welcome page is opened with a first question to create the right conversation (FIG. C2). The user taps the ‘Close’ button to return to the ‘Assistants’ page (FIG. C1). The user taps the ‘Actions’ button to open the list of possible options that will be ‘Share to someone’ to share the service on social networks or via message to someone, and ‘Read more’ to read more about the service, how the company collects personal data and much more.

Referring to FIG. C2, the Interior Designer says “Hi [User Name], I'm your Interior Designer. I'm here to help you design your spaces! What type of space do you want me to work on? It will be possible to select one only option and selecting the option the next question is automatically shown. The user selects the option ‘Residential’ to start a process for a residential space. The user selects the option ‘Commercial’ to start a process for a commercial space.

Referring to FIG. C3, selecting ‘Residential’ the assistant automatically shows the next question related to that choice. If the user selects the option ‘Commercial’ the process will be very similar to this process, obviously with styles, furniture and other appropriate options to the specific business and commercial context. The system shows the selected option ‘Residential’ at the top of the page. The user taps the ‘Delete’ button to delete the choice ‘Residential’ and the system returns to the previous page to choose one of the two options. The Interior Designer asks “What space do you want me to work on? It will be possible to select one only option and selecting the option the next question is automatically shown. The user selects the option ‘Specific room’ to generate a process for a specific room. The user selects the option ‘Whole house’ to generate a process for a whole house. The user selects the option ‘Outdoor space’ to generate a process for an outdoor space.

Referring to FIG. C4, the user selecting the option ‘Specific room—Choose your preferences and I will generate a project of a specific indoor space and a list of furniture I can buy for you’ will be entered into a process for creating and furnishing a specific room. The process starts as a conversation between the Interior Designer and the user based on questions with options to select or requests to fill. The user taps the ‘Close’ button to return to the ‘Assistant’ page and close the process (see FIG. C1). The user taps the ‘Options’ button to open the list of possible options that will be ‘Share to someone’ to share the service on social networks or via message to someone, and ‘Read more’ to read more about the service, how the company collects personal data and much more. The Interior Designer asks “Great, I'll be working on the specific room. What would you like to renew?”. It will be possible to select one or multiple options. Selecting at least one of the options is mandatory. The system shows 3 options: ‘Remodel space’, ‘Small fixes’ and ‘New furniture’. By selecting the first option the user will ask the Interior Designer to suggest and include in the projects remodeled spaces like new walls, elimination of walls and new flooring. By selecting the second option the user will ask the Interior Designer to suggest and include small fixes in the projects like wall painting, new door knobs, or other small, non-structural changes. By selecting the third option the user will ask the Interior Designer to suggest and include new furniture in the projects. The user taps the ‘Back’ button to return to the previous page.

Referring to FIG. C5, the user selects all the options to completely renovate the room. The user selects the option ‘Remodel space’, the option ‘Small fixes’ and the option ‘New furniture.’ The user taps the ‘Continue’ button to continue the process.

Referring to FIG. C6, during the process it will be possible to close the conversation with the Interior Designer with a tap on the ‘Close’ button (FIG. C4—Arrow n.1), an alert popup will appear automatically. By closing the process, the system shows an alert popup with a message “Do you really want to stop this process?—Returning to the assistants list the process will be stopped. However I will save this process in the History section, you will be able to continue it.” The user taps the ‘Cancel’ button to close the popup and return to the process. The user taps the ‘Stop it’ button to return to the ‘Assistant’ page and close the process (FIG. C1). Closing the process the system will preserve the conversation, which the user can continue by visiting the ‘History’ section. By opening the saved conversation the user will be able to continue the process from where it was closed or simply delete it.

Referring to FIG. C7, in the navigation bar, on the top side of the screen, the user can tap on the ‘Options’ button to open a list of available options. The user taps the ‘Share to someone’ button to share the service on social networks or via message to someone. The user taps the ‘Read more’ button to read more about the service, how the company collects personal data and other info. The user taps the ‘Cancel’ button to close the popup.

Referring to FG. C8, the user can easily share the Personal X app link. By choosing ‘Share to someone’ a popup will be opened. The user taps the ‘Close’ button to close the popup. The system shows a preview of possible recipients, selected based on the latest conversations, via external services. The user taps the ‘Share via Message’ button to share the app link via default message service. The user taps the ‘Share via Email’ button to share the app link via email. The user taps the ‘Share on Facebook’ button to share the app link on the social network. The user taps the ‘Share on Whatsapp’ button to share the app link via message.

Referring to FIG. C9, the user can easily read more about the Personal X services. By choosing ‘Read more’ a popup will be opened. The user taps the ‘Close’ button to close the popup. Visual and textual contents appear to explain the Interior Designer service, how it works, what it can generate, what it can suggest, some project examples, and other info.

Referring to FIG. C10, the user reaches the next request by tapping the ‘Continue’ button (FIG. C5). The Interior Designer asks “What will be the intended use of this room?” It will be possible to select one only option. Selecting at least one option is mandatory. The user searches for an option to select, writing a text or dictating. The Interior Designer shows some options (List #1—Room intent of use, included in Appendix A). In all pages the user can tap on the ‘Your preferences’ button to open the list of all the questions and answers given previously, and the personal preferences considered in the process, taken from the GiftProfile. The user taps the ‘Back’ button to return to the previous page.

Referring to FIG. C11, the user selects an option. The user selects the option ‘Bedroom’. The intent of use for the room will be bedroom. The user taps the ‘Continue’ button to continue the process.

Referring to FIG. C12, by tapping the ‘Continue’ button the user reaches the next request. The Interior Designer asks “Where is the building located and what geographical orientation does this room have?”. The user can skip the question. The Interior Designer shows the location field, the user can add ‘City’ and ‘Zip code.’ The Interior Designer shows the orientation options (North, South, East, West). The user taps the ‘Back’ button to return to the previous page. The user taps the ‘Skip’ button to skip the question.

Referring to FIG. C13, the user fills all the requests. The user fills the location fields, by entering the city and the zip code where the room in question is located. The user selects the orientation of the room ‘North’ and ‘East’, the room is north-east oriented. The user taps the ‘Continue’ button to continue the process.

Referring to FIG. C14, by tapping the ‘Continue’ button the user reaches the next request. The Interior Designer asks “Who will use this room?”. It will be possible to select one or multiple options. Selecting at least one option is mandatory. The user searches for an option to select, writing a text or dictating. The Interior Designer shows a list of options to select. (List #4—Users of the spaces, included in Appendix A). The order of the options can be random or based on trends (the ones most chosen by other users are at the top compared to the less popular ones). The user taps the ‘Back’ button to return to the previous page.

Referring to FIG. C15, the user selects some options. The user selected the options ‘Me’ and ‘Partner.’ The user taps the ‘Continue’ button to continue the process.

Referring to FIG. C15, if the user chooses some options, a popup may appear to better specify a type or quantity. The user selected ‘Pets’ as an option, so the system shows a popup to better specify the type of pet and quantity. The user taps on the ‘Add’ button on the top-right side of the popup to add a new type of pet and the related quantity. The user selects the type of pet as ‘Dog.’ The user selects the quantity of ‘Dog’, typing ‘2.’ The user taps the ‘Confirm’ button to proceed. The user taps the ‘Skip’ button to skip the question.

Referring to FIG. C17, if the user selects as user of the room someone the AI system will ask to search for his Profile or GiftProfile so that he can also include his general preferences in the project or in the case in which the system already knows the relationship that unites the user with the selected person, in this case his partner, it could automatically recognize the Profile or GiftProfile and suggest to approve the inclusion of his preferences. If the user and his partner prefer the color ‘Sage Green’, with the approval of his partner's preferences inclusion the system will know that ‘Sage Green’ would almost certainly be the perfect color to suggest in the final room project. In a popup the Interior Designer shows the found user (the system recognized as partner Brian Kool, considering his GiftProfile and the relationship the user has with him) and asks: “Do you want to include this user's preferences?—Including all user's preferences can have a positive impact on the final proposals to be the best choice for you and this user, however I will consider your preferences as a priority. I will suggest some options that this person might also like.” The user taps the ‘Accept’ button to accept the request. The user taps the ‘Skip’ button to skip the request.

Referring to FIG. C18, by tapping the ‘Continue’ button the user reaches the next request about the hobbies of the people who will use this room. The Interior Designer asks “What are your hobbies?” It will be possible to select one or multiple options. The user can skip the question. In this case the question concerns the user's hobbies (He had selected ‘Me’ as the user of the room). Automatically, having confirmed the use of the partner's preferences, the AI system will consider the partner's hobbies in the final processing, this user having already previously answered this question in the Preferences Quiz for his GiftProfile. If the user had selected ‘Daughter’ the system would then have asked for the children's hobbies. The user searches for an option to select, writing a text or dictating. The Interior Designer shows some options (List #5—Hobbies, included in Appendix A). The user taps the ‘Back’ button to return to the previous page. The user taps the ‘Skip’ button to skip the request.

Referring to FIG. C19, the user can choose some options. The user selects the options ‘Photography’ and ‘Music’. This choice will be stored in the user's GiftProfile as his primary personal preference and of course used to that process too. The user taps the ‘Continue’ button to continue the process.

Referring to FIG. C20, by tapping the ‘Continue’ button the user reaches the next request. The Interior Designer asks “To proceed, please do a 3D scan and upload the floor plan of your room”. The first request is mandatory, the second is optional. The user taps the ‘Room 3D scan’ button to start a scan of the room. The user taps the ‘Room Floor Plan’ button to upload a picture of the room flooring. The user taps the ‘Back’ button to return to the previous page.

Referring to FIG. C21, the user completes all requests. The user completed a room 3D scan. The user taps the ‘Delete’ button to delete the room 3D scan generated content. The user taps the ‘Open preview’ button to open a preview of the 3D scanned room. The user uploaded a file about the room floor plan. The user taps the ‘Delete’ button to delete the uploaded file about the room floor plan. The user taps the ‘Open preview’ button to open a preview of the uploaded file about the room floor plan. The user taps the ‘Continue’ button to continue the process.

Referring to FIG. C22, as requested by the Interior Designer, the user starts a ‘Room 3D Scan’. The app automatically will open the mobile camera and the user can scan the room following the guidance. The user taps the ‘Close’ button to close the scan page. The user taps the ‘Confirm’ button to confirm the completed scan of the room. The system recognizes specific room's area, objects or spaces to help the user to complete the scan. A geometric shape will appear on the screen as a guide for the user, advising to move the phone at certain positions or angles. The mobile camera shows the scene in real time. The system shows a preview of the scanned areas and objects. A progress bar notifies the user if there are enough scanned parts for the project. A red signal will indicate that the scanned areas are not enough, a yellow signal will indicate that the scanned areas are sufficient but it is weak, a green signal will indicate that the scanned areas fully satisfy the request.

Referring to FIG. C23, the user reaches the next request by tapping the ‘Continue’ button (FIG. C21). The Interior Designer informs the user that the options with the ‘Magic Star’ symbol are suggested options because the partner, another user of the room, has previously expressed that he prefers those options indicated, in this case the specific style ‘Shabby chic’, which the user is free to select. In some cases the AI system openly signals the user with suggested options with a specific symbol, in this case a ‘Magic Star’. They are options suggested based on previous choices or preferences of other users who have been included in the process. The Interior Designer asks “What style do you have in mind for this room?” It will be possible to select one or multiple options. The user can skip the question. The user searches for an option to select, writing a text or dictating. The Interior Designer shows some options (List #6—Design Styles, included in Appendix A). All suggested options have the ‘Magic Star’ icon. The user taps the ‘Back’ button to return to the previous page. The user taps the ‘Skip’ button to skip the request.

Referring to FIG. C24, the user selects some options. The user selects the options ‘Industrial’ and ‘Minimalistic.’ The user taps the ‘Continue’ button to continue the process.

Referring to FIG. C25, by tapping the ‘Continue’ button the user reaches the next request. The Interior Designer asks “How would you like to remodel this space?”. It will be possible to select one or multiple options. Selecting at least one option is mandatory. The Interior Designer shows the options ‘Breaking walls’, ‘Build walls’ and ‘Change flooring.’ The user taps the ‘Back’ button to return to the previous page.

Referring to FIG. C26, the user selects an option. The user selects the option ‘Change flooring.’ The user taps the ‘Continue’ button to continue the process.

Referring to FIG. C27, by tapping the ‘Continue’ button the user reaches the next request. The Interior Designer asks “What type of floor would you like?” It will be possible to select one or multiple options. The user can skip the question. The user searches for an option to select, writing a text or dictating. The Interior Designer shows some options (List #2—Floor types, included in Appendix A). The order of the options can be random or based on trends (the ones most chosen by other users are at the top compared to the less popular ones). The user taps the ‘Back’ button to return to the previous page. The user taps the ‘Skip’ button to skip the request.

Referring to FIG. C28, the user selects some options. The user selects the options ‘Tile’ and ‘Parquet.’ The user taps the ‘Continue’ button to continue the process.

Referring to FIG. C29, by tapping the ‘Continue’ button the user reaches the next request. The Interior Designer asks “What material of tile flooring would you like?” It will be possible to select one or multiple options. The user can skip the question. The user searches for an option to select, writing a text or dictating. The Interior Designer shows some options (List #12—Materials for tile flooring, included in Appendix A). The user taps the ‘Back’ button to return to the previous page. The user taps the ‘Skip’ button to skip the request.

Referring to FIG. C30, the user selects an option. The user selects the option ‘Ceramic.’ The user taps the ‘Continue’ button to continue the process.

Referring to FIG. C31, by tapping the ‘Continue’ button the user reaches the next request. The Interior Designer asks “What type of pattern for tile flooring would you like?” It will be possible to select one or multiple options. The user can skip the question. The user searches for an option to select, writing a text or dictating. The Interior Designer shows some options (List #10—Patterns for tile flooring, included in Appendix A). The user taps the ‘Back’ button to return to the previous page. The user taps the ‘Skip’ button to skip the request.

Referring to FIG. C32, the user selects an option. The user selects the options ‘Grid pattern’ and ‘Chevron pattern.’ The user taps the ‘Continue’ button to continue the process.

Referring to FG. C33, by tapping the ‘Continue’ button the user reaches the next request. The Interior Designer asks “Which material do you prefer for the parquet floor?”. It will be possible to select one or multiple options. The user can skip the question. The user searches for an option to select, writing a text or dictating. The Interior Designer shows some options (List #13—Materials for parquet flooring, included in Appendix A). The user taps the ‘Back’ button to return to the previous page. The user taps the ‘Skip’ button to skip the request.

Referring to FIG. C34, the user selects some options. The user selects the options ‘Walnut’ and ‘Cherry.’ The user taps the ‘Continue’ button to continue the process.

Referring to FG. C35, by tapping the ‘Continue’ button the user reaches the next request. The Interior Designer asks “What type of pattern for the parquet floor would you like?” It will be possible to select one or multiple options. The user can skip the question. The user searches for an option to select, writing a text or dictating. The Interior Designer shows some options (List #11—Patterns for parquet flooring, included in Appendix A). The user taps the ‘Back’ button to return to the previous page. The user taps the ‘Skip’ button to skip the request.

Referring to FIG. C36, the user selects an option. The user selects the option ‘Chevron.’ The user taps the ‘Continue’ button to continue the process.

Referring to FIG. C37, by tapping the ‘Continue’ button the user reaches the next request. The Interior Designer asks “What would you like to do specifically as small fixes for the bedroom?”. It will be possible to select one or multiple options. Selecting at least one option is mandatory. The user searches for an option to select, writing a text or dictating. The Interior Designer shows some options (List #3—Small fixes, included in Appendix A). The user taps the ‘Back’ button to return to the previous page.

Referring to FIG. C38, the user selects some options. The user selects the options ‘Door knobs,’ ‘Painting walls,’ and ‘Lighting.’ The user taps the ‘Continue’ button to continue the process.

Referring to FIG. C39, by tapping the ‘Continue’ button the user reaches the next request. The Interior Designer asks “What finishes do you have in mind for door knobs?” It will be possible to select one or multiple options. The user can skip the question. The user searches for an option to select, writing a text or dictating. The Interior Designer shows some options (List #9—Finishes for door knobs, included in Appendix A). The user taps the ‘Back’ button to return to the previous page. The user taps the ‘Skip’ button to skip the request.

Referring to FIG. C40, the user selects an option. The user selects the option ‘Metallic finishes.’ The user taps the ‘Continue’ button to continue the process.

Referring to FIG. C41, by tapping the ‘Continue’ button the user reaches the next request. The Interior Designer asks “What metallic colors do you have in mind for door knobs?” It will be possible to select one or multiple options. The user can skip the question. The user searches for an option to select, writing a text or dictating. The Interior Designer shows some options (List #14—Colors for metallic door knobs, included in Appendix A). The user taps the ‘Back’ button to return to the previous page. The user taps the ‘Skip’ button to skip the request.

Referring to FIG. C42, the user selects some options. The user selects the options ‘Matte Black,’ ‘Venetian Bronze,’ and ‘Brushed Nickel.’ The user taps the ‘Continue’ button to continue the process.

Referring to FIG. C43, by tapping the ‘Continue’ button the user reaches the next request. The Interior Designer asks “What colors do you have in mind for the walls of this room?” It will be possible to select primary, secondary and tertiary colors. The choice of primary and secondary colors is mandatory, the choice of tertiary colors is optional. The user selects the list of primary colors. The user selects the list of secondary colors. The user taps the ‘Back’ button to return to the previous page. The user taps the ‘Continue’ button to continue the process.

Referring to FIG. C44, with a tap on the ‘Manage’ button for the primary, secondary, or tertiary color fields a popup is opened to search and/or select colors. The popup to manage the secondary colors is opened. The user can select one or multiple options. The user searches for an option to select, writing a text or dictating. The user selects the options ‘Ivory’ and ‘Navajo white.’ The user taps the ‘Confirm’ button to confirm the choice.

Referring to FIG. C45, by tapping the ‘Continue’ button (FIG. C43) the user reaches the next request. The Interior Designer asks “What type of wall finishes would you like for this room?” It will be possible to select one or multiple options. The user can skip the question. The user searches for an option to select, writing a text or dictating. The Interior Designer shows some options (List #18—Wall finishes, included in Appendix A). The user taps the ‘Back’ button to return to the previous page. The user taps the ‘Skip’ button to skip the request.

Referring to FIG. C46, the user selects some options. The user selects the options ‘Paint,’ ‘Wallpaper,’ and ‘Panels.’ The user taps the ‘Continue’ button to continue the process.

Referring to FIG. C47, by tapping the ‘Continue’ button the user reaches the next request. The Interior Designer asks “What type of wall paint finishes would you like for this room?” It will be possible to select one or multiple options. The user can skip the question. The user searches for an option to select, writing a text or dictating. The Interior Designer shows some options (List #19—Paint finishes for walls, included in Appendix A). The user taps the ‘Back’ button to return to the previous page. The user taps the ‘Skip’ button to skip the request.

Referring to FIG. C48, the user selects some options. The user selects the options ‘Flat’ and ‘Satin.’ The user taps the ‘Continue’ button to continue the process.

Referring to FG. C49, by tapping the ‘Continue’ button the user reaches the next request. The Interior Designer asks “What type of wallpaper for walls would you like for this room?” It will be possible to select one or multiple options. The user can skip the question. The user searches for an option to select, writing a text or dictating. The Interior Designer shows some options (List #20—Wallpapers for walls, included in Appendix A). The user taps the ‘Back’ button to return to the previous page. The user taps the ‘Skip’ button to skip the request.

Referring to FIG. C50, the user selects some options. The user selects the options ‘Non-woven,’ ‘Geometric,’ and ‘Vintage.’ The user taps the ‘Continue’ button to continue the process.

Referring to FIG. C51, by tapping the ‘Continue’ button the user reaches the next request. The Interior Designer asks “What type of wall paneling do you like for this room?” It will be possible to select one or multiple options. The user can skip the question. The user searches for an option to select, writing a text or dictating. The Interior Designer shows some options (List #22—Panels for walls, included in Appendix A). The user taps the ‘Back’ button to return to the previous page. The user taps the ‘Skip’ button to skip the request.

Referring to FIG. C52, the user selects some options. The user selects the options ‘3D panels,’ ‘Wooden panels,’ and ‘Shiplap panels.’ The user taps the ‘Continue’ button to continue the process.

Referring to FIG. C53, by tapping the ‘Continue’ button the user reaches the next request. The Interior Designer asks “What type of ceiling finishes do you like for this room?” It will be possible to select one or multiple options. The user can skip the question. The user searches for an option to select, writing a text or dictating. The Interior Designer shows some options (List #23—Ceiling finishes, included in Appendix A). The user taps the ‘Back’ button to return to the previous page. The user taps the ‘Skip’ button to skip the request.

Referring to FIG. C54, the user selects an option. The user selects the option ‘Orange Peel.’ The user taps the ‘Continue’ button to continue the process.

Referring to FIG. C55, by tapping the ‘Continue’ button the user reaches the next request. The Interior Designer asks “Do you have particular needs on building materials for painting or wall panels?” It will be possible to select one or multiple options. The user can skip the question. The user searches for an option to select, writing a text or dictating. The Interior Designer shows some options (List #24—Special types of building materials, included in Appendix A). The user taps the ‘Back’ button to return to the previous page. The user taps the ‘Skip’ button to skip the request.

Referring to FIG. C56, the user selects some options. The user selects the options ‘Solvent free,’ ‘Anti-Condensation,’ and ‘Fire-Retardant.’ The user taps the ‘Continue’ button to continue the process.

Referring to FIG. C57, by tapping the ‘Continue’ button the user reaches the next request about the small fixes. The Interior Designer asks “What type of ceiling lighting do you like for this room?” It will be possible to select one or multiple options. The user can skip the question. The user searches for an option to select, writing a text or dictating. The Interior Designer shows some options (List #25—Ceiling lighting, included in Appendix A). The user taps the ‘Back’ button to return to the previous page. The user taps the ‘Skip’ button to skip the request.

Referring to FIG. C58, the user selects all options in one action. The user taps the ‘All options’ button to select all options. This means that all options are worth considering. Obviously in some cases it will not be possible to apply all the options chosen for a single project, but the system will do its best to apply them all. In fact the question specifically asks ‘What would you like . . . ’ and not ‘What do you absolutely want to include . . . ’. The user taps the ‘Continue’ button to continue the process.

Referring to FIG. C59, by tapping the ‘Continue’ button the user reaches the next request. The Interior Designer asks “What type of wall lighting do you like for this room?” It will be possible to select one or multiple options. The user can skip the question. The user searches for an option to select, writing a text or dictating. The Interior Designer shows some options (List #26—Wall lighting, included in Appendix A). The user taps the ‘Back’ button to return to the previous page. The user taps the ‘Skip’ button to skip the request.

Referring to FIG. C60, the user selects some options. The user selects the option ‘Directional light.’ The user taps the ‘Continue’ button to continue the process.

Referring to FIG. C61, by tapping the ‘Continue’ button the user reaches the next request. The Interior Designer asks “Do you want recommendations for artworks?” It will be possible to select one only option. Selecting at least one option is mandatory. The Interior Designer shows the ‘Yes’ and ‘No’ options. The user taps the ‘Back’ button to return to the previous page.

Referring to FIG. C62, the user selects an option. The user selects the option ‘Yes.’ The user taps the ‘Continue’ button to continue the process.

Referring to FG. C63, by tapping the ‘Continue’ button the user reaches the next request. The Interior Designer asks “What type of artworks do you like for this room?” It will be possible to select one or multiple options. The user can skip the question. The user searches for an option to select, writing a text or dictating. The Interior Designer shows some options (List #27—Artworks, included in Appendix A). The user taps the ‘Back’ button to return to the previous page. The user taps the ‘Skip’ button to skip the request.

Referring to FIG. C64, the user selects an option. The user selects the option ‘Oil Painting.’ The user taps the ‘Continue’ button to continue the process.

Referring to FIG. C65, by tapping the ‘Continue’ button the user reaches the next request about the furniture. The Interior Designer says “Upload images of any furniture you have or large items and want to keep to use in your new design.” The user taps the ‘Item #1—Upload’ button to upload the picture of the first item that he has in the room but that he wants to leave and not replace. The user can upload a maximum of 10 pictures of objects and furniture he wants to keep. The user taps the ‘Back’ button to return to the previous page. The user taps the ‘Skip’ button to skip the request.

Referring to FIG. C66, the user uploads some pictures (FIG. C66). The user uploads the picture of the first item ‘lamp.png’ renaming this element as ‘FLOS lamp purple.’ The user uploads the picture of a second item ‘picture1.png’ renaming this element as ‘Desk Ikea.’ The user uploads the picture of a third item ‘picture34.png’ renaming this element as ‘Armchair FRAU beige.’ The AI system will incorporate these images into the projects, while also endeavoring to identify and suggest new objects and furniture that works well, aesthetically and functionally, with the uploaded items. The user taps the ‘Delete’ button to delete the uploaded element. The user taps the ‘Continue’ button to continue the process.

Referring to FG, C67, by tapping the ‘Continue’ button the user reaches the next request. The Interior Designer asks “What furniture brands do you like for this room?” It will be possible to select one or multiple options. The user can skip the question. The user searches for an option to select, writing a text or dictating. The Interior Designer shows some options (List #28—Furniture brands, included in Appendix A). The user taps the ‘Back’ button to return to the previous page. The user taps the ‘Skip’ button to skip the request.

Referring to FIG. C68, the user selects some options. The user selects the options ‘Herman Miller’ and ‘Maison du Monde.’ The user taps the ‘Continue’ button to continue the process.

Referring to FG. C69, by tapping the ‘Continue’ button the user reaches the next request. The Interior Designer asks “What colors do you have in mind for the furniture of this room?” It will be possible to select one or multiple options. The user can skip the question. The user searches for an option to select, writing a text or dictating. The Interior Designer shows some options of colors for furniture. The user taps the ‘Back’ button to return to the previous page. The user taps the ‘Skip’ button to skip the request.

Referring to FIG. C70, the user selects some options. The user selects the options ‘Navy Blue,’ ‘Camel,’ and ‘Warm Grey.’ The user taps the ‘Continue’ button to continue the process.

Referring to FIG. C71, by tapping the ‘Continue’ button the user reaches the next request. The Interior Designer asks “What material do you prefer for the furniture?” It will be possible to select one or multiple options. The user can skip the question. The user searches for an option to select, writing a text or dictating. The Interior Designer shows some options. The user taps the ‘Back’ button to return to the previous page. The user taps the ‘Skip’ button to skip the request.

Referring to FIG. C72, the user selects an option. The user selects the option ‘Wood.’ The user taps the ‘Continue’ button to continue the process.

Referring to FIG. C73, by tapping the ‘Continue’ button the user reaches the next request. The Interior Designer asks “What type of bed do you prefer?’ It will be possible to select one or multiple options. The user can skip the question. The Interior Designer shows some options. The user can select the ‘All options’ to select all available options. The user selects the ‘King size bed’ option (List #40—Type of bed, included in Appendix A). The user taps the ‘Back’ button to return to the previous page. The user taps the ‘Continue’ button to continue the process.

Referring to FIG. C74, by tapping the ‘Continue’ button the user reaches the next request. The user selects the option ‘Yes’. The Interior Designer will therefore follow the rules of the Feng-Shui discipline, which mainly concerns the position of the furniture in the room and other specific indications. The Interior Designer shows the ‘Yes’ and ‘No’ options. The user selects the ‘Yes’ option to include the Feng-Shui discipline. The user taps the ‘Back’ button to return to the previous page. The user taps the ‘Continue’ button to continue the process.

Referring now to FIG. C106, by tapping the ‘Continue’ button the user reaches the next request about the possibility to express specific preferences for objects to add. The Interior Designer asks “Do you also want to express specific preferences for other objects that I will include in this bedroom?” The user can select one only option. Selecting at least one option is mandatory. The user selects the ‘Yes, I want option’. The user taps the ‘Back’ button to return to the previous page. The user taps the ‘Continue’ button to continue the process.

Referring to FIG. C107, by tapping the ‘Continue’ button the user reaches the next request. The user can select what kind of objects for the selected room he wants to control in terms of preferences. The Personal Interior Designer as an AI has developed his personal taste and has learned to know the user over time, so he will still be able to recommend the right products for the selected styles and preferences of the user. However, the Interior Designer offers the possibility for the user to independently manage his preferences on certain specific objects. The user will then have the possibility to ask the Interior Designer to add specific objects such as appliances, accessories, specific decorations, curtains, cushions, sofas and much more. On what he selects, the Interior Designer will create further specific questions for the chosen options to fully understand the user's tastes. The skill of the Interior Designer will be to match the user's tastes, direct requests with styles and moods in an appropriate way.

The Interior Designer asks “Fine! What are the objects that you absolutely want me to include in the room?” The user can select one or multiple options. Selecting at least one option is mandatory. The user searches for an option. The user selects the options ‘Armchairs’ and ‘Curtains’. He therefore wants these objects to be absolutely included in the final projects and wants to take control of the specifications. The user taps the ‘Continue’ button to continue the process.

Referring to FIG. C108, by tapping the ‘Continue’ button the user reaches the next request about the selected options, to understand the user preferences about ‘Armchairs’ and ‘Curtains.’ The user taps the ‘Close’ icon to close the chat process and return to the homepage. The Interior Designer asks “What types of armchairs do you like for this room?”. The user can select one or multiple options. The user can skip the question and the Interior Designer will choose for him. The user searches for an option. The system shows some possible options to select (List #43—Type of armchairs, included in Appendix A). The user selects the ‘Chesterfield’ option. The user taps the ‘Back’ button to return to the previous page. The user taps the ‘Continue’ button to continue the process.

Referring to FIG. C109, by tapping the ‘Continue’ button the user reaches the next request. The Interior Designer asks “What materials do you like for the armchairs of this room?” The user can select one or multiple options. The user can skip the question and the Interior Designer will choose for him. The user searches for an option. The system shows some possible options to select (List #42—Materials for sofa/armchairs, included in Appendix A). The user selects the ‘Leather’ option. The user taps the ‘Back’ button to return to the previous page. The user taps the ‘Continue’ button to continue the process.

Referring to FIG. C110, by tapping the ‘Continue’ button the user reaches the next request. The user taps the ‘Close’ icon to close the chat process and return to the homepage. The Interior Designer asks “What colors for armchairs do you like?” The user can select one or multiple options. The user can skip the question and the Interior Designer will choose for him. The user searches for an option. The system shows some possible options to select. The user taps the ‘Back’ button to return to the previous page. The user taps the ‘Skip’ button to skip the question and continue the process. The Interior Designer will choose the appropriate colors for the armchair for the projects.

Referring to FIG. C111, by tapping the ‘Continue’ button the user reaches the next request. The Interior Designer asks “What brands for armchairs do you like?” The user can select one or multiple options. The user can skip the question and the Interior Designer will choose for him. The user searches for an option. The system shows some possible options to select. The user taps the ‘Back’ button to return to the previous page. The user taps the ‘Skip’ button to skip the question and continue the process. The Interior Designer will choose the appropriate brands for the armchair for the projects.

Referring to FIG. C112, by tapping the ‘Continue’ button the user reaches the next request. The user taps the ‘Close’ icon to close the chat process and return to the homepage. The Interior Designer asks “What types of curtains do you like for this room?” The user can select one or multiple options. The user can skip the question and the Interior Designer will choose for him. The user searches for an option. The system shows some possible options to select (List #39—Type of curtains, included in Appendix A). The user taps the ‘Back’ button to return to the previous page. The user taps the ‘Skip’ button to skip the question and continue the process. The Interior Designer will choose the appropriate types of curtains for the projects.

Referring to FIG. C113, by tapping the ‘Continue’ button the user reaches the next request. The Interior Designer asks “What materials for curtains do you like for this room?” The user can select one or multiple options. The user can skip the question and the Interior Designer will choose for him. The user searches for an option. The system shows some possible options to select (List #31—Curtain fabrics, included in Appendix A). The user taps the ‘Back’ button to return to the previous page. The user taps the ‘Continue’ button to continue the process.

Referring to FIG. C114, by tapping the ‘Continue’ button the user reaches the next request. The user taps the ‘Close’ icon to close the chat process and return to the homepage. The Interior Designer asks “What colors for curtains do you like for this room?” The user can select one or multiple options. The user can skip the question and the Interior Designer will choose for him. The user searches for an option. The system shows some possible options to select. The user taps the ‘Back’ button to return to the previous page. The user taps the ‘Skip’ button to skip the question and continue the process. The Interior Designer will choose the appropriate colors for curtains for the projects.

Referring to FIG. C115, by tapping the ‘Continue’ button the user reaches the next request. The Interior Designer asks “What brands for curtains do you like for this room?” The user can select one or multiple options. The user can skip the question and the Interior Designer will choose for him. The user searches for an option. The system shows some possible options to select. The user taps the ‘Back’ button to return to the previous page. The user taps the ‘Skip’ button to skip the question and continue the process. The Interior Designer will choose the appropriate brands for curtains for the projects.

Referring now to FIG. C75, by tapping the ‘Continue’ button the user reaches the next request. The Interior Designer asks “How much are you willing to spend for remodel space and for small fixes?” The user can swipe the bar to select the price point or select the Min. (minimal amount) or Max (maximum amount) fields to manually add the specific amount (appears a numeric keyboard). Selecting the budget is mandatory. The user taps the ‘Back’ button to return to the previous page. The user taps the ‘Continue’ button to continue the process.

Referring to FIG. C76, by tapping the ‘Continue’ button the user reaches the next request. The Interior Designer asks “How much are you willing to spend for the total furniture?” The user can swipe the bar to select the price point or select the Min. (minimal amount) or Max (maximum amount) fields to manually add the specific amount (appears a numeric keyboard). Selecting the budget is mandatory. The user taps the ‘Continue’ button to continue the process.

Referring to FIG. C77, by tapping the ‘Continue’ button the user reaches the next request. The Interior Designer asks “How much are you willing to spend for the artworks?” The user can swipe the bar to select the price point or select the Min. (minimal amount) or Max (maximum amount) fields to manually add the specific amount (appears a numeric keyboard). Selecting the budget is mandatory. The user taps the ‘Back’ button to return to the previous page. The user taps the ‘Continue’ button to continue the process.

Referring to FIG. C78, by tapping the ‘Continue’ button the user reaches the next request. The Interior Designer asks “How many projects do you want to generate?” The user can select the quantity of project to generate. A minimum of 1 with a maximum of 10 projects. The user selects 3 projects. The Interior Designer informs the user that for each project will be generated a ‘Floor plan,’ an ‘Aerial view,’ a ‘Walkthrough view,’ a ‘Moodboard,’ and an ‘Items list’ to purchase. The user taps the ‘Back’ button to return to the previous page. The user taps the ‘Continue’ button to continue the process.

Referring to FIG. C79, by tapping the ‘Continue’ button the user confirms to generate 3 projects based on the previous preferences and requests. The user taps the ‘Close’ button to return to the previous page. The user taps the ‘Options’ button to open all possible options: ‘Generate new options’ to delete the created 3 projects and generate new 3 projects, ‘Start a new process’ to start a new process returning so at the first question, ‘Manage preferences’ to manage all selected preferences or budgets and ‘Share to someone’ to create a link of the 3 generated projects and share it to someone via private message, email or on social networks. The Interior Designer shows a list of 3 generated projects for the renovation of the room, in that case a bedroom, identifying the projects with a visual preview and a label.

Referring to FIG. C80, by tapping the content preview ‘Bedroom • Project #1’ the user opens the page to see the first generated project. The user taps the ‘Back’ button to return to the previous page. The user taps the ‘Options’ button to open all possible options. The Interior Designer shows some picture or video previews of the project in a carousel. It works like a sort of mood board to show some details of the project. The user easily watches the carousel contents. The first content of the project that the user can open is the ‘Floor plan.’

A floor plan is a scaled diagram or drawing that provides an overhead view of a room or building's layout. It is a fundamental tool used by interior designers, architects, and homeowners to visualize and plan the arrangement of furniture, fixtures, and other elements within a space. Floor plans are essential for both residential and commercial interior design projects, as they help to ensure efficient use of space, functionality, and aesthetics.

It includes: Room Layout: Floor plans show the layout of rooms within a space, including their size and shape. This allows designers to determine how different areas will be used and how they flow together. Walls and Partitions: Walls and partitions are represented by lines on the floor plan, helping to define the boundaries of rooms and spaces. The thickness of these lines can indicate the type of walls, such as exterior walls, interior walls, or structural walls. Doors and Windows: Doors and windows are indicated by specific symbols or icons. Furniture and Fixtures: Symbols or labels to represent furniture pieces, appliances, and fixtures like sinks, toilets, and kitchen appliances are used in the floor plan. Measurements and Scale: Floor plans are typically drawn to scale, meaning that the dimensions on the plan correspond accurately to the actual dimensions of the room or building. Common scales include ¼ inch=1 foot or 1:50. Electrical Outlets and Lighting: Electrical outlets, switches, and lighting fixtures are often indicated on floor plans. This is essential for planning the placement of lighting and ensuring that there are enough outlets for electrical devices. Built-in Features: If there are any built-in features like built-in shelving, fireplaces, or niche details, these are usually included in the floor plan to ensure they are incorporated into the design effectively. Annotations and Notes: The Interior Designer may include annotations or notes to provide additional information about materials, color schemes, or specific design details.

The second content of the project that the user can open is the ‘Aerial view.’ It refers to a perspective of a room or space as seen from above, typically from a bird's-eye view or a high vantage point. It is a graphical representation of a space that shows the entire layout, arrangement of furniture, fixtures, and other design elements from a top-down perspective. Aerial view is essential for providing a comprehensive and clear visual representation of a space's layout and design. It offers a complete overview of how various design elements fit together within the room, in 3D.

Referring to FIG. C81, scrolling the page the user sees the other contents. The third content of the project that the user can open is the ‘Walkthrough view.’ It is a dynamic and immersive presentation that allows the user to virtually explore and experience an interior space as if they were walking through it in real life. This view provides a three-dimensional and interactive representation of the interior design concept, allowing for a more comprehensive understanding of the space and its design elements. Walkthrough view is created using 3D modeling and rendering software. This view generates a virtual environment where the user can move freely and view the space from various angles and perspectives. Walkthroughs aim to create a realistic experience by simulating lighting, textures, and materials as accurately as possible. This enables viewers to get a sense of how the finished space will look and feel. The user can interact with the design by controlling their movement through the space. They can navigate using the mobile touchscreen or even connect to the app a virtual reality (VR) equipment for a more immersive experience. The user can explore different areas of the interior, inspect design details, and get a sense of the spatial layout, furniture placement, and overall ambiance.

The fourth content of the project that the user can open is the ‘Moodboard.’ It's a visual content, similar to a collage, that the Interior Designer uses to convey and communicate the overall look, feel, and atmosphere they intend to create for a space. It's a collection of images, materials, textures, colors, and other design elements that help capture the essence and mood of a design concept. Moodboard is primarily a visual representation of a design concept. Moodboard helps set the tone and mood for the interior design. Whether it's a cozy, rustic living room, a sleek and modern office space, or a vibrant and eclectic cafe, the moodboard conveys the emotions and feelings the designer aims to evoke, mentioning a chosen color Palette, texture and materials and furniture.

The fifth content of the project that the user can open is the ‘Item list’. It's a preview of some items used in the project. It will be possible to visit a dedicated page with all lists divided in macro categories. The user taps the ‘Show all’ button to open the page of the items lists.

Referring to FIG. C82, by tapping the ‘Floor plan’ button the user opens the page to see the floor plan design. The user taps the ‘Back’ button to return to the project's previews page. The user visits the ‘Floor plan’ design, he can drag with his fingers on the screen to rotate or zoom in/zoom out the image. The system shows a actions bar on the bottom side of the screen where the user can: Open the menu, Download the floor plan (It's free, sometimes it could have a cost), Zoom in the image or Zoom out it. The measurements view in meters, flooring, walls, windows, doors, staircases, columns, pillars and all structural details are shown on the floor plan. An icon identified as ‘Object signal’ indicates that it is possible to open a detail popup. This ‘Object signal’ appears for furniture and other objects that are present in the product list. In this case the icon appears on the armchair that appears in the corner, it is in fact possible to touch the ‘Object signal’ to see a preview of the armchair and all related info. The Interior Designer inserted an armchair in the design.

Referring to FIG. C83, by zooming in, the user can see the details. The user zooms in the design, the walls of the room and all furniture appears larger. The user taps on the ‘Object signal’ to see all details, like name of the product, brand, color, product image, the button ‘Open’ to open the item page and ‘Options’ to open the options.

Referring to FIG. C84, by tapping the ‘Options’ button the user opens a popup with all options. The system shows a popup with a list of options related to the item, in that case all options related to the ‘Armchair seat long.’ The user taps the ‘Close’ button to close the popup. The selected product appears in a preview with all options. The system shows the ‘Open item’ option to open the item page. The system shows the ‘Manage details’ option to manage item details like colors, model, size and other available variants. The system shows the ‘Edit position’ option to change its position in the design. The system shows the ‘Change item’ option to change the item with other possibilities. The system shows the ‘Clone in a project’ option to duplicate the item and apply it in another generated project. The system shows the ‘Share’ option to share the item with someone or social networks. The system shows the ‘Remove item’ option to delete it from the design and the items list. By tapping the ‘Open’ button from the item preview popup (FIG. C83) or visiting the items list page with a tap on ‘Menu’ (FIG. C82) and selecting the specific item or from the item options popup with a tap on ‘Open item’ the user opens the item page (FIG. C85).

Referring to FIG. C85, the user taps the ‘Back’ button to return to the previous page. The system shows a picture preview of the item, item name, brand, description, variants to select (Colors, sizes, etc. . . . ), seller name and link and all info related to the selected product. The user taps the ‘Add to Cart’ button to add it to the cart section, and proceed with the purchase. If the product is sold by an external seller site, the user will be automatically redirected to the purchase and payment page of the seller to complete the purchase, and then return to the app for confirmation feedback. In some cases, the purchase is completed directly in the Personal X app independently by the user or directly from the personal assistant. The user taps the ‘Add to GiftProfile’ button to add the product in his GiftProfile to receive it as a gift on an occasion. By tapping the ‘Manage details’ button from the item preview popup (FIG. C83) the user opens the page to manage all item's details (FIG. C86).

Referring to FIG. C86, the user taps the ‘Back’ button to return to the previous page. The system shows a picture preview of the product. The user selects the color option. The user taps the ‘Confirm’ button to confirm his choices. By tapping the ‘Edit position’ button from the item preview popup (FIG. C83) the user opens the page to edit the position of the item on the design (FIG. C87).

Referring to FIG. C87, the user taps the ‘Back’ button to return to the previous page. The user zooms in or zooms out the design. The system highlights the item in a container to move into the design to change the position of the item. The user taps the ‘To the left’ and ‘To the right’ buttons to change the orientation of the item. The user taps the ‘Confirm’ button to confirm the change and return to the floor plan design. By tapping the ‘Change item’ button from the item preview popup (FIG. C83) the user opens the page to change the item (FIG. C88).

Referring to FIG. C88, the user taps the ‘Back’ button to return to the previous page. The user swipe to the left or to the light to choose the product. The chosen product appears in a rectangle with the name of the product, brand and its price. The user taps the ‘Confirm’ button to confirm the change and return to the floor plan design. By tapping the ‘Clone in a project’ button from the item preview popup (FIG. C83) the user opens the page to clone the item and apply it in another project (FIG. C89).

Referring to FIG. C89, the user taps the ‘Back’ button to return to the previous page. The system shows a picture preview of the product. The user selects the ‘Bedroom • Project #2’ option to clone the product into the project. It will be possible to clone a product in another project only if the quantity of the generated projects is more than one project. The user taps the ‘Clone and apply’ button to duplicate the product into the selected project. By tapping the ‘Remove item’ button from the item preview popup (FIG. C83) the user removes it from the design (FIG. C90).

Referring to FIG. C90, the system shows an alert popup asking ‘Do you really want to remove this item from the project?’ The user taps the ‘Remove’ button to confirm this removal. The user taps the ‘Cancel’ button to close the popup and return back. By tapping the ‘Menu’ button from the floor plan page (FIG. C82—Arrow nr. 4) the user opens the menu page (FIG. C91).

Referring to FIG. C91, the system shows the menu page with all available options. The user taps the ‘Manage view’ option to manage the floor plan view. The user taps the ‘Manage structure’ option to manage the floor plan structure. The user taps the ‘Manage uploaded sources’ option to manage the uploaded sources. The user taps the ‘Read annotations’ option to open a page where the Interior designer uploaded some annotations, info or suggestions about that project. The user taps the ‘Open items list’ option to open the page with the list of all items of the project, divided in categories. The user taps the ‘Share this project’ option to share the project. The user taps the ‘Close’ button to return to the previous page. By tapping the ‘Manage view” option from the menu page (FIG. C91) the user opens the ‘Manage view’ page (FIG. C92).

Referring to FIG. C92, the user taps the ‘Back’ button to return to the previous page. The user enables the option ‘Show measurements’ choosing the option ‘Meters’ to show all measurements on the floor plan. The user enables the option ‘Show flooring’ to show the floor on the floor plan. The user enables the option ‘Show walls’ to show all walls on the floor plan. The user enables the option ‘Show windows and doors’ to show windows and doors on the floor plan. The user enables the option ‘Show products’ to show all products on all items on the floor plan. The user disables the option ‘Show object signals’ to not show object signals on all items on the floor plan. The user enables the option ‘Show background grid’ to show a grid on the floor plan. The user taps the ‘Confirm’ button to close the page. By tapping the ‘Manage structure’ option from the menu page (FIG. C91) the user opens the ‘Manage structure’ page (FIG. C93).

Referring to FIG. C93, the user taps the ‘Back’ button to return to the previous page. The user taps the ‘Flooring’ button to open the flooring section. The user taps the ‘Windows’ button to open the windows section. The user taps the ‘Doors’ button to open the doors section. The user taps the ‘Walls’ button to open the walls section. The user taps the ‘Staircase’ button to open the staircase section. The user taps the ‘Columns and pillars’ button to open the columns and pillars section. In this list could appear other options to manage as structure. By tapping the ‘Flooring’ button from the ‘Manage structure’ page (FIG. C93) the user opens the ‘Flooring’ page (FIG. C94).

Referring to FIG. C94, the user taps the ‘Back’ button to return to the ‘Manage structure’ page. The user swipe from the left to the right to select another flooring option. The user swipe from the right to the left to select another flooring option. In the middle the system shows the selected option. In that case it's a suggested option too, the Interior Designer communicates that in his opinion it's the best solution for the chosen style. The user selects some options about the type of floor (List #2—Floor types, included in Appendix A). The user selects some options about the floor pattern (List #11—Patterns for parquet flooring, included in Appendix A). The user selects the orientation of the floor. The user taps the ‘Confirm’ button to confirm and return to the previous page. By tapping the ‘Windows’ button from the ‘Manage structure’ page (FIG. C93) the user opens the ‘Windows’ page (FIG. C95).

Referring to FIG. C95, the user taps the ‘Back’ button to return to the previous page. The user taps the ‘Add new’ button to add a new window in the design, choosing its position on the project. The user zooms in the design. The user zooms out the design. The system shows the design of the bedroom with walls. The system shows the windows of the design. The system highlights the selected window. The user taps the ‘Delete’ button to delete the window from the design. The user taps the ‘Confirm’ button to confirm and return to the previous page. By tapping the ‘Walls’ button from the ‘Manage structure’ page (FIG. C93) the user opens the ‘Walls’ page (FIG. C96).

Referring to FIG. C96, the user taps the ‘Back’ button to return to the previous page. The user taps the ‘Add new’ button to add a new wall in the design, choosing its position on the project. The user taps the ‘Delete’ button to delete the selected wall. The user moves with his fingers a wall to move in another position, following the suggestions by the Interior Designer (The dotted lines represent the suggested new position for the wall the user is moving). The user taps the ‘Confirm’ button to confirm and return to the previous page. By tapping the ‘Manage uploaded sources’ button from the ‘Menu’ page (FIG. C91) the user opens the page to manage all uploaded sources by the user (FIG. C97).

Referring to FIG. C97, the user taps the ‘Back’ button to return to the previous page. The user manages the uploaded source ‘Room 3D Scan’, it's possible to delete it or open the preview of the uploaded picture. The user manages the uploaded source ‘Room Floor Plan’, it's possible to delete it or open the preview of the uploaded picture. The user manages the uploaded furniture, the furniture he already has and wants to keep in the room’, it's possible to delete it or open the preview of the uploaded pictures. The user taps the ‘Confirm’ button to confirm and return to the previous page. By tapping the ‘Items list’ button from the ‘Menu’ page (FIG. C91) the user opens the page to see the list of all items used in the project, from the building items like paints or door knobs to furniture for this room (FIG. C98).

Referring to FIG. C98, the user taps the ‘Back’ button to return to the previous page. The user can easily manage the cart and all items added in. The system shows in the top side of the page a list of categories like ‘Building items’, ‘Furniture’, ‘Artworks’, ‘Curtains’ and ‘Accessories’. The categories depend on the user's answers and the type of intended use of the room (in this case a bedroom). The user selects the ‘Furniture’ category. The system shows the number of items for the ‘Furniture’ category added in the project and the total price. The system shows a list of items. The user taps the ‘Add to GiftProfile’ button to add the item to the GiftProfile. The user taps the ‘Add to cart’ button to add the item in the cart. The user taps the ‘Add all this list to cart’ to add all 28 items to the cart and buy them.

Referring to FIG. C99, scrolling the categories bar on the top side of the page the user sees the other categories like ‘Artworks,’ ‘Curtains,’ and ‘Accessories’ suggested for this room. The user selects the ‘Accessories’ category on the top. The system shows the list of all items for that category. The user taps the ‘Add all this list to cart’ to add all 4 items to the cart and buy them.

From the main project page (FIG. C80) the user selects the option ‘Aerial view’ (FIG. C100). Referring to FIG. C100, the user taps the ‘Back’ button to return to the previous page. The system shows the generated aerial view of the project. It refers to a perspective of a room or space as seen from above, typically from a bird's-eye view or a high vantage point. It is a graphical representation of a space that shows the entire layout, arrangement of furniture, fixtures, and other design elements from a top-down perspective. Aerial view is essential for providing a comprehensive and clear visual representation of a space's layout and design. It offers a complete overview of how various design elements fit together within the room, in 3D. The system shows the instruments button to open the ‘Menu’, ‘Download’ the design, ‘Zoom in’ or ‘Zoom out’ the design.

From the main project page (FIG. C80) the user selects the option ‘Walkthrough view’ (FIG. C101). Referring to FIG. C101, the user taps the ‘Back’ button to return to the previous page. The system shows the generated walkthrough view of the project. It is a dynamic and immersive presentation that allows the user to virtually explore and experience an interior space as if they were walking through it in real life. This view provides a three-dimensional and interactive representation of the interior design concept, allowing for a more comprehensive understanding of the space and its design elements. Walkthrough view is created using 3D modeling and rendering software. This view generates a virtual environment where the user can move freely and view the space from various angles and perspectives. Walkthroughs aim to create a realistic experience by simulating lighting, textures, and materials as accurately as possible. This enables viewers to get a sense of how the finished space will look and feel. The user can interact with the design by controlling their movement through the space. They can navigate using the mobile touchscreen or even connect to the app a virtual reality (VR) equipment for a more immersive experience. The user can explore different areas of the interior, inspect design details, and get a sense of the spatial layout, furniture placement, and overall ambiance. The system shows the instruments button to open the ‘Menu’, ‘Download’ the design, ‘Zoom in’ or ‘Zoom out’ the design.

From the main project page (FIG. C80) the user selects the option ‘Moodboard’ (FIG. C102). Referring to FIG. C102, the user taps the ‘Back’ button to return to the previous page. The system shows the generated moodboard of the project. It's a visual content, similar to a collage, that the Interior Designer uses to convey and communicate the overall look, feel, and atmosphere they intend to create for a space. It's a collection of images, materials, textures, colors, and other design elements that help capture the essence and mood of a design concept. Moodboard is primarily a visual representation of a design concept. Moodboard helps set the tone and mood for the interior design. Whether it's a cozy, rustic living room, a sleek and modem office space, or a vibrant and eclectic cafe, the moodboard conveys the emotions and feelings the designer aims to evoke, mentioning a chosen color Palette, texture and materials and furniture.

From the projects list page (FIG. C79) the user taps the ‘Options’ button (FIG. C103). Referring to FIG. C103, the system shows a popup with the list of all options. The user taps the ‘Close’ button to close the popup. The user taps the ‘Generate new alternatives’ option to delete the projects and generate 3 new projects based on the answers. The user taps the ‘Manage answers’ option to manage the list of all answers of this chat process. The user taps the ‘Manage quantity’ option to manage the quantity of the project to generate. The user taps the ‘Share’ option to share the generated projects. The user taps the ‘Start a new chat’ option to start a new chat process.

From the options popup (FIG. C103) the user taps the ‘Generate new alternatives’ option (FIG. C104). Referring to FIG. C104, the system shows an alert popup to ask ‘Do you really want to delete these projects and generate 3 new alternatives?’ The user taps the ‘Confirm’ button to generate 3 new alternatives. The user taps the ‘Cancel’ button to close the alert popup.

From the options popup (FIG. C103) the user taps the ‘Manage answers’ option (FIG. C105). Referring to FIG. C105, some preferences already collected by the system via the ‘Preferences Quiz’ on the GiftClub app may also appear on this page. In all questions pages on the bottom side appears the text ‘I will provide selection based on your answers’. The users tapping the button ‘Your answers’ in fact will visit the page of all answers.

The system shows a page with all answers of the chat process that the user can manage. Editing some answers could generate other questions to answer. These questions need an answer by the user to continue the chat process. The system shows a list of all answers like ‘What space would you like to renew?’ and related answers like ‘Remodel space Small fixes New furniture.’ The user taps the ‘Edit’ button to edit the answer.

### Whole House

Referring to FIG. D1, the user opens the Personal X app and selects the Interior Designer from the list of all assistants available in the page ‘Assistants.’ From the app, the user arrives at the ‘Assistants’ page and selects ‘Interior Designer’ from the list. The Interior Designer welcome page is opened.

Referring to FIG. D2, a welcome page is opened with a first question to create the right conversation. The user taps the ‘Close’ button to return to the ‘Assistants’ page (FIG. D1). The user taps the ‘Options’ button to open the list of possible options that will be ‘Share to someone’ to share the service on social networks or via message to someone, and ‘Read more’ to read more about the service, how the company collects personal data and much more. The Interior Designer says “Hi [User Name], I'm your Interior Designer. I'm here to help you design your spaces! What type of space do you want me to work on? It will be possible to select one only option and selecting the option the next question is automatically shown. The user selects the option ‘Residential’ to start a process for a residential space. The user selects the option ‘Commercial’ to start a process for a commercial space.

Referring to FIG. 3, selecting ‘Residential’ the assistant automatically shows the next question related to that choice. If the user selects the option ‘Commercial’ the process will be very similar to this process, obviously with styles, furniture and other appropriate options to the specific business and commercial context. The system shows the selected option ‘Residential’ at the top of the page. The user taps the ‘Delete’ button to delete the choice ‘Residential’ and the system returns to the previous page to choose one of the two options. The Interior Designer asks “What space do you want me to work on?” It will be possible to select one only option and selecting the option the next question is automatically shown. The user selects the option ‘Specific room’ to generate a process for a specific room. The user selects the option ‘Whole house’ to generate a process for a whole house. The user selects the option ‘Outdoor space’ to generate a process for an outdoor space.

The user selecting the option ‘Whole house—Choose your preferences and I will generate one or multiple projects of the whole house with a list of furniture I can buy for you’ will be entered into a process for creating and furnishing the whole house. Referring to FIG. D4, the process starts as a conversation between the Interior Designer and the user based on questions with options to select or requests to fill. The user taps the ‘Close’ button to return to the ‘Assistant’ page and close the process (FIG. D1). The user taps the ‘Options’ button to open the list of possible options that will be ‘Share to someone’ to share the service on social networks or via message to someone, and ‘Read more’ to read more about the service, how the company collects personal data and much more. The Interior Designer asks “Great, I'll be working on the specific room. What would you like to renew?”. It will be possible to select one or multiple options. Selecting at least one of the options is mandatory. The system shows 3 options: ‘Remodel space,’ ‘Small fixes,’ and ‘New furniture.’ By selecting the first option the user will ask the Interior Designer to suggest and include in the projects remodeled spaces like new walls, elimination of walls and new flooring. By selecting the second option the user will ask the Interior Designer to suggest and include small fixes in the projects like wall painting, new door knobs, or other small, non-structural changes. By selecting the third option the user will ask the Interior Designer to suggest and include new furniture in the projects. The user taps the ‘Back’ button to return to the previous page.

Referring to FIG. D5, the user selects an option. The user selects the option ‘New furniture.’ The user taps the ‘Continue’ button to continue the process. During the process it will be possible to close the conversation with the Interior Designer with a tap on the ‘Close’ button (FIG. D4—Arrow n.1), an alert popup will appear automatically (FIG. D6).

Referring to FIG. D6, by closing the process, the system shows an alert popup with a message “Do you really want to stop this process?—Returning to the assistants list the process will be stopped. However I will save this process in the History section, you will be able to continue it.” The user taps the ‘Cancel’ button to close the popup and return to the process. The user taps the ‘Stop it’ button to return to the ‘Assistant’ page and close the process (FIG. D1). Closing the process the system will preserve the conversation, which the user can continue by visiting the ‘History’ section. By opening the saved conversation the user will be able to continue the process from where it was closed or simply delete it.

Referring to FIG. D7, in the navigation bar, on the top side of the screen, the user can tap on the ‘Options’ button to open a list of available options. The user taps the ‘Share to someone’ button to share the service on social networks or via message to someone. The user taps the ‘Read more’ button to read more about the service, how the company collects personal data and other info. The user taps the ‘Cancel’ button to close the popup.

Referring to FIG. D8, the user can easily share the Personal X app link. By choosing ‘Share to someone’ a popup will be opened. The user taps the ‘Close’ button to close the popup. The system shows a preview of possible recipients, selected based on the latest conversations, via external services. The user taps the ‘Share via Message’ button to share the app link via default message service. The user taps the ‘Share via Email’ button to share the app link via email. The user taps the ‘Share on Facebook’ button to share the app link on the social network. The user taps the ‘Share on Whatsapp’ button to share the app link via message.

Referring to FIG. D9, the user can easily read more about the Personal X services. By choosing ‘Read more’ a popup will be opened. The user taps the ‘Close’ button to close the popup. Visual and textual contents appear to explain the Interior Designer service, how it works, what it can generate, what it can suggest, some project examples, and other info. By tapping the ‘Continue’ button (FIG. D5) the user reaches the next request (FIG. D10).

Referring to FIG. D10, the Interior Designer asks “List all members of your family. Who will be living with you at this home and their relationship to you?” It will be possible to add the people who will live in this house, adding the relationships they have with the user. The user adds someone and a related relationship with him (List #4—Users of the spaces, included in Appendix A).

Referring to FIG. D11, the user uploaded some members. The user added ‘Tom’ as partner. The user taps the ‘Continue’ button to continue the process.

Referring to FIG. D12, by tapping the ‘Continue’ button the user reaches the next request. The Interior Designer asks “Assign rooms in the house to the members”. Selecting at least one of the options is mandatory. The user selects some members to the related room. It is possible to apply a name for the room. The user taps the ‘Add a room’ button to add a new room and assign it to someone or a group of people. The user taps the ‘Back’ button to return to the previous page.

Referring to FIG. D13, the user assigned the rooms to the members. The user assigned the ‘Bathroom’ to everyone. The user taps the ‘Continue’ button to continue the process.

Referring to FIG. D14, if the user chooses some options, a popup may appear to better specify a type or quantity. The user selected ‘Pets’ as an option, so the system shows a popup to better specify the type of pet and quantity. The user taps on the ‘Add’ button on the top-right side of the popup to add a new type of pet and the related quantity. The user selects the type of pet as ‘Dog.’ The user selects the quantity of ‘Dog,’ typing ‘2.’ The user taps the ‘Confirm’ button to proceed. The user taps the ‘Skip’ button to skip the question.

Referring to FIG. D15, if the user selects as user of the room someone the AI system will ask to search for his Profile or GiftProfile so that he can also include his general preferences in the project or in the case in which the system already knows the relationship that unites the user with the selected person, in this case his partner, it could automatically recognize the Profile or GiftProfile and suggest to approve the inclusion of his preferences. If the user and his partner prefer the color ‘Sage Green’, with the approval of his partner's preferences inclusion the system will know that ‘Sage Green’ would almost certainly be the perfect color to suggest in the final room project.

In a popup the Interior Designer shows the found user (the system recognized as partner Tom Kool, considering his GiftProfile and the relationship the user has with him) and asks: “Do you want to include this user's preferences?—Including all user's preferences can have a positive impact on the final proposals to be the best choice for you and this user, however I will consider your preferences as a priority. I will suggest some options that this person might also like.” The user taps the ‘Accept’ button to accept the request. The user taps the ‘Skip’ button to skip the request.

Referring to FIG. D16, in the next question the Interior Designer asks about hobbies of all members. The Interior Designer asks to fill the “List all hobbies for all members of your family.” The user taps on the container to add hobbies for his partner. The user taps the ‘Back’ button to return to the previous page. The user taps the ‘Continue’ button to continue the process.

Referring to FIG. D17, a popup appears to choose the hobbies list for a member. With a tap on the ‘Edit’ button a popup is opened by the system. The user searches the hobbies options. The system shows some hobbies options (List #5—Hobbies, included in Appendix A). The user taps the ‘Confirm’ button to confirm the process.

By tapping the ‘Continue’ button (FIG. D16) the user reaches the next request (FIG. D18). Referring to FIG. D18, the Interior Designer asks “Where is the building located and what geographical orientation does this house have?” The user can skip the question. The Interior Designer shows the location field, the user can add ‘City’ and ‘Zip code.’ The Interior Designer shows all rooms, with a tap on ‘Edit’ the user can manage the answers. The user taps the ‘Back’ button to return to the previous page. The user taps the ‘Skip’ button to skip the question.

Referring to FIG. D19, the user chooses the options in a popup. Tapping ‘Edit’ the system shows a popup. The user selects the ‘North’ and ‘East’ for the Kid Bedroom. The user taps the ‘Confirm’ button to confirm the choice and closes the popup. By tapping the ‘Continue’ button the user reaches the next request (FIG. D20).

Referring to FIG. D20, the Interior Designer asks “To proceed, please do a 3D scan and upload the floor plan of all rooms” The first request is mandatory, the second is optional. The user taps the ‘Room 3D scan’ button to start a scan of each room. The user taps the ‘Room Floor Plan’ button to upload a picture of each room flooring. The user taps the ‘Back’ button to return to the previous page. As requested by the Interior Designer, the user starts a ‘Room 3D Scan’ for each room.

Referring to FIG. D21, the app automatically will open the mobile camera and the user can scan each room following the guidance. The user taps the ‘Close’ button to close the scan page. The user taps the ‘Confirm’ button to confirm the completed scan of the room. The system recognizes specific room's area, objects or spaces to help the user to complete the scan. A geometric shape will appear on the screen as a guide for the user, advising to move the phone at certain positions or angles. The mobile camera shows the scene in real time. The system shows a preview of the scanned areas and objects. A progress bar notifies the user if there are enough scanned parts for the project. A red signal will indicate that the scanned areas are not enough, a yellow signal will indicate that the scanned areas are sufficient but it is weak, a green signal will indicate that the scanned areas fully satisfy the request. By tapping the ‘Continue’ button the user reaches the next question about the first room, the ‘Main bedroom’ (FIG. D22).

Referring to FIG. D22, the Interior Designer informs the user that the options with the ‘Magic Star’ symbol are suggested options because the partner, another user of the room, has previously expressed that he prefers those options indicated, in this case the specific style ‘Shabby chic,’ which the user is free to select. In some cases the AI system openly signals the user with suggested options with a specific symbol, in this case a ‘Magic Star.’ They are options suggested based on previous choices or preferences of other users who have been included in the process. The Interior Designer asks “What style do you have in mind for this room?” It will be possible to select one or multiple options. The user can skip the question. The user searches for an option to select, writing a text or dictating. The Interior Designer shows some options (List #6—Design Styles, included in Appendix A). All suggested options have the ‘Magic Star’ icon. The user taps the ‘Back’ button to return to the previous page. The user taps the ‘Skip’ button to skip the request.

Referring to FIG. D23, the user selects some options. The user selects the options ‘Industrial’ and ‘Minimalistic.’ The user taps the ‘Continue’ button to continue the process. By tapping the ‘Continue’ button the user reaches the next question (FIG. D24).

Referring to FIG. D24, the Interior Designer asks “Do you want recommendations for artworks for the main bedroom?” It will be possible to select one only option. Selecting at least one option is mandatory. The Interior Designer shows the ‘Yes’ and ‘No’ options. The user taps the ‘Back’ button to return to the previous page.

Referring to FIG. D25, the user selects an option. The user selects the option ‘Yes.’ The user taps the ‘Continue’ button to continue the process.

Referring to FIG. D26, by tapping the ‘Continue’ button the user reaches the next question. The Interior Designer asks “What type of artworks do you like for the main bedroom?” It will be possible to select one or multiple options. The user can skip the question. The user searches for an option to select, writing a text or dictating. The Interior Designer shows some options (List #27—Artworks, included in Appendix A). The user taps the ‘Back’ button to return to the previous page. The user taps the ‘Skip’ button to skip the request.

Referring to FIG. D27, the user selects an option. The user selects the option ‘Oil Painting.’ The user taps the ‘Continue’ button to continue the process. By tapping the ‘Continue’ button the user reaches the next request about the furniture (FIG. D28).

Referring to FIG. D28, the Interior Designer says “Upload images of any furniture you have or large items and want to keep to use in your new design of the main bedroom” The user can skip the question. The user taps the ‘Item #1—Upload’ button to upload the picture of the first item that he has in the room but that he wants to leave and not replace. The user can upload a maximum of 10 pictures of objects and furniture he wants to keep. The user taps the ‘Back’ button to return to the previous page. The user taps the ‘Skip’ button to skip the question.

Referring to FIG. D29, the user uploads some pictures. The user uploads the picture of the first item ‘lamp.png’ renaming this element as ‘FLOS lamp purple.’ The user uploads the picture of a second item ‘picture1.png’ renaming this element as ‘Desk Ikea.’ The user uploads the picture of a third item ‘picture34.png’ renaming this element as ‘Armchair FRAU beige.’ The AI system will incorporate these images into the projects, while also endeavoring to identify and suggest new objects and furniture that works well, aesthetically and functionally, with the uploaded items. The user taps the ‘Delete’ button to delete the uploaded element. The user taps the ‘Continue’ button to continue the process. By tapping the ‘Continue’ button the user reaches the next question (FIG. D30).

Referring to FIG. D30, the Interior Designer asks “What furniture brands do you like for the main bedroom?” It will be possible to select one or multiple options. The user can skip the question. The user searches for an option to select, writing a text or dictating. The Interior Designer shows some options (List #28—Furniture brands, included in Appendix A). The user taps the ‘Back’ button to return to the previous page. The user taps the ‘Skip’ button to skip the request.

Referring to FIG. D31, the user selects some options. The user selects the options ‘Herman Miller’ and ‘Maison du Monde.’ The user taps the ‘Continue’ button to continue the process. By tapping the ‘Continue’ button the user reaches the next question (FIG. D32).

Referring to FIG. D32, the Interior Designer asks “What colors do you have in mind for the furniture of the main bedroom?” It will be possible to select one or multiple options. The user can skip the question. The user searches for an option to select, writing a text or dictating. The Interior Designer shows some options of colors for furniture. The user taps the ‘Back’ button to return to the previous page. The user taps the ‘Skip’ button to skip the request.

Referring to FIG. D33, the user selects some options. The user selects the options ‘Navy Blue,’ ‘Camel,’ and ‘Warm Grey.’ The user taps the ‘Continue’ button to continue the process. By tapping the ‘Continue’ button the user reaches the next question (FIG. D34).

Referring to FIG. D34, the Interior Designer asks “What material do you prefer for the furniture of the main bedroom?” It will be possible to select one or multiple options. The user can skip the question. The user searches for an option to select, writing a text or dictating. The Interior Designer shows some options. The user taps the ‘Back’ button to return to the previous page. The user taps the ‘Skip’ button to skip the request.

Referring to FIG. D35, the user selects an option. The user selects the option ‘Wood.’ The user taps the ‘Continue’ button to continue the process. By tapping the ‘Continue’ button the user reaches the next question (FIG. D36).

Referring to FIG. D36, the Interior Designer asks “What type of bed do you prefer for the main bedroom?’ It will be possible to select one or multiple options. The user can skip the question. The Interior Designer shows some options. The user can select the ‘All options’ to select all available options. The user selects the ‘King size bed’ option (List #40—Type of bed, included in Appendix A). The user taps the ‘Back’ button to return to the previous page. The user taps the ‘Continue’ button to continue the process. By tapping the ‘Continue’ button the user reaches the next question (FIG. D37) about the possibility to express specific preferences for objects to add.

Referring to FIG. D37, the Interior Designer asks “Do you also want to express specific preferences for other objects that I will include in the main bedroom?”. The user can select one only option. Selecting at least one option is mandatory. The user selects the ‘No, I trust your taste’. The Interior Design will include some details following his taste as designer. The user taps the ‘Back’ button to return to the previous page. The user taps the ‘Continue’ button to continue the process.

Referring to FIGS. D38-D53, the same questions asked for the main bedroom will be asked for the kids bedroom. By tapping the ‘Continue’ button (FIG. D53) the user reaches the next question (FIG. D54) about the bathroom. Referring to FIGS. D54-D67, the same questions asked for the main bedroom and the kids bedroom will be asked for the bathroom. By tapping the ‘Continue’ button (FIG. D67) the user reaches the next question (FIG. D68).

Referring to FIG. D68, the next question is a specific question about the bathroom. The Interior Designer asks ‘What materials do you prefer for the top of bathroom furniture?’ The user can select one only option and can skip the question. The system shows some options (List #44—Materials for top of bathroom furniture, included in Appendix A). The user selects the ‘Marble’ and ‘Granite’ options. The user taps the ‘Back’ button to return to the previous page. The user taps the ‘Continue’ button to continue the process. By tapping the ‘Continue’ button the user reaches the next question (FIG. D69).

Referring to FIG. D69, the Interior Designer asks ‘What colors do you prefer for the top of bathroom furniture?’ The user can select one only option and can skip the question. The system shows some options of colors, the user can search for a color. The user selects the ‘Ivory’, ‘Cream’ and ‘Beige’ options. The user taps the ‘Back’ button to return to the previous page. The user taps the ‘Continue’ button to continue the process. By tapping the ‘Continue’ button the user reaches the next question (FIG. D70).

Referring to FIG. D70, the Interior Designer asks ‘What materials do you prefer for bathroom furniture handles?’ The user can select one only option and can skip the question. The system shows some options (List #45—Materials for furniture handles, included in Appendix A). The user selects the ‘Antique Brass’ and ‘Brushed Nickel Pull’ options. The user taps the ‘Back’ button to return to the previous page. The user taps the ‘Continue’ button to continue the process. By tapping the ‘Continue’ button the user reaches the next question (FIG. D71).

Referring to FIG. D71, the Interior Designer asks ‘What colors do you prefer for bathroom furniture handles?’ The user can select one only option and can skip the question. The system shows some options. The user selects the ‘Titanium’ option. The user taps the ‘Back’ button to return to the previous page. The user taps the ‘Continue’ button to continue the process. By tapping the ‘Continue’ button the user reaches the next question (FIG. D72) about the possibility to express specific preferences for objects to add.

Referring to FIG. D72, the Interior Designer asks “Do you also want to express specific preferences for other objects that I will include in the bathroom?” The user can select one only option. Selecting at least one option is mandatory. The user selects the ‘No, I trust your taste.’ The Interior Design will include some details following his taste as designer. The user taps the ‘Back’ button to return to the previous page. The user taps the ‘Continue’ button to continue the process. By tapping the ‘Continue’ button the user reaches the next question (FIG. D73) about the kitchen.

Referring to FIGS. D73-D86, the same questions asked for the main bedroom and the kids bedroom will be asked for the kitchen. The process continues with the question about the top of the kitchen furniture (FIG. D87).

Referring to FIG. D87, the Interior Designer asks ‘What materials do you prefer for the top of the kitchen furniture?’ The user can select one only option and can skip the question. The system shows some options (List #30—Materials for top of kitchen furniture, included in Appendix A). The user selects the ‘Marble’ option. The user taps the ‘Back’ button to return to the previous page. The user taps the ‘Continue’ button to continue the process. By tapping the ‘Continue’ button the user reaches the next question (FIG. D88).

Referring to FIG. D88, the Interior Designer asks ‘What colors do you prefer for the top of the kitchen furniture?’ The user can select one only option and can skip the question. The system shows some options. The user selects the ‘Rose’ option. The user taps the ‘Back’ button to return to the previous page. The user taps the ‘Continue’ button to continue the process.

Referring to FIG. D89, the process continues with the question about the top of the kitchen table. The Interior Designer asks ‘What materials do you prefer for the top of the kitchen table?’ The user can select one only option and can skip the question. The system shows some options (List #29—Materials for top of kitchen tables, included in Appendix A). The user selects the ‘Wood’ option. The user taps the ‘Back’ button to return to the previous page. The user taps the ‘Continue’ button to continue the process. By tapping the ‘Continue’ button the user reaches the next question (FIG. D90).

Referring to FIG. D90, the Interior Designer asks ‘What colors do you prefer for the top of the kitchen table?’ The user can select one only option and can skip the question. The system shows some options. The user selects the ‘Brown’ option. The user taps the ‘Back’ button to return to the previous page. The user taps the ‘Continue’ button to continue the process.

Referring to FIG. D91, the process continues with the question about the kitchen furniture handles. The Interior Designer asks ‘What materials do you prefer for kitchen furniture handles?’. The user can select one only option and can skip the question. The system shows some options (List #45—Materials for furniture handles, included in Appendix A). The user selects the ‘Oil-Rubbed Bronze’ option. The user taps the ‘Back’ button to return to the previous page. The user taps the ‘Continue’ button to continue the process. By tapping the ‘Continue’ button the user reaches the next question (FIG. D92).

Referring to FIG. D92, the Interior Designer asks ‘What colors do you prefer for kitchen furniture handles?’ The user can select one only option and can skip the question. The system shows some options. The user selects the ‘Titanium’ option. The user taps the ‘Back’ button to return to the previous page. The user taps the ‘Continue’ button to continue the process. By tapping the ‘Continue’ button the user reaches the next question (FIG. D93) about the possibility to express specific preferences for objects to add in the kitchen.

Referring to FIG. D93, the Interior Designer asks “Do you also want to express specific preferences for other objects that I will include in the kitchen?” The user can select one only option. Selecting at least one option is mandatory. The user selects the ‘No, I trust your taste.’ The Interior Design will include some details following his taste as designer. The user taps the ‘Back’ button to return to the previous page. The user taps the ‘Continue’ button to continue the process. By tapping the ‘Continue’ button the user reaches the next question (FIG. D94) about the hallway.

Referring to FIGS. D94-107, the same questions asked for the main bedroom, the kids bedroom, bathroom, and kitchen will be asked for the hallway. By tapping the ‘Continue’ button the user reaches the next question (FIG. D108) about the possibility to express specific preferences for objects to add in the hallway.

Referring to FIG. D108, the Interior Designer asks “Do you also want to express specific preferences for other objects that I will include in the hallway?” The user can select one only option. Selecting at least one option is mandatory. The user selects the ‘No, I trust your taste’. The Interior Design will include some details following his taste as designer. The user taps the ‘Back’ button to return to the previous page. The user taps the ‘Continue’ button to continue the process. By tapping the ‘Continue’ button the user reaches the next request (FIG. D109).

Referring to FIG. D109, the Interior Designer asks “Would you like to apply the Feng-Shui discipline for this room?” The user can select one only option and it is mandatory. The Interior Designer shows the ‘Yes’ and ‘No’ options. The user taps the ‘Back’ button to return to the previous page.

Referring to FIG. D110, the user selects the ‘Yes’ option to include the Feng-Shui discipline. The user taps the ‘Continue’ button to continue the process. By tapping the ‘Continue’ button the user reaches the next request (FIG. D111).

Referring to FIG. D111, the Interior Designer asks “How much are you willing to spend for the furniture?” The user can swipe the bar to select the price point or select the Min. (minimal amount) or Max (maximum amount) fields to manually add the specific amount (appears a numeric keyboard). Selecting the budget is mandatory. The user taps the ‘Back’ button to return to the previous page. The user taps the ‘Continue’ button to continue the process.

Referring to FIG. D112, by tapping the ‘Continue’ button the user reaches the next request. The Interior Designer asks “How much are you willing to spend for the artworks?” The user can swipe the bar to select the price point or select the Min. (minimal amount) or Max (maximum amount) fields to manually add the specific amount (appears a numeric keyboard). Selecting the budget is mandatory. The user taps the ‘Back’ button to return to the previous page. The user taps the ‘Continue’ button to continue the process.

Referring to FIG. D113, by tapping the ‘Continue’ button the user reaches the next request. The Interior Designer asks “How many projects do you want to generate?” The user can select the quantity of project to generate. A minimum of 1 with a maximum of 10 projects. The user selects 1 project. The Interior Designer informs the user that for each project will be generated a ‘Floor plan,’ an ‘Aerial view,’ a ‘Walkthrough view,’ a ‘Moodboard,’ and an ‘Items list’ to purchase. The user taps the ‘Back’ button to return to the previous page. The user taps the ‘Continue’ button to continue the process. By tapping the ‘Continue’ button the user confirms to generate 3 projects based on the previous preferences and requests (FIG. D114).

Referring to FIG. D114, the user taps the ‘Close’ button to return to the previous page. The user taps the ‘Options’ button to open all possible options: ‘Generate new options’ to delete the created project and generate a new project, ‘Start a new process’ to start a new process returning so at the first question, ‘Manage preferences’ to manage all selected preferences or budgets and ‘Share to someone’ to create a link of the 3 generated projects and share it to someone via private message, email or on social networks. The Interior Designer shows the generated project for the renovation of the whole house.

Referring to FIG. D115, by tapping the project the user opens a page with the list of all rooms. Referring to FIGS. D116 and D117, It will be possible to open each room to visit all generated contents and items lists.

### Outdoor Spaces

The process will be very similar to the process of ‘Specific room’ but with materials and furniture suitable for outdoor spaces.

### Wedding Planner System and Method

The portion of the disclosure is directed to the field of event planning, particularly specializing in wedding planning. Wedding planning is a multifaceted industry that involves coordinating various elements such as venues, vendors, logistics, and personal preferences to create memorable and seamless wedding experiences for couples and their guests. This invention addresses the challenges and complexities associated with wedding planning, aiming to enhance the efficiency and effectiveness of wedding planners' tasks. Information acquisition processes to generate images, designs, purchase proposals for products and services in store or on third-party websites, of which the company is part of affiliate programs.

Wedding planning is a highly demanding profession that involves numerous tasks, including budget management, vendor selection, timeline creation, and guest list management. The industry has seen significant growth in recent years, driven by couples seeking personalized and unique wedding experiences. However, wedding planners often face several challenges, including the following.

Time-Consuming Manual Processes: Traditional wedding planning relies heavily on manual processes, making it time-consuming and prone to errors. This inefficiency can lead to increased costs and decreased customer satisfaction.

Communication and Collaboration: Effective communication and collaboration among wedding planners, vendors, and clients are essential for successful weddings. Coordinating these aspects efficiently can be challenging and may lead to misunderstandings or delays.

Data Management: Managing vast amounts of data, including guest lists, seating arrangements, and vendor contracts, can overwhelm even experienced wedding planners. Data security and organization are paramount in this profession.

Customization: Couples increasingly seek personalized and unique wedding experiences. Wedding planners need tools to efficiently incorporate clients' individual preferences while managing the complexities of planning multiple weddings simultaneously.

The present disclosure aims to address the aforementioned problems and challenges faced by users who don't have enough money to pay to the services of a wedding planner. It introduces a novel and innovative wedding planning system, which is designed to streamline and enhance the entire wedding planning process. This system leverages cutting-edge technology, including artificial intelligence, data analytics, and collaborative tools, to offer wedding planners a comprehensive and user-friendly platform.

Some features of the disclosure include the following list. Efficient Planning Tools: The system provides intuitive tools for budget management, vendor selection, and timeline creation, significantly reducing the time required for these tasks. Communication Hub: A centralized communication hub enables seamless collaboration among wedding planners, vendors, and clients, ensuring that everyone is on the same page. Data Management and Security: Robust data management features simplify the organization of critical wedding information while ensuring data security and privacy. Personalization: The system offers advanced customization options, allowing wedding planners to create unique and memorable wedding experiences tailored to each couple's preferences.

The wedding planner described herein offers a revolutionary approach to wedding planning. By addressing the challenges faced by wedding planners and leveraging advanced technology, this innovation has the potential to transform the wedding planning industry, making it more efficient, personalized, and enjoyable for both professionals and clients. The wedding planner can be used for creating projects, organizing, scheduling and all necessary planning for a wedding event. The system will generate an image contesting in the design of the wedding; based on all of the answers given by the user. This computer generated design includes of images, videos, 2D or 3D visual content and other types of visual and interactive content for a wedding. The Wedding Planner is able to share suggestions to the client also based on the latest trends for weddings. The information acquisition process is based on a series of questions that the user must answer. The Wedding Planner AI will be able to process user preferences to create projects and lists of real products to purchase, products included in the generated projects. Purchases are managed by external stores or by our system. The products that will recommend will be as similar as possible to the design our system generates. In other words we will recommend items to purchase from different stores or services that resemble or match the items on the generated design. The company could be part of affiliate programs with third parties.

A Wedding Planner as an AI assistant will be able to create projects of a whole wedding or specific part of it. It is able to generate contents for the whole wedding, pre-wedding party, wedding ceremony, wedding party, wedding cake, honeymoon, wedding registry and wedding invitations. The Wedding Planner will take into consideration all of the selected preferences and make suggestions based on them. The system will be able to have a good taste in wedding planning and create a list of products the user can purchase. Users will be able to choose how many options they see, decide a budget and delegate the booking of restaurants, hotels, places, services, rentals and purchases to the Wedding Planner. The Wedding Planner system is able to start a collaboration with another Personal X assistant, the Wedding Stylist, to find the perfect wedding dress, accessories, wedding ring and shoes for the bride or groom and their selected partner.

### Pre-Wedding Party

Referring to FIG. E1, the user opens the Personal X app and selects the Wedding Planner from the list of all assistants available in the page ‘Assistants.’ From the app, the user arrives at the ‘Assistants’ page and selects ‘Wedding Planner’ from the list. The Wedding Planner welcome page is opened.

Referring to FIG. E2, a welcome page is opened with a first question to create the right conversation. The user taps the ‘Close’ button to return to the ‘Assistants’ page (FIG. E1). The user taps the ‘Actions’ button to open the list of possible options that will be ‘Share to someone’ to share the service on social networks or via message to someone, and ‘Read more’ to read more about the service, how the company collects personal data and much more. The Wedding Planner says “Hi [User Name], I'm your Wedding Planner. I'm here to help you organize your Wedding. What part of the wedding do you want me to work on?” It will be possible to select one only option and selecting the option the next question is automatically shown. The Wedding Planner shows the first options “Whole Wedding” to create a design of the whole wedding scenario and organize with the structures and professionals everything necessary for its realization, including the pre-wedding party, wedding ceremony, wedding party, wedding cake, wedding registry, honeymoon, guest invitations, wedding dress, and all details based on the user's preferences. It will be possible to generate scenarios and organize specific parts of the wedding. The Wedding Planner shows the second option “Pre-Wedding Party” to create a design of the pre-wedding party scenario and organize with the structures and professionals everything necessary for its realization. The Wedding Planner shows the third option “Wedding Ceremony” to create a design of the wedding ceremony scenario and organize with the structures and professionals everything necessary for its realization.

Referring to FIG. E3, the Wedding Planner shows the fourth option “Wedding party” to create a design of the wedding party scenario and organize with the structures and professionals everything necessary for its realization. The Wedding Planner shows the fifth option “Wedding Cake” to create a design of the wedding cake and organize with the structures and professionals everything necessary for its realization. The Wedding Planner shows the sixth option “Honeymoon” to create a design of the honeymoon scenario and organize with the structures and professionals everything necessary for its realization. The Wedding Planner shows the seventh option “Wedding Registry” to create an online registry matching the user's GiftProfile and the partner's GiftProfile to have a unique space to show the desired gifts. All guests can participate in charity donations, Gift Funds or buy a gift to send them. The Wedding Planner shows the eighth option “Guest invitations” to create a design of the wedding invitations, virtual or printed, and to send to all guests. It will be possible to send virtual invitations to all guests via email or private message or printed invitations creating a list of all addresses. By tapping the ‘Whole Wedding’ option (FIG. E2) the user reaches the next request (FIG. E4).

Referring to FIG. E4, the user taps the ‘Close’ button to close the conversation and return to the homepage (FIG. E1). The user taps the ‘Options’ button to open the list of possible options that will be ‘Share to someone’ to share the service on social networks or via message to someone, and ‘Read more’ to read more about the service, how the company collects personal data and much more. The Wedding Planner asks “Do you want to organize a Pre-Wedding Party?”. It will be possible to select one only option. Selecting at least one option is mandatory. The Wedding Planner shows two options ‘Yes’ and ‘No.’ The user taps the ‘Back’ button to return to the previous page.

Referring to FIG. E5, the user selects an option. The user selects the ‘Yes’ option to organize a pre-wedding party. The user taps the ‘Continue’ button to continue the process.

### Pre-Wedding Party

Referring to FIG. E6, by tapping the ‘Continue’ button the user reaches the next request. The Wedding Planner asks “What type of Pre-Wedding Party would you like?”. It will be possible to select one or multiple options. Selecting at least one option is mandatory. The user searches for an option to select, writing a text or dictating. The Wedding Planner shows some options the user can select. (List #1—Pre-wedding Parties, included in Appendix A). The user taps the ‘Back’ button to return to the previous page.

Referring to FIG. E7, the user selects an option. The user selects the option ‘Bridal Shower.’ The user taps the ‘Continue’ button to continue the process. By tapping the ‘Continue’ button the user reaches the next request (FIG. E8).

Referring to FIG. E8, the Wedding Planner asks “Who is your partner?” If the system already knows the relationship between the user and the partner this question will be skipped by the system. If not it will be required to type the phone number in the field to find the partner. If the partner has a GiftProfile, an acceptance pop-up appears, if the user does not have a GiftProfile it will be possible to simply add the partner's name and recommend to him to create a GiftProfile by sending a private message directly from the Personal X app. The user can skip the question. The user types the ‘Phone Number’ of the partner. The user taps the ‘Back’ button to return to the previous page. The user taps the ‘Skip’ button to skip the question and continue the process.

Referring to FIG. E9, the user fills the phone number field and a popup is opened. The Wedding Planner shows a popup with the partner's GiftProfile preview. The user taps the ‘Accept’ button to add the found user as a partner. The system communicates to GiftClub this kind of relationship between these two users. The user taps the ‘Cancel’ button to close the popup. By tapping the ‘Continue’ button the user reaches the next request (FIG. E10).

Referring to FIG. E10, the Wedding Planner asks ‘What is the date of the Bridal Shower?’ It will be required to fill all fields to continue. The Wedding Planner shows a list of fields to fill about the date and start time of the party. The user taps the ‘Back’ button to return to the previous page.

Referring to FIG. E11, the user selects some options. The user types the date of the event. The user types the time of the event. The user taps the ‘Continue’ button to continue the process. By tapping the ‘Continue’ button the user reaches the next request (FIG. E12).

Referring to FIG. E12, the Wedding Planner asks “What kind of venue would you like to have the Bridal Shower?”. It will be possible to select one or multiple options. The user can skip the question. The user searches for an option to select, writing a text or dictating. The user selects the ‘Garden’ and ‘Country Club’ options. (List #3—Venues for Parties, included in Appendix A). The user taps the ‘Back’ button to return to the previous page. The user taps the ‘Continue’ button to continue the process. By tapping the ‘Continue’ button the user reaches the next request (FIG. E13).

Referring to FIG. E13, the Wedding Planner asks “What is the place of the Bridal Shower?”. The user can skip the question. The user adds the City and the State for the bridal shower ‘Capri—Italy.’ The user adds the specific location or the bridal shower ‘Villa Castiglione.’ The user taps the ‘Back’ button to return to the previous page. The user taps the ‘Continue’ button to continue the process. By tapping the ‘Continue’ button the user reaches the next request (FIG. E14).

Referring to FIG. E14, the Wedding Planner asks “What type of Bridal Shower would you like?”. It will be possible to select one or multiple options. The user can skip the question. The user searches for an option to select, writing a text or dictating. The Wedding Planner shows some options (List #6—Type of Wedding Party, included in Appendix A). The user taps the ‘Back’ button to return to the previous page. The user taps the ‘Skip’ button to skip the question and continue the process.

Referring to FIG. E15, the user selects some options. The user selects the ‘Dinner’ and ‘Aperitif’ options. The user taps the ‘Continue’ button to continue the process. By tapping the ‘Continue’ button the user reaches the next request (FIG. E16).

Referring to FIG. E16, the Wedding Planner asks “What is the theme of the Bridal Shower?” It will be possible to select one or multiple options. The user can skip the question. The user searches for an option to select, writing a text or dictating. The Wedding Planner shows some options. (List #7—General Wedding Themes, included in Appendix A). The user taps the ‘Back’ button to return to the previous page. The user taps the ‘Skip’ button to skip the question and continue the process.

Referring to FIG. E17, the user selects some options. The user selects the ‘Romantic’ option. The user taps the ‘Continue’ button to continue the process. By tapping the ‘Continue’ button the user reaches the next request (FIG. E18).

Referring to FIG. E18, the Wedding Planner asks “What colors do you prefer for the Bridal Shower?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. E19, the user selects some options. The user selects the ‘White,’ ‘Green,’ and ‘Beige’ options. The user taps the ‘Continue’ button to continue the process. By tapping the ‘Continue’ button the user reaches the next request (FIG. E20).

Referring to FIG. E20, the Wedding Planner asks “What flowers do you prefer for the Bridal Shower?” It will be possible to select one or multiple options. The user can skip the question. The user searches for an option to select, writing a text or dictating. The Wedding Planner shows some options. It will be possible to select the option ‘Match with the theme’ to ask the Wedding Planner to choose the flowers that match with the theme. (List #9—Wedding Flowers, included in Appendix A). The user taps the ‘Back’ button to return to the previous page. The user taps the ‘Skip’ button to skip the question and continue the process.

Referring to FIG. E21, the user selects some options. The user selects the ‘Orchids’ option. The user taps the ‘Continue’ button to continue the process. By tapping the ‘Continue’ button the user reaches the next request (FIG. E22).

Referring to FIG. E22, the Wedding Planner asks “What kind of entertainment for the Bridal Shower do you prefer?” It will be possible to select one or multiple options. The user can skip the question. The user searches for an option to select, writing a text or dictating. The Wedding Planner shows some options. (List #11—Wedding Entertainments, included in Appendix A). The user taps the ‘Back’ button to return to the previous page. The user taps the ‘Skip’ button to skip the question and continue the process.

Referring to FIG. E23, the user selects some options. The user selects the ‘String Quartet’ option. The user taps the ‘Continue’ button to continue the process. By tapping the ‘Continue’ button the user reaches the next request (FIG. E24).

Referring to FIG. E24, the Wedding Planner asks “What kind of special shows for the Bridal Shower?” It will be possible to select one or multiple options. The user can skip the question. The user searches for an option to select, writing a text or dictating. The Wedding Planner shows some options. (List #12—Wedding Special Shows, included in Appendix A) The user taps the ‘Back’ button to return to the previous page. The user taps the ‘Skip’ button to skip the question and continue the process.

Referring to FIG. E25, the user selects some options. The user selects the ‘Fireworks’ and ‘Drones show’ options. The user taps the ‘Continue’ button to continue the process. By tapping the ‘Continue’ button the user reaches the next request (FIG. E26).

Referring to FIG. E26, the Wedding Planner asks “What kind of special service do you want to offer at the end of the Bridal Shower?” It will be possible to select one or multiple options. The user can skip the question. The user searches for an option to select, writing a text or dictating. The Wedding Planner shows some options. (List #13—Wedding Services, included in Appendix A) The user taps the ‘Back’ button to return to the previous page. The user taps the ‘Skip’ button to skip the question and continue the process.

Referring to FIG. E27, the user selects some options. The user selects the ‘Ice Cream Sundae Bar’ option. The user taps the ‘Continue’ button to continue the process. By tapping the ‘Continue’ button the user reaches the next request (FIG. E28).

Referring to FIG. E28, the Wedding Planner asks “Do you wanna give a gift to your partner for the Bridal Shower?” It will be possible to select one only option. Selecting at least one option is mandatory. The Wedding Planner shows two options ‘Yes’ and ‘No’. The user taps the ‘Back’ button to return to the previous page.

Referring to FIG. E29, the user selects some options. The user selects the ‘No’ option. If you had selected ‘Yes’, a collaboration with Gifts Assistant would have started to find the perfect gift for the occasion. (See more in ‘Gifts Assistants Patent’) The user taps the ‘Continue’ button to continue the process. By tapping the ‘Continue’ button the user reaches the next request (FIG. E30).

Referring to FIG. E30, the Wedding Planner asks “Do you need a dress for the Bridal Shower? I can collaborate with Wedding Stylist to find a perfect dress” It will be possible to select one only option. Selecting at least one option is mandatory. The Wedding Planner shows two options ‘Yes’ and ‘No.’ The user taps the ‘Back’ button to return to the previous page.

Referring to FIG. E31, the user selects some options. The user selects the ‘No’ option. If you had selected ‘Yes,’ a collaboration with Wedding Stylist assistant would have started. The user taps the ‘Continue’ button to continue the process. The system gives the user the opportunity to add further details or options that the assistant has not directly asked for. By choosing some additional options the system will be able to create further specific questions and receive their preferences from the user. In fact, the questionnaire process could really be long, so in this question the user can search and select all the details left out of the questionnaire to generate further questions. By tapping the ‘Continue’ button the user reaches the next request (FIG. E32).

Referring to FIG. E32, the Wedding Planner asks “Do you also want to express specific preferences for the Bridal Shower?” It will be possible to select one only option. Selecting at least one option is mandatory. The user selects the ‘Yes, I want’ option. The user taps the ‘Back’ button to return to the previous page. The user taps the ‘Continue’ button to continue the process. By tapping the ‘Continue’ button the user reaches the next request (FIG. E33).

Referring to FIG. E33, the Wedding Planner asks “Fine! What are the objects that you absolutely want me to include in the Bridal Shower?” It will be possible to select one or multiple options. Selecting at least one option is mandatory. The user searches for an option to select, writing a text or dictating. The user selects the ‘Balloons’ option to add this detail to the party too. The user taps the ‘Continue’ button to continue the process. By tapping the ‘Continue’ button the user reaches the next request (FIG. E34).

Referring to FIG. E34, the Wedding Planner asks “How many guests will be invited for the Bridal Shower?” It will be possible to select the number by swiping the line or by tapping on the number and the numeric keyboard will be opened to manually add the number. Selecting the guest number is mandatory. The user swipe the line to select the number of guests. The user taps the ‘Back’ button to return to the previous page. The user taps the ‘Continue’ button to continue the process. By tapping the ‘Continue’ button the user reaches the next request (FIG. E35).

Referring to FIG. E35, the Wedding Planner asks “What is the dress code of Bridal Shower?” It will be possible to select one or multiple options. The user can skip the question. The user searches for an option to select, writing a text or dictating. The Wedding Planner shows some options (List #8—Wedding Dress Code, included in Appendix A). The user taps the ‘Back’ button to return to the previous page. The user taps the ‘Skip’ button to skip the question and continue the process.

Referring to FIG. E36, the user selects some options. The user selects the ‘Cocktail Chic’ option. The user taps the ‘Continue’ button to continue the process. By tapping the ‘Continue’ button the user reaches the next request (FIG. E37).

Referring to FIG. E37, the Wedding Planner asks “Do you want to provide transportation to the Bridal Shower location for your guests?” It will be possible to select one or multiple options. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. E38, the user selects some options. The user selects the ‘Private Bus’ option. The user taps the ‘Continue’ button to continue the process. By tapping the ‘Continue’ button the user reaches the next request (FIG. E39).

Referring to FIG. E39, the Wedding Planner asks “What kind of menu do you prefer for the Bridal Shower?” It will be possible to select one or multiple options. The user can skip the question. The user searches for an option to select, writing a text or dictating. The Wedding Planner shows some options (List #21—Wedding Party Menu, included in Appendix A). The user taps the ‘Back’ button to return to the previous page. The user taps the ‘Skip’ button to skip the question and continue the process.

Referring to FIG. E40, the user selects some options. The user selects the ‘Seafood’ option. The user taps the ‘Continue’ button to continue the process. By tapping the ‘Continue’ button the user reaches the next request (FIG. E41).

Referring to FIG. E41, the Wedding Planner asks “Do you want to specify any menu intolerance and allergies for food of the Bridal Shower?” It will be possible to select one or multiple options. The user can skip the question. The user searches for an option to select, writing a text or dictating. The Wedding Planner shows some options (List #22—Food Allergies and intolerances, included in Appendix A). The user taps the ‘Back’ button to return to the previous page. The user taps the ‘Skip’ button to skip the question and continue the process. By tapping the ‘Continue’ button the user reaches the next request (FIG. E42).

Referring to FIG. E42, the Wedding Planner asks “Can I organize and book everything for the Bridal Shower?” It will be possible to select one only option. Selecting at least one option is mandatory. The user selects the ‘Yes’ option. The Wedding Planner will schedule and organize the Wedding Party with the restaurant in total autonomy. The user taps the ‘Back’ button to return to the previous page. The user taps the ‘Continue’ button to continue the process. By tapping the ‘Continue’ button the user reaches the last question for the Bridal Shower request (FIG. E43).

Referring to FIG. E43, the Wedding Planner asks “How much are you willing to spend for the Bridal Shower?” It will be possible to select a price point. Selecting at least the minimum and maximum amounts is mandatory. The user swipe the price point bar in the right or the left side to decide the amount (Right to reduce and left to increase the amount). It will be possible to manage the amounts manually tapping the min. or max. amounts and a numeric keyboard appears. The user selects a minimum amount to spend for the Bridal Shower in ‘$5,000’ and a maximum amount of ‘$6,500.’ The user selects the ‘I have a total budget for the Whole Wedding’ option. The user can now skip this question and enter a single total budget for the event at the end of the process. However the user can decide to enter a budget for that specific question too. Only by selecting this option the Wedding Planner will ask at the end of the process to indicate a total budget for the whole wedding. If the user has entered a budget for the bridal shower or other, the minimum total budget will take into account the specific budgets selected, giving the possibility to modify each budget. The user taps the ‘Back’ button to return to the previous page. The user taps the ‘Continue’ button to continue the process.

### Wedding Ceremony

Referring to FIG. F1, by tapping the ‘Continue’ button the user reaches the next question to organize the whole Wedding event, about the wedding ceremony. The user taps the ‘Close’ button to close the conversation and return to the homepage (FIG. E1). The user taps the ‘Options’ button to open the list of possible options that will be ‘Share to someone’ to share the service on social networks or via message to someone, and ‘Read more’ to read more about the service, how the company collects personal data and much more. The Wedding Planner asks “Do you want to organize the Wedding Ceremony?” It will be possible to select one only option. Selecting at least one option is mandatory. The Wedding Planner shows two options ‘Yes’ and ‘No.’ The user taps the ‘Back’ button to return to the previous page.

Referring to FIG. F2, the user selects an option. The user selects the ‘Yes’ option to organize the wedding ceremony. The user taps the ‘Continue’ button to continue the process. By tapping the ‘Continue’ button the user reaches the next question (FIG. F3).

Referring to FIG. F3, the Wedding Planner asks “What type of Wedding Ceremony would you like?” It will be possible to select one only option. The user can skip the question. The user searches for an option to select, writing a text or dictating. The Wedding Planner shows some options (List #14—Wedding Ceremony, included in Appendix A). The user taps the ‘Back’ button to return to the previous page. The user taps the ‘Skip’ button to skip the question and continue the process.

Referring to FIG. F4, the user selects an option. The user selects the ‘Catholic’ option. The user taps the ‘Continue’ button to continue the process. By tapping the ‘Continue’ button the user reaches the next question (FIG. F5).

Referring to FIG. F5, the Wedding Planner asks “What type of rituals for the Wedding Ceremony would you like?” It will be possible to select one or multiple options. The user can skip the question. The user searches for an option to select, writing a text or dictating. The Wedding Planner shows some options (List #15—Wedding Rituals, included in Appendix A). The user taps the ‘Back’ button to return to the previous page. The user taps the ‘Skip’ button to skip the question and continue the process.

Referring to FIG. F6, the user selects an option. The user selects the ‘Exchange of Vows,’ ‘Ring Exchange,’ and ‘Lighting of Unity Candle’ options. The user taps the ‘Continue’ button to continue the process. By tapping the ‘Continue’ button the user reaches the next question (FIG. F7).

Referring to FIG. F7, the Wedding Planner asks “What is the date of the Wedding Ceremony?” It will be required to fill all fields to continue. The Wedding Planner shows a list of fields to fill about the date and start time of the ceremony. The user taps the ‘Back’ button to return to the previous page.

Referring to FIG. F8, the user fills all requests. The user types the date of the event. The user types the time of the event. The user taps the ‘Continue’ button to continue the process. By tapping the ‘Continue’ button the user reaches the next question (FIG. F9).

Referring to FIG. F9, the Wedding Planner asks “What kind of venue would you like for the Wedding Ceremony?” It will be possible to select one or multiple options. The user can skip the question. The user searches for an option to select, writing a text or dictating. The Wedding Planner shows some options (List #4—Wedding Ceremony Venues, included in Appendix A) and the user selects the ‘Church’ option. The user taps the ‘Back’ button to return to the previous page. The user taps the ‘Continue’ button to continue the process. By tapping the ‘Continue’ button the user reaches the next question (FIG. F9.1).

Referring to FIG. F9.1, the Wedding Planner asks “What is the place of the Wedding Ceremony?” The user can skip the question. The user adds the city of ‘Naples—Italy.’ The user adds the specific location ‘St. Francesco di Paola—P.zza del Plebiscito Naples ITALY.’ The user taps the ‘Back’ button to return to the previous page. The user taps the ‘Continue’ button to continue the process. By tapping the ‘Continue’ button the user reaches the next question (FIG. F10).

Referring to FIG. F10, the Wedding Planner asks “What is the theme of the Wedding Ceremony?” It will be possible to select one or multiple options. The user can skip the question. The user searches for an option to select, writing a text or dictating. The Wedding Planner shows some options (List #7—General Wedding Themes, included in Appendix A). The user taps the ‘Back’ button to return to the previous page. The user taps the ‘Skip’ button to skip the question and continue the process.

Referring to FIG. F11, the user selects an option. The user selects the ‘Romantic’ option. The user taps the ‘Continue’ button to continue the process. By tapping the ‘Continue’ button the user reaches the next question (FIG. F12).

Referring to FIG. F12, the Wedding Planner asks “What colors do you prefer for the Wedding Ceremony?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. F13, the user selects some options. The user selects the ‘Gold’ and ‘White’ options. The user taps the ‘Continue’ button to continue the process. By tapping the ‘Continue’ button the user reaches the next question (FIG. F14).

Referring to FIG. F14, the Wedding Planner asks “What flowers do you prefer for the Wedding Ceremony?” It will be possible to select one or multiple options. The user can skip the question. The user searches for an option to select, writing a text or dictating. The Wedding Planner shows some options. (List #9—Wedding Flowers, included in Appendix A). The user taps the ‘Back’ button to return to the previous page. The user taps the ‘Skip’ button to skip the question and continue the process.

Referring to FIG. F15, the user selects an option. The user selects the ‘Orchids’ option. The user taps the ‘Continue’ button to continue the process. By tapping the ‘Continue’ button the user reaches the next question (FIG. F16).

Referring to FIG. F16, the Wedding Planner asks “How many bouquets do you want for the Wedding Ceremony?” It will be possible to select a number. Selecting at least one option is mandatory. The user selects the number ‘1’ for a bouquets quantity of 1. The user taps the ‘Back’ button to return to the previous page. The user taps the ‘Continue’ button to continue the process. By tapping the ‘Continue’ button the user reaches the next question (FIG. F17).

Referring to FIG. F17, the Wedding Planner asks “What flowers do you prefer for the first bouquet for the Wedding Ceremony?” It will be possible to select one or multiple options. The user can skip the question. The user searches for an option to select, writing a text or dictating. The user selects the ‘Peonies’ option (List #9—Wedding Flowers, included in Appendix A). The user taps the ‘Back’ button to return to the previous page. The user taps the ‘Continue’ button to continue the process. By tapping the ‘Continue’ button the user reaches the next question (FIG. F18).

Referring to FIG. F18, the Wedding Planner asks “What type of bouquet do you prefer for the Wedding Ceremony?” It will be possible to select one or multiple options. The user can skip the question. The user searches for an option to select, writing a text or dictating. The user selects the ‘Cascade’ option (List #10—Wedding Bouquet of Flowers, included in Appendix A). The user taps the ‘Back’ button to return to the previous page. The user taps the ‘Continue’ button to continue the process. By tapping the ‘Continue’ button the user reaches the next request (FIG. F19).

Referring to FIG. F19, the Wedding Planner asks “Do you need a dress for the Wedding Ceremony? I can collaborate with Wedding Stylist to find a perfect dress” It will be possible to select one only option. Selecting at least one option is mandatory. The Wedding Planner shows the ‘Yes’ and ‘No’ options. The user taps the ‘Back’ button to return to the previous page.

Referring to FIG. F20, the user selects an option. The user selects the ‘Yes’ option. The user taps the ‘Continue’ button to continue the process. Confirming the Wedding Planner continues the conversation in collaboration with the Wedding Stylist to find the perfect dress for the occasion. By tapping the ‘Continue’ button so the user reaches the next request related to the dress for the Wedding Ceremony (FIG. F21).

Referring to FIG. F21, the Wedding Planner asks “Do you have photos of wedding dresses or accessories for the ceremony that you like and want to show me as a reference?” It will be possible to select one only option. Selecting at least one option is mandatory. The Wedding Planner shows the ‘Yes’ and ‘No’ options. The user taps the ‘Back’ button to return to the previous page. The user taps the ‘Continue’ button to continue the process. By tapping the ‘Continue’ button the user reaches the next request (FIG. F22).

Referring to FIG. F22, the Wedding Planner says “To proceed, please upload the photos of wedding dresses or accessories you prefer as reference.” It will be possible to upload reference pictures for the dress. If the uploaded images are not related to the wedding dress or the requested object, the system will be able to discard the uploaded image. The user taps the ‘Upload’ button to upload a wedding dress picture. The Wedding Planner shows an uploaded reference with the button ‘Delete’ to delete the picture and ‘Open preview’ to open the preview of the uploaded picture. The user taps the ‘Back’ button to return to the previous page. The user taps the ‘Continue’ button to continue the process. By tapping the ‘Continue’ button the user reaches the next question (FIG. F23).

Referring to FIG. F23, the Wedding Planner asks “What type of dress do you need for the Wedding Ceremony?” It will be possible to select only one option. The user can skip the question. The user searches for an option to select, writing a text or dictating. The Wedding Planner shows some options. (List #51—Dress for Wedding, included in Appendix A). The user taps the ‘Back’ button to return to the previous page. The user taps the ‘Skip’ button to skip the question and continue the process.

Referring to FIG. F24, the user selects an option. The user selects the ‘Bride dress’ option. The user taps the ‘Continue’ button to continue the process. By tapping the ‘Continue’ button the user reaches the next question (FIG. F25).

Referring to FIG. F25, the Wedding Planner asks “What general style do you prefer for the bride dress for the Wedding Ceremony?” It will be possible to select one or multiple options. The user can skip the question. The user searches for an option to select, writing a text or dictating. The Wedding Planner shows some options. (List #29—Wedding General Dress Style, included in Appendix A). The user taps the ‘Back’ button to return to the previous page. The user taps the ‘Skip’ button to skip the question and continue the process.

Referring to FIG. F25.1, the user selects some options. The user selects the ‘Bohemian’ and ‘Floral’ options. The user taps the ‘Continue’ button to continue the process. By tapping the ‘Continue’ button the user reaches the next question (FIG. F26).

Referring to FIG. F26, the Wedding Planner asks “What colors do you prefer for the bride dress for the Wedding Ceremony?” It will be possible to select one or multiple options. The user can skip the question. The user searches for an option to select, writing a text or dictating. The user selects the ‘White’ option (List #32—Wedding Dress Colors, included in Appendix A). The user taps the ‘Back’ button to return to the previous page. The user taps the ‘Continue’ button to continue the process. By tapping the ‘Continue’ button the user reaches the next question (FIG. F27).

Referring to FIG. F27, the Wedding Planner asks “What brands do you prefer for the bride dress for the Wedding Ceremony?” It will be possible to select one or multiple options. The user can skip the question. The user searches for an option to select, writing a text or dictating. The user selects the ‘Surprise me!’ option (List #31—Wedding Dress Brands, included in Appendix A). The user taps the ‘Back’ button to return to the previous page. The user taps the ‘Continue’ button to continue the process. By tapping the ‘Continue’ button the user reaches the next question (FIG. F28).

Referring to FIG. F28, the Wedding Planner asks “What fabric do you prefer for the bride dress for the Wedding Ceremony?” It will be possible to select one or multiple options. The user can skip the question. The user searches for an option to select, writing a text or dictating. The Wedding Planner shows some options (List #30—Wedding Dress Fabric, included in Appendix A). The user taps the ‘Back’ button to return to the previous page. The user taps the ‘Skip’ button to skip the question and continue the process.

Referring to FIG. F29, the user selects some options. The user selects the ‘Satin’ and ‘Chiffon’ options. The user taps the ‘Continue’ button to continue the process. By tapping the ‘Continue’ button the user reaches the next question (FIG. F30).

Referring to FIG. F30, the Wedding Planner asks “What type of neckline do you prefer for the bride dress for the Wedding Ceremony?” It will be possible to select one or multiple options. The user can skip the question. The user searches for an option to select, writing a text or dictating. The Wedding Planner shows some options (List #33—Wedding Dress Neckline, included in Appendix A). The user taps the ‘Back’ button to return to the previous page. The user taps the ‘Skip’ button to skip the question and continue the process.

Referring to FIG. F31, the user selects an option. The user selects the ‘Sweetheart’ option. The user taps the ‘Continue’ button to continue the process. By tapping the ‘Continue’ button the user reaches the next question (FIG. F32).

Referring to FIG. F32, the Wedding Planner asks “What type of sleeves do you prefer for the bride dress for the Wedding Ceremony?” It will be possible to select one or multiple options. The user can skip the question. The user searches for an option to select, writing a text or dictating. The Wedding Planner shows some options (List #34—Wedding Dress Sleeves, included in Appendix A). The user taps the ‘Back’ button to return to the previous page. The user taps the ‘Skip’ button to skip the question and continue the process.

Referring to FIG. F33, the user selects an option. The user selects the ‘Sleeveless’ option. The user taps the ‘Continue’ button to continue the process. By tapping the ‘Continue’ button the user reaches the next question (FIG. F34).

Referring to FIG. F34, the Wedding Planner asks “What type of bodice do you prefer for the bride dress for the Wedding Ceremony?” It will be possible to select one or multiple options. The user can skip the question. The user searches for an option to select, writing a text or dictating. The Wedding Planner shows some options (List #35—Wedding Dress Bodice, included in Appendix A). The user taps the ‘Back’ button to return to the previous page. The user taps the ‘Skip’ button to skip the question and continue the process.

Referring to FIG. F35, the user selects an option. The user selects the ‘Corset’ option. The user taps the ‘Continue’ button to continue the process. By tapping the ‘Continue’ button the user reaches the next question (FIG. F36).

Referring to FIG. F36, the Wedding Planner asks “What type of waistline do you prefer for the bride dress for the Wedding Ceremony?” It will be possible to select one or multiple options. The user can skip the question. The user searches for an option to select, writing a text or dictating. The Wedding Planner shows some options (List #36—Wedding Dress Waistline, included in Appendix A). The user taps the ‘Back’ button to return to the previous page. The user taps the ‘Skip’ button to skip the question and continue the process.

Referring to FIG. F37, the user selects an option. The user selects the ‘Empire’ option. The user taps the ‘Continue’ button to continue the process. By tapping the ‘Continue’ button the user reaches the next question (FIG. F38).

Referring to FIG. F38, the Wedding Planner asks “What type of silhouette do you prefer for the bride dress for the Wedding Ceremony?” It will be possible to select one or multiple options. The user can skip the question. The user searches for an option to select, writing a text or dictating. The Wedding Planner shows some options (List #37—Wedding Dress Silhouette, included in Appendix A). The user taps the ‘Back’ button to return to the previous page. The user taps the ‘Skip’ button to skip the question and continue the process.

Referring to FIG. F39, the user selects an option. The user selects the ‘A-line’ option. The user taps the ‘Continue’ button to continue the process. By tapping the ‘Continue’ button the user reaches the next question (FIG. F40).

Referring to FIG. F40, the Wedding Planner asks “What type of hemline do you prefer for the bride dress for the Wedding Ceremony?” It will be possible to select one or multiple options. The user can skip the question. The user searches for an option to select, writing a text or dictating. The Wedding Planner shows some options (List #39—Wedding Dress Hemline, included in Appendix A). The user taps the ‘Back’ button to return to the previous page. The user taps the ‘Skip’ button to skip the question and continue the process.

Referring to FIG. F41, the user selects some options. The user selects the ‘Floor-Length’ and ‘Ankle-Length’ options. The user taps the ‘Continue’ button to continue the process. By tapping the ‘Continue’ button the user reaches the next question (FIG. F42).

Referring to FIG. F42, the Wedding Planner says “Please indicate the measurements for each part of the dress.” It will be possible to indicate all body measurements. Selecting at least one option is mandatory. The user completes all fields with the personal sizes and body measurements like ‘Bust,’ ‘Sleeves,’ ‘Neckline,’ ‘Bodice,’ ‘Waistline,’ ‘Silhouette,’ and ‘Hemline.’ The user taps the ‘Back’ button to return to the previous page.

Referring to FIG. F43, the user scrolls the page to complete all measurements requests. The user taps the ‘Continue’ button to continue the process. By tapping the ‘Continue’ button the user reaches the next question (FIG. F44).

Referring to FIG. F44, the Wedding Planner asks “What type of decorations do you like for the bride dress for the Wedding Ceremony?” It will be possible to select one or multiple options. The user can skip the question. The user searches for an option to select, writing a text or dictating. The Wedding Planner shows some options (List #38—Wedding Dress Decorations, included in Appendix A). The user taps the ‘Back’ button to return to the previous page. The user taps the ‘Skip’ button to skip the question and continue the process.

Referring to FIG. F45, the user selects an option. The user selects the ‘Pearls’ option. The user taps the ‘Continue’ button to continue the process. By tapping the ‘Continue’ button the user reaches the next question (FIG. F46).

Referring to FIG. F46, the Wedding Planner asks “Do you need shoes for the Wedding Ceremony?” It will be possible to select one only option. Selecting at least one option is mandatory. The Wedding Planner shows the ‘Yes’ and ‘No’ options. The user taps the ‘Back’ button to return to the previous page.

Referring to FIG. F47, the user selects an option. The user selects the ‘No’ option. The user taps the ‘Continue’ button to continue the process. By tapping the ‘Continue’ button the user reaches the next question (FIG. F48).

Referring to FIG. F48, the Wedding Planner asks “Do you need jewels and accessories for the Wedding Ceremony?” It will be possible to select one only option. Selecting at least one option is mandatory. The Wedding Planner shows the ‘Yes’ and ‘No’ options. The user taps the ‘Back’ button to return to the previous page.

Referring to FIG. F49, the user selects an option. The user selects the ‘No’ option. The user taps the ‘Continue’ button to continue the process. By tapping the ‘Continue’ button the user reaches the next question (FIG. F50).

Referring to FIG. F50, the Wedding Planner asks “How much are you willing to spend for the Ceremony Wedding Dress?” It will be possible to select a price point. Selecting at least the minimum and maximum amounts is mandatory. The user swipe the price point bar in the right or the left side to decide the amount (Right to reduce and left to increase the amount). It will be possible to manage the amounts manually tapping the min. or max. amounts and a numeric keyboard appears. The user selects a minimum amount to spend for the ceremony wedding dress in ‘$10,000’ and a maximum amount of ‘$20,000.’ The user selects the ‘I have a total budget for the Whole Wedding’ option. The user can now skip this question and enter a single total budget for the event at the end of the process. However the user can decide to enter a budget for that specific question too. Only by selecting this option the Wedding Planner will ask at the end of the process to indicate a total budget for the whole wedding. If the user has entered a budget for the dress or other, the minimum total budget will take into account the specific budgets selected, giving the possibility to modify each budget. The user taps the ‘Back’ button to return to the previous page. The user taps the ‘Continue’ button to continue the process. By tapping the ‘Continue’ button the user reaches the next question (FIG. F51).

Referring to FIG. F51, the Wedding Planner asks “Do you want to suggest the Wedding Stylist to your partner?” It will be possible to tap on the share button. The user taps on the ‘Suggest Wedding Stylist’ button to open the sharing popup. The user taps the ‘Back’ button to return to the previous page. The user taps the ‘Continue’ button to continue the process. The user taps the button to suggest the service of Wedding Stylist to someone (FIG. F52).

Referring to FIG. F52, the user tapping the ‘Suggest Wedding Stylist’ button opens a popup to share the assistant to the selected partner. The user taps the ‘Close’ button to close the popup. Considering the system knows the phone number of the partner, the Wedding Planner suggests as recipient of the private message the partner. The system shows a list of actions to send a message to someone (not only the partner). The actions are ‘Share via message’, ‘Share via email’, ‘Share on Facebook’ and ‘Share on Whatsapp’. Other messaging apps could appear in that list. By tapping the ‘Continue’ button the user reaches the next question (FIG. F53).

Referring to FIG. F53, the Wedding Planner asks “Let's continue with the event! How many guests will be invited for the Wedding Ceremony?” It will be possible to select a number. The user swipes the number bar on the right or on the left side to decide the amount (Right to reduce and left to increase the amount). It will be possible to manage the amounts manually by tapping the number and a numeric keyboard appears. The user selects ‘45 wedding ceremony guests.’ The user taps the ‘Back’ button to return to the previous page. The user taps the ‘Continue’ button to continue the process. By tapping the ‘Continue’ button the user reaches the next question (FIG. F54).

Referring to FIG. F54, the Wedding Planner asks “What is the dress code of Wedding Ceremony?” It will be possible to select one or multiple options. The user can skip the question. The user searches for an option to select, writing a text or dictating. The Wedding Planner shows some options (List #8—Wedding Dress Code, included in Appendix A). The user taps the ‘Back’ button to return to the previous page. The user taps the ‘Skip’ button to skip the question and continue the process.

Referring to FIG. F55, the user selects an option. The user selects the ‘No dress code’ option. The user taps the ‘Continue’ button to continue the process. By tapping the ‘Continue’ button the user reaches the next question (FIG. F56).

Referring to FIG. F56, the Wedding Planner asks “How many bridesmaids will you have for the Wedding Ceremony?” It will be possible to select a number. The user swipes the number bar on the right or on the left side to decide the amount (Right to reduce and left to increase the amount). It will be possible to manage the amounts manually by tapping the number and a numeric keyboard appears. The user selects ‘2 Bridesmaids.’ The user taps the ‘Back’ button to return to the previous page. The user taps the ‘Continue’ button to continue the process. By tapping the ‘Continue’ button the user reaches the next question (FIG. F57).

Referring to FIG. F57, the Wedding Planner asks “How many page boys will you have for the Wedding Ceremony?” It will be possible to select a number. The user swipes the number bar on the right or on the left side to decide the amount (Right to reduce and left to increase the amount). It will be possible to manage the amounts manually by tapping the number and a numeric keyboard appears. The user selects ‘0 page boys.’ The user taps the ‘Back’ button to return to the previous page. The user taps the ‘Continue’ button to continue the process. By tapping the ‘Continue’ button the user reaches the next question (FIG. F58).

Referring to FIG. F58, the Wedding Planner asks “Who will be the officiant of the Wedding Ceremony?” It will be possible to select one only option. The user can skip the question. The user searches for an option to select, writing a text or dictating. The Wedding Planner shows some options (List #16—Wedding Officiants, included in Appendix A). The user taps the ‘Back’ button to return to the previous page. The user taps the ‘Skip’ button to skip the question and continue the process.

Referring to FIG. F59, the user selects an option. The user selects the ‘Priest’ option. The user taps the ‘Continue’ button to continue the process. By tapping the ‘Continue’ button the user reaches the next question (FIG. F60).

Referring to FIG. F60, the Wedding Planner asks “How would you like to arrive at the ceremony?” It will be possible to select one only option. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. F61, the user selects an option. The user selects the ‘Horse-Drawn Carriage’ option. The user taps the ‘Continue’ button to continue the process. By tapping the ‘Continue’ button the user reaches the next question (FIG. F62).

Referring to FIG. F62, the Wedding Planner asks “How would your partner like to arrive at the ceremony?” It will be possible to select one only option. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. F63, the user selects an option. The user selects the ‘Limousine’ option. The user taps the ‘Continue’ button to continue the process. By tapping the ‘Continue’ button the user reaches the next question (FIG. F64).

Referring to FIG. F64, the Wedding Planner asks “Do you want to offer a service of transportation to the guests to arrive at the ceremony?” It will be possible to select one only option. Selecting at least one option is mandatory. The user selects the ‘Yes’ option. The user taps the ‘Back’ button to return to the previous page. The user taps the ‘Continue’ button to continue the process. By tapping the ‘Continue’ button the user reaches the next question (FIG. F65).

Referring to FIG. F65, the Wedding Planner asks “What kind of transportation would you like to offer to the guests to arrive at the ceremony?” It will be possible to select one only option. The user can skip the question. The Wedding Planner shows some options (List #17—Transportation, included in Appendix A) and the user selects the ‘Private bus’ option. The user taps the ‘Continue’ button to continue the process. By tapping the ‘Continue’ button the user reaches the next question (FIG. F66).

Referring to FIG. F66, the Wedding Planner asks “Which wedding march singer do you prefer?” It will be possible to select one only option. The user can skip the question. The user searches for an option to select, writing a text or dictating. The Wedding Planner shows some options (List #18—Wedding March Singers, included in Appendix A). The user taps the ‘Back’ button to return to the previous page. The user taps the ‘Skip’ button to skip the question and continue the process.

Referring to FIG. F67, the user selects an option. The user selects the ‘Soprano’ option. The user taps the ‘Continue’ button to continue the process. By tapping the ‘Continue’ button the user reaches the next question (FIG. F68).

Referring to FIG. F68, the Wedding Planner asks “Which wedding march would you like for the ceremony?” It will be possible to select one only option. The user can skip the question. The user searches for an option to select, writing a text or dictating. The Wedding Planner shows some options (List #19—Wedding Marches, included in Appendix A). The user taps the ‘Back’ button to return to the previous page. The user taps the ‘Skip’ button to skip the question and continue the process.

Referring to FIG. F69, the user selects some options. The user selects the ‘Ave Maria’ option. The user taps the ‘Continue’ button to continue the process. By tapping the ‘Continue’ button the user reaches the next question (FIG. F70).

Referring to FIG. F70, The Wedding Planner asks “Do you need wedding bags for guests for the ceremony?” It will be possible to select one only option. Selecting at least one option is mandatory. The user selects the ‘No’ option. If the user selects ‘Yes’ the next questions will be about the type of bags for guests with a list of options (List #2—Wedding Bags for Guests, included in Appendix A). The user taps the ‘Back’ button to return to the previous page. The user taps the ‘Continue’ button to continue the process. By tapping the ‘Continue’ button the user reaches the next question (FIG. F71).

Referring to FIG. F71, The Wedding Planner asks “Do you want music during the ceremony?” It will be possible to select one only option. Selecting at least one option is mandatory. The user selects the ‘No’ option. If the user selects ‘Yes’ the next questions will be about the music for the ceremony with a list of options (List #5—Music Genre, included in Appendix A) The user taps the ‘Back’ button to return to the previous page. The user taps the ‘Continue’ button to continue the process. By tapping the ‘Continue’ button the user reaches the next question (FIG. F72).

Referring to FIG. F72, The Wedding Planner asks “What kind of special shows would you like at the end of the ceremony?” It will be possible to select one or multiple options. The user can skip the question. The user searches for an option to select, writing a text or dictating. The Wedding Planner shows some options (List #12—Wedding Special Shows, included in Appendix A). The user selects the ‘Fireworks’ option. The user taps the ‘Back’ button to return to the previous page. The user taps the ‘Skip’ button to skip the question and continue the process. By tapping the ‘Continue’ button the user reaches the next question (FIG. F73).

Referring to FIG. F73, The Wedding Planner asks “What kind of wedding favors would you like for the ceremony?” It will be possible to select one or multiple options. The user can skip the question. The user searches for an option to select, writing a text or dictating. The Wedding Planner shows some options (List #20—Wedding Favors, included in Appendix A). The user selects the ‘Italian confetti’ and ‘Mini Succulents’ options. The user taps the ‘Back’ button to return to the previous page. The user taps the ‘Skip’ button to skip the question and continue the process. By tapping the ‘Continue’ button the user reaches the next question (FIG. F74).

Referring to FIG. F74, The Wedding Planner asks “What kind of special service would you like at the end of the ceremony?” It will be possible to select one only option. The user can skip the question. The user searches for an option to select, writing a text or dictating. The Wedding Planner shows some options (List #13—Wedding Services, included in Appendix A). The user taps the ‘Back’ button to return to the previous page. The user taps the ‘Skip’ button to skip the question and continue the process.

Referring to FIG. F75, the user selects some options. The user selects the ‘Photo Booth’ and ‘Candy buffet’ options. The user taps the ‘Continue’ button to continue the process. The system gives the user the opportunity to add further details or options that the assistant has not directly asked for. By choosing some additional options the system will be able to create further specific questions and receive their preferences from the user. In fact, the questionnaire process could really be long, so in this question the user can search and select all the details left out of the questionnaire to generate further questions. By tapping the ‘Continue’ button the user reaches the next request (FIG. F76).

Referring to FIG. F76, The Wedding Planner asks “What kind of details would you like to add to the Wedding Ceremony?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process. By tapping the ‘Continue’ button the user reaches the next question (FIG. F77).

Referring to FIG. F77, The Wedding Planner asks “Can I organize and book everything for the Wedding Ceremony?” It will be possible to select one only option. Selecting at least one option is mandatory. The user selects the ‘Yes’ option. The Wedding Planner will schedule and organize the Wedding Party with the restaurant in total autonomy. The user taps the ‘Back’ button to return to the previous page. The user taps the ‘Continue’ button to continue the process. By tapping the ‘Continue’ button the user reaches the next question (FIG. F78).

Referring to FIG. F77, The Wedding Planner asks “How much are you willing to spend for the Wedding Ceremony?” It will be possible to select a price point. Selecting at least the minimum and maximum amounts is mandatory. The user swipe the price point bar in the right or the left side to decide the amount (Right to reduce and left to increase the amount). It will be possible to manage the amounts manually tapping the min. or max. amounts and a numeric keyboard appears. The user selects a minimum amount to spend for the Wedding ceremony at ‘$8,000’ and a maximum amount of ‘$10,000.’ The user can select the ‘I have a total budget for the Whole Wedding’ option. If the user selects that option can skip this question and enter a single total budget for the event at the end of the process. However the user can decide to enter a budget for that specific question too. Only by selecting this option the Personal Wedding will ask at the end of the process to indicate a total budget for the whole wedding. If the user has entered a budget for the dress or other, the minimum total budget will take into account the specific budgets selected, giving the possibility to modify each budget. The user taps the ‘Back’ button to return to the previous page. The user taps the ‘Continue’ button to continue the process.

### Wedding Party

Referring to FIG. G1, by tapping the ‘Continue’ button the user reaches the next question about the Wedding Party. The Wedding Planner asks “Do you want to organize the Wedding Party?” It will be possible to select one only option. Selecting at least one option is mandatory. The Wedding Planner shows some options. The user taps the ‘Back’ button to return to the previous page.

Referring to FIG. G2, the user selects an option. The user selects the ‘Yes’ option. The user taps the ‘Continue’ button to continue the process. By tapping the ‘Continue’ button the user reaches the next request (FIG. G3).

Referring to FIG. G3, the Wedding Planner asks ‘What is the date of the Wedding Party?’ It will be required to fill all fields to continue. The Wedding Planner shows a list of fields to fill about the date and start time of the party. The user taps the ‘Back’ button to return to the previous page.

Referring to FIG. G4, the user fills all requests. The user types the date of the event. The user types the time of the event. The user taps the ‘Continue’ button to continue the process. By tapping the ‘Continue’ button the user reaches the next request (FIG. G5).

Referring to FIG. G5, the Wedding Planner asks “What kind of venue would you like for the Wedding Party?” It will be possible to select one or multiple options. The user can skip the question. The user searches for an option to select, writing a text or dictating. The user selects the ‘Restaurant’ option. (List #3—Venues for Parties, included in Appendix A). The user taps the ‘Back’ button to return to the previous page. The user taps the ‘Continue’ button to continue the process. By tapping the ‘Continue’ button the user reaches the next request (FIG. G6).

Referring to FIG. G6, the Wedding Planner asks “What is the place of the Wedding Party?” The user can skip the question. The user adds the City and the State for the wedding party ‘Capri—Italy.’ The user adds the specific location or the bridal shower ‘Riccio Capri Restaurant Capri (NA).’ The user taps the ‘Back’ button to return to the previous page. The user taps the ‘Continue’ button to continue the process. By tapping the ‘Continue’ button the user reaches the next request (FIG. G7).

Referring to FIG. G7, the Wedding Planner asks “What type of Wedding Party would you like?” It will be possible to select one or multiple options. The user can skip the question. The user searches for an option to select, writing a text or dictating. The Wedding Planner shows some options (List #6—Type of Wedding Party, included in Appendix A). The user taps the ‘Back’ button to return to the previous page. The user taps the ‘Skip’ button to skip the question and continue the process.

Referring to FIG. G8, the user selects an option. The user selects the ‘Dinner’ option. The user taps the ‘Continue’ button to continue the process. By tapping the ‘Continue’ button the user reaches the next request (FIG. G9).

Referring to FIG. G9, the Wedding Planner asks “What is the theme of the Wedding Party?” It will be possible to select one or multiple options. The user can skip the question. The user searches for an option to select, writing a text or dictating. The Wedding Planner shows some options. (List #7—General Wedding Themes, included in Appendix A). The user taps the ‘Back’ button to return to the previous page. The user taps the ‘Skip’ button to skip the question and continue the process.

Referring to FIG. G10, the user selects an option. The user selects the ‘Romantic’ option. The user taps the ‘Continue’ button to continue the process. By tapping the ‘Continue’ button the user reaches the next question (FIG. G11).

Referring to FIG. G11, the Wedding Planner asks “What colors do you prefer for the Wedding Party?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. G12, the user selects some options. The user selects the ‘Gold’ and ‘White’ options. The user taps the ‘Continue’ button to continue the process. By tapping the ‘Continue’ button the user reaches the next question (FIG. G13).

Referring to FIG. G13, the Wedding Planner asks “What flowers do you prefer for the first bouquet for the Wedding Party?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. G14, the user selects an option. The user selects the ‘Orchids’ option. The user taps the ‘Continue’ button to continue the process. By tapping the ‘Continue’ button the user reaches the next request (FIG. G15).

Referring to FIG. G15, the Wedding Planner asks “What is the dress code of the Wedding Party?” It will be possible to select one or multiple options. The user can skip the question. The user searches for an option to select, writing a text or dictating. The Wedding Planner shows some options (List #8—Wedding Dress Code, included in Appendix A). The user taps the ‘Back’ button to return to the previous page. The user taps the ‘Skip’ button to skip the question and continue the process.

Referring to FIG. G16, the user selects an option. The user selects the ‘Cocktail Chic’ option. The user taps the ‘Continue’ button to continue the process. By tapping the ‘Continue’ button the user reaches the next question (FIG. G17).

Referring to FIG. G17, the Wedding Planner asks “Do you need a dress for the Wedding Party? I can collaborate with Wedding Stylist to find a perfect dress” It will be possible to select one only option. Selecting at least one option is mandatory. The Wedding Planner shows the ‘Yes’ and ‘No’ options. The user taps the ‘Back’ button to return to the previous page.

Referring to FIG. G18, the user selects an option. The user selects the ‘No’ option. The user taps the ‘Continue’ button to continue the process. By tapping the ‘Continue’ button the user reaches the next question (FIG. G19).

Referring to FIG. G19, the Wedding Planner asks “Do you need shoes for the Wedding Party? I can collaborate with Wedding Stylist to find a perfect dress.” It will be possible to select one only option. Selecting at least one option is mandatory. The Wedding Planner shows the ‘Yes’ and ‘No’ options. The user taps the ‘Back’ button to return to the previous page.

Referring to FIG. G20, the user selects an option. The user selects the ‘No’ option. The user taps the ‘Continue’ button to continue the process. By tapping the ‘Continue’ button the user reaches the next question (FIG. G21).

Referring to FIG. G21, the Wedding Planner asks “Do you need accessories for the Wedding Party? I can collaborate with Wedding Stylist to find a perfect dress” It will be possible to select one only option. Selecting at least one option is mandatory. The Wedding Planner shows the ‘Yes’ and ‘No’ options. The user taps the ‘Back’ button to return to the previous page.

Referring to FIG. G22, the user selects an option. The user selects the ‘No’ option. The user taps the ‘Continue’ button to continue the process. By tapping the ‘Continue’ button the user reaches the next question (FIG. G23).

Referring to FIG. G23, the Wedding Planner asks “How would you like to arrive at the Wedding Party?” It will be possible to select one only option. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. G24, the user selects an option. The user selects the ‘Limousine’ option. The user taps the ‘Continue’ button to continue the process. By tapping the ‘Continue’ button the user reaches the next question (FIG. G25).

Referring to FIG. G25, the Wedding Planner asks “How would your partner like to arrive at the Wedding Party?” It will be possible to select one only option. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. G26, the user selects an option. The user selects the ‘Limousine’ option. The user taps the ‘Continue’ button to continue the process. By tapping the ‘Continue’ button the user reaches the next question (FIG. G27).

Referring to FIG. G27, the Wedding Planner asks “Do you want to offer a service of transportation to the guests to arrive at the Wedding Party?” It will be possible to select one only option. Selecting at least one option is mandatory. The user selects the ‘Yes’ option. The user taps the ‘Back’ button to return to the previous page. The user taps the ‘Continue’ button to continue the process. By tapping the ‘Continue’ button the user reaches the next question (FIG. G28).

Referring to FIG. G28, the Wedding Planner asks “What kind of transportation would you like to offer to the guests to arrive at the Wedding Party?” It will be possible to select one only option. The user can skip the question. The Wedding Planner shows some options (List #17—Transportation, included in Appendix A) and the user selects the ‘Private bus’ option. The user taps the ‘Continue’ button to continue the process. By tapping the ‘Continue’ button the user reaches the next question (FIG. G29).

Referring to FIG. G29, the Wedding Planner asks “Do you need wedding bags for guests for the Wedding Party?” It will be possible to select one only option. Selecting at least one option is mandatory. The user selects the ‘No’ option. If the user selects ‘Yes’ the next questions will be about the bags for guests for the Wedding Party with a list of options (List #2—Wedding Bags for Guests, included in Appendix A). The user taps the ‘Back’ button to return to the previous page. The user taps the ‘Continue’ button to continue the process. By tapping the ‘Continue’ button the user reaches the next question (FIG. G30).

Referring to FIG. G30, the Wedding Planner asks “What kind of Entertainments would you like for the Wedding Party?” It will be possible to select one or multiple options. The user can skip the question. The user searches for an option to select, writing a text or dictating. The Wedding Planner shows some options (List #11—Wedding Entertainments, included in Appendix A). The user taps the ‘Back’ button to return to the previous page. The user taps the ‘Skip’ button to skip the question and continue the process.

Referring to FIG. G30.1, the user selects some options. The user selects the ‘Jazz Band’ and ‘Fire Dancers’ options. The user taps the ‘Continue’ button to continue the process. By tapping the ‘Continue’ button the user reaches the next question (FIG. G31).

Referring to FIG. G31, the Wedding Planner asks “What kind of special shows would you like at the end of the Wedding Party?” It will be possible to select one or multiple options. The user can skip the question. The user searches for an option to select, writing a text or dictating. The user selects the ‘Fireworks’ option (List #12—Wedding Special Shows, included in Appendix A). The user taps the ‘Back’ button to return to the previous page. The user taps the ‘Continue’ button to continue the process. By tapping the ‘Continue’ button the user reaches the next question (FIG. G32).

Referring to FIG. G32, the Wedding Planner asks “What kind of wedding favors would you like for the Wedding Party?” It will be possible to select one or multiple options. The user can skip the question. The user searches for an option to select, writing a text or dictating. The user selects the ‘Italian confetti’ and ‘Mini Succulentes’ option (List #20—Wedding Favors, included in Appendix A). The user taps the ‘Back’ button to return to the previous page. The user taps the ‘Continue’ button to continue the process. By tapping the ‘Continue’ button the user reaches the next question (FIG. G33).

Referring to FIG. G33, the Wedding Planner asks “What kind of services would you like at the end of the Wedding Party?” It will be possible to select one or multiple options. The user can skip the question. The user searches for an option to select, writing a text or dictating. The Wedding Planner shows some options (List #13—Wedding Services, included in Appendix A). The user taps the ‘Back’ button to return to the previous page. The user taps the ‘Skip’ button to skip the question and continue the process.

Referring to FIG. G34, the user selects some options. The user selects the ‘Photo Booth’ and ‘Candy buffet’ options. The user taps the ‘Continue’ button to continue the process. By tapping the ‘Continue’ button the user reaches the next question (FIG. G35).

Referring to FIG. G35, the Wedding Planner asks “What kind of menu do you prefer for the Wedding Party?” It will be possible to select one or multiple options. The user can skip the question. The user searches for an option to select, writing a text or dictating. The Wedding Planner shows some options (List #21—Wedding Party Menu, included in Appendix A). The user taps the ‘Back’ button to return to the previous page. The user taps the ‘Skip’ button to skip the question and continue the process.

Referring to FIG. G36, the user selects an option. The user selects the ‘Seafood” option. The user taps the ‘Continue’ button to continue the process. By tapping the ‘Continue’ button the user reaches the next question (FIG. G37).

Referring to FIG. G37, the Wedding Planner asks “Do you want to specify any menu intolerance and allergies for food of the Wedding Party?” It will be possible to select one or multiple options. The user can skip the question. The user searches for an option to select, writing a text or dictating. The Wedding Planner shows some options (List #22—Food Allergies and intolerances, included in Appendix A). The user taps the ‘Back’ button to return to the previous page. The user taps the ‘Skip’ button to skip the question and continue the process. The system gives the user the opportunity to add further details or options that the assistant has not directly asked for. By choosing some additional options the system will be able to create further specific questions and receive their preferences from the user. In fact, the questionnaire process could really be long, so in this question the user can search and select all the details left out of the questionnaire to generate further questions. By tapping the ‘Continue’ button the user reaches the next question (FIG. G38).

Referring to FIG. G38, the Wedding Planner asks “What kind of details would you like to add to the Wedding Party?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process. By tapping the ‘Continue’ button the user reaches the next question (FIG. G39).

Referring to FIG. G39, the Wedding Planner asks “Can I organize and book everything for the Wedding Party?” It will be possible to select one only option. Selecting at least one option is mandatory. The user selects the ‘Yes’ option. The Wedding Planner will schedule and organize the Wedding Party with the restaurant in total autonomy. The user taps the ‘Back’ button to return to the previous page. The user taps the ‘Continue’ button to continue the process. By tapping the ‘Continue’ button the user reaches the next question (FIG. G40).

Referring to FIG. G40, the Wedding Planner asks “How much are you willing to spend for the Wedding Party?” It will be possible to select a price point. Selecting at least the minimum and maximum amounts is mandatory. The user swipe the price point bar in the right or the left side to decide the amount (Right to reduce and left to increase the amount). It will be possible to manage the amounts manually tapping the min. or max. amounts and a numeric keyboard appears. The user selects a minimum amount to spend for the Wedding Party at ‘$5,000’ and a maximum amount of ‘$6,500.’ Considering that the user already selected the option ‘I have a total budget for the Whole Wedding’, the option will be automatically selected. The user taps the ‘Back’ button to return to the previous page. The user taps the ‘Continue’ button to continue the process.

### Wedding Cake

By tapping the ‘Continue’ button the user reaches the next question about the wedding cake (FIG. H1). Referring to FIG. H1, the Wedding Planner asks “Do you want to create the Wedding Cake?” It will be possible to select one only option. Selecting at least one option is mandatory. The Wedding Planner shows the ‘Yes’ and ‘No’ options. The user taps the ‘Back’ button to return to the previous page.

Referring to FIG. H2, the user selects an option. The user selects the ‘Yes’ option. The user taps the ‘Continue’ button to continue the process. By tapping the ‘Continue’ button the user reaches the next question (FIG. H3).

Referring to FIG. H3, the Wedding Planner asks “Do you have photos of wedding cakes that you like and want to show me as a reference?” It will be possible to select one only option. Selecting at least one option is mandatory. The user selects the ‘Yes’ option. The user taps the ‘Back’ button to return to the previous page. The user taps the ‘Continue’ button to continue the process. By tapping the ‘Continue’ button the user reaches the next question (FIG. H4).

Referring to FIG. H4, the Wedding Planner says “To proceed, please upload the photos of wedding cakes you like as reference” It will be possible to upload pictures of wedding cakes or skip the question. The user taps the ‘Upload’ button to upload a picture. The Wedding Planner shows an upload picture with the button ‘Delete’ to delete it and the button ‘Open preview’ to open it. The user taps the ‘Back’ button to return to the previous page. The user taps the ‘Continue’ button to continue the process. By tapping the ‘Continue’ button the user reaches the next question (FIG. H5).

Referring to FIG. H5, the Wedding Planner asks “What types of Cake would you like?” It will be possible to select one or multiple options. The user can skip the question. The user searches for an option to select, writing a text or dictating. The Wedding Planner shows some options (List #53—Types of cakes and various pastries, included in Appendix A). The user taps the ‘Back’ button to return to the previous page. The user taps the ‘Skip’ button to skip the question and continue the process.

Referring to FIG. H6, the user selects an option. The user selects the ‘Tiramisu’ options. The user taps the ‘Continue’ button to continue the process. By tapping the ‘Continue’ button the user reaches the next question (FIG. H7).

Referring to FIG. H7, the Wedding Planner asks “What styles of Wedding Cake would you like?” It will be possible to select one or multiple options. The user can skip the question. The user searches for an option to select, writing a text or dictating. The Wedding Planner shows some options (List #23—Styles of Wedding Cake, included in Appendix A). The user taps the ‘Back’ button to return to the previous page. The user taps the ‘Skip’ button to skip the question and continue the process.

Referring to FIG. H8, the user selects some options. The user selects the ‘Oval’ and ‘Tower’ options. The user taps the ‘Continue’ button to continue the process. By tapping the ‘Continue’ button the user reaches the next question (FIG. H9).

Referring to FIG. H9, the Wedding Planner asks “What colors do you prefer for the Wedding Cake?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. H10, the user selects some options. The user selects the ‘Gold’ and ‘White’ options. The user taps the ‘Continue’ button to continue the process. By tapping the ‘Continue’ button the user reaches the next question (FIG. H11).

Referring to FIG. H11, the Wedding Planner asks “What flavors for the Wedding Cake would you like?” It will be possible to select one or multiple options. The user can skip the question. The user searches for an option to select, writing a text or dictating. The Wedding Planner shows some options (List #52—Cake flavors, included in Appendix A). The user taps the ‘Back’ button to return to the previous page. The user taps the ‘Skip’ button to skip the question and continue the process.

Referring to FIG. H12, the user selects an option. The user selects the ‘Coffee’ options. The user taps the ‘Continue’ button to continue the process. By tapping the ‘Continue’ button the user reaches the next question (FIG. H13).

Referring to FIG. H13, the Wedding Planner asks “What topper for the Wedding Cake would you like?” It will be possible to select one or multiple options. The user can skip the question. The user searches for an option to select, writing a text or dictating. The Wedding Planner shows some options (List #24—Wedding Cake Topper, included in Appendix A). The user taps the ‘Back’ button to return to the previous page. The user taps the ‘Skip’ button to skip the question and continue the process.

Referring to FIG. H14, the user selects some options. The user selects the ‘Traditional Bride and Groom Figurine’ and ‘Floral toppers’ options. The user taps the ‘Continue’ button to continue the process. By tapping the ‘Continue’ button the user reaches the next question (FIG. H15).

Referring to FIG. H15, the Wedding Planner asks “What type of intolerance and allergies for the Wedding Cake would you like to specify?” It will be possible to select one or multiple options. The user can skip the question. The user searches for an option to select, writing a text or dictating. The Wedding Planner shows some options (List #22—Food Allergies and intolerances, included in Appendix A). The user taps the ‘Back’ button to return to the previous page. The user taps the ‘Skip’ button to skip the question and continue the process. The system gives the user the opportunity to add further details or options that the assistant has not directly asked for. By choosing some additional options the system will be able to create further specific questions and receive their preferences from the user. In fact, the questionnaire process could really be long, so in this question the user can search and select all the details left out of the questionnaire to generate further questions. By tapping the ‘Continue’ button the user reaches the next question (FIG. H16).

Referring to FIG. H16, the Wedding Planner asks “What kind of details would you like to add to the Wedding Cake?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process. By tapping the ‘Continue’ button the user reaches the next question (FIG. H17).

Referring to FIG. H17, the Wedding Planner asks “Can I organize and book everything for the Wedding Cake?” It will be possible to select one only option. Selecting at least one option is mandatory. The user selects the ‘Yes’ option. The Wedding planner will organize and order a cake from a pastry shop in total autonomy. The user taps the ‘Back’ button to return to the previous page. The user taps the ‘Continue’ button to continue the process. By tapping the ‘Continue’ button the user reaches the next question (FIG. H18).

Referring to FIG. H18, the Wedding Planner asks “How much are you willing to spend for the Wedding Cake?” It will be possible to select a price point. Selecting at least the minimum and maximum amounts is mandatory. The price point is set to zero. The user decided to have no specific budget for the wedding cake and everything will depend on the total final budget the user will select. Considering that the user already selected the option ‘I have a total budget for the Whole Wedding’, the option will be automatically selected. The user taps the ‘Back’ button to return to the previous page. The user taps the ‘Continue’ button to continue the process.

### Honeymoon

By tapping the ‘Continue’ button the user reaches the next question about the honeymoon (FIG. L1). Referring to FIG. L1, the Wedding Planner asks “Do you want to organize your honeymoon?” It will be possible to select one only option. Selecting at least one option is mandatory. The Wedding Planner shows the ‘Yes’ and ‘No’ options. The user taps the ‘Back’ button to return to the previous page.

Referring to FIG. L2, the user selects an option. The user selects the ‘Yes’ option. The user taps the ‘Continue’ button to continue the process. By tapping the ‘Continue’ button the user reaches the next question (FIG. L3).

Referring to FIG. L3, the Wedding Planner asks “When would you like to go on your honeymoon?” It will be possible to fill all requests. Filling all requests is mandatory. The user types the departure date. The user types the return date. The system automatically shows the quantity of days based on the dates. The user can only type the departure date and indicate the quantity of days to calculate the return. The user taps the ‘Back’ button to return to the previous page. The user taps the ‘Continue’ button to continue the process. By tapping the ‘Continue’ button the user reaches the next question (FIG. L4).

Referring to FIG. L4, the Wedding Planner asks “What type of honeymoon would you like?” It will be possible to select one or multiple options. The user can skip the question. The user searches for an option to select, writing a text or dictating. The user selects the ‘Cruise’ option (List #25—Wedding Honeymoon, included in Appendix A). The user taps the ‘Back’ button to return to the previous page. The user taps the ‘Continue’ button to continue the process. By tapping the ‘Continue’ button the user reaches the next question (FIG. L5).

Referring to FIG. L5, the Wedding Planner asks “What is the place of the honeymoon?” It will be possible to fill all requests. The user can skip the question. The user types the general position of the cruise. The user types the locations to visit. The user taps the ‘Back’ button to return to the previous page. The user taps the ‘Continue’ button to continue the process. By tapping the ‘Continue’ button the user reaches the next question (FIG. L6).

Referring to FIG. L6, the Wedding Planner asks “How would you like to arrive at the place?” It will be possible to select one only option. The user can skip the question. The user searches for an option to select, writing a text or dictating. The Wedding Planner shows some options (List #17—Transportation, included in Appendix A). The user taps the ‘Back’ button to return to the previous page. The user taps the ‘Skip’ button to skip the question and continue the process.

Referring to FIG. L7, the user selects an option. The user selects the ‘Airplane’ option. The user taps the ‘Continue’ button to continue the process. By tapping the ‘Continue’ button the user reaches the next question (FIG. L8).

Referring to FIG. L8, the Wedding Planner asks “What kind of experiences would you like to do?” It will be possible to select one or multiple options. The user can skip the question. The user searches for an option to select, writing a text or dictating. The Wedding Planner shows some options (List #54—Trip experiences, included in Appendix A). The user taps the ‘Back’ button to return to the previous page. The user taps the ‘Skip’ button to skip the question and continue the process.

Referring to FIG. L9, the user selects some options. The user selects the ‘Culinary tours’, ‘City exploration’ and ‘Shopping’ options. The user taps the ‘Continue’ button to continue the process. By tapping the ‘Continue’ button the user reaches the next question (FIG. L10).

Referring to FIG. L10, the Wedding Planner asks “What kind of details would you like to add to the honeymoon?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process. By tapping the ‘Continue’ button the user reaches the next question (FIG. L11).

Referring to FIG. L11, the Wedding Planner asks “Can I organize and book everything for the honeymoon?” It will be possible to select one only option. Selecting at least one option is mandatory. The user selects the ‘Yes’ option. The Wedding planner will schedule and organize the honeymoon with a travel agency in total autonomy. The user taps the ‘Back’ button to return to the previous page. The user taps the ‘Continue’ button to continue the process. By tapping the ‘Continue’ button the user reaches the next question (FIG. L12).

Referring to FIG. L12, the Wedding Planner asks “How much are you willing to spend for the honeymoon?” It will be possible to select a price point. Selecting at least the minimum and maximum amounts is mandatory. The price point is set to zero. The user decided to have no specific budget for the wedding cake and everything will depend on the total final budget the user will select. Considering that the user already selected the option ‘I have a total budget for the Whole Wedding’, the option will be automatically selected. The user taps the ‘Back’ button to return to the previous page. The user taps the ‘Continue’ button to continue the process.

### Wedding Registry

By tapping the ‘Continue’ button the user reaches the next question about the honeymoon (FIG. M1). Referring to FIG. M1, the Wedding Planner asks “Do you need a Wedding Registry?” It will be possible to select one only option. Selecting at least one option is mandatory. The Wedding Planner shows the ‘Yes’ and ‘No’ options. The user taps the ‘Back’ button to return to the previous page.

Referring to FIG. M2, the user selects an option. The user selects the ‘Yes’ option. The user taps the ‘Continue’ button to continue the process. By tapping the ‘Continue’ button the user reaches the next question (FIG. M3).

Referring to FIG. M3, the Wedding Planner asks “What is the theme of the Wedding Registry?” It will be possible to select one or multiple options. The user can skip the question. The user searches for an option to select, writing a text or dictating. The Wedding Planner shows some options (List #7—General Wedding Themes, included in Appendix A). The user taps the ‘Back’ button to return to the previous page. The user taps the ‘Skip’ button to skip the question and continue the process.

Referring to FIG. M4, the user selects an option. The system shows a pre-selected option ‘Romantic’. It is a theme for the wedding registry consistent with the previous ones chosen. The user can decide to select any theme. The user taps the ‘Continue’ button to continue the process. By tapping the ‘Continue’ button the user reaches the next question (FIG. M5).

Referring to FIG. M5, the Wedding Planner asks “What colors do you prefer for the Wedding Registry?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. M6, the user selects some options. The user selects the ‘White,’ ‘Green,’ and ‘Beige’ options. The user taps the ‘Continue’ button to continue the process. By tapping the ‘Continue’ button the user reaches the next question (FIG. M7).

Referring to FIG. M7, the Wedding Planner says “Great I created a Wedding Registry. It includes your and your partner's GiftProfile.” It will be possible to visit a preview of the wedding registry. The user selects the toggle on ‘ON’ to include the Wedding registry link in the invitations. The user taps the ‘Back’ button to return to the previous page. The user taps the ‘Continue’ button to continue the process.

### Invitations

By tapping the ‘Continue’ button the user reaches the next question about the invitations for the pre-wedding party, wedding ceremony and wedding party (FIG. N1). Referring to FIG. N1, the Wedding Planner asks “Do you need Bridal Shower invitations for your guests?” It will be possible to select one only option. Selecting at least one option is mandatory. The Wedding Planner shows the ‘Yes’ and ‘No’ options. The user taps the ‘Back’ button to return to the previous page.

Referring to FIG. N2, the user selects an option. The user selects the ‘No’ option. The user taps the ‘Continue’ button to continue the process. By tapping the ‘Continue’ button the user reaches the next question (FIG. N3).

Referring to FIG. N3, the Wedding Planner asks “Do you need Wedding Ceremony invitations for your guests?” It will be possible to select one only option. Selecting at least one option is mandatory. The Wedding Planner shows the ‘Yes’ and ‘No’ options. The user taps the ‘Back’ button to return to the previous page.

Referring to FIG. N4, the user selects an option. The user selects the ‘Yes’ option. The user taps the ‘Continue’ button to continue the process. By tapping the ‘Continue’ button the user reaches the next question (FIG. N5).

Referring to FIG. N5, the Wedding Planner asks “Do you need different Wedding Party invitations?” It will be possible to select one only option. Selecting at least one option is mandatory. The Wedding Planner shows the ‘Yes’ and ‘No’ options. The user taps the ‘Back’ button to return to the previous page.

Referring to FIG. N6, the user selects an option. The user selects the ‘No’ option. The user taps the ‘Continue’ button to continue the process. By tapping the ‘Continue’ button the user reaches the next question (FIG. N7).

Referring to FIG. N7, the Wedding Planner asks “How many guests do you wanna invite?” It will be possible to select a number of guests. Selecting at least one option is mandatory. The user selects ‘45’ guests. The user taps the ‘Back’ button to return to the previous page. The user taps the ‘Continue’ button to continue the process. By tapping the ‘Continue’ button the user reaches the next question (FIG. N8).

Referring to FIG. N8, the Wedding Planner asks “What type of Wedding invitations do you wanna send?” It will be possible to select one only option. Selecting at least one option is mandatory. The Wedding Planner shows the ‘Virtual invitations’ to send a private message to all guests and ‘Printed invitations’ to create printed invitations that will be sent to the user that which it will distribute manually or by shipping to all guests. The user taps the ‘Back’ button to return to the previous page.

Referring to FIG. N9, the user selects an option. The user selects the ‘Printed invitations’ option. The user taps the ‘Continue’ button to continue the process. By tapping the ‘Continue’ button the user reaches the next question (FIG. N10).

Referring to FIG. N10, the Wedding Planner asks “What themes for Wedding Invitations do you prefer?” It will be possible to select one or multiple options. The user can skip the question. The user searches for an option to select, writing a text or dictating. The Wedding Planner shows some options (List #7—General Wedding Themes, included in Appendix A). The user taps the ‘Back’ button to return to the previous page. The user taps the ‘Skip’ button to skip the question and continue the process.

Referring to FIG. N11, the user selects an option. The user selects the ‘Romantic’ option. The user taps the ‘Continue’ button to continue the process. By tapping the ‘Continue’ button the user reaches the next question (FIG. N12).

Referring to FIG. N12, the Wedding Planner asks “What colors do you prefer for the Wedding Invitations?” It will be possible to select one or multiple options. The user can skip the question. The user searches for an option to select, writing a text or dictating. The Wedding Planner shows some options. The user taps the ‘Back’ button to return to the previous page. The user taps the ‘Skip’ button to skip the question and continue the process.

Referring to FIG. N13, the user selects some options. The user selects the ‘Gold’ and ‘White’ options. The user taps the ‘Continue’ button to continue the process. By tapping the ‘Continue’ button the user reaches the next question (FIG. N14).

Referring to FIG. N14, the Wedding Planner asks “What type of paper do you like for the Wedding Invitations?” It will be possible to select one or multiple options. The user can skip the question. The user searches for an option to select, writing a text or dictating. The Wedding Planner shows some options (List #26—Wedding Invitation Paper, included in Appendix A). The user taps the ‘Back’ button to return to the previous page. The user taps the ‘Skip’ button to skip the question and continue the process.

Referring to FIG. N15, the user selects an option. The user selects the ‘Amalfi Paper’ option. The user taps the ‘Continue’ button to continue the process. By tapping the ‘Continue’ button the user reaches the next question (FIG. N16).

Referring to FIG. N16, the Wedding Planner asks “What type of decorations do you like for the Wedding Invitations?” It will be possible to select one or multiple options. The user can skip the question. The user searches for an option to select, writing a text or dictating. The Wedding Planner shows some options (List #27—Wedding Invitation Decoration, included in Appendix A). The user taps the ‘Back’ button to return to the previous page. The user taps the ‘Skip’ button to skip the question and continue the process.

Referring to FIG. N17, the user selects an option. The user selects the ‘Floral Embellishments’ option. The user taps the ‘Continue’ button to continue the process. By tapping the ‘Continue’ button the user reaches the next question (FIG. N18).

Referring to FIG. N18, the Wedding Planner asks “What type of font do you like for the Wedding Invitations?” It will be possible to select one or multiple options. The user can skip the question. The user searches for an option to select, writing a text or dictating. The Wedding Planner shows some options (List #28—Wedding Invitation Font, included in Appendix A). The user taps the ‘Back’ button to return to the previous page. The user taps the ‘Skip’ button to skip the question and continue the process.

Referring to FIG. N19, the user selects an option. The user selects the ‘Times New Roman’ option. The user taps the ‘Continue’ button to continue the process. By tapping the ‘Continue’ button the user reaches the last question for the wedding invitations (FIG. N20).

Referring to FIG. N20, the Wedding Planner asks “How much are you willing to spend for the Wedding Invitations?” It will be possible to select a price point. The user swipe the price point bar in the right or the left side to decide the amount (Right to reduce and left to increase the amount). It will be possible to manage the amounts manually tapping the min. or max. amounts and a numeric keyboard appears. The user selects a minimum amount to spend for the wedding invitations in ‘$100’ and a maximum amount of ‘$120.’ The user selects the ‘I have a total budget for the Whole Wedding’ option. The user can now skip this question and enter a single total budget for the event at the end of the process. However the user can decide to enter a budget for that specific question too. Only by selecting this option the Wedding Planner will ask at the end of the process to indicate a total budget for the whole wedding. The user taps the ‘Back’ button to return to the previous page. The user taps the ‘Continue’ button to continue the process.

### Final Steps

By tapping the ‘Continue’ button the user reaches the next question about the total budget for the whole wedding (FIG. P1). Referring to FIG. P1, the Wedding Planner asks “How much are you willing to spend for the whole wedding?” It will be possible to select a price point. Selecting at least one option is mandatory. The user selects the price point. The Wedding Planner shows a list of specific budgets previously chosen by the user with the possibility to edit them. The user taps the ‘Your answers’ button to open the list of all answers of the process with the possibility to edit them. The user taps the ‘Back’ button to return to the previous page. The user taps the ‘Continue’ button to continue the process. By tapping the ‘Continue’ button the user reaches the next question about the number of projects it has to generate (FIG. P2).

Referring to FIG. P2, the Wedding Planner asks “How many projects do you want to generate?” It will be possible to select a number. Selecting at least one option is mandatory. The user selects the number of projects to generate. The Wedding Planner shows what the user will find in each project: ‘Design of Pre-party Wedding’, ‘Design of Wedding Ceremony’, ‘Design of Wedding Dress’, ‘Design of Wedding Party’, ‘Design of Wedding Cake’, ‘Quote of Honeymoon’, ‘Design of Wedding Registry (website)’ and ‘Design of Invitations.’ The user taps the ‘Back’ button to return to the previous page. The user taps the ‘Continue’ button to continue the process. By tapping the ‘Continue’ button the Wedding Planner generates the project of the whole wedding considering the information and all preferences the user chose in the process. The project includes packs of pictures, list of items to purchase and suggested stores or agencies.

Referring to FIG. P3, the Wedding Planner generates 1 only project as requested by the user. The Wedding Planner shows the pack of pictures, videos, items and suggestions for the Pre-Wedding Party. The Wedding Planner shows the pack of pictures, videos, items and suggestions for the Wedding dress. The Wedding Planner shows the pack of pictures, videos, items and suggestions for the Wedding Ceremony. The Wedding Planner shows the pack of pictures, videos, items and suggestions for the Wedding Party.

Referring to FIG. P4, scrolling the page, the Wedding Planner shows the pack of pictures, videos, items and suggestions for the Wedding Cake. The Wedding Planner shows the pack of pictures, videos, items and suggestions for the Honeymoon. The Wedding Planner shows the pack of pictures, videos, items and suggestions for the Wedding Registry. The Wedding Planner shows the pack of pictures, videos, items and suggestions for the Wedding Invitations. The user taps on the ‘Pre-Wedding Party’ pack (FIG. P5).

Referring to FIG. P5, the user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the pre-wedding party. The user taps on the ‘Location’ button to open the contents about the locations. The user taps on the ‘Special services’ button to open the contents about the special services.

Referring to FIG. P6, the user scrolls the page. The user taps on the ‘Entertainment’ button to open the contents about the entertainment. The user taps on the ‘Menu’ button to open the contents about the menu. The Wedding Planner shows some items to purchase. The user taps the ‘Show all’ button to open the list of all items.

Referring to FIG. P7, the user taps on the ‘Wedding Dress’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the wedding dress. The user taps on the ‘Details’ button to open the contents about the dress details.

Referring to FIG. P8, the user scrolls the page. The Wedding Planner shows some stores to purchase the dress and all accessories. The user taps the ‘Show all’ button to open the list of all stores.

Referring to FIG. P8, the user taps on the ‘Wedding Ceremony’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the Wedding Ceremony. The user taps on the ‘Location’ button to open the contents about the locations. The user taps on the ‘Special services’ button to open the contents about the special services.

Referring to FIG. P10, the user scrolls the page. The user taps on the ‘Entertainment’ button to open the contents about the entertainment. The user taps on the ‘Menu’ button to open the contents about the menu. The Wedding Planner shows some items to purchase. The user taps the ‘Show all’ button to open the list of all items.

Referring to FIG. P11, the user taps on the ‘Wedding Party’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the Wedding Party. The user taps on the ‘Location’ button to open the contents about the locations. The user taps on the ‘Special services’ button to open the contents about the special services.

Referring to FIG. P12, the user scrolls the page. The user taps on the ‘Entertainment’ button to open the contents about the entertainment. The user taps on the ‘Menu’ button to open the contents about the menu. The Wedding Planner shows some items to purchase. The user taps the ‘Show all’ button to open the list of all items.

Referring to FIG. P13, the user taps on the ‘Wedding Cake’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the Wedding Cake. The user taps on the ‘Details’ button to open the contents about the wedding cake details.

Referring to FIG. P14, the user scrolls the page. The Wedding Planner shows some pastry shops to purchase the cake. The user taps the ‘Show all’ button to open the list of all pastry stores.

Referring to FIG. P15, the user taps on the ‘Honeymoon’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. A list of pictures and videos will be shared on the top area. The user scrolls all contents about the Honeymoon (The user selected in the previous questions the desire to have a cruise as honeymoon). The user taps on the ‘Cruise ship’ button to open the contents about the cruise ship. The user taps on the ‘Cruise ship accommodations’ button to open the contents about the cruise ship accommodations.

Referring to FIG. P16, the user scrolls the page. The user taps on the ‘Experiences’ button to open the contents about the experiences. The user taps on the ‘Locations to visit’ button to open the contents about the locations to visit. The Wedding Planner shows some travel agencies as suggestions. The user taps the ‘Show all’ button to open the list of all travel agencies.

Referring to FIG. P17, the user taps on the ‘Wedding Registry’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. The Wedding Planner shows the page of the created wedding registry. The user and partner's GiftProfiles are matched in a unique place. It is a web page where the guest can participate in a Gift Fund, send a charity donation, or purchase a gift from the Gift List.

Referring to FIG. P18, the user taps on the ‘Wedding Invitations’ pack. The user taps the button ‘Back’ to return back to the project list page (FIG. P3). The user taps the ‘Actions’ button to open the list of possible options that will be ‘Share to someone’ to share the service on social networks or via message to someone, and ‘Read more’ to read more about the service, how the company collects personal data and much more. The Wedding Planner shows the page of the created wedding invitation with all information for the guests.

Instead of creating the whole wedding, the user can choose only one of the options from the options screen (FIG. E2). If the user selects the ‘Pre-Wedding Party’ option, the process will only be that described in the section ‘Pre-Wedding Party—Section E’, including the process and generated contents in “Final steps—Section P” (Only pre-wedding party questions and contents). If the user selects the ‘Wedding Ceremony’ option, the process will only be that described in the section ‘Wedding Ceremony—Section F’, including the process and generated contents in “Final steps—Section P” (Only wedding ceremony questions and contents). If the user selects the ‘Wedding Party’ option, the process will only be that described in the section ‘Wedding Party—Section G’, including the process and generated contents in “Final steps—Section P” (Only wedding party questions and contents). If the user selects the ‘Wedding Cake’ option, the process will only be that described in the section ‘Wedding Cake—Section H’, including the process and generated contents in “Final steps—Section P” (Only wedding cake questions and contents). If the user selects the ‘Honeymoon’ option, the process will only be that described in the section ‘Honeymoon—Section L’, including the process and generated contents in “Final steps—Section P” (Only honeymoon questions and contents). If the user selects the ‘Wedding Registry’ option, the process will only be that described in the section ‘Wedding Registry—Section M’, including the process and generated contents in “Final steps—Section P” (Only wedding registry questions and contents). If the user selects the ‘Wedding Invitations’ option, the process will only be that described in the section ‘Wedding Invitations—Section N’, including the process and generated contents in “Final steps—Section P” (Only wedding invitations questions and contents).

### Multi-Agent Search System

Referring to FIGS. 1A-7A, 1B-3B, 1C-4C, 1D-6D, and 1E, a Multi-Agent search system and method includes of a universal search box (FIG. 1A, arrow 1) where users can search for anything they are looking to purchase and a specific “agent” (FIG. 1B arrow 1) most suited to respond will follow up with questions (FIG. 1C arrow 1) related to this search 1. For example: The user can search for “show me a romantic cruise trip for my honeymoon”, the travel agent will then ask the user follow up questions related to the question that will help personalize the result; like do you have a budget in mind? How many days? Etc. Users can request results to be shown at any time skipping questions.

For example: The user can search for “Can you generate some beautiful outfit for me?” The “Personal Stylist” will then ask the user follow up questions related to the question that will help personalize the result; what styles do you like? Do you have a budget in mind? What is the location? Etc. Users can request results to be shown at any time skipping questions. The user has the option to select a category (FIG. 2A arrow 1) and if he does the system will show examples of information to be included in the prompt for optimal results (FIG. 1B arrow 2). If the user selects the category, he will also have the option to use the “personal stylist” with a “guided path” (FIG. 1B arrow 3) which is basically detailed questions asked by the personal stylist.

### Interior Designer

FIG. 1 describes the process through which the user can interact with the assistant ‘Interior Designer.’ The user starts a new chat with the Interior Designer. Descriptions of arrows: (1) The user clicks the prompt field to start the conversation. (2) The user can attach a picture or other type of content in the prompt field. (3) The user clicks the button ‘Send’ to send the request.

Referring to FIG. 2, (1) The user clicks the prompt field and type a request ‘Generate a luxurious master bedroom with neutral tones’ and clicks on the ‘Send button.’

In FIG. 3 a conversation between the Interior Designer virtual assistant and the user is shown. (1) The user shared after the request of the assistant the pictures and the floor plan of the room. (2) The user prefers to just renovate the furniture of the room and he indicates the total budget ‘$50,000.’ (3) The assistant asks “How many options do you want to generate?” and (4) the user selects the option ‘2 options’ so the assistant will generate 2 visual projects for the room.

FIG. 4 illustrates how the user selects a delivery date range, by which time the user would like to receive all the items needed to remodel his bedroom as requested. (1) The assistant asks to select a delivery range to enable the ‘Buy now’ button. The user already sets a payment method and a delivery address, and other personal preferences like colors or styles. The user can manage his address and payment method. (2) The user selects the month the range starts (3) and the month the range closes. (4) The user confirms his choice. The user can also skip that request clicking on ‘I don't want to respond’ but in that case the purchase will be done by the user. The system. Not knowing the user's preferred delivery date range, the user will not be able to complete the purchase automatically.

FIG. 5 illustrates how the assistant generates the requested options. (1) The user clicks the first option to visualize it, edit it if necessary and confirm to generate the list of related items to purchase. (2) The user selects the button ‘Options’ to ask to ‘Find another option’, ‘Download the content’, ‘Share’, ‘Report’, ‘Save as fav’, ‘Like or Send feedbacks’ and ‘Attach to the prompt’.

FIG. 6 shows the page where the user visualizes the generated room. (1) The user clicks the button ‘Options’ to have some options like: ‘Find another option’, ‘Download the content’, ‘Share’, ‘Report’, ‘Save as fav’, ‘Like or Send feedbacks’ and ‘Attach to the prompt’. (2) The user download the pictures of the generated room. (3) The user can zoom in or (4) zoom out the room. (5) The user clicks the button ‘Selector’ to select a specific area or element in the project of the room. (6) The user can view the room in different modes, including realistic 3D mode or 2D—The user selects the ‘Walkthrough view’ option where he can visit and visualize the room and all the elements the assistant added. Each part or element of the room is editable. (7) The user confirms the project and asks the assistant to generate and find all the items to purchase. (8) The user visualizes the entire room and can select each element (Furniture or specific item). (9) The user can navigate to 360° the room moving the room from left to the right with a long press of the mouse (Or moving the room to the left to the right with the finger on the mobile version) or move the ‘Room line’ to move the room view, as if the user were in the center of the room and rotated 3600 to view the entire room. (10) The user can continue the conversation with the assistant. (11) The user can move his position inside the room (The central dot is the user in the middle of the room). The user can move in the room the dot (that represents himself and his point of view) to change his point of view. For example, he will be able to move that circle to a specific corner of the room and visualize that corner with his new point of view in the central image (8).

FIG. 7 shows the user asking for a change. (1) The user asks the assistant to make a change ‘Could you move the bed closer to the window, remove the bedside tables, and find a bed with a shelf headboard? I think it's a space-saver!’ (2) Attaching contents, he presses (3) ‘Send’ to send the request.

FIG. 8 shows the assistant providing the requested feedback. (1) A feedback by the assistant appears in a popup to confirm the change. The image changes. (2) the user clicks the button ‘Reply’ to make a new request.

FIG. 9 shows additional interaction with a user. (1) The user clicks the button ‘Selector’ to select a specific area if the room (2) he select the ‘Ceiling chandelier’ (3) the button ‘Options’ appears and it opens a popup. The user can (4) Ask the assistant to make changes (5) find another option for that Ceiling chandelier, (6) change the color for the Ceiling chandelier (7) move it, (8) duplicate it and (9) delete it.

In FIG. 10 The user asks to change the color of the Ceiling chandelier (1) a popup appears with some color options, the user selects on color and (2) confirms the choice.

In FIG. 11 The user clicks the option ‘Ask to assistant’ to mention the selected element (Ceiling chandelier) in the prompt and ask the assistant to make changes on that selected element. (1) The user selects the element and it appears in the prompt field. (2) The user asks ‘About Ceiling chandelier—I would like it blue and a Murano Glass” (3) and press ‘Send’ to send the request.

FIG. 12 shows how the user can change the selected item with other options found by the assistant. (1) The user selects an option’ or (2) clicks on the button ‘Find other options’ to refresh the options, (3) Confirm the choice or (4) cancel it and return back.

Referring to FIG. 13, (1) The user selects an option and (2) confirms it.

Referring to FIG. 14, (1) The assistant replaces the chosen item in the whole project picture.

Referring to FIG. 15, (1) The user clicks on ‘Confirm and find items’ to generate the list of related items to purchase.

Referring to FIG. 16, all items to purchase appear in the picture of the room. (1) The user just clicks on a dot on an element (Like on the bed) to open the related item to purchase. (2) The user can visualize the whole list of all items clicking on ‘See the list of 32 items’.

Referring to FIG. 17, (1) The user clicks on the dot on the bed to open the related item found by the assistant. (2) It opens a popup with the items to purchase. (3) it will be possible to ‘Buy now’ the item and the assistant will purchase that items in just a single click, (4) ‘Preview’ to see the preview page of the item (5) ‘Add to bag’ to add the item in the shopping bag to purchase it later, (6) ‘Add to GiftProfile’ to add it in a wish list profile, (7) ‘Find another option’ to request to the assistant to find a different option of item, (8) ‘Ask to the assistant’ to mention the item for a new prompt, (9) other options like ‘Like the item’, ‘Save’, ‘Attach to the prompt ‘or’Generate similar item with a different price’.

Referring to FIG. 18, the user opens the list of items. (1) The name of the project appears on the top (2) the total price for everything appears in the top right side. (3) The user can click ‘BUY NOW’ to purchase everything in a single click or (4) ‘Preview order’ to customize the order, selecting the item he wants to exclude or include in the order, manage payment method and address for the delivery. (5) the user can select the category of the items, see the specific items and click on ‘Buy no’ to purchase a single item.

Referring to FIG. 19, the user can visit the item page and (1) customize the delivery date range, (2) edit address (3) payments method, (4) buy it, (5) add to bag (6) Add to gift profile, (7) find another option (8) ask the assistant a request about the item.

Referring to FIG. 20, if the item will not arrive in time in the date the user selected (1) will appear a popup to (2) Find another item, (3) ask the assistant a request, (4) Buy when it will be available or (5) Edit delivery date range.

### Alternative Implementation Section

Implementation 1. A method of customizing an interactive shopping environment for a user, the method comprising: receiving user input associated with a shopping session; generating a design element based on at least a portion of the received user input; generating the interactive shopping environment including a visual representation of the design element such that the user can interact with the visual representation within the interactive shopping environment; receiving user feedback associated with the visual representation; updating the interactive shopping environment based at least in part on the received user feedback to generate a revised interactive shopping environment including a revised visual representation of the design element; and responsive to receiving user input indicating approval of the revised interactive shopping environment, converting the revised visual representation into a user selectable element.

Implementation 2. The method of Implementation 1, wherein the receiving user input includes receiving contextual information associated with the interactive shopping environment.

Implementation 3. The method of Implementation 1 or Implementation 2, wherein the receiving user input includes receiving image data associated with an environmental aspect.

Implementation 4. The method of any one of implementations 1 to 3, wherein the receiving user input includes receiving personal information associated with the user.

Implementation 5. The method of implementation 4, wherein the generating the design element is based on (i) at least a portion of the received contextual information, (ii) at least a portion of the received image data, (iii) at least a portion of the received personal information, or (iv) any combination of (i), (ii), and (iii).

Implementation 6. The method of implementation 1, wherein the generating the design element includes using a pretrained large image model.

Implementation 7. The method of implementation 3, wherein the received image data is reproducible as a visually readable image and/or video of: a portion of a room, a portion of a building, a portion of a house, the user, a portion of the user, a portion of a wedding venue, a portion of a landscape, a portion of a vehicle, or any combination thereof.

Implementation 8. The method of implementation 2, wherein the received contextual information includes: occasion information, weather information, fashion trends, venue information, location information, room-type information, extent information, usage information, methodology information, budget information, theme information, meal information, occupation information, formality information, date information, time information, style information, color information, brand information, size information, pattern information, fabric information, material information, jewelry material information, jewelry stones, neckline information, detailed feature information, finish information, dress code information, attendee information, music information, services information, destination information, mode of travel information, lodging information, transportation information, or any combination thereof.

Implementation 9. The method of any one of the preceding implementations, further comprising permitting the user to interact with the visual representation within the interactive shopping environment by scrolling, panning, zooming, turning, twisting, selecting, inspecting, or any combination thereof.

Implementation 10. The method of any one of the preceding implementations, further comprising permitting the user to interact with the revised visual representation within the revised interactive shopping environment by scrolling, panning, zooming, turning, twisting, selecting, inspecting, or any combination thereof.

Implementation 11. The method of any one of the preceding implementations, wherein the received user feedback includes changing a color of the visual representation, changing a texture of the visual representation, changing a size of the visual representation, changing a pattern of the visual representation, changing a material of the visual representation, changing a brand associated with the visual representation, changing a location of the visual representation within the interactive shopping environment, changing a style of the visual representation, or any combination thereof.

Implementation 12. The method of any one of the preceding implementations, wherein the interactive shopping environment is for a specific category of interactive shopping environment.

Implementation 13. The method of implementation 12, wherein the specific category is personal stylist, wedding planner, interior decorator, travel agent, or personal shopper.

Implementation 14. The method of any one of the preceding implementations, wherein the visual representation of the design element is a two-dimensional (2D) visual representation of the design element.

Implementation 15. The method of any one of the preceding implementations, wherein the visual representation of the design element is a three-dimensional (3D) visual representation of the design element.

Implementation 16. The method of any one of the preceding implementations, wherein the user selectable element is selectable to aid the user in purchasing an item associated with the revised visual representation.

Implementation 17. The method of any one of the preceding implementations, further comprising, responsive to a selection associated with the user selectable representation, causing the user to be directed to a third party interface to aid the user in purchasing an item associated with the design element.

Implementation 18. The method of implementation 4, wherein the received personal information includes: user preference information, user profile information, user history information, user location, user hobbies, or any combination thereof.

Implementation 19. The method of any one of the preceding implementations, wherein the generating the design element includes using artificial intelligence, one or more machine learning algorithms, or both.

Implementation 20. The method of any one of the preceding implementations, wherein the generated interactive shopping environment includes a virtual reality environment or an augmented reality environment.

Implementation 21. The method of any one of the preceding implementations, wherein the received user feedback includes a user rating, a user comment, user interaction with the visual representation, or any combination thereof.

Implementation 22. The method of any one of the preceding implementations, wherein the updating the interactive shopping environment includes modifying a color of the design element, a texture of the design element, a size of the design element, a shape of the design element, a material of the design element, or any combination thereof.

Implementation 23. The method of any one of the preceding implementations, wherein the converting the revised visual representation into the user selectable element includes generating a hyperlink or a button associated with the item.

Implementation 24. The method of implementation 23, wherein the button is a buy now button.

Implementation 25. The method of any one of the preceding implementations, wherein the generating the design element includes generating a first design element and a second design element and wherein the interactive shopping environment includes a first visual representation of the first design element and a second visual representation of the second design element.

Implementation 26. The method of implementation 25, wherein the updating the interactive shopping environment further includes segmenting the first design element from the second design element.

Implementation 27. The method of implementation 26, wherein the updating the interactive shopping environment further includes performing a first reverse image search of the first design element and performing a second reverse image search of the second design element in a database.

Implementation 28. The method of any one of the preceding implementations, wherein the user input is received through conversational interactions with a chatbot, wherein the chatbot is configured to pose one or more questions to the user.

Implementation 29. The method of any one of the preceding implementations, wherein the user can interact with the visual representation within the interactive shopping environment by conversational interactions with a chatbot, by clicking on the visual representation, by touching the visual representation via a touch-screen interface, or any combination thereof.

Implementation 30. The method of implementation 28 or implementation 29, wherein the conversational interactions are synthesized by a large language model to suggest answers to at least some of the posed one or more questions.

Implementation 31. The method of any one of the preceding implementations, wherein the receiving the user input includes receiving a selection of one or more design element categories.

Implementation 32. The method of implementation 31, wherein the design element categories include consumer products, clothing, shoes, heels, dresses, accessories, underwear, bags, jewelry, furniture, floor types, door knobs, wall paint, lighting, shelves, artwork, curtains, windows, room types, party types, entertainment types, transportation, menus, religion, ceremonies, flowers, cakes, honeymoon types, registry themes, invitation themes, trip types, airports, airlines, hotel chains, rental car companies, hotel rooms, rental cars, or any combination thereof.

Implementation 33. The method of any one of the preceding implementations, wherein the interactive shopping environment includes an avatar associated with the user.

Implementation 34. The method of implementation 33, wherein the avatar appears dressed in the visual representation of the design element or in the revised visual representation of the design element.

Implementation 35. The method of implementation 13, wherein the interactive shopping environment shares user input with another interactive shopping environment from a different category.

Implementation 36. The method of implementation 28 or implementation 29, wherein an application programming interface (API) aids in determining answers to at least some of the one or more questions, and is configured to skip questions that have been already answered.

Implementation 37. The method of implementation 28, wherein a large language model summarizes the user input to generate an optimal prompt to query a large image model that is customized for a specific industry, the shopping session, or a specific interactive shopping environment.

Implementation 38. The method of any one of the preceding implementations, wherein the generating the interactive shopping environment including the visual representation of the design element includes using a pretrained large image model.

Implementation 39. The method of any one of the preceding implementations, wherein the user feedback associated with the visual representation includes keeping the visual representation, deleting the visual representation, saving the visual representation, or providing feedback on why the user does not like the visual representation and/or one or more aspects of the visual representation.

Implementation 40. The method of any one of the preceding implementations, wherein the user feedback includes requesting a change to a specific item or a specific aspect of the visual representation.

Implementation 41. The method of implementation 39 or implementation 40, wherein the user provides the user by clicking on the visual representation, speaking conversationally with a chatbot, or both.

Implementation 42. The method of implementation 17, wherein the selection associated with the user selectable representation includes a selection of a hyperlink that directs the user to the third party interface to aid the user in purchasing the item associated with the design element.

Implementation 43. The method of implementation 1, wherein the user selectable element includes a hyperlink embedded therein.

Implementation 44. A system comprising: a control system having one or more processors; and a memory device having stored thereon machine readable instructions; wherein the control system is coupled to the memory device, and the method of any one of implementations 1 to 43 is implemented when the machine executable instructions in the memory device are executed by at least one of the one or more processors of the control system.

Implementation 45. A system comprising a control system configured to implement the method of any one of implementations 1 to 43.

Implementation 46. A computer program product comprising instructions which, when executed by a computer, cause the computer to carry out the method of any one of implementations 1 to 43.

Implementation 47. The computer program product of implementation 46, wherein the computer program product is a non-transitory computer readable medium.

Implementation 48. A system comprising: a control system having one or more processors; and a memory device having stored thereon machine readable instructions, the control system coupled to the memory device such that at least one of the one or more processors is configured to execute the machine executable instructions to cause the system to: receive user input associated with a shopping session; generate a design element based on at least a portion of the received user input; generate the interactive shopping environment including a visual representation of the design element such that the user can interact with the visual representation within the interactive shopping environment; receive user feedback associated with the visual representation; update the interactive shopping environment based at least in part on the received user feedback to generate a revised interactive shopping environment including a revised visual representation of the design element; and responsive to receiving user input indicating approval of the revised interactive shopping environment, convert the revised visual representation into a user selectable element.

Implementation 49. A method of customizing an interactive shopping environment for a user, the method comprising: receiving user input associated with a shopping session; generating a design element based on at least a portion of the received user input; generating the interactive shopping environment including a user selectable representation of the design element such that the user can interact with the user selectable representation within the interactive shopping environment; and responsive to a selection associated with the user selectable representation, directing the user to a third party interface to aid the user in purchasing an item associated with the design element.

Implementation 50. The method of implementation 49, wherein the receiving user input includes receiving contextual information associated with the interactive shopping environment.

Implementation 51. The method of implementation 49 or implementation 50, wherein the receiving user input includes receiving image data associated with an environmental aspect.

Implementation 52. The method of any one of implementations 49 to 51, wherein the receiving user input includes receiving personal information associated with the user.

Implementation 53. The method of implementation 52, wherein the generating the design element is based on (i) at least a portion of the received contextual information, (ii) at least a portion of the received image data, (iii) at least a portion of the received personal information, or (iv) any combination of (i), (ii), and (iii).

Implementation 54. The method of implementation 49, wherein the generating the design element includes using a pretrained large image model.

Implementation 55. The method of implementation 51, wherein the received image data is reproducible as a visually readable image and/or video of: a portion of a room, a portion of a building, a portion of a house, the user, a portion of the user, a portion of a wedding venue, or any combination thereof.

Implementation 56. The method of implementation 50, wherein the received contextual information includes: occasion information, weather information, fashion trends, venue information, location information, room-type information, extent information, usage information, methodology information, budget information, theme information, meal information, occupation information, formality information, date information, time information, style information, color information, brand information, size information, pattern information, fabric information, material information, jewelry material information, jewelry stones, neckline information, detailed feature information, finish information, dress code information, attendee information, music information, services information, destination information, mode of travel information, lodging information, transportation information, or any combination thereof.

Implementation 57. The method of any one implementations 49 to 56, further comprising permitting the user to interact with the user selectable representation within the interactive shopping environment by scrolling, panning, zooming, turning, twisting, selecting, inspecting, or any combination thereof.

Implementation 58. The method of any one of implementations 49 to 57, wherein the interactive shopping environment is for a specific category of interactive shopping environment.

Implementation 59. The method of implementation 58, wherein the specific category is personal stylist, wedding planner, interior decorator, travel agent, or personal shopper.

Implementation 60. The method of any one of implementations 49 to 59, wherein the user selectable representation of the design element is a two-dimensional (2D) user selectable representation of the design element.

Implementation 61. The method of any one of implementations 49 to 60, wherein the user selectable representation of the design element is a three-dimensional (3D) user selectable representation of the design element.

Implementation 62. The method of implementation 52, wherein the received personal information includes: user preference information, user profile information, user history information, user location, user hobbies, or any combination thereof.

Implementation 63. The method of any one of implementations 49 to 62, wherein the generating the design element includes using artificial intelligence, one or more machine learning algorithms, or both.

Implementation 64. The method of any one of implementations 49 to 63, wherein the generated interactive shopping environment includes a virtual reality environment or an augmented reality environment.

Implementation 65. The method of any one of implementations 49 to 64, wherein the generated interactive shopping environment further includes a buy now button that is separate and distinct from the user selectable element.

Implementation 66. The method of any one of implementations 49 to 65, further comprising generating a second design element based on at least a portion of the received user input.

Implementation 67. The method of implementation 66, wherein the generated interactive shopping environment further includes a second user selectable representation of the second design element.

Implementation 68. The method of any one of implementations 49 to 67, wherein the user input is received through conversational interactions with a chatbot, wherein the chatbot is configured to pose one or more questions to the user.

Implementation 69. The method of any one of implementations 49 to 68, wherein the user can interact with the user selectable representation within the interactive shopping environment by conversational interactions with a chatbot, by clicking on the user selectable representation, by touching the visual representation via a touch-screen interface, or any combination thereof.

Implementation 70. The method of implementation 68 or 69, wherein the conversational interactions are synthesized by a large language model to suggest answers to at least some of the posed one or more questions.

Implementation 71. The method of any one of implementations 49 to 70, wherein the receiving the user input includes receiving a selection of one or more design element categories.

Implementation 72. The method of implementation 71, wherein the design element categories include consumer products, clothing, shoes, heels, dresses, accessories, underwear, bags, jewelry, furniture, floor types, door knobs, wall paint, lighting, shelves, artwork, curtains, windows, room types, party types, entertainment types, transportation, menus, religion, ceremonies, flowers, cakes, honeymoon types, registry themes, invitation themes, trip types, airports, airlines, hotel chains, rental car companies, hotel rooms, rental cars, or any combination thereof.

Implementation 73. The method of any one of implementations 49 to 72, wherein the interactive shopping environment includes an avatar associated with the user.

Implementation 74. The method of implementation 73, wherein the avatar appears dressed in the user selectable representation of the design element.

Implementation 75. The method of implementation 59, wherein the interactive shopping environment shares user input with another interactive shopping environment from a different category.

Implementation 76. The method of implementation 68 or implementation 69, wherein an application programming interface (API) aids in determining answers to at least some of the one or more questions, and is configured to skip questions that have been already answered.

Implementation 77. The method of implementation 68, wherein a large language model summarizes the user input to generate an optimal prompt to query a large image model that is customized for a specific industry, the shopping session, or a specific interactive shopping environment.

Implementation 78. The method of any one of implementations 49 to 77, wherein the generating the interactive shopping environment including the visual representation of the design element includes using a pretrained large image model.

Implementation 79. The method of any one of implementations 49 to 78, wherein the selection associated with the user selectable representation includes a selection of a hyperlink that directs the user to the third party interface to aid the user in purchasing the item associated with the design element.

Implementation 80. The method of any one of implementations 49 to 79, wherein the generating the design element based on the at least a portion of the received user input includes generating a first design element and a second design element based on the at least a portion of the received user input; wherein prior to generating the interactive shopping environment, segmenting the first design element from the second design element, and performing a first reverse image search of the first design element and performing a second reverse image search of the second design element in a database; wherein the generating the interactive shopping environment includes a first user selectable representation of the first design element and a second user selectable representation of the second design element such that the user can interact with the first user selectable representation and the second user selectable representation within the interactive shopping environment; responsive to a selection associated with the first user selectable representation, directing the user to a third party interface to aid the user in purchasing an item associated with the first design element, and responsive to a selection associated with the second user selectable representation, directing the user to a third party interface to aid the user in purchasing an item associated with the second design element.

Implementation 81. The method of any one of implementations 49 to 80, wherein the user selectable representation includes a hyperlink embedded therein.

Implementation 82. A system comprising: a control system having one or more processors; and a memory device having stored thereon machine readable instructions; wherein the control system is coupled to the memory device, and the method of any one of implementations 49 to 81 is implemented when the machine executable instructions in the memory device are executed by at least one of the one or more processors of the control system.

Implementation 83. A system comprising a control system configured to implement the method of any one of implementations 49 to 81.

Implementation 84. A computer program product comprising instructions which, when executed by a computer, cause the computer to carry out the method of any one of implementations 49 to 81.

Implementation 85. The computer program product of implementation 84, wherein the computer program product is a non-transitory computer readable medium.

Implementation 86. A system comprising: a control system having one or more processors; and a memory device having stored thereon machine readable instructions, the control system coupled to the memory device such that at least one of the one or more processors is configured to execute the machine executable instructions to cause the system to: receive user input associated with a shopping session; generate a design element based on at least a portion of the received user input; generate the interactive shopping environment including a user selectable representation of the design element such that the user can interact with the user selectable representation within the interactive shopping environment; and responsive to a selection associated with the user selectable representation, direct the user to a third party interface to aid the user in purchasing an item associated with the design element.

Implementation 87. A computer-implemented method for providing personalized recommendations, comprising: identifying, by a processing unit, a specific agent most suited to respond to a search query, wherein the specific agent is associated with a particular domain or category of items; engaging, by the specific agent, in a personalized interaction with a user by generating targeted follow-up questions related to the search query to refine search results; synthesizing, by a large language model (LLM), user inputs to optimize a recommendation process and provide recommendations in real-time; generating, by a personalized outfit recommendations system, recommendations using machine learning algorithms and recommender systems trained on user preferences and historical data; generating, by a Wedding Planner AI, an image contesting a design of a wedding based on user answers, sharing suggestions to a client based on latest wedding trends, and processing user preferences to create projects and lists of real products to purchase; and processing, by an Interior Designer AI, user preferences to create interior design projects and lists of real products to purchase.

Implementation 88. The computer-implemented method of Implementation 87, further comprising: receiving, by a universal search box, search queries from users for a wide range of desired items.

Implementation 89. The computer-implemented method of Implementation 87, further comprising: collecting, by a personal stylist chatbot, user inputs through conversational interactions.

Implementation 90. The computer-implemented method of Implementation 87, wherein the Wedding Planner AI is further configured to create projects, organize, schedule, and plan wedding events.

Implementation 91. The computer-implemented method of Implementation 87, wherein the Interior Designer AI is further configured to create interior design projects for residential, commercial, and outdoor areas, and generate images, designs, videos, 3D content, and other visual and interactive content including furniture and decorative or structural elements.

Implementation 92. The computer-implemented method of Implementation 87, wherein the specific agent specializes in a specific area, provides tailored user interaction, and asks relevant questions to improve results.

Implementation 93. The computer-implemented method of Implementation 87, wherein the LLM processes user data to generate prompt suggestions.

Implementation 94. The computer-implemented method of Implementation 87, wherein the personalized outfit recommendations system utilizes AI and user data to provide personalized suggestions.

Implementation 95. The computer-implemented method of Implementation 87, wherein the Wedding Planner AI creates visual representations of wedding concepts, offers trendy ideas, and uses user input to recommend relevant products and services.

Implementation 96. The computer-implemented method of Implementation 87, wherein the Interior Designer AI uses user input to recommend relevant products and design concepts.

Implementation 97. A system for providing personalized recommendations, comprising: a processing unit configured to identify a specific agent most suited to respond to a search query, wherein the specific agent is associated with a particular domain or category of items; a specific agent configured to engage in a personalized interaction with a user by generating targeted follow-up questions related to the search query to refine search results; a large language model (LLM) configured to synthesize user inputs to optimize a recommendation process and provide recommendations in real-time; a personalized outfit recommendations system configured to generate recommendations using machine learning algorithms and recommender systems trained on user preferences and historical data; a Wedding Planner AI configured to generate an image contesting a design of a wedding based on user answers, share suggestions to a client based on latest wedding trends, and process user preferences to create projects and lists of real products to purchase; and an Interior Designer AI configured to process user preferences to create interior design projects and lists of real products to purchase.

Implementation 98. The system of Implementation 97, further comprising: a universal search box configured to receive search queries from users for a wide range of desired items.

Implementation 99. The system of Implementation 97, further comprising: a personal stylist chatbot configured to collect user inputs through conversational interactions.

Implementation 100. The system of Implementation 97, wherein the Wedding Planner AI is further configured to create projects, organize, schedule, and plan wedding events.

Implementation 101. The system of Implementation 97, wherein the Interior Designer AI is further configured to create interior design projects for residential, commercial, and outdoor areas, and generate images, designs, videos, 3D content, and other visual and interactive content including furniture and decorative or structural elements.

Implementation 102. The system of Implementation 97, wherein the specific agent specializes in a specific area, provides tailored user interaction, and asks relevant questions to improve results.

Implementation 103. The system of Implementation 97, wherein the LLM processes user data to generate prompt suggestions.

Implementation 104. The system of Implementation 97, wherein the personalized outfit recommendations system utilizes AI and user data to provide personalized suggestions.

Implementation 105. The system of Implementation 97, wherein the Wedding Planner AI creates visual representations of wedding concepts, offers trendy ideas, and uses user input to recommend relevant products and services.

Implementation 106. The system of Implementation 97, wherein the Interior Designer AI uses user input to recommend relevant products and design concepts.

One or more elements or aspects or steps, or any portion(s) thereof, from one or more of any of the above implementations and/or the below claims can be combined with one or more elements or aspects or steps, or any portion(s) thereof, from one or more of any of the other above implementations and/or below claims or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

What is claimed is:

1. A method of customizing an interactive shopping environment for a user, the method comprising:
receiving user input associated with a shopping session; generating a design element based on at least a portion of the received user input;
generating the interactive shopping environment including a visual representation of the design element such that the user can interact with the visual representation within the interactive shopping environment;
receiving user feedback associated with the visual representation; updating the interactive shopping environment based at least in part on the received user feedback to generate a revised interactive shopping environment including a revised visual representation of the design element; and
responsive to receiving user input indicating approval of the revised interactive shopping environment, converting the revised visual representation into a user selectable element.

2. The method of claim 1, wherein the receiving user input includes receiving contextual information associated with the interactive shopping environment.

3. The method of claim 2, wherein the received contextual information includes: occasion information, weather information, fashion trends, venue information, location information, room-type information, extent information, usage information, methodology information, budget information, theme information, meal information, occupation information, formality information, date information, time information, style information, color information, brand information, size information, pattern information, fabric information, material information, jewelry material information, jewelry stones, neckline information, detailed feature information, finish information, dress code information, attendee information, music information, services information, destination information, mode of travel information, lodging information, transportation information, or any combination thereof.

4. The method of claim 2, wherein the receiving user input includes receiving image data associated with an environmental aspect,

5. The method of claim 4, wherein the received image data is reproducible as a visually readable image and/or video of: a portion of a room, a portion of a building, a portion of a house, the user, a portion of the user, a portion of a wedding venue, a portion of a landscape, a portion of a vehicle, or any combination thereof.

6. The method of claim 4, wherein the receiving user input includes receiving personal information associated with the user.

7. The method of claim 6, wherein the received personal information includes: user preference information, user profile information, user history information, user location, user hobbies, or any combination thereof.

8. The method of claim 6, wherein the generating the design element is based on (i) at least a portion of the received contextual information, (ii) at least a portion of the received image data, (iii) at least a portion of the received personal information, or (iv) any combination of (i), (ii), and (iii).

9. The method of claim 1, wherein the received user feedback includes changing a color of the visual representation, changing a texture of the visual representation, changing a size of the visual representation, changing a pattern of the visual representation, changing a material of the visual representation, changing a brand associated with the visual representation, changing a location of the visual representation within the interactive shopping environment, changing a style of the visual representation, or any combination thereof.

10. The method of claim 1, wherein the interactive shopping environment is for a specific category of interactive shopping environment, and wherein the specific category is personal stylist, wedding planner, interior decorator, travel agent, or personal shopper.

11. The method of claim 1, wherein the visual representation of the design element is a two-dimensional (2D) visual representation of the design element or a three-dimensional (3D) visual representation of the design element.

12. The method of claim 1, wherein the user selectable element is selectable to aid the user in purchasing an item associated with the revised visual representation.

13. The method of claim 1, wherein the generating the design element includes using artificial intelligence, one or more machine learning algorithms, or both, and wherein the generated interactive shopping environment includes a virtual reality environment or an augmented reality environment.

14. The method of claim 1, wherein the received user feedback includes a user rating, a user comment, user interaction with the visual representation, or any combination thereof, and wherein the updating the interactive shopping environment includes modifying a color of the design element, a texture of the design element, a size of the design element, a shape of the design element, a material of the design element, or any combination thereof.

15. The method of claim 1, wherein the converting the revised visual representation into the user selectable element includes generating a hyperlink or a button associated with the item.

16. The method of claim 1, wherein the generating the design element includes generating a first design element and a second design element and wherein the interactive shopping environment includes a first visual representation of the first design element and a second visual representation of the second design element.

17. The method of claim 16, wherein the updating the interactive shopping environment further includes segmenting the first design element from the second design element.

18. The method of claim 17, wherein the updating the interactive shopping environment further includes performing a first reverse image search of the first design element and performing a second reverse image search of the second design element in a database.

19. The method of claim 1, wherein the interactive shopping environment includes an avatar associated with the user, and wherein the avatar appears dressed in the visual representation of the design element or in the revised visual representation of the design element.

20. A method of customizing an interactive shopping environment for a user, the method comprising:
receiving user input associated with a shopping session;
generating a design element based on at least a portion of the received user input;
generating the interactive shopping environment including a user selectable representation of the design element such that the user can interact with the user selectable representation within the interactive shopping environment; and
responsive to a selection associated with the user selectable representation, directing the user to a third party interface to aid the user in purchasing an item associated with the design element.
